(19) United States
(12) Patent Application Publication
(10) Pub. No.: US 2026/0209483 A1
(43) Pub. Date: Jul. 23, 2026

(54) RUBBER COMPOSITIONS COMPRISING ANTIDEGRADANTS

(71) Applicant: FLEXSYS AMERICA L.P., Akron, OH (US)

(72) Inventors: Judicael Jacques CHAPELET, Copley, OH (US); Malik Hani AL-AFYOUNI, Akron, OH (US); Donald L. FIELDS, JR., Copley, OH (US); Frederick IGNATZ-HOOVER, Elyria, OH (US); Jonathan Michael PENNEY, Cuyahoga Falls, OH (US); Hiu Ching WONG, Tallmadge, OH (US); Shanzuo JI, Beachwood, OH (US); Ralph Dale TRIPLETT, II, Wadsworth, OH (US)

(73) Assignee: FLEXSYS AMERICA L.P., Akron, OH (US)

(21) Appl. No.: 19/140,647

(22) PCT Filed: Dec. 19, 2023
(86) PCT No.: PCT/US2023/084882

§ 371 Date: Jun. 18, 2025

Related U.S. Application Data
(60) Provisional application No. 63/476,118, filed on Dec. 19, 2022.
(60) Provisional application No. 63/510,462, filed on Jun. 27, 2023.

(51) Int. Cl. C08L 7/00; B60C 1/00; C08K 3/04; C08K 3/06; C08K 3/22; C08K 5/09; C08K 5/18; C08K 5/3417; C08K 5/3437; C08K 5/3447; C08K 5/3462; C08K 5/3492; C08K 5/353; C08K 5/372; C08K 5/375; C08K 5/47; C08L 9/00; C08L 17/00

(52) U.S. Cl. CPC C08L 7/00; B60C 1/0016; B60C 1/0025; C08K 3/04; C08K 3/06; C08K 3/22; C08K 5/09; C08K 5/18; C08K 5/3417; C08K 5/3437; C08K 5/3447; C08K 5/3462; C08K 5/34926; C08K 5/353; C08K 5/372; C08K 5/375; C08K 5/47; C08L 9/00; C08L 17/00; C08K 2003/2296; C08L 2205/025; C08L 2205/03; C08L 2312/00

(57) ABSTRACT

The present disclosure provides compositions comprising compounds of Formula (I-A), (IV-A), (I-B), (I-C), (VI-C), (VII-C), (I-D), (II-D), (III-D), (IV-D), (V-D), (VI-D), (VII-D), (I E), (II-E), (III-E), (IV-E), (V-E), (VI-E), (I-F), (II-F), (III-F), (I-G), (II-G), (III-G), (I-H), (II-H), (III-H), (IV-H), (V-H), (VI-H), (I-J), (II-J), (III-J), (IV-J), (V-J), (VI-J), (VII-J), (VIII-J), (IX-J), (X-J), (XI-J), (XII-J), (XIII-J), (XIV-J), or (XV-J), or salts or solvates thereof, that are useful additives for tires and other vulcanized rubber articles. The present disclosure also provides vulcanized elastomeric articles comprising compounds of Formula (I-A), (IV-A), (I-B), (I-C), (VI-C), (VII-C), ((I-D), (II-D), (III-D), (IV-D), (V-D), (VI-D), (VII-D), (I E), (II-E), (III-E), (IV-E), (V-E), (VI-E), (I-F), (II-F), (III-F), (I-G), (II-G), (III-G), (I-H), (II-H), (III-H), (IV-H), (V-H), (VI-H), (I-J), (II-J), (III-J), (IV-J), (V-J), (VI-J), (VII-J), (VIII-J), (IX-J), (X-J), (XI-J), (XII-J), (XIII-J), (XIV-J), or (XV-J), or salts or solvates thereof. The present disclosure also provides processes for preparing the compositions and vulcanized elastomeric articles described herein.

### BACKGROUND

### Field

The present disclosure provides compositions comprising antidegradants, e.g., antiozonant, antioxidant and/or antifatigue molecules, that are useful additives for tires and other vulcanized rubber articles.

### Background

Many materials such as plastics, elastomers, elastomeric products (tires, belts, hoses, bushings, mounts, vibration isolators, etc.), lubricants and petroleum products (such as hydraulic fluids, oils, fuels and oil/fuel additives for automotive and aviation applications) are prone to degradation upon prolonged exposure to light, heat, oxygen, ozone, repetitive mechanical actions and the like. Accordingly, compounds and compositions demonstrating antidegradant efficacy are well known in the art. For example, U.S. Pat. No. 8,987,515 discloses an aromatic polyamine useful in inhibiting oxidative degradation particularly in lubricant compositions. U.S. Patent Application Publication No. 2014/0316163 discloses antioxidant macromolecules with purported improved solubility in many commercially available oils and lubricants.

Antidegradants useful in the manufacture of articles formed from elastomers, plastics and the like require a very specific combination of qualities that can be difficult to achieve. While the antidegradants must obviously have commercially acceptable efficacy, they must also exhibit that efficacy over prolonged periods of time associated with use of the article, particularly at exposed surfaces of the article where degradation from environmental factors such as light, oxygen and ozone primarily occurs. Just as important to the protection of surface exposed components, efficacy in protecting imbedded components of composite materials from the effects of oxidative aging and repetitive mechanical action are critically important. The antidegradants must achieve these results while not negatively impacting other additives' efficacy or desirable characteristics in the final article. Further, antidegradants which provide or improve the mechanical fatigue life after an article has been in service, aged oxidatively or by exposure to ozone are highly valued since these will inherently improve the useful mechanical service life of article. Consequently, elastomeric articles which undergo repeated mechanical flexure, extension, or compression during service would greatly benefit from such a discovery.

Articles formed from general purpose elastomers such as natural rubber, in particular tires, are especially prone to degradation from both oxygen and ozone. As discussed in U.S. Pat. No. 2,905,654, the effect on rubber from degradation by oxygen is different from the effect from degradation from ozone; however, both effects can be detrimental to tire performance, appearance and life expectancy. Fatigue and crack propagation are also issues of specific concern, in particular for steel belt edge areas and tire sidewalls which are subject to significant stresses and stretching forces while flexed whether inflated, partially inflated and throughout the service life of the tire. U.S. Pat. No. 8,833,417 describes an antioxidant system that purportedly increases long-term resistance to fatigue and crack propagation over the known antioxidants discussed immediately below.

Materials with antidegradant efficacy are well known in the art for use in tire applications and are commercially available. For example, N,N′-disubstituted-paraphenylenediamines such as those sold under the trademark Santoflex® are generally favored by many tire manufacturers for this purpose. EP 3147321 A1 discloses rubber compositions, tires, amine compounds, and anti-aging agents, and in particular, a rubber composition that is said to be suitable for use in tread rubber or sidewall rubber of a tire.

### BRIEF SUMMARY

The present disclosure provides compositions comprising:
(i) a first antidegradant; and
(ii) one or more elastomers; or
(iii) one or more fillers; or
(iv) one or more rubber chemicals; or
(v) one or more plasticizers; or
(vi) one or more second antidegradants; or
(vii) a combination of one or more elastomers, one or more fillers, one or more rubber chemicals, one or more plasticizers, and/or one or more second antidegradants,
wherein the first antidegradant is a compound any one of Formulae (I-A), (IV-A), (I-B), (I-C), (VI-C), (VII-C), (I-D), (II-D), (III-D), (IV-D), (V-D), (VI-D), (VII-D), (I E), (II-E), (III-E), (IV-E), (V-E), (VI-E), (I-F), (II-F), (III-F), (I-G), (II-G), (III-G), (I-H), (II-H), (III-H), (IV-H), (V-H), (VI-H), (I-J), (II-J), (III-J), (IV-J), (V-J), (VI-J), (VII-J), (VIII-J), (IX-J), (X-J), (XI-J), (XII-J), (XIII-J), (XIV-J), or (XV-J), or a compound of Tables A-J, below, collectively referred to herein as “Compositions of the Disclosure” or individually as a “Composition of the Disclosure.”

The present disclosure also provides vulcanized elastomeric articles prepared using a Composition of the Disclosure.

The present disclosure also provides a process for preparing the vulcanized elastomeric articles described herein, the process comprising:
(a) forming a Composition of the Disclosure into a formed shape; and
(b) vulcanizing the formed shape to provide a vulcanized elastomeric article.

The present disclosure also provides a process for retreading tires, the process comprising:
(a) applying Composition of the Disclosure to a tire;
(b) disposing a pre-vulcanized tread around the tire;
(c) disposing a curing envelope around the tire; and
(d) vulcanizing the tire.

The present disclosure also provides kits comprising a Composition of the Disclosure and instructions for using the composition in a vulcanizable elastomeric composition.

The present disclosure also provides kits comprising a Composition of the Disclosure and instructions for using the composition to prepare a vulcanized elastomeric article.

Additional embodiments and advantages of the disclosure will be set forth, in part, in the description that follows, and will flow from the description, or can be learned by practice of the disclosure. The embodiments and advantages of the disclosure will be realized and attained by means of the elements and combinations particularly pointed out in the appended claims.

It is to be understood that both the foregoing summary and the following detailed description are exemplary and explanatory only, and are not restrictive of the invention as claimed.

### BRIEF DESCRIPTION OF THE DRAWINGS

FIG. 1 is line graph showing force retention as a function of time for sidewall compounds comprising Compounds 1-A, 2-A, or 3-A under static conditions.

FIG. 2 is line graph showing force retention as a function of time for sidewall compounds comprising Compounds 1-A, 2-A, or 3-A under intermittent conditions.

FIG. 3 is line graph showing force retention as a function of time for sidewall compounds comprising Compounds 1-A, 2-A, or 3-A under dynamic conditions.

FIG. 4 is line graph showing force retention as a function of time for sidewall compounds comprising Compounds 1-A, 2-A, or 3-A under dynamic conditions, average of 3 samples.

FIG. 5 is line graph showing force retention as a function of time for tread compounds comprising Compounds 1-A, 2-A, or 3-A under dynamic conditions, average of 3 samples.

### DETAILED DESCRIPTION

In one embodiment, the present disclosure provides compositions comprising:
(i) a first antidegradant; and
(ii) one or more elastomers; or
(iii) one or more fillers; or
(iv) one or more rubber chemicals; or
(v) one or more plasticizers; or
(vi) one or more second antidegradants; or
(vii) a combination of one or more elastomers, one or more fillers, one or more rubber chemicals, one or more plasticizers, and/or one or more second antidegradants,
wherein the first antidegradant is a Compound of the Disclosure.

The term “Compound of the Disclosure” as used herein refers to a compound of any one of Formulae (I-A), (IV-A), (I-B), (I-C), (VI-C), (VII-C), (I-D), (II-D), (III-D), (IV-D), (V-D), (VI-D), (VII-D), (I E), (II-E), (III-E), (IV-E), (V-E), (VI-E), (I-F), (II-F), (III-F), (I-G), (II-G), (III-G), (I-H), (II-H), (III-H), (IV-H), (V-H), (VI-H), (I-J), (II-J), (III-J), (IV-J), (V-J), (VI-J), (VII-J), (VIII-J), (IX-J), (X-J), (XI-J), (XII-J), (XIII-J), (XIV-J), or (XV-J), which is understood to include the species listed in Tables A-J.

In some embodiments, Compounds of the Disclosure are compounds described in International Appl. No. PCT/US2023/021205 (WO 2023/215590), which is fully incorporated by reference herein in its entirety.

In some embodiments, Compounds of the Disclosure are compounds having Formula (I-A):

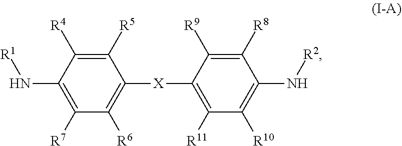

or a salt or solvate thereof, wherein:
R¹ is selected from the group consisting of C₁-C₁₂ alkyl, —CHR^{1a}R^{1b}, C₃-C₆ cycloalkyl, and optionally substituted phenyl; or
R¹ and R⁴ taken together with the nitrogen and carbon atoms, respectively, to which they are attached form a saturated or partially saturated optionally substituted 5- or 6-membered heterocyclo;
R^{1a} is selected from the group consisting of optionally substituted phenyl, C₃-C₆ cycloalkyl, and optionally substituted 5- or 6-membered heteroaryl;
R^{1b} is selected from the group consisting of hydrogen and C₁-C₆ alkyl;
R² is selected from the group consisting of C₁-C₁₂ alkyl, —CHR^{2a}R^{2b}, C₃-C₆ cycloalkyl, and optionally substituted phenyl; or
R² and R⁸ taken together with the nitrogen and carbon atoms, respectively, to which they are attached form a saturated or partially saturated optionally substituted 5- or 6-membered heterocyclo;
R^{2a} is selected from the group consisting of optionally substituted phenyl, C₃-C₆ cycloalkyl, and optionally substituted 5- or 6-membered heteroaryl;
R^{2b} is selected from the group consisting of hydrogen and C₁-C₆ alkyl;
X is selected from the group consisting of —CHR^{3a}—, —NR^{3b}—, —O—, and —S—;
R^{3a} is selected from the group consisting of hydrogen, C₁-C₁₂ alkyl, C₃-C₆ cycloalkyl, optionally substituted phenyl, optionally substituted 5- or 6-membered heterocyclo, and optionally substituted 5- or 6-membered heteroaryl;
R^{3b} is selected from the group consisting of hydrogen, C₁-C₁₂ alkyl, C₃-C₆ cycloalkyl, optionally substituted phenyl, optionally substituted 5- or 6-membered heterocyclo, and optionally substituted 5- or 6-membered heteroaryl;
R⁴, R⁵, R⁶, and R⁷ are independently selected from the group consisting of hydrogen, halogen, C₁-C₆ alkyl, C₁-C₆ alkoxy, and C₁-C₆ alkylthio; or
R¹ and R⁴ taken together with the nitrogen and carbon atoms, respectively, to which they are attached form a saturated or partially saturated optionally substituted 5- or 6-membered heterocyclo; and
R⁵, R⁶, and R⁷ are independently selected from the group consisting of hydrogen, halogen, C₁-C₆ alkyl, C₁-C₆ alkoxy, and C₁-C₆ alkylthio; and
R⁸, R⁹, R¹⁰, and R¹¹ are independently selected from the group consisting of hydrogen, halogen, C₁-C₆ alkyl, C₁-C₆ alkoxy, and C₁-C₆ alkylthio; or
R² and R⁸ taken together with the nitrogen and carbon atoms, respectively, to which they are attached form a saturated or partially saturated optionally substituted 5- or 6-membered heterocyclo; and
R⁹, R¹⁰, and R¹¹ are independently selected from the group consisting of hydrogen, halogen, C₁-C₆ alkyl, C₁-C₆ alkoxy, and C₁-C₆ alkylthio.

In some embodiments, Compounds of the Disclosure are compounds having Formula (I-A), wherein X is —NR^{3b}—.

In some embodiments, Compounds of the Disclosure are compounds having Formula (I-A), wherein X is —O—.

In some embodiments, Compounds of the Disclosure are compounds having Formula (I-A), wherein X is —S—.

In some embodiments, Compounds of the Disclosure are compounds having Formula (I-A), wherein X is —CHR^{3a}—.

In some embodiments, Compounds of the Disclosure are compounds having Formula (I-A), wherein R¹ and R² are isopropyl.

In some embodiments, Compounds of the Disclosure are compounds having Formula (I-A), wherein R⁴, R⁵, R⁶, R⁷, R⁸, R⁹, R¹⁰, and R¹¹ are selected from the group consisting of hydrogen and methyl.

In some embodiments, Compounds of the Disclosure are compounds having Formula (I-A), wherein R⁴, R⁵, R⁶, R⁷, R⁸, R⁹, R¹⁰, and R¹¹ are hydrogen.

In some embodiments, Compounds of the Disclosure are compounds having Formula (I-A), wherein R^{3a} is selected from the group consisting of C₁-C₁₂ alkyl,

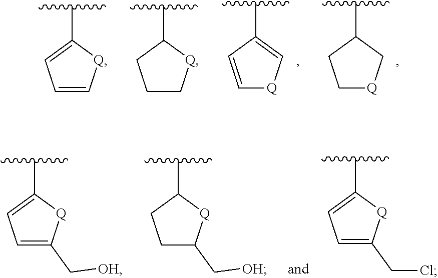

and Q is —NH—, —O—, or —S—.

In some embodiments, Compounds of the Disclosure are compounds having Formula (I-A), wherein R^{3a} is C₁-C₁₂ alkyl.

In some embodiments, Compounds of the Disclosure are compounds having Formula (I-A), wherein R^{3a} is methyl, ethyl, propyl, isopropyl, butyl, iso-butyl, sec-butyl, or tert-butyl.

In some embodiments, Compounds of the Disclosure are compounds having Formula (I-A), wherein Q is —O—.

In some embodiments, Compounds of the Disclosure are compounds having Formula (IV-A):

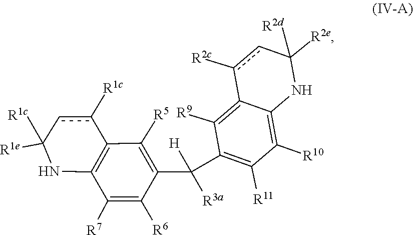

or a salt or solvate, or stereoisomer thereof, wherein:
each [symbol] is a single or double bond;
R^{1c}, R^{1d}, R^{1e}, R^{2c}, R^{2d}, and R^{2e} are independently selected from the group consisting of hydrogen and C₁-C₆ alkyl; and
R⁵, R⁶, R⁷, R⁹, R¹⁰, and R¹¹ are as defined in connection with Formula (I-A).

In some embodiments, Compounds of the Disclosure are compounds having Formula (IV-A), wherein R⁵, R⁶, R⁷, R⁹, R¹⁰, and R¹¹ are selected from the group consisting of hydrogen, methyl, C₁-C₆ alkoxy, and C₁-C₆ alkylthio.

In some embodiments, Compounds of the Disclosure are compounds having Formula (IV-A), wherein R⁵, R⁶, R⁷, R⁹, R¹⁰, and R¹¹ are hydrogen.

In some embodiments, Compounds of the Disclosure are compounds having Formula (IV-A), wherein R^{1c}, R^{1d}, R^{1e}, R^{2c}, R^{2d}, and R^{2e} are methyl, ethyl, or hydrogen.

In some embodiments, Compounds of the Disclosure are compounds having Formula (IV-A), wherein R^{1c}, R^{1d}, R^{1e}, R^{2c}, R^{2d}, and R^{2e} are methyl.

In some embodiments, Compounds of the Disclosure are compounds having Formula (IV-A), wherein R^{3a} is hydrogen.

In some embodiments, Compounds of the Disclosure are compounds having Formula (IV-A), wherein R^{3a} is selected from the group consisting of C₁-C₁₂ alkyl,

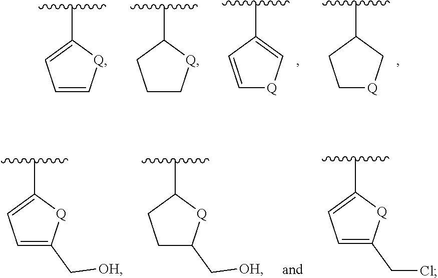

and Q is —NH—, —O—, or —S—.

In some embodiments, Compounds of the Disclosure are compounds having Formula (IV-A), wherein R^{3a} is C₁-C₁₂ alkyl.

In some embodiments, Compounds of the Disclosure are compounds having Formula (IV-A), wherein R^{3a} is methyl, ethyl, propyl, isopropyl, butyl, iso-butyl, sec-butyl, or tert-butyl.

In some embodiments, Compounds of the Disclosure are compounds having Formula (IV-A), wherein R^{3a} is:

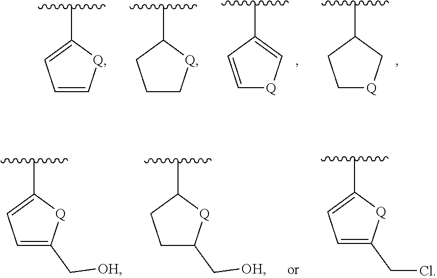

In some embodiments, Compounds of the Disclosure are compounds of any one of Formula (IV-A), wherein Q is —O—.

In some embodiments, Compounds of the Disclosure are any of the compounds of Table A, or a salt or solvate thereof.

TABLE A

| Compound No. | Structure |
|---|---|
| 1-A | 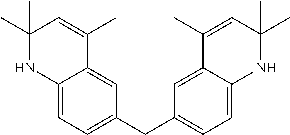 |
| 2-A | 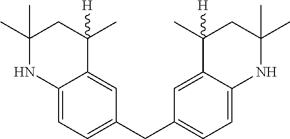 |
| 3-A | 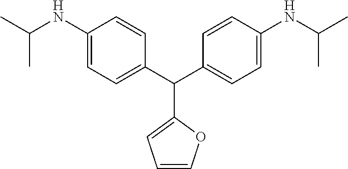 [SMILES: CC(C)Nc1ccc(C(c2ccc(NC(C)C)cc2)c2ccco2)cc1] |
| 4-A | 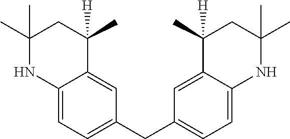 |
| 5-A | 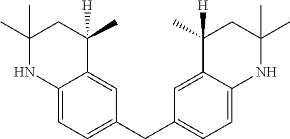 |
| 6-A | 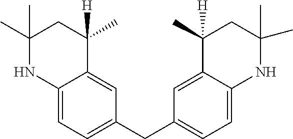 |
| 7-A | 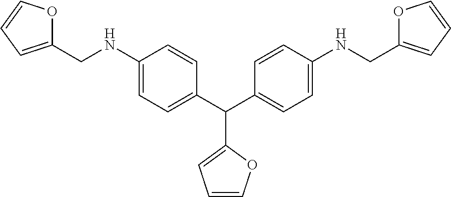 [SMILES: c1coc(CNc2ccc(C(c3ccc(NCc4ccco4)cc3)c3ccco3)cc2)c1] |
| 8-A | 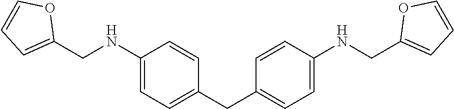 [SMILES: c1coc(CNc2ccc(Cc3ccc(NCc4ccco4)cc3)cc2)c1] |
| 9-A | 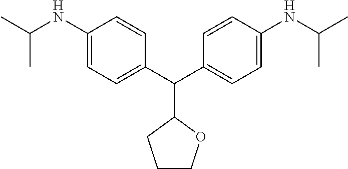 [SMILES: CC(C)Nc1ccc(C(c2ccc(NC(C)C)cc2)C2CCCO2)cc1] |
| 10-A | 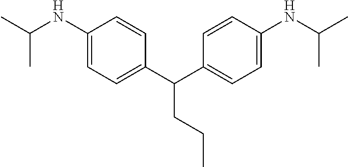 [SMILES: CCCC(c1ccc(NC(C)C)cc1)c1ccc(NC(C)C)cc1] |
| 11-A | 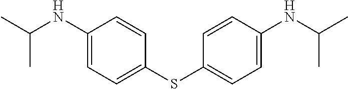 [SMILES: CC(C)Nc1ccc(Sc2ccc(NC(C)C)cc2)cc1] |
| 12-A | 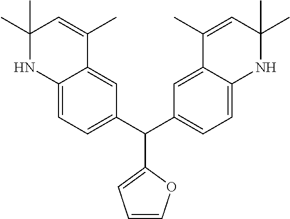 |
| 13-A | 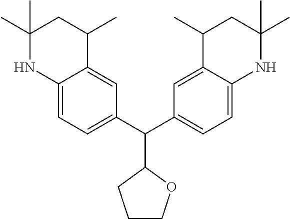 |
| 14-A | 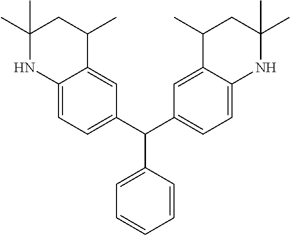 |
| 15-A | 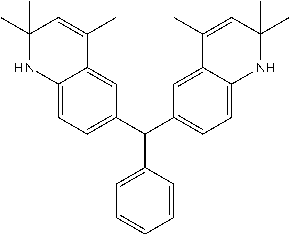 |
| 16-A | 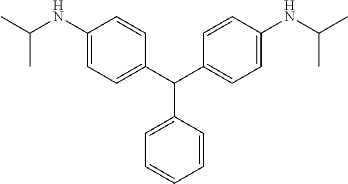 [SMILES: CC(C)Nc1ccc(C(c2ccccc2)c2ccc(NC(C)C)cc2)cc1] |
| 17-A | 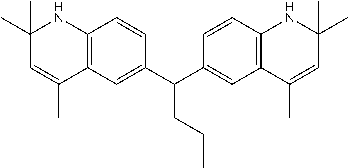 |
| 18-A | 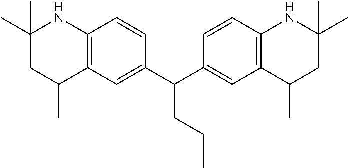 |
| 19-A | 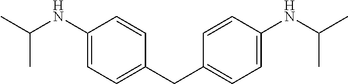 [SMILES: CC(C)Nc1ccc(Cc2ccc(NC(C)C)cc2)cc1] |
| 20-A | 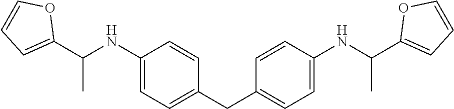 [SMILES: CC(Nc1ccc(Cc2ccc(NC(C)c3ccco3)cc2)cc1)c1ccco1] |
| 21-A | 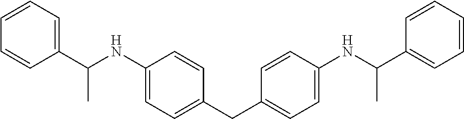 [SMILES: CC(Nc1ccc(Cc2ccc(NC(C)c3ccccc3)cc2)cc1)c1ccccc1] |
| 22-A | 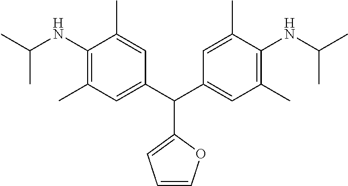 [SMILES: Cc1cc(C(c2cc(C)c(NC(C)C)c(C)c2)c2ccco2)cc(C)c1NC(C)C] |
| 23-A | 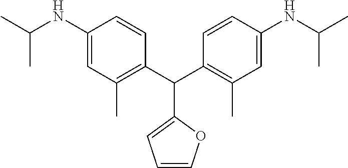 [SMILES: Cc1cc(NC(C)C)ccc1C(c1ccco1)c1ccc(NC(C)C)cc1C] |
| 24-A | 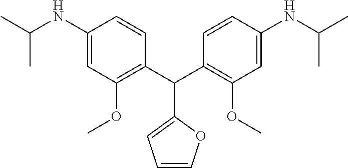 [SMILES: COc1cc(NC(C)C)ccc1C(c1ccco1)c1ccc(NC(C)C)cc1OC] |
| 25-A | 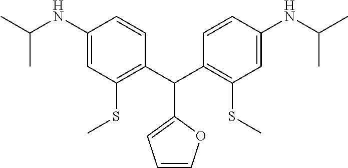 [SMILES: CSc1cc(NC(C)C)ccc1C(c1ccco1)c1ccc(NC(C)C)cc1SC] |
| 26-A | 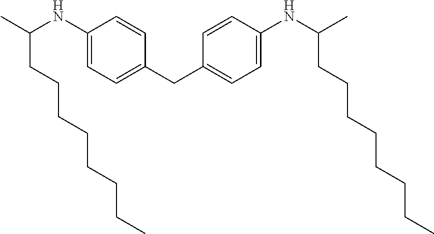 [SMILES: CCCCCCCCC(C)Nc1ccc(Cc2ccc(NC(C)CCCCCCCC)cc2)cc1] |
| 27-A | 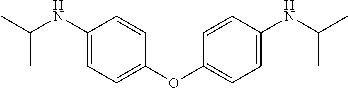 [SMILES: CC(C)Nc1ccc(Oc2ccc(NC(C)C)cc2)cc1] |
| 28-A | 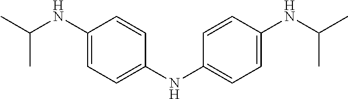 [SMILES: CC(C)Nc1ccc(Nc2ccc(NC(C)C)cc2)cc1] |
| 29-A | 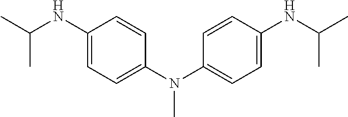 [SMILES: CC(C)Nc1ccc(N(C)c2ccc(NC(C)C)cc2)cc1] |
| 30-A | 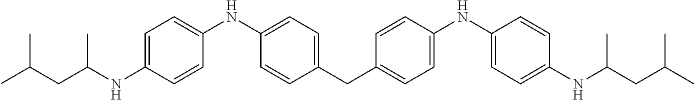 [SMILES: CC(C)CC(C)Nc1ccc(Nc2ccc(Cc3ccc(Nc4ccc(NC(C)CC(C)C)cc4)cc3)cc2)cc1] |
| 31-A | 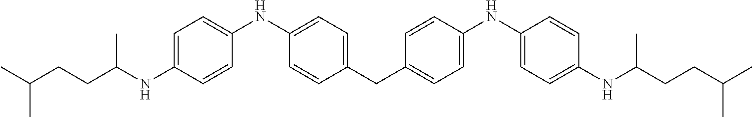 [SMILES: CC(C)CCC(C)Nc1ccc(Nc2ccc(Cc3ccc(Nc4ccc(NC(C)CCC(C)C)cc4)cc3)cc2)cc1] |
| 32-A | 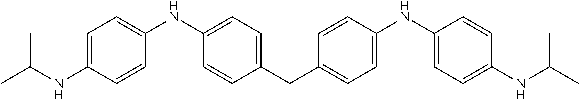 [SMILES: CC(C)Nc1ccc(Nc2ccc(Cc3ccc(Nc4ccc(NC(C)C)cc4)cc3)cc2)cc1] |
| 33-A | 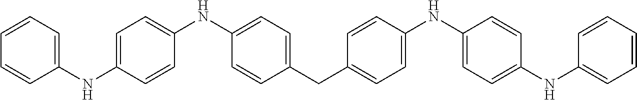 [SMILES: c1ccc(Nc2ccc(Nc3ccc(Cc4ccc(Nc5ccc(Nc6ccccc6)cc5)cc4)cc3)cc2)cc1] |
| 34-A | 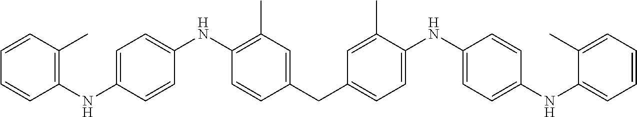 [SMILES: Cc1ccccc1Nc1ccc(Nc2ccc(Cc3ccc(Nc4ccc(Nc5ccccc5C)cc4)c(C)c3)cc2C)cc1] |
| 35-A | 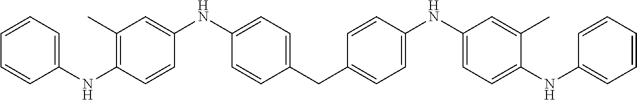 [SMILES: Cc1cc(Nc2ccc(Cc3ccc(Nc4ccc(Nc5ccccc5)c(C)c4)cc3)cc2)ccc1Nc1ccccc1] |
| 36-A | 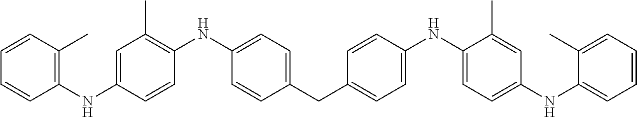 [SMILES: Cc1ccccc1Nc1ccc(Nc2ccc(Cc3ccc(Nc4ccc(Nc5ccccc5C)cc4C)cc3)cc2)c(C)c1] |
| 37-A | 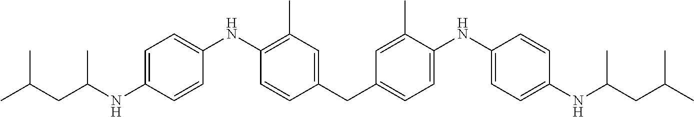 [SMILES: Cc1cc(Cc2ccc(Nc3ccc(NC(C)CC(C)C)cc3)c(C)c2)ccc1Nc1ccc(NC(C)CC(C)C)cc1] |
| 38-A | 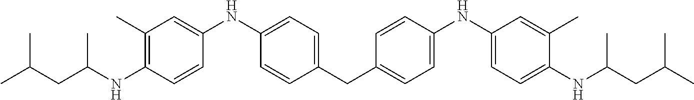 [SMILES: Cc1cc(Nc2ccc(Cc3ccc(Nc4ccc(NC(C)CC(C)C)c(C)c4)cc3)cc2)ccc1NC(C)CC(C)C] |
| 39-A | 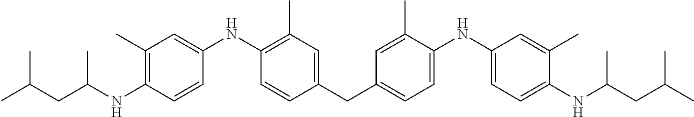 [SMILES: Cc1cc(Cc2ccc(Nc3ccc(NC(C)CC(C)C)c(C)c3)c(C)c2)ccc1Nc1ccc(NC(C)CC(C)C)c(C)c1] |
| 40-A | 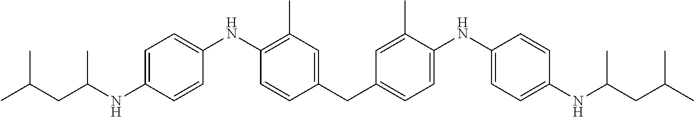 [SMILES: Cc1cc(Cc2ccc(Nc3ccc(NC(C)CC(C)C)cc3)c(C)c2)ccc1Nc1ccc(NC(C)CC(C)C)cc1] |
| 41-A | 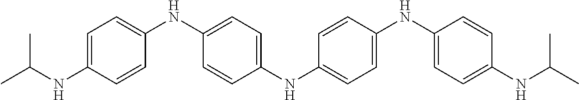 [SMILES: CC(C)Nc1ccc(Nc2ccc(Nc3ccc(Nc4ccc(NC(C)C)cc4)cc3)cc2)cc1] |
| 42-A | 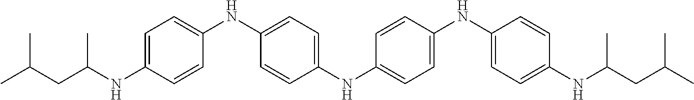 [SMILES: CC(C)CC(C)Nc1ccc(Nc2ccc(Nc3ccc(Nc4ccc(NC(C)CC(C)C)cc4)cc3)cc2)cc1] |
| 43-A | 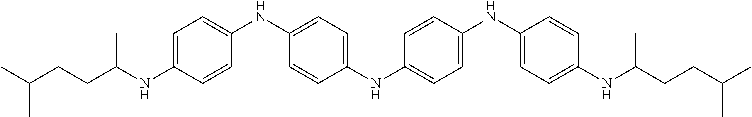 [SMILES: CC(C)CCC(C)Nc1ccc(Nc2ccc(Nc3ccc(Nc4ccc(NC(C)CCC(C)C)cc4)cc3)cc2)cc1] |
| 44-A | 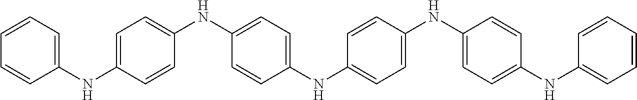 [SMILES: c1ccc(Nc2ccc(Nc3ccc(Nc4ccc(Nc5ccc(Nc6ccccc6)cc5)cc4)cc3)cc2)cc1] |
| 45-A | 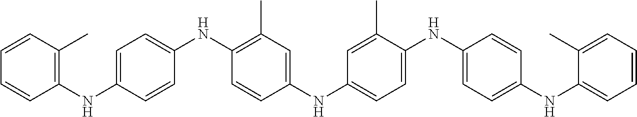 [SMILES: Cc1ccccc1Nc1ccc(Nc2ccc(Nc3ccc(Nc4ccc(Nc5ccccc5C)cc4)c(C)c3)cc2C)cc1] |
| 46-A | 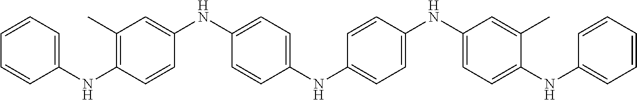 [SMILES: Cc1cc(Nc2ccc(Nc3ccc(Nc4ccc(Nc5ccccc5)c(C)c4)cc3)cc2)ccc1Nc1ccccc1] |
| 47-A | 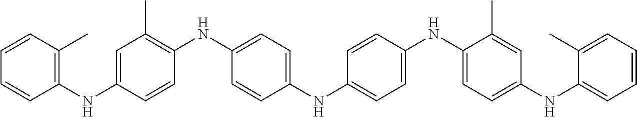 [SMILES: Cc1ccccc1Nc1ccc(Nc2ccc(Nc3ccc(Nc4ccc(Nc5ccccc5C)cc4C)cc3)cc2)c(C)c1] |
| 48-A | 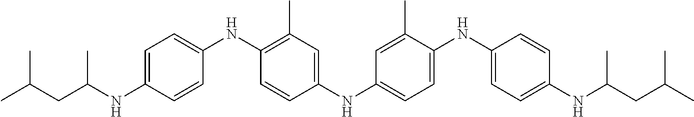 [SMILES: Cc1cc(Nc2ccc(Nc3ccc(NC(C)CC(C)C)cc3)c(C)c2)ccc1Nc1ccc(NC(C)CC(C)C)cc1] |
| 49-A | 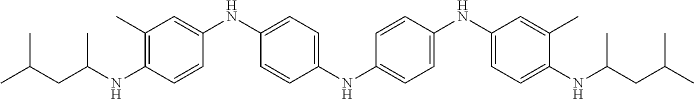 [SMILES: Cc1cc(Nc2ccc(Nc3ccc(Nc4ccc(NC(C)CC(C)C)c(C)c4)cc3)cc2)ccc1NC(C)CC(C)C] |
| 50-A | 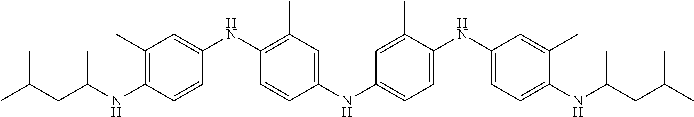 [SMILES: Cc1cc(Nc2ccc(Nc3ccc(NC(C)CC(C)C)c(C)c3)c(C)c2)ccc1Nc1ccc(NC(C)CC(C)C)c(C)c1] |
| 51-A | 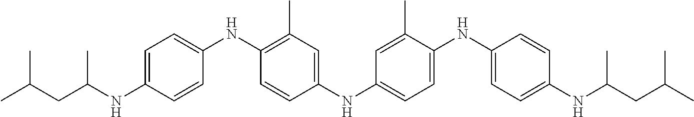 [SMILES: Cc1cc(Nc2ccc(Nc3ccc(NC(C)CC(C)C)cc3)c(C)c2)ccc1Nc1ccc(NC(C)CC(C)C)cc1] |
| 52-A | 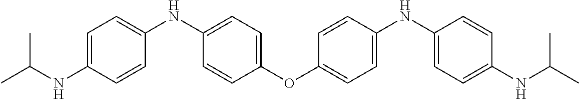 [SMILES: CC(C)Nc1ccc(Nc2ccc(Oc3ccc(Nc4ccc(NC(C)C)cc4)cc3)cc2)cc1] |
| 53-A | 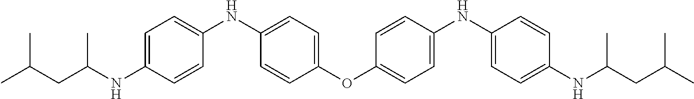 [SMILES: CC(C)CC(C)Nc1ccc(Nc2ccc(Oc3ccc(Nc4ccc(NC(C)CC(C)C)cc4)cc3)cc2)cc1] |
| 54-A | 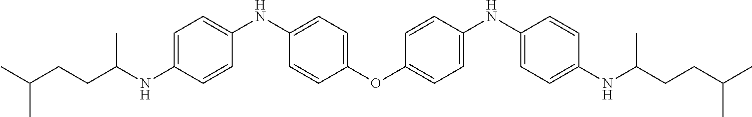 [SMILES: CC(C)CCC(C)Nc1ccc(Nc2ccc(Oc3ccc(Nc4ccc(NC(C)CCC(C)C)cc4)cc3)cc2)cc1] |
| 55-A | 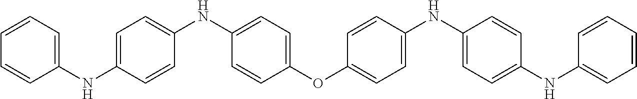 [SMILES: c1ccc(Nc2ccc(Nc3ccc(Oc4ccc(Nc5ccc(Nc6ccccc6)cc5)cc4)cc3)cc2)cc1] |
| 56-A | 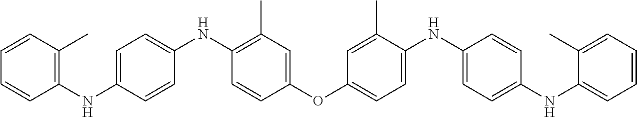 [SMILES: Cc1ccccc1Nc1ccc(Nc2ccc(Oc3ccc(Nc4ccc(Nc5ccccc5C)cc4)c(C)c3)cc2C)cc1] |
| 57-A | 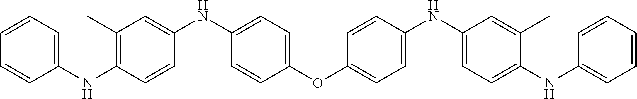 [SMILES: Cc1cc(Nc2ccc(Oc3ccc(Nc4ccc(Nc5ccccc5)c(C)c4)cc3)cc2)ccc1Nc1ccccc1] |
| 58-A | 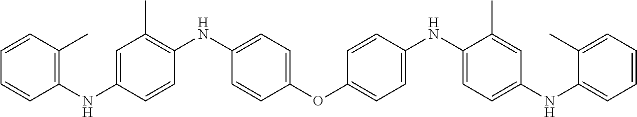 [SMILES: Cc1ccccc1Nc1ccc(Nc2ccc(Oc3ccc(Nc4ccc(Nc5ccccc5C)cc4C)cc3)cc2)c(C)c1] |
| 59-A | 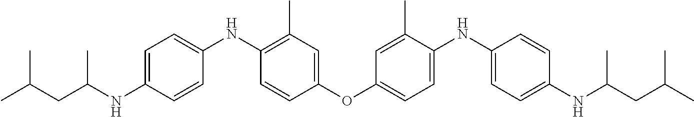 [SMILES: Cc1cc(Oc2ccc(Nc3ccc(NC(C)CC(C)C)cc3)c(C)c2)ccc1Nc1ccc(NC(C)CC(C)C)cc1] |
| 60-A | 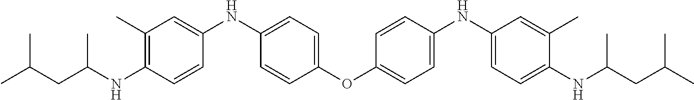 [SMILES: Cc1cc(Nc2ccc(Oc3ccc(Nc4ccc(NC(C)CC(C)C)c(C)c4)cc3)cc2)ccc1NC(C)CC(C)C] |
| 61-A | 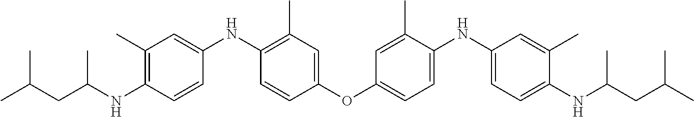 [SMILES: Cc1cc(Oc2ccc(Nc3ccc(NC(C)CC(C)C)c(C)c3)c(C)c2)ccc1Nc1ccc(NC(C)CC(C)C)c(C)c1] |
| 62-A | 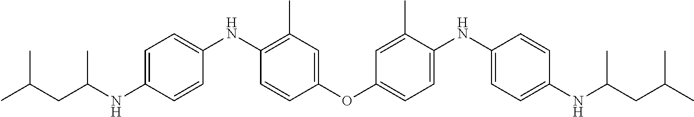 [SMILES: Cc1cc(Oc2ccc(Nc3ccc(NC(C)CC(C)C)cc3)c(C)c2)ccc1Nc1ccc(NC(C)CC(C)C)cc1] |
| 63-A | 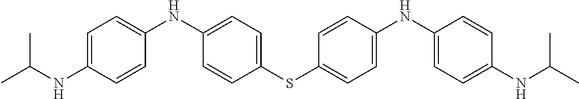 [SMILES: CC(C)Nc1ccc(Nc2ccc(Sc3ccc(Nc4ccc(NC(C)C)cc4)cc3)cc2)cc1] |
| 64-A | 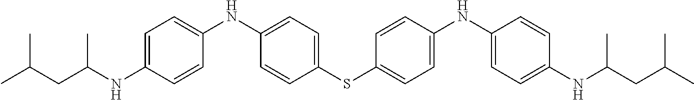 [SMILES: CC(C)CC(C)Nc1ccc(Nc2ccc(Sc3ccc(Nc4ccc(NC(C)CC(C)C)cc4)cc3)cc2)cc1] |
| 65-A | 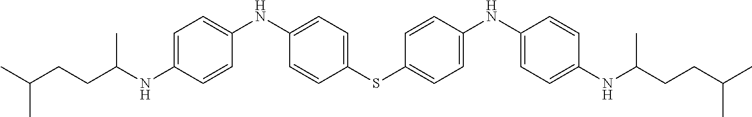 [SMILES: CC(C)CCC(C)Nc1ccc(Nc2ccc(Sc3ccc(Nc4ccc(NC(C)CCC(C)C)cc4)cc3)cc2)cc1] |
| 66-A | 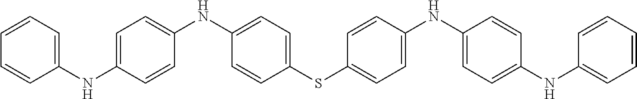 [SMILES: c1ccc(Nc2ccc(Nc3ccc(Sc4ccc(Nc5ccc(Nc6ccccc6)cc5)cc4)cc3)cc2)cc1] |
| 67-A | 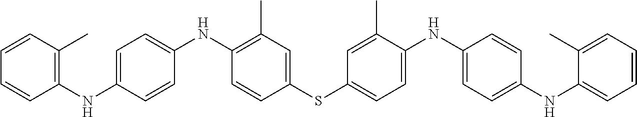 [SMILES: Cc1ccccc1Nc1ccc(Nc2ccc(Sc3ccc(Nc4ccc(Nc5ccccc5C)cc4)c(C)c3)cc2C)cc1] |
| 68-A | 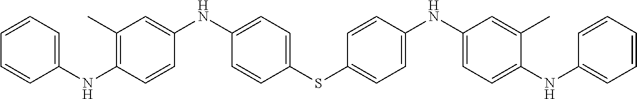 [SMILES: Cc1cc(Nc2ccc(Sc3ccc(Nc4ccc(Nc5ccccc5)c(C)c4)cc3)cc2)ccc1Nc1ccccc1] |
| 69-A | 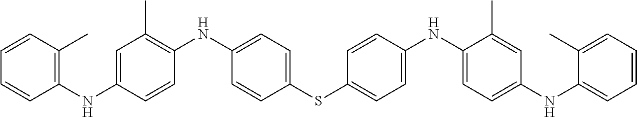 [SMILES: Cc1ccccc1Nc1ccc(Nc2ccc(Sc3ccc(Nc4ccc(Nc5ccccc5C)cc4C)cc3)cc2)c(C)c1] |
| 70-A | 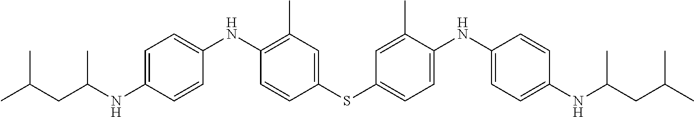 [SMILES: Cc1cc(Sc2ccc(Nc3ccc(NC(C)CC(C)C)cc3)c(C)c2)ccc1Nc1ccc(NC(C)CC(C)C)cc1] |
| 71-A | 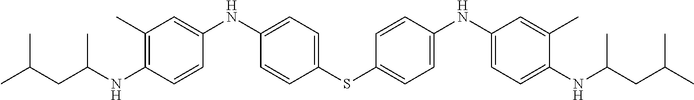 [SMILES: Cc1cc(Nc2ccc(Sc3ccc(Nc4ccc(NC(C)CC(C)C)c(C)c4)cc3)cc2)ccc1NC(C)CC(C)C] |
| 72-A | 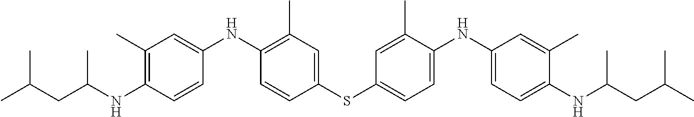 [SMILES: Cc1cc(Sc2ccc(Nc3ccc(NC(C)CC(C)C)c(C)c3)c(C)c2)ccc1Nc1ccc(NC(C)CC(C)C)c(C)c1] |
| 73-A | 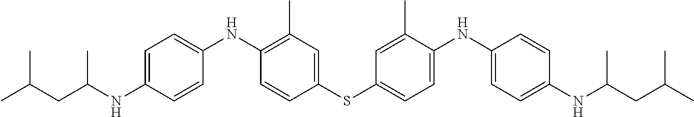 [SMILES: Cc1cc(Sc2ccc(Nc3ccc(NC(C)CC(C)C)cc3)c(C)c2)ccc1Nc1ccc(NC(C)CC(C)C)cc1] |
| 74-A | 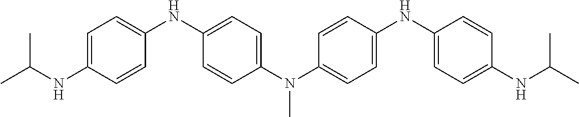 [SMILES: CC(C)Nc1ccc(Nc2ccc(N(C)c3ccc(Nc4ccc(NC(C)C)cc4)cc3)cc2)cc1] |
| 75-A | 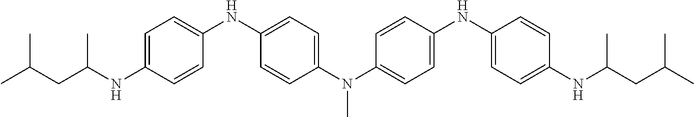 [SMILES: CC(C)CC(C)Nc1ccc(Nc2ccc(N(C)c3ccc(Nc4ccc(NC(C)CC(C)C)cc4)cc3)cc2)cc1] |
| 76-A | 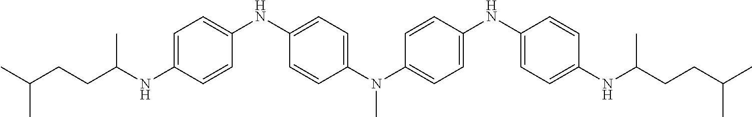 [SMILES: CC(C)CCC(C)Nc1ccc(Nc2ccc(N(C)c3ccc(Nc4ccc(NC(C)CCC(C)C)cc4)cc3)cc2)cc1] |
| 77-A | 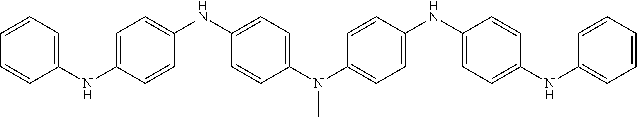 [SMILES: CN(c1ccc(Nc2ccc(Nc3ccccc3)cc2)cc1)c1ccc(Nc2ccc(Nc3ccccc3)cc2)cc1] |
| 78-A | 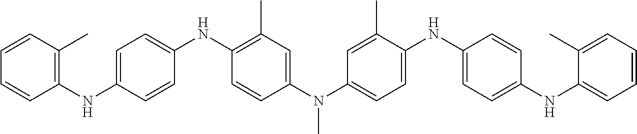 [SMILES: Cc1ccccc1Nc1ccc(Nc2ccc(N(C)c3ccc(Nc4ccc(Nc5ccccc5C)cc4)c(C)c3)cc2C)cc1] |
| 79-A | 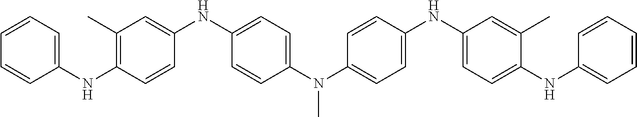 [SMILES: Cc1cc(Nc2ccc(N(C)c3ccc(Nc4ccc(Nc5ccccc5)c(C)c4)cc3)cc2)ccc1Nc1ccccc1] |
| 80-A | 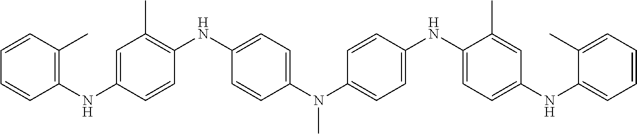 [SMILES: Cc1ccccc1Nc1ccc(Nc2ccc(N(C)c3ccc(Nc4ccc(Nc5ccccc5C)cc4C)cc3)cc2)c(C)c1] |
| 81-A | 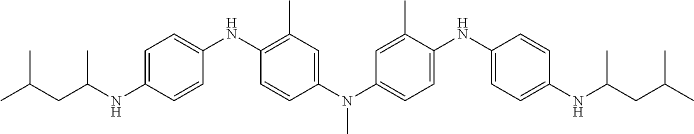 [SMILES: Cc1cc(N(C)c2ccc(Nc3ccc(NC(C)CC(C)C)cc3)c(C)c2)ccc1Nc1ccc(NC(C)CC(C)C)cc1] |
| 82-A | 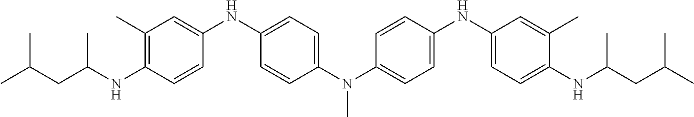 [SMILES: Cc1cc(Nc2ccc(N(C)c3ccc(Nc4ccc(NC(C)CC(C)C)c(C)c4)cc3)cc2)ccc1NC(C)CC(C)C] |
| 83-A | 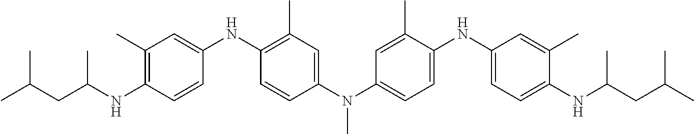 [SMILES: Cc1cc(N(C)c2ccc(Nc3ccc(NC(C)CC(C)C)c(C)c3)c(C)c2)ccc1Nc1ccc(NC(C)CC(C)C)c(C)c1] |
| 84-A | 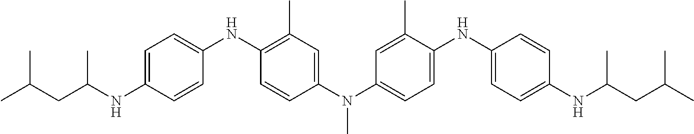 [SMILES: Cc1cc(N(C)c2ccc(Nc3ccc(NC(C)CC(C)C)cc3)c(C)c2)ccc1Nc1ccc(NC(C)CC(C)C)cc1] |
| 85-A | 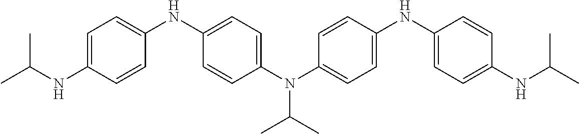 [SMILES: CC(C)Nc1ccc(Nc2ccc(N(c3ccc(Nc4ccc(NC(C)C)cc4)cc3)C(C)C)cc2)cc1] |
| 86-A | 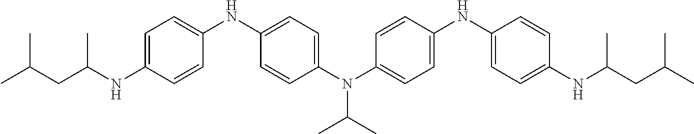 [SMILES: CC(C)CC(C)Nc1ccc(Nc2ccc(N(c3ccc(Nc4ccc(NC(C)CC(C)C)cc4)cc3)C(C)C)cc2)cc1] |
| 87-A | 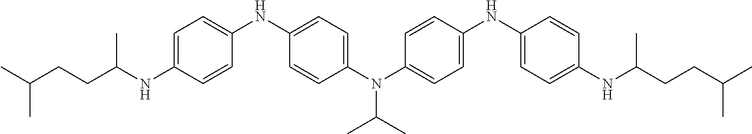 [SMILES: CC(C)CCC(C)Nc1ccc(Nc2ccc(N(c3ccc(Nc4ccc(NC(C)CCC(C)C)cc4)cc3)C(C)C)cc2)cc1] |
| 88-A | 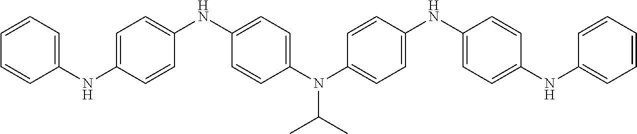 [SMILES: CC(C)N(c1ccc(Nc2ccc(Nc3ccccc3)cc2)cc1)c1ccc(Nc2ccc(Nc3ccccc3)cc2)cc1] |
| 89-A | 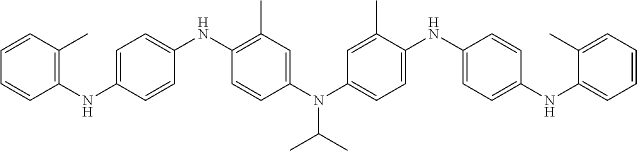 [SMILES: Cc1ccccc1Nc1ccc(Nc2ccc(N(c3ccc(Nc4ccc(Nc5ccccc5C)cc4)c(C)c3)C(C)C)cc2C)cc1] |
| 90-A | 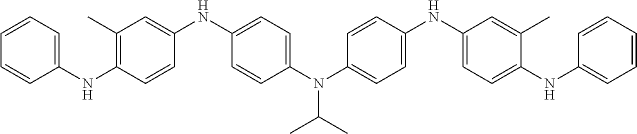 [SMILES: Cc1cc(Nc2ccc(N(c3ccc(Nc4ccc(Nc5ccccc5)c(C)c4)cc3)C(C)C)cc2)ccc1Nc1ccccc1] |
| 91-A | 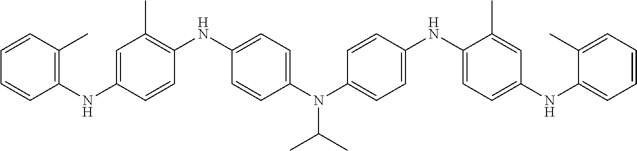 [SMILES: Cc1ccccc1Nc1ccc(Nc2ccc(N(c3ccc(Nc4ccc(Nc5ccccc5C)cc4C)cc3)C(C)C)cc2)c(C)c1] |
| 92-A | 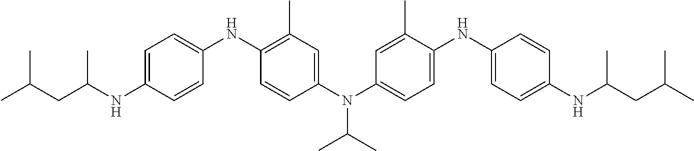 [SMILES: Cc1cc(N(c2ccc(Nc3ccc(NC(C)CC(C)C)cc3)c(C)c2)C(C)C)ccc1Nc1ccc(NC(C)CC(C)C)cc1] |
| 93-A | 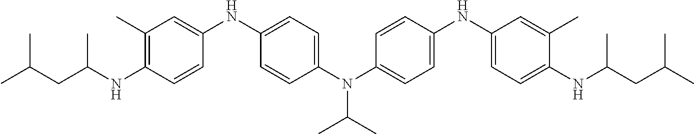 [SMILES: Cc1cc(Nc2ccc(N(c3ccc(Nc4ccc(NC(C)CC(C)C)c(C)c4)cc3)C(C)C)cc2)ccc1NC(C)CC(C)C] |
| 94-A | 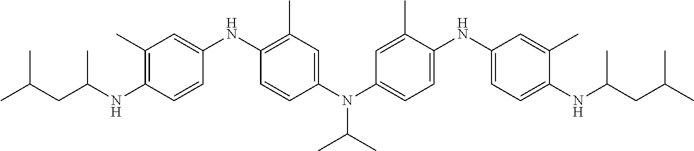 [SMILES: Cc1cc(N(c2ccc(Nc3ccc(NC(C)CC(C)C)c(C)c3)c(C)c2)C(C)C)ccc1Nc1ccc(NC(C)CC(C)C)c(C)c1] |
| 95-A | 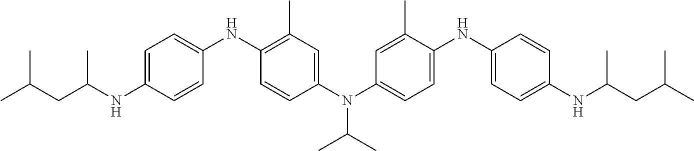 [SMILES: Cc1cc(N(c2ccc(Nc3ccc(NC(C)CC(C)C)cc3)c(C)c2)C(C)C)ccc1Nc1ccc(NC(C)CC(C)C)cc1] |
| 96-A | 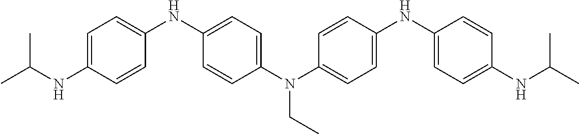 [SMILES: CCN(c1ccc(Nc2ccc(NC(C)C)cc2)cc1)c1ccc(Nc2ccc(NC(C)C)cc2)cc1] |
| 97-A | 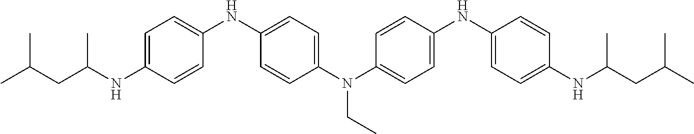 [SMILES: CCN(c1ccc(Nc2ccc(NC(C)CC(C)C)cc2)cc1)c1ccc(Nc2ccc(NC(C)CC(C)C)cc2)cc1] |
| 98-A | 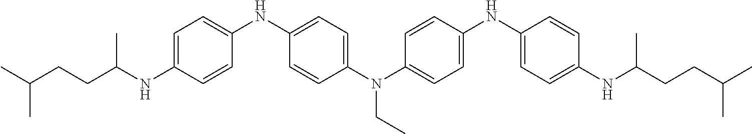 [SMILES: CCN(c1ccc(Nc2ccc(NC(C)CCC(C)C)cc2)cc1)c1ccc(Nc2ccc(NC(C)CCC(C)C)cc2)cc1] |
| 99-A | 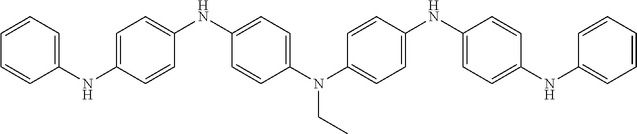 [SMILES: CCN(c1ccc(Nc2ccc(Nc3ccccc3)cc2)cc1)c1ccc(Nc2ccc(Nc3ccccc3)cc2)cc1] |
| 100-A | 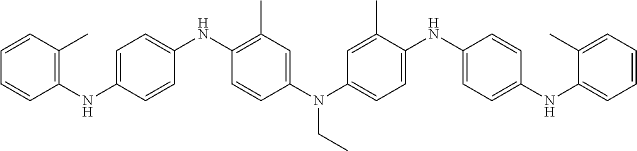 [SMILES: CCN(c1ccc(Nc2ccc(Nc3ccccc3C)cc2)c(C)c1)c1ccc(Nc2ccc(Nc3ccccc3C)cc2)c(C)c1] |
| 101-A | 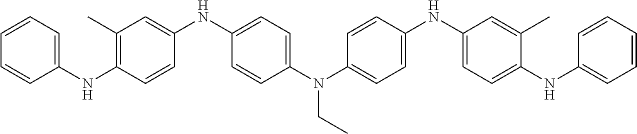 [SMILES: CCN(c1ccc(Nc2ccc(Nc3ccccc3)c(C)c2)cc1)c1ccc(Nc2ccc(Nc3ccccc3)c(C)c2)cc1] |
| 102-A | 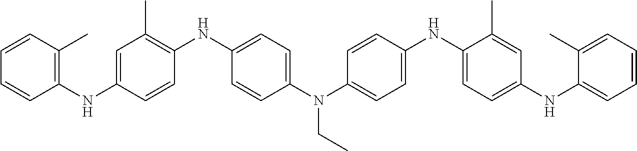 [SMILES: CCN(c1ccc(Nc2ccc(Nc3ccccc3C)cc2C)cc1)c1ccc(Nc2ccc(Nc3ccccc3C)cc2C)cc1] |
| 103-A | 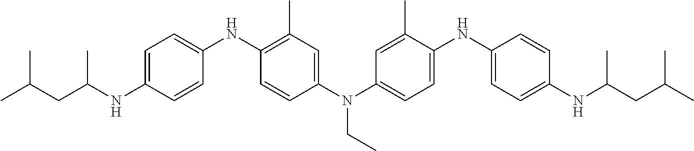 [SMILES: CCN(c1ccc(Nc2ccc(NC(C)CC(C)C)cc2)c(C)c1)c1ccc(Nc2ccc(NC(C)CC(C)C)cc2)c(C)c1] |
| 104-A | 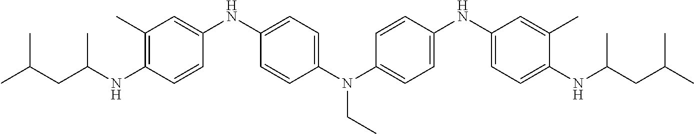 [SMILES: CCN(c1ccc(Nc2ccc(NC(C)CC(C)C)c(C)c2)cc1)c1ccc(Nc2ccc(NC(C)CC(C)C)c(C)c2)cc1] |
| 105-A | 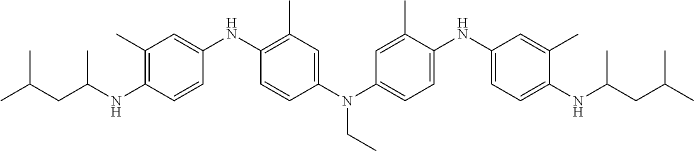 [SMILES: CCN(c1ccc(Nc2ccc(NC(C)CC(C)C)c(C)c2)c(C)c1)c1ccc(Nc2ccc(NC(C)CC(C)C)c(C)c2)c(C)c1] |
| 106-A | 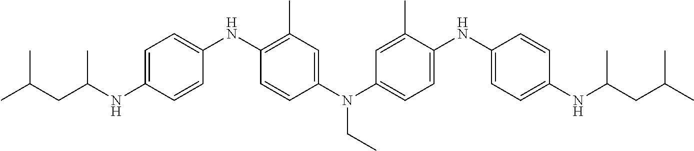 [SMILES: CCN(c1ccc(Nc2ccc(NC(C)CC(C)C)cc2)c(C)c1)c1ccc(Nc2ccc(NC(C)CC(C)C)cc2)c(C)c1] |
| 107-A | 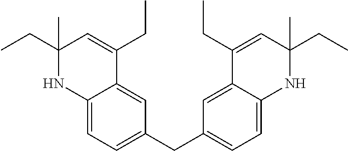 [SMILES: CCC1=CC(C)(CC)Nc2ccc(Cc3ccc4c(c3)C(CC)=CC(C)(CC)N4)cc21] |
| 108-A | 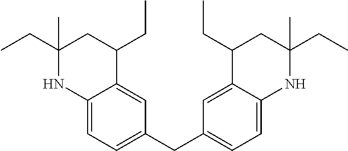 [SMILES: CCC1CC(C)(CC)Nc2ccc(Cc3ccc4c(c3)C(CC)CC(C)(CC)N4)cc21] |
| 109-A | 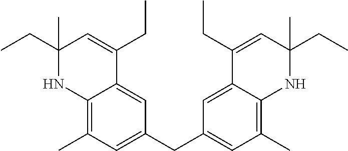 [SMILES: CCC1=CC(C)(CC)Nc2c(C)cc(Cc3cc(C)c4c(c3)C(CC)=CC(C)(CC)N4)cc21] |
| 110-A | 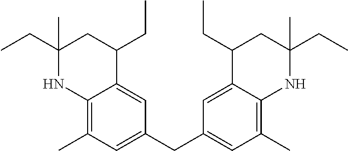 [SMILES: CCC1CC(C)(CC)Nc2c(C)cc(Cc3cc(C)c4c(c3)C(CC)CC(C)(CC)N4)cc21] |
| 111-A | 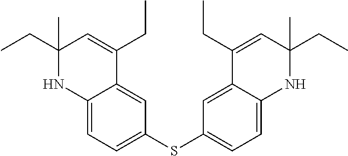 [SMILES: CCC1=CC(C)(CC)Nc2ccc(Sc3ccc4c(c3)C(CC)=CC(C)(CC)N4)cc21] |
| 112-A | 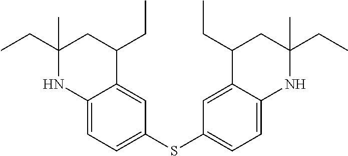 [SMILES: CCC1CC(C)(CC)Nc2ccc(Sc3ccc4c(c3)C(CC)CC(C)(CC)N4)cc21] |
| 113-A | 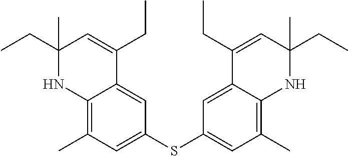 [SMILES: CCC1=CC(C)(CC)Nc2c(C)cc(Sc3cc(C)c4c(c3)C(CC)=CC(C)(CC)N4)cc21] |
| 114-A | 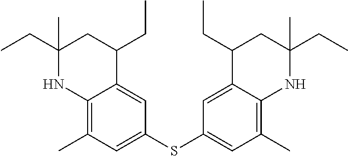 [SMILES: CCC1CC(C)(CC)Nc2c(C)cc(Sc3cc(C)c4c(c3)C(CC)CC(C)(CC)N4)cc21] |
| 115-A | 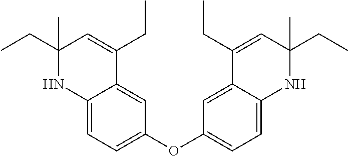 [SMILES: CCC1=CC(C)(CC)Nc2ccc(Oc3ccc4c(c3)C(CC)=CC(C)(CC)N4)cc21] |
| 116-A | 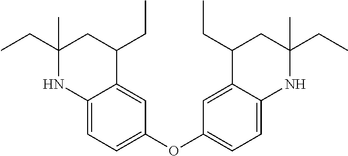 [SMILES: CCC1CC(C)(CC)Nc2ccc(Oc3ccc4c(c3)C(CC)CC(C)(CC)N4)cc21] |
| 117-A | 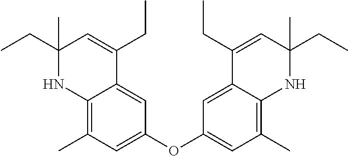 [SMILES: CCC1=CC(C)(CC)Nc2c(C)cc(Oc3cc(C)c4c(c3)C(CC)=CC(C)(CC)N4)cc21] |
| 118-A | 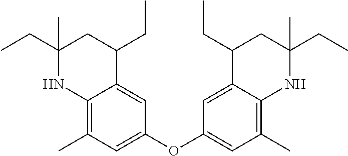 [SMILES: CCC1CC(C)(CC)Nc2c(C)cc(Oc3cc(C)c4c(c3)C(CC)CC(C)(CC)N4)cc21] |
| 119-A | 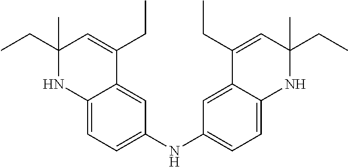 [SMILES: CCC1=CC(C)(CC)Nc2ccc(Nc3ccc4c(c3)C(CC)=CC(C)(CC)N4)cc21] |
| 120-A | 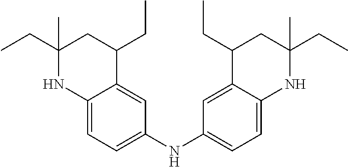 [SMILES: CCC1CC(C)(CC)Nc2ccc(Nc3ccc4c(c3)C(CC)CC(C)(CC)N4)cc21] |
| 121-A | 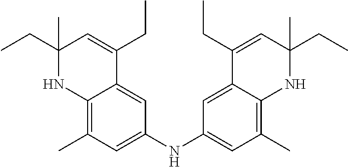 [SMILES: CCC1=CC(C)(CC)Nc2c(C)cc(Nc3cc(C)c4c(c3)C(CC)=CC(C)(CC)N4)cc21] |
| 122-A | 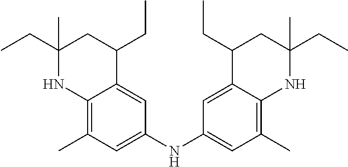 [SMILES: CCC1CC(C)(CC)Nc2c(C)cc(Nc3cc(C)c4c(c3)C(CC)CC(C)(CC)N4)cc21] |
| 123-A | 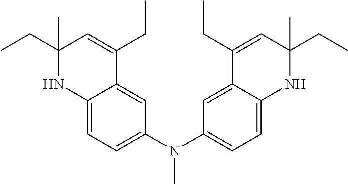 [SMILES: CCC1=CC(C)(CC)Nc2ccc(N(C)c3ccc4c(c3)C(CC)=CC(C)(CC)N4)cc21] |
| 124-A | 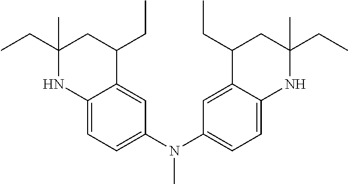 [SMILES: CCC1CC(C)(CC)Nc2ccc(N(C)c3ccc4c(c3)C(CC)CC(C)(CC)N4)cc21] |
| 125-A | 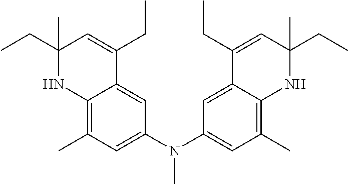 [SMILES: CCC1=CC(C)(CC)Nc2c(C)cc(N(C)c3cc(C)c4c(c3)C(CC)=CC(C)(CC)N4)cc21] |
| 126-A | 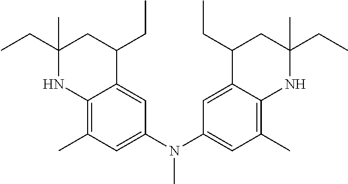 [SMILES: CCC1CC(C)(CC)Nc2c(C)cc(N(C)c3cc(C)c4c(c3)C(CC)CC(C)(CC)N4)cc21] |
| 127-A | 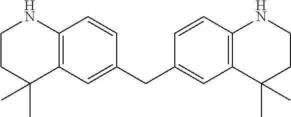 |
| 128-A | 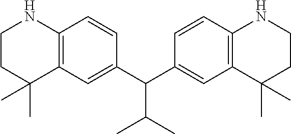 |
| 129-A | 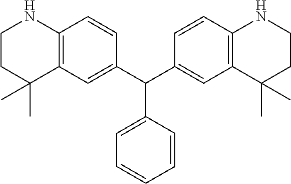 |
| 130-A | 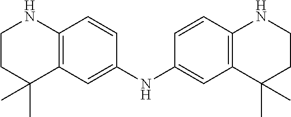 |
| 131-A | 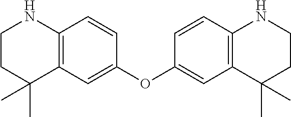 |
| 132-A | 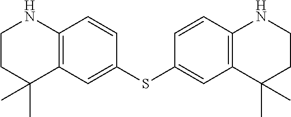 |
| 133-A | 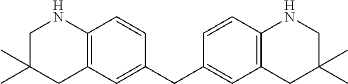 |
| 134-A | 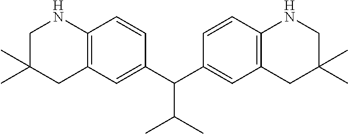 |
| 135-A | 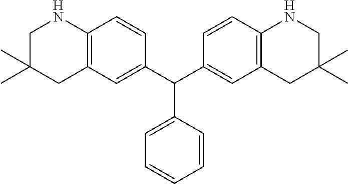 |
| 136-A | 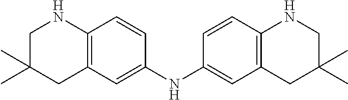 |
| 137-A | 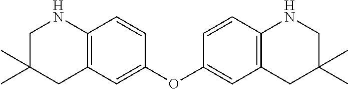 |
| 138-A | 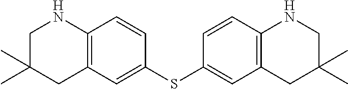 |
| 139-A | 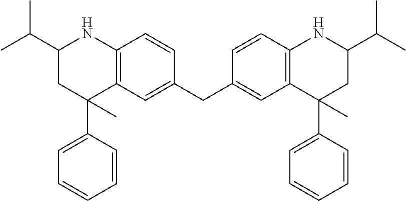 [SMILES: CC(C)C1CC(C)(c2ccccc2)c2cc(Cc3ccc4c(c3)C(C)(c3ccccc3)CC(C(C)C)N4)ccc2N1] |
| 140-A | 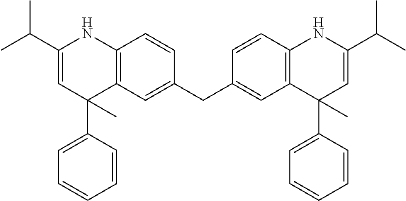 [SMILES: CC(C)C1=CC(C)(c2ccccc2)c2cc(Cc3ccc4c(c3)C(C)(c3ccccc3)C=C(C(C)C)N4)ccc2N1] |
| 141-A | 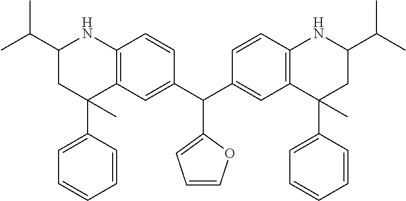 [SMILES: CC(C)C1CC(C)(c2ccccc2)c2cc(C(c3ccc4c(c3)C(C)(c3ccccc3)CC(C(C)C)N4)c3ccco3)ccc2N1] |
| 142-A | 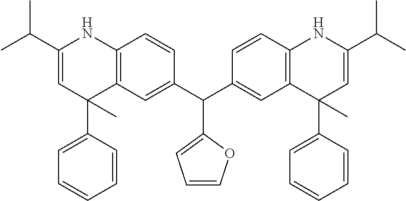 [SMILES: CC(C)C1=CC(C)(c2ccccc2)c2cc(C(c3ccc4c(c3)C(C)(c3ccccc3)C=C(C(C)C)N4)c3ccco3)ccc2N1] |
| 143-A | 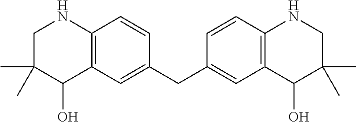 |
| 144-A | 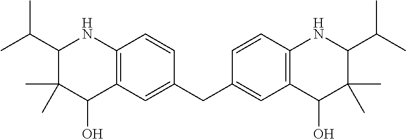 [SMILES: CC(C)C1Nc2ccc(Cc3ccc4c(c3)C(O)C(C)(C)C(C(C)C)N4)cc2C(O)C1(C)C] |
| 145-A | 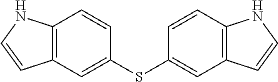 [SMILES: c1cc2cc(Sc3ccc4[nH]ccc4c3)ccc2[nH]1] |
| 146-A | 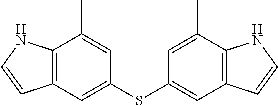 [SMILES: Cc1cc(Sc2cc(C)c3[nH]ccc3c2)cc2cc[nH]c12] |
| 147-A | 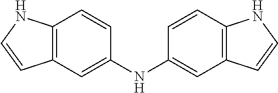 [SMILES: c1cc2cc(Nc3ccc4[nH]ccc4c3)ccc2[nH]1] |
| 148-A | 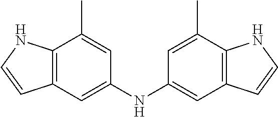 [SMILES: Cc1cc(Nc2cc(C)c3[nH]ccc3c2)cc2cc[nH]c12] |
| 149-A | 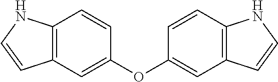 [SMILES: c1cc2cc(Oc3ccc4[nH]ccc4c3)ccc2[nH]1] |
| 150-A | 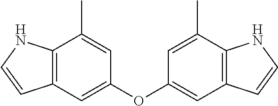 [SMILES: Cc1cc(Oc2cc(C)c3[nH]ccc3c2)cc2cc[nH]c12] |
| 151-A | 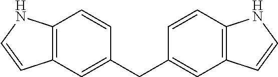 [SMILES: c1cc2cc(Cc3ccc4[nH]ccc4c3)ccc2[nH]1] |
| 152-A | 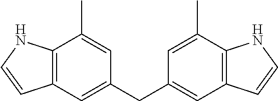 [SMILES: Cc1cc(Cc2cc(C)c3[nH]ccc3c2)cc2cc[nH]c12] |
| 153-A | 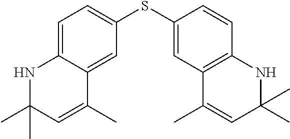 |
| 154-A | 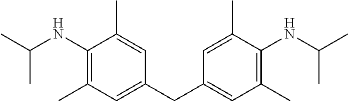 [SMILES: Cc1cc(Cc2cc(C)c(NC(C)C)c(C)c2)cc(C)c1NC(C)C] |
| 155-A | 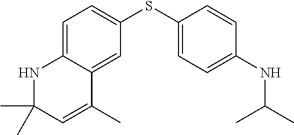 [SMILES: CC1=CC(C)(C)Nc2ccc(Sc3ccc(NC(C)C)cc3)cc21] |
| 156-A | 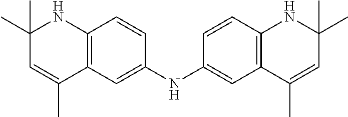 |
| 157-A | 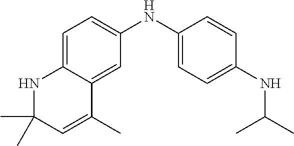 [SMILES: CC1=CC(C)(C)Nc2ccc(Nc3ccc(NC(C)C)cc3)cc21] |

Compounds of Formula (I-A) can be prepared by reacting a secondary aniline with an aldehyde in the presence of acid, as shown in Scheme 1-A.

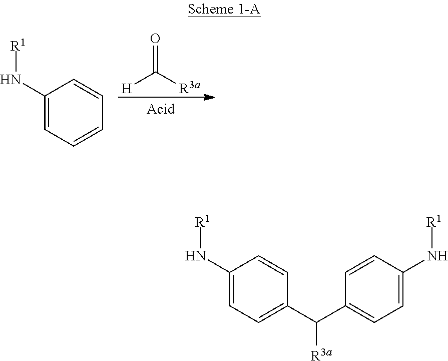

Compounds of Formula (I-A) can also be prepared by the reaction of 4,4′-alkylenedianilines with methyl ketones in the presence of acid, as shown in Scheme 2-A.

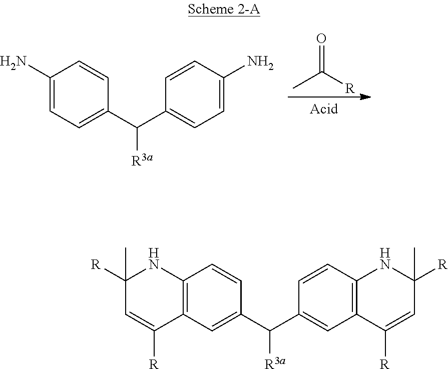

Compounds of Formula (I-A) can also be prepared by the reduction of the compounds obtained in the reaction described by Scheme 2-A, as shown in Scheme 3-A. Reduction may be carried out using any methods known in the art, such as exposure to hydrogen over a palladium on carbon (Pd/C) catalyst.

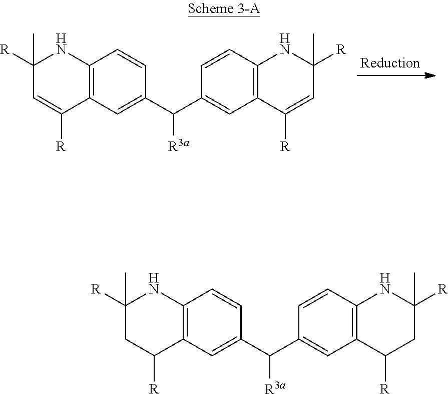

In some embodiments, Compounds of the Disclosure are compounds described in International Appl. No. PCT/US2023/067852 (WO 2023/235855), which is fully incorporated by reference herein in its entirety.

In some embodiments, Compounds of the Disclosure are compounds having

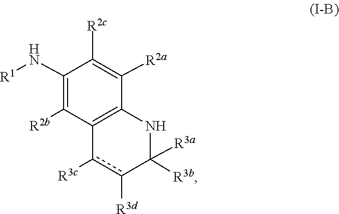

or a salt, solvate, or stereoisomer thereof, wherein:
[symbol] is a single or a double bond;
R¹ is selected from the group consisting of optionally substituted C₁-C₁₂ alkyl, —CHR^{1a}R^{1b}, C₃-C₆ cycloalkyl, 4- to 6-membered heterocyclyl, optionally substituted phenyl, and optionally substituted 5- or 6-membered heteroaryl;
R^{1a} is selected from the group consisting of optionally substituted phenyl, C₃-C₆ cycloalkyl, 4- to 6-membered heterocyclo, and optionally substituted 5- or 6-membered heteroaryl;
R^{1b} is selected from the group consisting of hydrogen and C₁-C₉ alkyl;
R^{2a}, R^{2b}, and R^{2c} are independently selected from the group consisting of hydrogen, halogen, C₁-C₉ alkyl, C₁-C₉ haloalkyl, C₃-C₈ cycloalkyl, C₁-C₈ alkoxy, C₁-C₈ alkylthio, —C(═O)OR⁴, —OC(═O)R⁴, —C(═O)NR⁴R⁵, —NR⁴C(═O)R⁵, —NR⁴R⁵, —OH, —SH, —SC(═O)R⁴, —SC(═O)SR⁴, —SC(═O)NR⁴R⁵, —NR⁴C(═O)SR⁵, —NR⁴C(═S)SR⁵, 4- to 6-membered heterocyclyl, optionally substituted phenyl, and optionally substituted 5- or 6-membered heteroaryl,
with the proviso that at least one of R^{2a}, R^{2b}, or R^{2c} is not hydrogen, i.e., at least one of R^{2a}, R^{2b}, or R^{2c} is halogen, C₁-C₉ alkyl, C₁-C₉ haloalkyl, C₃-C₈ cycloalkyl, C₁-C₈ alkoxy, C₁-C₈ alkylthio, —C(═O)OR⁴, —OC(═O)R⁴, —C(═O)NR⁴R⁵, —NR⁴C(═O)R⁵,
—NR⁴R⁵, —OH, —SH, —SC(═O)R⁴, —SC(═O)SR⁴, —SC(═O)NR⁴R⁵, —NR⁴C(═O)SR⁵, —NR⁴C(═S)SR⁵, 4- to 6-membered heterocyclyl, optionally substituted phenyl, or optionally substituted 5- or 6-membered heteroaryl;
R^{3a} is selected from the group consisting of hydrogen, halogen, C₁-C₉ alkyl, optionally substituted phenyl, —C(═O)OR⁴, —C(═O)NR⁴R⁵, —C(═O)SR⁴, —CH₂OR⁴, —CH₂OC(═O)R⁴, and

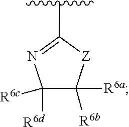

and
R^{3b} is selected from the group consisting of hydrogen, halogen, C₁-C₉ alkyl, and optionally substituted phenyl; or
R^{3a} and R^{3b} taken together with the carbon atom to which they are attached form a C₃-C₁₂ cycloalkyl;
R^{3c} is selected from the group consisting of hydrogen, halogen, C₁-C₉ alkyl, optionally substituted phenyl, —C(═O)OR⁴, —C(═O)NR⁴R⁵, —C(═O)SR⁴, —CH₂OR⁴, —CH₂OC(═O)R⁴, and

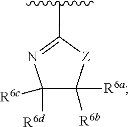

and
R^{3d} is selected from the group consisting of hydrogen, halogen, C₁-C₉ alkyl, and optionally substituted phenyl; or
R^{3c} and R^{3d} taken together with the two carbon atoms to which they are attached form a C₃-C₁₂ cycloalkyl;
Z at each occurrence is independently selected from the group consisting of —O—, —S—, and —NR⁷—;
R⁴ at each occurrence is independently selected from the group consisting of hydrogen, C₁-C₉ alkyl, C₃-C₆ cycloalkyl, and optionally substituted phenyl;
R⁵ at each occurrence is independently selected from the group consisting of hydrogen, C₁-C₉ alkyl, C₃-C₆ cycloalkyl, and optionally substituted phenyl;
R^{6a}, R^{6b}, R^{6c}, and R^{6d} at each occurrence are independently selected from the group consisting of hydrogen, C₁-C₁₂ alkyl, and optionally substituted phenyl; and
R⁷ at each occurrence is independently selected from the group consisting or hydrogen and C₁-C₆ alkyl.

In some embodiments, Compounds of the Disclosure are compounds having Formula (I-B), or a salt, solvate, or stereoisomer thereof, wherein:
[symbol] is a single or a double bond;
R¹ is selected from the group consisting of optionally substituted C₁-C₁₂ alkyl, —CHR^{1a}R^{1b}, C₃-C₆ cycloalkyl, 4- to 6-membered heterocyclyl, optionally substituted phenyl, and optionally substituted 5- or 6-membered heteroaryl;
R^{1a} is selected from the group consisting of optionally substituted phenyl, C₃-C₆ cycloalkyl, and optionally substituted 5- or 6-membered heteroaryl;
R^{1b} is selected from the group consisting of hydrogen and C₁-C₉ alkyl;
R^{2a}, R^{2b}, and R^{2c} are independently selected from the group consisting of hydrogen, halogen, C₁-C₉ alkyl, C₁-C₉ haloalkyl, C₃-C₈ cycloalkyl, C₁-C₈ alkoxy, C₁-C₈ alkylthio, —C(═O)OR⁴, —OC(═O)R⁴, —C(═O)NR⁴R⁵, —NR⁴C(═O)R⁵, —NHR⁴, —NR⁴R⁵, —OH, —SH, —SC(═O)R⁴, —SC(═O)SR⁴, —SC(═O)NHR⁴, —SC(═O)NR⁴R⁵, —NHC(═O)SR⁴,
—NR⁴C(═O)SR⁵, —NHC(═S)SR⁴, —NR⁴C(═S)SR⁵, 4- to 6-membered heterocyclyl, optionally substituted phenyl, and optionally substituted 5- or 6-membered heteroaryl,
with the proviso that at least one of R^{2a}, R^{2b}, or R^{2c} is not hydrogen, i.e., at least one of R^{2a}, R^{2b}, or R^{2c} is halogen, C₁-C₉ alkyl, C₁-C₉ haloalkyl, C₃-C₈ cycloalkyl, C₁-C₈ alkoxy, C₁-C₈ alkylthio, —C(═O)OR⁴, —OC(═O)R⁴, —C(═O)NR⁴R⁵, —NR⁴C(═O)R⁵, —NHR⁴, —NR⁴R⁵, —OH, —SH, —SC(═O)R⁴, —SC(═O)SR⁴, —SC(═O)NHR⁴, —SC(═O)NR⁴R⁵, —NHC(═O)SR⁴,
—NR⁴C(═O)SR⁵, —NHC(═S)SR⁴, —NR⁴C(═S)SR⁵, 4- to 6-membered heterocyclyl, optionally substituted phenyl, and optionally substituted 5- or 6-membered heteroaryl;
R^{3a} and R^{3b} are independently selected from the group consisting of hydrogen, halogen, C₁-C₉ alkyl, and optionally substituted phenyl; or
R^{3a} and R^{3b} taken together with the carbon atom to which they are attached form a C₃-C₁₂ cycloalkyl;
R^{3c} and R^{3d} are independently selected from the group consisting of hydrogen, halogen, C₁-C₉ alkyl, and optionally substituted phenyl; or
R^{3c} and R^{3d} taken together with the two carbon atoms to which they are attached form a C₃-C₁₂ cycloalkyl;
R⁴ is selected from the group consisting of hydrogen and C₁-C₉ alkyl; and
R⁵ is selected from the group consisting of hydrogen and C₁-C₉ alkyl.

In some embodiments, Compounds of the Disclosure are compounds having Formula (I-B), wherein R^{3a}, R^{3b}, and R^{3c} are independently selected from the group consisting of methyl, ethyl, propyl, iso-propyl, n-butyl, sec-butyl, iso-butyl, tert-butyl, pentyl, hexyl, heptyl, octyl, and nonyl.

In some embodiments, Compounds of the Disclosure are compounds having Formula (I-B), wherein R^{3a}, R^{3b}, and R^{3c} are methyl.

In some embodiments, Compounds of the Disclosure are compounds having Formula (I-B), wherein R^{3b} is methyl; and R^{3a} and R^{3c} are C₂-C₉ alkyl.

In some embodiments, Compounds of the Disclosure are compounds having Formula (I-B), wherein R^{3b} is methyl; and R^{3a} and R^{3c} are ethyl.

In some embodiments, Compounds of the Disclosure are compounds having Formula (I-B), wherein R^{3a} is —C(═O)OR⁴, —C(═O)NR⁴R⁵, —C(═O)SR⁴, —CH₂OR⁴, —CH₂OC(═O)R⁴, or

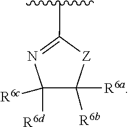

In some embodiments, Compounds of the Disclosure are compounds having Formula (I-B), wherein R^{3a} is —C(═O)OR⁴. In some embodiments, R^{3a} is —C(═O)OEt.

In some embodiments, Compounds of the Disclosure are compounds having Formula (I-B), wherein R^{3a} is —C(═O)NR⁴R⁵.

In some embodiments, Compounds of the Disclosure are compounds having Formula (I-B), wherein R^{3a} is —C(═O)SR⁴.

In some embodiments, Compounds of the Disclosure are compounds having Formula (I-B), wherein R^{3a} is —CH₂OR⁴.

In some embodiments, Compounds of the Disclosure are compounds having Formula (I-B), wherein R^{3a} is —CH₂OC(═O)R⁴.

In some embodiments, Compounds of the Disclosure are compounds having Formula (I-B), wherein R^{3a} is:

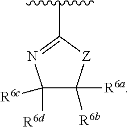

In some embodiments, Compounds of the Disclosure are compounds having Formula (I-B), wherein R^{3c} is —C(═O)OR⁴. In some embodiments, R^{3c} is —C(═O)OEt.

In some embodiments, Compounds of the Disclosure are compounds having Formula (I-B), wherein R^{3c} is —C(═O)NR⁴R⁵.

In some embodiments, Compounds of the Disclosure are compounds having Formula (I-B), wherein R^{3c} is —C(═O)SR⁴.

In some embodiments, Compounds of the Disclosure are compounds having Formula (I-B), wherein R^{3c} is —CH₂OR⁴.

In some embodiments, Compounds of the Disclosure are compounds having Formula (I-B), wherein R^{3c} is —CH₂OC(═O)R⁴.

In some embodiments, Compounds of the Disclosure are compounds having Formula (I-B), wherein R^{3c} is:

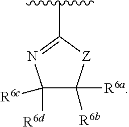

In some embodiments, Compounds of the Disclosure are compounds having Formula (I-B), wherein Z is —O—. In some embodiments, Z is —S—. In some embodiments, Z is —NR⁷—. In some embodiments, R⁷ is hydrogen. In some embodiments, R^{6a}, R^{6b}, R^{6c}, and R^{6d} are hydrogen.

In some embodiments, Compounds of the Disclosure are compounds having Formula (I-B), wherein R¹ is optionally substituted phenyl.

In some embodiments, Compounds of the Disclosure are compounds having Formula (I-B), wherein R¹ is C₁-C₁₂ alkyl.

In some embodiments, Compounds of the Disclosure are compounds having Formula (I-B), wherein R^{2b} and R^{2c} are hydrogen.

In some embodiments, Compounds of the Disclosure are compounds having Formula (I-B), wherein R^{2a} and R^{2c} are hydrogen.

In some embodiments, Compounds of the Disclosure are compounds having Formula (I-B), wherein R^{2a} and R^{2b} are hydrogen.

In some embodiments, Compounds of the Disclosure are compounds having Formula (I-B), wherein one of R^{2a}, R^{2b}, and R^{2c} is halogen, C₁-C₉ alkyl, C₁-C₆ alkoxy, or C₁-C₆ alkylthio, and the other two are hydrogen.

In some embodiments, Compounds of the Disclosure are compounds having Formula (I-B), wherein two of R^{2a}, R^{2b}, and R^{2c} is halogen, C₁-C₉ alkyl, C₁-C₆ alkoxy, or C₁-C₆ alkylthio, and the other one is hydrogen.

In some embodiments, Compounds of the Disclosure are compounds having Formula (I-B), wherein wherein [symbol] is a double bond.

In some embodiments, Compounds of the Disclosure are compounds having Formula (I-B), wherein wherein [symbol] is a single bond.

In some embodiments, the Compound of the Disclosure is any of the compounds of Table B, or a salt or solvate thereof.

TABLE B

| Compound No. | Structure |
|---|---|
| 1-B | 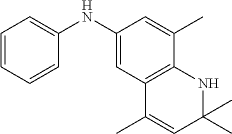 [SMILES: CC1=CC(C)(C)Nc2c(C)cc(Nc3ccccc3)cc21] |
| 2-B | 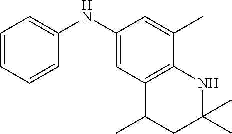 [SMILES: Cc1cc(Nc2ccccc2)cc2c1NC(C)(C)CC2C] |
| 3-B | 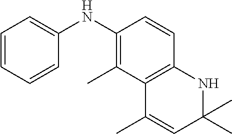 [SMILES: CC1=CC(C)(C)Nc2ccc(Nc3ccccc3)c(C)c21] |
| 4-B | 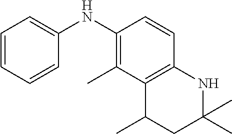 [SMILES: Cc1c(Nc2ccccc2)ccc2c1C(C)CC(C)(C)N2] |
| 5-B | 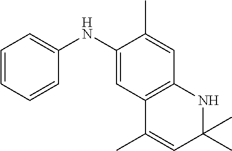 [SMILES: CC1=CC(C)(C)Nc2cc(C)c(Nc3ccccc3)cc21] |
| 6-B | 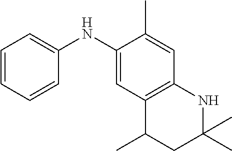 [SMILES: Cc1cc2c(cc1Nc1ccccc1)C(C)CC(C)(C)N2] |
| 7-B | 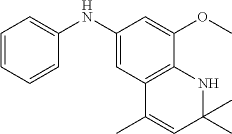 [SMILES: COc1cc(Nc2ccccc2)cc2c1NC(C)(C)C=C2C] |
| 8-B | 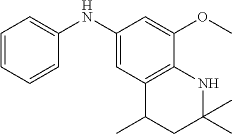 [SMILES: COc1cc(Nc2ccccc2)cc2c1NC(C)(C)CC2C] |
| 9-B | 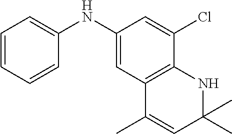 [SMILES: CC1=CC(C)(C)Nc2c(Cl)cc(Nc3ccccc3)cc21] |
| 10-B | 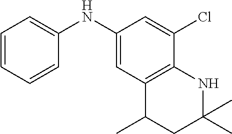 [SMILES: CC1CC(C)(C)Nc2c(Cl)cc(Nc3ccccc3)cc21] |
| 11-B | 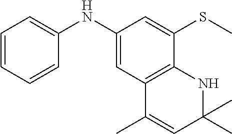 [SMILES: CSc1cc(Nc2ccccc2)cc2c1NC(C)(C)C=C2C] |
| 12-B | 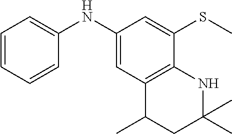 [SMILES: CSc1cc(Nc2ccccc2)cc2c1NC(C)(C)CC2C] |
| 13-B | 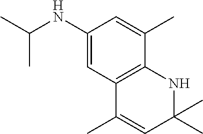 [SMILES: CC1=CC(C)(C)Nc2c(C)cc(NC(C)C)cc21] |
| 14-B | 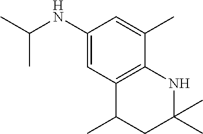 [SMILES: Cc1cc(NC(C)C)cc2c1NC(C)(C)CC2C] |
| 15-B | 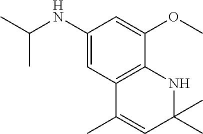 [SMILES: COc1cc(NC(C)C)cc2c1NC(C)(C)C=C2C] |
| 16-B | 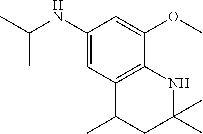 [SMILES: COc1cc(NC(C)C)cc2c1NC(C)(C)CC2C] |
| 17-B | 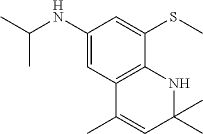 [SMILES: CSc1cc(NC(C)C)cc2c1NC(C)(C)C=C2C] |
| 18-B | 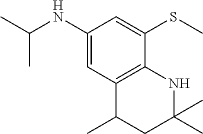 [SMILES: CSc1cc(NC(C)C)cc2c1NC(C)(C)CC2C] |
| 19-B | 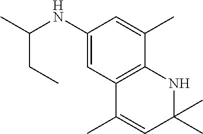 [SMILES: CCC(C)Nc1cc(C)c2c(c1)C(C)=CC(C)(C)N2] |
| 20-B | 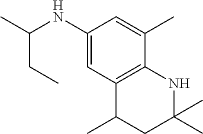 [SMILES: CCC(C)Nc1cc(C)c2c(c1)C(C)CC(C)(C)N2] |
| 21-B | 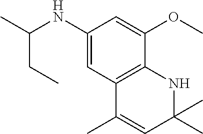 [SMILES: CCC(C)Nc1cc(OC)c2c(c1)C(C)=CC(C)(C)N2] |
| 22-B | 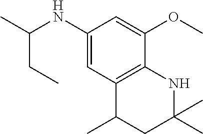 [SMILES: CCC(C)Nc1cc(OC)c2c(c1)C(C)CC(C)(C)N2] |
| 23-B | 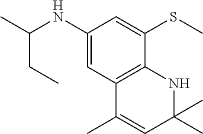 [SMILES: CCC(C)Nc1cc(SC)c2c(c1)C(C)=CC(C)(C)N2] |
| 24-B | 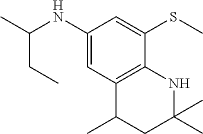 [SMILES: CCC(C)Nc1cc(SC)c2c(c1)C(C)CC(C)(C)N2] |
| 25-B | 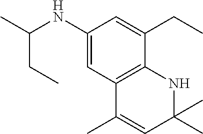 [SMILES: CCc1cc(NC(C)CC)cc2c1NC(C)(C)C=C2C] |
| 26-B | 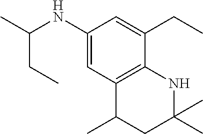 [SMILES: CCc1cc(NC(C)CC)cc2c1NC(C)(C)CC2C] |
| 27-B | 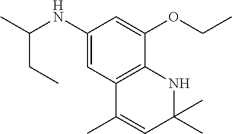 [SMILES: CCOc1cc(NC(C)CC)cc2c1NC(C)(C)C=C2C] |
| 28-B | 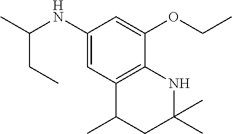 [SMILES: CCOc1cc(NC(C)CC)cc2c1NC(C)(C)CC2C] |
| 29-B | 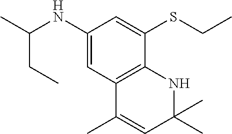 [SMILES: CCSc1cc(NC(C)CC)cc2c1NC(C)(C)C=C2C] |
| 30-B | 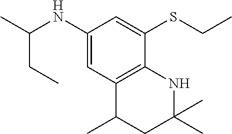 [SMILES: CCSc1cc(NC(C)CC)cc2c1NC(C)(C)CC2C] |
| 31-B | 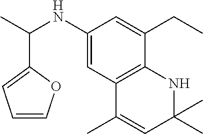 [SMILES: CCc1cc(NC(C)c2ccco2)cc2c1NC(C)(C)C=C2C] |
| 32-B | 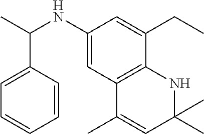 [SMILES: CCc1cc(NC(C)c2ccccc2)cc2c1NC(C)(C)C=C2C] |
| 33-B | 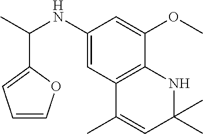 [SMILES: COc1cc(NC(C)c2ccco2)cc2c1NC(C)(C)C=C2C] |
| 34-B | 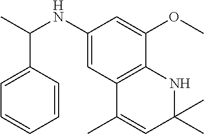 [SMILES: COc1cc(NC(C)c2ccccc2)cc2c1NC(C)(C)C=C2C] |
| 35-B | 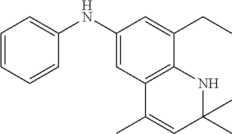 [SMILES: CCc1cc(Nc2ccccc2)cc2c1NC(C)(C)C=C2C] |
| 36-B | 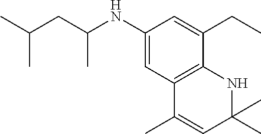 [SMILES: CCc1cc(NC(C)CC(C)C)cc2c1NC(C)(C)C=C2C] |
| 37-B | 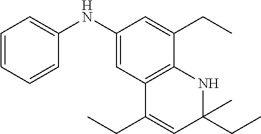 [SMILES: CCC1=CC(C)(CC)Nc2c(CC)cc(Nc3ccccc3)cc21] |
| 38-B | 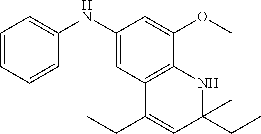 [SMILES: CCC1=CC(C)(CC)Nc2c(OC)cc(Nc3ccccc3)cc21] |
| 39-B | 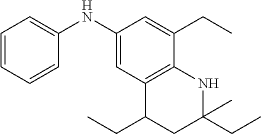 [SMILES: CCc1cc(Nc2ccccc2)cc2c1NC(C)(CC)CC2CC] |
| 40-B | 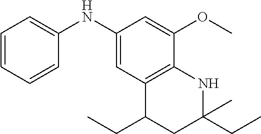 [SMILES: CCC1CC(C)(CC)Nc2c(OC)cc(Nc3ccccc3)cc21] |
| 41-B | 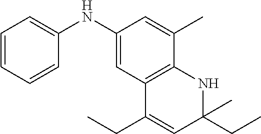 [SMILES: CCC1=CC(C)(CC)Nc2c(C)cc(Nc3ccccc3)cc21] |
| 42-B | 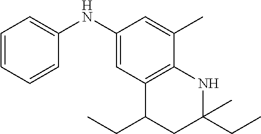 [SMILES: CCC1CC(C)(CC)Nc2c(C)cc(Nc3ccccc3)cc21] |
| 43-B | 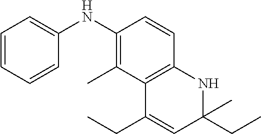 [SMILES: CCC1=CC(C)(CC)Nc2ccc(Nc3ccccc3)c(C)c21] |
| 44-B | 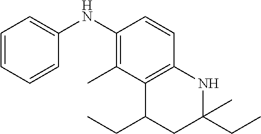 [SMILES: CCC1CC(C)(CC)Nc2ccc(Nc3ccccc3)c(C)c21] |
| 45-B | 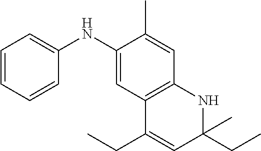 [SMILES: CCC1=CC(C)(CC)Nc2cc(C)c(Nc3ccccc3)cc21] |
| 46-B | 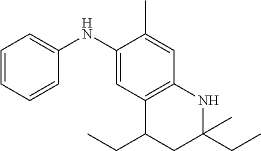 [SMILES: CCC1CC(C)(CC)Nc2cc(C)c(Nc3ccccc3)cc21] |
| 47-B | 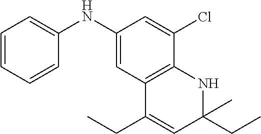 [SMILES: CCC1=CC(C)(CC)Nc2c(Cl)cc(Nc3ccccc3)cc21] |
| 48-B | 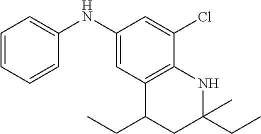 [SMILES: CCC1CC(C)(CC)Nc2c(Cl)cc(Nc3ccccc3)cc21] |
| 49-B | 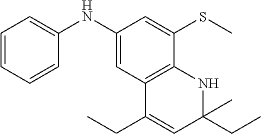 [SMILES: CCC1=CC(C)(CC)Nc2c(SC)cc(Nc3ccccc3)cc21] |
| 50-B | 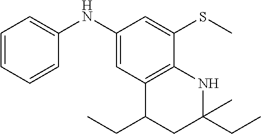 [SMILES: CCC1CC(C)(CC)Nc2c(SC)cc(Nc3ccccc3)cc21] |
| 51-B | 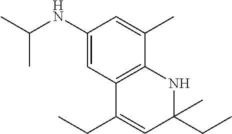 [SMILES: CCC1=CC(C)(CC)Nc2c(C)cc(NC(C)C)cc21] |
| 52-B | 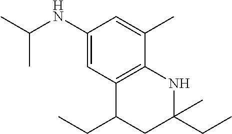 [SMILES: CCC1CC(C)(CC)Nc2c(C)cc(NC(C)C)cc21] |
| 53-B | 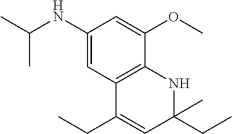 [SMILES: CCC1=CC(C)(CC)Nc2c(OC)cc(NC(C)C)cc21] |
| 54-B | 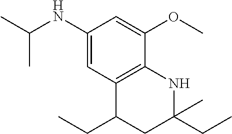 [SMILES: CCC1CC(C)(CC)Nc2c(OC)cc(NC(C)C)cc21] |
| 55-B | 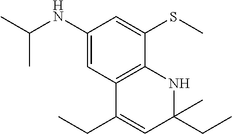 [SMILES: CCC1=CC(C)(CC)Nc2c(SC)cc(NC(C)C)cc21] |
| 56-B | 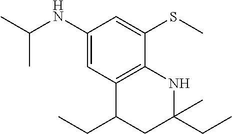 [SMILES: CCC1CC(C)(CC)Nc2c(SC)cc(NC(C)C)cc21] |
| 57-B | 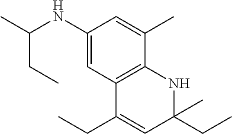 [SMILES: CCC1=CC(C)(CC)Nc2c(C)cc(NC(C)CC)cc21] |
| 58-B | 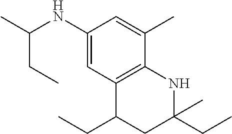 [SMILES: CCC(C)Nc1cc(C)c2c(c1)C(CC)CC(C)(CC)N2] |
| 59-B | 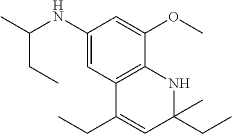 [SMILES: CCC1=CC(C)(CC)Nc2c(OC)cc(NC(C)CC)cc21] |
| 60-B | 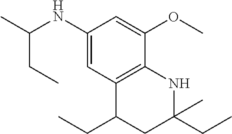 [SMILES: CCC(C)Nc1cc(OC)c2c(c1)C(CC)CC(C)(CC)N2] |
| 61-B | 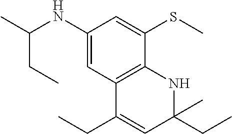 [SMILES: CCC1=CC(C)(CC)Nc2c(SC)cc(NC(C)CC)cc21] |
| 62-B | 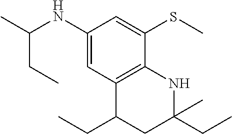 [SMILES: CCC(C)Nc1cc(SC)c2c(c1)C(CC)CC(C)(CC)N2] |
| 63-B | 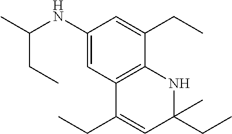 [SMILES: CCC1=CC(C)(CC)Nc2c(CC)cc(NC(C)CC)cc21] |
| 64-B | 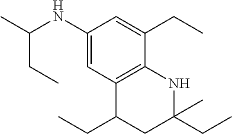 [SMILES: CCc1cc(NC(C)CC)cc2c1NC(C)(CC)CC2CC] |
| 65-B | 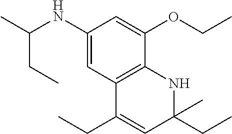 [SMILES: CCOc1cc(NC(C)CC)cc2c1NC(C)(CC)C=C2CC] |
| 66-B | 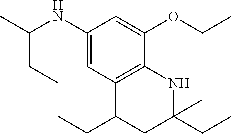 [SMILES: CCOc1cc(NC(C)CC)cc2c1NC(C)(CC)CC2CC] |
| 67-B | 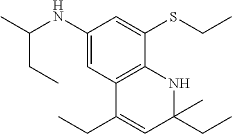 [SMILES: CCSc1cc(NC(C)CC)cc2c1NC(C)(CC)C=C2CC] |
| 68-B | 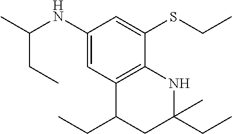 [SMILES: CCSc1cc(NC(C)CC)cc2c1NC(C)(CC)CC2CC] |
| 69-B | 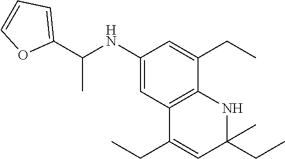 [SMILES: CCC1=CC(C)(CC)Nc2c(CC)cc(NC(C)c3ccco3)cc21] |
| 70-B | 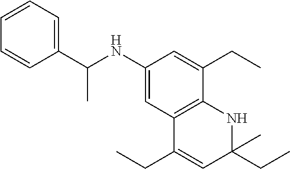 [SMILES: CCC1=CC(C)(CC)Nc2c(CC)cc(NC(C)c3ccccc3)cc21] |
| 71-B | 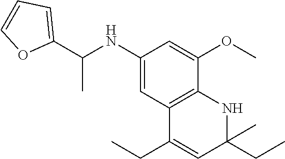 [SMILES: CCC1=CC(C)(CC)Nc2c(OC)cc(NC(C)c3ccco3)cc21] |
| 72-B | 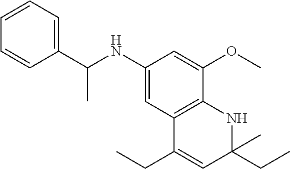 [SMILES: CCC1=CC(C)(CC)Nc2c(OC)cc(NC(C)c3ccccc3)cc21] |
| 73-B | 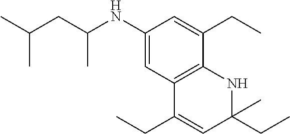 [SMILES: CCC1=CC(C)(CC)Nc2c(CC)cc(NC(C)CC(C)C)cc21] |
| 74-B | 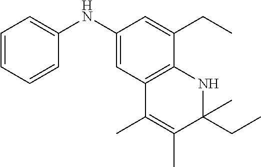 [SMILES: CCc1cc(Nc2ccccc2)cc2c1NC(C)(CC)C(C)=C2C] |
| 75-B | 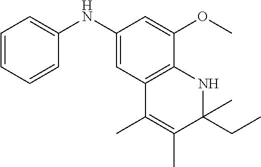 [SMILES: CCC1(C)Nc2c(OC)cc(Nc3ccccc3)cc2C(C)=C1C] |
| 76-B | 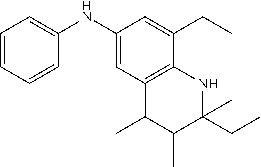 [SMILES: CCc1cc(Nc2ccccc2)cc2c1NC(C)(CC)C(C)C2C] |
| 77-B | 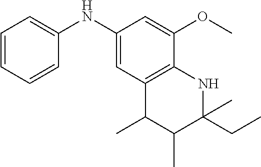 [SMILES: CCC1(C)Nc2c(OC)cc(Nc3ccccc3)cc2C(C)C1C] |
| 78-B | 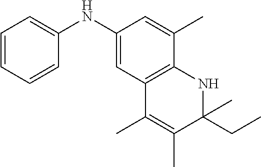 [SMILES: CCC1(C)Nc2c(C)cc(Nc3ccccc3)cc2C(C)=C1C] |
| 79-B | 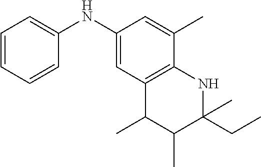 [SMILES: CCC1(C)Nc2c(C)cc(Nc3ccccc3)cc2C(C)C1C] |
| 80-B | 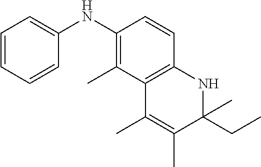 [SMILES: CCC1(C)Nc2ccc(Nc3ccccc3)c(C)c2C(C)=C1C] |
| 81-B | 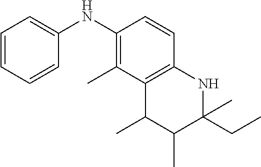 [SMILES: CCC1(C)Nc2ccc(Nc3ccccc3)c(C)c2C(C)C1C] |
| 82-B | 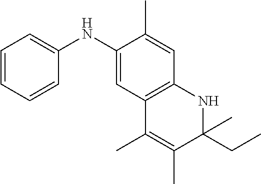 [SMILES: CCC1(C)Nc2cc(C)c(Nc3ccccc3)cc2C(C)=C1C] |
| 83-B | 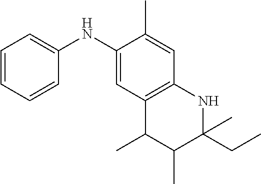 [SMILES: CCC1(C)Nc2cc(C)c(Nc3ccccc3)cc2C(C)C1C] |
| 84-B | 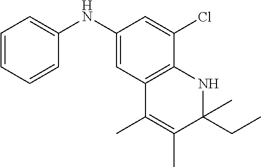 [SMILES: CCC1(C)Nc2c(Cl)cc(Nc3ccccc3)cc2C(C)=C1C] |
| 85-B | 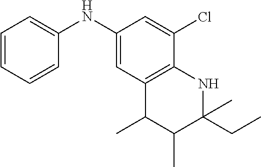 [SMILES: CCC1(C)Nc2c(Cl)cc(Nc3ccccc3)cc2C(C)C1C] |
| 86-B | 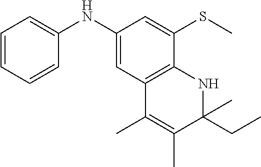 [SMILES: CCC1(C)Nc2c(SC)cc(Nc3ccccc3)cc2C(C)=C1C] |
| 87-B | 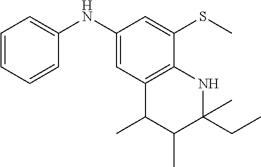 [SMILES: CCC1(C)Nc2c(SC)cc(Nc3ccccc3)cc2C(C)C1C] |
| 88-B | 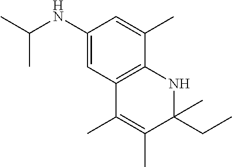 [SMILES: CCC1(C)Nc2c(C)cc(NC(C)C)cc2C(C)=C1C] |
| 89-B | 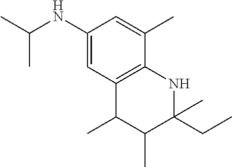 [SMILES: CCC1(C)Nc2c(C)cc(NC(C)C)cc2C(C)C1C] |
| 90-B | 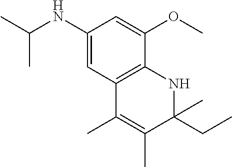 [SMILES: CCC1(C)Nc2c(OC)cc(NC(C)C)cc2C(C)=C1C] |
| 91-B | 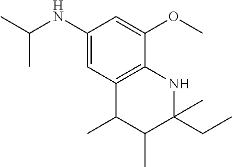 [SMILES: CCC1(C)Nc2c(OC)cc(NC(C)C)cc2C(C)C1C] |
| 92-B | 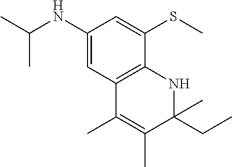 [SMILES: CCC1(C)Nc2c(SC)cc(NC(C)C)cc2C(C)=C1C] |
| 93-B | 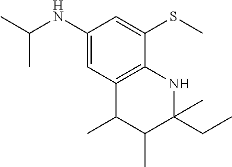 [SMILES: CCC1(C)Nc2c(SC)cc(NC(C)C)cc2C(C)C1C] |
| 94-B | 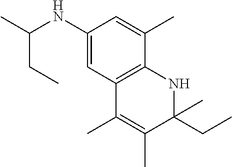 [SMILES: CCC(C)Nc1cc(C)c2c(c1)C(C)=C(C)C(C)(CC)N2] |
| 95-B | 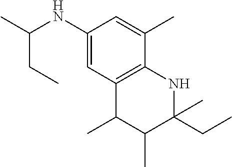 [SMILES: CCC(C)Nc1cc(C)c2c(c1)C(C)C(C)C(C)(CC)N2] |
| 96-B | 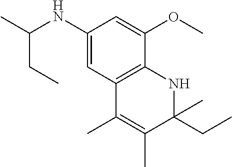 [SMILES: CCC(C)Nc1cc(OC)c2c(c1)C(C)=C(C)C(C)(CC)N2] |
| 97-B | 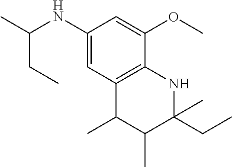 [SMILES: CCC(C)Nc1cc(OC)c2c(c1)C(C)C(C)C(C)(CC)N2] |
| 98-B | 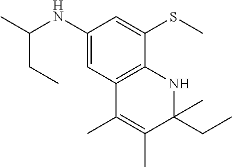 [SMILES: CCC(C)Nc1cc(SC)c2c(c1)C(C)=C(C)C(C)(CC)N2] |
| 99-B | 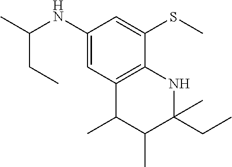 [SMILES: CCC(C)Nc1cc(SC)c2c(c1)C(C)C(C)C(C)(CC)N2] |
| 100-B | 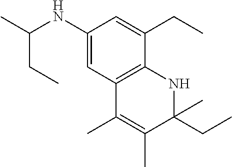 [SMILES: CCc1cc(NC(C)CC)cc2c1NC(C)(CC)C(C)=C2C] |
| 101-B | 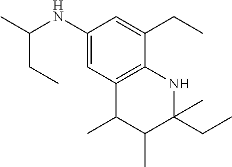 [SMILES: CCc1cc(NC(C)CC)cc2c1NC(C)(CC)C(C)C2C] |
| 102-B | 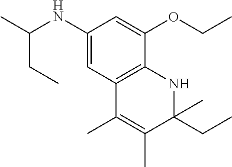 [SMILES: CCOc1cc(NC(C)CC)cc2c1NC(C)(CC)C(C)=C2C] |
| 103-B | 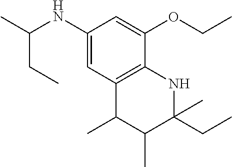 [SMILES: CCOc1cc(NC(C)CC)cc2c1NC(C)(CC)C(C)C2C] |
| 104-B | 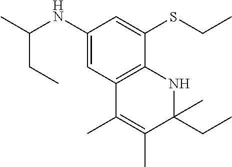 [SMILES: CCSc1cc(NC(C)CC)cc2c1NC(C)(CC)C(C)=C2C] |
| 105-B | 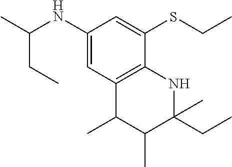 [SMILES: CCSc1cc(NC(C)CC)cc2c1NC(C)(CC)C(C)C2C] |
| 106-B | 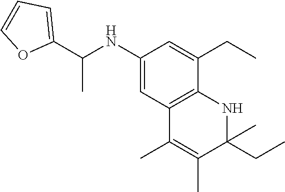 [SMILES: CCc1cc(NC(C)c2ccco2)cc2c1NC(C)(CC)C(C)=C2C] |
| 107-B | 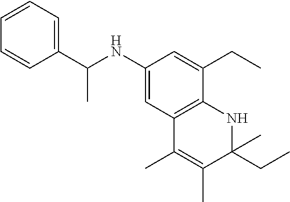 [SMILES: CCc1cc(NC(C)c2ccccc2)cc2c1NC(C)(CC)C(C)=C2C] |
| 108-B | 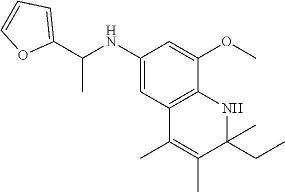 [SMILES: CCC1(C)Nc2c(OC)cc(NC(C)c3ccco3)cc2C(C)=C1C] |
| 109-B | 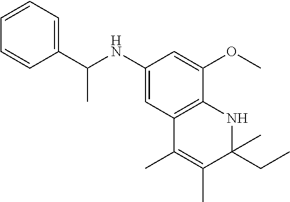 [SMILES: CCC1(C)Nc2c(OC)cc(NC(C)c3ccccc3)cc2C(C)=C1C] |
| 110-B | 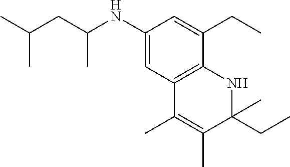 [SMILES: CCc1cc(NC(C)CC(C)C)cc2c1NC(C)(CC)C(C)=C2C] |
| 111-B | 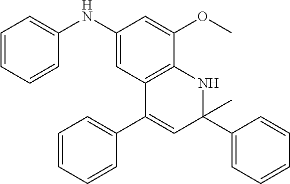 [SMILES: COc1cc(Nc2ccccc2)cc2c1NC(C)(c1ccccc1)C=C2c1ccccc1] |
| 112-B | 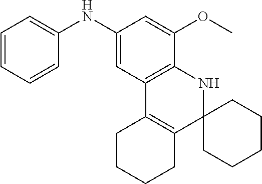 [SMILES: COc1cc(Nc2ccccc2)cc2c1NC1(CCCCC1)C1=C2CCCC1] |
| 113-B | 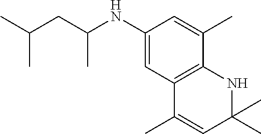 [SMILES: CC1=CC(C)(C)Nc2c(C)cc(NC(C)CC(C)C)cc21] |
| 114-B | 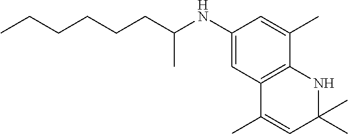 [SMILES: CCCCCCC(C)Nc1cc(C)c2c(c1)C(C)=CC(C)(C)N2] |
| 115-B | 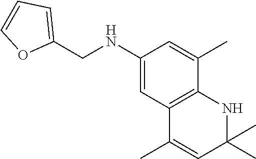 [SMILES: CC1=CC(C)(C)Nc2c(C)cc(NCc3ccco3)cc21] |
| 116-B | 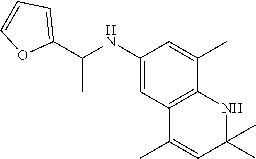 [SMILES: CC1=CC(C)(C)Nc2c(C)cc(NC(C)c3ccco3)cc21] |
| 117-B | 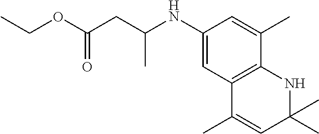 [SMILES: CCOC(=O)CC(C)Nc1cc(C)c2c(c1)C(C)=CC(C)(C)N2] |
| 118-B | 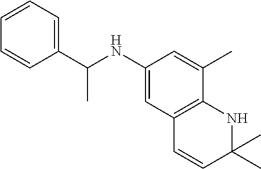 [SMILES: Cc1cc(NC(C)c2ccccc2)cc2c1NC(C)(C)C=C2] |
| 119-B | 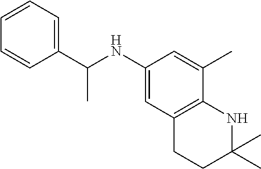 [SMILES: Cc1cc(NC(C)c2ccccc2)cc2c1NC(C)(C)CC2] |
| 120-B | 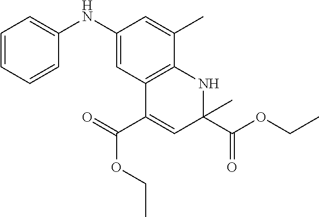 [SMILES: CCOC(=O)C1=CC(C)(C(=O)OCC)Nc2c(C)cc(Nc3ccccc3)cc21] |
| 121-B | 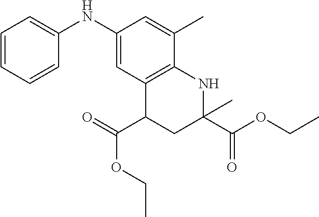 [SMILES: CCOC(=O)C1CC(C)(C(=O)OCC)Nc2c(C)cc(Nc3ccccc3)cc21] |

Compounds of Formula (I-B) can be prepared by a three-step process comprising i) reacting a secondary arylamine with sodium nitrite in acid, ii) reducing the resulting nitroso intermediate to an amine, and iii) reacting the resulting amine with a ketone, e.g., acetone, as shown in Scheme 1-B. Reduction of the nitroso intermediate to an amine can be carried out using any methods known in the art, such as treatment with sodium borohydride (NaBH₄) in ethanol.

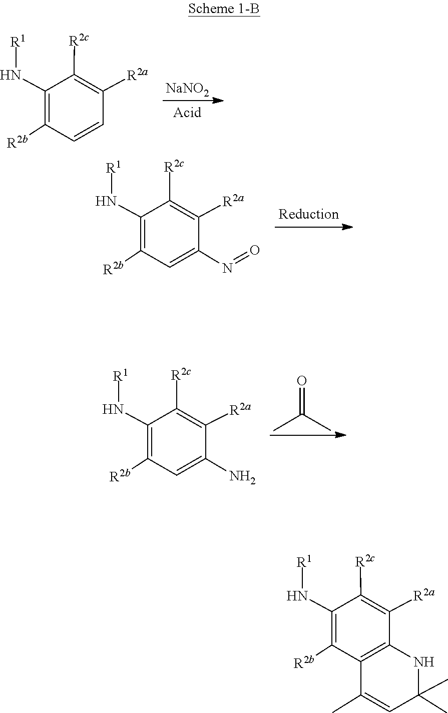

Compounds of Formula (I-B) can also be prepared by further reduction of compounds synthesized using Scheme 1-B, as shown in Scheme 2-B. Reduction may be carried out using any methods known in the art, such as exposure to hydrogen over a palladium on carbon (Pd/C) catalyst.

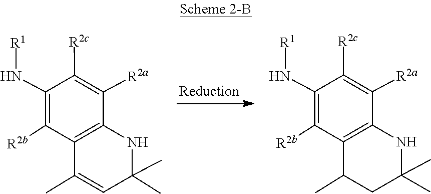

In some embodiments, Compounds of the Disclosure are compounds described in International Appl. No. PCT/US2023/070705, which is fully incorporated by reference herein in their entirety.

In some embodiments, Compounds of the Disclosure are compounds having Formula (I-C):

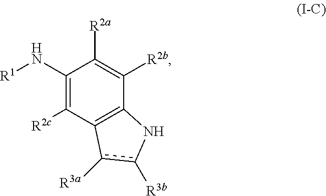

or a salt or solvate thereof, wherein:
[symbol] is a single or a double bond;
R¹ is selected from the group consisting of C₁-C₁₂ alkyl, —CHR^{1a}R^{1b}, optionally substituted C₃-C₆ cycloalkyl, optionally substituted 4- to 6-membered heterocyclyl, optionally substituted phenyl, and optionally substituted 5- or 6-membered heteroaryl;
R^{1a} is selected from the group consisting of optionally substituted phenyl, optionally substituted C₃-C₆ cycloalkyl, optionally substituted 4- to 6-membered heterocyclyl, and optionally substituted 5- or 6-membered heteroaryl;
R^{1b} is selected from the group consisting of hydrogen and C₁-C₉ alkyl;
R^{2a}, R^{2b}, and R^{2c} are independently selected from the group consisting of hydrogen, halogen, C₁-C₉ alkyl, C₁-C₉ haloalkyl, optionally substituted C₃-C₈ cycloalkyl, —OH, C₁-C₈ alkoxy, —SH, C₁-C₈alkylthio, —C(═O)OR⁴, —OC(═O)R⁴, —C(═O)NR⁴R⁵, —NR⁴C(═O)R⁵, —NHR⁴, —NR⁴R⁵, —SC(═O)R⁴, —SC(═O)SR⁴, —SC(═O)NHR⁴, —SC(═O)NR⁴R⁵, —NHC(═O)SR⁴, —NR⁴C(═O)SR⁵, —NHC(═S)SR⁴, —NR⁴C(═S)SR⁵, optionally substituted 4- to 6-membered heterocyclyl, optionally substituted phenyl, and optionally substituted 5- or 6-membered heteroaryl; or
R^{2a} and R^{2b} taken together with the two carbon atoms to which they are attached form an optionally substituted C₃-C₆ cycloalkyl, an optionally substituted 4- to 6-membered heterocyclyl, an optionally substituted 4- to 6-membered aryl, or an optionally substituted 4- to 6-membered heteroaryl; and
R^{2c} is selected from the group consisting of hydrogen, halogen, C₁-C₉ alkyl, C₁-C₉ haloalkyl, optionally substituted C₃-C₈ cycloalkyl, —OH, C₁-C₈ alkoxy, —SH, C₁-C₈ alkylthio, —C(═O)OR⁴, —OC(═O)R⁴, —C(═O)NR⁴R⁵, —NR⁴C(═O)R⁵, —NHR⁴, —NR⁴R⁵, —SC(═O)R⁴, —SC(═O)SR⁴, —SC(═O)NHR⁴, —SC(═O)NR⁴R⁵, —NHC(═O)SR⁴, —NR⁴C(═O)SR⁵, —NHC(═S)SR⁴, —NR⁴C(═S)SR⁵, optionally substituted 4- to 6-membered heterocyclyl, optionally substituted phenyl, and optionally substituted 5- or 6-membered heteroaryl;
R^{3a} and R^{3b} are independently selected from the group consisting of hydrogen, halogen, C₁-C₉ alkyl, C₁-C₉ haloalkyl, optionally substituted C₃-C₈ cycloalkyl, —OH, C₁-C₈ alkoxy, —SH, C₁-C₈ alkylthio, —C(═O)OR⁴, —OC(═O)R⁴, —C(═O)NR⁴R⁵, —NR⁴C(═O)R⁵, —NHR⁴, —NR⁴R⁵, —SC(═O)R⁴, —SC(═O)SR⁴, —SC(═O)NHR⁴, —SC(═O)NR⁴R⁵, —NHC(═O)SR⁴, —NR⁴C(—O)SR⁵, —NHC(—S)SR⁴, —NR⁴C(═S)SR⁵, optionally substituted 4- to 6-membered heterocyclyl, optionally substituted phenyl, and optionally substituted 5- or 6-membered heteroaryl; or
R^{3a} and R^{3b} taken together with the two carbon atoms to which they are attached form an optionally substituted C₃-C₁₂ cycloalkyl or an optionally substituted 4- to 6-membered heterocyclyl;
R⁴ is selected from the group consisting of hydrogen and C₁-C₉ alkyl; and
R⁵ is selected from the group consisting of hydrogen and C₁-C₉ alkyl.

In some embodiments, Compounds of the Disclosure are compounds having Formula (I-C), wherein [symbol] is a double bond.

In some embodiments, Compounds of the Disclosure are compounds having Formula (I-C), wherein [symbol] is a single bond.

In some embodiments, Compounds of the Disclosure are compounds having Formula (I-C), wherein R^{3a} and R^{3b} are selected from the group consisting of hydrogen and C₁-C₆ alkyl.

In some embodiments, Compounds of the Disclosure are compounds having Formula (I-C), wherein R^{3a} and R^{3b} are hydrogen.

In some embodiments, Compounds of the Disclosure are compounds having Formula (VI-C):

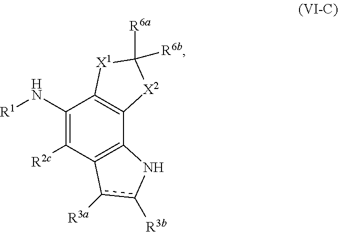

or a salt or solvate thereof, wherein:
X¹ is selected from the group consisting of —CR^{6c}R^{6d}—, —O—, —S—, and —NH—;
X² is selected from the group consisting of —(CR^{6e}R^{6f})ₚ—, —O—, —S—, and —NH—;
p is 1 or 2;
R^{6a} and R^{6b} are independently selected from the group consisting of hydrogen and C₁-C₆ alkyl; or
R^{6a} and R^{6b} taken together with the carbon atom to which they are attached form an oxo, i.e., —C(═O)—;
R^{6c} and R^{6d} are independently selected from the group consisting of hydrogen and C₁-C₆ alkyl;
each R^{6e} and R^{6f} are independently selected from the group consisting of hydrogen and C₁-C₆ alkyl; and
R¹, R^{2c}, R^{3a}, R^{3b}, and [symbol] are defined in connection with Formula (I-C).

In some embodiments, Compounds of the Disclosure are compounds having Formula (VII-C):

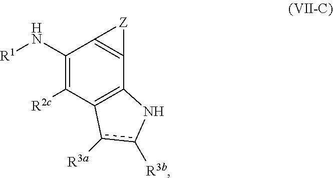

or a salt or solvate thereof, wherein:
Z is selected from the group consisting of —CR^{7a}═CR^{7b}—CR^{7c}═CR^{7d}—, —CR^{7a}═CR^{7b}—CHR^{7c}—CHR^{7d}—, —CHR^{7a}—CHR^{7b}—CHR^{7c}—CHR^{7d}, —CR^{7a}═CR^{7b}—CHR^{7c}—, and —CHR^{7a}—CHR^{7b}—CHR^{7c}—;
R^{7a}, R^{7b}, R^{7c}, and R^{7d} are independently selected from the group consisting of hydrogen, halogen, C₁-C₉ alkyl, C₁-C₉ haloalkyl, optionally substituted C₃-C₈ cycloalkyl, —OH, C₁-C₈alkoxy, —SH, C₁-C₈ alkylthio, —C(═O)OR⁴, —OC(═O)R⁴, —C(═O)NR⁴R⁵, —NR⁴C(═O)R⁵, —NHR⁴, —NR⁴R⁵, —SC(═O)R⁴, —SC(═O)SR⁴, —SC(═O)NHR⁴, —SC(═O)NR⁴R⁵, —NHC(═O)SR⁴, —NR⁴C(═O)SR⁵, —NHC(═S)SR⁴, —NR⁴C(═S)SR⁵, optionally substituted 4- to 6-membered heterocyclyl, optionally substituted phenyl, and optionally substituted 5- or 6-membered heteroaryl; and
R¹, R^{2c}, R^{3a}, R^{3b}, and [symbol] are defined in connection with Formula (I-C).

In some embodiments, Compounds of the Disclosure are compounds having Formula (VII-C), wherein Z is —CR^{7a}—CR^{7b}—CR^{7c}—CR^{7d}—. In some embodiments, R^{7a}, R^{7b}, R^{7c}, and R^{7d} are hydrogen.

In some embodiments, Compounds of the Disclosure are compounds having Formula (VII-C), wherein Z is —CR^{7a}═CR^{7b}—CHR^{7c}—CHR^{7d}—. In some embodiments, R^{7a}, R^{7b}, R^{7c}, and R^{7d} are hydrogen.

In some embodiments, Compounds of the Disclosure are compounds having Formula (VII-C), wherein Z is —CHR^{7a}—CHR^{7b}—CHR⁷—CHR^{7d}—. In some embodiments, R^{7a}, R^{7b}, R^{7c}, and R^{7d} are hydrogen.

In some embodiments, Compounds of the Disclosure are compounds having Formula (VII-C), wherein Z is —CR^{7a}═CR^{7b}—CHR^{7c}—. In some embodiments, R^{7a}, R^{7b}, and R^{7c} are hydrogen.

In some embodiments, Compounds of the Disclosure are compounds having Formula (VII-C), wherein Z is —CHR^{7a}—CHR^{7b}—CHR^{7c}—. In some embodiments, R^{7a}, R^{7b}, and R^{7c} are hydrogen.

In some embodiments, Compounds of the Disclosure are compounds having Formula (VI-C) or (VII-C), wherein [symbol] is a double bond.

In some embodiments, Compounds of the Disclosure are compounds having Formula (VI-C) or (VII-C), wherein [symbol] is a single bond.

In some embodiments, Compounds of the Disclosure are compounds of any one of Formulae (I-C), (VI-C), or (VII-C), wherein R¹ is selected from the group consisting of C₁-C₁₂ alkyl and optionally substituted phenyl.

In some embodiments, Compounds of the Disclosure are compounds of any one of Formulae (I-C), (VI-C), or (VII-C), wherein R¹ is phenyl.

In some embodiments, Compounds of the Disclosure are compounds of any one of Formulae (I-C), (VI-C), or (VII-C), wherein R¹ is selected from the group consisting of methyl, ethyl, propyl, isopropyl, tert-butyl, sec-butyl, iso-butyl, pentyl, hexyl, heptyl, octyl, nonyl, decyl, undecyl, and dodecyl.

In some embodiments, Compounds of the Disclosure are compounds of any one of Formulae (I-C), (VI-C), or (VII-C), wherein R¹ is sec-butyl.

In some embodiments, Compounds of the Disclosure are compounds of any one of Formulae (I-C), (VI-C), or (VII-C), wherein R¹ is isopropyl.

In some embodiments, Compounds of the Disclosure are compounds of any one of Formulae (I-C), (VI-C), or (VII-C), wherein R¹ is —CHR^{1a}R^{1b}.

In some embodiments, Compounds of the Disclosure are compounds of any one of Formulae (I-C), (VI-C), or (VII-C), wherein R^{1a} is selected from the group consisting of

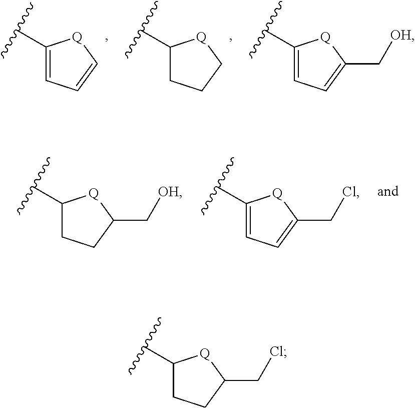

and

Q is selected from the group consisting of —NH—, —O—, and —S—.

In some embodiments, Compounds of the Disclosure are compounds of any one of Formulae (I-C), (VI-C), or (VII-C), wherein Q is —O—.

In some embodiments, Compounds of the Disclosure are compounds of any one of Formulae I-C), (VI-C), or (VII-C), wherein R^{1a} is selected from the group consisting of:

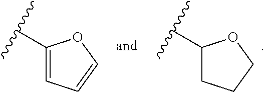 [SMILES: *c1ccco1 ; *C1CCCO1]

In some embodiments, Compounds of the Disclosure are compounds of any one of Formulae (I-C), (VI-C), or (VII-C), wherein R^{1b} is selected from the group consisting of hydrogen and methyl.

In some embodiments, Compounds of the Disclosure are compounds of any one of Formula (I-C), wherein R^{2a}, R^{2b}, and R^{2c} are independently selected from the group consisting of hydrogen, halogen, C₁-C₉ alkyl, C₁-C₆ alkoxy, and C₁-C₆ alkylthio.

In some embodiments, Compounds of the Disclosure are compounds of any one of Formula (I-C), wherein R^{2a} is selected from the group consisting of C₁-C₉ alkyl, C₁-C₆ alkoxy, and C₁-C₆ alkylthio; and R^{2b} and R^{2c} are hydrogen.

In some embodiments, Compounds of the Disclosure are compounds of any one of Formula (I-C), wherein R^{2b} is selected from the group consisting of C₁-C₉ alkyl, C₁-C₆ alkoxy, and C₁-C₆ alkylthio; and R^{2a} and R^{2c} are hydrogen.

In some embodiments, Compounds of the Disclosure are compounds of any one of Formula (I-C), wherein R^{2c} is selected from the group consisting of C₁-C₉ alkyl, C₁-C₆ alkoxy, and C₁-C₆ alkylthio; and R^{2a} and R^{2b} are hydrogen.

In some embodiments, Compounds of the Disclosure are compounds of any one of Formula (I-C), wherein R^{2a}, R^{2b}, and R^{2c} are hydrogen.

In some embodiments, Compounds of the Disclosure are any one or more of the compounds of Table C, or a salt or solvate thereof.

TABLE C

| Compound No. | Structure |
|---|---|
| 1-C | 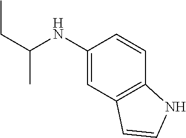 |
| 2-C | 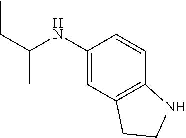 |
| 3-C | 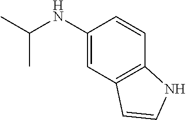 |
| 4-C | 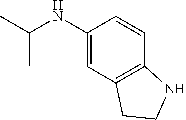 |
| 5-C | 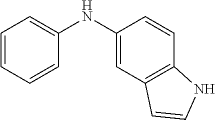 [SMILES: c1ccc(Nc2ccc3[nH]ccc3c2)cc1] |
| 6-C | 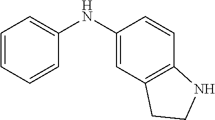 [SMILES: c1ccc(Nc2ccc3c(c2)CCN3)cc1] |
| 7-C | 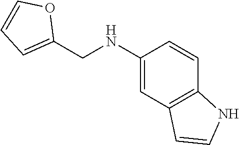 [SMILES: c1coc(CNc2ccc3[nH]ccc3c2)c1] |
| 8-C | 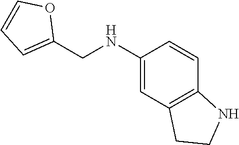 [SMILES: c1coc(CNc2ccc3c(c2)CCN3)c1] |
| 9-C | 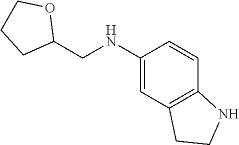 [SMILES: c1cc2c(cc1NCC1CCCO1)CCN2] |
| 10-C | 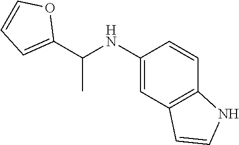 [SMILES: CC(Nc1ccc2[nH]ccc2c1)c1ccco1] |
| 11-C | 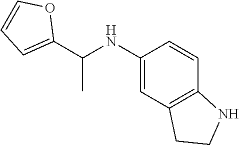 [SMILES: CC(Nc1ccc2c(c1)CCN2)c1ccco1] |
| 12-C | 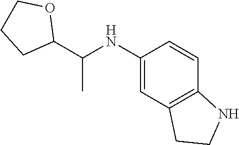 [SMILES: CC(Nc1ccc2c(c1)CCN2)C1CCCO1] |
| 13-C | 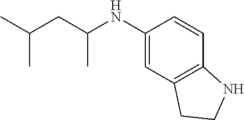 [SMILES: CC(C)CC(C)Nc1ccc2c(c1)CCN2] |
| 14-C | 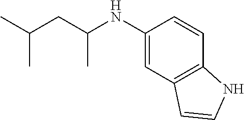 [SMILES: CC(C)CC(C)Nc1ccc2[nH]ccc2c1] |
| 15-C | 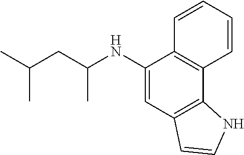 [SMILES: CC(C)CC(C)Nc1cc2cc[nH]c2c2ccccc12] |
| 16-C | 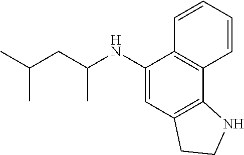 [SMILES: CC(C)CC(C)Nc1cc2c(c3ccccc13)NCC2] |
| 17-C | 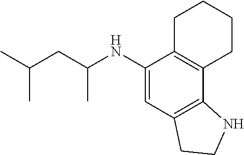 [SMILES: CC(C)CC(C)Nc1cc2c(c3c1CCCC3)NCC2] |
| 18-C | 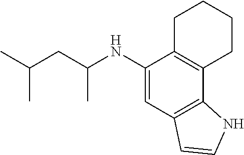 [SMILES: CC(C)CC(C)Nc1cc2cc[nH]c2c2c1CCCC2] |
| 19-C | 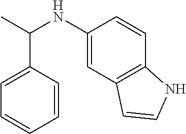 [SMILES: CC(Nc1ccc2[nH]ccc2c1)c1ccccc1] |
| 20-C | 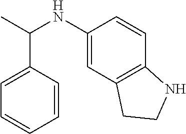 [SMILES: CC(Nc1ccc2c(c1)CCN2)c1ccccc1] |
| 21-C | 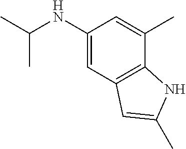 |
| 22-C | 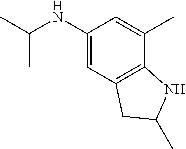 |

Compounds of Formula (I-C) can be prepared by reacting 5-aminoindole or 5-aminoindoline with an aldehyde or ketone via reductive alkylation, as shown in Scheme 1-C.

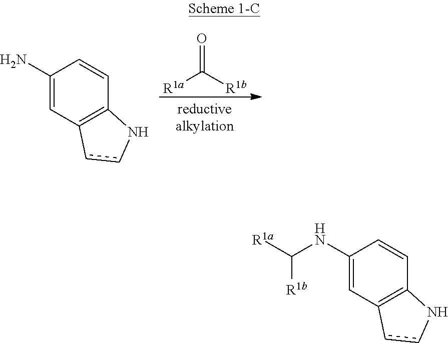

In some embodiments, Compounds of the Disclosure are compounds described in U.S. Provisional Appl. Nos. 63/489,704 and 63/505,909, which are fully incorporated by reference herein in their entirety.

In some embodiments, Compounds of the Disclosure are compounds having Formula (I-D):

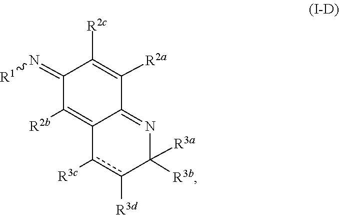

or a salt, solvate, or stereoisomer thereof, wherein:
[symbol] is a single or a double bond;
R¹ is selected from the group consisting of optionally substituted C₁-C₁₂ alkyl, —CHR^{1a}R^{1b}, C₃-C₆ cycloalkyl, 4- to 6-membered heterocyclyl, optionally substituted phenyl, and optionally substituted 5- or 6-membered heteroaryl;
R^{1a} is selected from the group consisting of optionally substituted phenyl, C₃-C₆ cycloalkyl, and optionally substituted 5- or 6-membered heteroaryl;
R^{1b} is selected from the group consisting of hydrogen and C₁-C₉ alkyl;
R^{2a}, R^{2b}, and R^{2c} are independently selected from the group consisting of hydrogen, halogen, C₁-C₉ alkyl, C₁-C₉ haloalkyl, C₃-C₈ cycloalkyl, C₁-C₈ alkoxy, C₁-C₈ alkylthio, —C(═O)OR⁴, —OC(═O)R⁴, —C(═O)NR⁴R⁵, —NR⁴C(═O)R⁵, —NR⁴R⁵, —OH, —SH, —SC(═O)R⁴, —SC(═O)SR⁴, —SC(═O)NR⁴R⁵, —NR⁴C(—O)SR⁵, —NHC(═S)SR⁴, —NR⁴C(═S)SR⁵, 4- to 6-membered heterocyclyl, optionally substituted phenyl, optionally substituted 5- or 6-membered heteroaryl, aryloxy, arylthio, and arylamino; or
R^{2a} and R^{2c} taken together with the two carbon atoms to which they are attached form an optionally substituted C₃-C₆ cycloalkyl, an optionally substituted 4- to 6-membered heterocyclyl, an optionally substituted 4- to 6-membered aryl, or an optionally substituted 4- to 6-membered heteroaryl; and
R^{2b} is selected from the group consisting of hydrogen, halogen, C₁-C₉ alkyl, C₁-C₉ haloalkyl, optionally substituted C₃-C₈ cycloalkyl, —OH, C₁-C₈ alkoxy, —SH, C₁-C₈ alkylthio, —C(═O)OR⁴, —OC(═O)R⁴, —C(═O)NR⁴R⁵, —NR⁴C(═O)R⁵, —NHR⁴, —NR⁴R⁵, —SC(═O)R⁴, —SC(═O)SR⁴, —SC(═O)NHR⁴, —SC(═O)NR⁴R⁵, —NHC(═O)SR⁴, —NR⁴C(═O)SR⁵, —NHC(═S)SR⁴, —NR⁴C(═S)SR⁵, optionally substituted 4- to 6-membered heterocyclyl, optionally substituted phenyl, optionally substituted 5- or 6-membered heteroaryl, aryloxy, arylthio, and arylamino;
R^{3a} is selected from the group consisting of hydrogen, halogen, C₁-C₉ alkyl, optionally substituted phenyl, —C(═O)OR⁴, —C(═O)NR⁴R⁵, —C(═O)SR⁴, —CH₂OR⁴, —CH₂OC(═O)R⁴, and

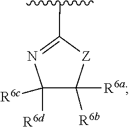

and
R^{3b} is selected from the group consisting of hydrogen, halogen, C₁-C₉ alkyl, and optionally substituted phenyl; or
R^{3a} and R^{3b} taken together with the carbon atom to which they are attached form a C₃-C₁₂ cycloalkyl;
R^{3c} is selected from the group consisting of hydrogen, halogen, C₁-C₉ alkyl, optionally substituted phenyl, —C(═O)OR⁴, —C(═O)NR⁴R⁵, —C(═O)SR⁴, —CH₂OR⁴, —CH₂OC(═O)R⁴, and

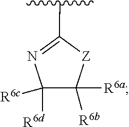

and
R^{3d} is selected from the group consisting of hydrogen, halogen, C₁-C₉ alkyl, and optionally substituted phenyl; or
R^{3c} and R^{3d} taken together with the two carbon atoms to which they are attached form a C₃-C₁₂ cycloalkyl;
R⁴ at each occurrence is independently selected from the group consisting of hydrogen and C₁-C₉ alkyl; and
R⁵ at each occurrence is independently selected from the group consisting of hydrogen and C₁-C₉ alkyl;
R^{6a}, R^{6b}, R^{6c}, and R^{6d} at each occurrence are independently selected from the group consisting of hydrogen, C₁-C₁₂ alkyl, and optionally substituted phenyl;
Z at each occurrence is independently selected from the group consisting of —O—, —S—, and —NR⁷—; and
R⁷ at each occurrence is independently selected from the group consisting of hydrogen and C₁-C₆ alkyl.

In some embodiments, Compounds of the Disclosure are compounds having Formula (I-D), with the proviso that the compound of Formula (I-D) is not:

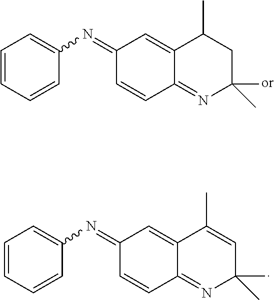

In some embodiments, Compounds of the Disclosure are compounds having Formula (I-D), wherein R^{3a}, R^{3b}, and R^{3c} are independently selected from the group consisting of methyl, ethyl, propyl, iso-propyl, n-butyl, sec-butyl, iso-butyl, tert-butyl, pentyl, hexyl, heptyl, octyl, and nonyl.

In some embodiments, Compounds of the Disclosure are compounds having Formula (I-D), wherein R^{3a}, R^{3b}, and R^{3c} are methyl.

In some embodiments, Compounds of the Disclosure are compounds having Formula (I-D), wherein R¹ is optionally substituted phenyl.

In some embodiments, Compounds of the Disclosure are compounds having Formula (I-D), wherein R¹ is substituted phenyl.

In some embodiments, Compounds of the Disclosure are compounds having Formula (I-D), wherein R¹ is C₁-C₁₂ alkyl.

In another embodiment, Compounds of the Disclosure are compounds having Formula (I-D), wherein R^{2a}, R^{2b}, and R^{2c} are hydrogen.

In another embodiment, Compounds of the Disclosure are compounds having Formula (I-D), wherein:
R¹ is selected from the group consisting of optionally substituted C₁-C₁₂ alkyl, —CHR^{1a}R^{1b}, C₃-C₆ cycloalkyl, 4- to 6-membered heterocyclyl, substituted phenyl, and optionally substituted 5- or 6-membered heteroaryl; and
R^{2a}, R^{2b}, and R^{2c} are hydrogen.

In another embodiment, Compounds of the Disclosure are compounds having Formula (I-D), wherein:
R^{2a}, R^{2b}, and R^{2c} are hydrogen;
R^{3a} is selected from the group consisting of hydrogen, halogen, C₂-C₉ alkyl, and optionally substituted phenyl; and
R^{3b} is selected from the group consisting of hydrogen, halogen, C₁-C₉ alkyl, and optionally substituted phenyl.

In another embodiment, Compounds of the Disclosure are compounds having Formula (I-D), wherein:
R^{2a}, R^{2b}, and R^{2c} are hydrogen; and
R^{3c} is selected from the group consisting of hydrogen, halogen, C₂-C₉ alkyl, and optionally substituted phenyl; and
R^{3d} is selected from the group consisting of hydrogen, halogen, C₁-C₉ alkyl, and optionally substituted phenyl.

In another embodiment, Compounds of the Disclosure are compounds having Formula (II-D):

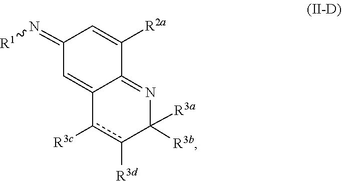

or a salt, solvate, or stereoisomer thereof, wherein
R^{2a} is selected from the group consisting of halogen, C₁-C₉ alkyl, C₁-C₉ haloalkyl, C₃-C₈ cycloalkyl, C₁-C₈ alkoxy, C₁-C₈ alkylthio, C(═O)OR⁴, —OC(═O)R⁴, —C(═O)NR⁴R⁵, —NR⁴C(═O)R⁵, —NHR⁴, —NR⁴R⁵, —OH, —SH, —SC(═O)R⁴, —SC(═O)SR⁴, —SC(═O)NHR⁴,
—SC(═O)NR⁴R⁵, —NHC(═O)SR⁴, —NR⁴C(═O)SR⁵, —NHC(═S)SR⁴, —NR⁴C(═S)SR⁵, 4- to 6-membered heterocyclyl, optionally substituted phenyl, optionally substituted 5- or 6-membered heteroaryl, aryloxy, arylthio, and arylamino;
[symbol] is a single or a double bond; and
R¹, R^{3a}, R^{3b}, R^{3c}, R^{3d}, R⁴, and R⁵ are as defined in connection with Formula (I-D).

In some embodiments, Compounds of the Disclosure are compounds having Formula (II-D), wherein R^{2a} is C₁-C₉ alkyl.

In some embodiments, Compounds of the Disclosure are compounds having Formula (II-D), wherein R^{2a} is methyl.

In another embodiment, Compounds of the Disclosure are compounds having Formula (III-D):

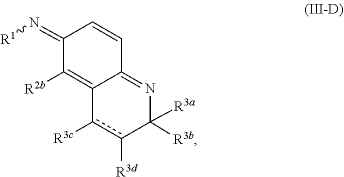

or a salt, solvate, or stereoisomer thereof, wherein
R^{2b} is selected from the group consisting of halogen, C₁-C₉ alkyl, C₁-C₉ haloalkyl, C₃-C₈ cycloalkyl, C₁-C₈alkoxy, C₁-C₈alkylthio, C(═O)OR⁴, —OC(═O)R⁴, —C(═O)NR⁴R⁵, —NR⁴C(═O)R⁵, —NHR⁴, —NR⁴R⁵, —OH, —SH, —SC(═O)R⁴, —SC(═O)SR⁴, —SC(═O)NHR⁴,
—SC(═O)NR⁴R⁵, —NHC(═O)SR⁴, —NR⁴C(═O)SR⁵, —NHC(═S)SR⁴, —NR⁴C(═S)SR⁵, 4- to 6-membered heterocyclyl, optionally substituted phenyl, optionally substituted 5- or 6-membered heteroaryl, aryloxy, arylthio, and arylamino;
[symbol] is a single or a double bond; and
R¹, R^{3a}, R^{3b}, R^{3c}, R^{3d}, R⁴, and R⁵ are as defined in connection with Formula (I-D).

In some embodiments, Compounds of the Disclosure are compounds having Formula (III-D), wherein R^{2b} is C₁-C₉ alkyl.

In some embodiments, Compounds of the Disclosure are compounds having Formula (III-D), wherein R^{2b} is methyl.

In another embodiment, Compounds of the Disclosure are compounds having Formula (IV-D):

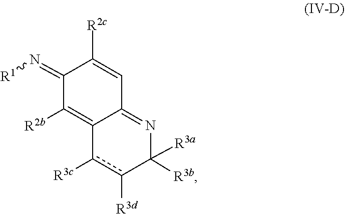

or a salt, solvate, or stereoisomer thereof, wherein:
R^{2c} is selected from the group consisting of halogen, C₁-C₉ alkyl, C₁-C₉ haloalkyl, C₃-C₈ cycloalkyl, C₁-C₈alkoxy, C₁-C₈ alkylthio, —C(═O)OR⁴, —OC(═O)R⁴, —C(═O)NR⁴R⁵, —NR⁴C(═O)R⁵, —NHR⁴, —NR⁴R⁵, —OH, —SH, —SC(═O)R⁴, —SC(═O)SR⁴, —SC(═O)NHR⁴,
—SC(═O)NR⁴R⁵, —NHC(═O)SR⁴, —NR⁴C(—O)SR⁵, —NHC(═S)SR⁴, —NR⁴C(═S)SR⁵, 4- to 6-membered heterocyclyl, optionally substituted phenyl, optionally substituted 5- or 6-membered heteroaryl, aryloxy, arylthio, and arylamino;
[symbol] is a single or a double bond; and
R¹, R^{3a}, R^{3b}, R^{3c}, R^{3d}, R⁴, and R⁵ are as defined in connection with Formula (I-D).

In some embodiments, Compounds of the Disclosure are compounds having Formula (IV-D), wherein R^{2c} is C₁-C₉ alkyl.

In some embodiments, Compounds of the Disclosure are compounds having Formula (IV-D), wherein R^{2c} is methyl.

In another embodiment, Compounds of the Disclosure are compounds having Formula (V-D):

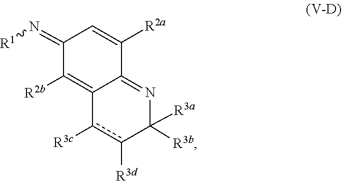

or a salt, solvate, or stereoisomer thereof, wherein:
R^{2a} and R^{2b} are independently selected from the group consisting of halogen, C₁-C₉ alkyl, C₁-C₉ haloalkyl, C₃-C₈ cycloalkyl, C₁-C₈ alkoxy, C₁-C₈alkylthio, —C(═O)OR⁴,
—OC(═O)R⁴, —C(═O)NR⁴R⁵, —NR⁴C(═O)R⁵, —NHR⁴, —NR⁴R⁵, —OH, —SH, —SC(═O)R⁴,
—SC(═O)SR⁴, —SC(═O)NHR⁴, —SC(═O)NR⁴R⁵, —NHC(═O)SR⁴, —NR⁴C(═O)SR⁵,
—NHC(═S)SR⁴, —NR⁴C(═S)SR⁵, 4- to 6-membered heterocyclyl, optionally substituted phenyl, optionally substituted 5- or 6-membered heteroaryl, aryloxy, arylthio, and arylamino;
[symbol] is a single or a double bond; and
R¹, R^{3a}, R^{3b}, R^{3c}, R^{3d}, R⁴, and R⁵ are as defined in connection with Formula (I-D).

In some embodiments, Compounds of the Disclosure are compounds having Formula (V-D), wherein R^{2a} and R^{2b} are independently C₁-C₉ alkyl.

In some embodiments, Compounds of the Disclosure are compounds having Formula (V-D), wherein R^{2a} and R^{2b} are methyl.

In another embodiment, Compounds of the Disclosure are compounds having Formula (VI-D):

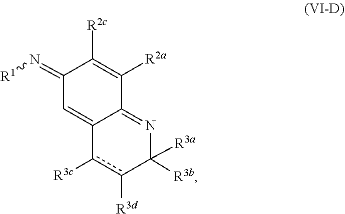

or a salt, solvate, or stereoisomer thereof, wherein:
R^{2a} and R^{2c} are independently selected from the group consisting of halogen, C₁-C₉ alkyl, C₁-C₉ haloalkyl, C₃-C₈ cycloalkyl, C₁-C₈ alkoxy, C₁-C₈ alkylthio, —C(═O)OR⁴, —OC(═O)R⁴, —C(═O)NR⁴R⁵, —NR⁴C(═O)R⁵, —NHR⁴, —NR⁴R⁵, —OH, —SH,
—SC(═O)R⁴, —SC(═O)SR⁴, —SC(═O)NHR⁴, —SC(═O)NR⁴R⁵, —NHC(═O)SR⁴,
—NR⁴C(═O)SR⁵, —NHC(═S)SR⁴, —NR⁴C(═S)SR⁵, 4- to 6-membered heterocyclyl, optionally substituted phenyl, optionally substituted 5- or 6-membered heteroaryl aryloxy, arylthio, and arylamino;
[symbol] is a single or a double bond; and
R¹, R^{3a}, R^{3b}, R^{3c}, R^{3d}, R⁴, and R⁵ are as defined in connection with Formula (I-D).

In some embodiments, Compounds of the Disclosure are compounds having Formula (VI-D), wherein R^{2a} and R^{2c} are independently C₁-C₉ alkyl.

In some embodiments, Compounds of the Disclosure are compounds having Formula (VI-D), wherein R^{2a} and R^{2c} are methyl.

In another embodiment, Compounds of the Disclosure are compounds having Formula (VII-D):

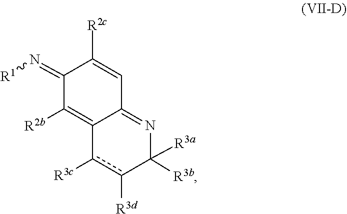

or a salt, solvate, or stereoisomer thereof, wherein:
R^{2b} and R^{2c} are independently selected from the group consisting of halogen, C₁-C₉ alkyl, C₁-C₉ haloalkyl, C₃-C₈ cycloalkyl, C₁-C₈ alkoxy, C₁-C₈ alkylthio, —C(═O)OR⁴, —OC(═O)R⁴, —C(═O)NR⁴R⁵, —NR⁴C(═O)R⁵, —NHR⁴, —NR⁴R⁵, —OH, —SH,
—SC(═O)R⁴, —SC(═O)SR⁴, —SC(═O)NHR⁴, —SC(═O)NR⁴R⁵, —NHC(═O)SR⁴,
—NR⁴C(═O)SR⁵, —NHC(═S)SR⁴, —NR⁴C(═S)SR⁵, 4- to 6-membered heterocyclyl, optionally substituted phenyl, optionally substituted 5- or 6-membered heteroaryl, aryloxy, arylthio, and arylamino;
[symbol] is a single or a double bond; and
R¹, R^{3a}, R^{3b}, R^{3c}, R^{3d}, R⁴, and R⁵ are as defined in connection with Formula (I-D).

In some embodiments, Compounds of the Disclosure are compounds having Formula (VII-D), wherein R^{2b} and R^{2c} are independently C₁-C₉ alkyl.

In some embodiments, Compounds of the Disclosure are compounds having Formula (VII-D), wherein R^{2b} and R^{2c} are methyl.

In some embodiments, Compounds of the Disclosure are compounds having Formula (-D I), wherein R^{2a}, R^{2b}, and R^{2c} are independently selected from the group consisting of halogen, C₁-C₉ alkyl, C₁-C₆ alkoxy, and C₁-C₆ alkylthio.

In some embodiments, Compounds of the Disclosure are compounds having any Formulae (II-D)-(VII-D), wherein R^{2a}, R^{2b}, and R^{2c} are independently selected from the group consisting of methyl, ethyl, methoxy, chloro, —SCH₃, and —SCH₂CH₃.

In some embodiments, Compounds of the Disclosure are compounds of any one of Formulae (I-D)-(VII-D), wherein [symbol] is a double bond.

In some embodiments, Compounds of the Disclosure are compounds of any one of Formulae (I-D)-(VII-D), wherein wherein [symbol] is a single bond.

In some embodiments, Compounds of the Disclosure are compounds of any one of Formulae (II-D)-(VII-D), wherein R¹ is optionally substituted phenyl.

In some embodiments, Compounds of the Disclosure are compounds of any one of Formulae (II-D)-(VII-D), wherein R¹ is C₁-C₁₂ alkyl.

In some embodiments, Compounds of the Disclosure are compounds of any one of Formulae (II-D)-(VII-D), wherein R¹ is selected from the group consisting of methyl, ethyl, propyl, iso-propyl, n-butyl, sec-butyl, iso-butyl, tert-butyl, pentyl, hexyl, heptyl, octyl, and nonyl.

In some embodiments, Compounds of the Disclosure are compounds of any one of Formulae (I-D)-(VII-D), wherein R¹ is —CHR^{1a}R^{1b}. In some embodiments, R^{1a} is selected from the group consisting of optionally substituted phenyl and optionally substituted 5- or 6-membered heteroaryl. In some embodiments, R^{1a} is phenyl or 2-furyl. In some embodiments, R^{1b} is hydrogen or methyl.

In some embodiments, Compounds of the Disclosure are compounds of any one of Formulae (II-D)-(VII-D), wherein R^{3a}, R^{3b}, and R^{3c} are independently selected from the group consisting of methyl, ethyl, propyl, iso-propyl, n-butyl, sec-butyl, iso-butyl, tert-butyl, pentyl, hexyl, heptyl, octyl, and nonyl.

In some embodiments, Compounds of the Disclosure are compounds of any one of Formulae (II-D)-(VII-D), wherein R^{3a}, R^{3b}, and R^{3c} are methyl.

In some embodiments, Compounds of the Disclosure are compounds of any one of Formulae (I-D)-(VII-D), wherein R^{3b} is methyl; and R^{3a} and R^{3c} are C₂-C₉ alkyl.

In some embodiments, Compounds of the Disclosure are compounds of any one of Formulae (I-D)-(VII-D), wherein R^{3b} is methyl; and R^{3a} and R^{3c} are ethyl.

In some embodiments, Compounds of the Disclosure are compounds of any one of Formulae (I-D)-(VII-D), wherein R^{3a} is —C(═O)OR⁴. In some embodiments, R^{3a} is —C(═O)OEt.

In some embodiments, Compounds of the Disclosure are compounds of any one of Formulae (I-D)-(VII-D), wherein R^{3a} is —C(═O)NR⁴R⁵.

In some embodiments, Compounds of the Disclosure are compounds of any one of Formulae (I-D)-(VII-D), wherein R^{3a} is —C(═O)SR⁴.

In some embodiments, Compounds of the Disclosure are compounds of any one of Formulae (I-D)-(VII-D), wherein R^{3a} is —CH₂OR⁴.

In some embodiments, Compounds of the Disclosure are compounds of any one of Formulae (I-D)-(VII-D), wherein R^{3a} is —CH₂OC(═O)R⁴.

In some embodiments, Compounds of the Disclosure are compounds of any one of Formulae (I-D)-(VII-D), wherein R^{3a} is

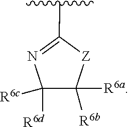

In some embodiments, Compounds of the Disclosure are compounds of any one of Formulae (I-D)-(VII-D), wherein R^{3c} is —C(═O)OR⁴. In some embodiments, R^{3c} is —C(═O)OEt.

In some embodiments, Compounds of the Disclosure are compounds of any one of Formulae (I-D)-(VII-D), wherein R^{3c} is —C(═O)NR⁴R⁵.

In some embodiments, Compounds of the Disclosure are compounds of any one of Formulae (I-D)-(VII-D), wherein R^{3c} is —C(═O)SR⁴.

In some embodiments, Compounds of the Disclosure are compounds of any one of Formulae (I-D)-(VII-D), wherein R^{3c} is —CH₂OR⁴.

In some embodiments, Compounds of the Disclosure are compounds of any one of Formulae (I-D)-(VII-D), wherein R^{3c} is —CH₂OC(═O)R⁴.

In some embodiments, Compounds of the Disclosure are compounds of any one of Formulae (I-D)-(VII-D), wherein R^{3c} is

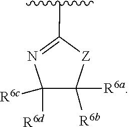

In some embodiments, Compounds of the Disclosure are compounds of any one of Formulae (I-D)-(VII-D), wherein Z is —O—. In some embodiments, Z is —S—. In some embodiments, Z is —NR⁷—. In some embodiments, R⁷ is hydrogen. In some embodiments, R^{6a}, R^{6b}, R^{6c}, and R^{6d} are hydrogen.

In some embodiments, Compounds of the Disclosure are compounds of any one of Formulae (I-D)-(VII-D), wherein each R⁴ is hydrogen or C₁-C₉ alkyl.

In some embodiments, Compounds of the Disclosure are compounds of any one of Formulae (I-D)-(VII-D), wherein each R⁴ is ethyl.

In some embodiments, Compounds of the Disclosure are compounds of any one of Formulae (I-D)-(VII-D), wherein each R⁴ is hydrogen.

In some embodiments, Compounds of the Disclosure are compounds of any one of Formulae (I-D)-(VII-D), wherein R^{3b} is C₁-C₉ alkyl.

In some embodiments, Compounds of the Disclosure are compounds of any one of Formulae (I-D)-(VII-D), wherein R^{3b} is methyl.

In some embodiments, Compounds of the Disclosure are compounds of any one of Formulae (I-D)-(VII-D), wherein R^{3b} is methyl; and R^{3a} and R^{3c} are —C(═O)OR⁴.

In some embodiments, Compounds of the Disclosure are any one or more of the compounds of Table D, or a salt or solvate thereof.

TABLE D

| Cpd | |
|---|---|
| No. | Structure |
| 1-D | 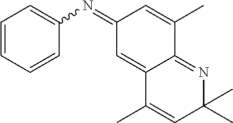 [SMILES: CC1=CC(C)(C)N=C2C(C)=CC(=Nc3ccccc3)C=C12] |
| 2-D | 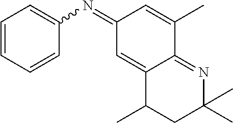 [SMILES: CC1=CC(=Nc2ccccc2)C=C2C1=NC(C)(C)CC2C] |
| 3-D | 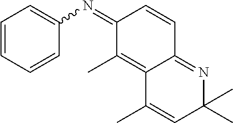 [SMILES: CC1=CC(C)(C)N=C2C=CC(=Nc3ccccc3)C(C)=C12] |
| 4-D | 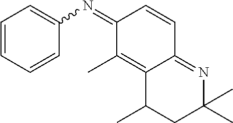 [SMILES: CC1=C2C(=NC(C)(C)CC2C)C=CC1=Nc1ccccc1] |
| 5-D | 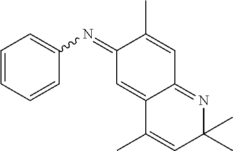 [SMILES: CC1=CC(C)(C)N=C2C=C(C)C(=Nc3ccccc3)C=C12] |
| 6-D | 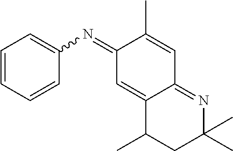 [SMILES: CC1=CC2=NC(C)(C)CC(C)C2=CC1=Nc1ccccc1] |
| 7-D | 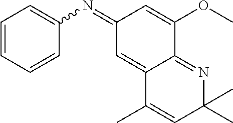 [SMILES: COC1=CC(=Nc2ccccc2)C=C2C(C)=CC(C)(C)N=C12] |
| 8-D | 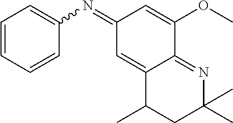 [SMILES: COC1=CC(=Nc2ccccc2)C=C2C1=NC(C)(C)CC2C] |
| 9-D | 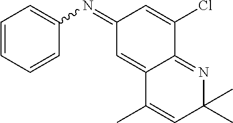 [SMILES: CC1=CC(C)(C)N=C2C(Cl)=CC(=Nc3ccccc3)C=C12] |
| 10-D | 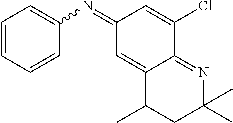 [SMILES: CC1CC(C)(C)N=C2C(Cl)=CC(=Nc3ccccc3)C=C21] |
| 11-D | 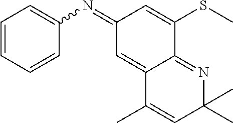 [SMILES: CSC1=CC(=Nc2ccccc2)C=C2C(C)=CC(C)(C)N=C12] |
| 12-D | 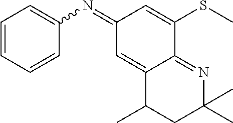 [SMILES: CSC1=CC(=Nc2ccccc2)C=C2C1=NC(C)(C)CC2C] |
| 13-D | 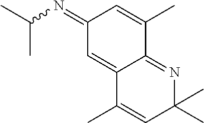 [SMILES: CC1=CC(C)(C)N=C2C(C)=CC(=NC(C)C)C=C12] |
| 14-D | 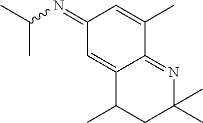 [SMILES: CC1=CC(=NC(C)C)C=C2C1=NC(C)(C)CC2C] |
| 15-D | 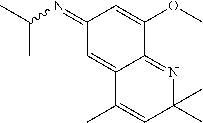 [SMILES: COC1=CC(=NC(C)C)C=C2C(C)=CC(C)(C)N=C12] |
| 16-D | 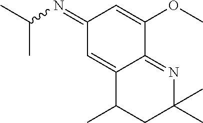 [SMILES: COC1=CC(=NC(C)C)C=C2C1=NC(C)(C)CC2C] |
| 17-D | 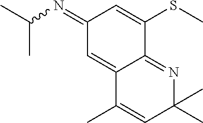 [SMILES: CSC1=CC(=NC(C)C)C=C2C(C)=CC(C)(C)N=C12] |
| 18-D | 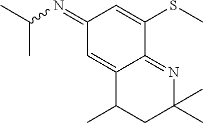 [SMILES: CSC1=CC(=NC(C)C)C=C2C1=NC(C)(C)CC2C] |
| 19-D | 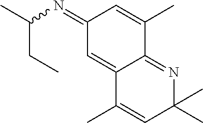 [SMILES: CCC(C)N=C1C=C(C)C2=NC(C)(C)C=C(C)C2=C1] |
| 20-D | 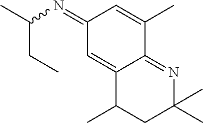 [SMILES: CCC(C)N=C1C=C(C)C2=NC(C)(C)CC(C)C2=C1] |
| 21-D | 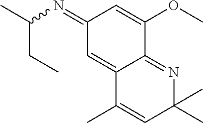 [SMILES: CCC(C)N=C1C=C(OC)C2=NC(C)(C)C=C(C)C2=C1] |
| 22-D | 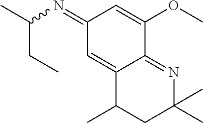 [SMILES: CCC(C)N=C1C=C(OC)C2=NC(C)(C)CC(C)C2=C1] |
| 23-D | 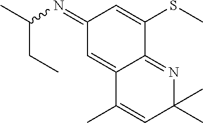 [SMILES: CCC(C)N=C1C=C(SC)C2=NC(C)(C)C=C(C)C2=C1] |
| 24-D | 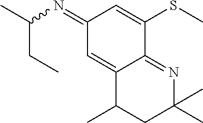 [SMILES: CCC(C)N=C1C=C(SC)C2=NC(C)(C)CC(C)C2=C1] |
| 25-D | 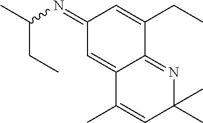 [SMILES: CCC1=CC(=NC(C)CC)C=C2C(C)=CC(C)(C)N=C12] |
| 26-D | 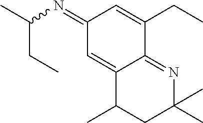 [SMILES: CCC1=CC(=NC(C)CC)C=C2C1=NC(C)(C)CC2C] |
| 27-D | 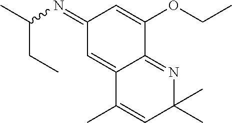 [SMILES: CCOC1=CC(=NC(C)CC)C=C2C(C)=CC(C)(C)N=C12] |
| 28-D | 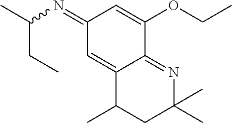 [SMILES: CCOC1=CC(=NC(C)CC)C=C2C1=NC(C)(C)CC2C] |
| 29-D | 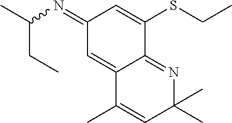 [SMILES: CCSC1=CC(=NC(C)CC)C=C2C(C)=CC(C)(C)N=C12] |
| 30-D | 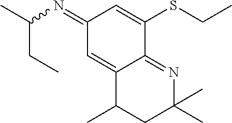 [SMILES: CCSC1=CC(=NC(C)CC)C=C2C1=NC(C)(C)CC2C] |
| 31-D | 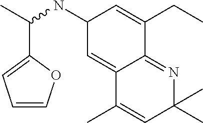 [SMILES: CCC1=CC(NC(C)c2ccco2)C=C2C(C)=CC(C)(C)N=C12] |
| 32-D | 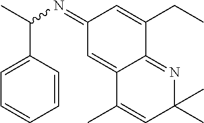 [SMILES: CCC1=CC(=NC(C)c2ccccc2)C=C2C(C)=CC(C)(C)N=C12] |
| 33-D | 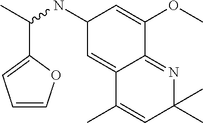 [SMILES: COC1=CC(NC(C)c2ccco2)C=C2C(C)=CC(C)(C)N=C12] |
| 34-D | 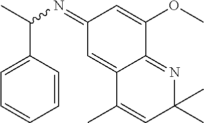 [SMILES: COC1=CC(=NC(C)c2ccccc2)C=C2C(C)=CC(C)(C)N=C12] |
| 35-D | 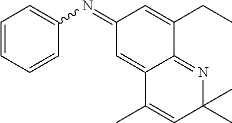 [SMILES: CCC1=CC(=Nc2ccccc2)C=C2C(C)=CC(C)(C)N=C12] |
| 36-D | 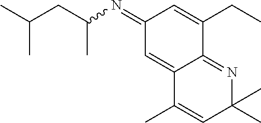 [SMILES: CCC1=CC(=NC(C)CC(C)C)C=C2C(C)=CC(C)(C)N=C12] |
| 37-D | 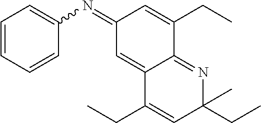 [SMILES: CCC1=CC(C)(CC)N=C2C(CC)=CC(=Nc3ccccc3)C=C12] |
| 38-D | 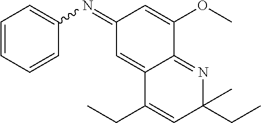 [SMILES: CCC1=CC(C)(CC)N=C2C(OC)=CC(=Nc3ccccc3)C=C12] |
| 39-D | 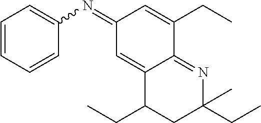 [SMILES: CCC1=CC(=Nc2ccccc2)C=C2C1=NC(C)(CC)CC2CC] |
| 40-D | 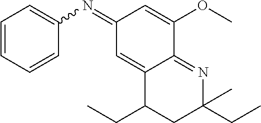 [SMILES: CCC1CC(C)(CC)N=C2C(OC)=CC(=Nc3ccccc3)C=C21] |
| 41-D | 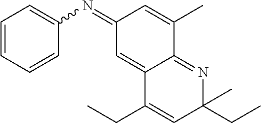 [SMILES: CCC1=CC(C)(CC)N=C2C(C)=CC(=Nc3ccccc3)C=C12] |
| 42-D | 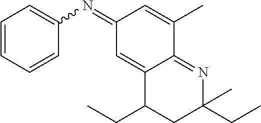 [SMILES: CCC1CC(C)(CC)N=C2C(C)=CC(=Nc3ccccc3)C=C21] |
| 43-D | 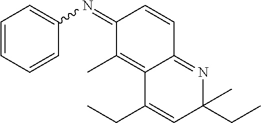 [SMILES: CCC1=CC(C)(CC)N=C2C=CC(=Nc3ccccc3)C(C)=C12] |
| 44-D | 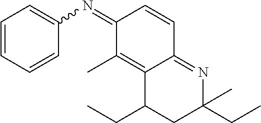 [SMILES: CCC1CC(C)(CC)N=C2C=CC(=Nc3ccccc3)C(C)=C21] |
| 45-D | 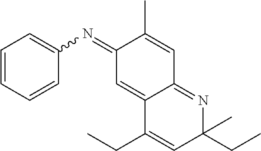 [SMILES: CCC1=CC(C)(CC)N=C2C=C(C)C(=Nc3ccccc3)C=C12] |
| 46-D | 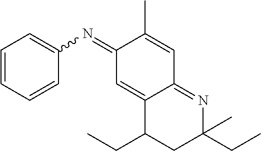 [SMILES: CCC1CC(C)(CC)N=C2C=C(C)C(=Nc3ccccc3)C=C21] |
| 47-D | 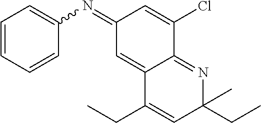 [SMILES: CCC1=CC(C)(CC)N=C2C(Cl)=CC(=Nc3ccccc3)C=C12] |
| 48-D | 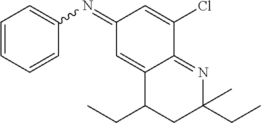 [SMILES: CCC1CC(C)(CC)N=C2C(Cl)=CC(=Nc3ccccc3)C=C21] |
| 49-D | 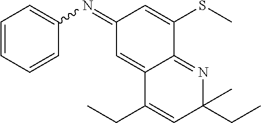 [SMILES: CCC1=CC(C)(CC)N=C2C(SC)=CC(=Nc3ccccc3)C=C12] |
| 50-D | 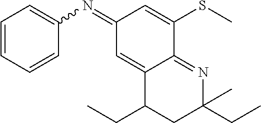 [SMILES: CCC1CC(C)(CC)N=C2C(SC)=CC(=Nc3ccccc3)C=C21] |
| 51-D | 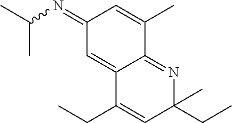 [SMILES: CCC1=CC(C)(CC)N=C2C(C)=CC(=NC(C)C)C=C12] |
| 52-D | 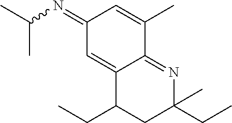 [SMILES: CCC1CC(C)(CC)N=C2C(C)=CC(=NC(C)C)C=C21] |
| 53-D | 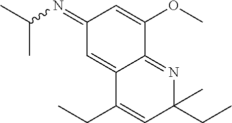 [SMILES: CCC1=CC(C)(CC)N=C2C(OC)=CC(=NC(C)C)C=C12] |
| 54-D | 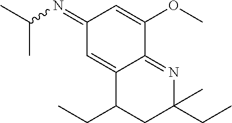 [SMILES: CCC1CC(C)(CC)N=C2C(OC)=CC(=NC(C)C)C=C21] |
| 55-D | 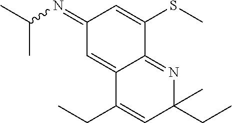 [SMILES: CCC1=CC(C)(CC)N=C2C(SC)=CC(=NC(C)C)C=C12] |
| 56-D | 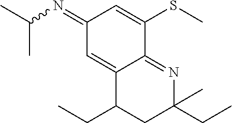 [SMILES: CCC1CC(C)(CC)N=C2C(SC)=CC(=NC(C)C)C=C21] |
| 57-D | 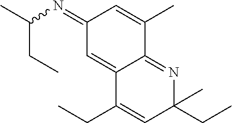 [SMILES: CCC1=CC(C)(CC)N=C2C(C)=CC(=NC(C)CC)C=C12] |
| 58-D | 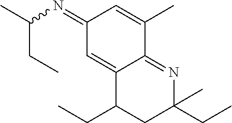 [SMILES: CCC(C)N=C1C=C(C)C2=NC(C)(CC)CC(CC)C2=C1] |
| 59-D | 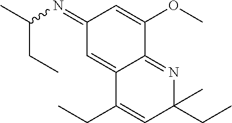 [SMILES: CCC1=CC(C)(CC)N=C2C(OC)=CC(=NC(C)CC)C=C12] |
| 60-D | 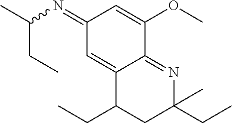 [SMILES: CCC(C)N=C1C=C(OC)C2=NC(C)(CC)CC(CC)C2=C1] |
| 61-D | 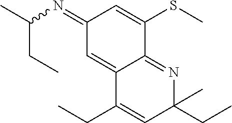 [SMILES: CCC1=CC(C)(CC)N=C2C(SC)=CC(=NC(C)CC)C=C12] |
| 62-D | 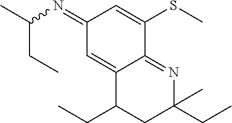 [SMILES: CCC(C)N=C1C=C(SC)C2=NC(C)(CC)CC(CC)C2=C1] |
| 63-D | 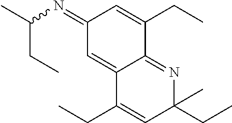 [SMILES: CCC1=CC(C)(CC)N=C2C(CC)=CC(=NC(C)CC)C=C12] |
| 64-D | 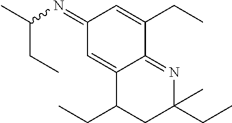 [SMILES: CCC1=CC(=NC(C)CC)C=C2C1=NC(C)(CC)CC2CC] |
| 65-D | 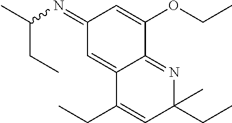 [SMILES: CCOC1=CC(=NC(C)CC)C=C2C(CC)=CC(C)(CC)N=C12] |
| 66-D | 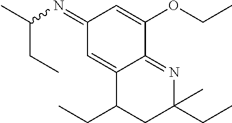 [SMILES: CCOC1=CC(=NC(C)CC)C=C2C1=NC(C)(CC)CC2CC] |
| 67-D | 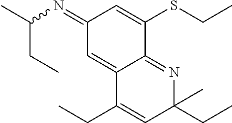 [SMILES: CCSC1=CC(=NC(C)CC)C=C2C(CC)=CC(C)(CC)N=C12] |
| 68-D | 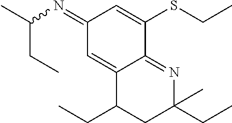 [SMILES: CCSC1=CC(=NC(C)CC)C=C2C1=NC(C)(CC)CC2CC] |
| 69-D | 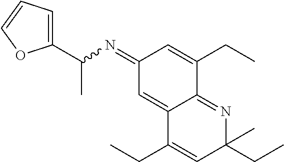 [SMILES: CCC1=CC(C)(CC)N=C2C(CC)=CC(=NC(C)c3ccco3)C=C12] |
| 70-D | 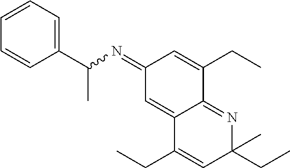 [SMILES: CCC1=CC(C)(CC)N=C2C(CC)=CC(=NC(C)c3ccccc3)C=C12] |
| 71-D | 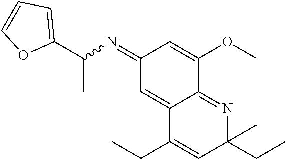 [SMILES: CCC1=CC(C)(CC)N=C2C(OC)=CC(=NC(C)c3ccco3)C=C12] |
| 72-D | 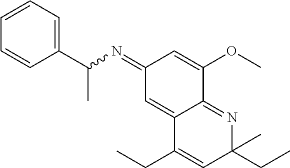 [SMILES: CCC1=CC(C)(CC)N=C2C(OC)=CC(=NC(C)c3ccccc3)C=C12] |
| 73-D | 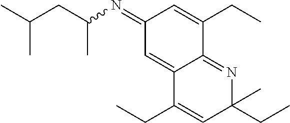 [SMILES: CCC1=CC(C)(CC)N=C2C(CC)=CC(=NC(C)CC(C)C)C=C12] |
| 74-D | 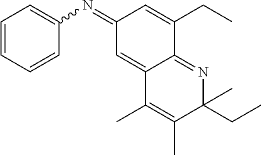 [SMILES: CCC1=CC(=Nc2ccccc2)C=C2C1=NC(C)(CC)C(C)=C2C] |
| 75-D | 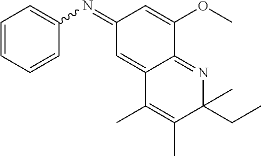 [SMILES: CCC1(C)N=C2C(OC)=CC(=Nc3ccccc3)C=C2C(C)=C1C] |
| 76-D | 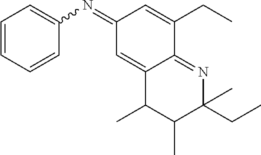 [SMILES: CCC1=CC(=Nc2ccccc2)C=C2C1=NC(C)(CC)C(C)C2C] |
| 77-D | 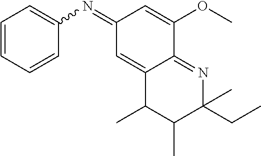 [SMILES: CCC1(C)N=C2C(OC)=CC(=Nc3ccccc3)C=C2C(C)C1C] |
| 78-D | 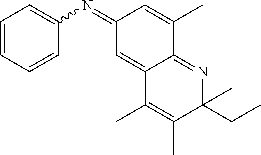 [SMILES: CCC1(C)N=C2C(C)=CC(=Nc3ccccc3)C=C2C(C)=C1C] |
| 79-D | 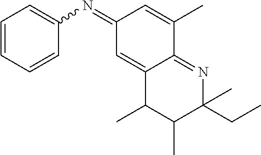 [SMILES: CCC1(C)N=C2C(C)=CC(=Nc3ccccc3)C=C2C(C)C1C] |
| 80-D | 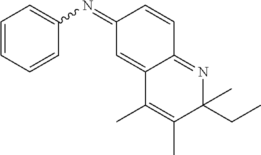 [SMILES: CCC1(C)N=C2C=CC(=Nc3ccccc3)C=C2C(C)=C1C] |
| 81-D | 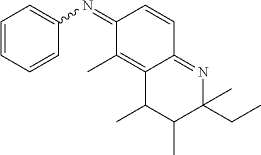 [SMILES: CCC1(C)N=C2C=CC(=Nc3ccccc3)C(C)=C2C(C)C1C] |
| 82-D | 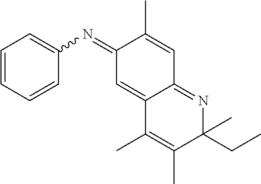 [SMILES: CCC1(C)N=C2C=C(C)C(=Nc3ccccc3)C=C2C(C)=C1C] |
| 83-D | 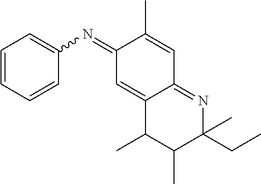 [SMILES: CCC1(C)N=C2C=C(C)C(=Nc3ccccc3)C=C2C(C)C1C] |
| 84-D | 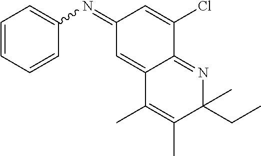 [SMILES: CCC1(C)N=C2C(Cl)=CC(=Nc3ccccc3)C=C2C(C)=C1C] |
| 85-D | 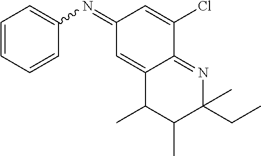 [SMILES: CCC1(C)N=C2C(Cl)=CC(=Nc3ccccc3)C=C2C(C)C1C] |
| 86-D | 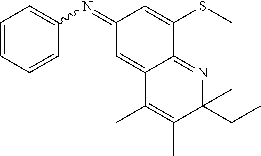 [SMILES: CCC1(C)N=C2C(SC)=CC(=Nc3ccccc3)C=C2C(C)=C1C] |
| 87-D | 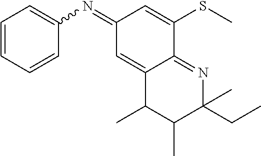 [SMILES: CCC1(C)N=C2C(SC)=CC(=Nc3ccccc3)C=C2C(C)C1C] |
| 88-D | 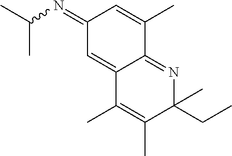 [SMILES: CCC1(C)N=C2C(C)=CC(=NC(C)C)C=C2C(C)=C1C] |
| 89-D | 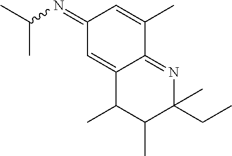 [SMILES: CCC1(C)N=C2C(C)=CC(=NC(C)C)C=C2C(C)C1C] |
| 90-D | 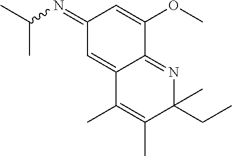 [SMILES: CCC1(C)N=C2C(OC)=CC(=NC(C)C)C=C2C(C)=C1C] |
| 91-D | 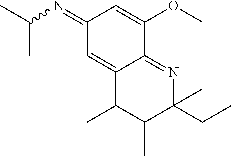 [SMILES: CCC1(C)N=C2C(OC)=CC(=NC(C)C)C=C2C(C)C1C] |
| 92-D | 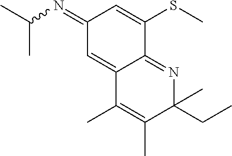 [SMILES: CCC1(C)N=C2C(SC)=CC(=NC(C)C)C=C2C(C)=C1C] |
| 93-D | 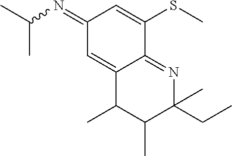 [SMILES: CCC1(C)N=C2C(SC)=CC(=NC(C)C)C=C2C(C)C1C] |
| 94-D | 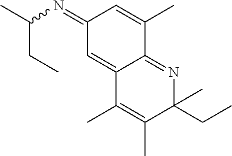 [SMILES: CCC(C)N=C1C=C(C)C2=NC(C)(CC)C(C)=C(C)C2=C1] |
| 95-D | 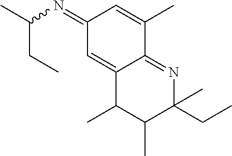 [SMILES: CCC(C)N=C1C=C(C)C2=NC(C)(CC)C(C)C(C)C2=C1] |
| 96-D | 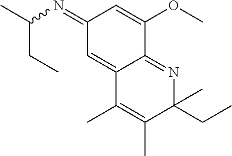 [SMILES: CCC(C)N=C1C=C(OC)C2=NC(C)(CC)C(C)=C(C)C2=C1] |
| 97-D | 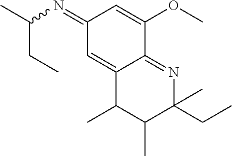 [SMILES: CCC(C)N=C1C=C(OC)C2=NC(C)(CC)C(C)C(C)C2=C1] |
| 98-D | 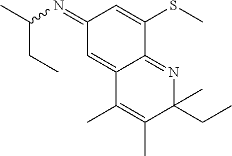 [SMILES: CCC(C)N=C1C=C(SC)C2=NC(C)(CC)C(C)=C(C)C2=C1] |
| 99-D | 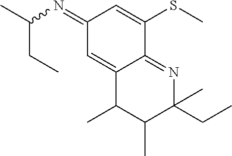 [SMILES: CCC(C)N=C1C=C(SC)C2=NC(C)(CC)C(C)C(C)C2=C1] |
| 100-D | 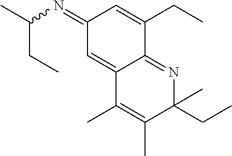 [SMILES: CCC1=CC(=NC(C)CC)C=C2C1=NC(C)(CC)C(C)=C2C] |
| 101-D | 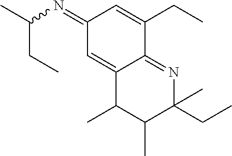 [SMILES: CCC1=CC(=NC(C)CC)C=C2C1=NC(C)(CC)C(C)C2C] |
| 102-D | 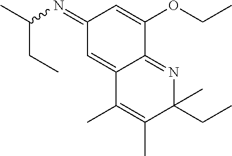 [SMILES: CCOC1=CC(=NC(C)CC)C=C2C1=NC(C)(CC)C(C)=C2C] |
| 103-D | 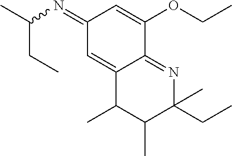 [SMILES: CCOC1=CC(=NC(C)CC)C=C2C1=NC(C)(CC)C(C)C2C] |
| 104-D | 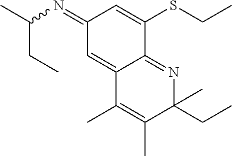 [SMILES: CCSC1=CC(=NC(C)CC)C=C2C1=NC(C)(CC)C(C)=C2C] |
| 105-D | 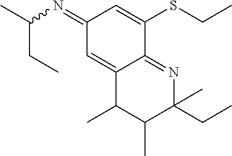 [SMILES: CCSC1=CC(=NC(C)CC)C=C2C1=NC(C)(CC)C(C)C2C] |
| 106-D | 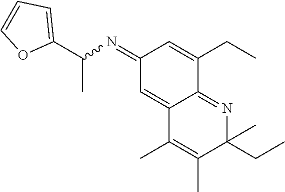 [SMILES: CCC1=CC(=NC(C)c2ccco2)C=C2C1=NC(C)(CC)C(C)=C2C] |
| 107-D | 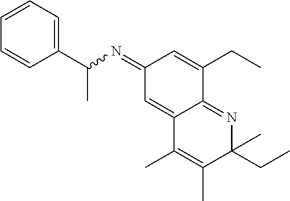 [SMILES: CCC1=CC(=NC(C)c2ccccc2)C=C2C1=NC(C)(CC)C(C)=C2C] |
| 108-D | 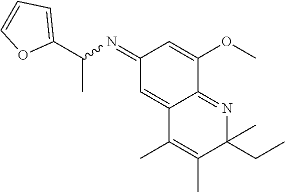 [SMILES: CCC1(C)N=C2C(OC)=CC(=NC(C)c3ccco3)C=C2C(C)=C1C] |
| 109-D | 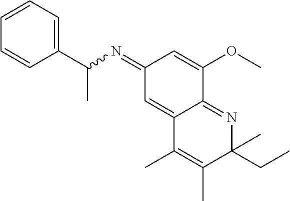 [SMILES: CCC1(C)N=C2C(OC)=CC(=NC(C)c3ccccc3)C=C2C(C)=C1C] |
| 110-D | 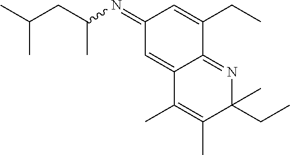 [SMILES: CCC1=CC(=NC(C)CC(C)C)C=C2C1=NC(C)(CC)C(C)=C2C] |
| 111-D | 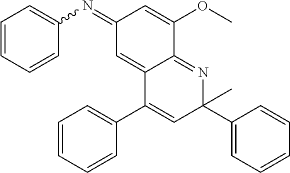 [SMILES: COC1=CC(=Nc2ccccc2)C=C2C(c3ccccc3)=CC(C)(c3ccccc3)N=C12] |
| 112-D | 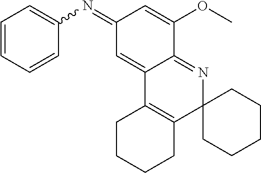 [SMILES: COC1=CC(=Nc2ccccc2)C=C2C1=NC1(CCCCC1)C1=C2CCCC1] |
| 113-D | 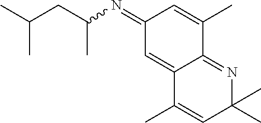 [SMILES: CC1=CC(C)(C)N=C2C(C)=CC(=NC(C)CC(C)C)C=C12] |
| 114-D | 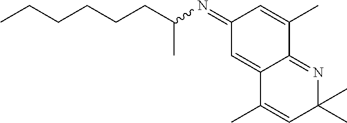 [SMILES: CCCCCCC(C)N=C1C=C(C)C2=NC(C)(C)C=C(C)C2=C1] |
| 115-D | 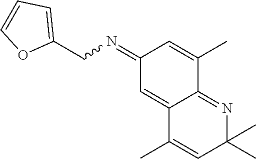 [SMILES: CC1=CC(C)(C)N=C2C(C)=CC(=NCc3ccco3)C=C12] |
| 116-D | 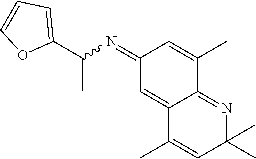 [SMILES: CC1=CC(C)(C)N=C2C(C)=CC(=NC(C)c3ccco3)C=C12] |
| 117-D | 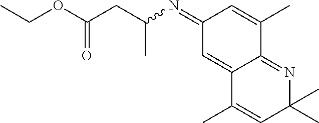 [SMILES: CCOC(=O)CC(C)N=C1C=C(C)C2=NC(C)(C)C=C(C)C2=C1] |
| 118-D | 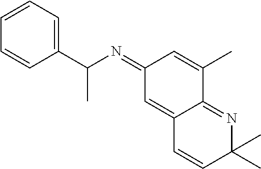 [SMILES: CC1=C/C(=N/C(C)c2ccccc2)C=C2C=CC(C)(C)N=C12] |
| 119-D | 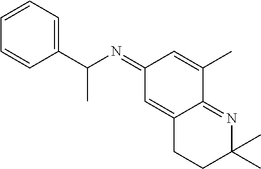 [SMILES: CC1=C/C(=N/C(C)c2ccccc2)C=C2CCC(C)(C)N=C12] |
| 120-D | 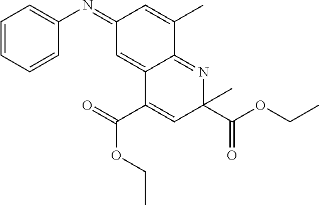 [SMILES: CCOC(=O)C1=CC(C)(C(=O)OCC)N=C2C(C)=C/C(=N/c3ccccc3)C=C12] |
| 121-D | 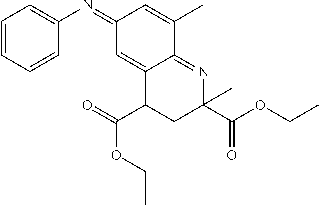 [SMILES: CCOC(=O)C1CC(C)(C(=O)OCC)N=C2C(C)=C/C(=N/c3ccccc3)C=C21] |
| 122-D | 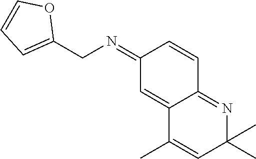 [SMILES: CC1=CC(C)(C)N=C2C=C/C(=N/Cc3ccco3)C=C12] |
| 123-D | 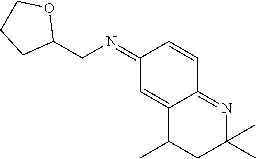 [SMILES: CC1CC(C)(C)N=C2C=C/C(=N/CC3CCCO3)C=C21] |
| 124-D | 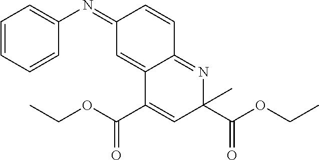 [SMILES: CCOC(=O)C1=CC(C)(C(=O)OCC)N=C2C=C/C(=N/c3ccccc3)C=C12] |
| 125-D | 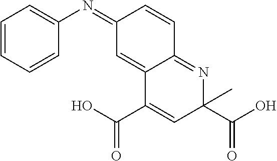 [SMILES: CC1(C(=O)O)C=C(C(=O)O)C2=C/C(=N\c3ccccc3)C=CC2=N1] |
| 126-D | 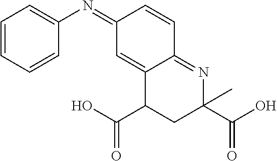 [SMILES: CC1(C(=O)O)CC(C(=O)O)C2=C/C(=N\c3ccccc3)C=CC2=N1] |
| 127-D | 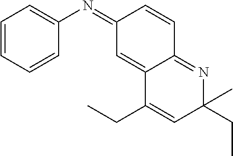 [SMILES: CCC1=CC(C)(CC)N=C2C=C/C(=N/c3ccccc3)C=C12] |
| 128-D | 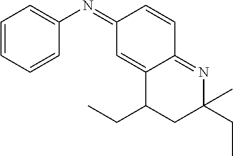 [SMILES: CCC1CC(C)(CC)N=C2C=C/C(=N/c3ccccc3)C=C21] |
| 129-D | 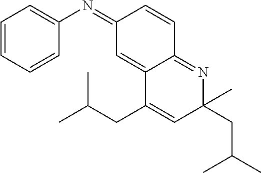 [SMILES: CC(C)CC1=CC(C)(CC(C)C)N=C2C=C/C(=N/c3ccccc3)C=C12] |
| 130-D | 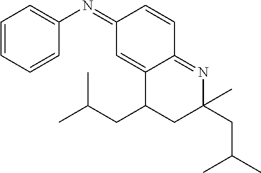 [SMILES: CC(C)CC1CC(C)(CC(C)C)N=C2C=C/C(=N/c3ccccc3)C=C21] |
| 131-D | 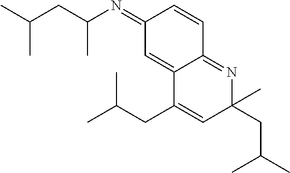 [SMILES: CC(C)CC1=CC(C)(CC(C)C)N=C2C=C/C(=N/C(C)CC(C)C)C=C12] |
| 132-D | 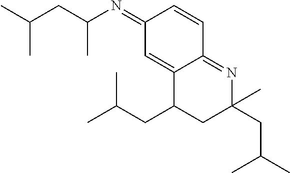 [SMILES: CC(C)CC(C)/N=C1/C=CC2=NC(C)(CC(C)C)CC(CC(C)C)C2=C1] |
| 133-D | 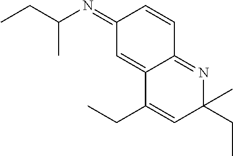 [SMILES: CCC1=CC(C)(CC)N=C2C=C/C(=N/C(C)CC)C=C12] |
| 134-D | 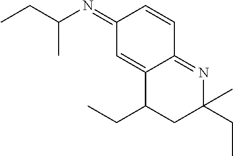 [SMILES: CCC(C)/N=C1/C=CC2=NC(C)(CC)CC(CC)C2=C1] |
| 135-D | 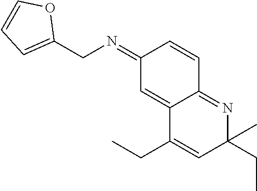 [SMILES: CCC1=CC(C)(CC)N=C2C=C/C(=N/Cc3ccco3)C=C12] |
| 136-D | 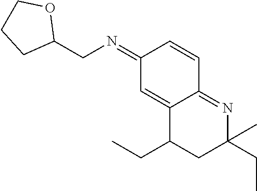 [SMILES: CCC1CC(C)(CC)N=C2C=C/C(=N/CC3CCCO3)C=C21] |
| 137-D | 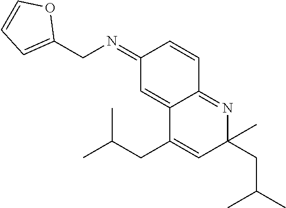 [SMILES: CC(C)CC1=CC(C)(CC(C)C)N=C2C=C/C(=N/Cc3ccco3)C=C12] |
| 138-D | 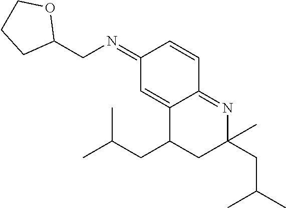 [SMILES: CC(C)CC1CC(C)(CC(C)C)N=C2C=C/C(=N/CC3CCCO3)C=C21] |

Compounds having Formula (I-D) can be prepared by dehydrogenation of the corresponding quinolineamine as shown in Scheme 1-D. The dehydrogenation can be carried out using any method known in the art, i.e. treatment with an oxidant such as sodium hypochlorite, O₂, H₂O₂ or the like in a solvent such as hexane, heptane, acetonitrile or the like, and optionally using a catalyst such as tetrabutylammonium bromide or the like.

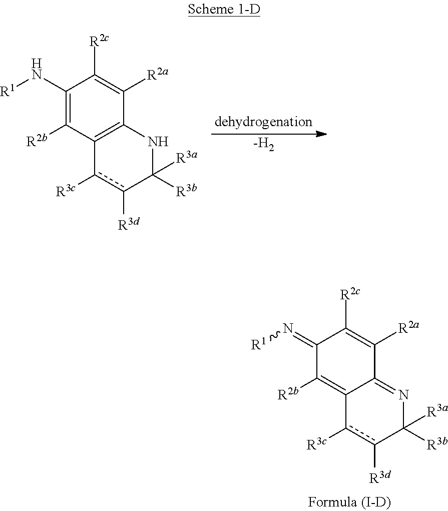

In some embodiments, Compounds of the Disclosure are compound described in U.S. Provisional Appl. No. 63/493,653, which is fully incorporated by reference herein in its entirety.

In some embodiments, Compounds of the Disclosure are compounds having Formula (I-E):

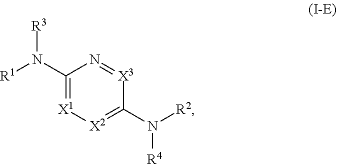

or a salt, solvate, or stereoisomer thereof, wherein:
X¹, X², and X³ are each independently selected from the group consisting of —CR— and —N—;
R is at each occurrence independently selected from the group consisting of hydrogen, C₁-C₉ alkyl, C₁-C₉ alkoxy, and C₁-C₉ alkylthio;
R¹ is selected from the group consisting of C₁-C₁₂ alkyl, —CHR^{1a}R^{1b}, C₃-C₆ cycloalkyl, optionally substituted phenyl, and optionally substituted 5- or 6-membered heteroaryl;
R^{1a} is selected from the group consisting of optionally substituted phenyl, C₃-C₆ cycloalkyl, and optionally substituted 5- or 6-membered heteroaryl;
R^{1b} is independently selected from the group consisting of hydrogen and C₁-C₆ alkyl;
R² is selected from the group consisting of C₁-C₁₂ alkyl, —CHR^{2a}R^{2b}, C₃-C₆ cycloalkyl, optionally substituted phenyl, and optionally substituted 5- or 6-membered heteroaryl;
R^{2a} is selected from the group consisting of optionally substituted phenyl, C₃-C₆ cycloalkyl, and optionally substituted 5- or 6-membered heteroaryl;
R^{2b} is independently selected from the group consisting of hydrogen and C₁-C₆ alkyl; and
R³ and R⁴ are each independently selected from the group consisting of hydrogen, methyl, ethyl, n-propyl, iso-propyl, n-butyl, iso-butyl, sec-butyl, and tert-butyl.

In some embodiments, Compounds of the Disclosure are compounds having Formula (I-E), with provisos that:
(i) if R¹ and R³ are both methyl, both n-propyl, or both iso-propyl, R² is not optionally substituted phenyl, or
(ii) if R² and R⁴ are both methyl, both n-propyl, or both iso-propyl, R¹ is not optionally substituted phenyl, or
(iii) if X¹ and X² are —CH—, X³ is —N—, R¹ is iso-propyl, and R³ and R⁴ are hydrogen, R² is not phenyl, or
(iv) if X¹ and X² are —CH—, X³ is —N—, R¹ is 4-(dimethylamino)phenyl, and R³ and R⁴ are hydrogen, R² is not 4-(dimethylamino)phenyl.

In some embodiments, Compounds of the Disclosure are compounds having Formula (I-E), wherein R³ and R⁴ are independently selected from the group consisting of hydrogen and methyl.

In some embodiments, Compounds of the Disclosure are compounds having Formula (II-E):

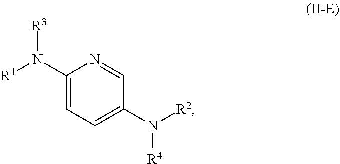

wherein R¹, R², R³, and R⁴ are as defined in connection with Formula (I-E), with provisos that (i) if R¹ and R³ are both methyl, both n-propyl, or both iso-propyl, R² is not optionally substituted phenyl; or (ii) if R² and R⁴ are both methyl, both n-propyl, or both iso-propyl, R¹ is not optionally substituted phenyl.

In some embodiments, Compounds of the Disclosure are compounds having Formula (III-E):

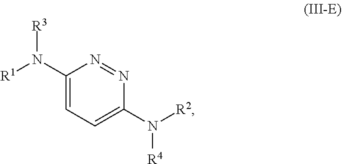

wherein R¹, R², R³, and R⁴ are as defined in connection with Formula (I-E), with provisos that (i) if R¹ and R³ are both methyl, both n-propyl, or both iso-propyl, R² is not optionally substituted phenyl; or (ii) if R² and R⁴ are both methyl, both n-propyl, or both iso-propyl, R¹ is not optionally substituted phenyl (iii) if R¹ is iso-propyl, and R³ and R⁴ are hydrogen, R² is not phenyl, or (iv) if R¹ is 4-(dimethylamino)phenyl, and R³ and R⁴ are hydrogen, R² is not 4-(dimethylamino)phenyl.

In some embodiments, Compounds of the Disclosure are compounds having Formula (IV-E):

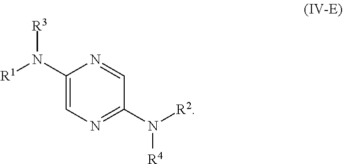

wherein R¹, R², R³, and R⁴ are as defined in connection with Formula (I-E), with provisos that (i) if R¹ and R³ are both methyl, both n-propyl, or both iso-propyl, R² is not optionally substituted phenyl; or (ii) if R² and R⁴ are both methyl, both n-propyl, or both iso-propyl, R¹ is not optionally substituted phenyl.

In some embodiments, Compounds of the Disclosure are compounds having Formula (V-E):

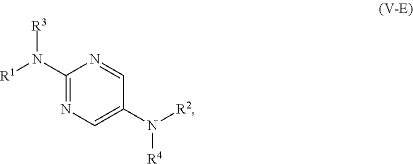

wherein R¹, R², R³, and R⁴ are as defined in connection with Formula (I-E), with provisos that (i) if R¹ and R³ are both methyl, both n-propyl, or both iso-propyl, R² is not optionally substituted phenyl; or (ii) if R² and R⁴ are both methyl, both n-propyl, or both iso-propyl, R¹ is not optionally substituted phenyl.

In some embodiments, Compounds of the Disclosure are compounds having Formula (VI-E):

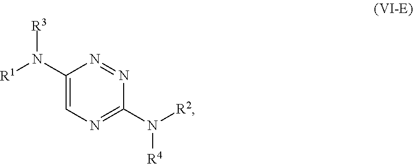

wherein R¹, R², R³, and R⁴ are as defined in connection with Formula (I-E), with provisos that (i) if R¹ and R³ are both methyl, both n-propyl, or both iso-propyl, R² is not optionally substituted phenyl; or (ii) if R² and R⁴ are both methyl, both n-propyl, or both iso-propyl, R¹ is not optionally substituted phenyl.

In some embodiments, Compounds of the Disclosure are compounds having Formula (VII-E):

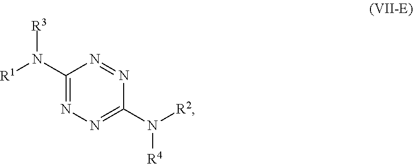

wherein R¹, R², R³, and R⁴ are as defined in connection with Formula (I-E) with provisos that (i) if R¹ and R³ are both methyl, both n-propyl, or both iso-propyl, R² is not optionally substituted phenyl; or (ii) if R² and R⁴ are both methyl, both n-propyl, or both iso-propyl, R¹ is not optionally substituted phenyl.

In some embodiments, Compounds of the Disclosure are compounds of any one of Formulae (I-E)-(VII-E), wherein R³ is hydrogen.

In some embodiments, Compounds of the Disclosure are compounds of any one of Formulae (I-E)-(VII-E), wherein R⁴ is hydrogen.

In some embodiments, Compounds of the Disclosure are compounds of any one of Formulae (I-E)-(VII-E), wherein R³ and R⁴ are hydrogen.

In some embodiments, Compounds of the Disclosure are compounds of any one of Formulae (I-E)-(VII-E), wherein R¹ is C₁-C₁₂ alkyl.

In some embodiments, Compounds of the Disclosure are compounds of any one of Formulae (I-E)-(VII-E), wherein R¹ is methyl, ethyl, propyl, iso-propyl, n-butyl, sec-butyl, iso-butyl, tert-butyl, pentyl, hexyl, heptyl, octyl, or nonyl.

In some embodiments, Compounds of the Disclosure are compounds of any one of Formulae (I-E)-(VII-E), wherein R¹ is iso-propyl.

In some embodiments, Compounds of the Disclosure are compounds of any one of Formulae (I-E)-(VII-E), wherein R¹ is:

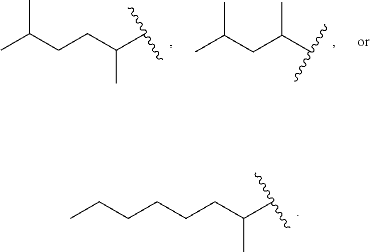

In some embodiments, Compounds of the Disclosure are compounds of any one of Formulae (I-E)-(VII-E), wherein R¹ is optionally substituted phenyl.

In some embodiments, Compounds of the Disclosure are compounds of any one of Formulae (I-E)-(VII-E), wherein R¹ is —CHR^{1a}R^{1b}.

In some embodiments, Compounds of the Disclosure are compounds of any one of Formulae (I-E)-(VII-E), wherein:
R^{1a} is selected from the group consisting of:

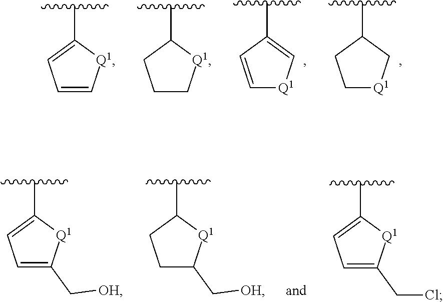

Q¹ is —NH—, —O—, or —S—; and
R^{1b} is hydrogen.

In some embodiments, Compounds of the Disclosure are compounds of any one of Formulae (I-E)-(VII-E), wherein Q¹ is —O—.

In some embodiments, Compounds of the Disclosure are compounds of any one of Formulae (I-E)-(VII-E), wherein R² is C₁-C₁₂ alkyl.

In some embodiments, Compounds of the Disclosure are compounds of any one of Formulae (I-E)-(VII-E), wherein R² is methyl, ethyl, propyl, iso-propyl, n-butyl, sec-butyl, iso-butyl, tert-butyl, pentyl, hexyl, heptyl, octyl, or nonyl.

In some embodiments, Compounds of the Disclosure are compounds of any one of Formulae (I-E)-(VII-E), wherein R² is iso-propyl.

In some embodiments, Compounds of the Disclosure are compounds of any one of Formulae (I-E)-(VII-E), wherein R² is:

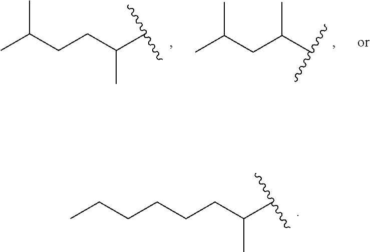

In some embodiments, Compounds of the Disclosure are compounds of any one of Formulae (I-E)-(VII-E), wherein R² is optionally substituted phenyl.

In some embodiments, Compounds of the Disclosure are compounds of any one of Formulae (I-E)-(VII-E), wherein R² is —CHR^{2a}R^{2b}.

In some embodiments, Compounds of the Disclosure are compounds of any one of Formulae (I-E)-(VII-E), wherein:
R^{2a} is selected from the group consisting of:

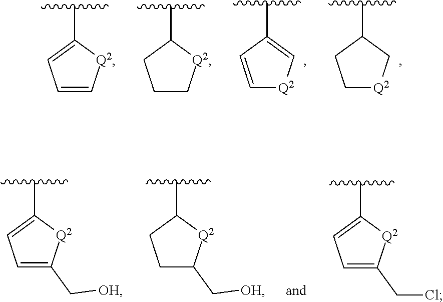

Q² is —NH—, —O—, or —S—; and
R^{2b} is hydrogen.

In some embodiments, Compounds of the Disclosure are compounds of any one of Formulae (I-E)-(VII-E), wherein Q² is —O—.

In some embodiments, Compounds of the Disclosure are compounds of any one of Formulae (I-E)-(VII-E), wherein R¹ and R² are the same.

In some embodiments, Compounds of the Disclosure are compounds of any one of Formulae (I-E)-(VII-E), wherein R¹ and R² are not the same.

In some embodiments, Compounds of the Disclosure are any one or more of the compounds of Table E, or a salt or solvate thereof.

TABLE E

| Compound | |
|---|---|
| No. | Structure |
| 1-E | 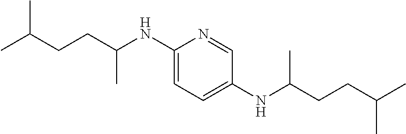 [SMILES: CC(C)CCC(C)Nc1ccc(NC(C)CCC(C)C)nc1] |
| 2-E | 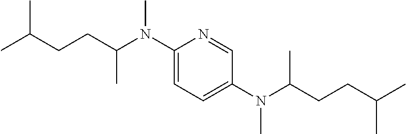 [SMILES: CC(C)CCC(C)N(C)c1ccc(N(C)C(C)CCC(C)C)nc1] |
| 3-E | 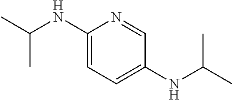 |
| 4-E | 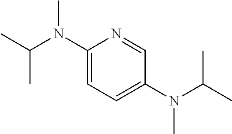 [SMILES: CC(C)N(C)c1ccc(N(C)C(C)C)nc1] |
| 5-E | 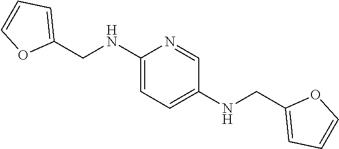 [SMILES: c1coc(CNc2ccc(NCc3ccco3)nc2)c1] |
| 6-E | 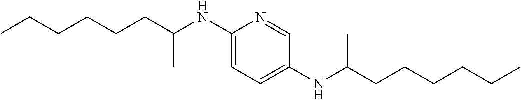 [SMILES: CCCCCCC(C)Nc1ccc(NC(C)CCCCCC)nc1] |
| 7-E | 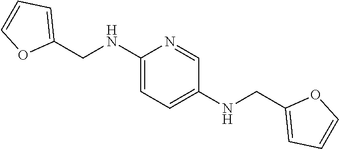 [SMILES: c1coc(CNc2ccc(NCc3ccco3)nc2)c1] |
| 8-E | 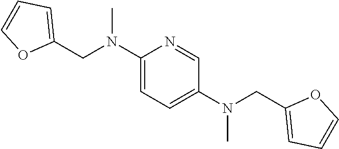 [SMILES: CN(Cc1ccco1)c1ccc(N(C)Cc2ccco2)nc1] |
| 9-E | 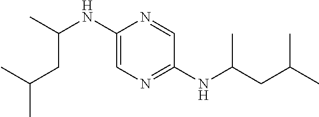 [SMILES: CC(C)CC(C)Nc1cnc(NC(C)CC(C)C)cn1] |
| 10-E | 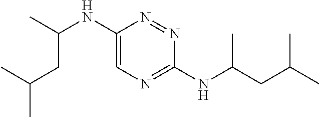 [SMILES: CC(C)CC(C)Nc1cnc(NC(C)CC(C)C)nn1] |
| 11-E | 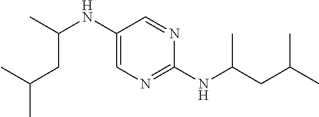 [SMILES: CC(C)CC(C)Nc1cnc(NC(C)CC(C)C)nc1] |
| 12-E | 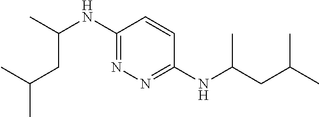 [SMILES: CC(C)CC(C)Nc1ccc(NC(C)CC(C)C)nn1] |
| 13-E | 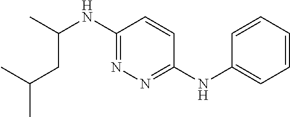 [SMILES: CC(C)CC(C)Nc1ccc(Nc2ccccc2)nn1] |
| 14-E | 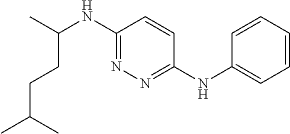 [SMILES: CC(C)CCC(C)Nc1ccc(Nc2ccccc2)nn1] |
| 15-E | 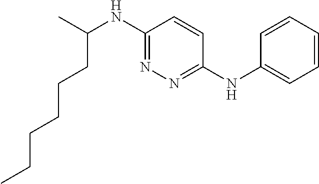 [SMILES: CCCCCCC(C)Nc1ccc(Nc2ccccc2)nn1] |
| 16-E | 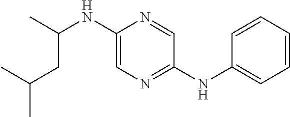 [SMILES: CC(C)CC(C)Nc1cnc(Nc2ccccc2)cn1] |
| 17-E | 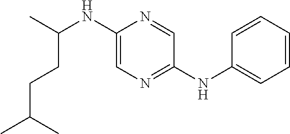 [SMILES: CC(C)CCC(C)Nc1cnc(Nc2ccccc2)cn1] |
| 18-E | 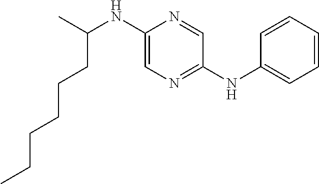 [SMILES: CCCCCCC(C)Nc1cnc(Nc2ccccc2)cn1] |
| 19-E | 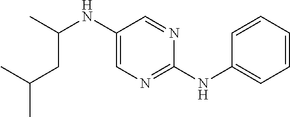 [SMILES: CC(C)CC(C)Nc1cnc(Nc2ccccc2)nc1] |
| 20-E | 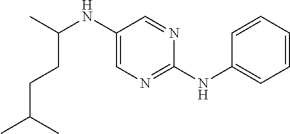 [SMILES: CC(C)CCC(C)Nc1cnc(Nc2ccccc2)nc1] |
| 21-E | 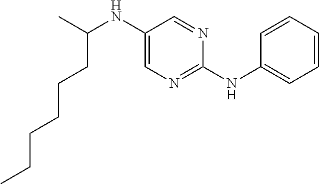 [SMILES: CCCCCCC(C)Nc1cnc(Nc2ccccc2)nc1] |
| 22-E | 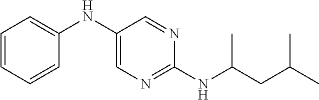 [SMILES: CC(C)CC(C)Nc1ncc(Nc2ccccc2)cn1] |
| 23-E | 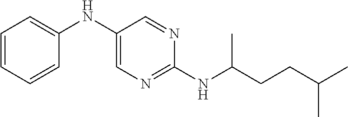 [SMILES: CC(C)CCC(C)Nc1ncc(Nc2ccccc2)cn1] |
| 24-E | 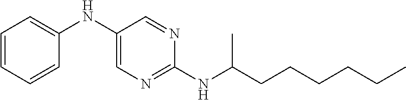 [SMILES: CCCCCCC(C)Nc1ncc(Nc2ccccc2)cn1] |
| 25-E | 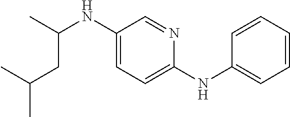 [SMILES: CC(C)CC(C)Nc1ccc(Nc2ccccc2)nc1] |
| 26-E | 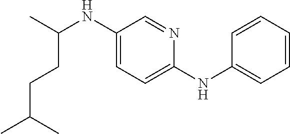 [SMILES: CC(C)CCC(C)Nc1ccc(Nc2ccccc2)nc1] |
| 27-E | 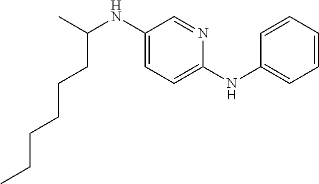 [SMILES: CCCCCCC(C)Nc1ccc(Nc2ccccc2)nc1] |
| 28-E | 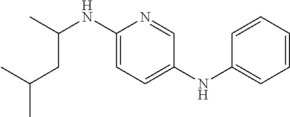 [SMILES: CC(C)CC(C)Nc1ccc(Nc2ccccc2)cn1] |
| 29-E | 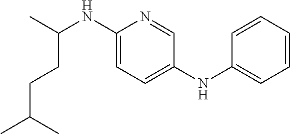 [SMILES: CC(C)CCC(C)Nc1ccc(Nc2ccccc2)cn1] |
| 30-E | 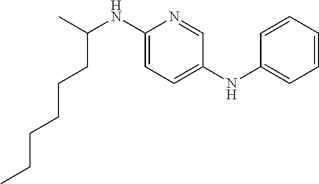 [SMILES: CCCCCCC(C)Nc1ccc(Nc2ccccc2)cn1] |
| 31-E | 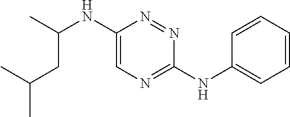 [SMILES: CC(C)CC(C)Nc1cnc(Nc2ccccc2)nn1] |
| 32-E | 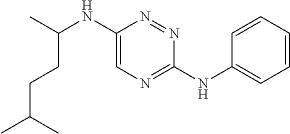 [SMILES: CC(C)CCC(C)Nc1cnc(Nc2ccccc2)nn1] |
| 33-E | 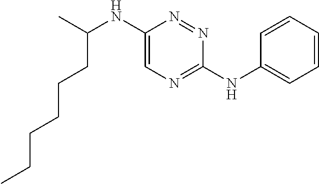 [SMILES: CCCCCCC(C)Nc1cnc(Nc2ccccc2)nn1] |
| 34-E | 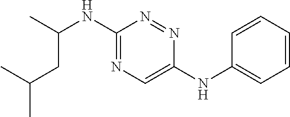 [SMILES: CC(C)CC(C)Nc1ncc(Nc2ccccc2)nn1] |
| 35-E | 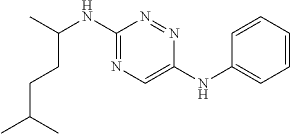 [SMILES: CC(C)CCC(C)Nc1ncc(Nc2ccccc2)nn1] |
| 36-E | 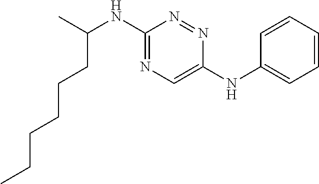 [SMILES: CCCCCCC(C)Nc1ncc(Nc2ccccc2)nn1] |
| 37-E | 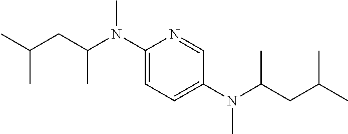 [SMILES: CC(C)CC(C)N(C)c1ccc(N(C)C(C)CC(C)C)nc1] |
| 38-E | 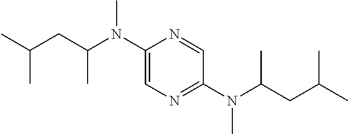 [SMILES: CC(C)CC(C)N(C)c1cnc(N(C)C(C)CC(C)C)cn1] |
| 39-E | 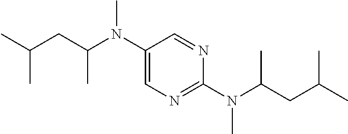 [SMILES: CC(C)CC(C)N(C)c1cnc(N(C)C(C)CC(C)C)nc1] |
| 40-E | 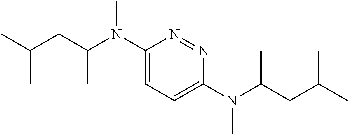 [SMILES: CC(C)CC(C)N(C)c1ccc(N(C)C(C)CC(C)C)nn1] |
| 41-E | 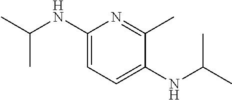 |
| 42-E | 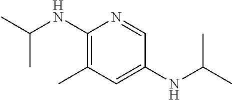 |
| 43-E | 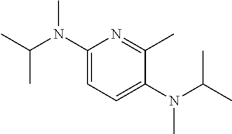 [SMILES: Cc1nc(N(C)C(C)C)ccc1N(C)C(C)C] |
| 44-E | 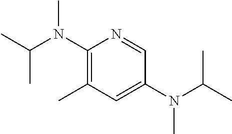 [SMILES: Cc1cc(N(C)C(C)C)cnc1N(C)C(C)C] |
| 45-E | 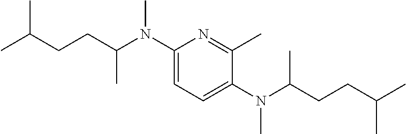 [SMILES: Cc1nc(N(C)C(C)CCC(C)C)ccc1N(C)C(C)CCC(C)C] |
| 46-E | 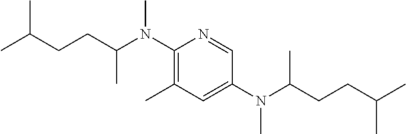 [SMILES: Cc1cc(N(C)C(C)CCC(C)C)cnc1N(C)C(C)CCC(C)C] |
| 47-E | 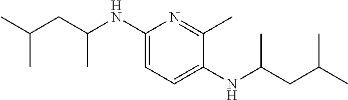 [SMILES: Cc1nc(NC(C)CC(C)C)ccc1NC(C)CC(C)C] |
| 48-E | 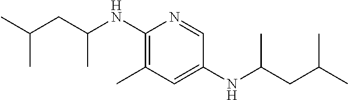 [SMILES: Cc1cc(NC(C)CC(C)C)cnc1NC(C)CC(C)C] |
| 49-E | 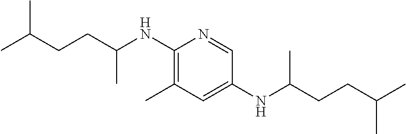 [SMILES: Cc1cc(NC(C)CCC(C)C)cnc1NC(C)CCC(C)C] |
| 50-E | 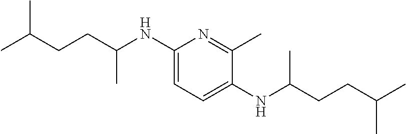 [SMILES: Cc1nc(NC(C)CCC(C)C)ccc1NC(C)CCC(C)C] |
| 51-E | 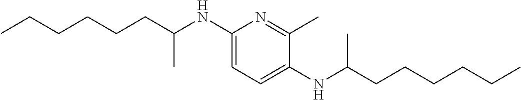 [SMILES: CCCCCCC(C)Nc1ccc(NC(C)CCCCCC)c(C)n1] |
| 52-E | 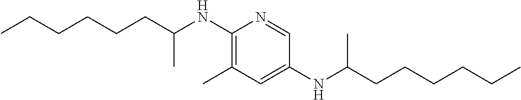 [SMILES: CCCCCCC(C)Nc1cnc(NC(C)CCCCCC)c(C)c1] |
| 53-E | 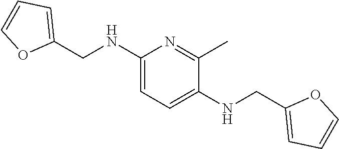 [SMILES: Cc1nc(NCc2ccco2)ccc1NCc1ccco1] |
| 54-E | 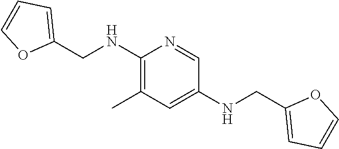 [SMILES: Cc1cc(NCc2ccco2)cnc1NCc1ccco1] |
| 55-E | 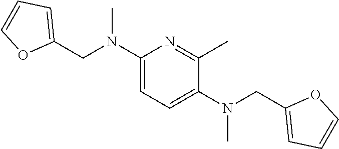 [SMILES: Cc1nc(N(C)Cc2ccco2)ccc1N(C)Cc1ccco1] |
| 56-E | 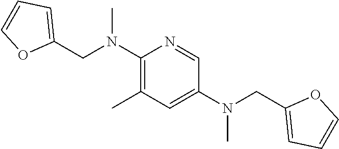 [SMILES: Cc1cc(N(C)Cc2ccco2)cnc1N(C)Cc1ccco1] |
| 57-E | 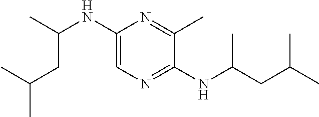 [SMILES: Cc1nc(NC(C)CC(C)C)cnc1NC(C)CC(C)C] |
| 58-E | 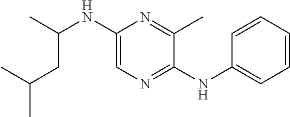 [SMILES: Cc1nc(NC(C)CC(C)C)cnc1Nc1ccccc1] |
| 59-E | 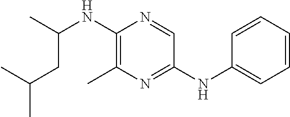 [SMILES: Cc1nc(Nc2ccccc2)cnc1NC(C)CC(C)C] |
| 60-E | 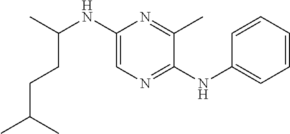 [SMILES: Cc1nc(NC(C)CCC(C)C)cnc1Nc1ccccc1] |
| 61-E | 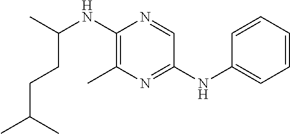 [SMILES: Cc1nc(Nc2ccccc2)cnc1NC(C)CCC(C)C] |
| 62-E | 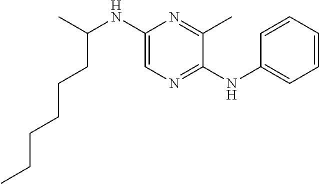 [SMILES: CCCCCCC(C)Nc1cnc(Nc2ccccc2)c(C)n1] |
| 63-E | 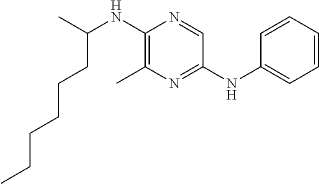 [SMILES: CCCCCCC(C)Nc1ncc(Nc2ccccc2)nc1C] |
| 64-E | 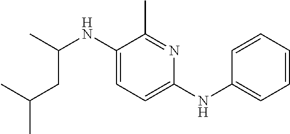 [SMILES: Cc1nc(Nc2ccccc2)ccc1NC(C)CC(C)C] |
| 65-E | 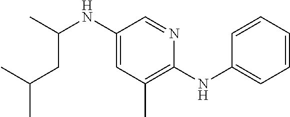 [SMILES: Cc1cc(NC(C)CC(C)C)cnc1Nc1ccccc1] |
| 66-E | 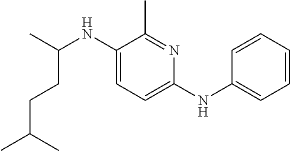 [SMILES: Cc1nc(Nc2ccccc2)ccc1NC(C)CCC(C)C] |
| 67-E | 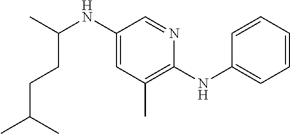 [SMILES: Cc1cc(NC(C)CCC(C)C)cnc1Nc1ccccc1] |
| 68-E | 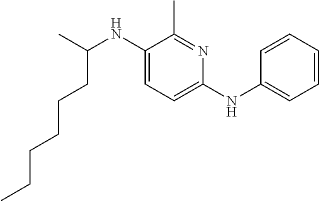 [SMILES: CCCCCCC(C)Nc1ccc(Nc2ccccc2)nc1C] |
| 69-E | 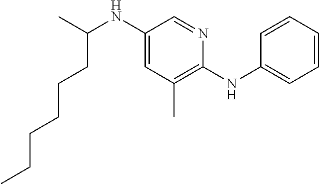 [SMILES: CCCCCCC(C)Nc1cnc(Nc2ccccc2)c(C)c1] |
| 70-E | 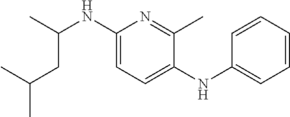 [SMILES: Cc1nc(NC(C)CC(C)C)ccc1Nc1ccccc1] |
| 71-E | 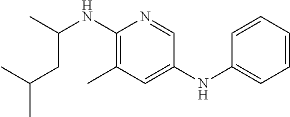 [SMILES: Cc1cc(Nc2ccccc2)cnc1NC(C)CC(C)C] |
| 72-E | 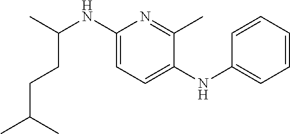 [SMILES: Cc1nc(NC(C)CCC(C)C)ccc1Nc1ccccc1] |
| 73-E | 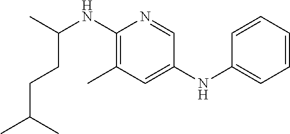 [SMILES: Cc1cc(Nc2ccccc2)cnc1NC(C)CCC(C)C] |
| 74-E | 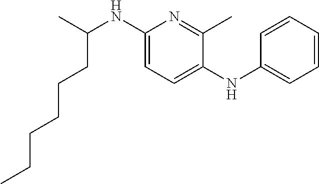 [SMILES: CCCCCCC(C)Nc1ccc(Nc2ccccc2)c(C)n1] |
| 75-E | 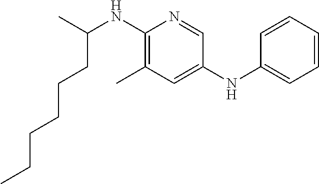 [SMILES: CCCCCCC(C)Nc1ncc(Nc2ccccc2)cc1C] |
| 76-E | 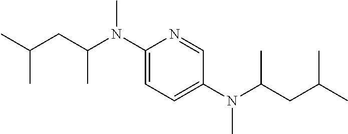 [SMILES: CC(C)CC(C)N(C)c1ccc(N(C)C(C)CC(C)C)nc1] |
| 77-E | 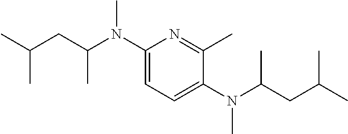 [SMILES: Cc1nc(N(C)C(C)CC(C)C)ccc1N(C)C(C)CC(C)C] |
| 78-E | 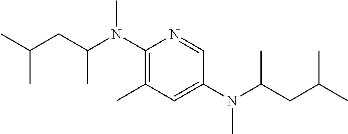 [SMILES: Cc1cc(N(C)C(C)CC(C)C)cnc1N(C)C(C)CC(C)C] |
| 79-E | 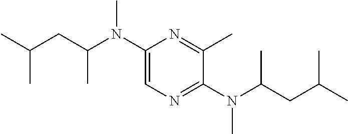 [SMILES: Cc1nc(N(C)C(C)CC(C)C)cnc1N(C)C(C)CC(C)C] |
| 80-E | 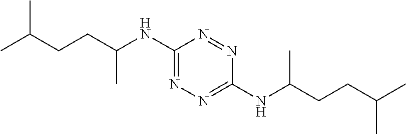 [SMILES: CC(C)CCC(C)Nc1nnc(NC(C)CCC(C)C)nn1] |
| 81-E | 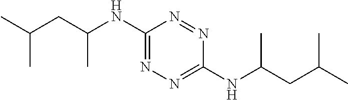 [SMILES: CC(C)CC(C)Nc1nnc(NC(C)CC(C)C)nn1] |
| 82-E | 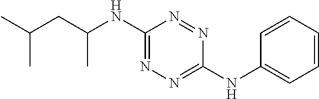 [SMILES: CC(C)CC(C)Nc1nnc(Nc2ccccc2)nn1] |

Compounds having Formula (I-E) can be prepared, for example, by reacting a diaminoheteroarene with a ketone, as shown in Scheme 1-E, wherein R^{1c} is, for example, C₁-C₁₂ alkyl, C₃-C₆ cycloalkyl, optionally substituted phenyl, or optionally substituted 5- or 6-membered heteroaryl, and R^{1d} is, for example, hydrogen or C₁-C₆ alkyl.

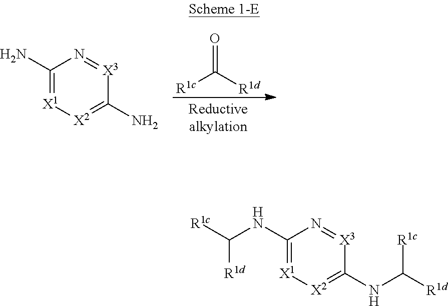

Compounds having Formula (I-E) can also be prepared, for example, starting from an appropriate dinitro- or nitroamino-heteroarene, as shown in Scheme 2-E.

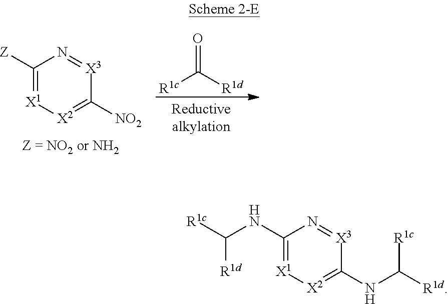

In some embodiments, Compounds of the Disclosure are compounds described in U.S. Provisional Appl. No. 63/493,650, which is fully incorporated by reference herein in its entirety.

In some embodiments, Compounds of the Disclosure are compounds having Formula (I-F):

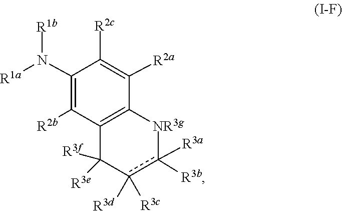

or a salt, solvate, or stereoisomer thereof, wherein:
[symbol] is a single or a double bond;
R^{1a} is selected from the group consisting of optionally substituted C₁-C₁₂ alkyl, —CHR^{1c}R^{1d}, C₃-C₆ cycloalkyl, 4- to 6-membered heterocyclyl, optionally substituted phenyl, and optionally substituted 5- or 6-membered heteroaryl;
R^{1b} is selected from the group consisting of hydrogen and C₁-C₉ alkyl;
R^{1c} is selected from the group consisting of optionally substituted phenyl, C₃-C₆ cycloalkyl, and optionally substituted 5- or 6-membered heteroaryl;
R^{1d} is selected from the group consisting of hydrogen and C₁-C₉ alkyl;
R^{2a}, R^{2b}, and R^{2c} are independently selected from the group consisting of hydrogen, halogen, C₁-C₉ alkyl, C₁-C₉ haloalkyl, C₃-C₈ cycloalkyl, C₁-C₈ alkoxy, C₁-C₈ alkylthio, C(═O)OR⁴, —OC(═O)R⁴, —C(═O)NR⁴R⁵, —NR⁴C(═O)R⁵, —NHR⁴, —NR⁴R⁵, —OH, —SH, —SC(═O)R⁴, —SC(═O)SR⁴, —SC(═O)NHR⁴, —SC(═O)NR⁴R⁵, —NHC(═O)SR⁴, —NR⁴C(═O)SR⁵, —NHC(═S)SR⁴, —NR⁴C(═S)SR⁵, 4- to 6-membered heterocyclyl, optionally substituted phenyl, and optionally substituted 5- or 6-membered heteroaryl; or
R^{2b} is selected from the group consisting of hydrogen, halogen, C₁-C₉ alkyl, C₁-C₉ haloalkyl, C₃-C₈ cycloalkyl, C₁-C₈ alkylthio, C₁-C₈ alkoxy, C(═O)OR⁴, —OC(═O)R⁴, —C(═O)NR⁴R⁵, —NR⁴C(═O)R⁵, —NHR⁴, —NR⁴R⁵, —OH, —SH, —SC(═O)R⁴, —SC(═O)SR⁴, —SC(═O)NHR⁴, —SC(═O)NR⁴R⁵, —NHC(═O)SR⁴, —NR⁴C(═O)SR⁵, —NHC(═S)SR⁴, —NR⁴C(═S)SR⁵, 4- to 6-membered heterocyclyl, optionally substituted phenyl, and optionally substituted 5- or 6-membered heteroaryl; and
R^{2a} and R^{2c} together with the two carbon atoms to which they are attached form a C₅-C₈ cycloalkyl, a 5- to 8-membered heterocyclyl, or a C₅-C₆ aryl;
R^{3a} and R^{3b} are independently selected from the group consisting of hydrogen, C₁-C₉ alkyl, C₃-C₆ cycloalkyl, and optionally substituted phenyl, with the proviso that if is a double bond, R^{3b} is absent; or
R^{3a} and R^{3b} together with the carbon atom to which they are attached form a C₃-C₁₂ cycloalkyl, with the proviso that [symbol] is a single bond;
R^{3c} and R^{3d} are independently selected from the group consisting of hydrogen, C₁-C₉ alkyl, C₃-C₆ cycloalkyl, and optionally substituted phenyl, with the proviso that if is a double bond, R^{3d} is absent; or
R^{3c} and R^{3d} together with the carbon atom to which they are attached form a C₃-C₁₂ cycloalkyl, with the proviso that [symbol] is a single bond;
R^{3e} and R^{3f} are independently selected from the group consisting of hydrogen, halogen, C₁-C₉ alkyl, C₁-C₉ haloalkyl, C₃-C₈ cycloalkyl, —OH, —SH, C₁-C₈ alkoxy, C₁-C₈alkylthio, arylthio, —C(═O)OR⁴, —OC(═O)R⁴, —C(═O)NR⁴R⁵, —NR⁴C(═O)R⁵, —NHR⁴, —NR⁴R⁵, —SC(═O)R⁴, —SC(═O)SR⁴, —SC(═O)NHR⁴, —SC(═O)NR⁴R⁵, —NHC(═O)SR⁴, —NR⁴C(═O)SR⁵, —NHC(═S)SR⁴, —NR⁴C(═S)SR⁵, 4- to 6-membered heterocyclyl, optionally substituted phenyl, and optionally substituted 5- or 6-membered heteroaryl; or
R^{3e} and R^{3f} taken together with the carbon atom to which they are attached form a C₃-C₁₂ cycloalkyl;
R^{3g} is selected from the group consisting of hydrogen and C₁-C₉ alkyl; and
R⁴ and R⁵ are at each occurrence independently selected from the group consisting of hydrogen, C₁-C₉ alkyl, C₃-C₆ cycloalkyl, and optionally substituted phenyl.

In some embodiments, Compounds of the Disclosure are compounds having Formula (I-F), with the proviso that if R^{3e} and/or R^{3f} are hydrogen, R^{3c} and R^{3d} are independently selected from the group consisting of C₁-C₉ alkyl, C₃-C₆ cycloalkyl, and optionally substituted phenyl.

In some embodiments, Compounds of the Disclosure are compounds having Formula (II-F):

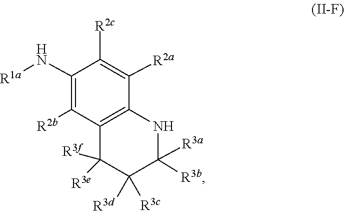

wherein R^{1a}, R^{2a}, R^{2b}, R^{2c}, R^{3a}, R^{3b}, R^{3c}, R^{3d}, R^{3e}, and R^{3f} are as defined in connection with Formula (I-F).

In some embodiments, Compounds of the Disclosure are compounds of Formula (II-F), wherein:

R^{3c} and R^{3d} are independently selected from the group consisting of C₁-C₉ alkyl, C₃-C₆ cycloalkyl, and optionally substituted phenyl; or
R^{3c} and R^{3d} together with the carbon atom to which they are attached form a C₃-C₁₂ cycloalkyl.

In some embodiments, Compounds of the Disclosure are compounds of Formula (II-F), wherein:
R^{3e} and R^{3f} are independently selected from the group consisting of halogen, C₁-C₉ alkyl, C₁-C₉ haloalkyl, C₃-C₈ cycloalkyl, —OH, —SH, C₁-C₈ alkoxy, C₁-C₈ alkylthio, arylthio, C(═O)OR⁴, —OC(═O)R⁴, —C(═O)NR⁴R⁵, —NR⁴C(═O)R⁵, —NHR⁴, —NR⁴R⁵, —SC(═O)R⁴, —SC(═O)SR⁴, —SC(═O)NHR⁴, —SC(═O)NR⁴R⁵, —NHC(═O)SR⁴, —NR⁴C(═O)SR⁵, —NHC(═S)SR⁴, —NR⁴C(═S)SR⁵, 4- to 6-membered heterocyclyl, optionally substituted phenyl, and optionally substituted 5- or 6-membered heteroaryl; or
R^{3e} and R^{3f} taken together with the carbon atom to which they are attached form a C₃-C₁₂ cycloalkyl.

In some embodiments, Compounds of the Disclosure are compounds of Formula (I-F) or Formula (II-F), wherein R^{3b} is hydrogen.

In some embodiments, Compounds of the Disclosure are compounds having Formula (III-F):

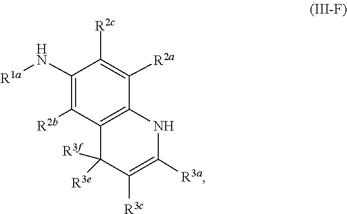

wherein R^{1a}, R^{2a}, R^{2b}, R^{2c}, R^{3a}, R^{3c}, R^{3e}, and R^{3f} are as defined in connection with Formula (I-F).

In some embodiments, Compounds of the Disclosure are compounds of any one of Formulae (I-F)-(III-F), wherein R^{1a} is optionally substituted phenyl.

In some embodiments, Compounds of the Disclosure are compounds of any one of Formulae (I-F)-(III-F), wherein R^{1a} is C₁-C₁₂ alkyl.

In some embodiments, Compounds of the Disclosure are compounds of any one of Formulae (I-F)-(III-F), wherein R^{1a} is methyl, ethyl, propyl, iso-propyl, n-butyl, sec-butyl, iso-butyl, tert-butyl, pentyl, hexyl, heptyl, octyl, or nonyl.

In some embodiments, Compounds of the Disclosure are compounds of any one of Formulae (I-F)-(III-F), wherein wherein R^{1a} is iso-propyl or sec-butyl.

In some embodiments, Compounds of the Disclosure are compounds of any one of Formulae (I-F)-(III-F), wherein wherein R^{1a} is:

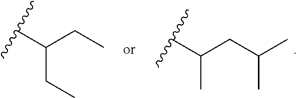

In some embodiments, Compounds of the Disclosure are compounds of any one of Formulae (I-F)-(III-F), wherein R^{2a}, R^{2b}, and R^{2c} are independently selected from the group consisting of hydrogen and C₁-C₉ alkyl.

In some embodiments, Compounds of the Disclosure are compounds of any one of Formulae (I-F)-(III-F), wherein R^{2b} and R^{2c} are hydrogen.

In some embodiments, Compounds of the Disclosure are compounds of any one of Formulae (I-F)-(III-F), wherein R^{2a} is selected from the group consisting of hydrogen and C₁-C₄ alkyl.

In some embodiments, Compounds of the Disclosure are compounds of any one of Formulae (I-F)-(III-F), wherein R^{3a} is hydrogen.

In some embodiments, Compounds of the Disclosure are compounds of any one of Formulae (I-F)-(III-F), wherein R^{3a} is C₁-C₉ alkyl.

In some embodiments, Compounds of the Disclosure are compounds of any one of Formulae (I-F)-(III-F), wherein R^{3a} is C₃-C₆ cycloalkyl.

In some embodiments, Compounds of the Disclosure are compounds of any one of Formulae (I-F)-(III-F), wherein R^{3a} is optionally substituted phenyl.

In some embodiments, Compounds of the Disclosure are compounds of any one of Formulae (I-F)-(III-F), wherein R^{3c} is hydrogen.

In some embodiments, Compounds of the Disclosure are compounds of any one of Formulae (I-F)-(III-F), wherein R^{3c} is C₁-C₉ alkyl.

In some embodiments, Compounds of the Disclosure are compounds of any one of Formulae (I-F)-(III-F), wherein R^{3c} is C₃-C₆ cycloalkyl.

In some embodiments, Compounds of the Disclosure are compounds of any one of Formulae (I-F)-(III-F), wherein R^{3c} is optionally substituted phenyl.

In some embodiments, Compounds of the Disclosure are compounds of any one of Formulae (I-F)-(III-F), wherein R^{3e} is hydrogen.

In some embodiments, Compounds of the Disclosure are compounds of any one of Formulae (I-F)-(III-F), wherein R^{3e} is C₁-C₈ alkoxy.

In some embodiments, Compounds of the Disclosure are compounds of any one of Formulae (I-F)-(III-F), wherein R^{3e} is —OH.

In some embodiments, Compounds of the Disclosure are compounds of any one of Formulae (I-F)-(III-F), wherein R^{3e} is —SH.

In some embodiments, Compounds of the Disclosure are compounds of any one of Formulae (I-F)-(III-F), wherein R^{3e} is C₁-C₈ alkylthio.

In some embodiments, Compounds of the Disclosure are compounds of any one of Formulae (I-F)-(III-F), wherein R^{3e} is arylthio.

In some embodiments, Compounds of the Disclosure are compounds of any one of Formulae (I-F)-(III-F), wherein R^{3e} is C₁-C₉ alkyl.

In some embodiments, Compounds of the Disclosure are compounds of any one of Formulae (I-F)-(III-F), wherein R^{3e} is C₃-C₆ cycloalkyl.

In some embodiments, Compounds of the Disclosure are compounds of any one of Formulae (I-F)-(III-F), wherein R^{3e} is optionally substituted phenyl.

In some embodiments, Compounds of the Disclosure are compounds of any one of Formulae (I-F)-(III-F), wherein R^{3f} is hydrogen.

In some embodiments, Compounds of the Disclosure are compounds of any one of Formulae (I-F)-(III-F), wherein R^{3f} is C₁-C₉ alkyl.

In some embodiments, Compounds of the Disclosure are compounds of any one of Formulae (I-F)-(III-F), wherein R^{3f} is C₃-C₆ cycloalkyl.

In some embodiments, Compounds of the Disclosure are compounds of any one of Formulae (I-F)-(III-F), wherein R^{3f} is optionally substituted phenyl.

In some embodiments, Compounds of the Disclosure are any one or more of the compounds of Table F, or a salt or solvate thereof.

TABLE F

| Compound No. | Structure |
|---|---|
| 1-F | 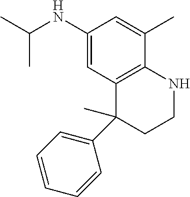 [SMILES: Cc1cc(NC(C)C)cc2c1NCCC2(C)c1ccccc1] |
| 2-F | 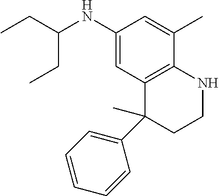 [SMILES: CCC(CC)Nc1cc(C)c2c(c1)C(C)(c1ccccc1)CCN2] |
| 3-F | 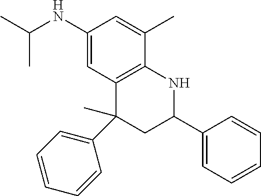 [SMILES: Cc1cc(NC(C)C)cc2c1NC(c1ccccc1)CC2(C)c1ccccc1] |
| 4-F | 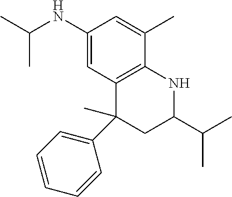 [SMILES: Cc1cc(NC(C)C)cc2c1NC(C(C)C)CC2(C)c1ccccc1] |
| 5-F | 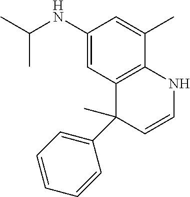 [SMILES: Cc1cc(NC(C)C)cc2c1NC=CC2(C)c1ccccc1] |
| 6-F | 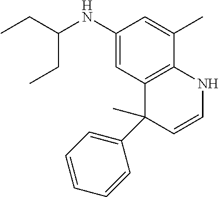 [SMILES: CCC(CC)Nc1cc(C)c2c(c1)C(C)(c1ccccc1)C=CN2] |
| 7-F | 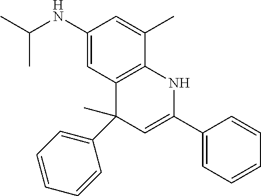 [SMILES: Cc1cc(NC(C)C)cc2c1NC(c1ccccc1)=CC2(C)c1ccccc1] |
| 8-F | 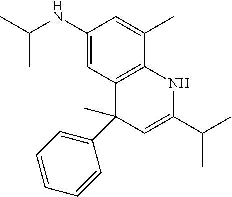 [SMILES: Cc1cc(NC(C)C)cc2c1NC(C(C)C)=CC2(C)c1ccccc1] |
| 9-F | 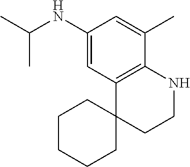 [SMILES: Cc1cc(NC(C)C)cc2c1NCCC21CCCCC1] |
| 10-F | 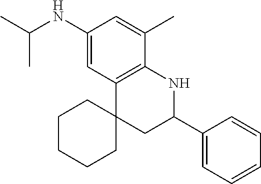 [SMILES: Cc1cc(NC(C)C)cc2c1NC(c1ccccc1)CC21CCCCC1] |
| 11-F | 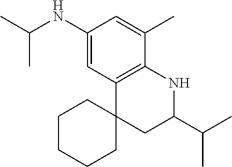 [SMILES: Cc1cc(NC(C)C)cc2c1NC(C(C)C)CC21CCCCC1] |
| 12-F | 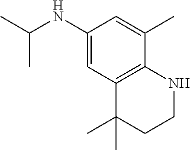 [SMILES: Cc1cc(NC(C)C)cc2c1NCCC2(C)C] |
| 13-F | 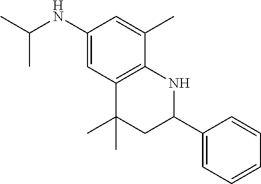 [SMILES: Cc1cc(NC(C)C)cc2c1NC(c1ccccc1)CC2(C)C] |
| 14-F | 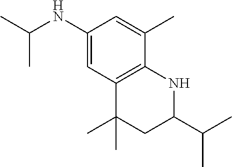 [SMILES: Cc1cc(NC(C)C)cc2c1NC(C(C)C)CC2(C)C] |
| 15-F | 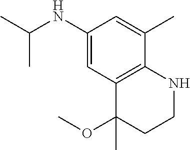 [SMILES: COC1(C)CCNc2c(C)cc(NC(C)C)cc21] |
| 16-F | 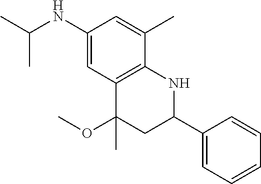 [SMILES: COC1(C)CC(c2ccccc2)Nc2c(C)cc(NC(C)C)cc21] |
| 17-F | 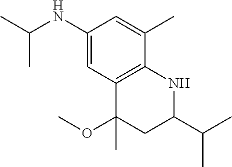 [SMILES: COC1(C)CC(C(C)C)Nc2c(C)cc(NC(C)C)cc21] |
| 18-F | 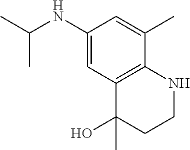 [SMILES: Cc1cc(NC(C)C)cc2c1NCCC2(C)O] |
| 19-F | 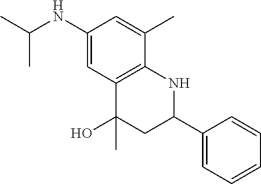 [SMILES: Cc1cc(NC(C)C)cc2c1NC(c1ccccc1)CC2(C)O] |
| 20-F | 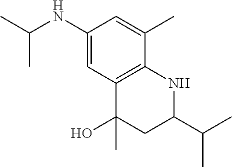 [SMILES: Cc1cc(NC(C)C)cc2c1NC(C(C)C)CC2(C)O] |
| 21-F | 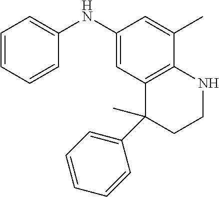 [SMILES: Cc1cc(Nc2ccccc2)cc2c1NCCC2(C)c1ccccc1] |
| 22-F | 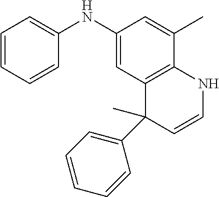 [SMILES: Cc1cc(Nc2ccccc2)cc2c1NC=CC2(C)c1ccccc1] |
| 23-F | 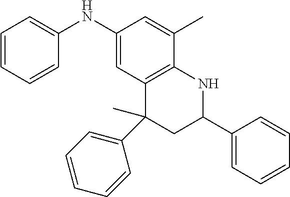 [SMILES: Cc1cc(Nc2ccccc2)cc2c1NC(c1ccccc1)CC2(C)c1ccccc1] |
| 24-F | 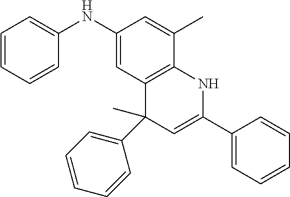 [SMILES: Cc1cc(Nc2ccccc2)cc2c1NC(c1ccccc1)=CC2(C)c1ccccc1] |
| 25-F | 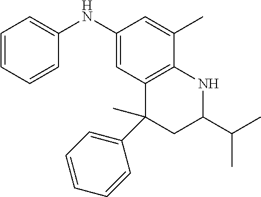 [SMILES: Cc1cc(Nc2ccccc2)cc2c1NC(C(C)C)CC2(C)c1ccccc1] |
| 26-F | 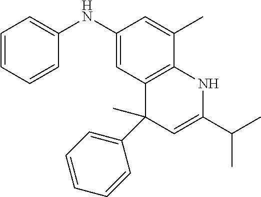 [SMILES: Cc1cc(Nc2ccccc2)cc2c1NC(C(C)C)=CC2(C)c1ccccc1] |
| 27-F | 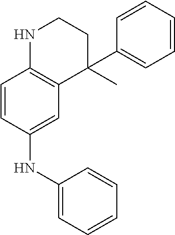 [SMILES: CC1(c2ccccc2)CCNc2ccc(Nc3ccccc3)cc21] |
| 28-F | 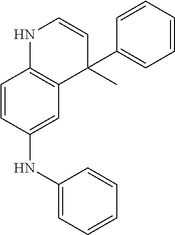 [SMILES: CC1(c2ccccc2)C=CNc2ccc(Nc3ccccc3)cc21] |
| 29-F | 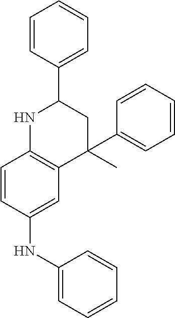 [SMILES: CC1(c2ccccc2)CC(c2ccccc2)Nc2ccc(Nc3ccccc3)cc21] |
| 30-F | 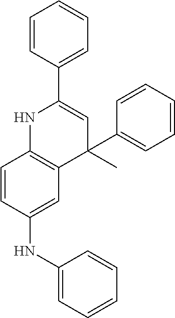 [SMILES: CC1(c2ccccc2)C=C(c2ccccc2)Nc2ccc(Nc3ccccc3)cc21] |
| 31-F | 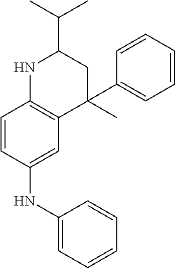 [SMILES: CC(C)C1CC(C)(c2ccccc2)c2cc(Nc3ccccc3)ccc2N1] |
| 32-F | 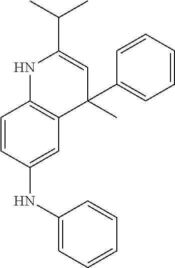 [SMILES: CC(C)C1=CC(C)(c2ccccc2)c2cc(Nc3ccccc3)ccc2N1] |
| 33-F | 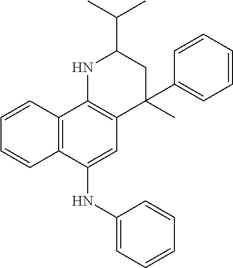 [SMILES: CC(C)C1CC(C)(c2ccccc2)c2cc(Nc3ccccc3)c3ccccc3c2N1] |
| 34-F | 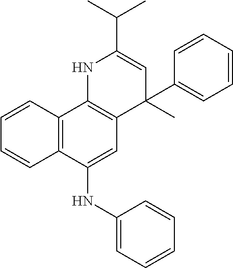 [SMILES: CC(C)C1=CC(C)(c2ccccc2)c2cc(Nc3ccccc3)c3ccccc3c2N1] |
| 35-F | 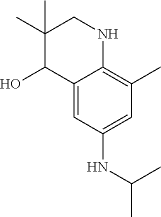 [SMILES: Cc1cc(NC(C)C)cc2c1NCC(C)(C)C2O] |
| 36-F | 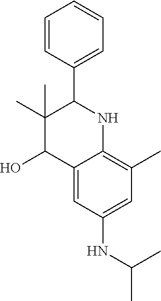 [SMILES: Cc1cc(NC(C)C)cc2c1NC(c1ccccc1)C(C)(C)C2O] |
| 37-F | 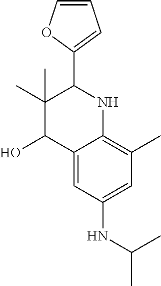 [SMILES: Cc1cc(NC(C)C)cc2c1NC(c1ccco1)C(C)(C)C2O] |
| 38-F | 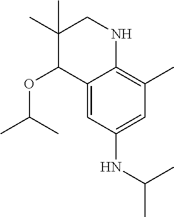 [SMILES: Cc1cc(NC(C)C)cc2c1NCC(C)(C)C2OC(C)C] |
| 39-F | 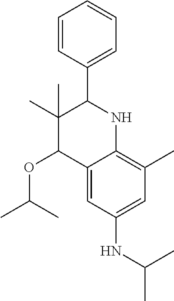 [SMILES: Cc1cc(NC(C)C)cc2c1NC(c1ccccc1)C(C)(C)C2OC(C)C] |
| 40-F | 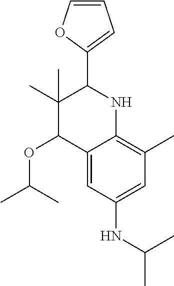 [SMILES: Cc1cc(NC(C)C)cc2c1NC(c1ccco1)C(C)(C)C2OC(C)C] |
| 41-F | 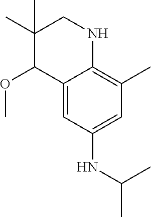 [SMILES: COC1c2cc(NC(C)C)cc(C)c2NCC1(C)C] |
| 42-F | 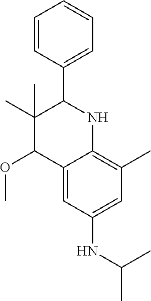 [SMILES: COC1c2cc(NC(C)C)cc(C)c2NC(c2ccccc2)C1(C)C] |
| 43-F | 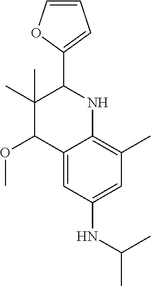 [SMILES: COC1c2cc(NC(C)C)cc(C)c2NC(c2ccco2)C1(C)C] |
| 44-F | 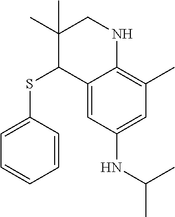 [SMILES: Cc1cc(NC(C)C)cc2c1NCC(C)(C)C2Sc1ccccc1] |
| 45-F | 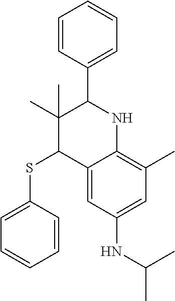 [SMILES: Cc1cc(NC(C)C)cc2c1NC(c1ccccc1)C(C)(C)C2Sc1ccccc1] |
| 46-F | 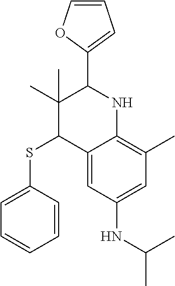 [SMILES: Cc1cc(NC(C)C)cc2c1NC(c1ccco1)C(C)(C)C2Sc1ccccc1] |
| 47-F | 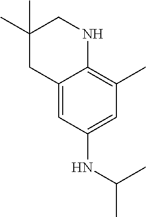 [SMILES: Cc1cc(NC(C)C)cc2c1NCC(C)(C)C2] |
| 48-F | 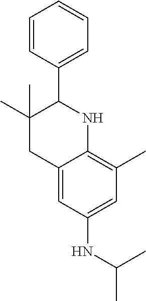 [SMILES: Cc1cc(NC(C)C)cc2c1NC(c1ccccc1)C(C)(C)C2] |
| 49-F | 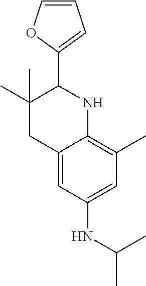 [SMILES: Cc1cc(NC(C)C)cc2c1NC(c1ccco1)C(C)(C)C2] |
| 50-F | 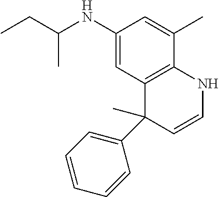 [SMILES: CCC(C)Nc1cc(C)c2c(c1)C(C)(c1ccccc1)C=CN2] |
| 51-F | 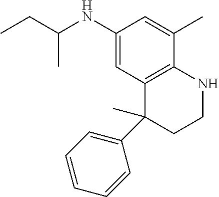 [SMILES: CCC(C)Nc1cc(C)c2c(c1)C(C)(c1ccccc1)CCN2] |
| 52-F | 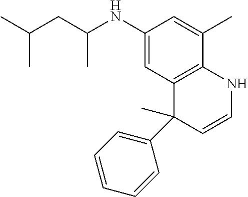 [SMILES: Cc1cc(NC(C)CC(C)C)cc2c1NC=CC2(C)c1ccccc1] |
| 53-F | 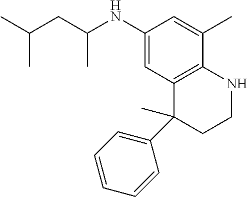 [SMILES: Cc1cc(NC(C)CC(C)C)cc2c1NCCC2(C)c1ccccc1] |

Compounds of Formula (I-F) can be prepared, for example, by a two-step process comprising i) reacting a 4-nitroaniline with an alkene and an aldehyde or ketone in acetonitrile or other suitable solvents and a catalyst such as any suitable acid or I₂, i.e., via a Povarov reaction, and ii) reacting the product of step i) with an aldehyde or ketone under reductive conditions, e.g., pressurized H₂ with a platinum catalyst, as shown in Scheme 1, wherein R^{1e} is, for example, C₁-C₁₂ alkyl, C₃-C₆ cycloalkyl, optionally substituted phenyl, or optionally substituted 5- or 6-membered heteroaryl, and R^{1f} is, for example, hydrogen or C₁-C₆ alkyl.

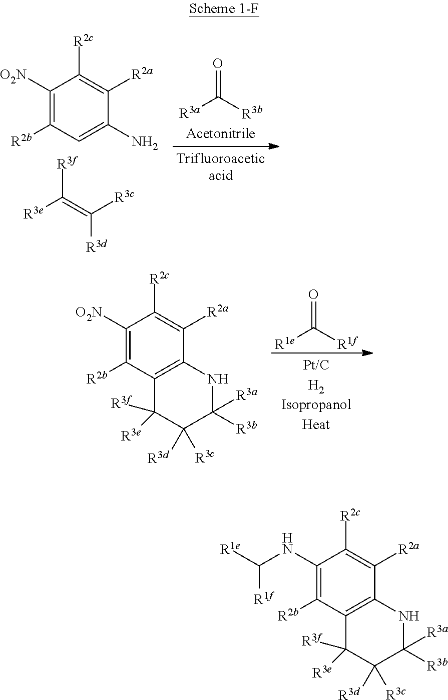

Compounds of Formula (I-F) can also be prepared, for example, by oxidizing the compound obtained in Scheme 1-F by methods known in the art, as shown in Scheme 2-F.

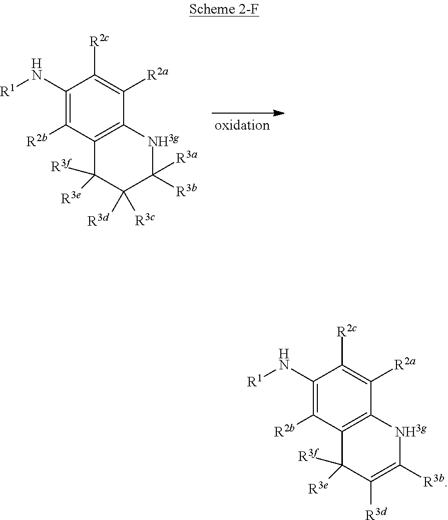

In some embodiments, Compounds of the Disclosure are compounds described in U.S. Provisional Appl. No. 63/500,443, which is fully incorporated by reference herein in its entirety.

In one embodiment, Compounds of the Disclosure are compounds having Formula (I-G):

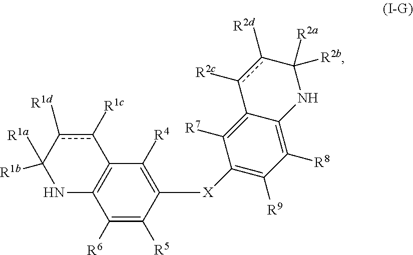

or a salt or solvate thereof, wherein:
each [symbol] is a single or double bond;
R^{1a} and R^{2a} are each independently selected from the group consisting of C₁-C₁₂ alkyl, —C(═O)OR′, —C(═O)NR′R″, —C(═O)SR′, —CH₂OR′, —CH₂OC(═O)R′, and

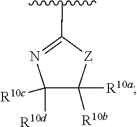

R^{1b}, and R^{2b} are each independently selected from the group consisting of hydrogen and C₁-C₁₂ alkyl;
R^{1c} and R^{2c} are each independently selected from the group consisting of C₁-C₁₂ alkyl, —C(═O)OR′, —C(═O)NR′R″, —C(═O)SR′, —CH₂OR′, —CH₂OC(═O)R′, and

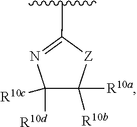

with the proviso that at least one of R^{1a}, R^{1c}, R^{2a}, and R^{2c} is selected from the group consisting of —C(═O)OR′, —C(═O)NR′R″, —C(═O)SR′, —CH₂OR′, —CH₂OC(═O)R′, and

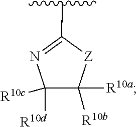

R^{1d} and R^{2d} are each independently selected from the group consisting of hydrogen and C₁-C₁₂ alkyl;
R′ and R″ at each occurrence are independently selected from the group consisting of hydrogen, C₁-C₁₂ alkyl, C₃-C₆ cycloalkyl, and optionally substituted phenyl;
X is selected from the group consisting of —CHR^{3a}—, —NR^{3b}—, —O—, and —S—;
Z at each occurrence is independently selected from the group consisting of —O—, —S—, and —NR¹¹—;
R^{10a}, R^{10b}, R^{10c}, and R^{10d} are each independently selected from the group consisting of hydrogen, C₁-C₁₂ alkyl, and optionally substituted phenyl;
R¹¹ at each occurrence is selected from the group consisting or hydrogen and C₁-C₆ alkyl;
R^{3a} is selected from the group consisting of hydrogen, C₁-C₁₂ alkyl, C₃-C₆ cycloalkyl, optionally substituted phenyl, optionally substituted 5- or 6-membered heterocyclo, and optionally substituted 5- or 6-membered heteroaryl;
R^{3b} is selected from the group consisting of hydrogen, C₁-C₁₂ alkyl, C₃-C₆ cycloalkyl, optionally substituted phenyl, optionally substituted 5- or 6-membered heterocyclo, and optionally substituted 5- or 6-membered heteroaryl; and
R⁴, R⁵, R⁶, R⁷, R⁸, and R⁹ are independently selected from the group consisting of hydrogen, halogen, C₁-C₆ alkyl, C₁-C₆ alkoxy, and C₁-C₆ alkylthio.

In some embodiments, Compounds of the Disclosure are compounds having Formula (II-G):

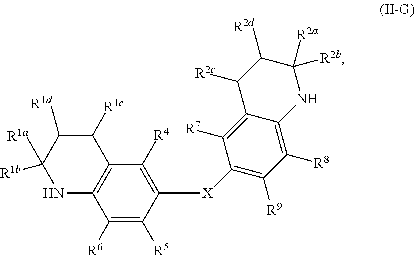

or a salt or solvate thereof, wherein X, R^{1a}, R^{1b}, R^{1c}, R^{1d}, R^{2a}, R^{2b}, R^{2c}, R^{2d}, R⁴, R⁵, R⁶, R⁷, R⁸ and R⁹ are as defined in connection with Formula (I-G).

In some embodiments, Compounds of the Disclosure are compounds having Formula (III-G):

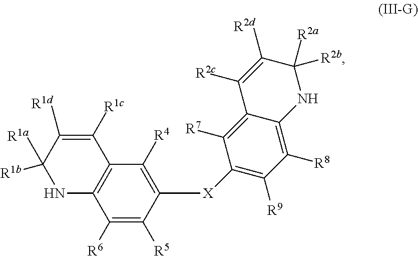

or a salt or solvate thereof, wherein X, R^{1a}, R^{1b}, R^{1c}, R^{1d}, R^{2a}, R^{2b}, R^{2c}, R^{2d}, R⁴, R⁵, R⁶, R⁷, R⁸ and R⁹ are as defined in connection with Formula (I-G).

In some embodiments, Compounds of the Disclosure are compounds of any one of Formulae (I-G), (II-G), or (III-G), wherein R^{1a} and R^{2a} are —C(═O)OR′.

In some embodiments, Compounds of the Disclosure are compounds of any one of Formulae (I-G), (II-G), or (III-G), wherein R^{1a} and R^{2a} are —C(═O)NR′R″.

In some embodiments, Compounds of the Disclosure are compounds of any one of Formulae (I-G), (II-G), or (III-G), wherein R^{1a} and R^{2a} are —C(═O)NR′R″.

In some embodiments, Compounds of the Disclosure are compounds of any one of Formulae (I-G), (II-G), or (III-G), wherein R^{1a} and R^{2a} are —C(═O)SR′.

In some embodiments, Compounds of the Disclosure are compounds of any one of Formulae (I-G), (II-G), or (III-G), wherein R^{1a} and R^{2a} are —CH₂OR′.

In some embodiments, Compounds of the Disclosure are compounds of any one of Formulae (I-G), (II-G), or (III-G), wherein R^{1a} and R^{2a} are —CH₂OC(═O)R′.

In some embodiments, Compounds of the Disclosure are compounds of any one of Formulae (I-G), (II-G), or (III-G), wherein R^{1a} and R^{2a} are:

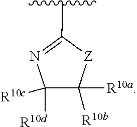

In some embodiments, Z is —O—. In some embodiments, Z is —S—. In some embodiments, Z is —NH—. In some embodiments, R^{10a}, R^{10b}, R^{10c}, and R^{10d} are hydrogen.

In some embodiments, Compounds of the Disclosure are compounds of any one of Formulae (I-G), (II-G), or (III-G), wherein R^{1a} and R^{2a} are C₁-C₆ alkyl.

In some embodiments, Compounds of the Disclosure are compounds of any one of Formulae (I-G), (II-G), or (III-G), wherein R^{1c} and R^{2c} are —C(═O)OR′.

In some embodiments, Compounds of the Disclosure are compounds of any one of Formulae ((I-G), (II-G), or (III-G), wherein R^{1c} and R^{2c} are —C(═O)NR′R″.

In some embodiments, Compounds of the Disclosure are compounds of any one of Formulae (I-G), (II-G), or (III-G), wherein R^{1c} and R^{2c} are —C(═O)NR′R″.

In some embodiments, Compounds of the Disclosure are compounds of any one of Formulae (I-G), (II-G), or (III-G), wherein R^{1c} and R^{2c} are —C(═O)SR′.

In some embodiments, Compounds of the Disclosure are compounds of any one of Formulae (I-G), (II-G), or (III-G), wherein R^{1c} and R^{2c} are —CH₂OR′.

In some embodiments, Compounds of the Disclosure are compounds of any one of Formulae (I-G), (II-G), or (III-G), wherein R^{1c} and R^{2c} are —CH₂OC(═O)R′.

In some embodiments, Compounds of the Disclosure are compounds of any one of Formulae (I-G), (II-G), or (III-G), wherein R^{1c} and R^{2c} are:

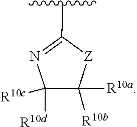

In some embodiments, Z is —O—. In some embodiments, Z is —S—. In some embodiments, Z is —NH—. In some embodiments, Z is —NH—. In some embodiments, R^{10a}, R^{10b}, R^{10c}, and R^{10d} are hydrogen.

In some embodiments, Compounds of the Disclosure are compounds of any one of Formulae (I-G), (II-G), or (III-G), wherein R^{1c} and R^{2c} are C₁-C₆ alkyl.

In some embodiments, Compounds of the Disclosure are compounds of any one of Formulae (I-G), (II-G), or (III-G), wherein R^{1a}, R^{1c}, R^{2a}, and R^{2c} are —C(═O)OR′.

In some embodiments, Compounds of the Disclosure are compounds of any one of Formulae (I-G), (II-G), or (III-G), wherein each R′ is independently hydrogen or C₁-C₆ alkyl.

In some embodiments, Compounds of the Disclosure are compounds of any one of Formulae (I-G), (II-G), or (III-G), wherein each R′ is independently methyl, ethyl, propyl, isopropyl, butyl, tert-butyl, or sec-butyl.

In some embodiments, Compounds of the Disclosure are compounds of any one of Formulae (I-G), (II-G), or (III-G), wherein each R′ is ethyl.

In some embodiments, Compounds of the Disclosure are compounds of any one of Formulae (I-G), (II-G), or (III-G), wherein each R′ is hydrogen.

In some embodiments, Compounds of the Disclosure are compounds of any one of Formulae (I-G), (II-G), or (III-G), wherein R^{1b}, and R^{2b} are each independently C₁-C₆ alkyl.

In some embodiments, Compounds of the Disclosure are compounds of any one of Formulae (I-G), (II-G), or (III-G), wherein R^{1b}, and R^{2b} are methyl.

In some embodiments, Compounds of the Disclosure are compounds of any one of Formulae (I-G), (II-G), or (III-G), wherein R^{1d} and R^{2d} are hydrogen.

In some embodiments, Compounds of the Disclosure are compounds of any one of Formulae (I-G), (II-G), or (III-G), wherein X is —CHR^{3a}—.

In some embodiments, Compounds of the Disclosure are compounds of any one of Formulae (I-G), (II-G), or (III-G), wherein R^{3a} is hydrogen.

In some embodiments, Compounds of the Disclosure are compounds of any one of Formulae (I-G), (II-G), or (III-G), wherein R^{3a} is C₁-C₁₂ alkyl.

In some embodiments, Compounds of the Disclosure are compounds of any one of Formulae (I-G), (II-G), or (III-G), wherein R^{3a} is methyl, ethyl, propyl, isopropyl, butyl, tert-butyl, or sec-butyl.

In some embodiments, Compounds of the Disclosure are compounds of any one of Formulae (I-G), (II-G), or (III-G), wherein R^{3a} is isopropyl.

In some embodiments, Compounds of the Disclosure are compounds of any one of Formulae (I-G), (II-G), or (III-G), wherein R^{3a} is optionally substituted phenyl.

In some embodiments, Compounds of the Disclosure are compounds of any one of Formulae (I-G), (II-G), or (III-G), wherein R^{3a} is optionally substituted 5- or 6-membered heteroaryl.

In some embodiments, Compounds of the Disclosure are compounds of any one of Formulae (I-G), (II-G), or (III-G), wherein R^{3a} is:

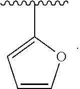 [SMILES: *c1ccco1]

In some embodiments, Compounds of the Disclosure are compounds of any one of Formulae (I-G), (II-G), or (III-G), wherein X is —NR^{3b}—.

In some embodiments, Compounds of the Disclosure are compounds of any one of Formulae (I-G), (II-G), or (III-G), wherein R^{3b} is hydrogen.

In some embodiments, Compounds of the Disclosure are compounds of any one of Formulae (I-G), (II-G), or (III-G), wherein X is —O—.

In some embodiments, Compounds of the Disclosure are compounds of any one of Formulae (I-G), (II-G), or (III-G), wherein X is —S—.

In some embodiments, Compounds of the Disclosure are compounds of any one of Formulae (I-G), (II-G), or (III-G), wherein R⁴, R⁵, R⁶, R⁷, R⁸, and R⁹ are each independently hydrogen or C₁-C₆ alkyl.

In some embodiments, Compounds of the Disclosure are compounds of any one of Formulae (I-G), (II-G), or (III-G), wherein R⁴, R⁵, R⁶, R⁷, R⁸, and R⁹ are each independently hydrogen or methyl.

In some embodiments, Compounds of the Disclosure are compounds of any one of Formulae (I-G), (II-G), or (III-G), wherein R⁴, R⁵, R⁶, R⁷, R⁸, and R⁹ are hydrogen.

In some embodiments, Compounds of the Disclosure are compounds of any one of Formulae (I-G), (II-G), or (III-G), wherein R^{1a}, R^{1c}, R^{2a}, and R^{2c} are —C(═O)OR′; R′ is selected from the group consisting of hydrogen and ethyl; R^{1b}, and R^{2b} are methyl; R^{1d} and R^{2d} are hydrogen; and X is selected from the group consisting of —CHR^{3a}—, —NR^{3b}—, —O—, and —S—. In some embodiments, X is CHR^{3a}—. In some embodiments, X is —NR^{3b}—. In some embodiments, X is —O—. In some embodiments, X is —S—.

In some embodiments, Compounds of the Disclosure are any one or more of the compounds of Table G, or a salt or solvate thereof.

TABLE G

| Compound No. | Structure |
|---|---|
| 1-G | 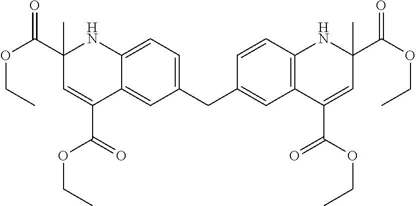 [SMILES: CCOC(=O)C1=CC(C)(C(=O)OCC)Nc2ccc(Cc3ccc4c(c3)C(C(=O)OCC)=CC(C)(C(=O)OCC)N4)cc21] |
| 2-G | 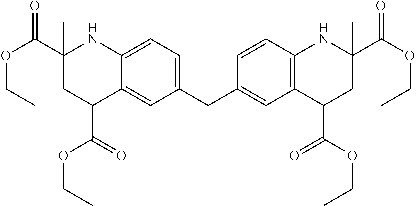 [SMILES: CCOC(=O)C1CC(C)(C(=O)OCC)Nc2ccc(Cc3ccc4c(c3)C(C(=O)OCC)CC(C)(C(=O)OCC)N4)cc21] |
| 3-G | 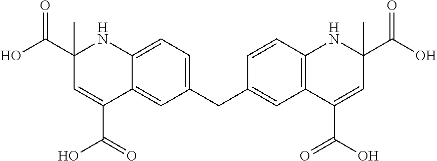 [SMILES: CC1(C(=O)O)C=C(C(=O)O)c2cc(Cc3ccc4c(c3)C(C(=O)O)=CC(C)(C(=O)O)N4)ccc2N1] |
| 4-G | 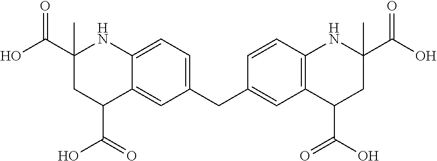 [SMILES: CC1(C(=O)O)CC(C(=O)O)c2cc(Cc3ccc4c(c3)C(C(=O)O)CC(C)(C(=O)O)N4)ccc2N1] |
| 5-G | 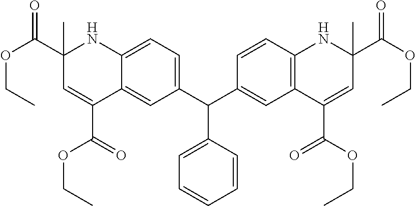 [SMILES: CCOC(=O)C1=CC(C)(C(=O)OCC)Nc2ccc(C(c3ccccc3)c3ccc4c(c3)C(C(=O)OCC)=CC(C)(C(=O)OCC)N4)cc21] |
| 6-G | 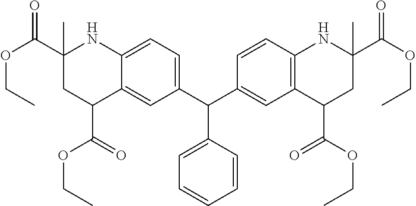 [SMILES: CCOC(=O)C1CC(C)(C(=O)OCC)Nc2ccc(C(c3ccccc3)c3ccc4c(c3)C(C(=O)OCC)CC(C)(C(=O)OCC)N4)cc21] |
| 7-G | 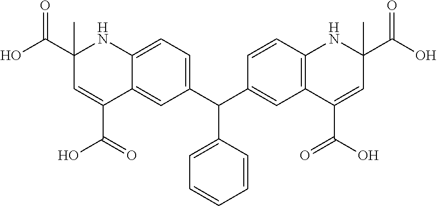 [SMILES: CC1(C(=O)O)C=C(C(=O)O)c2cc(C(c3ccccc3)c3ccc4c(c3)C(C(=O)O)=CC(C)(C(=O)O)N4)ccc2N1] |
| 8-G | 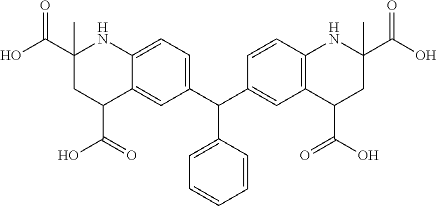 [SMILES: CC1(C(=O)O)CC(C(=O)O)c2cc(C(c3ccccc3)c3ccc4c(c3)C(C(=O)O)CC(C)(C(=O)O)N4)ccc2N1] |
| 9-G | 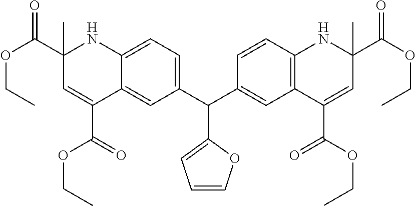 [SMILES: CCOC(=O)C1=CC(C)(C(=O)OCC)Nc2ccc(C(c3ccc4c(c3)C(C(=O)OCC)=CC(C)(C(=O)OCC)N4)c3ccco3)cc21] |
| 10-G | 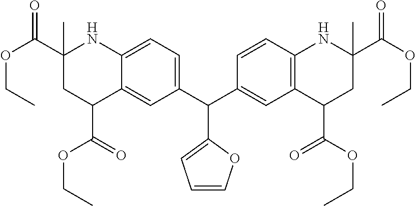 [SMILES: CCOC(=O)C1CC(C)(C(=O)OCC)Nc2ccc(C(c3ccc4c(c3)C(C(=O)OCC)CC(C)(C(=O)OCC)N4)c3ccco3)cc21] |
| 11-G | 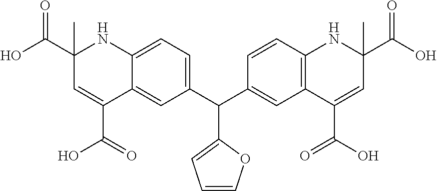 [SMILES: CC1(C(=O)O)C=C(C(=O)O)c2cc(C(c3ccc4c(c3)C(C(=O)O)=CC(C)(C(=O)O)N4)c3ccco3)ccc2N1] |
| 12-G | 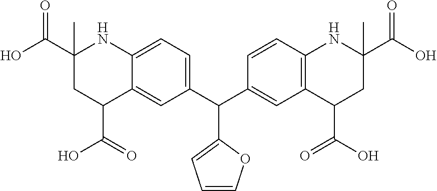 [SMILES: CC1(C(=O)O)CC(C(=O)O)c2cc(C(c3ccc4c(c3)C(C(=O)O)CC(C)(C(=O)O)N4)c3ccco3)ccc2N1] |
| 13-G | 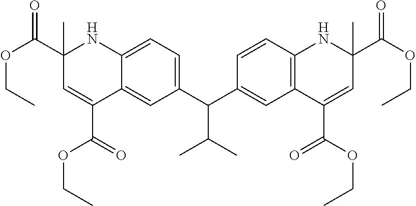 [SMILES: CCOC(=O)C1=CC(C)(C(=O)OCC)Nc2ccc(C(c3ccc4c(c3)C(C(=O)OCC)=CC(C)(C(=O)OCC)N4)C(C)C)cc21] |
| 14-G | 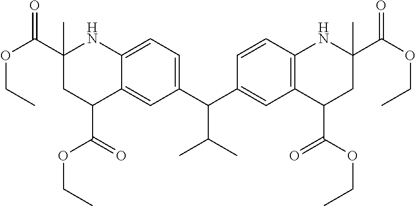 [SMILES: CCOC(=O)C1CC(C)(C(=O)OCC)Nc2ccc(C(c3ccc4c(c3)C(C(=O)OCC)CC(C)(C(=O)OCC)N4)C(C)C)cc21] |
| 15-G | 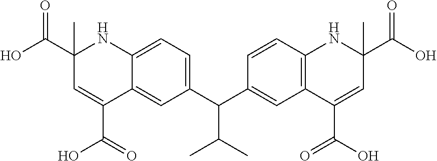 [SMILES: CC(C)C(c1ccc2c(c1)C(C(=O)O)=CC(C)(C(=O)O)N2)c1ccc2c(c1)C(C(=O)O)=CC(C)(C(=O)O)N2] |
| 16-G | 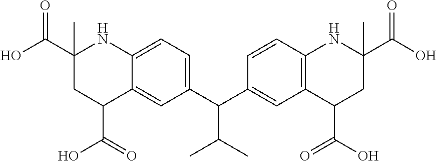 [SMILES: CC(C)C(c1ccc2c(c1)C(C(=O)O)CC(C)(C(=O)O)N2)c1ccc2c(c1)C(C(=O)O)CC(C)(C(=O)O)N2] |
| 17-G | 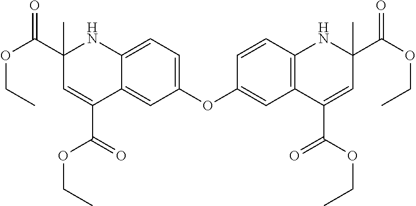 [SMILES: CCOC(=O)C1=CC(C)(C(=O)OCC)Nc2ccc(Oc3ccc4c(c3)C(C(=O)OCC)=CC(C)(C(=O)OCC)N4)cc21] |
| 18-G | 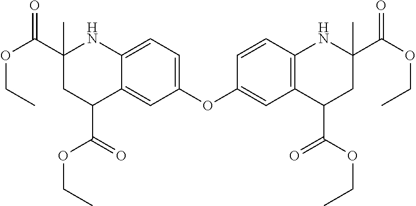 [SMILES: CCOC(=O)C1CC(C)(C(=O)OCC)Nc2ccc(Oc3ccc4c(c3)C(C(=O)OCC)CC(C)(C(=O)OCC)N4)cc21] |
| 19-G | 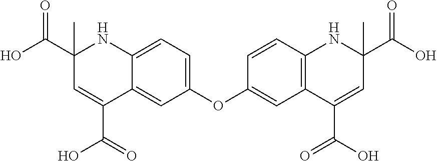 [SMILES: CC1(C(=O)O)C=C(C(=O)O)c2cc(Oc3ccc4c(c3)C(C(=O)O)=CC(C)(C(=O)O)N4)ccc2N1] |
| 20-G | 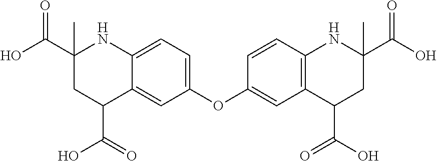 [SMILES: CC1(C(=O)O)CC(C(=O)O)c2cc(Oc3ccc4c(c3)C(C(=O)O)CC(C)(C(=O)O)N4)ccc2N1] |
| 21-G | 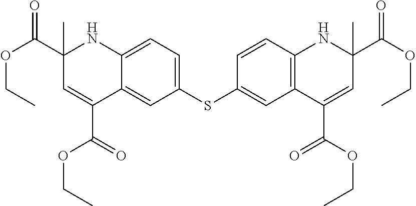 [SMILES: CCOC(=O)C1=CC(C)(C(=O)OCC)Nc2ccc(Sc3ccc4c(c3)C(C(=O)OCC)=CC(C)(C(=O)OCC)N4)cc21] |
| 22-G | 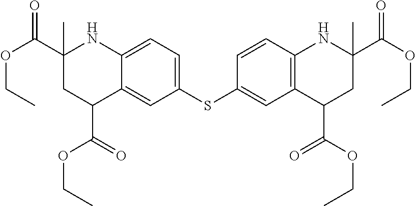 [SMILES: CCOC(=O)C1CC(C)(C(=O)OCC)Nc2ccc(Sc3ccc4c(c3)C(C(=O)OCC)CC(C)(C(=O)OCC)N4)cc21] |
| 23-G | 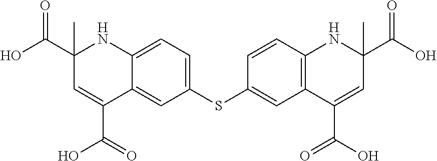 [SMILES: CC1(C(=O)O)C=C(C(=O)O)c2cc(Sc3ccc4c(c3)C(C(=O)O)=CC(C)(C(=O)O)N4)ccc2N1] |
| 24-G | 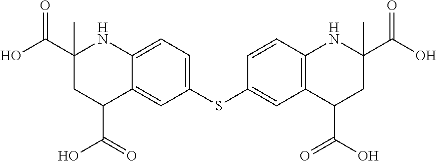 [SMILES: CC1(C(=O)O)CC(C(=O)O)c2cc(Sc3ccc4c(c3)C(C(=O)O)CC(C)(C(=O)O)N4)ccc2N1] |
| 25-G | 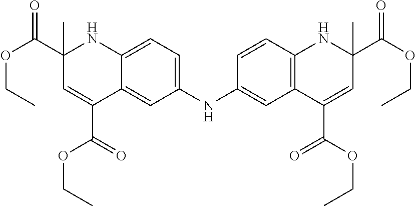 [SMILES: CCOC(=O)C1=CC(C)(C(=O)OCC)Nc2ccc(Nc3ccc4c(c3)C(C(=O)OCC)=CC(C)(C(=O)OCC)N4)cc21] |
| 26-G | 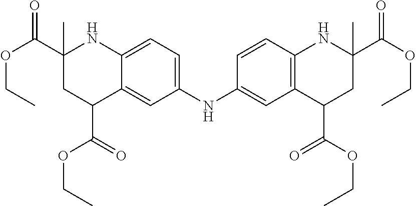 [SMILES: CCOC(=O)C1CC(C)(C(=O)OCC)Nc2ccc(Nc3ccc4c(c3)C(C(=O)OCC)CC(C)(C(=O)OCC)N4)cc21] |
| 27-G | 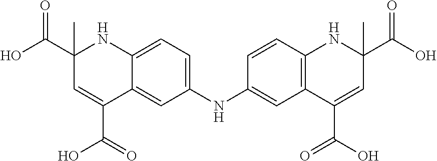 [SMILES: CC1(C(=O)O)C=C(C(=O)O)c2cc(Nc3ccc4c(c3)C(C(=O)O)=CC(C)(C(=O)O)N4)ccc2N1] |
| 28-G | 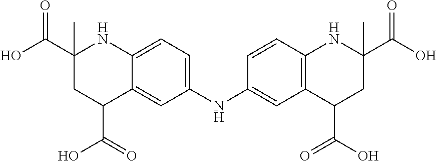 [SMILES: CC1(C(=O)O)CC(C(=O)O)c2cc(Nc3ccc4c(c3)C(C(=O)O)CC(C)(C(=O)O)N4)ccc2N1] |
| 29-G | 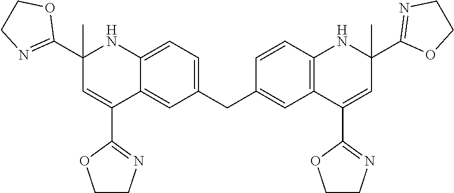 [SMILES: CC1(C2=NCCO2)C=C(C2=NCCO2)c2cc(Cc3ccc4c(c3)C(C3=NCCO3)=CC(C)(C3=NCCO3)N4)ccc2N1] |
| 30-G | 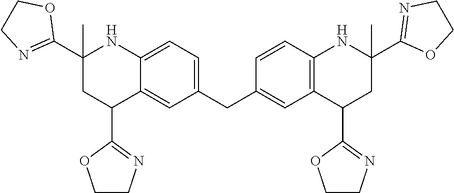 [SMILES: CC1(C2=NCCO2)CC(C2=NCCO2)c2cc(Cc3ccc4c(c3)C(C3=NCCO3)CC(C)(C3=NCCO3)N4)ccc2N1] |
| 31-G | 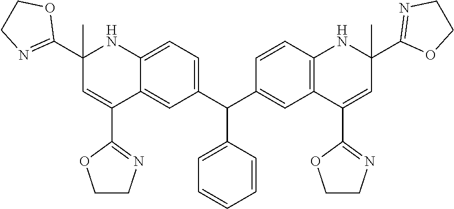 [SMILES: CC1(C2=NCCO2)C=C(C2=NCCO2)c2cc(C(c3ccccc3)c3ccc4c(c3)C(C3=NCCO3)=CC(C)(C3=NCCO3)N4)ccc2N1] |
| 32-G | 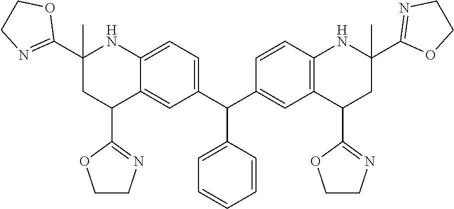 [SMILES: CC1(C2=NCCO2)CC(C2=NCCO2)c2cc(C(c3ccccc3)c3ccc4c(c3)C(C3=NCCO3)CC(C)(C3=NCCO3)N4)ccc2N1] |

Compounds having Formula (I-G) can be prepared by the reaction of methylene, amino, ether, or sulfur bisanilines with an alpha-oxoester, e.g., ethyl pyruvate, in the presence of acid, as shown in Scheme 1-G.

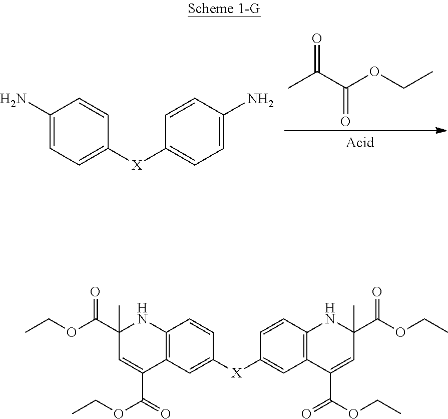

Compounds having Formula (I-G) can also be prepared by the reduction of the compounds obtained in the reaction described by Scheme 1-G, as shown in Scheme 2-G. Reduction may be carried out using any methods known in the art, such as exposure to hydrogen over a palladium on carbon (Pd/C) catalyst.

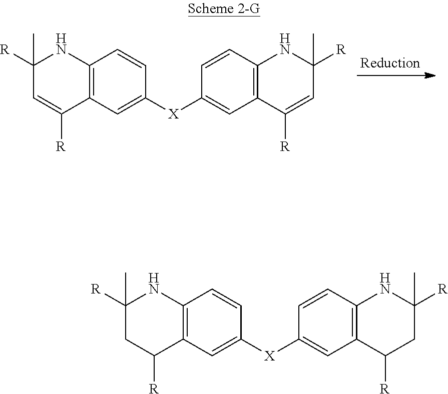

In some embodiments, Compounds of the Disclosure are compounds described in U.S. Provisional Appl. No. 63/505,850, which is fully incorporated by reference herein in its entirety.

In some embodiments, Compounds of the Disclosure are compounds having Formula (I-H):

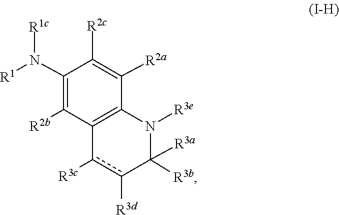

or a salt, solvate, or stereoisomer thereof, wherein:
[symbol] is a single or a double bond;
R¹ is selected from the group consisting of optionally substituted C₁-C₁₂ alkyl, —CHR^{1a}R^{1b}, C₃-C₆ cycloalkyl, 4- to 6-membered heterocyclyl, optionally substituted phenyl, and optionally substituted 5- or 6-membered heteroaryl;
R^{1a} is selected from the group consisting of optionally substituted phenyl, 4- to 6-membered heterocyclyl, C₃-C₆ cycloalkyl, and optionally substituted 5- or 6-membered heteroaryl;
R^{1b} is selected from the group consisting of hydrogen and C₁-C₉ alkyl;
R^{1c} is selected from the group consisting of hydrogen and C₁-C₆ alkyl;
R^{2a}, R^{2b}, and R^{2c} are independently selected from the group consisting of hydrogen, halogen, C₁-C₉ alkyl, C₁-C₉ haloalkyl, C₃-C₈ cycloalkyl, C₁-C₈ alkoxy, C₁-C₈ alkylthio, —C(═O)OR⁴, —OC(═O)R⁴, —C(═O)NR⁴R⁵, —NR⁴C(═O)R⁵, —NR⁴R⁵, —OH, —SH, —S C(═O)R⁴, —SC(═O)SR⁴, —SC(═O)NR⁴R⁵, —NR⁴C(═O)SR⁵, —NR⁴C(═S)SR⁵, 4- to 6-membered heterocyclyl, optionally substituted phenyl, and optionally substituted 5- or 6-membered heteroaryl;
R^{3a} is selected from the group consisting of hydrogen, halogen, C₁-C₉ alkyl, optionally substituted phenyl, —C(═O)OR⁴, —C(═O)NR⁴R⁵, —C(═O)SR⁴, —CH₂OR⁴, —CH₂OC(═O)R⁴, and

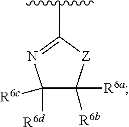

and
R^{3b} is selected from the group consisting of hydrogen, halogen, C₁-C₉ alkyl, and optionally substituted phenyl; or
R^{3a} and R^{3b} taken together with the carbon atom to which they are attached form a C₃-C₁₂ cycloalkyl;
R^{3c} is selected from the group consisting of hydrogen, halogen, C₁-C₉ alkyl, optionally substituted phenyl, —C(═O)OR⁴, —C(═O)NR⁴R⁵, —C(═O)SR⁴, —CH₂OR⁴, —CH₂OC(═O)R⁴, and

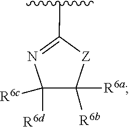

and
R^{3d} is selected from the group consisting of hydrogen, halogen, C₁-C₉ alkyl, and optionally substituted phenyl; or
R^{3c} and R^{3d} taken together with the two carbon atoms to which they are attached form a C₃-C₁₂ cycloalkyl;
R^{3e} is selected from the group consisting of hydrogen and C₁-C₆ alkyl;
Z at each occurrence is independently selected from the group consisting of —O—, —S—, and —NR⁷—;
R⁴ at each occurrence is independently selected from the group consisting of hydrogen, C₁-C₉ alkyl, C₃-C₆ cycloalkyl, and optionally substituted phenyl;
R⁵ at each occurrence is independently selected from the group consisting of hydrogen, C₁-C₉ alkyl, C₃-C₆ cycloalkyl, and optionally substituted phenyl;
R^{6a}, R^{6b}, R^{6c}, and R^{6d} at each occurrence are independently selected from the group consisting of hydrogen, C₁-C₁₂ alkyl, and optionally substituted phenyl; and
R⁷ at each occurrence is independently selected from the group consisting or hydrogen and C₁-C₆ alkyl.

In some embodiments, Compounds of the Disclosure are compounds having Formula (I-H), with the proviso that the compound of Formula (I-H) is not 2,2,4-trimethyl-N-phenyl-1,2-dihydroquinolin-6-amine, 2,2,4-trimethyl-N-phenyl-1,2,3,4-tetrahydroquinolin-6-amine, or 2,2,4-trimethyl-N-(p-tolyl)-1,2-dihydroquinolin-6-amine:

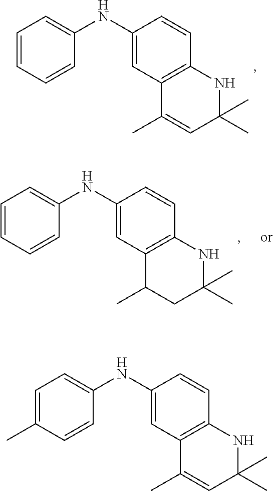

In some embodiments, Compounds of the Disclosure are compounds having Formula (I-H), wherein R^{2a}, R^{2b}, and R^{2c} are hydrogen.

In some embodiments, Compounds of the Disclosure are compounds having Formula (I-H), wherein if R^{2a}, R^{2b}, and R^{2c} are hydrogen, R^{3a}, R^{3b}, and R^{3c} are methyl, and R^{3d} is hydrogen, then R¹ is selected from the group consisting of optionally substituted C₁-C₁₂ alkyl, —CHR^{1a}R^{1b}, C₃-C₆ cycloalkyl, 4- to 6-membered heterocyclyl, and optionally substituted 5- or 6-membered heteroaryl.

In some embodiments, Compounds of the Disclosure are compounds having Formula (I-H), wherein if R¹ is phenyl, R^{2a}, R^{2b}, and R^{2c} are hydrogen, R^{3b} is methyl, and R^{3d} is hydrogen, then R^{3a} is selected from the group consisting of hydrogen, halogen, C₂-C₉ alkyl, optionally substituted phenyl, —C(═O)OR⁴, —C(═O)NR⁴R⁵, —C(═O)SR⁴, —CH₂OR⁴, —CH₂OC(═O)R⁴, and

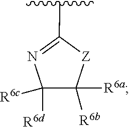

and
R^{3c} is selected from the group consisting of hydrogen, halogen, C₂-C₉ alkyl, optionally substituted phenyl, —C(═O)OR⁴, —C(═O)NR⁴R⁵, —C(═O)SR⁴, —CH₂OR⁴, —CH₂OC(═O)R⁴, and

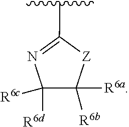

In another embodiment, Compounds of the Disclosure are compounds having Formula (II-H):

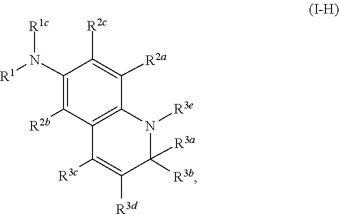

or a salt, solvate, or stereoisomer thereof, wherein R¹, R^{1c}, R^{2a}, R^{2b}, R^{2c}, R^{3a}, R^{3b}, R^{3c}, R^{3d}, and R^{3e} are as defined in connection with Formula (I-H).

In another embodiment, Compounds of the Disclosure are compounds having Formula (IIa-H):

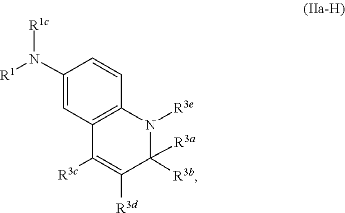

or a salt, solvate, or stereoisomer thereof, wherein R¹, R^{1c}, R^{3a}, R^{3b}, R^{3c}, R^{3d}, and R^{3e} are as defined in connection with Formula (I-H).

In another embodiment, Compounds of the Disclosure are compounds having Formula (III-H):

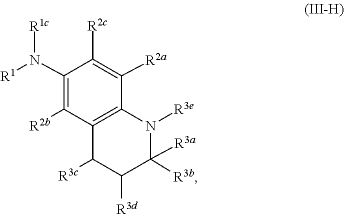

or a salt, solvate, or stereoisomer thereof, wherein R¹, R^{1c}, R^{2a}, R^{2b}, R^{2c}, R^{3a}, R^{3b}, R^{3c}, R^{3d}, and R^{3e} are as defined in connection with Formula (I-H).

In another embodiment, Compounds of the Disclosure are compounds having Formula (IIIa-H):

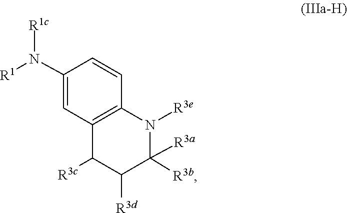

or a salt, solvate, or stereoisomer thereof, wherein R¹, R^{1c}, R^{3a}, R^{3b}, R^{3c}, R^{3d}, and R^{3e} are as defined in connection with Formula (I-H).

In some embodiments, Compounds of the Disclosure are compounds having any one of Formulae (II-H), (IIa-H), (III-H), or (IIIa-H), with the proviso that the compound of Formulae (II-H), (IIa-H), (III-H), or (IIIa-H), is not 2,2,4-trimethyl-N-phenyl-1,2-dihydroquinolin-6-amine or 2,2,4-trimethyl-N-phenyl-1,2,3,4-tetrahydroquinolin-6-amine.

In some embodiments, Compounds of the Disclosure are compounds having any one of Formulae (I-H), (II-H), (IIa-H), (III-H), or (IIIa-H), wherein R^{3a}, R^{3b}, and R^{3c} are independently selected from the group consisting of methyl, ethyl, propyl, iso-propyl, n-butyl, sec-butyl, iso-butyl, tert-butyl, pentyl, hexyl, heptyl, octyl, and nonyl.

In some embodiments, Compounds of the Disclosure are compounds having any one of Formulae (I-H), (II-H), (IIa-H), (III-H), or (IIIa-H), wherein R^{3a}, R^{3b}, and R^{3c} are methyl, ethyl, or iso-butyl.

In some embodiments, Compounds of the Disclosure are compounds having any one of Formulae (I-H), (II-H), (IIa-H), (III-H), or (IIIa-H), wherein R^{3a} and R^{3c} are methyl.

In some embodiments, Compounds of the Disclosure are compounds having any one of Formulae (I-H), (II-H), (IIa-H), (III-H), or (IIIa-H), wherein R^{3a} and R^{3c} are ethyl.

In some embodiments, Compounds of the Disclosure are compounds having any one of Formulae (I-H), (II-H), (IIa-H), (III-H), or (IIIa-H), wherein R^{3a} and R^{3c} are iso-butyl.

In some embodiments, Compounds of the Disclosure are compounds having any one of Formulae (I-H), (II-H), (IIa-H), (III-H), or (IIIa-H), wherein R^{3b} is methyl.

In some embodiments, Compounds of the Disclosure are compounds having any one of Formulae (I-H), (II-H), (IIa-H), (III-H), or (IIIa-H), wherein R^{3a} and R^{3b} are methyl; and R^{3c} and R^{3d} are hydrogen.

In some embodiments, Compounds of the Disclosure are compounds having any one of Formulae (I-H), (II-H), (IIa-H), (III-H), or (IIIa-H), wherein R^{3a} and R^{3b} are ethyl; and R^{3c} and R^{3d} are hydrogen.

In some embodiments, Compounds of the Disclosure are compounds having any one of Formulae (I-H), (II-H), (IIa-H), (III-H), or (IIIa-H), wherein R^{3a} is ethyl; R^{3b} is methyl; and R^{3c} and R^{3d} are hydrogen.

In some embodiments, Compounds of the Disclosure are compounds having any one of Formulae (I-H), (II-H), (IIa-H), (III-H), or (IIIa-H), wherein R^{3a} is —C(═O)OR⁴, —C(═O)NR⁴R⁵, —C(═O)SR⁴, —CH₂OR⁴, —CH₂OC(═O)R⁴, or

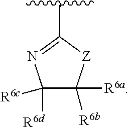

In some embodiments, Compounds of the Disclosure are compounds having any one of Formulae (I-H), (II-H), (IIa-H), (III-H), or (IIIa-H), wherein R^{3a} is —C(═O)OR⁴. In some embodiments, R^{3a} is —C(═O)OEt.

In some embodiments, Compounds of the Disclosure are compounds having any one of Formulae (I-H), (II-H), (IIa-H), (III-H), or (IIIa-H), wherein R^{3a} is —C(═O)NR⁴R⁵.

In some embodiments, Compounds of the Disclosure are compounds having any one of Formulae (I-H), (II-H), (IIa-H), (III-H), or (IIIa-H), wherein R^{3a} is —C(═O)SR⁴.

In some embodiments, Compounds of the Disclosure are compounds having any one of Formulae (I-H), (II-H), (IIa-H), (III-H), or (IIIa-H), wherein R^{3a} is —CH₂OR⁴.

In some embodiments, Compounds of the Disclosure are compounds having any one of Formulae (I-H), (II-H), (IIa-H), (III-H), or (IIIa-H), wherein R^{3a} is —CH₂OC(═O)R⁴.

In some embodiments, Compounds of the Disclosure are compounds having any one of Formulae (I-H), (II-H), (IIa-H), (III-H), or (IIIa-H), wherein R^{3a} is

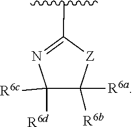

In some embodiments, Compounds of the Disclosure are compounds having any one of Formulae (I-H), (II-H), (IIa-H), (III-H), or (IIIa-H), wherein R^{3c} is —C(═O)OR⁴. In some embodiments, R^{3c} is —C(═O)OEt.

In some embodiments, Compounds of the Disclosure are compounds having any one of Formulae (I-H), (II-H), (IIa-H), (III-H), or (IIIa-H), wherein R^{3c} is —C(═O)NR⁴R⁵.

In some embodiments, Compounds of the Disclosure are compounds having any one of Formulae (I-H), (II-H), (IIa-H), (III-H), or (IIIa-H), wherein R^{3c} is —C(═O)SR⁴.

In some embodiments, Compounds of the Disclosure are compounds having any one of Formulae (I-H), (II-H), (IIa-H), (III-H), or (IIIa-H), wherein R^{3c} is —CH₂OR⁴.

In some embodiments, Compounds of the Disclosure are compounds having any one of Formulae (I-H), (II-H), (IIa-H), (III-H), or (IIIa-H), wherein R^{3c} is —CH₂OC(═O)R⁴.

In some embodiments, Compounds of the Disclosure are compounds having any one of Formulae (I-H), (II-H), (IIa-H), (III-H), or (IIIa-H), wherein R^{3c} is

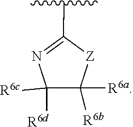

In some embodiments, Compounds of the Disclosure are compounds having any one of Formulae (I-H), (II-H), (IIa-H), (III-H), or (IIIa-H), wherein Z is —O—. In some embodiments, Z is —S—. In some embodiments, Z is —NR⁷—. In some embodiments, R⁷ is hydrogen. In some embodiments, R^{6a}, R^{6b}, R^{6c}, and R^{6d} are hydrogen.

In some embodiments, Compounds of the Disclosure are compounds having any one of Formulae (I-H), (II-H), (IIa-H), (III-H), or (IIIa-H), wherein each R⁴ is hydrogen or C₁-C₉ alkyl.

In some embodiments, Compounds of the Disclosure are compounds having any one of Formulae (I-H), (II-H), (IIa-H), (III-H), or (IIIa-H), wherein each R⁴ is ethyl.

In some embodiments, Compounds of the Disclosure are compounds having any one of Formulae (I-H), (II-H), (IIa-H), (III-H), or (IIIa-H), wherein each R⁴ is hydrogen.

In some embodiments, Compounds of the Disclosure are compounds having any one of Formulae (I-H), (II-H), (IIa-H), (III-H), or (IIIa-H), wherein R¹ is optionally substituted phenyl.

In some embodiments, Compounds of the Disclosure are compounds having any one of Formulae (I-H), (II-H), (IIa-H), (III-H), or (IIIa-H), wherein R¹ is C₁-C₁₂ alkyl.

In some embodiments, Compounds of the Disclosure are compounds having any one of Formulae (I-H), (II-H), (IIa-H), (III-H), or (IIIa-H), wherein R¹ is methyl, ethyl, propyl, iso-propyl, n-butyl, sec-butyl, iso-butyl, tert-butyl, pentyl, hexyl, heptyl, octyl, or nonyl.

In some embodiments, Compounds of the Disclosure are compounds having any one of Formulae (I-H), (II-H), (IIa-H), (III-H), or (IIIa-H), wherein R¹ is:

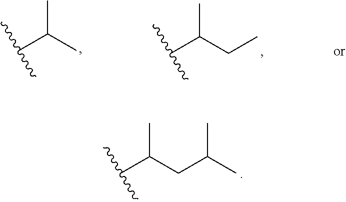

In some embodiments, Compounds of the Disclosure are compounds having any one of Formulae (I-H), (II-H), (IIa-H), (III-H), or (IIIa-H), wherein R¹ is —CHR^{1a}R^{1b}.

In some embodiments, Compounds of the Disclosure are compounds having any one of Formulae (I-H), (II-H), (IIa-H), (III-H), or (IIIa-H), wherein R^{1a} is optionally substituted phenyl.

In some embodiments, Compounds of the Disclosure are compounds having any one of Formulae (I-H), (II-H), (IIa-H), (III-H), or (IIIa-H), wherein R^{1a} is C₃-C₆ cycloalkyl.

In some embodiments, Compounds of the Disclosure are compounds having any one of Formulae (I-H), (II-H), (IIa-H), (III-H), or (IIIa-H), wherein R^{1a} is optionally substituted 5- or 6-membered heteroaryl.

In some embodiments, Compounds of the Disclosure are compounds having any one of Formulae (I-H), (II-H), (IIa-H), (III-H), or (IIIa-H), wherein R^{1a} is phenyl, 2-furyl, or 2-tetrahydrofuryl.

In some embodiments, Compounds of the Disclosure are compounds having any one of Formulae (I-H), (II-H), (IIa-H), (III-H), or (IIIa-H), wherein R^{1a} is phenyl.

In some embodiments, Compounds of the Disclosure are compounds having any one of Formulae (I-H), (II-H), (IIa-H), (III-H), or (IIIa-H), wherein R^{1a} is 2-furyl.

In some embodiments, Compounds of the Disclosure are compounds having any one of Formulae (I-H), (II-H), (IIa-H), (III-H), or (IIIa-H), wherein R^{1a} is 2-tetrahydrofuryl.

In some embodiments, Compounds of the Disclosure are compounds having any one of Formulae (I-H), (II-H), (IIa-H), (III-H), or (IIIa-H), wherein R^{1b} is hydrogen or methyl.

In some embodiments, Compounds of the Disclosure are compounds having any one of Formulae (I-H), (II-H), (IIa-H), (III-H), or (IIIa-H), wherein R^{1b} is hydrogen.

In some embodiments, Compounds of the Disclosure are compounds having any one of Formulae (I-H), (II-H), (IIa-H), (III-H), or (IIIa-H), wherein R^{1b} is methyl.

In some embodiments, Compounds of the Disclosure are compounds having any one of Formulae (I-H), (II-H), (IIa-H), (III-H), or (IIIa-H), wherein R^{1c} is C₁-C₆ alkyl.

In some embodiments, Compounds of the Disclosure are compounds having any one of Formulae (I-H), (II-H), (IIa-H), (III-H), or (IIIa-H), wherein R^{1c} is methyl.

In some embodiments, Compounds of the Disclosure are compounds having any one of Formulae (I-H), (II-H), (IIa-H), (III-H), or (IIIa-H), wherein R^{1c} is hydrogen.

e embodiments, Compounds of the Disclosure are compounds having any one of Formulae (I-H), (II-H), (IIa-H), (III-H), or (IIIa-H), wherein R^{3e} is C₁-C₆ alkyl.

In some embodiments, Compounds of the Disclosure are compounds having any one of Formulae (I-H), (II-H), (IIa-H), (III-H), or (IIIa-H), wherein R^{3e} is methyl.

In some embodiments, Compounds of the Disclosure are compounds having any one of Formulae (I-H), (II-H), (IIa-H), (III-H), or (IIIa-H), wherein R^{3e} is hydrogen.

In another embodiment, Compounds of the Disclosure are compounds having Formula (IV-H):

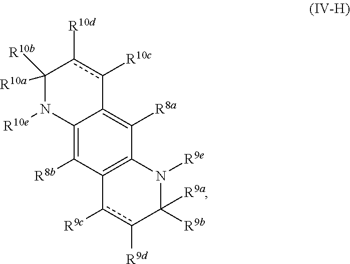

or a salt, solvate, or stereoisomer thereof, wherein:
each [symbol] is independently a single or a double bond;
R^{8a} and R^{8b} are independently selected from the group consisting of hydrogen, halogen, C₁-C₉ alkyl, C₁-C₉ haloalkyl, C₃-C₈ cycloalkyl, C₁-C₈ alkoxy, C₁-C₈ alkylthio, C(═O)OR⁴, —OC(═O)R⁴, —C(═O)NR⁴R⁵, —NR⁴C(═O)R⁵, —NR⁴R⁵, —OH, —SH, —SC(═O)R⁴, —SC(═O)SR⁴, —SC(═O)NR⁴R⁵, —NR⁴C(═O)SR⁵, —NR⁴C(═S)SR⁵, 4- to 6-membered heterocyclyl, optionally substituted phenyl, optionally substituted 5- or 6-membered heteroaryl, aryloxy, arylthio, and arylamino;
R^{9a} is selected from the group consisting of hydrogen, halogen, C₁-C₉ alkyl, optionally substituted phenyl, —C(═O)OR⁴, —C(═O)NR⁴R⁵, —C(═O)SR⁴, —CH₂OR⁴, —CH₂OC(═O)R⁴, and

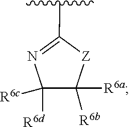

and
R^{9b} is selected from the group consisting of hydrogen, halogen, C₁-C₉ alkyl, and optionally substituted phenyl; or
R^{9a} and R^{9b} taken together with the carbon atom to which they are attached form a C₃-C₁₂ cycloalkyl;
R^{9c} is selected from the group consisting of hydrogen, halogen, C₁-C₉ alkyl, optionally substituted phenyl, —C(═O)OR⁴, —C(═O)NR⁴R⁵, —C(═O)SR⁴, —CH₂OR⁴, —CH₂OC(═O)R⁴, and

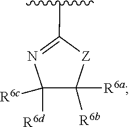

and
R^{9d} is selected from the group consisting of hydrogen, halogen, C₁-C₉ alkyl, and optionally substituted phenyl; or
R⁹ and R^{9d} taken together with the two carbon atoms to which they are attached form a C₃-C₁₂ cycloalkyl;
R^{9e} is selected from the group consisting of hydrogen and C₁-C₆ alkyl;
R^{10a} is selected from the group consisting of hydrogen, halogen, C₁-C₉ alkyl, optionally substituted phenyl, —C(═O)OR⁴, —C(═O)NR⁴R⁵, —C(═O)SR⁴, —CH₂OR⁴, —CH₂OC(═O)R⁴, and

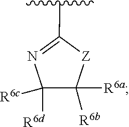

and
R^{10b} is selected from the group consisting of hydrogen, halogen, C₁-C₉ alkyl, and optionally substituted phenyl; or
R^{10a} and R^{10b} taken together with the carbon atom to which they are attached form a C₃-C₁₂ cycloalkyl;
R^{10c} is selected from the group consisting of hydrogen, halogen, C₁-C₉ alkyl, optionally substituted phenyl, —C(═O)OR⁴, —C(═O)NR⁴R⁵, —C(═O)SR⁴, —CH₂OR⁴, —CH₂OC(═O)R⁴, and

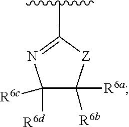

and
R^{10d} is selected from the group consisting of hydrogen, halogen, C₁-C₉ alkyl, and optionally substituted phenyl; or
R^{10c} and R^{10d} taken together with the two carbon atoms to which they are attached form a C₃-C₁₂ cycloalkyl;
R^{10e} is selected from the group consisting of hydrogen and C₁-C₆ alkyl;
Z at each occurrence is independently selected from the group consisting of —O—, —S—, and —NR⁷—;
R⁴ at each occurrence is independently selected from the group consisting of hydrogen, C₁-C₉ alkyl, C₃-C₆ cycloalkyl, and optionally substituted phenyl; and
R⁵ at each occurrence is independently selected from the group consisting of hydrogen, C₁-C₉ alkyl, C₃-C₆ cycloalkyl, and optionally substituted phenyl;
R^{6a}, R^{6b}, R^{6c}, and R^{6d} at each occurrence are independently selected from the group consisting of hydrogen, C₁-C₁₂ alkyl, and optionally substituted phenyl; and
R⁷ at each occurrence is independently selected from the group consisting or hydrogen and C₁-C₆ alkyl.

In another embodiment, Compounds of the Disclosure are compounds having Formula (V-H):

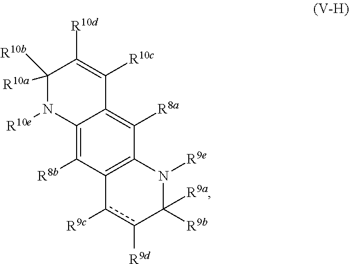

or a salt, solvate, or stereoisomer thereof, wherein R^{8a}, R^{8b}, R^{9a}, R^{9b}, R^{9c}, R^{9d}, R^{9e}, R^{10a}, R^{10b}, R^{10c}, R^{10d}, and R^{10e} are as defined in connection with Formula (IV-H).

In another embodiment, Compounds of the Disclosure are compounds having Formula (VI-H):

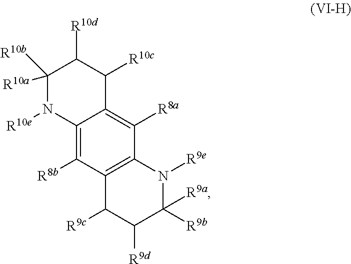

or a salt, solvate, or stereoisomer thereof, wherein R^{8a}, R^{8b}, R^{9a}, R^{9b}, R^{9c}, R^{9d}, R^{9e}, R^{10a}, R^{10b}, R^{10c}, R^{10d}, R^{10e} are as defined in connection with Formula (IV-H).

In some embodiments, Compounds of the Disclosure are compounds having any one of Formulae (IV-H), (V-H), or (VI-H), wherein R^{8a} and R^{8b} are hydrogen.

In some embodiments, Compounds of the Disclosure are compounds having any one of Formulae (IV-H), (V-H), or (VI-H), wherein R^{8a} and R^{8b} are methyl.

In some embodiments, Compounds of the Disclosure are compounds having any one of Formulae (IV-H), (V-H), or (VI-H), wherein R^{9a}, R^{9b}b, and R^{9c} are independently selected from the group consisting of methyl, ethyl, propyl, iso-propyl, n-butyl, sec-butyl, iso-butyl, tert-butyl, pentyl, hexyl, heptyl, octyl, and nonyl.

In some embodiments, Compounds of the Disclosure are compounds having any one of Formulae (IV-H), (V-H), or (VI-H), wherein R^{9a}, R^{9b}, and R^{9c} are methyl, ethyl, or iso-butyl.

In some embodiments, Compounds of the Disclosure are compounds having any one of Formulae (IV-H), (V-H), or (VI-H), wherein R^{9a} and R^{9c} are methyl.

In some embodiments, Compounds of the Disclosure are compounds having any one of Formulae (IV-H), (V-H), or (VI-H), wherein R^{9a} and R^{9c} are ethyl.

In some embodiments, Compounds of the Disclosure are compounds having any one of Formulae (IV-H), (V-H), or (VI-H), wherein R^{9a} and R^{9c} are iso-butyl.

In some embodiments, Compounds of the Disclosure are compounds having any one of Formulae (IV-H), (V-H), or (VI-H), wherein Rob is methyl.

In some embodiments, Compounds of the Disclosure are compounds having any one of Formulae (IV-H), (V-H), or (VI-H), wherein R^{9a} and R^{9b} are methyl; and R^{9c} and R^{9d} are hydrogen.

In some embodiments, Compounds of the Disclosure are compounds having any one of Formulae (IV-H), (V-H), or (VI-H), wherein R^{9a} and R^{9b} are ethyl; and R^{9c} and R^{9d} are hydrogen.

In some embodiments, Compounds of the Disclosure are compounds having any one of Formulae (IV-H), (V-H), or (VI-H), wherein R^{9a} is ethyl; R^{9b} is methyl; and R^{9c} and Rod are hydrogen.

In some embodiments, Compounds of the Disclosure are compounds having any one of Formulae (IV-H), (V-H), or (VI-H), wherein is —C(═O)OR⁴, —C(═O)NR⁴R⁵, —C(═O)SR⁴, —CH₂OR⁴, —CH₂OC(═O)R⁴, or

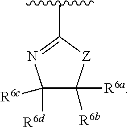

In some embodiments, Compounds of the Disclosure are compounds having any one of Formulae (IV-H), (V-H), or (VI-H), wherein R^{9a} is —C(═O)OR⁴. In some embodiments, R^{9a} is —C(═O)OEt.

In some embodiments, Compounds of the Disclosure are compounds having any one of Formulae (IV-H), (V-H), or (VI-H), wherein R^{9a} is —C(═O)NR⁴R⁵.

In some embodiments, Compounds of the Disclosure are compounds having any one of Formulae (IV-H), (V-H), or (VI-H), wherein R^{9a} is —C(═O)SR⁴.

In some embodiments, Compounds of the Disclosure are compounds having any one of Formulae (IV-H), (V-H), or (VI-H), wherein R^{9a} is —CH₂OR⁴.

In some embodiments, Compounds of the Disclosure are compounds having any one of Formulae (IV-H), (V-H), or (VI-H), wherein R^{9a} is —CH₂OC(═O)R⁴.

In some embodiments, Compounds of the Disclosure are compounds having any one of Formulae (IV-H), (V-H), or (VI-H), wherein R^{9a} is

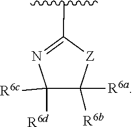

In some embodiments, Compounds of the Disclosure are compounds having any one of Formulae (IV-H), (V-H), or (VI-H), wherein R^{9c} is —C(═O)OR⁴. In some embodiments, R^{9c} is —C(═O)OEt.

In some embodiments, Compounds of the Disclosure are compounds having any one of Formulae (IV-H), (V-H), or (VI-H), wherein R^{9c} is —C(═O)NR⁴R⁵.

In some embodiments, Compounds of the Disclosure are compounds having any one of Formulae (IV-H), (V-H), or (VI-H), wherein R^{9c} is —C(═O)SR⁴.

In some embodiments, Compounds of the Disclosure are compounds having any one of Formulae (IV-H), (V-H), or (VI-H), wherein R^{9c} is —CH₂OR⁴.

In some embodiments, Compounds of the Disclosure are compounds having any one of Formulae (IV-H), (V-H), or (VI-H), wherein R^{9c} is —CH₂OC(═O)R⁴.

In some embodiments, Compounds of the Disclosure are compounds having any one of Formulae (IV-H), (V-H), or (VI-H), wherein R^{9c} is

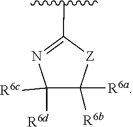

In some embodiments, Compounds of the Disclosure are compounds having any one of Formulae (IV-H), (V-H), or (VI-H), wherein R^{10a}, R^{10b}, and R^{10c} are independently selected from the group consisting of methyl, ethyl, propyl, iso-propyl, n-butyl, sec-butyl, iso-butyl, tert-butyl, pentyl, hexyl, heptyl, octyl, and nonyl.

In some embodiments, Compounds of the Disclosure are compounds having any one of Formulae (IV-H), (V-H), or (VI-H), wherein R^{10a}, R^{10b}, and R^{10c} are methyl, ethyl, or iso-butyl.

In some embodiments, Compounds of the Disclosure are compounds having any one of Formulae (IV-H), (V-H), or (VI-H), wherein R^{10a} and R^{10c} are methyl.

In some embodiments, Compounds of the Disclosure are compounds having any one of Formulae (IV-H), (V-H), or (VI-H), wherein R^{10a} and R^{10c} are ethyl.

In some embodiments, Compounds of the Disclosure are compounds having any one of Formulae (IV-H), (V-H), or (VI-H), wherein R^{10a} and R^{10c} are iso-butyl.

In some embodiments, Compounds of the Disclosure are compounds having any one of Formulae (IV-H), (V-H), or (VI-H), wherein R^{10b} is methyl.

In some embodiments, Compounds of the Disclosure are compounds having any one of Formulae (IV-H), (V-H), or (VI-H), wherein R^{10a} and R^{10b} are methyl; and R^{10c} and R^{10d} are hydrogen.

In some embodiments, Compounds of the Disclosure are compounds having any one of Formulae (IV-H), (V-H), or (VI-H), wherein R^{10a} and R^{10b} are ethyl; and R^{10c} and R^{10d} are hydrogen.

In some embodiments, Compounds of the Disclosure are compounds having any one of Formulae (IV-H), (V-H), or (VI-H), wherein R^{10a} is ethyl; R^{10b} is methyl; and R^{10c} and R^{10d} are hydrogen.

In some embodiments, Compounds of the Disclosure are compounds having any one of Formulae (IV-H), (V-H), or (VI-H), wherein R^{10a} is —C(═O)OR⁴, —C(═O)NR⁴R⁵, —C(═O)SR⁴, —CH₂OR⁴, —CH₂OC(═O)R⁴, or

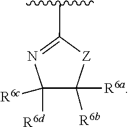

In some embodiments, Compounds of the Disclosure are compounds having any one of Formulae (IV-H), (V-H), or (VI-H), wherein R^{10a} is —C(═O)OR⁴. In some embodiments, R^{10a} is —C(═O)OEt.

In some embodiments, Compounds of the Disclosure are compounds having any one of Formulae (IV-H), (V-H), or (VI-H), wherein R^{10a} is —C(═O)NR⁴R⁵.

In some embodiments, Compounds of the Disclosure are compounds having any one of Formulae (IV-H), (V-H), or (VI-H), wherein R^{10a} is —C(═O)SR⁴.

In some embodiments, Compounds of the Disclosure are compounds having any one of Formulae (IV-H), (V-H), or (VI-H), wherein R^{10a} is —CH₂OR⁴.

In some embodiments, Compounds of the Disclosure are compounds having any one of Formulae (IV-H), (V-H), or (VI-H), wherein R^{10a} is —CH₂OC(═O)R⁴.

In some embodiments, Compounds of the Disclosure are compounds having any one of Formulae (IV-H), (V-H), or (VI-H), wherein R^{10a} is

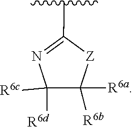

In some embodiments, Compounds of the Disclosure are compounds having any one of Formulae (IV-H), (V-H), or (VI-H), wherein R^{10c} is —C(═O)OR⁴. In some embodiments, R^{10c} is —C(═O)OEt.

In some embodiments, Compounds of the Disclosure are compounds having any one of Formulae (IV-H), (V-H), or (VI-H), wherein R^{10c} is —C(═O)NR⁴R⁵.

In some embodiments, Compounds of the Disclosure are compounds having any one of Formulae (IV-H), (V-H), or (VI-H), wherein R^{10c} is —C(═O)SR⁴.

In some embodiments, Compounds of the Disclosure are compounds having any one of Formulae (IV-H), (V-H), or (VI-H), wherein R^{10c} is —CH₂OR⁴.

In some embodiments, Compounds of the Disclosure are compounds having any one of Formulae (IV-H), (V-H), or (VI-H), wherein R^{10c} is —CH₂OC(═O)R⁴.

In some embodiments, Compounds of the Disclosure are compounds having any one of Formulae (IV-H), (V-H), or (VI-H), wherein R^{10c} is

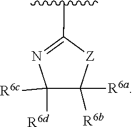

In some embodiments, Compounds of the Disclosure are compounds having any one of Formulae (IV-H), (V-H), or (VI-H), wherein Z is —O—. In some embodiments, Z is —S—. In some embodiments, Z is —NR⁷—. In some embodiments, R⁷ is hydrogen. In some embodiments, R^{6a}, R^{6b}, R^{6c}, and R^{6d} are hydrogen.

In some embodiments, Compounds of the Disclosure are compounds having any one of Formulae (IV-H), (V-H), or (VI-H), wherein each R⁴ is hydrogen or C₁-C₉ alkyl.

In some embodiments, Compounds of the Disclosure are compounds having any one of Formulae (IV-H), (V-H), or (VI-H), wherein each R⁴ is ethyl.

In some embodiments, Compounds of the Disclosure are compounds having any one of Formulae (IV-H), (V-H), or (VI-H), wherein each R⁴ is hydrogen.

In some embodiments, Compounds of the Disclosure are compounds having any one of Formulae (IV-H), (V-H), or (VI-H), wherein R^{9a} and R^{10a} are the same, e.g., R^{9a} and R^{10a} are both methyl, both ethyl, or both iso-butyl.

In some embodiments, Compounds of the Disclosure are compounds having any one of Formulae (IV-H), (V-H), or (VI-H), wherein R^{9b} and R^{10b} are the same, e.g., R^{9a} and R^{10a} are both methyl, both ethyl, or both iso-butyl.

In some embodiments, Compounds of the Disclosure are compounds having any one of Formulae (IV-H), (V-H), or (VI-H), wherein R^{9c} and R^{10c} are the same, e.g., R^{9a} and R^{10a} are both methyl, both ethyl, or both iso-butyl.

In some embodiments, Compounds of the Disclosure are compounds having any one of Formulae (IV-H), (V-H), or (VI-H), wherein R^{9d} and R^{10d} are the same, e.g., R^{9a} and R^{10a} are both hydrogen.

In some embodiments, Compounds of the Disclosure are compounds having any one of Formulae (IV-H), (V-H), or (VI-H), wherein R^{9e} is C₁-C₆ alkyl.

In some embodiments, Compounds of the Disclosure are compounds having any one of Formulae (IV-H), (V-H), or (VI-H), wherein R^{9e} is methyl.

In some embodiments, Compounds of the Disclosure are compounds having any one of Formulae (IV-H), (V-H), or (VI-H), wherein R^{9e} is hydrogen.

In some embodiments, Compounds of the Disclosure are compounds having any one of Formulae (IV-H), (V-H), or (VI-H), wherein R^{10e} is C₁-C₆ alkyl.

In some embodiments, Compounds of the Disclosure are compounds having any one of Formulae (IV-H), (V-H), or (VI-H), wherein R^{10e} is methyl.

In some embodiments, Compounds of the Disclosure are compounds having any one of Formulae (IV-H), (V-H), or (VI-H), wherein R^{10e} is hydrogen.

In some embodiments, Compounds of the Disclosure are any one or more of the compounds of Table H, or a salt or solvate thereof.

TABLE H

| Compound No. | Structure |
|---|---|
| 1-H | 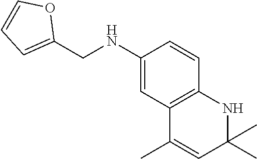 [SMILES: CC1=CC(C)(C)Nc2ccc(NCc3ccco3)cc21] |
| 2-H | 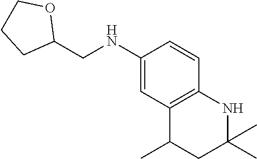 [SMILES: CC1CC(C)(C)Nc2ccc(NCC3CCCO3)cc21] |
| 3-H | 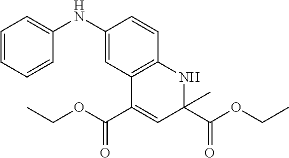 [SMILES: CCOC(=O)C1=CC(C)(C(=O)OCC)Nc2ccc(Nc3ccccc3)cc21] |
| 4-H | 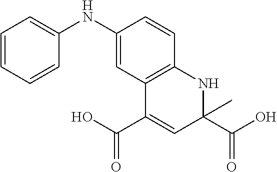 [SMILES: CC1(C(=O)O)C=C(C(=O)O)c2cc(Nc3ccccc3)ccc2N1] |
| 5-H | 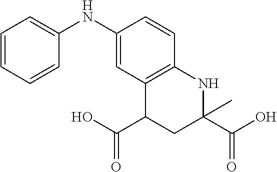 [SMILES: CC1(C(=O)O)CC(C(=O)O)c2cc(Nc3ccccc3)ccc2N1] |
| 6-H | 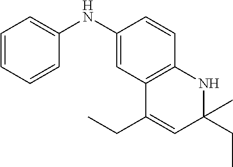 [SMILES: CCC1=CC(C)(CC)Nc2ccc(Nc3ccccc3)cc21] |
| 7-H | 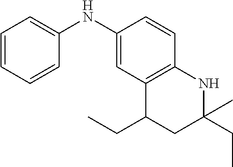 [SMILES: CCC1CC(C)(CC)Nc2ccc(Nc3ccccc3)cc21] |
| 8-H | 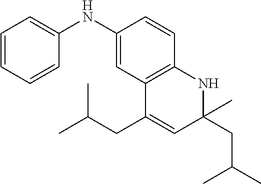 [SMILES: CC(C)CC1=CC(C)(CC(C)C)Nc2ccc(Nc3ccccc3)cc21] |
| 9-H | 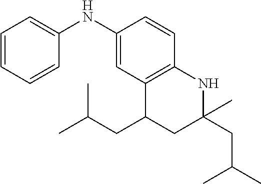 [SMILES: CC(C)CC1CC(C)(CC(C)C)Nc2ccc(Nc3ccccc3)cc21] |
| 10-H | 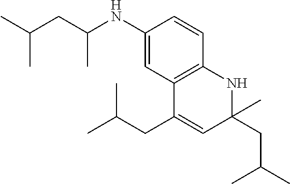 [SMILES: CC(C)CC1=CC(C)(CC(C)C)Nc2ccc(NC(C)CC(C)C)cc21] |
| 11-H | 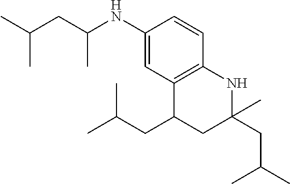 [SMILES: CC(C)CC(C)Nc1ccc2c(c1)C(CC(C)C)CC(C)(CC(C)C)N2] |
| 12-H | 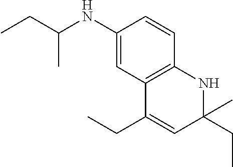 [SMILES: CCC1=CC(C)(CC)Nc2ccc(NC(C)CC)cc21] |
| 13-H | 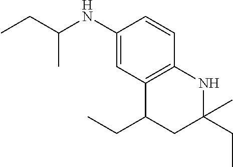 [SMILES: CCC(C)Nc1ccc2c(c1)C(CC)CC(C)(CC)N2] |
| 14-H | 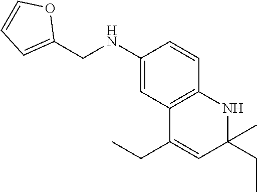 [SMILES: CCC1=CC(C)(CC)Nc2ccc(NCc3ccco3)cc21] |
| 15-H | 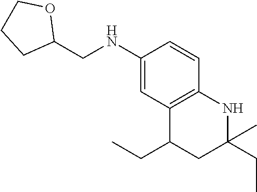 [SMILES: CCC1CC(C)(CC)Nc2ccc(NCC3CCCO3)cc21] |
| 16-H | 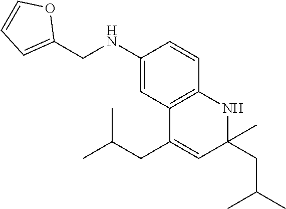 [SMILES: CC(C)CC1=CC(C)(CC(C)C)Nc2ccc(NCc3ccco3)cc21] |
| 17-H | 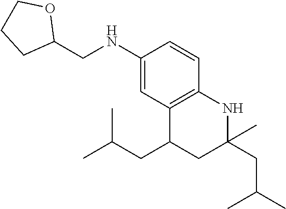 [SMILES: CC(C)CC1CC(C)(CC(C)C)Nc2ccc(NCC3CCCO3)cc21] |
| 18-H | 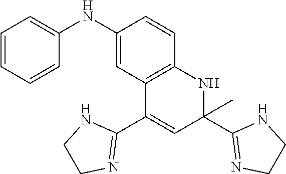 [SMILES: CC1(C2=NCCN2)C=C(C2=NCCN2)c2cc(Nc3ccccc3)ccc2N1] |
| 19-H | 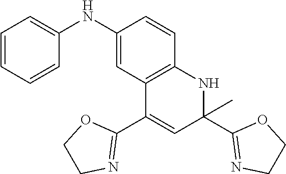 [SMILES: CC1(C2=NCCO2)C=C(C2=NCCO2)c2cc(Nc3ccccc3)ccc2N1] |
| 20-H | 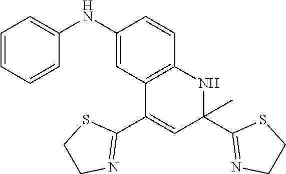 [SMILES: CC1(C2=NCCS2)C=C(C2=NCCS2)c2cc(Nc3ccccc3)ccc2N1] |
| 21-H | 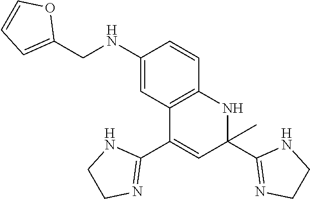 [SMILES: CC1(C2=NCCN2)C=C(C2=NCCN2)c2cc(NCc3ccco3)ccc2N1] |
| 22-H | 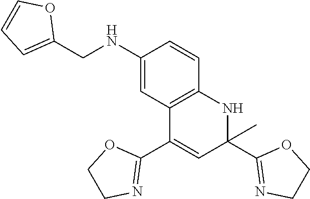 [SMILES: CC1(C2=NCCO2)C=C(C2=NCCO2)c2cc(NCc3ccco3)ccc2N1] |
| 23-H | 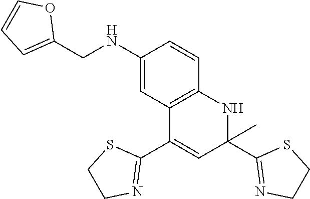 [SMILES: CC1(C2=NCCS2)C=C(C2=NCCS2)c2cc(NCc3ccco3)ccc2N1] |
| 24-H | 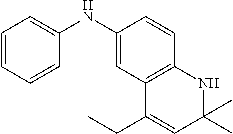 [SMILES: CCC1=CC(C)(C)Nc2ccc(Nc3ccccc3)cc21] |
| 25-H | 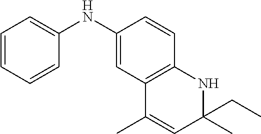 [SMILES: CCC1(C)C=C(C)c2cc(Nc3ccccc3)ccc2N1] |
| 26-H | 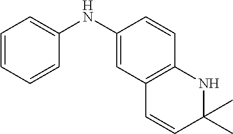 [SMILES: CC1(C)C=Cc2cc(Nc3ccccc3)ccc2N1] |
| 27-H | 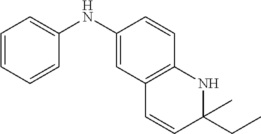 [SMILES: CCC1(C)C=Cc2cc(Nc3ccccc3)ccc2N1] |
| 28-H | 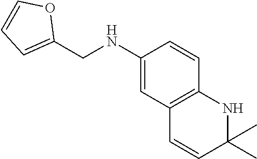 [SMILES: CC1(C)C=Cc2cc(NCc3ccco3)ccc2N1] |
| 29-H | 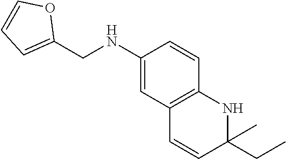 [SMILES: CCC1(C)C=Cc2cc(NCc3ccco3)ccc2N1] |
| 30-H | 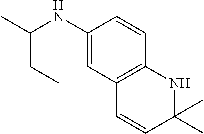 [SMILES: CCC(C)Nc1ccc2c(c1)C=CC(C)(C)N2] |
| 31-H | 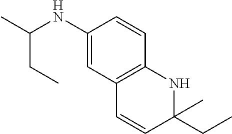 [SMILES: CCC(C)Nc1ccc2c(c1)C=CC(C)(CC)N2] |
| 32-H | 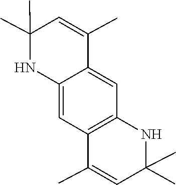 |
| 33-H | 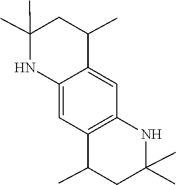 |
| 34-H | 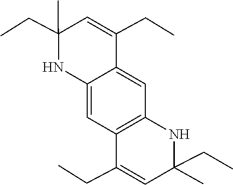 [SMILES: CCC1=CC(C)(CC)Nc2cc3c(cc21)NC(C)(CC)C=C3CC] |
| 35-H | 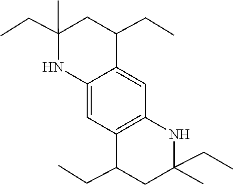 [SMILES: CCC1CC(C)(CC)Nc2cc3c(cc21)NC(C)(CC)CC3CC] |
| 36-H | 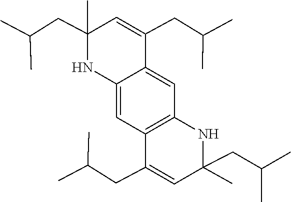 [SMILES: CC(C)CC1=CC(C)(CC(C)C)Nc2cc3c(cc21)NC(C)(CC(C)C)C=C3CC(C)C] |
| 37-H | 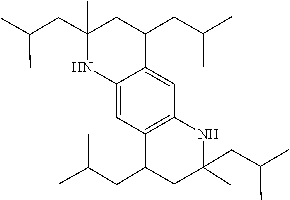 [SMILES: CC(C)CC1CC(C)(CC(C)C)Nc2cc3c(cc21)NC(C)(CC(C)C)CC3CC(C)C] |
| 38-H | 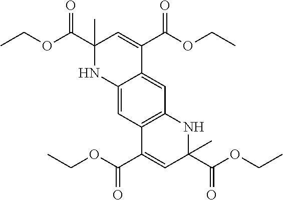 [SMILES: CCOC(=O)C1=CC(C)(C(=O)OCC)Nc2cc3c(cc21)NC(C)(C(=O)OCC)C=C3C(=O)OCC] |
| 39-H | 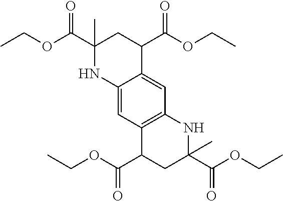 [SMILES: CCOC(=O)C1CC(C)(C(=O)OCC)Nc2cc3c(cc21)NC(C)(C(=O)OCC)CC3C(=O)OCC] |
| 40-H | 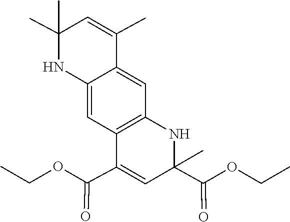 [SMILES: CCOC(=O)C1=CC(C)(C(=O)OCC)Nc2cc3c(cc21)NC(C)(C)C=C3C] |
| 41-H | 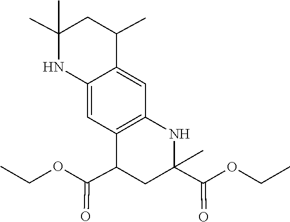 [SMILES: CCOC(=O)C1CC(C)(C(=O)OCC)Nc2cc3c(cc21)NC(C)(C)CC3C] |
| 42-H | 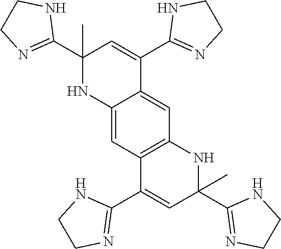 [SMILES: CC1(C2=NCCN2)C=C(C2=NCCN2)c2cc3c(cc2N1)C(C1=NCCN1)=CC(C)(C1=NCCN1)N3] |
| 43-H | 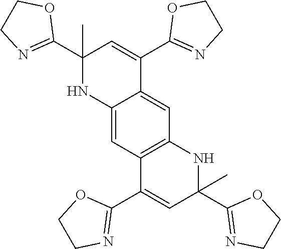 [SMILES: CC1(C2=NCCO2)C=C(C2=NCCO2)c2cc3c(cc2N1)C(C1=NCCO1)=CC(C)(C1=NCCO1)N3] |
| 44-H | 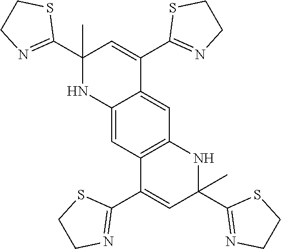 [SMILES: CC1(C2=NCCS2)C=C(C2=NCCS2)c2cc3c(cc2N1)C(C1=NCCS1)=CC(C)(C1=NCCS1)N3] |
| 45-H | 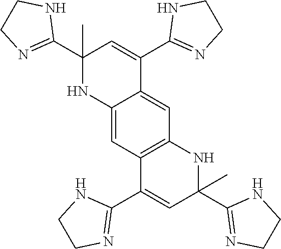 [SMILES: CC1(C2=NCCN2)C=C(C2=NCCN2)c2cc3c(cc2N1)C(C1=NCCN1)=CC(C)(C1=NCCN1)N3] |
| 46-H | 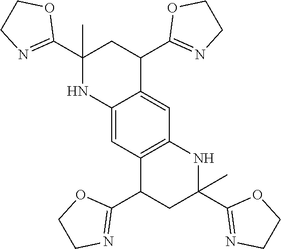 [SMILES: CC1(C2=NCCO2)CC(C2=NCCO2)c2cc3c(cc2N1)C(C1=NCCO1)CC(C)(C1=NCCO1)N3] |
| 47-H | 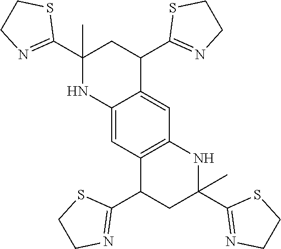 [SMILES: CC1(C2=NCCS2)CC(C2=NCCS2)c2cc3c(cc2N1)C(C1=NCCS1)CC(C)(C1=NCCS1)N3] |
| 48-H | 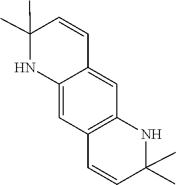 |
| 49-H | 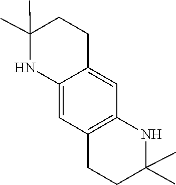 |
| 50-H | 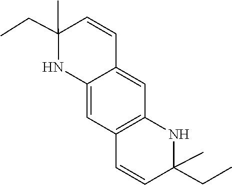 [SMILES: CCC1(C)C=Cc2cc3c(cc2N1)C=CC(C)(CC)N3] |
| 51-H | 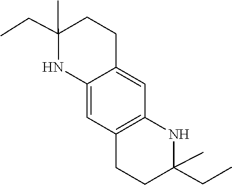 [SMILES: CCC1(C)CCc2cc3c(cc2N1)CCC(C)(CC)N3] |
| 52-H | 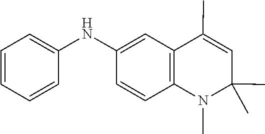 [SMILES: CC1=CC(C)(C)N(C)c2ccc(Nc3ccccc3)cc21] |
| 53-H | 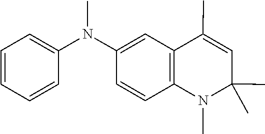 [SMILES: CC1=CC(C)(C)N(C)c2ccc(N(C)c3ccccc3)cc21] |

Compounds having Formula (I-H) can be prepared by a three-step process comprising i) reacting a secondary arylamine with sodium nitrite in acid, ii) reducing the resulting nitroso intermediate to an amine, and iii) reacting the resulting amine with a ketone, e.g., acetone, or aldehyde, as shown in Scheme 1-H. Reduction of the nitroso intermediate to an amine can be carried out using any methods known in the art, such as treatment with sodium borohydride (NaBH₄) in ethanol.

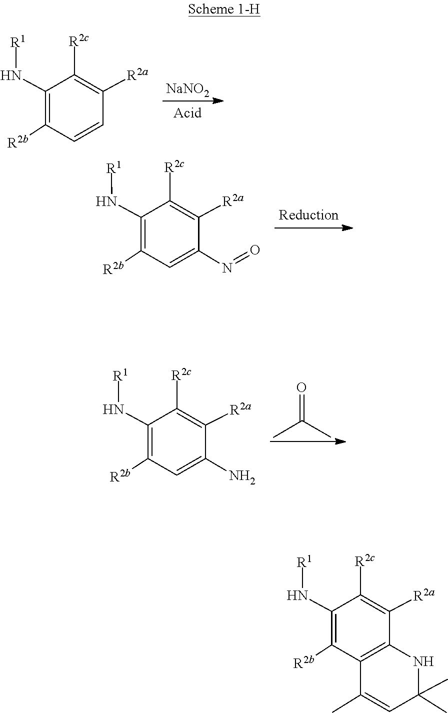

Compounds having Formula (IV-H) can be prepared by reacting a 1,4-diaminobenzene with a ketone, e.g., acetone, or aldehyde, as shown in Scheme 2-H.

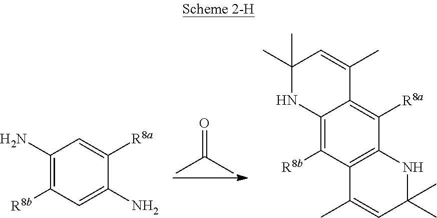

Compounds having Formulae (I-H) or (IV-H) can also be prepared by further reduction of compounds synthesized using Scheme 1-H or 2-H, as shown in Schemes 3-H and 4-H, respectively. Reduction may be carried out using any methods known in the art, such as exposure to hydrogen over a palladium on carbon (Pd/C) catalyst.

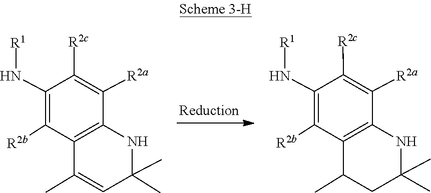

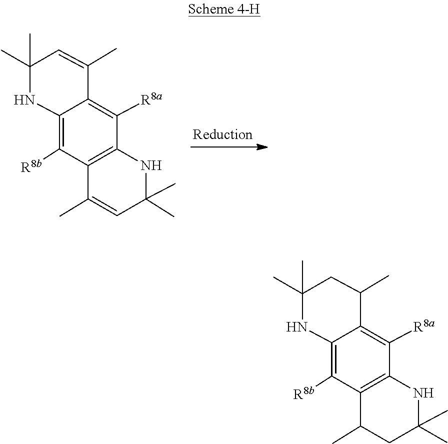

In some embodiments, Compounds of the Disclosure are any one or more of the compounds of Table I.

TABLE I

| Compound No. | Structure |
|---|---|
| 1-I | 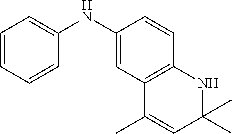 [SMILES: CC1=CC(C)(C)Nc2ccc(Nc3ccccc3)cc21] |
| 2-I | 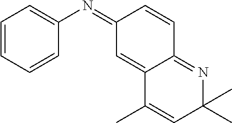 [SMILES: CC1=CC(C)(C)N=C2C=C/C(=N/c3ccccc3)C=C12] |
| 3-I | 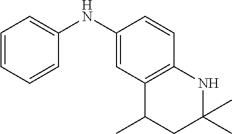 [SMILES: CC1CC(C)(C)Nc2ccc(Nc3ccccc3)cc21] |
| 4-I | 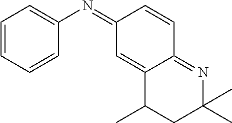 [SMILES: CC1CC(C)(C)N=C2C=C/C(=N/c3ccccc3)C=C21] |
| 5-I | 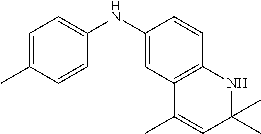 |
| 6-I | 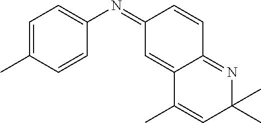 |
| 7-I | 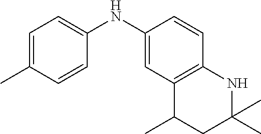 |
| 8-I | 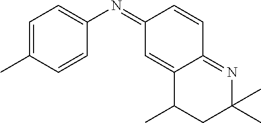 |

In some embodiments, Compounds of the Disclosure are compounds described in U.S. Provisional Appl. No. 63/611,865, which is fully incorporated by reference herein in its entirety.

In some embodiments, Compounds of the Disclosure are compounds having Formula (I-J):

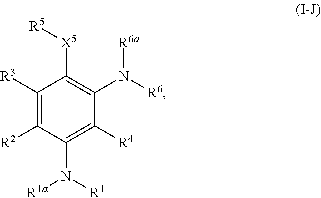

or a salt, solvate, or stereoisomer thereof, wherein:
R¹ is selected from the group consisting of optionally substituted C₁-C₁₂ alkyl, —CHR^{1c}R^{1d}, C₃-C₆ cycloalkyl, 4- to 6-membered heterocyclyl, optionally substituted phenyl, and optionally substituted 5- or 6-membered heteroaryl;
R^{1a} is selected from the group consisting of hydrogen and C₁-C₄ alkyl;
R^{1c} is selected from the group consisting of optionally substituted phenyl, 4- to 6-membered heterocyclyl, C₃-C₆ cycloalkyl, and optionally substituted 5- or 6-membered heteroaryl;
R^{1d} is selected from the group consisting of hydrogen and C₁-C₉ alkyl;
R², R³, and R⁴ are independently selected from the group consisting of hydrogen, halogen, C₁-C₉ alkyl, C₁-C₉ haloalkyl, C₃-C₈ cycloalkyl, C₁-C₈ alkoxy, C₁-C₈ alkylthio, —C(═O)OR⁷, —OC(═O)R⁷, —C(═O)NR⁷R⁸, —NR⁷C(═O)R⁸, —NR⁷R⁸, —OH, —SH, —SC(═O)R⁷, —SC(═O)SR⁷, —SC(═O)NR⁷R⁸, —NR⁷C(═O)SR⁸, —NR⁷C(═S)SR⁸, 4- to 6-membered heterocyclyl, optionally substituted phenyl, and optionally substituted 5- or 6-membered heteroaryl;
X⁵ is selected from the group consisting of —CR^{5a}R^{5b}—, —NR^{5a}—, —O—, and —S—;
R^{5a} is absent or is selected from the group consisting of hydrogen and C₁-C₄ alkyl;
R^{5b} is selected from the group consisting of hydrogen, halogen, C₁-C₉ alkyl, optionally substituted phenyl, —C(═O)OR⁷, —C(═O)NR⁷R⁸, —C(═O)SR⁷, —CH₂OR⁷, —CH₂OC(═O)R⁷, and

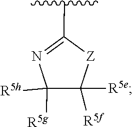

R^{6a} is absent or is selected from the group consisting of hydrogen and C₁-C₄ alkyl;
R⁵ is selected from the group consisting of hydrogen, optionally substituted C₁-C₁₂ alkyl, —CHR^{5c}R^{5d}, C₃-C₆ cycloalkyl, 4- to 6-membered heterocyclyl, optionally substituted phenyl, and optionally substituted 5- or 6-membered heteroaryl; or
R⁵ and R⁶ taken together with the atoms to which they are attached form an optionally substituted 5- or 6-membered heterocyclyl or an optionally substituted 5- or 6-membered heteroaryl;
R^{5c} is selected from the group consisting of optionally substituted phenyl, 4- to 6-membered heterocyclyl, C₃-C₆ cycloalkyl, and optionally substituted 5- or 6-membered heteroaryl;
R^{5d} is selected from the group consisting of hydrogen and C₁-C₉ alkyl;
R⁶ is selected from the group consisting of optionally substituted C₁-C₁₂ alkyl, —CHR^{6b}R^{6c}, C₃-C₆ cycloalkyl, 4- to 6-membered heterocyclyl, optionally substituted phenyl, and optionally substituted 5- or 6-membered heteroaryl; or
R⁵ and R⁶ taken together with the atoms to which they are attached form an optionally substituted 5- or 6-membered heterocyclyl or an optionally substituted 5- or 6-membered heteroaryl;
R^{6b} is selected from the group consisting of optionally substituted phenyl, 4- to 6-membered heterocyclyl, C₃-C₆ cycloalkyl, and optionally substituted 5- or 6-membered heteroaryl;
R^{6c} is selected from the group consisting of hydrogen and C₁-C₉ alkyl;
R⁷ and R⁸ at each occurrence are independently selected from the group consisting of hydrogen, C₁-C₉ alkyl, C₃-C₆ cycloalkyl, and optionally substituted phenyl; Z at each occurrence is independently selected from the group consisting of —O—, —S—, and —NR⁹—;
R^{5e}, R^{5f}, R^{5g}, and R^{5h} at each occurrence are independently selected from the group consisting of hydrogen, C₁-C₁₂ alkyl, and optionally substituted phenyl; and
R⁹ at each occurrence is independently selected from the group consisting of hydrogen and C₁-C₆ alkyl.

In some embodiments, Compounds of the Disclosure are compounds having Formula (I-J), wherein R⁵ and R⁶ taken together with the atoms to which they are attached form an optionally substituted 5- or 6-membered heterocyclyl or an optionally substituted 5- or 6-membered heteroaryl.

In some embodiments, Compounds of the Disclosure are compounds having Formula (II-J):

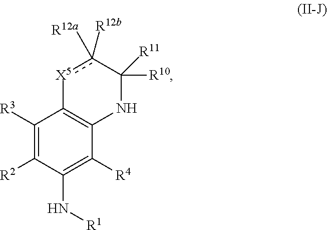

or a salt, solvate, or stereoisomer thereof, wherein:
R¹, R², R³, R⁴, and X⁵ are as defined in connection with Formula (I-J);
when X⁵ is —CR^{5a}R^{5b}— or —NR^{5a}, then [symbol] is a single or a double bond, and when X⁵ is —O— or —S—, then [symbol] is a single bond,
with the proviso that when [symbol] is a double bond, then R^{5a} and R^{12b} are absent;
R¹⁰ is selected from the group consisting of hydrogen, halogen, C₁-C₉ alkyl, optionally substituted phenyl, —C(═O)OR⁷, —C(═O)NR⁷R⁸, —C(═O)SR⁷, —CH₂OR⁷, —CH₂OC(═O)R⁷, and

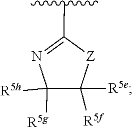

R¹¹ is selected from the group consisting of hydrogen, halogen, C₁-C₉ alkyl, and optionally substituted phenyl; or
R¹⁰ and R¹¹ taken together with the carbon atom to which they are attached form a C₃-C₁₂ cycloalkyl; and
R^{12a} and R^{12b} are independently selected from the group consisting of hydrogen, halogen, C₁-C₉ alkyl, and optionally substituted phenyl.

In some embodiments, Compounds of the Disclosure are compounds having Formula (III-J):

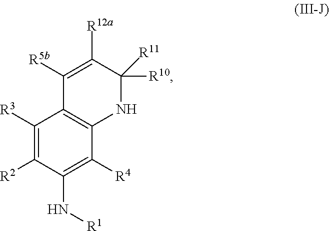

or a salt, solvate, or stereoisomer thereof, wherein:
R¹, R², R³, R⁴, and R^{5b} are as defined in connection with Formula (I-J); and
R¹⁰, R¹¹, and R^{12a} are as defined in connection with Formula (II-J).

In some embodiments, Compounds of the Disclosure are compounds having Formula (IV-J):

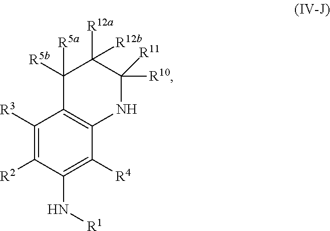

or a salt, solvate, or stereoisomer thereof, wherein:
R¹, R², R³, R⁴, R^{5a}, and R^{5b} are as defined in connection with Formula (I-J); and
R¹⁰, R¹¹, R^{12a}, and R^{12b} are as defined in connection with Formula (II-J).

In some embodiments, Compounds of the Disclosure are compounds having any one of Formulae (II-J)-(IV-J), wherein R^{5b} is hydrogen, C₁-C₉ alkyl, or optionally substituted phenyl.

In some embodiments, Compounds of the Disclosure are compounds having any one of Formulae (II-J)-(IV-J), wherein R^{5b} is hydrogen, methyl, or optionally substituted phenyl.

In some embodiments, Compounds of the Disclosure are compounds having Formulae (II-J) or (IV-J), wherein R^{5a} is hydrogen or C₁-C₄ alkyl.

In some embodiments, Compounds of the Disclosure are compounds having Formulae (II-J) or (IV-J), wherein R^{5a} is hydrogen or methyl.

In some embodiments, Compounds of the Disclosure are compounds having any one of Formulae (II-J)-(IV-J), wherein R¹⁰ and R¹¹ are independently hydrogen or C₁-C₉ alkyl.

In some embodiments, Compounds of the Disclosure are compounds having any one of Formulae (II-J)-(IV-J), wherein R¹⁰ and R¹¹ are hydrogen.

In some embodiments, Compounds of the Disclosure are compounds having any one of Formulae (II-J)-(IV-J), wherein R¹⁰ and R¹¹ are methyl.

In some embodiments, Compounds of the Disclosure are compounds having any one of Formulae (II-J)-(IV-J), wherein R^{12a} is hydrogen or C₁-C₉ alkyl.

In some embodiments, Compounds of the Disclosure are compounds having any one of Formulae (II-J)-(IV-J), wherein R^{12a} is hydrogen.

In some embodiments, Compounds of the Disclosure are compounds having Formula (V-J):

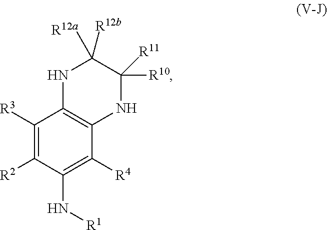

or a salt, solvate, or stereoisomer thereof, wherein:
R¹, R², R³, and R⁴ are as defined in connection with Formula (I-J); and
R¹⁰, R¹¹, R^{12a}, and R^{12b} are as defined in connection with Formula (II-J).

In some embodiments, Compounds of the Disclosure are compounds having Formula (VI-J):

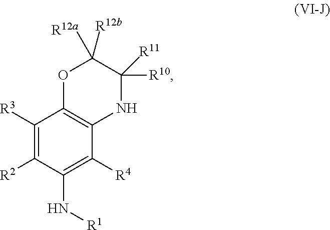

or a salt, solvate, or stereoisomer thereof, wherein:
R¹, R², R³, and R⁴ are as defined in connection with Formula (I-J); and
R¹⁰, R¹¹, R^{12a}, and R^{12b} are as defined in connection with Formula (II-J).

In some embodiments, Compounds of the Disclosure are compounds having Formula (VII-J):

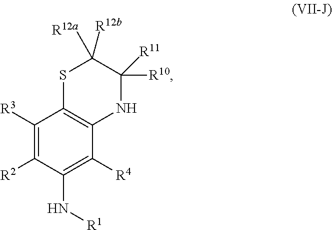

or a salt, solvate, or stereoisomer thereof, wherein:
R¹, R², R³, and R⁴ are as defined in connection with Formula (I-J); and
R¹⁰, R¹¹, R^{12a}, and R^{12b} are as defined in connection with Formula (II-J).

In some embodiments, Compounds of the Disclosure are compounds having any one of Formulae (V-J)-(VII-J), wherein R¹⁰ and R¹¹ are independently hydrogen or C₁-C₉ alkyl.

In some embodiments, Compounds of the Disclosure are compounds having any one of Formulae (V-J)-(VII-J), wherein R¹⁰ and R¹¹ are hydrogen.

In some embodiments, Compounds of the Disclosure are compounds having any one of Formulae (V-J)-(VII-J), wherein R^{12a} and R^{12b} are independently hydrogen or C₁-C₉ alkyl.

In some embodiments, Compounds of the Disclosure are compounds having any one of Formulae (V-J)-(VII-J), wherein R^{12a} and R^{12b} are hydrogen.

In some embodiments, Compounds of the Disclosure are compounds having any one of Formulae (V-J)-(VII)-J, wherein R¹⁰, R¹¹, R^{12a}, and R^{12b} are hydrogen.

In some embodiments, Compounds of the Disclosure are compounds having Formula (VIII):

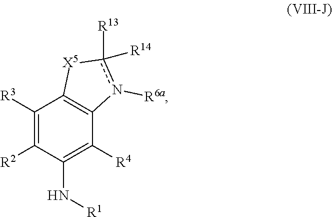

or a salt, solvate, or stereoisomer thereof, wherein:
R¹, R², R³, R⁴, X⁵, and R^{6a} are as defined in connection with Formula (I-J);
[symbol] is a single or a double bond, with the proviso that when [symbol] is a double bond, then R^{6a} and R¹³ are absent; and
R¹³ and R¹⁴ are selected from the group consisting of hydrogen and C₁-C₄ alkyl.

In some embodiments, Compounds of the Disclosure are compounds having Formula (IX-J):

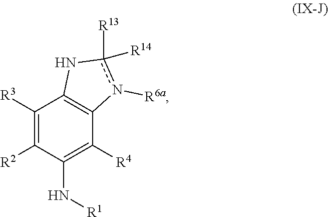

or a salt, solvate, or stereoisomer thereof, wherein:
R¹, R², R³, R₄, and R^{6a} are as defined in connection with Formula (I-J);
[symbol] is a single or a double bond; and
R¹³ and R¹⁴ are as defined in connection with Formula (VIII-J), with the proviso that when [symbol] is a double bond, then R^{6a} and R¹³ are absent.

In some embodiments, Compounds of the Disclosure are compounds having Formula (IX-J), wherein if [symbol] is a double bond, R¹⁴ is methyl, and R², R³, and R⁴ are hydrogen, then R¹ is not:

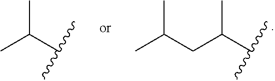

In some embodiments, Compounds of the Disclosure are compounds having Formula (IX-J), wherein the compound is not:

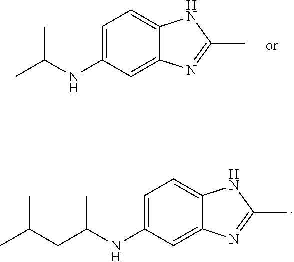

In some embodiments, Compounds of the Disclosure are compounds having Formula (X-J):

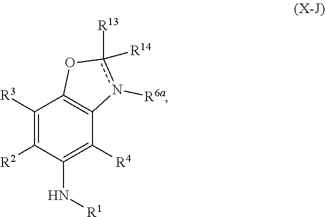

or a salt, solvate, or stereoisomer thereof, wherein:
R¹, R², R³, R⁴, and R^{6a} are as defined in connection with Formula (I-J);
[symbol] is a single or a double bond; and
R¹³ and R¹⁴ are as defined in connection with Formula (VIII-J),
with the proviso that when [symbol] is a double bond, then R^{6a} and R¹³ are absent.

In some embodiments, Compounds of the Disclosure are compounds having Formula (X-J), wherein if [symbol] is a double bond, R¹⁴ is methyl, and R², R³, and R⁴ are hydrogen, then R¹ is not:

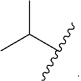 [SMILES: *C(C)C]

In some embodiments, Compounds of the Disclosure are compounds having Formula (X-J), wherein the compound is not:

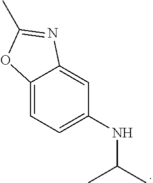

In some embodiments, Compounds of the Disclosure are compounds having Formula (XI-J):

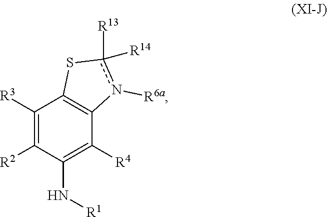

or a salt, solvate, or stereoisomer thereof, wherein:
R¹, R², R³, R⁴, and R^{6a} are as defined in connection with Formula (I-J);
[symbol] is a single or a double bond; and
R¹³ and R¹⁴ are as defined in connection with Formula (VIII-J),
with the proviso that when [symbol] is a double bond, then R^{6a} and R¹³ are absent.

In some embodiments, Compounds of the Disclosure are compounds having any one of Formulae (VIII-J)-(XI-J), wherein [symbol] is a double bond.

In some embodiments, Compounds of the Disclosure are compounds having any one of Formulae (VIII-J)-(XI-J), wherein [symbol] is a single bond.

In some embodiments, Compounds of the Disclosure are compounds having any one of Formulae (VIII-J)-(XI-J), wherein R^{6a} is hydrogen or methyl.

In some embodiments, Compounds of the Disclosure are compounds having any one of Formulae (VIII-J)-(XI-J), wherein R^{6a} is hydrogen.

In some embodiments, Compounds of the Disclosure are compounds having any one of Formulae (VIII-J)-(XI-J), wherein R¹³ and R¹⁴ are independently hydrogen or C₁-C₄ alkyl.

In some embodiments, Compounds of the Disclosure are compounds having any one of Formulae (VIII-J)-(XI-J), wherein R¹³ and R¹⁴ are independently hydrogen or methyl.

In some embodiments, Compounds of the Disclosure are compounds having any one of Formulae (VIII-J)-(XI-J), wherein R¹⁴ is methyl.

In some embodiments, Compounds of the Disclosure are compounds having Formula (XII-J):

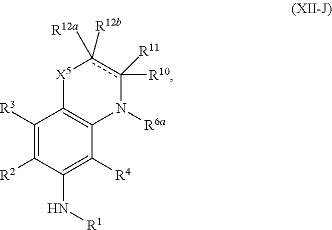

or a salt, solvate, or stereoisomer thereof, wherein:
R¹, R², R³, R⁴, X⁵, and R^{6a} are as defined in connection with Formula (I-J);
[symbol] is a single or a double bond,
with the proviso that when [symbol] is a double bond, then R¹¹ and R^{12b} are absent;
R¹⁰ is selected from the group consisting of hydrogen, halogen, C₁-C₉ alkyl, optionally substituted phenyl, —C(═O)OR⁷, —C(═O)NR⁷R⁸, —C(═O)SR⁷, —CH₂OR⁷, —CH₂OC(═O)R⁷, and

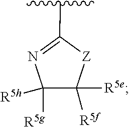

R¹¹ is absent or is selected from the group consisting of hydrogen, halogen, C₁-C₉ alkyl, and optionally substituted phenyl; or
R¹⁰ and R¹¹ taken together with the carbon atom to which they are attached form a C₃-C₁₂ cycloalkyl;
R^{12a} is selected from the group consisting of hydrogen, halogen, C₁-C₉ alkyl, and optionally substituted phenyl; and
R^{12b} is absent or is selected from the group consisting of hydrogen, halogen, C₁-C₉ alkyl, and optionally substituted phenyl.

In some embodiments, Compounds of the Disclosure are compounds having Formula (XII-J), wherein X⁵ is —CR^{5a}R^{5b}—.

In some embodiments, Compounds of the Disclosure are compounds having Formula (XII-J), wherein R^{5a} is hydrogen or methyl.

In some embodiments, Compounds of the Disclosure are compounds having Formula (XII-J), wherein R^{5b} is hydrogen, C₁-C₉ alkyl, or optionally substituted phenyl.

In some embodiments, Compounds of the Disclosure are compounds having Formula (XII-J), wherein R¹⁰ is hydrogen, C₁-C₉ alkyl, or optionally substituted phenyl.

In some embodiments, Compounds of the Disclosure are compounds having Formula (XII-J), wherein R^{6a} is hydrogen or methyl.

In some embodiments, Compounds of the Disclosure are compounds having Formula (XII-J), wherein [symbol] is a single bond.

In some embodiments, Compounds of the Disclosure are compounds having Formula (XII-J), wherein [symbol] is a double bond.

In some embodiments, Compounds of the Disclosure are compounds having Formula (XII-J), wherein R¹¹ is hydrogen or C₁-C₉ alkyl.

In some embodiments, Compounds of the Disclosure are compounds having Formula (XII-J), wherein R^{12b} is hydrogen or C₁-C₉ alkyl.

In some embodiments, Compounds of the Disclosure are compounds having Formula (XIII-J):

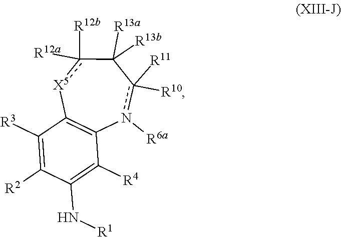

or a salt, solvate, or stereoisomer thereof, wherein:
R¹, R², R³, R⁴, X⁵, and R^{6a} are as defined in connection with Formula (I-J);
each [symbol] is independently a single or a double bond;
when X⁵ is —CR^{5a}R^{5b}— or —NR^{5a}, then the [symbol] attached to X⁵ is a single or a double bond, and when X⁵ is —O— or —S—, then the [symbol] attached to X⁵ is a single bond,
with the provisos that when the [symbol] attached to X⁵ is a double bond, then R^{12b} is absent, and when the [symbol] attached to N is a double bond, then R¹¹ is absent;
R¹⁰ is selected from the group consisting of hydrogen, halogen, C₁-C₉ alkyl, optionally substituted phenyl, —C(═O)OR⁷, —C(═O)NR⁷R⁸, —C(═O)SR⁷, —CH₂OR⁷, —CH₂OC(═O)R⁷, and

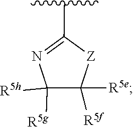

R¹¹ is absent or is selected from the group consisting of hydrogen, halogen, C₁-C₉ alkyl, and optionally substituted phenyl; or
R¹⁰ and R¹¹ taken together with the carbon atom to which they are attached form a C₃-C₁₂ cycloalkyl;
R^{12a} is absent or is selected from the group consisting of hydrogen, halogen, C₁-C₉ alkyl, optionally substituted phenyl, —C(═O)OR⁷, —C(═O)NR⁷R⁸, —C(═O)SR⁷, —CH₂OR⁷, —CH₂OC(═O)R⁷, and

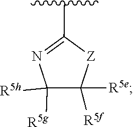

R^{12b} is selected from the group consisting of hydrogen, halogen, C₁-C₉ alkyl, and optionally substituted phenyl; or
R^{12a} and R^{12b} taken together with the carbon atom to which they are attached form a C₃-C₁₂ cycloalkyl;
R^{13a} is selected from the group consisting of hydrogen, halogen, C₁-C₉ alkyl, and optionally substituted phenyl; and
R^{13b} is selected from the group consisting of hydrogen, halogen, C₁-C₉ alkyl, and optionally substituted phenyl.

In some embodiments, Compounds of the Disclosure are compounds having Formula (XIV-J):

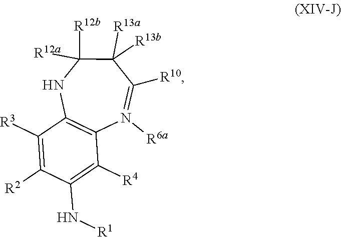

or a salt, solvate, or stereoisomer thereof, wherein:
R¹, R², R³, R⁴, R^{6a}, R¹⁰, R^{12a}, R^{12b}, R^{13a}, and R^{13b} are as defined in connection with Formula (XIII-J).

In some embodiments, Compounds of the Disclosure are compounds having Formula (XV-J):

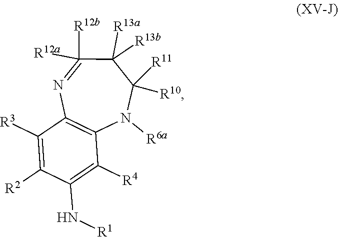

or a salt, solvate, or stereoisomer thereof, wherein:
R¹, R², R³, R⁴, R^{6a}, R¹⁰, R¹¹, R^{12a}, R^{13a}, and R^{13b} are as defined in connection with Formula (XIII-J).

In some embodiments, Compounds of the Disclosure are compounds having any one of Formulae (XIII-J)-(XV-J), wherein R^{6a} is hydrogen or methyl.

In some embodiments, Compounds of the Disclosure are compounds having any one of Formulae (XIII-J)-(XV-J), wherein R^{6a} is hydrogen.

In some embodiments, Compounds of the Disclosure are compounds having any one of Formulae (XIII-J)-(XV-J), wherein R¹⁰ is hydrogen or C₁-C₉ alkyl.

In some embodiments, Compounds of the Disclosure are compounds having any one of Formulae (XIII-J)-(XV-J), wherein R¹⁰ is methyl.

In some embodiments, Compounds of the Disclosure are compounds having Formula (XIII-J) or (XV-J), wherein R¹¹ is hydrogen or C₁-C₉ alkyl.

In some embodiments, Compounds of the Disclosure are compounds having Formula (XIII-J) or (XV-J), wherein R¹¹ is methyl.

In some embodiments, Compounds of the Disclosure are compounds having any one of Formulae (XIII-J)-(XV-J), wherein R^{12a} is hydrogen or C₁-C₉ alkyl.

In some embodiments, Compounds of the Disclosure are compounds having any one of Formulae (XIII-J)-(XV-J), wherein R^{12a} is methyl.

In some embodiments, Compounds of the Disclosure are compounds having Formula (XIII-J) or (XIV-J), wherein R^{12b} is hydrogen or C₁-C₉ alkyl.

In some embodiments, Compounds of the Disclosure are compounds having Formula (XIII-J) or (XIV-J), wherein R^{12b} is methyl.

In some embodiments, Compounds of the Disclosure are compounds having any one of Formulae (XIII-J)-(XV-J), wherein R^{13a} is hydrogen or C₁-C₉ alkyl.

In some embodiments, Compounds of the Disclosure are compounds having any one of Formulae (XIII-J)-(XV-J), wherein R^{13a} is hydrogen.

In some embodiments, Compounds of the Disclosure are compounds having any one of Formulae (XIII-J)-(XV-J), wherein R^{13b} is hydrogen or C₁-C₉ alkyl.

In some embodiments, Compounds of the Disclosure are compounds having any one of Formulae (XIII-J)-(XV-J), wherein R^{13b} is hydrogen.

In some embodiments, Compounds of the Disclosure are compounds having any one of Formulae (I-J)-(XV-J), wherein R¹ is C₁-C₁₂ alkyl.

In some embodiments, Compounds of the Disclosure are compounds having any one of Formulae (I-J)-(XV-J), wherein R¹ is methyl, ethyl, propyl, isopropyl, butyl, sec-butyl, tert-butyl, pentyl, isopentyl, neo-pentyl, hexyl, heptyl, octyl, nonyl, decyl, undecyl, or dodecyl.

In some embodiments, Compounds of the Disclosure are compounds having any one of Formulae (I-J)-(XV-J), wherein R¹ is:

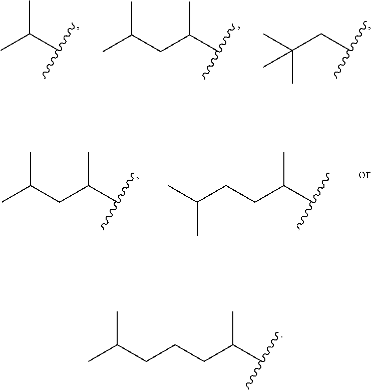

In some embodiments, Compounds of the Disclosure are compounds having Formula (I-J), wherein:
R⁵ is selected from the group consisting of hydrogen, optionally substituted C₁-C₁₂ alkyl, —CHR^{5c}R^{5d}, C₃-C₆ cycloalkyl, 4- to 6-membered heterocyclyl, optionally substituted phenyl, and optionally substituted 5- or 6-membered heteroaryl; and
R⁶ is selected from the group consisting of optionally substituted C₁-C₁₂ alkyl, —CHR^{6b}R^{6c}, C₃-C₆ cycloalkyl, 4- to 6-membered heterocyclyl, optionally substituted phenyl, and optionally substituted 5- or 6-membered heteroaryl.

In some embodiments, Compounds of the Disclosure are compounds having Formula (I-J), wherein R^{1a} is hydrogen or methyl.

In some embodiments, Compounds of the Disclosure are compounds having Formula (I-J), wherein R^{1a} is hydrogen.

In some embodiments, Compounds of the Disclosure are compounds having Formula (I-J), wherein R¹ is C₁-C₁₂ alkyl.

In some embodiments, Compounds of the Disclosure are compounds having Formula (I-J), wherein R¹ is methyl, ethyl, propyl, isopropyl, butyl, sec-butyl, tert-butyl, pentyl, isopentyl, neo-pentyl, hexyl, heptyl, octyl, nonyl, decyl, undecyl, or dodecyl.

In some embodiments, Compounds of the Disclosure are compounds Formula (I-J), wherein R¹ is:

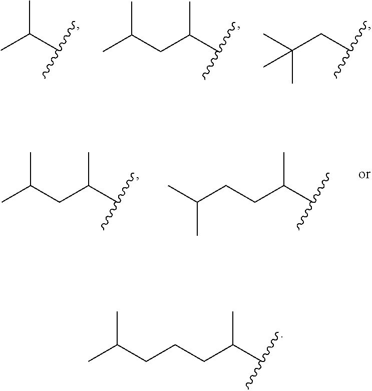

In some embodiments, Compounds of the Disclosure are compounds having Formula (I-J), wherein X⁵ is —CR^{5a}R^{5b}—.

In some embodiments, Compounds of the Disclosure are compounds having Formula (I-J), wherein R^{5a} and R^{5b} are hydrogen.

In some embodiments, Compounds of the Disclosure are compounds having Formula (I-J), wherein R^{5a} and R^{5b} are C₁-C₄ alkyl.

In some embodiments, Compounds of the Disclosure are compounds having Formula (I-J), wherein X⁵ is —NR^{5a}—.

In some embodiments, Compounds of the Disclosure are compounds having Formula (I-J), wherein R^{5a} is hydrogen or methyl.

In some embodiments, Compounds of the Disclosure are compounds having Formula (I-J), wherein R^{5a} is hydrogen.

In some embodiments, Compounds of the Disclosure are compounds having Formula (I-J), wherein X⁵ is —O—.

In some embodiments, Compounds of the Disclosure are compounds having Formula (I-J), wherein R⁵ is C₁-C₁₂ alkyl.

In some embodiments, Compounds of the Disclosure are compounds having Formula (I-J), wherein R⁵ is methyl, ethyl, propyl, isopropyl, butyl, sec-butyl, tert-butyl, pentyl, isopentyl, neo-pentyl, hexyl, heptyl, octyl, nonyl, decyl, undecyl, or dodecyl.

In some embodiments, Compounds of the Disclosure are compounds Formula (I-J), wherein R⁵ is:

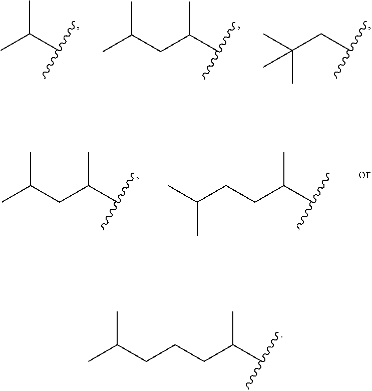

In some embodiments, Compounds of the Disclosure are compounds having Formula (I-J), wherein R⁵ is hydrogen.

In some embodiments, Compounds of the Disclosure are compounds having Formula (I-J), wherein R⁶ is C₁-C₁₂ alkyl.

In some embodiments, Compounds of the Disclosure are compounds having Formula (I-J), wherein R⁶ is methyl, ethyl, propyl, isopropyl, butyl, sec-butyl, tert-butyl, pentyl, isopentyl, neo-pentyl, hexyl, heptyl, octyl, nonyl, decyl, undecyl, or dodecyl.

In some embodiments, Compounds of the Disclosure are compounds Formula (I-J), wherein R⁶ is:

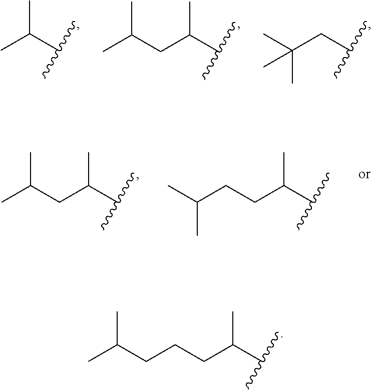

In some embodiments, Compounds of the Disclosure are compounds having Formula (I-J), wherein R^{6a} is hydrogen or methyl.

In some embodiments, Compounds of the Disclosure are compounds having Formula (I-J), wherein R^{6a} is hydrogen.

In some embodiments, Compounds of the Disclosure are compounds having any one of Formulae (I-J)-(XV-J), wherein R², R³, and R⁴ are independently hydrogen or C₁-C₉ alkyl.

In some embodiments, Compounds of the Disclosure are compounds having any one of Formulae (I-J)-(XV-J), wherein R², R³, and R⁴ are independently hydrogen or methyl.

In some embodiments, Compounds of the Disclosure are compounds having any one of Formulae (I-J)-(XV-J), wherein R⁴ is methyl.

In some embodiments, Compounds of the Disclosure are compounds having any one of Formulae (I-J)-(XV-J), wherein R² and R³ are hydrogen.

In some embodiments, Compounds of the Disclosure are any one or more of the compounds of Table J, or a salt or solvate thereof.

TABLE J

| Compound No. | Structure |
|---|---|
| 1-J | 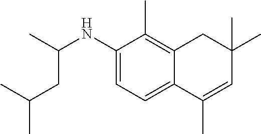 [SMILES: CC1=CC(C)(C)Cc2c1ccc(NC(C)CC(C)C)c2C] |
| 2-J | 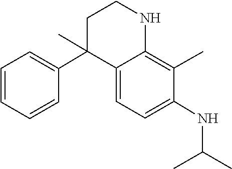 [SMILES: Cc1c(NC(C)C)ccc2c1NCCC2(C)c1ccccc1] |
| 3-J | 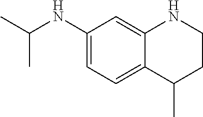 |
| 4-J | 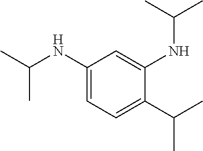 [SMILES: CC(C)Nc1ccc(C(C)C)c(NC(C)C)c1] |
| 5-J | 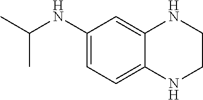 |
| 6-J | 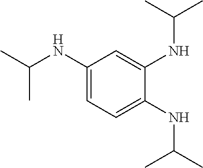 [SMILES: CC(C)Nc1ccc(NC(C)C)c(NC(C)C)c1] |
| 7-J | 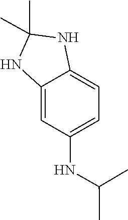 |
| 8-J | 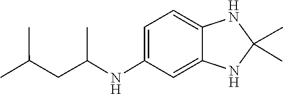 [SMILES: CC(C)CC(C)Nc1ccc2c(c1)NC(C)(C)N2] |
| 9-J | 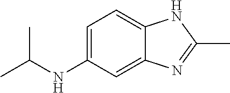 |
| 10-J | 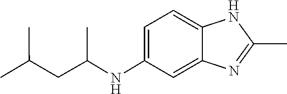 [SMILES: Cc1nc2cc(NC(C)CC(C)C)ccc2[nH]1] |
| 11-J | 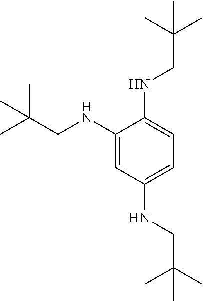 [SMILES: CC(C)(C)CNc1ccc(NCC(C)(C)C)c(NCC(C)(C)C)c1] |
| 12-J | 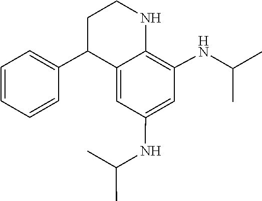 [SMILES: CC(C)Nc1cc(NC(C)C)c2c(c1)C(c1ccccc1)CCN2] |
| 13-J | 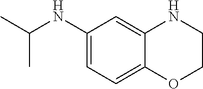 |
| 14-J | 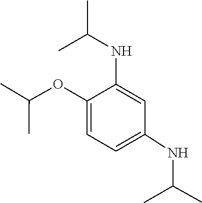 [SMILES: CC(C)Nc1ccc(OC(C)C)c(NC(C)C)c1] |
| 15-J | 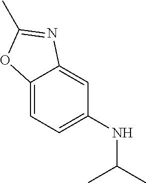 |
| 16-J | 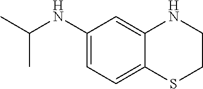 |
| 17-J | 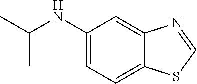 |
| 18-J | 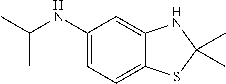 |
| 19-J | 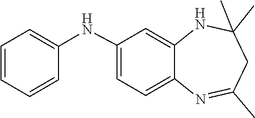 [SMILES: CC1=Nc2ccc(Nc3ccccc3)cc2NC(C)(C)C1] |
| 20-J | 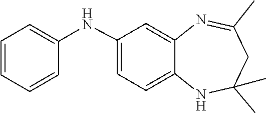 [SMILES: CC1=Nc2cc(Nc3ccccc3)ccc2NC(C)(C)C1] |

Compounds having Formula (I-J) can be prepared by a two-step process comprising i) reacting a 1,3-diaminobenzene with one equivalent of a ketone, e.g., acetone, methyl isobutyl ketone, or methyl isoamyl ketone, or an aldehyde such as isobutyraldehyde, under reductive conditions, e.g., in the presence of hydrogen and a metal catalyst, e.g., platinum or palladium, or using hydride chemistry such as sodium borohydride, sodium triacetoxyborohydride, or sodium cyanoborohydride; and ii) reacting the 1-alkylamino-3-aminobenzene product of step i) with a ketone or acetal, e.g., acetone, 2,2′-dimethylpropane, or mesityl oxide, in the presence of an acid, base, or elemental halogen catalyst, e.g., hydrochloric acid, zinc (II) triflate, lithium carbonate, or elemental iodine as shown in Scheme J.

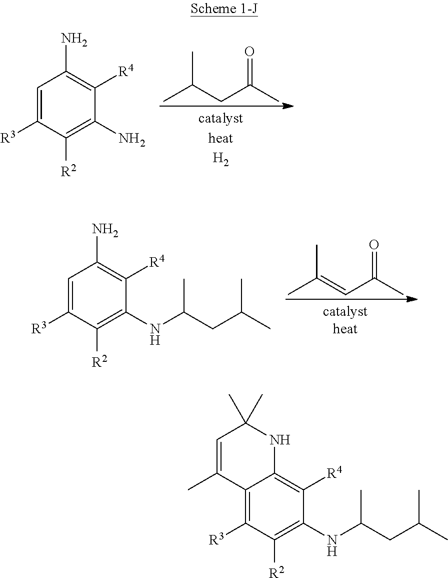

Compounds having Formula (I-J) can also be prepared by a two-step process comprising i) reacting a 3-nitroaniline with a ketone or aldehyde, e.g., formaldehyde, and an olefin, e.g., alpha-methylstyrene, in the presence of an acid, e.g., trifluoroacetic acid; and ii) reacting the product of step i) with a ketone, e.g., acetone, methyl isobutyl ketone, or methyl isoamyl ketone, or an aldehyde such as isobutyraldehyde, under reductive conditions, e.g., in the presence of hydrogen and a metal catalyst, e.g., platinum or palladium, or using hydride chemistry such as sodium borohydride, sodium triacetoxyborohydride, or sodium cyanoborohydride, as shown in Scheme 2-J.

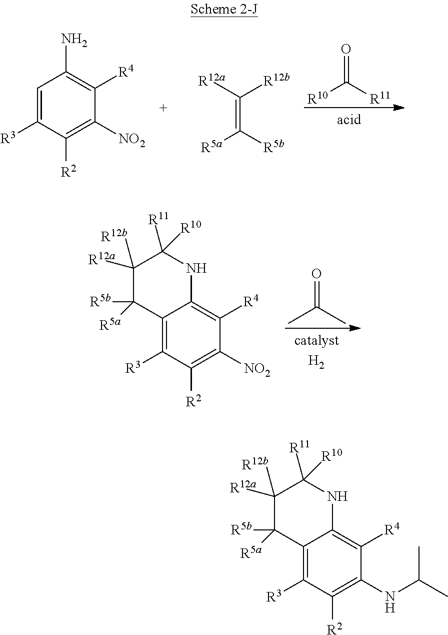

Compounds of having Formula (I-J) can also be prepared by further reduction of compounds synthesized using Scheme 1-J, as shown in Scheme 3-J. Reduction may be carried out using any methods known in the art, such as exposure to hydrogen over a palladium on carbon (Pd/C) catalyst.

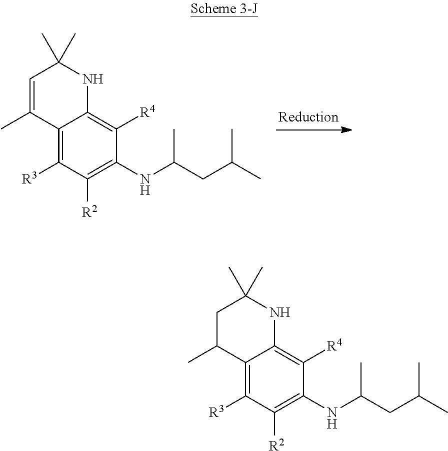

Compounds having Formula (I-J) can also be prepared by a two-step process comprising i) reacting a 4-halo-1,2-diaminobenzene with a ketone or aldehyde, e.g., acetone, in the presence of an acid catalyst, e.g., zirconyl chloride octahydrate, and ii) reacting the product of step i) with an aniline, e.g., in a Buchwald-Hartwig coupling, as shown in Scheme 4-J.

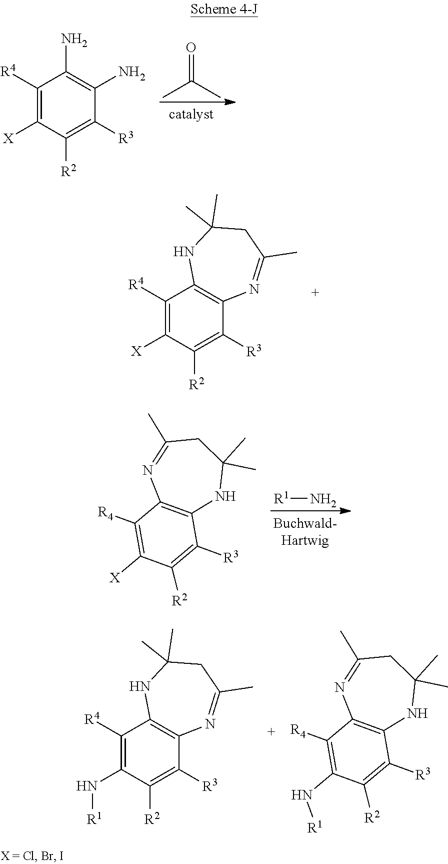

### Definitions

The term “alkyl” as used herein by itself or as part of another group refers to a straight- or branched-chain aliphatic hydrocarbon containing one to twelve carbon atoms, i.e., a C₁-C₁₂ alkyl, or the number of carbon atoms designated, e.g., C₁-C₃ alkyl such as methyl, ethyl, propyl, or isopropyl; a C₁-C₄ alkyl such as methyl, ethyl, propyl, isopropyl, n-butyl, isobutyl, sec-butyl, or t-butyl; and so on. In one embodiment the alkyl is a straight-chain alkyl. In some embodiments, the alkyl is a branched-chain alkyl. In one embodiment, the alkyl is a C₁-C₈ alkyl. In some embodiments, the alkyl is a C₁-C₆ alkyl. In some embodiments, the alkyl is a C₁-C₄ alkyl. In some embodiments, the alkyl is a C₁-C₃ alkyl. Non-limiting exemplary C₁-C₁₂ alkyl groups include methyl, ethyl, propyl, isopropyl, butyl, sec-butyl, tert-butyl, iso-butyl, 3-pentyl, hexyl, heptyl, octyl, nonyl, and decyl.

The term “optionally substituted alkyl” as used herein by itself or as part of another group refers to an alkyl that is either unsubstituted or substituted with one, two, or three substituents, wherein the substituents are each independently nitro, cyano, hydroxyl, amino, (e.g., —NH₂, alkylamino, or dialkylamino), alkoxy, alkylthio, alkylcarbonyl, cycloalkyl, or —C(═O)OR^{1h}, wherein R^{1h} is C₁-C₆ alkyl.

The term “halo” or “halogen” as used herein by itself or as part of another group refers to —Cl, —F, —Br, or —I.

The term “nitro” as used herein by itself or as part of another group refers to —NO₂.

The term “cyano” as used herein by itself or as part of another group refers to —CN.

The term “hydroxy” as herein used by itself or as part of another group refers to —OH.

The term “amino” as used by itself or as part of another group refers to a radical of the formula —NR^{1f}R^{1g}, wherein R^{1f} and R^{1g} are independently hydrogen or alkyl.

In one embodiment, the amino is —NH₂.

In some embodiments, the amino is an “alkylamino,” i.e., an amino group wherein R^{1f} is C₁₋₆ alkyl and R^{1g} is hydrogen. In one embodiment, R^{1f} is C₁-C₄ alkyl. Non-limiting exemplary alkylamino groups include —N(H)CH₃ and —N(H)CH₂CH₃.

In some embodiments, the amino is a “dialkylamino,” i.e., an amino group wherein R^{1f} and R^{1g} are each independently C₁₋₆ alkyl. In one embodiment, R^{1f} and R^{1g} are each independently C₁-C₄ alkyl. Non-limiting exemplary dialkylamino groups include —N(CH₃)₂ and —N(CH₃) CH₂CH(CH₃)₂.

The term “alkylcarbonyl” as used herein by itself or as part of another group refers to a carbonyl group, i.e., —C(═O)—, substituted by an alkyl group. In one embodiment, the alkyl is a C₁-C₄ alkyl. A non-limiting exemplary alkylcarbonyl group is —COCH₃.

The term “haloalkyl” as used herein by itself or as part of another group refers to an alkyl substituted by one or more fluorine, chlorine, bromine, and/or iodine atoms. In one embodiment, the alkyl is substituted by one, two, or three fluorine and/or chlorine atoms. In some embodiments, the alkyl is substituted by one, two, or three fluorine atoms. In some embodiments, the alkyl is a C₁-C₆ alkyl and the resulting haloalkyl is referred to as a “C₁-C₆ haloalkyl.” In some embodiments, the alkyl is a C₁-C₄ alkyl and the resulting haloalkyl is referred to as a “C₁-C₄ haloalkyl.” In some embodiments, the alkyl group is a C₁ or C₂ alkyl. Non-limiting exemplary haloalkyl groups include fluoromethyl, difluoromethyl, trifluoromethyl, pentafluoroethyl, 1,1-difluoroethyl, 2,2-difluoroethyl, 2,2,2-trifluoroethyl, 3,3,3-trifluoropropyl, 4,4,4-trifluorobutyl, and trichloromethyl groups.

The term “alkoxy” as used herein by itself or as part of another group refers to an alkyl attached to a terminal oxygen atom. In one embodiment, the alkyl is a C₁-C₆ alkyl, and the resulting alkoxy is referred to as a “C₁-C₆ alkoxy.” In some embodiments, the alkyl is a C₁-C₄ alkyl group and thus the resulting alkoxy is referred to as a “C₁-C₄ alkoxy.” Non-limiting exemplary alkoxy groups include methoxy, ethoxy, and tert-butoxy.

The term “alkylthio” as used herein by itself or as part of another group refers to an alkyl group attached to a terminal sulfur atom. In one embodiment, the alkyl is a C₁-C₆ alkyl, and the resulting alkylthio is referred to as a “C₁-C₆ alkylthio.” In one embodiment, the alkyl group is a C₁-C₄ alkyl group and the resulting alkylthio is referred to as a “C₁-C₄ alkylthio.” Non-limiting exemplary alkylthio groups include —SCH₃, and —SCH₂CH₃.

The term “cycloalkyl” as used herein by itself or as part of another group refers to saturated and partially unsaturated, e.g., containing one or two double bonds, monocyclic, bicyclic, or tricyclic aliphatic hydrocarbons containing three to twelve carbon atoms, i.e., a C₃-C₁₂ cycloalkyl, or the number of carbons designated, e.g., a C₃-C₆ cycloalkyl such a cyclopropyl, cyclobutyl, cyclopentyl, and cyclohexyl. In one embodiment, the cycloalkyl is bicyclic, i.e., it has two rings. In some embodiments, the cycloalkyl is monocyclic, i.e., it has one ring. In some embodiments, the cycloalkyl is a C₃-C₈ cycloalkyl. In some embodiments, the cycloalkyl is a C₃-C₆ cycloalkyl. In some embodiments, the cycloalkyl is a C₅ cycloalkyl, i.e., cyclopentyl. In some embodiments, the cycloalkyl is a C₆ cycloalkyl, i.e., cyclohexyl. Non-limiting exemplary C₃-C₁₂ cycloalkyl groups include cyclopropyl, cyclobutyl, cyclopentyl, cyclohexyl, cycloheptyl, cyclooctyl, norbornyl, decalin, adamantyl, cyclohexenyl, and spiro[3.3]heptane.

The term “optionally substituted phenyl” as used herein by itself or as part of another group refers to phenyl that is either unsubstituted or substituted with one to five substitutents, wherein the substituents are each independently halo, nitro, cyano, hydroxyl, amino, (e.g., —NH₂, alkylamino, or dialkylamino), alkoxy, alkylthio, alkylcarbonyl, alkyl, or cycloalkyl.

The term “heterocyclo” as used herein by itself or as part of another group refers to saturated and partially unsaturated, e.g., containing one or two double bonds, monocyclic, bicyclic, or tricyclic groups containing three to eighteen ring members, i.e., a 3- to 18-membered heterocyclo, comprising one, two, three, or four heteroatoms. Each heteroatom is independently oxygen, sulfur, or nitrogen. Each sulfur atom may be independently oxidized to give a sulfoxide, i.e., S(═O), or sulfone, i.e., S(═O)₂. The term heterocyclo includes groups wherein one or more —CH₂-groups is replaced with one or more —C(═O)— groups, including cyclic ureido groups such as imidazolidinyl-2-one, cyclic amide groups such as pyrrolidin-2-one or piperidin-2-one, and cyclic carbamate groups such as oxazolidinyl-2-one. The term heterocyclo also includes groups having fused optionally substituted aryl or optionally substituted heteroaryl groups such as indoline, indolin-2-one, 2,3-dihydro-1H-pyrrolo[2,3-c]pyridine, 2,3,4,5-tetrahydro-1H-benzo[d]azepine, or 1,3,4,5-tetrahydro-2H-benzo[d]azepin-2-one. In some embodiments, heterocyclo is a 6-membered ring comprising one nitrogen atom. The heterocyclo may be fused to the rest of the molecule to form a bicyclic group, e.g., 1,2-dihydroquinoline or 1,2,3,4-tetrahydroquinoline.

The term “optionally substituted heterocyclo” as used herein by itself or part of another group refers to a heterocyclo group that is either unsubstituted or substituted with one to four substituents, independently halo, nitro, cyano, hydroxyl, amino, (e.g., —NH₂, alkylamino, or dialkylamino), alkoxy, alkylthio, alkylcarbonyl, alkyl, or cycloalkyl.

The term “heteroaryl” as used herein by itself or as part of another group refers to monocyclic aromatic ring systems having five to six ring members, i.e., a 5- to 6-membered heteroaryl, comprising one, two, three, four, or five heteroatoms. Each heteroatom is independently oxygen, sulfur, or nitrogen. In one embodiment, the heteroaryl has three heteroatoms. In some embodiments, the heteroaryl has two heteroatoms. In some embodiments, the heteroaryl has one heteroatom. In some embodiments, the heteroaryl has 5 ring atoms, e.g., furyl, a 5-membered heteroaryl having four carbon atoms and one oxygen atom. In some embodiments, the heteroaryl has 6 ring atoms, e.g., pyridyl, a 6-membered heteroaryl having five carbon atoms and one nitrogen atom. Non-limiting exemplary heteroaryl groups include thienyl, furyl, pyranyl, 2H-pyrrolyl, pyrrolyl, imidazolyl, pyrazolyl, pyridyl, pyrazinyl, pyrimidinyl, pyridazinyl, thiazolyl, isothiazolyl, and isoxazolyl. In one embodiment, the heteroaryl is chosen from thienyl (e.g., thien-2-yl and thien-3-yl), furyl (e.g., 2-furyl and 3-furyl), pyrrolyl (e.g., 1H-pyrrol-2-yl and 1H-pyrrol-3-yl), imidazolyl (e.g., 2H-imidazol-2-yl and 2H-imidazol-4-yl), pyrazolyl (e.g., 1H-pyrazol-3-yl, 1H-pyrazol-4-yl, and 1H-pyrazol-5-yl), pyridyl (e.g., pyridin-2-yl, pyridin-3-yl, and pyridin-4-yl), pyrimidinyl (e.g., pyrimidin-2-yl, pyrimidin-4-yl, and pyrimidin-5-yl), thiazolyl (e.g., thiazol-2-yl, thiazol-4-yl, and thiazol-5-yl), isothiazolyl (e.g., isothiazol-3-yl, isothiazol-4-yl, and isothiazol-5-yl), oxazolyl (e.g., oxazol-2-yl, oxazol-4-yl, and oxazol-5-yl) and isoxazolyl (e.g., isoxazol-3-yl, isoxazol-4-yl, and isoxazol-5-yl). The term heteroaryl also includes N-oxides. A non-limiting exemplary N-oxide is pyridyl N-oxide.

The term “optionally substituted heteroaryl” as used herein by itself or as part of another group refers to a heteroaryl that is either unsubstituted or substituted with one to four substituents, wherein the substituents are independently halo, nitro, cyano, hydroxyl, amino, (e.g., —NH₂, alkylamino, or dialkylamino), alkoxy, alkylthio, alkylcarbonyl, alkyl, or cycloalkyl.

As used herein, the term “stereoisomers” is a general term for all isomers of an individual molecule that differ only in the orientation of their atoms in space. It includes enantiomers and isomers of compounds with more than one chiral center that are not mirror images of one another (diastereomers).

In some embodiments, a Compound of the Disclosure comprises only the E stereoisomer, i.e., there is no detectable amount of the Z stereoisomer as measured by HPLC.

In some embodiments, a Compound of the Disclosure comprises only the Z stereoisomer, i.e., there is no detectable amount of the E stereoisomer as measured by HPLC.

The term “chiral center” or “asymmetric carbon atom” refers to a carbon atom to which four different groups are attached.

The terms “enantiomer” and “enantiomeric” refer to a molecule that cannot be superimposed on its mirror image and hence is optically active wherein the enantiomer rotates the plane of polarized light in one direction and its mirror image compound rotates the plane of polarized light in the opposite direction.

The term “racemic” refers to a mixture of equal parts of enantiomers and which mixture is optically inactive.

The term “absolute configuration” refers to the spatial arrangement of the atoms of a chiral molecular entity (or group) and its stereochemical description, e.g., R or S.

The stereochemical terms and conventions used in the specification are meant to be consistent with those described in Pure & Appl. Chem 68:2193 (1996), unless otherwise indicated.

The term “enantiomeric excess” or “ee” refers to a measure for how much of one enantiomer is present compared to the other. For a mixture of R and S enantiomers, the percent enantiomeric excess is defined as |R−S|*100, where R and S are the respective mole or weight fractions of enantiomers in a mixture such that R+S=1. With knowledge of the optical rotation of a chiral substance, the percent enantiomeric excess is defined as ([α]_{obs}/[α]ₘₐₓ)*100, where [α]_{obs} is the optical rotation of the mixture of enantiomers and [α]ₘₐₓ is the optical rotation of the pure enantiomer. Determination of enantiomeric excess is possible using a variety of analytical techniques, including NMR spectroscopy, chiral column chromatography, or optical polarimetry.

In thin layer chromatography (TLC), the term R_{f} stands for retention factor. R_{f} is defined as the distance travelled by an individual component divided by the total distance travelled by the eluent. Its value is always between zero and one.

Salts and solvates, e.g., hydrates, of the Compounds of the Disclosure can also be used in the methods disclosed herein.

The present disclosure encompasses the preparation and use of salts of Compounds of the Disclosure. Salts of Compounds of the Disclosure can be prepared during the final isolation and purification of the compounds or separately by reacting the compound with an acid having a suitable cation. Salts of Compounds of the Disclosure can be acid addition salts formed with acceptable acids. Examples of acids which can be employed to form salts include inorganic acids such as nitric, boric, hydrochloric, hydrobromic, sulfuric, and phosphoric, and organic acids such as oxalic, maleic, succinic, and citric. Non-limiting examples of salts of compounds of the disclosure include, but are not limited to, the hydrochloride, hydrobromide, hydroiodide, sulfate, bisulfate, 2-hydroxyethansulfonate, phosphate, hydrogen phosphate, acetate, adipate, alginate, aspartate, benzoate, bisulfate, butyrate, camphorate, camphorsulfonate, digluconate, glycerolphosphate, hemisulfate, heptanoate, hexanoate, formate, succinate, fumarate, maleate, ascorbate, isethionate, salicylate, methanesulfonate, mesitylenesulfonate, naphthylenesulfonate, nicotinate, 2-naphthalenesulfonate, oxalate, pamoate, pectinate, persulfate, 3-phenylproprionate, picrate, pivalate, propionate, trichloroacetate, trifluoroacetate, phosphate, glutamate, bicarbonate, paratoluenesulfonate, undecanoate, lactate, citrate, tartrate, gluconate, methanesulfonate, ethanedisulfonate, benzene sulfonate, and p-toluenesulfonate salts. In addition, available amino groups present in the compounds of the disclosure can be quaternized with methyl, ethyl, propyl, and butyl chlorides, bromides, and iodides; dimethyl, diethyl, dibutyl, and diamyl sulfates; decyl, lauryl, myristyl, and steryl chlorides, bromides, and iodides; and benzyl and phenethyl bromides. In light of the foregoing, any reference to Compounds of the Disclosure appearing herein is intended to include Compounds of the Disclosure as well as salts, hydrates, or solvates thereof.

The present disclosure encompasses the preparation and use of solvates of Compounds of the Disclosure. The term “solvate” as used herein is a combination, physical association and/or solvation of a compound of the present disclosure with a solvent molecule such as, e.g., a disolvate, monosolvate or hemisolvate, where the ratio of solvent molecule to compound of the present disclosure is about 2:1, about 1:1 or about 1:2, respectively. This physical association involves varying degrees of ionic and covalent bonding, including hydrogen bonding. In certain instances, the solvate can be isolated, such as when one or more solvent molecules are incorporated into the crystal lattice of a crystalline solid. Thus, “solvate” encompasses both solution-phase and isolatable solvates. Compounds of the Disclosure can be present as solvated forms with a solvent, such as water, methanol, and ethanol, and it is intended that the disclosure includes both solvated and unsolvated forms of Compounds of the Disclosure.

One type of solvate is a hydrate. A “hydrate” relates to a particular subgroup of solvates where the solvent molecule is water. Preparation of solvates is known in the art. See, for example, M. Caira et al, J. Pharmaceut. Sci., 93 (3): 601-611 (2004), which describes the preparation of solvates of fluconazole with ethyl acetate and with water. Similar preparation of solvates, hemisolvates, hydrates, and the like are described by van Tonder et al., AAPS Pharm. Sci. Tech., 5 (1): Article 12 (2004), and A. L. Bingham et al., Chem. Commun. 603-604 (2001). A typical, non-limiting, process of preparing a solvate would involve dissolving a Compound of the Disclosure in a desired solvent (organic, water, or a mixture thereof) at temperatures above 20° C. to about 25° C., then cooling the solution at a rate sufficient to form crystals, and isolating the crystals by known methods, e.g., filtration. Analytical techniques such as infrared spectroscopy can be used to confirm the presence of the solvent in a crystal of the solvate.

The use of the terms “a”, “an”, “the”, and similar referents in the context of describing the disclosure (especially in the context of the claims) are to be construed to cover both the singular and the plural, unless otherwise indicated. Recitation of ranges of values herein merely are intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended to better illustrate the disclosure and is not a limitation on the scope of the disclosure unless otherwise claimed. No language in the specification should be construed as indicating any non-claimed element as essential to the practice of the disclosure.

Furthermore, “and/or” where used herein is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

It is understood that wherever aspects are described herein with the language “comprising,” otherwise analogous aspects described in terms of “consisting of” and/or “consisting essentially of” are also provided.

The term “wt/wt %” as used herein refers to the mass of one component in a composition or blend, e.g., a composition comprising a Compound of the Disclosure and one or more elastomers; or a Composition of the Disclosure and one or more fillers; or a blend comprising two or more elastomers, etc., divided by the combined mass of all components in the composition or blend, times 100. For example, the wt/wt % of a Compound of the Disclosure in a composition comprising 1 kg of the compound, 1 kg natural rubber, and 2 kg of synthetic rubber, is 25 wt/wt % (1 kg/4 kg=0.25×100=25 wt/wt %). The wt/wt % of a Compound of the Disclosure in a composition comprising 1 kg of the compound and 1 kg of carbon black is 50 wt/wt % (1 kg/2 kg=0.20×100=50 wt/wt %). The wt/wt % of a Compound of the Disclosure in a composition comprising 1 kg of the compound, 1 kg natural rubber, 2 kg of synthetic rubber, and 1 kg of carbon black is 20 wt/wt % (1 kg/5 kg=0.20×100=20 wt/wt %). The wt/wt % of natural rubber in a blend of one or more elastomers comprising 20 kg natural rubber and 30 kg synthetic rubber is 40 wt/wt % (20 kg/50 kg=0.40×100=40 wt/wt %).

The term “one or more” as used herein is intended to mean that at least one component in a relevant category of components, e.g. one or more second antidegradants, is present and, in some embodiments, more than one component is present. In some embodiments, one or more means 1 to 10. In some embodiments, one or more means 1 to 5. In some embodiments, one or more means 1 to 3. In some embodiments, one or more means 1 or 2. In some embodiments, one or more means 1.

### Compositions and Methods of Use

In some embodiments, a Composition of the Disclosure comprises from about 15 wt/wt % to about 85 wt/wt % of a first antidegradant. In some embodiments, the composition comprises from about 1 wt/wt % to about 5 wt/wt %, from about 1 wt/wt % to about 15 wt/wt %, from about 1 wt/wt % to about 25 wt/wt %, from about 1 wt/wt % to about 35 wt/wt %, from about 1 wt/wt % to about 45 wt/wt %, from about 1 wt/wt % to about 55 wt/wt %, from about 1 wt/wt % to about 65 wt/wt %, from about 1 wt/wt % to about 75 wt/wt %, from about 1 wt/wt % to about 85 wt/wt %, from about 1 wt/wt % to about 95 wt/wt %, from about 5 wt/wt % to about 15 wt/wt %, from about 5 wt/wt % to about 25 wt/wt %, from about 5 wt/wt % to about 35 wt/wt %, from about 5 wt/wt % to about 45 wt/wt %, from about 5 wt/wt % to about 55 wt/wt %, from about 5 wt/wt % to about 65 wt/wt %, from about 5 wt/wt % to about 75 wt/wt %, from about 5 wt/wt % to about 85 wt/wt %, from about 5 wt/wt % to about 95 wt/wt %, from about 15 wt/wt % to about 25 wt/wt %, from about 15 wt/wt % to about 35 wt/wt %, from about 15 wt/wt % to about 45 wt/wt %, from about 15 wt/wt % to about 55 wt/wt %, from about 15 wt/wt % to about 65 wt/wt %, from about 15 wt/wt % to about 75 wt/wt %, from about 15 wt/wt % to about 95 wt/wt %, from about 25 wt/wt % to about 35 wt/wt %, from about 25 wt/wt % to about 45 wt/wt %, from about 25 wt/wt % to about 55 wt/wt %, from about 25 wt/wt % to about 65 wt/wt %, from about 25 wt/wt % to about 75 wt/wt %, from about 25 wt/wt % to about 85 wt/wt %, from about 25 wt/wt % to about 95 wt/wt %, from about 35 wt/wt % to about 45 wt/wt %, from about 35 wt/wt % to about 55 wt/wt %, from about 35 wt/wt % to about 65 wt/wt %, from about 35 wt/wt % to about 75 wt/wt %, from about 35 wt/wt % to about 85 wt/wt %, from about 35 wt/wt % to about 95 wt/wt %, from about 45 wt/wt % to about 55 wt/wt %, from about 45 wt/wt % to about 65 wt/wt %, from about 45 wt/wt % to about 75 wt/wt %, from about 45 wt/wt % to about 85 wt/wt %, from about 45 wt/wt % to about 95 wt/wt %, from about 55 wt/wt % to about 65 wt/wt %, from about 55 wt/wt % to about 75 wt/wt %, from about 55 wt/wt % to about 85 wt/wt %, from about 55 wt/wt % to about 95 wt/wt %, from about 65 wt/wt % to about 75 wt/wt %, from about 65 wt/wt % to about 85 wt/wt %, from about 65 wt/wt % to about 95 wt/wt %, from about 75 wt/wt % to about 85 wt/wt %, from about 75 wt/wt % to about 95 wt/wt %, or from about 85 wt/wt % to about 95 wt/wt % of a first antidegradant.

In some embodiments, a Composition of the Disclosure comprises about 50 wt/wt % of a first antidegradant. In some embodiments, the composition comprises about 1 wt/wt %, about 5 wt/wt %, about 10 wt/wt %, about 15 wt/wt %, about 20 wt/wt %, about 25 wt/wt %, about 30 wt/wt %, about 35 wt/wt %, about 40 wt/wt %, about 45 wt/wt %, about 55 wt/wt %, about 60 wt/wt %, about 65 wt/wt %, about 70 wt/wt %, about 75 wt/wt %, about 80 wt/wt %, about 85 wt/wt %, about 90 wt/wt %, or about 95 wt/wt % of a first antidegradant.

In some embodiments, a Composition of the Disclosure comprises a Compound of the Disclosure and one or more elastomers.

The term “elastomer” as used herein is a polymer with viscoelasticity (i.e., having both viscosity and elasticity) that typically has low intermolecular forces, low Young's modulus, and high failure strain. Elastomers can typically be cross-linked by heating in the presence of one or more cross-linking agents, a process called curing or vulcanization. Rubber is one type of elastomer. Non-limiting types of rubber include natural rubber (NR), synthetic rubber, and blends thereof. The term “natural rubber” as used herein refers to a naturally occurring elastomer that can be obtained from Hevea rubber trees. Non-limiting types of synthetic rubbers include unsaturated rubbers, saturated rubbers, rubbers with fluoro and fluoralkyl or fluoralkoxy substituent groups on the polymer chain (FKM), silicone rubbers (Q), and blends thereof. Non-limiting examples of unsaturated rubbers include polyisoprene rubber (IR), butyl rubber (IIR), polybutadiene rubber (BR), styrene-isoprene-butadiene rubber (SIBR), styrene butadiene rubber (SBR), nitrile butadiene rubber (NBR), chloroprene rubber (CR), ethylene propylene diene rubber (EPDM), and blends thereof. These unsaturated rubbers undergo cyclization and crosslinking reactions that lead to hardening of the aged part. As oxidation occurs, these vulcanizates harden and eventually become brittle products. Partial oxidation of vulcanizates leads to losses in performance when used in applications such as vehicle tire sidewalls. Saturated rubbers are rubbers that do not contain C═C unsaturation and include, but are not limited to, acrylic rubber (ACM), chlorinated polyethylene (CM), chlorosulfonated polyethylene (CSM), polychloromethyloxiran (CO), ethylene-ethyl acrylate copolymer (EAM), epichlorohydrin rubber (ECO), ethylene propylene rubber (EPM), ethylenevinylacetate copolymer (EVM), rubbers with fluoro and fluoralkyl or fluoralkoxy substituent groups on the polymer chain (FKM), silicone rubber (Q), and blends thereof.

In some embodiments, the natural rubber comprises rubber derived from an alternative rubber plant. The term “natural rubber comprises rubber derived from an alternative rubber plant” as used herein refers to a naturally occurring elastomer that can be obtained from “non-Hevea” sources. In some embodiments, the alternative rubber plant is Parthenium argentatum (guayule) or Taraxacum kok-saghyz (Russian dandelion).

In some embodiments, the one or more elastomers further comprises recycled rubber. The term “recycled rubber” as used herein refers to an elastomer that has been reclaimed from scrap materials such as used tires.

In some embodiments, a Composition of the Disclosure comprises from about 15 wt/wt % to about 85 wt/wt % of one or more elastomers. In some embodiments, the composition comprises from about 1 wt/wt % to about 5 wt/wt %, from about 1 wt/wt % to about 15 wt/wt %, from about 1 wt/wt % to about 25 wt/wt %, from about 1 wt/wt % to about 35 wt/wt %, from about 1 wt/wt % to about 45 wt/wt %, from about 1 wt/wt % to about 55 wt/wt %, from about 1 wt/wt % to about 65 wt/wt %, from about 1 wt/wt % to about 75 wt/wt %, from about 1 wt/wt % to about 85 wt/wt %, from about 1 wt/wt % to about 95 wt/wt %, from about 5 wt/wt % to about 15 wt/wt %, from about 5 wt/wt % to about 25 wt/wt %, from about 5 wt/wt % to about 35 wt/wt %, from about 5 wt/wt % to about 45 wt/wt %, from about 5 wt/wt % to about 55 wt/wt %, from about 5 wt/wt % to about 65 wt/wt %, from about 5 wt/wt % to about 75 wt/wt %, from about 5 wt/wt % to about 85 wt/wt %, from about 5 wt/wt % to about 95 wt/wt %, from about 15 wt/wt % to about 25 wt/wt %, from about 15 wt/wt % to about 35 wt/wt %, from about 15 wt/wt % to about 45 wt/wt %, from about 15 wt/wt % to about 55 wt/wt %, from about 15 wt/wt % to about 65 wt/wt %, from about 15 wt/wt % to about 75 wt/wt %, from about 15 wt/wt % to about 95 wt/wt %, from about 25 wt/wt % to about 35 wt/wt %, from about 25 wt/wt % to about 45 wt/wt %, from about 25 wt/wt % to about 55 wt/wt %, from about 25 wt/wt % to about 65 wt/wt %, from about 25 wt/wt % to about 75 wt/wt %, from about 25 wt/wt % to about 85 wt/wt %, from about 25 wt/wt % to about 95 wt/wt %, from about 35 wt/wt % to about 45 wt/wt %, from about 35 wt/wt % to about 55 wt/wt %, from about 35 wt/wt % to about 65 wt/wt %, from about 35 wt/wt % to about 75 wt/wt %, from about 35 wt/wt % to about 85 wt/wt %, from about 35 wt/wt % to about 95 wt/wt %, from about 45 wt/wt % to about 55 wt/wt %, from about 45 wt/wt % to about 65 wt/wt %, from about 45 wt/wt % to about 75 wt/wt %, from about 45 wt/wt % to about 85 wt/wt %, from about 45 wt/wt % to about 95 wt/wt %, from about 55 wt/wt % to about 65 wt/wt %, from about 55 wt/wt % to about 75 wt/wt %, from about 55 wt/wt % to about 85 wt/wt %, from about 55 wt/wt % to about 95 wt/wt %, from about 65 wt/wt % to about 75 wt/wt %, from about 65 wt/wt % to about 85 wt/wt %, from about 65 wt/wt % to about 95 wt/wt %, from about 75 wt/wt % to about 85 wt/wt %, from about 75 wt/wt % to about 95 wt/wt %, or from about 85 wt/wt % to about 95 wt/wt % of one or more elastomers.

In some embodiments, a Composition of the Disclosure comprises about 50 wt/wt % of one or more elastomers. In some embodiments, the composition comprises about 1 wt/wt %, about 5 wt/wt %, about 10 wt/wt %, about 15 wt/wt %, about 20 wt/wt %, about 25 wt/wt %, about 30 wt/wt %, about 35 wt/wt %, about 40 wt/wt %, about 45 wt/wt %, about 55 wt/wt %, about 60 wt/wt %, about 65 wt/wt %, about 70 wt/wt %, about 75 wt/wt %, about 80 wt/wt %, about 85 wt/wt %, about 90 wt/wt %, or about 95 wt/wt % of one or more elastomers.

The term “phr” as used herein refers to parts per hundred parts of rubber by weight. The parts by weight of individual components are based on 100 parts by weight of the total mass of the one or more elastomers present in the composition.

In some embodiments, a Composition of the Disclosure comprises from about 1 phr to about 5 phr of a Compound of the Disclosure. In some embodiments, the composition comprises from about 0.01 phr to about 0.1 phr, from about 0.01 phr to about 0.5 phr, from about 0.01 phr to about 1 phr, from about 0.01 phr to about 2 phr, from about 0.01 phr to about 3 phr, from about 0.01 phr to about 4 phr, from about 0.01 phr to about 5 phr, from about 0.01 phr to about 7.5 phr, from about 0.01 phr to about 10 phr, from about 0.01 phr to about 20 phr, from about 0.1 phr to about 0.5 phr, from about 0.1 phr to about 1 phr, from about 0.1 phr to about 2 phr, from about 0.1 phr to about 3 phr, from about 0.1 phr to about 4 phr, from about 0.1 phr to about 5 phr, from about 0.1 phr to about 7.5 phr, from about 0.1 phr to about 10 phr, from about 0.1 phr to about 20 phr, from about 1 phr to about 2 phr, from about 1 phr to about 3 phr, from about 1 phr to about 4 phr, from about 1 phr to about 7.5 phr, from about 1 phr to about 10 phr, from about 1 phr to about 20 phr, from about 2 phr to about 3 phr, from about 2 phr to about 4 phr, from about 2 phr to about 5 phr, from about 2 phr to about 7.5 phr, from about 2 phr to about 10 phr, from about 2 phr to about 20 phr, from about 3 phr to about 4 phr, from about 3 phr to about 5 phr, from about 3 phr to about 7.5 phr, from about 3 phr to about 10 phr, from about 3 phr to about 20 phr, from about 4 phr to about 5 phr, from about 4 phr to about 7.5 phr, from about 4 phr to about 10 phr, from about 4 phr to about 20 phr, from about 5 phr to about 7.5 phr, from about 5 phr to about 10 phr, from about 5 phr to about 20 phr, from about 7.5 phr to about 10 phr, from about 7.5 phr to about 20 phr, or from about 10 phr to about 20 phr of a Compound of the Disclosure.

In some embodiments, a Composition of the Disclosure comprises about 3 phr of a first antidegradant. In some embodiments, the composition comprises about 0.01 phr, about 0.1 phr, about 0.5 phr, about 1 phr, about 2 phr, about 3 phr, about 4 phr, about 5 phr, about 7.5 phr, about 10 phr, or about 20 phr of a first antidegradant.

In some embodiments, a Composition of the Disclosure comprises a Compound of the Disclosure and one or more fillers.

The term “filler” as used herein is a substance that reinforces an elastomeric composition or gives an elastomeric composition other properties, including but not limited to expanding the volume of the composition. Non-limiting examples of fillers include carbon black, silica, kaolin, calcium silicate, talc, carbon nanotubes (CNT), carbon fibers (HCF), graphite, graphenes, aluminosilicates, starch, and fibers, and combinations thereof.

In some embodiments, the filler is derived from natural sources. For example, silica may be derived from rice husks.

In some embodiments, a Composition of the Disclosure comprises from about 15 wt/wt % to about 85 wt/wt % of one or more fillers. In some embodiments, the composition comprises from about 1 wt/wt % to about 5 wt/wt %, from about 1 wt/wt % to about 15 wt/wt %, from about 1 wt/wt % to about 25 wt/wt %, from about 1 wt/wt % to about 35 wt/wt %, from about 1 wt/wt % to about 45 wt/wt %, from about 1 wt/wt % to about 55 wt/wt %, from about 1 wt/wt % to about 65 wt/wt %, from about 1 wt/wt % to about 75 wt/wt %, from about 1 wt/wt % to about 85 wt/wt %, from about 1 wt/wt % to about 95 wt/wt %, from about 5 wt/wt % to about 15 wt/wt %, from about 5 wt/wt % to about 25 wt/wt %, from about 5 wt/wt % to about 35 wt/wt %, from about 5 wt/wt % to about 45 wt/wt %, from about 5 wt/wt % to about 55 wt/wt %, from about 5 wt/wt % to about 65 wt/wt %, from about 5 wt/wt % to about 75 wt/wt %, from about 5 wt/wt % to about 85 wt/wt %, from about 5 wt/wt % to about 95 wt/wt %, from about 15 wt/wt % to about 25 wt/wt %, from about 15 wt/wt % to about 35 wt/wt %, from about 15 wt/wt % to about 45 wt/wt %, from about 15 wt/wt % to about 55 wt/wt %, from about 15 wt/wt % to about 65 wt/wt %, from about 15 wt/wt % to about 75 wt/wt %, from about 15 wt/wt % to about 95 wt/wt %, from about 25 wt/wt % to about 35 wt/wt %, from about 25 wt/wt % to about 45 wt/wt %, from about 25 wt/wt % to about 55 wt/wt %, from about 25 wt/wt % to about 65 wt/wt %, from about 25 wt/wt % to about 75 wt/wt %, from about 25 wt/wt % to about 85 wt/wt %, from about 25 wt/wt % to about 95 wt/wt %, from about 35 wt/wt % to about 45 wt/wt %, from about 35 wt/wt % to about 55 wt/wt %, from about 35 wt/wt % to about 65 wt/wt %, from about 35 wt/wt % to about 75 wt/wt %, from about 35 wt/wt % to about 85 wt/wt %, from about 35 wt/wt % to about 95 wt/wt %, from about 45 wt/wt % to about 55 wt/wt %, from about 45 wt/wt % to about 65 wt/wt %, from about 45 wt/wt % to about 75 wt/wt %, from about 45 wt/wt % to about 85 wt/wt %, from about 45 wt/wt % to about 95 wt/wt %, from about 55 wt/wt % to about 65 wt/wt %, from about 55 wt/wt % to about 75 wt/wt %, from about 55 wt/wt % to about 85 wt/wt %, from about 55 wt/wt % to about 95 wt/wt %, from about 65 wt/wt % to about 75 wt/wt %, from about 65 wt/wt % to about 85 wt/wt %, from about 65 wt/wt % to about 95 wt/wt %, from about 75 wt/wt % to about 85 wt/wt %, from about 75 wt/wt % to about 95 wt/wt %, or from about 85 wt/wt % to about 95 wt/wt % of one or more fillers.

In some embodiments, a Composition of the Disclosure comprises about 50 wt/wt % of one or more fillers. In some embodiments, the composition comprises about 1 wt/wt %, about 5 wt/wt %, about 10 wt/wt %, about 15 wt/wt %, about 20 wt/wt %, about 25 wt/wt %, about 30 wt/wt %, about 35 wt/wt %, about 40 wt/wt %, about 45 wt/wt %, about 55 wt/wt %, about 60 wt/wt %, about 65 wt/wt %, about 70 wt/wt %, about 75 wt/wt %, about 80 wt/wt %, about 85 wt/wt %, about 90 wt/wt %, or about 95 wt/wt % of one or more fillers.

In some embodiments, a Composition of the Disclosure comprises from about 30 phr to about 500 phr of one or more fillers. In some embodiments, the composition comprises from about 30 phr to about 50 phr, from about 30 phr to about 100 phr, from about 30 phr to about 150 phr, from about 30 phr to about 200 phr, from about 30 phr to about 250 phr, from about 30 phr to about 300 phr, from about 30 phr to about 350 phr, from about 30 phr to about 400 phr, from about 30 phr to about 450 phr, from about 30 phr to about 500 phr, from about 50 phr to about 100 phr, from about 50 phr to about 150 phr, from about 50 phr to about 200 phr, from about 50 phr to about 250 phr, from about 50 phr to about 300 phr, from about 50 phr to about 350 phr, from about 50 phr to about 400 phr, from about 50 phr to about 450 phr, from about 50 phr to about 500 phr, from about 100 phr to about 150 phr, from about 100 phr to about 200 phr, from about 100 phr to about 250 phr, from about 100 phr to about 300 phr, from about 100 phr to about 350 phr, from about 100 phr to about 400 phr, from about 100 phr to about 450 phr, from about 100 phr to about 500 phr, from about 150 phr to about 200 phr, from about 150 phr to about 250 phr, from about 150 phr to about 300 phr, from about 150 phr to about 350 phr, from about 150 phr to about 400 phr, from about 150 phr to about 450 phr, from about 150 phr to about 500 phr, from about 200 phr to about 250 phr, from about 200 phr to about 300 phr, from about 200 phr to about 350 phr, from about 200 phr to about 400 phr, from about 200 phr to about 450 phr, from about 200 phr to about 500 phr, from about 250 phr to about 300 phr, from about 250 phr to about 350 phr, from about 250 phr to about 400 phr, from about 250 phr to about 450 phr, from about 250 phr to about 500 phr, from about 300 phr to about 350 phr, from about 300 phr to about 400 phr, from about 300 phr to about 450 phr, from about 300 phr to about 500 phr, from about 350 phr to about 400 phr, from about 350 phr to about 450 phr, from about 350 phr to about 500 phr, from about 400 phr to about 450 phr, from about 400 phr to about 500 phr, or from about 450 phr to about 500 phr of one or more fillers.

In some embodiments, a Composition of the Disclosure comprises about 300 phr of one or more fillers. In some embodiments, the composition comprises about 30 phr, about 50 phr, about 100 phr, about 150 phr, about 200 phr, about 250 phr, about 350 phr, about 400 phr, about 450 phr, or about 500 phr of one or more fillers.

In some embodiments, a Composition of the Disclosure comprises a Compound of the Disclosure and one or more rubber chemicals. The term “rubber chemicals” as used herein refers to a compound or substance used to facilitate the vulcanization of rubber. Rubber chemicals include, but are not limited to, vulcanizing agents, accelerators, activators, and pre-vulcanization inhibitors.

The term “vulcanization” as used herein refers to a process wherein cross-links are formed between elastomers to effect changes in the material properties of elastomers. In particular, vulcanization typically increases the rigidity and durability of elastomers. Vulcanization is carried out at room temperature or at elevated temperatures, depending on the nature of the elastomer(s), filler(s), and rubber chemical(s) being used. The term “curing” is also used in the art to describe this process.

The term “vulcanizing agent” as used herein refers to any substance that enables cross-linking between elastomers. Vulcanizing agents can enable cross-linking between separate polymer chains of an elastomer by various mechanisms, including, but not limited to, by formation of covalent bonds between the vulcanizing agent and two or more separate polymer chains or by generating radical species on separate polymer chains that can combine to form covalent bonds between the two polymer chains. Non-limiting examples of vulcanizing agents include sulfur, peroxides, vulcanized vegetable oil, factices and resins. Non-limiting examples of sulfur include octasulfur (S₈), cyclododecasulfur (S₁₂), and polymeric sulfur. Non-limiting examples of peroxides include benzoyl peroxide, dicumyl peroxide (DC), 2,5-dimethyl-2,5-di-(tert-butylperoxy)-3-hexyne (2,5 Tri), 2,5-dimethyl-2,5-di(tert-butylperoxy)hexane (DDPH), di-(2-tert-butylperoxyisopropyl)benzene (VC), butyl-4,4-di-(tert-butylperoxy)valerate (VAL), and 1,1-di(tert-butylperoxy)-3,3,5-trimethylcyclohexane (TMC). Nonlimiting examples of resins include bonding resins. The term “bonding resin” as used herein refers to a chemical such as resorcinol formaldehyde resins and phenolic resins that reacts with methylene donors (such as hexamethylenetetramine (HMTA) or hexamethoxymethyl melamine (HMMM)) to promote adhesion.

The term “accelerator” as used herein refers to any substance that increases the kinetics of vulcanization. In some embodiments, accelerators enable vulcanization to be performed at lower temperatures and/or to use the vulcanization agent, e.g., sulfur, more efficiently. Non-limiting examples of accelerators include guanidines, thiazoles, sulfenamides, thiurams, dithiocarbamates, xanthates, and thiophosphates. Non-limiting examples of guanidines include diphenylguanidine (DPG). Non-limiting examples of thiazoles include 2-mercaptobenzothiazole (MBT), zinc 2-mercaptobenzothiazole (ZMBT), mercaptobenzothiazole disulfide (MBTS), and N-tert-butyl-2-benzothiazole sulfenimide (TBSI). Non-limiting examples of sulfenamides include N-tert-butyl-2-benzothiazylsulfenamide (TBBS), N-cyclohexylbenzothiazol-2-sulfenamide (CBS), dicyclohexyl-2-benzothiazolesulfenamide (DCBS), N-oxydiethylene benzothiazole sulfenamide (OBTS), N-oxydiethylenethiocarbamyl-N′-oxydiethylene sulfenamide (OTOS), and thiocarbamyl sulfenamide. Non-limiting examples of thiurams include dimethylcarbamothioic dithioperoxyanhydride (thiram), dipentamethylene thiuram tetrasulfide (DPIT), tetrabenzyl thiuram disulfide (TBzTD), tetraethylthiuram disulfide (TETD), tetramethylthiuram disulfide (TMTD), and tetramethylthiuram monosulfide (TMTM). Non-limiting examples of dithiocarbamates include zinc dimethyldithiocarbamate (ZDMC), zinc diethyldithiocarbamate (ZDEC), zinc dibutyldithiocarbamate (ZDBC), nickel dibutyldithiocarbamate (NDBC), sodium dibenzyldithiocarbamate (SBEC), sodium diethyldithiocarbamate (SDEC), tellurium diethyldithiocarbamate (TDEC), and zinc dibenzyldithiocarbamate (ZEBC).

The term “activator” as used herein refers to any substance that activates a vulcanizing agent and enables it to cross-link elastomers as described above. Activators may act via various mechanisms, including, but not limited to, by forming chemical complexes with accelerators or by coordinating to sulfur (when sulfur is used as a vulcanizing agent). Non-limiting examples of activators include metal oxides, acids, and metal complexes. Non-limiting examples of metal oxides include zinc oxide, magnesium oxide, and lead oxide. Non-limiting examples of acids include stearic acid and lauric acid. Non limiting examples of metal complexes include zinc ethylhexanoate.

The term “pre-vulcanization inhibitor” as used herein refers to compounds that delay the onset and/or the rate of vulcanization. These compounds are also referred to as “retarders.” Non-limiting examples of pre-vulcanization inhibitors include N-(cyclohexylthio) phthalimide (CTP), benzoic anhydride, salicylic anhydride, and phthalic anhydride.

In some embodiments, a Composition of the Disclosure comprises from about 15 wt/wt % to about 85 wt/wt % of one or more rubber chemicals. In some embodiments, the composition comprises from about 1 wt/wt % to about 5 wt/wt %, from about 1 wt/wt % to about 15 wt/wt %, from about 1 wt/wt % to about 25 wt/wt %, from about 1 wt/wt % to about 35 wt/wt %, from about 1 wt/wt % to about 45 wt/wt %, from about 1 wt/wt % to about 55 wt/wt %, from about 1 wt/wt % to about 65 wt/wt %, from about 1 wt/wt % to about 75 wt/wt %, from about 1 wt/wt % to about 85 wt/wt %, from about 1 wt/wt % to about 95 wt/wt %, from about 5 wt/wt % to about 15 wt/wt %, from about 5 wt/wt % to about 25 wt/wt %, from about 5 wt/wt % to about 35 wt/wt %, from about 5 wt/wt % to about 45 wt/wt %, from about 5 wt/wt % to about 55 wt/wt %, from about 5 wt/wt % to about 65 wt/wt %, from about 5 wt/wt % to about 75 wt/wt %, from about 5 wt/wt % to about 85 wt/wt %, from about 5 wt/wt % to about 95 wt/wt %, from about 15 wt/wt % to about 25 wt/wt %, from about 15 wt/wt % to about 35 wt/wt %, from about 15 wt/wt % to about 45 wt/wt %, from about 15 wt/wt % to about 55 wt/wt %, from about 15 wt/wt % to about 65 wt/wt %, from about 15 wt/wt % to about 75 wt/wt %, from about 15 wt/wt % to about 95 wt/wt %, from about 25 wt/wt % to about 35 wt/wt %, from about 25 wt/wt % to about 45 wt/wt %, from about 25 wt/wt % to about 55 wt/wt %, from about 25 wt/wt % to about 65 wt/wt %, from about 25 wt/wt % to about 75 wt/wt %, from about 25 wt/wt % to about 85 wt/wt %, from about 25 wt/wt % to about 95 wt/wt %, from about 35 wt/wt % to about 45 wt/wt %, from about 35 wt/wt % to about 55 wt/wt %, from about 35 wt/wt % to about 65 wt/wt %, from about 35 wt/wt % to about 75 wt/wt %, from about 35 wt/wt % to about 85 wt/wt %, from about 35 wt/wt % to about 95 wt/wt %, from about 45 wt/wt % to about 55 wt/wt %, from about 45 wt/wt % to about 65 wt/wt %, from about 45 wt/wt % to about 75 wt/wt %, from about 45 wt/wt % to about 85 wt/wt %, from about 45 wt/wt % to about 95 wt/wt %, from about 55 wt/wt % to about 65 wt/wt %, from about 55 wt/wt % to about 75 wt/wt %, from about 55 wt/wt % to about 85 wt/wt %, from about 55 wt/wt % to about 95 wt/wt %, from about 65 wt/wt % to about 75 wt/wt %, from about 65 wt/wt % to about 85 wt/wt %, from about 65 wt/wt % to about 95 wt/wt %, from about 75 wt/wt % to about 85 wt/wt %, from about 75 wt/wt % to about 95 wt/wt %, or from about 85 wt/wt % to about 95 wt/wt % of one or more rubber chemicals.

In some embodiments, a Composition of the Disclosure comprises about 15 wt/wt % of one or more rubber chemicals. In some embodiments, the composition comprises about 1 wt/wt %, about 5 wt/wt %, about 10 wt/wt %, about 20 wt/wt %, about 25 wt/wt %, about 30 wt/wt %, about 35 wt/wt %, about 40 wt/wt %, about 45 wt/wt %, about 50 wt/wt %, about 55 wt/wt %, about 60 wt/wt %, about 65 wt/wt %, about 70 wt/wt %, about 75 wt/wt %, about 80 wt/wt %, about 85 wt/wt %, about 90 wt/wt %, or about 95 wt/wt % of one or more rubber chemicals.

In some embodiments, a Composition of the Disclosure comprises from about 1 phr to about 20 phr of one or more rubber chemicals. In some embodiments, the composition comprises from about 0.1 phr to about 1 phr, from about 0.1 phr to about 5 phr, from about 0.1 phr to about 10 phr, from about 0.1 phr to about 15 phr, from about 0.1 phr to about 20 phr, from about 0.1 phr to about 25 phr, from about 0.1 phr to about 30 phr, from about 0.1 phr to about 35 phr, from about 0.1 phr to about 40 phr, from about 1 phr to about 5 phr, from about 1 phr to about 10 phr, from about 1 phr to about 15 phr, from about 1 phr to about 25 phr, from about 1 phr to about 30 phr, from about 1 phr to about 35 phr, from about 1 phr to about 40 phr, from about 5 phr to about 10 phr, from about 5 phr to about 15 phr, from about 5 phr to about 20 phr, from about 5 phr to about 25 phr, from about 5 phr to about 30 phr, from about 5 phr to about 35 phr, from about 5 phr to about 40 phr, from about 10 phr to about 15 phr, from about 10 phr to about 20 phr, from about 10 phr to about 25 phr, from about 10 phr to about 30 phr, from about 10 phr to about 35 phr, from about 10 phr to about 40 phr, from about 15 phr to about 20 phr, from about 15 phr to about 25 phr, from about 15 phr to about 30 phr, from about 15 phr to about 35 phr, from about 15 phr to about 40 phr, from about 20 phr to about 25 phr, from about 20 phr to about 30 phr, from about 20 phr to about 35 phr, from about 20 phr to about 40 phr, from about 25 phr to about 30 phr, from about 25 phr to about 35 phr, from about 25 phr to about 40 phr, from about 30 phr to about 35 phr, from about 30 phr to about 40 phr, or from about 35 phr to about 40 phr of one or more rubber chemicals.

In some embodiments, a Composition of the Disclosure comprises about 10 phr of one or more rubber chemicals. In some embodiments, the composition comprises about 0.1 phr, about 1 phr, about 5 phr, about 15 phr, about 20 phr, about 25 phr, about 30 phr, about 35 phr, or about 40 phr of one or more rubber chemicals.

The term “plasticizer” as used herein refers to a processing aid used to reduce the viscosity, increase the plasticity, and/or extend the volume of a composition. Plasticizers facilitate the process of mixing and forming a composition comprising an elastomer before the composition is vulcanized. Non-limiting examples of plasticizers include mineral oils (paraffinic, aromatic, or naphthenic), organic esters, resins, waxes, ester plasticizers, and naturally derived oils, such as soybean oil, vegetable oil, or orange oil.

In some embodiments, a Composition of the Disclosure comprises from about 15 wt/wt % to about 85 wt/wt % of one or more plasticizers. In some embodiments, the composition comprises from about 1 wt/wt % to about 5 wt/wt %, from about 1 wt/wt % to about 15 wt/wt %, from about 1 wt/wt % to about 25 wt/wt %, from about 1 wt/wt % to about 35 wt/wt %, from about 1 wt/wt % to about 45 wt/wt %, from about 1 wt/wt % to about 55 wt/wt %, from about 1 wt/wt % to about 65 wt/wt %, from about 1 wt/wt % to about 75 wt/wt %, from about 1 wt/wt % to about 85 wt/wt %, from about 1 wt/wt % to about 95 wt/wt %, from about 5 wt/wt % to about 15 wt/wt %, from about 5 wt/wt % to about 25 wt/wt %, from about 5 wt/wt % to about 35 wt/wt %, from about 5 wt/wt % to about 45 wt/wt %, from about 5 wt/wt % to about 55 wt/wt %, from about 5 wt/wt % to about 65 wt/wt %, from about 5 wt/wt % to about 75 wt/wt %, from about 5 wt/wt % to about 85 wt/wt %, from about 5 wt/wt % to about 95 wt/wt %, from about 15 wt/wt % to about 25 wt/wt %, from about 15 wt/wt % to about 35 wt/wt %, from about 15 wt/wt % to about 45 wt/wt %, from about 15 wt/wt % to about 55 wt/wt %, from about 15 wt/wt % to about 65 wt/wt %, from about 15 wt/wt % to about 75 wt/wt %, from about 15 wt/wt % to about 95 wt/wt %, from about 25 wt/wt % to about 35 wt/wt %, from about 25 wt/wt % to about 45 wt/wt %, from about 25 wt/wt % to about 55 wt/wt %, from about 25 wt/wt % to about 65 wt/wt %, from about 25 wt/wt % to about 75 wt/wt %, from about 25 wt/wt % to about 85 wt/wt %, from about 25 wt/wt % to about 95 wt/wt %, from about 35 wt/wt % to about 45 wt/wt %, from about 35 wt/wt % to about 55 wt/wt %, from about 35 wt/wt % to about 65 wt/wt %, from about 35 wt/wt % to about 75 wt/wt %, from about 35 wt/wt % to about 85 wt/wt %, from about 35 wt/wt % to about 95 wt/wt %, from about 45 wt/wt % to about 55 wt/wt %, from about 45 wt/wt % to about 65 wt/wt %, from about 45 wt/wt % to about 75 wt/wt %, from about 45 wt/wt % to about 85 wt/wt %, from about 45 wt/wt % to about 95 wt/wt %, from about 55 wt/wt % to about 65 wt/wt %, from about 55 wt/wt % to about 75 wt/wt %, from about 55 wt/wt % to about 85 wt/wt %, from about 55 wt/wt % to about 95 wt/wt %, from about 65 wt/wt % to about 75 wt/wt %, from about 65 wt/wt % to about 85 wt/wt %, from about 65 wt/wt % to about 95 wt/wt %, from about 75 wt/wt % to about 85 wt/wt %, from about 75 wt/wt % to about 95 wt/wt %, or from about 85 wt/wt % to about 95 wt/wt % of one or more plasticizers.

In some embodiments, a Composition of the Disclosure comprises about 15 wt/wt % of one or more plasticizers. In some embodiments, the composition comprises about 1 wt/wt %, about 5 wt/wt %, about 10 wt/wt %, about 20 wt/wt %, about 25 wt/wt %, about 30 wt/wt %, about 35 wt/wt %, about 40 wt/wt %, about 45 wt/wt %, about 50 wt/wt %, about 55 wt/wt %, about 60 wt/wt %, about 65 wt/wt %, about 70 wt/wt %, about 75 wt/wt %, about 80 wt/wt %, about 85 wt/wt %, about 90 wt/wt %, or about 95 wt/wt % of one or more plasticizers.

In some embodiments, a Composition of the Disclosure comprises from about 1 phr to about 20 phr of one or more plasticizers. In some embodiments, the composition comprises from about 0.1 phr to about 1 phr, from about 0.1 phr to about 5 phr, from about 0.1 phr to about 10 phr, from about 0.1 phr to about 15 phr, from about 0.1 phr to about 20 phr, from about 0.1 phr to about 25 phr, from about 0.1 phr to about 30 phr, from about 0.1 phr to about 35 phr, from about 0.1 phr to about 40 phr, from about 1 phr to about 5 phr, from about 1 phr to about 10 phr, from about 1 phr to about 15 phr, from about 1 phr to about 25 phr, from about 1 phr to about 30 phr, from about 1 phr to about 35 phr, from about 1 phr to about 40 phr, from about 5 phr to about 10 phr, from about 5 phr to about 15 phr, from about 5 phr to about 20 phr, from about 5 phr to about 25 phr, from about 5 phr to about 30 phr, from about 5 phr to about 35 phr, from about 5 phr to about 40 phr, from about 10 phr to about 15 phr, from about 10 phr to about 20 phr, from about 10 phr to about 25 phr, from about 10 phr to about 30 phr, from about 10 phr to about 35 phr, from about 10 phr to about 40 phr, from about 15 phr to about 20 phr, from about 15 phr to about 25 phr, from about 15 phr to about 30 phr, from about 15 phr to about 35 phr, from about 15 phr to about 40 phr, from about 20 phr to about 25 phr, from about 20 phr to about 30 phr, from about 20 phr to about 35 phr, from about 20 phr to about 40 phr, from about 25 phr to about 30 phr, from about 25 phr to about 35 phr, from about 25 phr to about 40 phr, from about 30 phr to about 35 phr, from about 30 phr to about 40 phr, or from about 35 phr to about 40 phr of one or more plasticizers.

In some embodiments, a Composition of the Disclosure comprises about 10 phr of one or more plasticizers. In some embodiments, the composition comprises about 0.1 phr, about 1 phr, about 5 phr, about 15 phr, about 20 phr, about 25 phr, about 30 phr, about 35 phr, or about 40 phr of one or more plasticizers.

In some embodiments, a Composition of the Disclosure further comprises one or more second, i.e., additional, antidegradants that is (are) different from the first antidegradant. In some embodiments, the one or more second antidegradants comprise an antioxidant. In some embodiments, one or more second antidegradants comprise an antiozonant. Non-limiting examples of antidegradants include paraphenylenediamines (PPDs), trimethyl-dihydroquinolines (TMQs), phenolics, alkylated diphenylamines (DPAs), diphenylamine-ketone condensates, and natural antidegradants. Non-limiting examples of PPDs include N¹-(4-methylpentan-2-yl)-N⁴-phenylbenzene-1,4-diamine (6PPD or 6-PPD), N-(1,4-dimethylpentyl)-N′-phenyl-p-phenylenediamine (7PPD), N¹-phenyl-N⁴-(propan-2-yl)benzene-1,4-diamine (IPPD), N,N′-di-sec-butyl-p-phenylenediamine (44PD), N,N′-bis(1,3-dimethylbutyl)-p-phenylenediamine (66PD), N,N′-bis(1,4-dimethylpentyl)-p-phenylenediamine (77PD), and N—N′-dioctyl-p-phenylenediamine (88PD). Non-limiting examples of TMQs include 2,2,4-trimethyl-1,2-dihydroquinoline and oligomers or polymers thereof.

In some embodiments, a Composition of the Disclosure comprises from about 15 wt/wt % to about 85 wt/wt % of one or more second antidegradants. In some embodiments, the composition comprises from about 1 wt/wt % to about 5 wt/wt %, from about 1 wt/wt % to about 15 wt/wt %, from about 1 wt/wt % to about 25 wt/wt %, from about 1 wt/wt % to about 35 wt/wt %, from about 1 wt/wt % to about 45 wt/wt %, from about 1 wt/wt % to about 55 wt/wt %, from about 1 wt/wt % to about 65 wt/wt %, from about 1 wt/wt % to about 75 wt/wt %, from about 1 wt/wt % to about 85 wt/wt %, from about 1 wt/wt % to about 95 wt/wt %, from about 5 wt/wt % to about 15 wt/wt %, from about 5 wt/wt % to about 25 wt/wt %, from about 5 wt/wt % to about 35 wt/wt %, from about 5 wt/wt % to about 45 wt/wt %, from about 5 wt/wt % to about 55 wt/wt %, from about 5 wt/wt % to about 65 wt/wt %, from about 5 wt/wt % to about 75 wt/wt %, from about 5 wt/wt % to about 85 wt/wt %, from about 5 wt/wt % to about 95 wt/wt %, from about 15 wt/wt % to about 25 wt/wt %, from about 15 wt/wt % to about 35 wt/wt %, from about 15 wt/wt % to about 45 wt/wt %, from about 15 wt/wt % to about 55 wt/wt %, from about 15 wt/wt % to about 65 wt/wt %, from about 15 wt/wt % to about 75 wt/wt %, from about 15 wt/wt % to about 95 wt/wt %, from about 25 wt/wt % to about 35 wt/wt %, from about 25 wt/wt % to about 45 wt/wt %, from about 25 wt/wt % to about 55 wt/wt %, from about 25 wt/wt % to about 65 wt/wt %, from about 25 wt/wt % to about 75 wt/wt %, from about 25 wt/wt % to about 85 wt/wt %, from about 25 wt/wt % to about 95 wt/wt %, from about 35 wt/wt % to about 45 wt/wt %, from about 35 wt/wt % to about 55 wt/wt %, from about 35 wt/wt % to about 65 wt/wt %, from about 35 wt/wt % to about 75 wt/wt %, from about 35 wt/wt % to about 85 wt/wt %, from about 35 wt/wt % to about 95 wt/wt %, from about 45 wt/wt % to about 55 wt/wt %, from about 45 wt/wt % to about 65 wt/wt %, from about 45 wt/wt % to about 75 wt/wt %, from about 45 wt/wt % to about 85 wt/wt %, from about 45 wt/wt % to about 95 wt/wt %, from about 55 wt/wt % to about 65 wt/wt %, from about 55 wt/wt % to about 75 wt/wt %, from about 55 wt/wt % to about 85 wt/wt %, from about 55 wt/wt % to about 95 wt/wt %, from about 65 wt/wt % to about 75 wt/wt %, from about 65 wt/wt % to about 85 wt/wt %, from about 65 wt/wt % to about 95 wt/wt %, from about 75 wt/wt % to about 85 wt/wt %, from about 75 wt/wt % to about 95 wt/wt %, or from about 85 wt/wt % to about 95 wt/wt % of one or more second antidegradants.

In some embodiments, a Composition of the Disclosure comprises about 15 wt/wt % of one or more second antidegradants. In some embodiments, the composition comprises about 1 wt/wt %, about 5 wt/wt %, about 10 wt/wt %, about 20 wt/wt %, about 25 wt/wt %, about 30 wt/wt %, about 35 wt/wt %, about 40 wt/wt %, about 45 wt/wt %, about 50 wt/wt %, about 55 wt/wt %, about 60 wt/wt %, about 65 wt/wt %, about 70 wt/wt %, about 75 wt/wt %, about 80 wt/wt %, about 85 wt/wt %, about 90 wt/wt %, or about 95 wt/wt % of one or more second antidegradants.

In some embodiments, a Composition of the Disclosure comprises from about 1 to about 5 phr of one or more second antidegradants. In some embodiments, the composition comprises from about 0.001 phr to about 0.01 phr, from about 0.001 phr to about 0.1 phr, from about 0.001 phr to about 1 phr, from about 0.001 phr to about 5 phr, from about 0.001 phr to about 7.5 phr, from about 0.001 phr to about 10 phr, from about 0.01 phr to about 0.1 phr, from about 0.01 phr to about 1 phr, from about 0.01 phr to about 5 phr, from about 0.01 phr to about 7.5 phr, from about 0.01 phr to about 10 phr, from about 0.1 phr to about 1 phr, from about 0.1 phr to about 5 phr, from about 0.1 phr to about 7.5 phr, from about 0.1 phr to about 10 phr, from about 1 phr to about 7.5 phr, from about 1 phr to about 10 phr, from about 5 phr to about 7.5 phr, from about 5 phr to about 10 phr, or from about 7.5 phr to about 10 phr.

In some embodiments, a Composition of the Disclosure comprises about 3 phr of one or more second antidegradants. In some embodiments, the composition comprises about 0.001 phr, about 0.01 phr, about 0.1 phr, about 1 phr, about 2 phr, about 4 phr, about 5 phr, about 7.5 phr, or about 10 phr of one or more second antidegradants.

In some embodiments, the disclosure provides a composition comprising a Compound of the Disclosure and one or more carriers. The term “carrier” as used herein refers to a solid that can adsorb a liquid while retaining the general properties of a solid at room temperature. In some embodiments, the carrier is an inert material. In some embodiments, the carrier has a high surface area. In some embodiments, the carrier comprises particles with diameters of less than 500 microns.

In some embodiments, the composition comprises from about 15 wt/wt % to about 85 wt/wt % of one or more carriers. In some embodiments, the composition comprises from about 1 wt/wt % to about 5 wt/wt %, from about 1 wt/wt % to about 15 wt/wt %, from about 1 wt/wt % to about 25 wt/wt %, from about 1 wt/wt % to about 35 wt/wt %, from about 1 wt/wt % to about 45 wt/wt %, from about 1 wt/wt % to about 55 wt/wt %, from about 1 wt/wt % to about 65 wt/wt %, from about 1 wt/wt % to about 75 wt/wt %, from about 1 wt/wt % to about 85 wt/wt %, from about 1 wt/wt % to about 95 wt/wt %, from about 5 wt/wt % to about 15 wt/wt %, from about 5 wt/wt % to about 25 wt/wt %, from about 5 wt/wt % to about 35 wt/wt %, from about 5 wt/wt % to about 45 wt/wt %, from about 5 wt/wt % to about 55 wt/wt %, from about 5 wt/wt % to about 65 wt/wt %, from about 5 wt/wt % to about 75 wt/wt %, from about 5 wt/wt % to about 85 wt/wt %, from about 5 wt/wt % to about 95 wt/wt %, from about 15 wt/wt % to about 25 wt/wt %, from about 15 wt/wt % to about 35 wt/wt %, from about 15 wt/wt % to about 45 wt/wt %, from about 15 wt/wt % to about 55 wt/wt %, from about 15 wt/wt % to about 65 wt/wt %, from about 15 wt/wt % to about 75 wt/wt %, from about 15 wt/wt % to about 95 wt/wt %, from about 25 wt/wt % to about 35 wt/wt %, from about 25 wt/wt % to about 45 wt/wt %, from about 25 wt/wt % to about 55 wt/wt %, from about 25 wt/wt % to about 65 wt/wt %, from about 25 wt/wt % to about 75 wt/wt %, from about 25 wt/wt % to about 85 wt/wt %, from about 25 wt/wt % to about 95 wt/wt %, from about 35 wt/wt % to about 45 wt/wt %, from about 35 wt/wt % to about 55 wt/wt %, from about 35 wt/wt % to about 65 wt/wt %, from about 35 wt/wt % to about 75 wt/wt %, from about 35 wt/wt % to about 85 wt/wt %, from about 35 wt/wt % to about 95 wt/wt %, from about 45 wt/wt % to about 55 wt/wt %, from about 45 wt/wt % to about 65 wt/wt %, from about 45 wt/wt % to about 75 wt/wt %, from about 45 wt/wt % to about 85 wt/wt %, from about 45 wt/wt % to about 95 wt/wt %, from about 55 wt/wt % to about 65 wt/wt %, from about 55 wt/wt % to about 75 wt/wt %, from about 55 wt/wt % to about 85 wt/wt %, from about 55 wt/wt % to about 95 wt/wt %, from about 65 wt/wt % to about 75 wt/wt %, from about 65 wt/wt % to about 85 wt/wt %, from about 65 wt/wt % to about 95 wt/wt %, from about 75 wt/wt % to about 85 wt/wt %, from about 75 wt/wt % to about 95 wt/wt %, or from about 85 wt/wt % to about 95 wt/wt % of one or more carriers.

In some embodiments, the composition comprises about 15 wt/wt % of one or more carriers. In some embodiments, the composition comprises about 1 wt/wt %, about 5 wt/wt %, about 10 wt/wt %, about 20 wt/wt %, about 25 wt/wt %, about 30 wt/wt %, about 35 wt/wt %, about 40 wt/wt %, about 45 wt/wt %, about 50 wt/wt %, about 55 wt/wt %, about 60 wt/wt %, about 65 wt/wt %, about 70 wt/wt %, about 75 wt/wt %, about 80 wt/wt %, about 85 wt/wt %, about 90 wt/wt %, or about 95 wt/wt % of one or more carriers.

The present disclosure also provides processes for preparing a composition comprising a Compound of the Disclosure and one or more carriers, the process comprising admixing the compound and the one or more carriers.

In some embodiments, the disclosure provides the rubber compositions and/or tires described in U.S. Pat. No. 11,396,208, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 1.

TABLE 1

| | C1 | C2 | C3 | C4 | C5 | C6 |
|---|---|---|---|---|---|---|
| NR (1) | 50 | 50 | 50 | 50 | 50 | 50 |
| BR (2) | 50 | 50 | 50 | 50 | 50 | 50 |
| Carbon black (3) | 56 | 56 | 56 | 56 | 56 | 56 |
| Crumb (4) | 0^{a} | 30^{a} | 50^{a} | 0^{b} | 23^{b} | 54^{b} |
| Plasticizing oil (5) | 22 | 22 | 22 | 22 | 25 | 29 |
| Antioxidants (6) | 4 | 4 | 4 | 4 | 4 | 4 |
| Anti-ozone wax (7) | 1 | 1 | 1 | 1 | 1.1 | 1.3 |
| Stearic acid (8) | 1 | 1 | 1 | 1 | 1.1 | 1.3 |
| Zinc oxide (9) | 2.4 | 2.4 | 2.4 | 2.4 | 2.7 | 3.2 |
| Accelerator (10) | 0.85 | 0.85 | 0.85 | 0.85 | 1.0 | 1.1 |
| Sulfur | 1.7 | 1.7 | 1.7 | 1.70 | 1.9 | 2.3 |

(1) NR: Natural rubber
(2) BR with 0.5% of 1,2-units; 2% of trans-; 96.5% of 1,4-cis- (Tg = −107° C.)
(3) Carbon black, ASTM N330 grade
(4^{a})Crum rubber sold under the name HTR704 by the company Eswar and as described below:
Crumb HTR704
Acetone extract 14.5%
Chloroform extract 28.3%
Mw (CHCl₃ extract) 41 000 g/mol
Mooney viscosity 60
(4^{b})Crumb rubber of heavy-weight vehicle tire tread, used milled. The milling is carried out on a piece of equipment, CUM150, from the company Netzsch using spike diameters of 3 mm and a mill rotation speed of 15 000 rpm. The flow rate of matter is about 50 kg/h and the facility is cooled in order to guarantee a mill outlet gas temperature of −60° C.
Crumb
Acetone extract 4.5%
Chloroform extract 6.3% Mw (CHCl₃ extract) 7000 g/mol
Particle size (D50) 155 μm
(5) MES oil, Catenex SNR, from the company Shell
(6) Compound of the Disclosure, e.g., a compound of Tables A-J and/or 2,2,4-trimethyl-1,2-dihydroquinoline (TMQ)
(7) Anti-ozone wax, Varazon 4959 from the company Sasol
(8) Stearin, Pristerene 4931 from the company Uniqema
(9) Zinc oxide, industrial grade - Umicore
(10) N-Cyclohexyl-2-benzothiazolesulfenamide (Santocure CBS from Flexsys)
* all in phr (parts per hundred rubber)

In some embodiments, the disclosure provides a tire provided with an outer sidewall, the outer sidewall comprising at least a rubber composition based on at least an elastomer, a reinforcing filler, a crosslinking system, more than 25 phr of a crumb rubber, and a Compound of the Disclosure, e.g., a compound of Tables A-J, wherein the crumb rubber has a chloroform extract of which the weight-average molecular weight is greater than 10,000 g/mol.

In some embodiments, the disclosure provides a tire provided with an outer sidewall, the outer sidewall comprising at least a rubber composition based on at least an elastomer, a reinforcing filler, a crosslinking system, more than 25 phr of a crumb rubber, and a Compound of the Disclosure, e.g., a compound of Tables A-J, wherein the crumb rubber has not undergone any modification by a treatment selected from the group consisting of thermal, mechanical, biological and chemical treatments and combinations thereof, and wherein the crumb rubber has an acetone extract of between 3% and 15% by weight.

In some embodiments, the disclosure provides a tire provided with an outer sidewall, the outer sidewall comprising at least a rubber composition based on at least an elastomer, a reinforcing filler, a crosslinking system, more than 25 phr of a crumb rubber, and a Compound of the Disclosure, e.g., a compound of Tables A-J, wherein the crumb rubber has not undergone any modification by a treatment selected from the group consisting of thermal, mechanical, biological and chemical treatments and combinations thereof, and wherein the crumb rubber has a chloroform extract of between 3% and 20% by weight.

In some embodiments, the disclosure provides a tire provided with an outer sidewall, the outer sidewall comprising at least a rubber composition based on at least an elastomer, a reinforcing filler, a crosslinking system, more than 25 phr of a crumb rubber, and a Compound of the Disclosure, e.g., a compound of Tables A-J, wherein the crumb rubber has not undergone any modification by a treatment selected from the group consisting of thermal, mechanical, biological and chemical treatments and combinations thereof, and wherein the crumb rubber has a ratio of a chloroform extract to an acetone extract, expressed as weight percentage, of less than 1.5.

In some embodiments, the disclosure provides a tire provided with an outer sidewall, the outer sidewall comprising at least a rubber composition based on at least an elastomer, a reinforcing filler, a crosslinking system, more than 25 phr of a crumb rubber, and a Compound of the Disclosure, e.g., a compound of Tables A-J, wherein the crumb rubber has not undergone any modification by a treatment selected from the group consisting of thermal, mechanical, biological and chemical treatments and combinations thereof, and wherein the crumb rubber has a chloroform extract of which the weight-average molecular weight is less than 10,000 g/mol.

In some embodiments, the disclosure provides the rubber compositions and/or tires described in U.S. Pat. No. 11,400,756, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 2.

TABLE 2

| | M | T1 | T2 | C1 |
|---|---|---|---|---|
| Natural rubber | 80 | 100 | 100 | 100 |
| SBR | 20 | — | — | — |
| Carbon black (1) | 42 | — | — | — |
| Carbon black (2) | — | 24 | 24 | — |
| Silica (3) | 10 | 18 | 18 | 7 |
| Black covered by silica | — | — | — | 35 |
| (4) | | | | |
| Coupling agent (5) | 3.6 | 3.6 | 3.6 | 3.6 |
| Antioxidant (6) | 4 | 4 | 4 | 4 |
| Stearic acid | 2 | 2 | 2 | 2 |
| ZnO (7) | 3 | 3 | 3 | 3 |
| Sulfur | 2 | 2 | 2 | 2 |

(1) N234 sold by Cabot Corporation
(2) N375 sold by Cabot Corporation
(3) Zeosil 1165MP precipitated silica, sold by Solvay
(4) CRX2125 sold by Cabot Corporation
(5) bis(3-triethoxysilylpropyl) tetrasulfide, TESPT, SI69, sold by Evonik
(6) Compound of the Disclosure, e.g., a compound of Tables A-J
(7) Industrial grade zinc oxide, sold by Umicore
(8) N-cyclohexyl-2-benzothiazolesulfenamide, Santocure CBS, sold by Flexsys

In some embodiments, the disclosure provides a tire having a radial carcass reinforcement configured to equip vehicles carrying heavy loads and running at sustained speed, comprising a crown reinforcement, itself capped radially with a tread joined to two beads via two sidewalls, the tread comprising at least two radially superposed layers of polymeric compound, a radially outer first layer that comes into contact with the ground and a radially inner second layer, wherein the second layer has a composition based on at least an elastomeric matrix comprising a diene elastomer, a reinforcing filler comprising predominantly a filler covered at least partially by silica, an agent for coupling the filler with the elastomer, a crosslinking system, and a Compound of the Disclosure, e.g., compound of Tables A-J, wherein the dispersion of the filler in the elastomeric matrix having a Z value greater than or equal to 70, according to the method described by S. Otto et al. in Kautschuk Gummi Kunststoffe, 58 Jahrgang, NR 7-8/2005, in agreement with standard ISO 11345.

In some embodiments, the disclosure provides the rubber compositions described in U.S. Pat. No. 11,396,569, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 3.

TABLE 3

| | C01 | C02 | C03 | C04 | C05 |
|---|---|---|---|---|---|
| NR [1] | 100 | — | — | — | — |
| BR1 (2a) | — | 100 | 100 | — | — |
| BR2 (2b) | — | — | — | — | — |
| SBR1 (3a) | — | — | — | — | — |
| SBR2 (3b) | — | — | — | — | — |
| IR1 (4a) | — | — | — | 35 | |
| Carbon black | 65 | 65 | 65 | 65 | 65 |
| Compound of the | 2.0 | 2.0 | 2.0 | 2.0 | 2.0 |
| Disclosure, e.g., a | | | | | |
| compound of Tables A-J | | | | | |
| Stearic acid (6) | 0. | 0.6 | 0.6 | 0.6 | 0.6 |
| ZnO (7) | 8.0 | 8.0 | 8.0 | 8.0 | 8.0 |
| TBBS (8) | — | — | 2.7 | — | 2.3 |
| Compound III-a | — | — | 2.7 | — | 2.3 |

[1]: Natural rubber;
(2): Polybutadiene;
(3): Styrene-butadiene copolymer;
(4): Polyisoprene;
(6): Stearin “Pristerene 4931” from Uniquema;
(7): Zinc oxide, industrial grade - Umicore;
(8): N-(tert-butyl)-2-benzothiazolesulfenamide (Santocure TBBS from Flexsys).

In some embodiments, the disclosure provides a rubber composition comprising a functional elastomer, which functional elastomer is a diene elastomer which comprises diene units in the cis-1,4 configuration and pendant groups of formula (I) of U.S. Pat. No. 11,396,569:

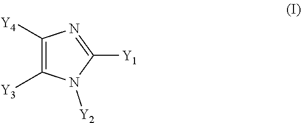

in which: the Y₁, Y₂, Y₃ and Y₄ symbols, which are identical or different, represent an atom or a group of atoms, at least one of the Y₁, Y₂, Y₃ and Y₄ symbols denotes an attachment to a diene unit of the elastomer, the diene units in the cis-1,4 configuration representing at least 90 mol % of the diene units of the functional elastomer, a reinforcing filler which comprises a carbon black, the carbon black representing more than 50% by weight of the reinforcing filler, and a Compound of the Disclosure, e.g., a compound of Tables A-J.

In some embodiments, the disclosure provides the rubber compositions and/or tires described in U.S. Pat. No. 11,390,117, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 4.

TABLE 4

| | C-1 | C-2 |
|---|---|---|
| SBR1 (1) | 45 | — |
| SBR2 (2) | — | 45 |
| NR (3) | 45 | 45 |
| BR (4) | 10 | 10 |
| Carbon black (5) | 25 | 25 |
| Silica (6) | 40 | 40 |
| Coupling agent (7) | 3.2 | 3.2 |
| Liquid plasticizer (8) | 5 | 5 |
| Hydrocarbon resin (9) | 15 | 15 |
| Resin-OPFT (10) | 3 | 3 |
| ZnO | 2 | 2 |
| Stearic acid | 1 | 1 |
| Antiozone wax | 1 | 1 |
| Antioxidant (11) | 2 | 2 |
| DPG (12) | 1 | 1 |
| Sulphur | 5 | 5 |
| Accelerator (13) | 2 | 2 |

(1) SBR1: Solution SBR with 27% of styrene unit and 24% of unit 1.2 of the butadiene part (Tg_{DSC} = −48° C.) bearing a SiOR function, R being a hydrogen atom, the SiOR being dimethylsilanol function at the end of the elastomer chain, the SBR prepared according to a process described in a patent EP 0 778 311;
(2) SBR2: Solution SBR with 27% of styrene unit and 24% of unit 1.2 of the butadiene part (Tg_{DSC} = −48° C.) bearing a SiOR function, R being a methyl radical, the SiOR function not located at the ends of the elastomer chain; wherein the silicon atom of the SiOR function is inserted between the carbon-carbon bonds of the elastomer chain; the SBR further bearing a tertiary amine function made of the amine substituted with two methyl radicals; wherein the nitrogen atom of the amine function is not inserted between the carbon-carbon of the elastomer chain, and the SiOR function bears the amine function; the SBR prepared according to a process described in a patent EP 2 285 852;
(3) NR: Natural rubber (peptised);
(4) BR: BR with 0.3% of 1,2 vinyl; 2.7% of trans; 97% of cis-1,4 (Tg_{DSC} = −105° C.);
(5) Carbon black: Carbon black (ASTM grade N234 from Cabot);
(6) Silica: Silica (“Zeosil 1165MP” from Rhodia (CTAB, BET: about 160 m²/g));
(7) Coupling agent TESPT (“Si69” from Evonik);
(8) Oleic sunflower oil (“Agripure 80” from Cargill, Weight percent oleic acid: 100%);
(9) Cycloaliphatic hydrocarbon resins (“ESCOREZ5600” from ExxonMobil, Tg_{DSC} = 52° C.);
(10) Octyl-substituted phenol-formaldehyde resin;
(11) Compound of the Disclosure, e.g., a compound of Tables A-J;
(12) Diphenylguanidine (“Perkacit DPG” from Flexsys);
(13) N-dicyclohexyl-2-benzothiazolesulphenamide (“Santocure CBS” from Flexsys).

In some embodiments, the disclosure provides a tire comprising a rubber composition based on at least: an elastomer matrix comprising 30 to 50 phr of a first diene elastomer bearing at least one SiOR function, R being a hydrogen atom or a hydrocarbon radical, the SiOR function not located at the chain ends of the first diene elastomer, 40 to 50 phr of a second diene elastomer which is a polyisoprene, and 5 to 20 phr of a third diene elastomer; a reinforcing filler predominantly comprising a reinforcing inorganic filler; and a Compound of the Disclosure, e.g., a compound of Tables A-J.

In some embodiments, the disclosure provides the rubber compositions and/or tires described in U.S. Pat. No. 11,365,308, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 5.

TABLE 5

| | T0 | T1 | T2 | T3 | T4 | T5 | T6 | C1 | C2 | C3 | C4 |
|---|---|---|---|---|---|---|---|---|---|---|---|
| BR (1) | 100 | 100 | 100 | 100 | 100 | 100 | 100 | 100 | 100 | 100 | 100 |
| Carbon | 4 | 4 | 4 | 4 | 4 | 4 | 4 | 4 | 4 | 4 | 4 |
| black (2) | | | | | | | | | | | |
| Silica (3) | 130 | 130 | 130 | 130 | 130 | 130 | 130 | 130 | 130 | 130 | 130 |
| Resin 1 (4) | — | 95 | — | — | — | — | — | — | — | — | — |
| Resin 2 (4) | — | — | 95 | — | — | — | — | — | — | — | — |
| Resin 3 (4) | — | — | — | 95 | — | — | — | — | — | — | — |
| Resin 4 (4) | — | — | — | — | 95 | — | — | — | — | — | — |
| Resin 5 (4) | — | — | — | — | — | 95 | — | — | — | — | — |
| Resin 6 (4) | — | — | — | — | — | — | 95 | — | — | — | — |
| Resin 7 (4) | — | — | — | — | — | — | — | 95 | — | — | — |
| Resin 8 (4) | — | — | — | — | — | — | — | — | 95 | — | — |
| Resin 9 (4) | — | — | — | — | — | — | — | — | — | 95 | — |
| Resin 10 | — | — | — | — | — | — | — | — | — | — | 95 |
| (4) | | | | | | | | | | | |
| Antioxidant | 6 | 6 | 6 | 6 | 6 | 6 | 6 | 6 | 6 | 6 | 6 |
| (5) | | | | | | | | | | | |
| Coupling | 13 | 13 | 13 | 13 | 13 | 13 | 13 | 13 | 13 | 13 | 13 |
| agent (6) | | | | | | | | | | | |
| DPG (7) | 2.5 | 2.5 | 2.5 | 2.5 | 2.5 | 2.5 | 2.5 | 2.5 | 2.5 | 2.5 | 2.5 |
| Stearic acid | 3 | 3 | 3 | 3 | 3 | 3 | 3 | 3 | 3 | 3 | 3 |
| (8) | | | | | | | | | | | |
| ZnO (9) | 0.9 | 0.9 | 0.9 | 0.9 | 0.9 | 0.9 | 0.9 | 0.9 | 0.9 | 0.9 | 0.9 |
| Accelerator | 2.3 | 2.3 | 2.3 | 2.3 | 2.3 | 2.3 | 2.3 | 2.3 | 2.3 | 2.3 | 2.3 |
| (10) | | | | | | | | | | | |
| Soluble | 0.7 | 0.7 | 0.7 | 0.7 | 0.7 | 0.7 | 0.7 | 0.7 | 0.7 | 0.7 | 0.7 |
| sulfur | | | | | | | | | | | |

(1) BR: polybutadiene, CB24 from Lanxess; 96% of 1,4-cis-; Tg = −107° C.
(2) Carbon black, ASTM N234 grade
(3) Silica, Zeosil 1165 MP from Solvay, HDS type
(4) Resins 1 to 10: see Table 6 below
(5) Compound of the Disclosure, e.g., a compound of Tables A-J and/or 2,2,4-trimethyl-1,2-dihydroquinoline (TMQ)
(6) Coupling agent: Si69 from Evonik - Degussa
(7) Diphenylguanidine, Perkacit DPG from Flexsys
(8) Stearin, Pristerene 4931 from Uniqema
(9) Zinc oxide, industrial grade - Umicore
(10) N-Cyclohexyl-2-benzothiazolesulfenamide (Santocure CBS from Flexsys)

TABLE 6

| | Trade | Resin | |
|---|---|---|---|
| Resin | Reference | manufacturer | Chemical name |
| Resin 1 | E5600 BR | Exxon Mobil | Hydrogenated DCPD-C9 |
| Resin 2 | PR-383 BR | Exxon Mobil | Hydrogenated DCPD-C9 |
| Resin 3 | TP7042 BR | Arizona | Terpene phenolic |
| | | Chemical | |
| Resin 4 | ARKON P125 BR | Arakawa | Alicyclic hydrogenated |
| Resin 5 | E5415 BR | Exxon Mobil | Hydrogenated DCPD |
| Resin 6 | E5320 BR | Exxon Mobil | Hydrogenated DCPD |
| Resin 7 | E5340 BR | Exxon Mobil | Hydrogenated DCPD |
| Resin 8 | PR-100 BR | Exxon Mobil | Hydrogenated DCPD |
| Resin 9 | E5615 BR | Exxon Mobil | Hydrogenated DCPD-C9 |
| Resin 10 | E5637 BR | Exxon Mobil | Hydrogenated DCPD-C9 |

In some embodiments, the disclosure provides a rubber composition based on at least one elastomer, a reinforcing filler, a crosslinking system, Compound of the Disclosure, e.g., a compound of Tables A-J, and an optionally hydrogenated hydrocarbon-based resin, predominantly composed of units selected from the group consisting of cyclopentadiene, dicyclopentadiene, methylcyclopentadiene and mixtures thereof, the hydrocarbon-based resin having an average molecular weight Mz of less than 2000 g/mol and a glass transition temperature Tg, expressed in ° C., such that Tg ≥80−2*(% HA), wherein % HA represents the content of aromatic protons of the hydrocarbon-based resin, wherein the content of the hydrocarbon-based resin is within a range extending from 95 to 110 phr, and wherein the reinforcing filler is a combination of silica and carbon black and a content of the reinforcing filler is present within a range extending from 40 to 160 phr, the silica being present at a content within a range extending from 40 to 150 phr.

In some embodiments, the disclosure provides the rubber compositions and/or tires described in U.S. Pat. No. 11,352,484, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 7.

TABLE 7

| | CP1 | CP2 | CP3 | CP4 | CP5 | CP6 | CP7 | CP8 |
|---|---|---|---|---|---|---|---|---|
| Elastomer (1) | 100 | 100 | 100 | 100 | 100 | 100 | 100 | 100 |
| Reinforcing | 130 | 130 | 130 | 130 | 130 | 130 | 130 | 130 |
| inorganic filler | | | | | | | | |
| (2) | | | | | | | | |
| Coupling agent | 11 | — | 11 | — | 11 | — | 11 | — |
| (3) | | | | | | | | |
| Coupling agent | — | 11 | — | 11 | — | 11 | — | 11 |
| (4) | | | | | | | | |
| Resin 1 (5) | 88 | 88 | — | — | — | — | — | — |
| Resin 2 (5) | — | — | 88 | 88 | — | — | — | — |
| Resin 3 (5) | — | — | — | — | 88 | 88 | — | — |
| Resin 4 (5) | — | — | — | — | — | — | 88 | 88 |
| Carbon black (6) | 4 | 4 | 4 | 4 | 4 | 4 | 4 | 4 |
| Antioxidant (7) | 6 | 6 | 6 | 6 | 6 | 6 | 6 | 6 |
| Anti-ozone wax | 2.85 | 2.85 | 2.85 | 2.85 | 2.85 | 2.85 | 2.85 | 2.85 |
| DPG (8) | 2.4 | 2.4 | 2.4 | 2.4 | 2.4 | 2.4 | 2.4 | 2.4 |
| Stearic acid (9) | 3 | 3 | 3 | 3 | 3 | 3 | 3 | 3 |
| ZnO (10) | 0.9 | 0.9 | 0.9 | 0.9 | 0.9 | 0.9 | 0.9 | 0.9 |
| Accelerator (11) | 2.3 | 2.3 | 2.3 | 2.3 | 2.3 | 2.3 | 2.3 | 2.3 |
| Soluble sulfur | 0.7 | 0.7 | 0.7 | 0.7 | 0.7 | 0.7 | 0.7 | 0.7 |

(1) Styrene-butadiene copolymer, aminoalkoxysilane-functional in the middle of the chain, with a glass transition temperature equal to −88° C., the microstructure of this copolymer is determined via the NIR method. The content of 1,2- units is 12.7% relative to the butadiene units. The mass content of styrene is 2.1%; this copolymer is synthesized according to the process described in WO 2017/060395;
(2) Zeosil 1165 MP silica from the company Solvay, of HDS type; its BET specific surface area is 160 m²/g;
(3) bis(triethoxysilylpropyl)tetrasulfide polysulfide silane coupling agent sold under the reference Si69 from the company Evonik-Degussa;
(4) Mercapto/blocked mercapto organofunctional silane coupling agent sold under the reference NXT-Z45 by Momentive Inc.;
(5) Resins 1 to 4: see table 8 below;
(6) ASTM N234 grade carbon black sold by Cabot;
(7) Compound of the Disclosure, e.g., a compound of Tables A-J and/or 2,2,4-trimethyl-1,2-dihydroquinoline (TMQ);
(8) Diphenylguanidine, Perkacit DPG from the company Flexsys;
(9) Pristerene 4931 stearin from the company Uniqema;
(10) Zinc oxide, industrial grade - from Umicore;
(11) N-Cyclohexyl-2-benzothiazolesulfenamide (Santocure CBS from the company Flexsys).

TABLE 8

| Resin | Trade Reference | Resin manufacturer | Chemical name |
|---|---|---|---|
| Resin 1 | Kristalex F85 | Eastman Chemical | α-methylstyrene |
| | | | and styrene |
| Resin 2 | Piccolyte S135 | Pinova | Terpenes (β-pinene) |
| Resin 3 | Neopolymer L-90 | Nisseki | Coumarone-indene |
| Resin 4 | PR-383 | ExxonMobil | Aromatic DCDP |

In some embodiments, the disclosure provides a rubber composition based on at least: a diene elastomer; a reinforcing inorganic filler; an agent for coupling the reinforcing inorganic filler with the diene elastomer, the coupling agent being an organofunctional silane comprising at least one oligomer bearing at least one blocked mercaptosilane unit and at least one mercaptosilane unit, the at least one oligomer corresponding to general formula (I) of U.S. Pat. No. 11,352,484 below:

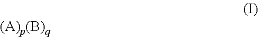

in which A is a blocked mercaptosilane unit corresponding to general formula (II) of U.S. Pat. No. 11,352,484:

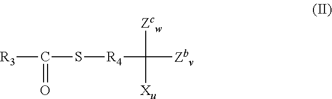

B is a mercaptosilane unit corresponding to general formula (III) of U.S. Pat. No. 11,352,484:

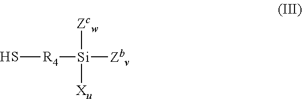

in which formulae (II) and (III) of U.S. Pat. No. 11,352,484:
R³ is selected from the group consisting of a hydrogen atom, a linear or branched C₁-C₁₈ alkyl and a linear or branched C₂-C₁₈ alkenyl,
each R⁴, which may be identical or different, is a saturated, linear or branched C₁-C₆ divalent hydrocarbon-based group,
Z_{b} forms a bridging structure between a silicon atom of one unit and a silicon atom of another unit, these units being identical or different, and is selected from the group consisting of (—O—)_{0.5} and [—O(R⁰CR⁰)_{f}(O-]_{0.5} with R⁰, which may be identical or different, being a group selected from the group consisting of a hydrogen atom, methyl, ethyl and propyl and f being a number within a range extending from 2 to 15,
each Z_{c}, which may be identical or different, forms a cyclic structure with the silicon atom of one unit and is [—O(R⁰CR⁰)_{f}O—]_{0.5} with R⁰ and f as defined above,
each X, which may be identical or different, is selected from the group consisting of a hydrogen atom, a hydroxyl group, a C₁-C₆ alkyl group, a C₁-C₆ alkoxy group and a group) HO(R⁰CR⁰)_{f}O— with R⁰ and f as defined above,
and with u+v+2w=3 in which u is a number equal to 0, 1, 2 or 3, vis a number equal to 1, 2 or 3 and w is a number equal to 0 or 1, p is a number within a range extending from 1 to 20, and q is a number within a range extending from 1 to 20; a hydrocarbon-based resin predominantly composed of monomers selected from the group consisting of cyclopentadiene, dicyclopentadiene, methylcyclopentadiene and mixtures thereof; Compound of the Disclosure, e.g., a compound of Tables A-J; and a crosslinking system.

In some embodiments, the disclosure provides the rubber compositions and/or tires described in U.S. Pat. No. 11,286,369, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 9.

TABLE 9

| | T1 | T2 | T3 | T4 | C1 | C2 | C3 |
|---|---|---|---|---|---|---|---|
| NR (1) | 75 | — | — | 75 | — | — | — |
| BR (2) | 25 | — | — | 25 | — | — | — |
| EBR (3) | — | 100 | 100 | — | 100 | 100 | 100 |
| N234 (4) | 52 | 52 | 40 | 45 | 45 | 37 | 30 |
| Sulfur | 1 | 1 | 1 | — | — | — | — |
| CBS (5) | 1 | 1 | 1 | — | — | — | — |
| ZnO (6) | 2.5 | 2.5 | 2.5 | — | — | — | — |
| Stearic acid (7) | 1.5 | 1.5 | 1.5 | — | — | — | — |
| Compound of | 2 | 2 | 2 | — | — | — | — |
| the Disclosure, | | | | | | | |
| e.g., a compound | | | | | | | |
| of Tables A-J | | | | | | | |
| TMPTMA (9) | — | — | — | 10 | 10 | 10 | 10 |
| DICUP (10) | — | — | — | 1 | 1 | 1 | 1 |

(1) Natural rubber
(2) Polybutadiene (Nd) with 0.7% of 1,2; 1.7% of trans 1,4; 98% of cis 1,4 (Tg = −105° C.) (Buna CB24 from the company Arlanxeo)
(3) Ethylene-butadiene copolymer with 80 mol % of ethylene units prepared according to a process for the polymerization of ethylene and butadiene according to Example 4-2 of patent EP 1 954 705 B1, the polymerization time being adjusted so as to obtain a molar mass Mn = 153 000 g/mol with a polydispersity index equal to 1.9
(4) Carbon black N234 (name according to Standard ASTM D-1765)
(5) N-Cyclohexyl-2-benzothiazolesulfenamide (Santocure CBS from Flexsys)
(6) Zinc oxide (industrial grade-Umicore)
(7) Stearin (Pristerene 4931 from Uniqenna)
(8) Compound of the Disclosure, e.g., a compound of Tables A-J
(9) Trimethylolpropane trimethacrylate (SR351 from the company Sartomer)
(10) Dicumyl peroxide (Dicup from the company Hercules)

In some embodiments, the disclosure provides a tire comprising a rubber composition based on at least: an elastomeric matrix comprising predominantly a random copolymer comprising ethylene units and conjugated diene units, the mole fraction of the ethylene units in the copolymer being within a range extending from 50% to 95%; a peroxide; and a polyfunctional acrylate of formula (I) of U.S. Pat. No. 11,286,369:

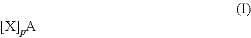

in which:
A represents a carbon atom or a linear, branched or cyclic C₁-C₁₃ hydrocarbon-based group,
A comprises p free valences, p having a value ranging from 2 to 4, and
[X]ₚ corresponds to a radical of formula (II) of U.S. Pat. No. 11,286,369:

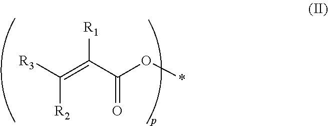

in which:
R₁, R₂ and R₃ independently represent a hydrogen atom or a C₁-C₈ hydrocarbon-based group selected from the group consisting of linear, branched or cyclic alkyl groups, alkylaryl groups, aryl groups and aralkyls, and which are optionally interrupted by one or more heteroatoms, it being possible for R₂ and R₃ together to form a non-aromatic ring,
(*) represents the point of attachment of the radical of formula (II) to A, and
each X is identical or different from one another, wherein contents of polyfunctional acrylate and of peroxide are such that a ratio of peroxide content to polyfunctional acrylate content is between 0.09 and 0.30,
wherein the composition comprises Compound of the Disclosure, e.g., a compound of Tables A-J and from 5 to less than 65 parts by weight per hundred parts by weight of elastomer, phr, of reinforcing filler,
wherein a ratio of filler content to the content of polyfunctional acrylate of formula (I) is within a range extending from 2 to 9,
wherein the composition does not contain molecular sulfur or a sulfur-donating agent as a vulcanizing agent, wherein the composition does not contain zinc oxide, and wherein the composition does not contain stearic acid.

In some embodiments, the disclosure provides the rubber compositions and/or tires described in U.S. Pat. No. 11,254,804, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides a tire comprising a rubber composition based on at least: an elastomeric matrix comprising predominantly a random copolymer comprising ethylene units and conjugated diene units, the mole fraction of the ethylene units in the copolymer being within a range extending from 50% to 95%; a peroxide; Compound of the Disclosure, e.g., a compound of Tables A-J, and a zinc diacrylate derivative in the form of a zinc salt of formula (I) of U.S. Pat. No. 11,254,804:

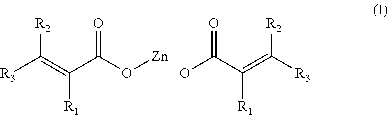

in which R¹, R² and R³ represent independently of one another a hydrogen atom or a C₁-C₇ hydrocarbon-based group selected from linear, branched or cyclic alkyl groups, aralkyl groups, alkylaryl groups and aryl groups, and optionally interrupted by one or more heteroatoms, R² and R³ possibly together forming a non-aromatic ring,
wherein contents of zinc diacrylate derivative and of peroxide are such that a ratio of peroxide content to zinc diacrylate derivative content is greater than or equal to 0.08,
wherein the composition comprises from 5 to less than 65 parts by weight per hundred parts by weight of elastomer, phr, of reinforcing filler, and
wherein a ratio of filler content to the content of zinc diacrylate derivative is greater than or equal to 1.25.

In some embodiments, the disclosure provides the rubber compositions and/or tires described in U.S. Pat. No. 11,254,164, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 10.

TABLE 10

| | C-1 | C-2 | C-3 | C-4 |
|---|---|---|---|---|
| SBR1 (1) | 100 | 100 | — | — |
| SBR2 (2) | — | — | 100 | — |
| IR (3) | — | — | — | 100 |
| Carbon black (4) | 5 | 5 | 5 | 5 |
| Silica (5) | 80 | 80 | 80 | 80 |
| Coupling agent (6) | 6.4 | 6.4 | 6.4 | 6.4 |
| Liquid plasticizer (7) | 40 | — | — | — |
| Liquid phosphate plasticizer (8) | — | 40 | 40 | 40 |
| Hydrocarbon resin (9) | 20 | 20 | 20 | 20 |
| ZnO | 1.3 | 1.3 | 1.3 | 1.3 |
| Stearic acid | 1 | 1 | 1 | 1 |
| Antiozone wax | 1.5 | 1.5 | 1.5 | 1.5 |
| Antioxidant (10) | 2.0 | 2.0 | 2.0 | 2.0 |
| DPG (11) | 1.9 | 1.9 | 1.9 | 1.9 |
| Sulphur | 2.0 | 2.0 | 2.0 | 2.0 |
| Accelerator (12) | 1.7 | 1.7 | 1.7 | 1.7 |

(1) SBR1: solution SBR with 16% of styrene unit and 24% of unit 1,2 of the butadiene part (Tg_{DSC} = −65° C.) bearing a SiOR function, R being a hydrogen atom, the SiOR being dimethylsilanol function at the end of the elastomer chain, the SBR prepared according to a process described in a patent EP 0 778 311 B1;
(2) SBR2: solution SBR with 16% of styrene unit and 24% of unit 1,2 of the butadiene part (Tg_{DSC} = −65° C.) bearing a SiOR function, R being a methyl radical, the SiOR function not located at the ends of the elastomer chain; wherein the silicon atom of the SiOR function is inserted between the carbon-carbon bonds of the elastomer chain; the SBR further bearing a tertiary amine function made of the amine substituted with two methyl radicals; wherein the nitrogen atom of the amine function is not inserted between the carbon-carbon of the elastomer chain, and the SiOR function bears the amine function; the SBR prepared according to a process described in a patent EP 2 285 852 B1;
(3) IR: Polyisoprene rubber (“IR2200” from ZEON (Tg_{DSC} = −62° C.));
(4) Carbon black: Carbon black (ASTM grade N234 from Cabot);
(5) Silica: Silica (“Zeosil 1165MP” from Rhodia (CTAB, BET: about 160 m²/g));
(6) Coupling agent TESPT (“Si69” from Evonik);
(7) Oleic sunflower oil (“Agripure 80” from Cargill, Weight percent oleic acid: 100%);
(8) Tris(2-ethylhexyl)phosphate (“Disflamoll TOF” from Lanxess, Tg_{DSC} = −105° C.);
(9) Hydrocarbon resin C₅/C₉ type (“Escorez ECR-373” from Exxon, Tg_{DSC} = 44° C.);
(10) Compound of the Disclosure, e.g., a compound of Tables A-J;
(11) Diphenylguanidine (“Perkacit DPG” from Flexsys);
(12) N-dicyclohexyl-2-benzothiazolesulphenamide (“Santocure CBS” from Flexsys).

In some embodiments, the disclosure provides a tire having a tread comprising a rubber composition based on at least: an elastomer matrix comprising more than 50 phr and up to 100 phr of a first diene elastomer bearing at least one SiOR function, R being a hydrogen atom or a hydrocarbon radical, and optionally, 0 to less than 50 phr of a second diene elastomer, which is different from the first diene elastomer; a reinforcing filler predominantly comprising a reinforcing inorganic filler, wherein the content of reinforcing inorganic filler is 20 to 80 phr; Compound of the Disclosure, e.g., a compound of Tables A-J; and a liquid phosphate plasticizer having a glass transition temperature of less than-80° C., wherein the content of the liquid phosphate plasticizer is 5 to 100 phr, wherein the first diene elastomer is a styrene-butadiene copolymer.

In some embodiments, the disclosure provides the rubber compositions and/or tires described in U.S. Pat. No. 11,241,912, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 11.

TABLE 11

| | C-1 | C-2 | C-3 | C-4 | C-5 | C-6 |
|---|---|---|---|---|---|---|
| SBR1 (1) | 100 | 100 | — | 45 | — | — |
| SBR2 (2) | — | 100 | 100 | — | 45 | 45 |
| NR (3) | — | — | — | 45 | 45 | 45 |
| Carbon black (5) | 3 | 3 | 3 | 25 | 25 | 25 |
| Silica (6) | 65 | 65 | 85 | 35 | 35 | 40 |
| Coupling agent (7) | 5.2 | 5.2 | 6.8 | 2.8 | 2.8 | 3.2 |
| Liquid plasticizer (8) | 20 | 20 | 25 | 10 | 10 | 15 |
| Hydrocarbon resin (9) | 10 | 10 | 15 | 5 | 5 | 5 |
| Resin-OPRT (10) | — | — | — | 3 | 3 | 3 |
| Stearic acid | 1.5 | 1.5 | 1.5 | 1.5 | 1.5 | 1.5 |
| Antiozone wax | 1.5 | 1.5 | 1.5 | 1.5 | 1.5 | 1.5 |
| Antioxidant (11) | 2.5 | 2.5 | 2.5 | 2.5 | 2.5 | 2.5 |
| DPG (12) | 1 | 1 | 1 | 1 | 1 | 1 |
| Sulphur | 1.5 | 1.5 | 1.5 | 5 | 5 | 5 |
| Accelerator (13) | 2 | 2 | 2 | 2 | 2 | 2 |

(1) SBR1: Solution SBR with 27% of styrene unit and 24% of unit 1.2 of the butadiene part (Tg_{DSC} = −48° C.) bearing a SiOR function, R being a hydrogen atom, the SiOR being dimethylsilanol function at the end of the elastomer chain, the SBR prepared according to a process described in a patent EP 0 778 311 B1;
(2) SBR2: Solution SBR with 27% of styrene unit and 24% of unit 1.2 of the butadiene part (Tg_{DSC} = −48.° C.) bearing a SiOR function, R being a methyl radical, the SiOR function not located at the ends of the elastomer chain; wherein the silicon atom of the SiOR function is inserted between the carbon-carbon bonds of the elastomer chain; the SBR further bearing a tertiary amine function made of the amine substituted with two methyl radicals; wherein the nitrogen atom of the amine function is not inserted between the carbon-carbon of the elastomer chain, and the SiOR function bears the amine function; the SBR prepared according to a process described in a patent EP 2 285 852 B1;
(3) NR: Natural rubber (peptised);
(4) BR: BR with 0.3% of 1.2 vinyl; 2.7% of trans; 97% of cis-1.4 (Tg_{DSC} = −105° C.);
(5) Carbon black: Carbon black (ASTM grade N234 from Cabot);
(6) Silica: Silica (“Zeosil 1165MP” from Rhodia (CTAB, BET: about 160 m²/g));
(7) Coupling agent TESPT (“Si69” from Evonik);
(8) Oleic sunflower oil (“Agripure 80” from Cargill, Weight percent oleic acid: 100%);
(9) Cycloaliphatic hydrocarbon resins (“ESCOREZ5600” from ExxonMobil, Tg_{DSC} = 52° C.);
(10) Octyl-substituted phenol-formaldehyde resin;
(11) Compound of the Disclosure, e.g., a compound of Tables A-J;
(12) Diphenylguanidine (“Perkacit DPG” from Flexsys);
(13) Mixtures of N-dicyclohexyl-2-benzothiazolesulphenamide (“Santocure CBS” from Flexsys) and 2-mercaptobenzothiazyl disulphide (“Perkacit MBTS” from Flexsys).

In some embodiments, the disclosure provides a tire having a tread comprising at least two radially superposed portions which comprise a radially external portion intended to come into contact with ground during rolling, the radially external portion being made of a first rubber composition, and a radially internal portion made of a second rubber composition which is different from the first rubber composition, wherein the first rubber composition is based on at least: an elastomer matrix; Compound of the Disclosure, e.g., a compound of Tables A-J; and a reinforcing filler comprising between 40 and 200 phr of a reinforcing inorganic filler, and wherein the second rubber composition is based on at least: an elastomer matrix comprising 20 to 70 phr of a first diene elastomer bearing at least one SiOR function, R being a hydrogen atom or a hydrocarbon radical, 20 to 70 phr of a second diene elastomer which is polyisoprene, and comprising no third diene elastomer or equal to or less than 20 phr of a third diene elastomer; Compound of the Disclosure, e.g., a compound of Tables A-J; and a reinforcing filler comprising a reinforcing inorganic filler.

In some embodiments, the disclosure provides the rubber compositions and/or tires described in U.S. Pat. No. 11,230,636, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 12.

TABLE 12

| | C1 | C2 | C3 | C4 | C5 | C6 | I1 | I2 |
|---|---|---|---|---|---|---|---|---|
| Natural rubber | 40 | 40 | 40 | 40 | 40 | 40 | 40 | 40 |
| SBR 1 (a) | 60 | — | — | — | — | — | — | — |
| SBR 2 (b) | — | 60 | — | — | — | — | — | — |
| SBR 3 (c) | — | — | 60 | — | — | — | — | — |
| SBR 4 (d) | — | — | — | 60 | 60 | 60 | 60 | 60 |
| N550 (e) | — | — | — | 50 | — | — | — | — |
| N134 (f) | — | — | — | — | 50 | — | — | — |
| N234 (g) | — | — | — | — | — | 50 | — | — |
| N375 (h) | — | — | — | — | — | — | 50 | 50 |
| Anti-reversion agent 1 (i) | 1 | 1 | 1 | 1 | 1 | 1 | 1 | — |
| Anti-reversion agent 2 (j) | — | — | — | — | — | — | — | 1 |
| Liquid plasticizer (k) | 2 | 2 | 2 | 2 | 2 | 2 | 2 | 2 |
| Tackifying resin (l) | 5 | 5 | 5 | 5 | 5 | 5 | 5 | 5 |
| Zinc oxide | 3 | 3 | 3 | 3 | 3 | 3 | 3 | 3 |
| Stearic acid (m) | 1.5 | 1.5 | 1.5 | 1.5 | 1.5 | 1.5 | 1.5 | 1.5 |
| Compound of the | 1.5 | 1.5 | 1.5 | 1.5 | 1.5 | 1.5 | 1.5 | 1.5 |
| Disclosure, e.g., a | | | | | | | | |
| compound of Tables A-J | | | | | | | | |
| TMQ (o) | 1 | 1 | 1 | 1 | 1 | 1 | 1 | 1 |
| Sulfur | 2 | 2 | 2 | 2 | 2 | 2 | 2 | 2 |
| Sulfenamide (p) | 0.5 | 0.5 | 0.5 | 0.5 | 0.5 | 0.5 | 0.5 | 0.5 |

(a): SBR 1: Emulsion SBR of Tg −48° C., % Styrene 23.5, % Vinyl 18, % Trans 71
(b): SBR 2: Solution SBR of Tg −27° C., % Styrene 26.5, % Vinyl 58, % Trans 23
(c): SBR 3: Solution SBR of Tg −65° C., % Styrene 15.5, % Vinyl 24, % Trans 47
(d): SBR 4: Solution SBR of Tg −54° C., % Styrene 27, % Vinyl 6, % Trans 78
(e): Carbon black N550 (according to Standard ASTM D-1765) of BET 39 m²/g and COAN 85 ml/100 g
(f): Carbon black N134 (according to Standard ASTM D-1765) of BET 140 m²/g and COAN 100 ml/100 g
(g): Carbon black N234 (according to Standard ASTM D-1765) of BET 120 m²/g and COAN 100 ml/100 g
(h): Carbon black N375 (according to Standard ASTM D-1765) of BET 95 m²/g and COAN 95 ml/100 g
(i): Anti-reversion agent 1: 1,3-bis(citraconimidomethyl)benzene, DP900 from Lanxess
(j): Anti-reversion agent 2: sodium hexamethylene-1,6-bisthiosulfate, HTSNa from Flexsys
(k): MES oil from Exxon Mobil
(l): Octylphenol/formaldehyde resin from BASF
(m): Stearin, Pristerene 4931 from Uniqema
(n): Compound of the Disclosure, e.g., a compound of Tables A-J
(o): 2,2,4-Trimethyl-1,2-dihydroquinoline (TMQ) from Lanxess
(p): N-(tert-Butyl)-2-benzothiazolesulfenamide, Santocure TBBS from Flexsys

In some embodiments, the disclosure provides a rubber composition based on at least: an elastomeric matrix comprising at most 70 parts by weight per hundred parts by weight of elastomer, phr, of a polyisoprene and at least 30 phr of a butadiene/styrene copolymer, wherein the butadiene/styrene copolymer exhibits a content of styrene units of between 20% and 40% by weight, with respect to the total weight of the butadiene/styrene copolymer, a content of trans-1,4-butadiene units of greater than 65% by weight, with respect to the total weight of the butadiene units, a content of vinyl units of less than 8% by weight, with respect to the total weight of the butadiene units, and a glass transition temperature of between −60° C. and −35° C.; from 35 to 75 phr of a carbon black exhibiting a BET (Brunauer, Emmett and Teller) specific surface of between 90 and 100 m²/g and a COAN absorption index of between 90 and 100 ml/100 g; Compound of the Disclosure, e.g., a compound of Tables A-J; and a crosslinking system.

In some embodiments, the disclosure provides the rubber compositions and/or tires described in U.S. Pat. No. 11,225,567, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Tables 13 and 14.

TABLE 13

| | T1 | C1 | C2 | C3 |
|---|---|---|---|---|
| NR (1) | 100 | 100 | 100 | 100 |
| Carbon black (2) | 47 | 47 | 47 | 47 |
| Hydrocarbon resin (3) | 0 | 5 | 7.5 | 10 |
| Antioxidant (4) | 1.5 | 1.5 | 1.5 | 1.5 |
| Antiozonant (5) | 1 | 1 | 1 | 1 |
| Reinforcing resin (6) | 1 | 1 | 1 | 1 |
| Hardener (7) | 1 | 1 | 1 | 1 |
| Stearic acid | 2.5 | 2.5 | 2.5 | 2.5 |
| ZnO | 3 | 3 | 3 | 3 |
| Accelerator (8) | 0.8 | 0.8 | 0.8 | 0.8 |
| Sulfur | 1.5 | 1.5 | 1.5 | 1.5 |

TABLE 14

| | T2 | C4 | C5 | C6 | C7 | T3 | C8 | C9 | C10 |
|---|---|---|---|---|---|---|---|---|---|
| NR (1) | 50 | 50 | 50 | 50 | 50 | 35 | 35 | 35 | 35 |
| SBR (9) | 50 | 50 | 50 | 50 | 50 | 65 | 65 | 65 | 65 |
| Carbon black (2) | 49 | 49 | 49 | 49 | 49 | 49 | 49 | 49 | 49 |
| Silica (10) | 5 | 5 | 5 | 5 | 5 | 5 | 5 | 5 | 5 |
| Coupling agent (11) | 1 | 1 | 1 | 1 | 1 | 1 | 1 | 1 | 1 |
| Hydrocarbon resin (3) | 0 | 2.5 | 5 | 7.5 | 10 | 0 | 5 | 7.5 | 10 |
| Antioxidant (4) | 1.5 | 1.5 | 1.5 | 1.5 | 1.5 | 1.5 | 1.5 | 1.5 | 1.5 |
| Antiozonant (5) | 1 | 1 | 1 | 1 | 1 | 1 | 1 | 1 | 1 |
| Stearic acid | 2.5 | 2.5 | 2.5 | 2.5 | 2.5 | 2.5 | 2.5 | 2.5 | 2.5 |
| ZnO | 3 | 3 | 3 | 3 | 3 | 3 | 3 | 3 | 3 |
| Accelerator (8) | 0.8 | 0.8 | 0.8 | 0.8 | 0.8 | 0.8 | 0.8 | 0.8 | 0.8 |
| Sulfur | 1.5 | 1.5 | 1.5 | 1.5 | 1.5 | 1.5 | 1.5 | 1.5 | 1.5 |

(1) Natural rubber
(2) Carbon black of N115 grade according to standard ASTM D-1765
(3) DCPD/Aromatic hydrocarbon resin Novares TC160 from the company Rutgers Mn = 710 g/mol; Mw = 2000 g/mol; Pl = 2.8, Tg = 106° C. Aromatic protons: 13%, Ethylenic protons: 5.6%, Aliphatic protons: 81.4%
(4) Compound of the Disclosure, e.g., a compound of Tables A-J
(5) Antiozone wax
(6) Resorcinol reinforcing resin from the company Sumitomo
(7) HMT Hexamethylenetetramine from the company Evonik-Degussa
(8) N-Cyclohexyl-2-benzothiazolesulfenamide, Santocure CBS from the company Flexsys-Solutia
(9) Tin-functionalized solution SBR, with 24% of 1,2-polybutadiene units, 15.5% of styrene units - Tg = −65° C.
(10) Silica, Zeosil 1165 MP from the company Solvay-Rhodia, HDS type
(11) Silane

In some embodiments, the disclosure provides an aircraft tire having a tread comprising a composition based on at least: an elastomeric matrix comprising 100 phr of isoprene elastomer; from 40 to 60 phr of a reinforcing filler, wherein the reinforcing filler is carbon black; from 2 to 15 phr of at least one hydrocarbon resin predominantly composed of units derived from aromatic and cycloaliphatic monomers; Compound of the Disclosure, e.g., a compound of Tables A-J; and a crosslinking system, wherein a number of carcass plies is within a range extending from 2 to 12.

In some embodiments, the disclosure provides the rubber compositions and/or tires described in U.S. Pat. No. 11,220,591, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 15.

TABLE 15

| | T1 | T2 | T3 | T4 | C1 | C2 | C3 | T5 |
|---|---|---|---|---|---|---|---|---|
| Elastomer 1 (1) | 100 | 100 | 100 | 100 | 100 | 0 | 100 | 100 |
| Elastomer 2 (2) | 0 | 0 | 0 | 0 | 0 | 100 | 0 | 0 |
| Carbon | 4 | 4 | 4 | 4 | 4 | 4 | 4 | 4 |
| black (3) | | | | | | | | |
| Silica (4) | 130 | 130 | 130 | 130 | 130 | 130 | 130 | 130 |
| Coupling | 13 | 13 | 13 | 13 | 13 | 13 | 13 | 13 |
| agent (5) | | | | | | | | |
| Resin 1 (6) | 88 | 0 | 0 | 0 | 0 | 0 | 0 | 0 |
| Resin 2 (6) | 0 | 88 | 0 | 0 | 0 | 0 | 0 | 0 |
| Resin 3 (6) | 0 | 0 | 88 | 0 | 0 | 0 | 0 | 0 |
| Resin 4 (6) | 0 | 0 | 0 | 88 | 0 | 0 | 0 | 0 |
| Resin 5 (6) | 0 | 0 | 0 | 0 | 88 | 88 | 50 | 20 |
| Antioxidant (7) | 6 | 6 | 6 | 6 | 6 | 6 | 6 | 6 |
| Stearic | 3 | 3 | 3 | 3 | 3 | 3 | 3 | 3 |
| acid (8) | | | | | | | | |
| DPG (9) | 2.5 | 2.5 | 2.5 | 2.5 | 2.5 | 2.5 | 2.5 | 2.5 |
| ZnO (10) | 1 | 1 | 1 | 1 | 1 | 1 | 1 | 1 |
| Accelerator | 2.3 | 2.3 | 2.3 | 2.3 | 2.3 | 2.3 | 2.3 | 2.3 |
| (11) | | | | | | | | |
| Sulfur | 0.7 | 0.7 | 0.7 | 0.7 | 0.7 | 0.7 | 0.7 | 0.7 |

(1) Elastomer 1: SBR A with 2.1% of styrene units and 12.7% of 1,2- units of the butadiene part (Tg = −88° C.);
(2) Elastomer 2: BR, N103 sold by Asahi with 13% of 1,2- units of the butadiene part (Tg = −92° C.);
(3) Carbon black, ASTM N234 grade
(4) Silica, Zeosil 1165 MP from Solvay, HDS type
(5) Coupling agent: Si69 from Evonik-Degussa
(6) Resins 1 to 5: see Table 16 below
(7) Compound of the Disclosure, e.g., a compound of Tables A-J
(8) Stearin, Pristerene 4931 from Uniqema
(9) Diphenylguanidine, Perkacit DPG from Flexsys
(10) Zinc oxide, industrial grade-Umicore
(11) N-Cyclohexyl-2-benzothiazolesulfenamide (Santocure CBS from Flexsys)

TABLE 16

| | | | Tg | |
|---|---|---|---|---|
| Resin | Supplier | Trade Name | (° C.) | Monomers |
| Resin 1 | Arizona | Sylvatraxx 4401 | 35 | Styrene/α-methylstyrene |
| Resin 2 | Eastman | Kristalex 3085 | 38 | Styrene/α-methylstyrene |
| Resin 3 | Eastman | Kristalex F85 | 37 | Styrene/α-methylstyrene |
| Resin 4 | DRT | Dercolyte L120 | 74 | D-Limonene |
| Resin 5 | Arakawa | ARKON P125 | 71 | C₉ |

In some embodiments, the disclosure provides a rubber composition based on at least: from 50 to 100 phr of at least one diene elastomer, wherein the at least one diene elastomer is a very low glass transition temperature Tg diene elastomer consisting of a copolymer of butadiene and of a vinylaromatic monomer, wherein the copolymer of butadiene and of a vinylaromatic monomer has a Tg within a range of from −110° C. to −70° C. and has a content of vinylaromatic units of between 0 and 5% by weight relative to the total weight of the at least one diene elastomer; a reinforcing filler; a crosslinking system; Compound of the Disclosure, e.g., a compound of Tables A-J; and from 40 to 150 phr of at least one hydrogenated hydrocarbon resin predominantly composed of units derived from C₉ monomers, the resin having a content of aromatic protons of less than 25% and a content of ethylenic protons of less than 1%.

In some embodiments, the disclosure provides the rubber compositions and/or tires described in U.S. Pat. No. 11,203,680, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 17.

TABLE 17

| | T1 | T2 | C1 | C2 | T3 | T4 | T5 | T6 | T7 |
|---|---|---|---|---|---|---|---|---|---|
| Elastomer 1 (1) | 100 | 0 | 0 | 0 | 0 | 0 | 0 | 0 | 0 |
| Elastomer 2 (2) | 0 | 100 | 100 | 0 | 100 | 100 | 100 | 100 | 100 |
| Elastomer 3 (3) | 0 | 0 | 0 | 100 | 0 | 0 | 0 | 0 | 0 |
| Carbon black (4) | 4 | 4 | 4 | 4 | 4 | 4 | 4 | 4 | 4 |
| Silica (5) | 130 | 130 | 130 | 130 | 130 | 130 | 130 | 130 | 130 |
| Coupling agent (6) | 13 | 13 | 13 | 13 | 13 | 13 | 13 | 13 | 13 |
| Resin 1 (7) | 88 | 40 | 88 | 88 | 0 | 0 | 0 | 0 | 0 |
| Resin 2 (7) | 0 | 0 | 0 | 0 | 88 | 0 | 0 | 0 | 0 |
| Resin 3 (7) | 0 | 0 | 0 | 0 | 0 | 88 | 0 | 0 | 0 |
| Resin 4 (7) | 0 | 0 | 0 | 0 | 0 | 0 | 88 | 0 | 0 |
| Resin 5 (7) | 0 | 0 | 0 | 0 | 0 | 0 | 0 | 88 | 0 |
| Resin 6 (7) | 0 | 0 | 0 | 0 | 0 | 0 | 0 | 0 | 88 |
| Antioxidant (8) | 6 | 6 | 6 | 6 | 6 | 6 | 6 | 6 | 6 |
| Stearic acid (9) | 3 | 3 | 3 | 3 | 3 | 3 | 3 | 3 | 3 |
| DPG (10) | 2.5 | 2.5 | 2.5 | 2.5 | 2.5 | 2.5 | 2.5 | 2.5 | 2.5 |
| ZnO (11) | 1 | 1 | 1 | 1 | 1 | 1 | 1 | 1 | 1 |
| Accelerator (12) | 2.3 | 2.3 | 2.3 | 2.3 | 2.3 | 2.3 | 2.3 | 2.3 | 2.3 |
| Sulfur | 0.7 | 0.7 | 0.7 | 0.7 | 0.7 | 0.7 | 0.7 | 0.7 | 0.7 |

(1) Elastomer 1: SBR solution with 27% of styrene units and 24% of 1,2-units of the butadiene part (Tg = −48° C.);
(2) Elastomer 2: SBR A with 2.1% of styrene units and 12.7% of 1,2-units of the butadiene part (Tg = −88° C.);
(3) Elastomer 3: BR, N103 sold by Asahi with 13% of 1,2-units of the butadiene part (Tg = −92° C.);
(4) Carbon black, ASTM N234 grade
(5) Silica, Zeosil 1165 MP from Solvay, HDS type
(6) Coupling agent: Si69 from Evonik-Degussa
(7) Resins 1 to 6: Table 18 below
(8) Compound of the Disclosure, e.g., a compound of Tables A-J
(9) Stearin, Pristerene 4931 from Uniqema
(10) Diphenylguanidine, Perkacit DPG from Flexsys
(11) Zinc oxide, industrial grade-Umicore
(12) N-Cyclohexyl-2-benzothiazolesulfenamide (Santocure CBS from Flexsys)

TABLE 18

| | | | Tg | |
|---|---|---|---|---|
| Resin | Supplier | Trade Name | (° C.) | Monomers |
| Resin 1 | Arizona | Sylvatraxx 6720 | 67 | Terpene |
| | | | | Phenol |
| Resin 2 | Arizona | Sylvares TP 2040 | 76 | Terpene |
| | | | | Phenol |
| Resin 3 | Arizona | Sylvares TP 7042 | 100 | Terpene |
| | | | | Phenol |
| Resin 4 | DRT | Dertophene 1510 | 105 | Terpene |
| | | | | Phenol |
| Resin 5 | Arizona | Sylvares TP 2019 | 70 | Terpene |
| | | | | Phenol |
| Resin 6 | DRT | Dercolyte L120 | 74 | D- |
| | | | | Limonene |

In some embodiments, the disclosure provides a rubber composition comprising at least: from 50 to 100 phr of at least one diene elastomer, wherein the at least one diene elastomer is a very low glass transition temperature Tg diene elastomer, having a Tg within a range of from −110° C. to −70° C. and selected from the group consisting of butadiene homopolymers, copolymers of butadiene and of a vinylaromatic monomer, having a content of vinylaromatic units of between 0 and 5% by weight, and mixtures thereof; a reinforcing filler; a crosslinking system; Compound of the Disclosure, e.g., a compound of Tables A-J; and from 50 to 150 phr of at least one hydrocarbon resin predominantly composed of units derived from terpene and phenol monomers, the resin having a content of aromatic protons of greater than 15%.

In some embodiments, the disclosure provides the rubber compositions and/or tires described in U.S. Pat. No. 11,161,962, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 19.

TABLE 19

| | T1 | C1 | C2 | C3 | C4 |
|---|---|---|---|---|---|
| NR (1) | 100 | 100 | 100 | 100 | 100 |
| N326 (2) | 55 | — | — | — | — |
| N550 (2) | — | 47 | 57 | 52 | 47 |
| Silica (3) | — | 10 | 10 | 15 | 20 |
| DPG (4) | — | 1 | 1 | 1 | 1 |
| Compound of the | 3 | 3 | 3 | 3 | 3 |
| Disclosure, e.g., a | | | | | |
| compound of | | | | | |
| Tables A-J | | | | | |
| Stear. Ac. (6) | 0.6 | 0.6 | 0.6 | 0.6 | 0.6 |
| ZnO (7) | 8 | 8 | 8 | 8 | 8 |
| Acac(Mg) (8) | 1.8 | 1.8 | 1.8 | 1.8 | 1.8 |
| Co salt (9) | 1 | 1 | 1 | 1 | 1 |
| Sulfur | 5 | 5 | 5 | 5 | 5 |
| TBBS (10) | 0.8 | 0.8 | 0.8 | 0.8 | 0.8 |

(1) Natural Rubber
(2) Carbon black N326, N550 (name according to ASTM standard D-1765)
(3) Zeosil 160MP silica, sold by Rhodia
(4) Perkacit DPG diphenylguanidine from Flexsys
(5) Compound of the Disclosure, e.g., a compound of Tables A-J
(6) Stearin (Pristerene 4931 from Uniqema)
(7) Zinc oxide (industrial grade - Umicore)
(8) Magnesium acetylacetonate “NACEM Magnesium” (CAS 68488-07-3) from the company Niho Kagaku Sangyo
(9) cobalt naphthenate - product No. 60830 from Fluka
(10) N-tert-butyl-2-benzothiazylsulfenamide Santocure TBBS from Flexsys

In some embodiments, the disclosure provides a rubber composition based on at least: a diene elastomer comprising mainly an isoprene elastomer; a reinforcing filler comprising: from 15 to 70 phr of carbon black having a BET specific surface area of less than 70 m²/g, and from 5 to 20 phr of silica; a salt of an alkaline-earth, alkali or lanthanide metal, wherein the salt of the alkaline-earth, alkali or lanthanide metal is an acetylacetonate of an alkaline-earth, alkali or lanthanide metal; Compound of the Disclosure, e.g., a compound of Tables A-J; and a crosslinking system; wherein the ratio of carbon black to silica is greater than 1.

In some embodiments, the disclosure provides the rubber compositions and/or tires described in U.S. Pat. No. 11,155,701, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 20.

TABLE 20

| | T1 | T2 | T3 | T4 | C1 | C2 |
|---|---|---|---|---|---|---|
| NR (1) | 80 | 80 | 80 | 80 | 80 | 80 |
| BR (2) | 20 | 20 | 20 | 20 | 20 | 20 |
| Carbon black (3) | 48 | 48 | 48 | 48 | 48 | 48 |
| Crumb 1 | 0 | 53 | 0 | 0 | 0 | 0 |
| Crumb 2 | 0 | 0 | 53 | 0 | 0 | 0 |
| Crumb 3 | 0 | 0 | 0 | 53 | 0 | 0 |
| Crumb 4 | 0 | 0 | 0 | 0 | 53 | 0 |
| Crumb 5 | 0 | 0 | 0 | 0 | 0 | 53 |
| Antioxidant (4) | 3 | 3 | 3 | 3 | 3 | 3 |
| Stearic acid (5) | 2.6 | 2.6 | 2.6 | 2.6 | 2.6 | 2.6 |
| Zinc oxide (6) | 3.3 | 3.3 | 3.3 | 3.3 | 3.3 | 3.3 |
| Accelerator (7) | 1.15 | 1.15 | 1.15 | 1.15 | 1.15 | 1.15 |
| Sulfur | 1.9 | 1.9 | 1.9 | 1.9 | 1.9 | 1.9 |

(1) NR: Natural rubber
(2) BR: polybutadiene, CB24 from Lanxess; 96% of 1,4-cis-; Tg = −107° C.
(3) Carbon black, ASTM N234 grade
(4) Compound of the Disclosure, e.g., a compound of Tables A-J
(5) Stearin, Pristerene 4931 from the company Uniqema
(6) Zinc oxide, industrial grade - Umicore
(7) N-Cyclohexyl-2-benzothiazolesulfenamide (Santocure CBS from Flexsys)

Crumbs 1-5 comprise 80 phr natural rubber, 20 phr polybutadiene (CB24 from the company Lanxess; 96% of 1,4-cis-; Tg=−107° C.), 48 phr carbon black (ASTM N234 grade), 3 phr Compound of the Disclosure, e.g., a compound of Tables A-J, 2 phr stearic acid (Stearin, Pristerene 4931 from the company Uniqema), 3 phr zinc oxide (industrial grade, Umicore), 1 phr accelerator (N-cyclohexyl-2-benzothiazolesulfenamide (Santocure CBS from the company Flexsys)), and 1.5 phr sulfur. Crumbs 1-5 also have the properties shown in Table 21.

TABLE 21

| | Crumb | Crumb | Crumb | Crumb | Crumb |
|---|---|---|---|---|---|
| | 1 | 2 | 3 | 4 | 5 |
| Size distribution | 0 to | 0 to | 0 to | 50 to | 100 to |
| | 200 μm | 100 μm | 50 μm | 100 μm | 200 μm |
| Acetone extract | 4.6% | 4.6% | 4.6% | 4.6% | 4.6% |
| Chloroform | 6.3% | 6.3% | 6.3% | 6.3% | 6.3% |
| extract | | | | | |
| Mw of the | 7000 | 7000 | 7000 | 7000 | 7000 |
| chloroform | g/mol | g/mol | g/mol | g/mol | g/mol |
| extract | | | | | |
| Carbon black | 30% | 30% | 30% | 30% | 30% |
| weight fraction | | | | | |

In some embodiments, the disclosure provides a rubber composition based on at least an elastomer, a reinforcing filler, a crosslinking system, Compound of the Disclosure, e.g., a compound of Tables A-J, and a crumb rubber, wherein the crumb rubber has a particle size distribution such that it comprises less than 35% by weight of particles having a size of less than 50 μm and less than 30% by weight of particles having a size of greater than 100 μm.

In some embodiments, the disclosure provides the rubber compositions described in U.S. Pat. No. 11,155,656, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 22.

TABLE 22

| | C | I |
|---|---|---|
| EBR (1) | 100 | — |
| EBR (2) | — | 100 |
| Antioxidant (3) | 2 | 2 |
| Stearic acid | 2 | 2 |
| ZnO | 1 | 1 |
| Accelerator (4) | 2 | 2 |
| Sulfur | 1 | 1 |
| N234 | 3 | 3 |
| Silica (5) | 55 | 55 |
| Antiozone wax | 1.6 | 1.6 |
| Silane (6) | 4 | 4 |
| DPG (7) | 1.5 | 1.5 |

(1) Copolymer of ethylene and 1,3-butadiene with 79 mol % of ethylene units and 7 mol % of 1,2-cyclohexanediyl units (non-functional)
(2) Copolymer of ethylene and 1,3-butadiene with 77 mol % of ethylene units and 9 mol % of 1,2-cyclohexanediyl units which is functionalized at the chain end, functional group content 35%, functionalizing agent (N,N-dimethyl-3-aminopropyl)methyldimethoxysilane
(3) Compound of the Disclosure, e.g., a compound of Tables A-J
(4) N-cyclohexyl-2-benzothiazolesulfenamide (Santocure CBS from Flexsys)
(5) Zeosil 1165 MP, Solvay-Rhodia, in the form of micropearls
(6) TESPT (Si69), Evonik-Degussa
(7) Diphenylguanidine

In some embodiments, the disclosure provides the rubber compositions and/or tires described in U.S. Pat. No. 11,111,360, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Tables 23 and 24.

TABLE 23

| | T1 | C1 | T2 | C2 | T3 | C3 | T4 | C4 | T5 | C5 |
|---|---|---|---|---|---|---|---|---|---|---|
| Elastomer (1) | 100 | 100 | — | — | 100 | 100 | — | — | 100 | 100 |
| Elastomer (2) | — | — | 100 | 100 | — | — | 100 | 100 | — | — |
| Carbon black (3) | 3 | 3 | 3 | 3 | 3 | 3 | 3 | 3 | 3 | — |
| Silica SC1 | 130 | — | 100 | — | — | — | — | — | — | — |
| Silica S1 | — | 130 | — | 100 | — | — | — | — | — | 130 |
| Silica SC2 | — | — | — | — | 130 | — | 100 | — | — | — |
| Silica S2 | — | — | — | — | — | 130 | — | 100 | — | — |
| Silica SC3 | | | | | | | | | 130 | — |
| Agent for | 10 | 10 | 8 | 8 | 13 | 13 | 10.4 | 10.4 | 9.5 | 9.8 |
| coupling the | | | | | | | | | | |
| elastomer to the | | | | | | | | | | |
| reinforcing | | | | | | | | | | |
| inorganic filler | | | | | | | | | | |
| (4) | | | | | | | | | | |
| DPG (5) | 2.0 | 2.9 | 1.8 | 2.6 | 2.8 | 3.3 | 2.5 | 3.0 | 3.4 | 2.9 |
| Resin (6) | 47 | 47 | 47 | 47 | 47 | 47 | 47 | 47 | 47 | 47 |
| Plasticizer (7) | 23 | 23 | 23 | 23 | 23 | 23 | 23 | 23 | 23 | 23 |
| Anti ozone wax | 2 | 2 | 2 | 2 | 2 | 2 | 2 | 2 | 2 | 2 |
| Antioxidant (8) | 3 | 3 | 3 | 3 | 3 | 3 | 3 | 3 | 3 | 3 |
| Stearic acid | 3 | 3 | 3 | 3 | 3 | 3 | 3 | 3 | 3 | 3 |
| Zinc oxide | 1 | 1 | 1 | 1 | 1 | 1 | 1 | 1 | 1 | 1 |
| Accelerator (9) | 2 | 2 | 2 | 2 | 2 | 2 | 2 | 2 | 2 | 2 |
| Sulfur | 1 | 1 | 1 | 1 | 1 | 1 | 1 | 1 | 1 | 1 |

TABLE 24

| | T1 | C6 | C7 | C8 |
|---|---|---|---|---|
| Elastomer (1) | 100 | 100 | 100 | 100 |
| Carbon black (3) | 3 | 3 | 3 | 3 |
| Silica SC1 | 130 | — | — | — |
| Silica S3 | — | 130 | — | — |
| Silica S2 | — | — | 130 | — |
| Silica S4 | — | — | — | 130 |
| Agent for coupling | 10 | 8.7 | 13.0 | 14.7 |
| the elastomer to the | | | | |
| reinforcing inorganic | | | | |
| filler (4) | | | | |
| DPG (5) | 2.0 | 2.6 | 3.3 | 3.7 |
| Resin (6) | 47 | 47 | 47 | 47 |
| Plasticizer (7) | 23 | 23 | 23 | 23 |
| Anti ozone wax | 2 | 2 | 2 | 2 |
| Antioxidant (8) | 3 | 3 | 3 | 3 |
| Stearic acid | 3 | 3 | 3 | 3 |
| Zinc oxide | 1 | 1 | 1 | 1 |
| Accelerator (9) | 2 | 2 | 2 | 2 |
| Sulfur | 1 | 1 | 1 | 1 |

(1) Elastomer: Styrene/butadiene copolymer SBR, having a tertiary amine-alkoxysilane function in the middle of the chain and having a glass transition temperature, measured according to standard D3418 of 1999, equal to −48° C. Its microstructure, determined by the NIR method, is as follows: the content by weight of 1,4-trans units is 45.1%, that of 1,4-cis units is 30.5% and that of 1,2- units is 24.4% (each of these three contents relates to the butadiene units). The content by weight of styrene units is 27%;
(2) Elastomer: Non-functionalized styrene/butadiene copolymer SBR in solution, having a glass transition temperature measured according to standard D3418 of 1999 equal to −48° C. Its microstructure, determined by the NIR method, is as follows: the content by weight of 1,4-trans units is 50%, that of 1,4-cis units is 26% and that of 1,2- units is 24% (each of these three contents relates to the butadiene units). The content by weight of styrene units is 26.5%;
(3) N234 grade carbon black sold by Cabot Corporation;
(4) Coupling agent: Bis[3-(triethoxysilyl)propyl] tetrasulfide silane (TESPT) sold by Evonik under the reference Si69;
(5) DPG: diphenylguanidine, sold by Flexsys under the reference Perkacit;
(6) Resin: C5/C9 fraction sold by Exxon under the reference ECR-373;
(7) Plasticizer: Sunflower oil comprising 85% by weight of oleic acid, sold by Novance under the reference Lubrirob Tod 1880;
(8) Compound of the Disclosure, e.g., a compound of Tables A-J;
(9) Accelerator: N-cyclohexyl-2-benzothiazolesulfenamide sold by Flexsys under the reference Santocure CBS.

The preparation and properties of silicas SC1, S1, SC2, S2, SC3, S3, and S4 are described in U.S. Pat. No. 11,111,360.

In some embodiments, the disclosure provides a rubber composition based on at least one elastomer, a reinforcing inorganic filler, an agent for coupling the elastomer to the reinforcing inorganic filler, Compound of the Disclosure, e.g., a compound of Tables A-J, and a crosslinking system, wherein the reinforcing inorganic filler comprises at least one silica S having: a CTAB specific surface area S_{CTAB} within a range extending from 40 to 300 m²/g; a difference between a BET specific surface area S_{BET} and the CTAB specific surface area S_{CTAB} of greater than or equal to 35 m²/g; an aluminium content W_{Al} within a range extending from 0.5 to 7.0% by weight relative to a weight of the silica S; a width of the aggregate size distribution Ld, measured by centrifugal sedimentation, of greater than or equal to 1.5; and a median aggregate diameter d50, measured by centrifugal sedimentation, such that for a given value of CTAB specific surface area S_{CTAB} and a given aluminium content W_{Al}, a magnitude A is defined by the following equation (I): A=[d50]+0.782×[S_{CTAB}]−8.524×[W_{Al}] (I) in which: [d50] is the numerical value of d50, expressed in nm; [S_{CTAB}] is the numerical value of S_{CTAB}, expressed in m²/g; [W_{Al}] is the numerical value of W_{Al}, expressed in % by weight relative to the weight of the silica S; and the magnitude A satisfies the relationship (II): A ≥253 (II), and wherein the content of reinforcing inorganic filler is within a range extending from 80 to 150 phr.

In some embodiments, the disclosure provides a process for preparing a rubber composition based on at least one elastomer, a reinforcing inorganic filler, an agent for coupling the elastomer to the reinforcing inorganic filler, Compound of the Disclosure, e.g., a compound of Tables A-J, and a crosslinking system, the process comprising the following steps: contacting the at least one elastomer, the at least one reinforcing inorganic filler, and the at least one agent for coupling the elastomer to the reinforcing inorganic filler to make a mixture, wherein the content of reinforcing inorganic filler is within a range extending from 80 to 150 phr, wherein the reinforcing inorganic filler comprises at least one silica S having: a CTAB specific surface area S_{CTAB} within a range extending from 40 to 300 m²/g; a difference between a BET specific surface area S_{BET} and the CTAB specific surface area S_{CTAB} of greater than or equal to 35 m²/g; an aluminium content W_{Al} within a range extending from 0.5 to 7.0% by weight relative to a weight of the silica S; a width of the aggregate size distribution Ld, measured by centrifugal sedimentation, of greater than or equal to 1.5; and a median aggregate diameter d50, measured by centrifugal sedimentation, such that for a given value of CTAB specific surface area S_{CTAB} and a given aluminium content W_{Al}, a magnitude A is defined by the following equation (I): A=[d50]+0.782×[S_{CTAB}]−8.524×[W_{Al}] (I) in which: [d50] is the numerical value of d50, expressed in nm; [S_{CTAB}] is the numerical value of S_{CTAB}, expressed in m²/g; [W_{Al}] is the numerical value of W_{Al}, expressed in % by weight relative to the weight of the silica S; and the magnitude A satisfies the relationship (II): A ≥253 (II); thermomechanically kneading the mixture, once or several times, until a maximum temperature of between 110° C. and 190° C. is reached; cooling the mixture from the preceding step to a temperature below 100° C.; incorporating a crosslinking system into the cooled mixture from the preceding step; and kneading the mixture comprising the crosslinking system up to a maximum temperature below 110° C.

In some embodiments, the disclosure provides the rubber compositions and/or tires described in U.S. Pat. No. 11,090,980, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 25.

TABLE 25

| | T1 | C1 |
|---|---|---|
| NR (1) | 100 | — |
| Elastomer E1 | — | 100 |
| Carbon black (2) | 30 | 30 |
| Antioxidant (3) | 1.5 | 1.5 |
| Stearic acid (4) | 2.5 | 2.5 |
| Zinc oxide (5) | 3 | 3 |
| Accelerator (6) | 2.0 | 2.0 |
| Sulfur | 0.8 | 1.5 |

(1) Natural rubber
(2) N234 according to Standard ASTM D-1765
(3) Compound of the Disclosure, e.g., a compound of Tables A-J
(4) Stearin, Pristerene 4931 from Uniqema
(5) Zinc oxide of industrial grade from Umicore
(6) N-Cyclohexyl-2-benzothiazolesulfenamide, Santocure CBS from Flexsys

In some embodiments, the disclosure provides an aeroplane tire, comprising a tread having an axial width L, the tread comprising: a middle part having an axial width Lc at least equal to 50% and at most equal to 80% of the axial width L of the tread and composed of a middle rubber composition, and two lateral parts positioned axially on either side of the middle part, each having an axial width at least equal to 10% and at most equal to 25% of the axial width L of the tread and each composed of a lateral rubber composition, wherein the middle rubber composition comprises at least 50 phr of a first diene elastomer, a reinforcing filler, Compound of the Disclosure, e.g., a compound of Tables A-J, and a crosslinking system, which first diene elastomer comprises ethylene units and diene units comprising a carbon-carbon double bond, which units are distributed randomly within the first diene elastomer, the ethylene units representing at least 50 mol % of all the monomer units of the first diene elastomer, wherein the tire comprising a crown reinforcement radially inside the tread, wherein the tire comprises an interlayer composed of at least one rubber composition comprising Compound of the Disclosure, e.g., a compound of Tables A-J, in contact by a radially outer face with at least the middle part of the tread and by a radially inner face with the crown reinforcement, wherein the interlayer is composed of an elastomeric laminate comprising, radially from the outside to the inside, n layers Ci, n being an integer greater than or equal to 2 and i being an integer ranging from 1 to n, each composed of a diene rubber composition, the layer C1 comprising a diene elastomer E comprising ethylene units and diene units, the diene units representing more than 10% by weight of the monomer units of the diene elastomer E, the layer Cn comprising from 50 to less than 100 phr of a diene elastomer N having a content by weight of diene units of greater than 50%, the content expressed in phr of diene elastomer N being higher in the layer Cn than in the layer C1, the content expressed in phr of the diene elastomer E being higher in the layer C1 than in the layer Cn, the layers Ci, for the values of i ranging from 2 to n−1, where n is greater than 2, comprising a diene elastomer I selected from the group consisting of diene homopolymers and copolymers having more than 10% by weight of diene units.

In some embodiments, the disclosure provides the rubber compositions and/or tires described in U.S. Pat. No. 11,046,838, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber crumbs of Table 26.

TABLE 26

| | P1 | | P2 | | P3 | |
|---|---|---|---|---|---|---|
| NR (1) | 80 | | 100 | | 100 | |
| BR (2) | 20 | | 0 | | 0 | |
| Carbon black (3) | 48 | | 48 | | 57 | |
| Carbon black (3) (% by | 30 | | 30 | | 34 | |
| weight) | | | | | | |
| Antioxidant (4) | 3 | | 3 | | 1.5 | |
| Stearic acid (5) | 2 | | 2 | | 2 | |
| Zinc oxide (6) | 3 | | 3 | | 3 | |
| Accelerator (7) | 1 | | 1 | | 1 | |
| Sulfur | 1.5 | | 1.5 | | 1.5 | |
| Acetone extract | 4.6% | | 4.6% | | 4.6% | |
| Chloroform extract | 6.3% | | 6.3% | | 6.3% | |
| Mw (Chloroform extract) | 7000 | g/mol | 7000 | g/mol | 7000 | g/mol |
| D50 | 155 | μm | 155 | μm | 155 | μm |

(1) NR: Natural rubber
(2) BR: polybutadiene, CB24 from Lanxess; 96% of cis-1,4; Tg = −107° C.
(3) Carbon black, ASTM N234 or N375 grade
(4) Compound of the Disclosure, e.g., a compound of Tables A-J
(5) Stearin, Pristerene 4931 from Uniqema
(6) Zinc oxide, industrial grade - Umicore
(7) N-Cyclohexyl-2-benzothiazolesulfenamide (Santocure CBS from Flexsys)

In some embodiments, the disclosure provides the rubber compositions of Table 27, which comprise the rubber crumbs P1-P3 described in Table 26 above.

TABLE 27

| | C1 | C2 | I |
|---|---|---|---|
| NR (1) | 80 | 80 | 80 |
| BR (2) | 20 | 20 | 20 |
| Carbon black (3) | 48 | 48 | 48 |
| Crumb P1 | 40 | 0 | 0 |
| Crumb P2 | 0 | 40 | 0 |
| Crumb P3 | 0 | 0 | 40 |
| Antioxidant (4) | 3 | 3 | 3 |
| Stearic acid (5) | 2 | 2 | 2 |
| Zinc oxide (6) | 3 | 3 | 3 |
| Accelerator (7) | 1 | 1 | 1 |
| Sulfur | 1.5 | 1.5 | 1.5 |

(1) NR: Natural rubber
(2) BR: polybutadiene, CB24 from Lanxess; 96% of cis-1,4; Tg = −107° C.
(3) Carbon black, ASTM N234 grade
(4) Compound of the Disclosure, e.g., a compound of Tables A-J
(5) Stearin, Pristerene 4931 from Uniqema
(6) Zinc oxide, industrial grade - Umicore
(7) N-Cyclohexyl-2-benzothiazolesulfenamide (Santocure CBS from Flexsys)

In some embodiments, the disclosure provides a rubber composition based on at least an elastomer, a reinforcing filler, a crosslinking system, Compound of the Disclosure, e.g., a compound of Tables A-J, and a crumb rubber, wherein the crumb rubber comprises 100 phr of natural rubber, wherein the crumb rubber exhibits a fraction by weight of carbon black ranging from 31% to 35%, wherein the crumb rubber is present in the rubber composition at a content ranging from 5 to 100 phr, wherein the crumb rubber has not undergone modification by a method selected from the group consisting of thermal, mechanical, biological, and chemical treatments and combinations thereof, and wherein the crumb rubber exhibits a chloroform extract, the weight-average molecular weight of which is less than 10,000 g/mol.

In some embodiments, the disclosure provides a rubber composition based on at least an elastomer, a reinforcing filler, a crosslinking system, Compound of the Disclosure, e.g., a compound of Tables A-J, and a crumb rubber, wherein the crumb rubber comprises 100 phr of natural rubber, wherein the crumb rubber exhibits a fraction by weight of carbon black ranging from 31% to 35%, wherein the crumb rubber is present in the rubber composition at a content ranging from 5 to 100 phr, wherein the crumb rubber exhibits a morphology modified by a method selected from the group consisting of thermal, mechanical, biological, and chemical treatments and combinations thereof, and wherein the crumb rubber exhibits a chloroform extract, the weight-average molecular weight of which is greater than 10,000 g/mol.

In some embodiments, the disclosure provides the rubber compositions and/or tires described in U.S. Pat. No. 11,046,116, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Tables 28 and 29.

TABLE 28

| | T2 | C1 | C2 | C3 | C4 | C5 |
|---|---|---|---|---|---|---|
| NR (1) | 100 | — | 10 | 20 | 40 | 60 |
| EPDM 1 (2) | — | 100 | 90 | 80 | 60 | 40 |
| Carbon black (3) | 30 | 30 | 30 | 30 | 30 | 30 |
| Antioxidant (4) | 1.5 | 1.5 | 1.5 | 1.5 | 1.5 | 1.5 |
| Stearic acid (5) | 2.5 | 2.5 | 2.5 | 2.5 | 2.5 | 2.5 |
| Zinc oxide (6) | 3 | 3 | 3 | 3 | 3 | 3 |
| Accelerator (7) | 2 | 2 | 2 | 2 | 2 | 2 |
| Sulfur | 0.8 | 0.8 | 0.8 | 0.8 | 0.8 | 0.8 |

(1) Natural rubber
(2) EPDM, Nordel IP 4570 from Dow
(3) Carbon black of N234 grade according to Standard ASTM D-1765
(4) Compound of the Disclosure, e.g., a compound of Tables A-J
(5) Stearin, Pristerene 4931 from Uniqema
(6) Zinc oxide of industrial grade from Umicore
(7) N-Cyclohexyl-2-benzothiazolesulfenamide, Santocure CBS from Flexsys

TABLE 29

| | T1 | C1 | C15 | C18 | C19 | C20 | C21 | C22 | C23 | C24 |
|---|---|---|---|---|---|---|---|---|---|---|
| NR (1) | 100 | — | — | — | — | — | — | — | — | — |
| EPDM (2) | — | 100 | 100 | 100 | 100 | 100 | 100 | 100 | 100 | 100 |
| Carbon black 1 (3) | 47.5 | 30 | 47.5 | 70 | — | — | — | — | — | — |
| Carbon black 2 (4) | — | — | — | — | 30 | 47.5 | — | — | — | — |
| Carbon black 3 (5) | — | — | — | — | — | — | 30 | 47.5 | — | — |
| Silica (6) | — | — | — | — | — | — | — | — | 30 | 47.5 |
| Silane (7) | — | — | — | — | — | — | — | — | 2.4 | 3.8 |
| Antioxidant (8) | 1.5 | 1.5 | 1.5 | 1.5 | 1.5 | 1.5 | 1.5 | 1.5 | 1.5 | 1.5 |
| Stearic acid (9) | 2.5 | 2.5 | 2.5 | 2.5 | 2.5 | 2.5 | 2.5 | 2.5 | 2.5 | 2.5 |
| Zinc oxide (10) | 3 | 3 | 3 | 3 | 3 | 3 | 3 | 3 | 3 | 3 |
| Accelerator (11) | 0.8 | 2 | 2 | 2 | 2 | 2 | 2 | 2 | 0.8 | 0.8 |
| Sulfur | 1.5 | 0.8 | 0.8 | 0.8 | 0.8 | 0.8 | 0.8 | 0.8 | 1.5 | 1.5 |

(1) Natural rubber
(2) EPDM, Nordel IP 4570 from Dow
(3) Carbon black of N234 grade according to Standard ASTM D-1765
(4) Carbon black of N115 grade according to Standard ASTM D-1765
(5) Carbon black of N550 grade according to Standard ASTM D-1765
(6) Silica of 160 MP grade
(7) Liquid silane, Si69 from Degussa
(8) Compound of the Disclosure, e.g., a compound of Tables A-J
(9) Stearin, Pristerene 4931 from Uniqema
(10) Zinc oxide of industrial grade from Umicore
(11) N-Cyclohexyl-2-benzothiazolesulfenamide, Santocure CBS from Flexsys

In some embodiments, the disclosure provides an aeroplane tire comprising a tread having an axial width L, the tread comprising: a middle part having an axial width Lc at least equal to 50% and at most equal to 80% of the axial width L of the tread and composed of a middle rubber composition, and two lateral parts positioned axially on either side of the middle part, each having an axial width at least equal to 10% and at most equal to 25% of the axial width L of the tread and each composed of a lateral rubber composition, wherein the middle rubber composition comprises at least 50 phr of a first middle part diene elastomer, at most 70 phr of a middle part reinforcing filler, Compound of the Disclosure, e.g., a compound of Tables A-J, and a crosslinking system, which first middle part diene elastomer is a terpolymer of ethylene, of an α-olefin and of a non-conjugated diene and wherein the lateral rubber composition of each lateral part comprises at least 50 phr of a first lateral part diene elastomer, a lateral part reinforcing filler content greater than the middle part reinforcing filler content, Compound of the Disclosure, e.g., a compound of Tables A-J, and a crosslinking system, which first lateral part diene elastomer is a terpolymer of ethylene, of an α-olefin and of a non-conjugated diene, wherein, for at least one of the first middle part and respectively lateral part diene elastomers, the α-olefin is propylene, and wherein the middle part reinforcing filler comprises 100% by weight of a carbon black.

In some embodiments, the disclosure provides the rubber compositions and/or tires described in U.S. Pat. No. 11,046,115, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides an airplane tire comprising a tread having an axial width L, the tread comprising: a middle part having an axial width Lc at least equal to 50% and at most equal to 80% of the axial width L of the tread and composed of a middle rubber composition, and two lateral parts positioned axially on either side of the middle part, each having an axial width at least equal to 10% and at most equal to 25% of the axial width L of the tread and each composed of a lateral rubber composition, wherein the middle rubber composition comprises a first diene elastomer as the only elastomer, a reinforcing filler, Compound of the Disclosure, e.g., a compound of Tables A-J, and a crosslinking system, which first diene elastomer is a terpolymer of ethylene, of an α-olefin and of a non-conjugated diene, and wherein the α-olefin is propylene, and wherein at least one lateral rubber composition comprises a diene elastomer, a reinforcing filler, Compound of the Disclosure, e.g., a compound of Tables A-J, and a crosslinking system, which diene elastomer is a highly unsaturated diene elastomer, selected from the group consisting of polybutadienes, polyisoprenes, butadiene copolymers, isoprene copolymers and the mixtures of these elastomers.

In some embodiments, the disclosure provides the rubber compositions and/or tires described in U.S. Pat. No. 11,041,065, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber crumbs of Table 30.

TABLE 30

| | P1 | | P2 | |
|---|---|---|---|---|
| NR (1) | 100 | | 100 | |
| Carbon black (2) | 57 | | 57 | |
| Stearic acid (4) | 2 | | 2 | |
| Zinc oxide (5) | 3 | | 3 | |
| Accelerator (6) | 2 | | 1.5 | |
| Sulfur | 5 | | 1.5 | |
| Sulfur + accelerator content | 7 | | 3 | |
| Total S content (7) | 5.6 | | 2.1 | |
| Acetone extract | 4.6% | | 4.6% | |
| Chloroform extract | 6.3% | | 6.3% | |
| Mw (Chloroform extract) | 7000 | g/mol | 7000 | g/mol |
| D50 | 155 | μm | 155 | μm |

(1) NR: Natural rubber
(2) Carbon black, ASTM N234 grade
(3) Compound of the Disclosure, e.g., a compound of Tables A-J
(4) Stearin, Pristerene 4931 from Uniqema
(5) Zinc oxide, industrial grade - Umicore
(6) N-Cyclohexyl-2-benzothiazolesulfenamide (Santocure CBS from Flexsys)
(7) The total sulfur in the composition very predominantly originates from the sulfur added in the crosslinking system but also from the sulfur present in other ingredients of the composition. An amount of the order of 0.5% of sulfur is present in the carbon black. A small amount (0.1%) of sulfur is also contributed by the accelerator CBS.

In some embodiments, the disclosure provides the rubber compositions of Table 31, which comprise the rubber crumbs P1-P2 described in Table 30 above.

TABLE 31

| | C1 | I1 | C2 | I2 |
|---|---|---|---|---|
| NR (1) | 80 | 80 | 100 | 100 |
| BR (2) | 20 | 20 | 0 | 0 |
| Carbon black (3) | 48 | 48 | 48 | 48 |
| Crumb P1 | 40 | 0 | 40 | 0 |
| Crumb P2 | 0 | 40 | 0 | 40 |
| Antioxidant (4) | 3 | 3 | 3 | 3 |
| Stearic acid (5) | 2 | 2 | 2 | 2 |
| Zinc oxide (6) | 3 | 3 | 3 | 3 |
| Accelerator (7) | 1 | 1 | 1 | 1 |
| Sulfur | 1.5 | 1.5 | 1.5 | 1.5 |

(1) NR: Natural rubber
(2) BR: polybutadiene, CB24 from Lanxess; 96% of cis-1,4; Tg = −107° C.
(3) Carbon black, ASTM N234 grade
(4) Compound of the Disclosure, e.g., a compound of Tables A-J
(5) Stearin, Pristerene 4931 from Uniqema
(6) Zinc oxide, industrial grade - Umicore
(7) N-Cyclohexyl-2-benzothiazolesulfenamide (Santocure CBS from Flexsys)

In some embodiments, the disclosure provides a rubber composition based on at least an elastomer, a reinforcing filler, a crosslinking system, Compound of the Disclosure, e.g., a compound of Tables A-J, and a crumb rubber, wherein the crumb rubber comprises sulfur, Compound of the Disclosure, e.g., a compound of Tables A-J, and an accelerator, and the crumb rubber exhibits a content of sulfur and a content of accelerator such that a sum of the contents is less than or equal to 5 parts by weight per 100 parts by weight of elastomer (phr) in a composition of the crumb rubber, wherein the crumb rubber exhibits a total sulfur content of less than or equal to 4 parts by weight per 100 parts by weight of elastomer (phr) in the composition of the crumb rubber, and wherein the accelerator is present in a content between 0.5 and 3 phr in the composition of the crumb rubber, and wherein the crumb rubber has not undergone modification by a method selected from the group consisting of thermal, mechanical, biological, and chemical treatments and combinations thereof, and exhibits a chloroform extract, the weight-average molecular weight of which is less than 10,000 g/mol.

In some embodiments, the disclosure provides a rubber composition based on at least an elastomer, a reinforcing filler, a crosslinking system, Compound of the Disclosure, e.g., a compound of Tables A-J, and a crumb rubber, wherein the crumb rubber comprises sulfur, Compound of the Disclosure, e.g., a compound of Tables A-J, and an accelerator, and the crumb rubber exhibits a content of sulfur and a content of accelerator such that a sum of the contents is less than or equal to 5 parts by weight per 100 parts by weight of elastomer (phr) in a composition of the crumb rubber, wherein the crumb rubber exhibits a total sulfur content of less than or equal to 4 parts by weight per 100 parts by weight of elastomer (phr) in the composition of the crumb rubber, wherein the accelerator is present in a content between 0.5 and 3 phr in the composition of the crumb rubber, and wherein the crumb rubber exhibits a morphology modified by a method selected from the group consisting of thermal, mechanical, biological, and chemical treatments and combinations thereof, and exhibits a chloroform extract, the weight-average molecular weight of which is greater than 10,000 g/mol.

In some embodiments, the disclosure provides the rubber compositions and/or tires described in U.S. Pat. No. 11,028,254, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber crumbs of Table 32.

TABLE 32

| | P0 | | P1 | | P2 | | P3 | |
|---|---|---|---|---|---|---|---|---|
| NR (1) | 0 | | 60 | | 80 | | 100 | |
| BR (2) | 0 | | 20 | | 20 | | 0 | |
| SBR (3) | 100 | | 20 | | 0 | | 0 | |
| Carbon black (4) | 54 | | 54 | | 48 | | 48 | |
| Carbon black (% by weight) | 33 | | 33 | | 30 | | 30 | |
| Antioxidant (5) | 2 | | 2 | | 3 | | 3 | |
| Stearic acid (6) | 2 | | 2 | | 2 | | 2 | |
| Zinc oxide (7) | 3 | | 3 | | 3 | | 3 | |
| Accelerator (8) | 1.5 | | 1 | | 1 | | 1 | |
| Sulfur | 1.5 | | 1.5 | | 1.5 | | 1.5 | |
| Acetone extract | 4.2% | | 4.5% | | 4.6% | | 4.6% | |
| Chloroform extract | 5.8% | | 6.1% | | 6.3% | | 6.3% | |
| Mw (Chloroform extract) | 7000 | g/mol | 7000 | g/mol | 7000 | g/mol | 7000 | g/mol |
| D50 | 155 | μm | 155 | μm | 155 | μm | 155 | μm |

(1) NR: Natural rubber
(2) BR: polybutadiene, CB24 from Lanxess; 96% of 1,4-cis-; Tg = −107° C.
(3) SBR with 15.5% of styrene units and 24% of 1,2-units of the butadiene part (Tg = −65° C.)
(4) Carbon black, ASTM N234 or N375 grade
(5) Compound of the Disclosure, e.g., a compound of Tables A-J
(6) Stearin, Pristerene 4931 from the company Uniqema
(7) Zinc oxide, industrial grade - from the company Umicore
(8) N-Cyclohexyl-2-benzothiazolesulfenamide (Santocure CBS from the company Flexsys)

In some embodiments, the disclosure provides the rubber compositions of Table 33, which comprise the rubber crumbs P0-P3 described in Table 32 above.

TABLE 33

| | T1 | T2 | C1 | C2 | C3 |
|---|---|---|---|---|---|
| NR (1) | 80 | 80 | 80 | 80 | 80 |
| BR (2) | 20 | 20 | 20 | 20 | 20 |
| Carbon black (3) | 48 | 48 | 48 | 48 | 48 |
| Crumb P0 | 40 | — | — | — | — |
| Crumb (4) | — | 40 | — | — | — |
| Crumb P1 | — | — | 40 | — | — |
| Crumb P2 | — | — | — | 40 | — |
| Crumb P3 | — | — | — | — | 40 |
| Antioxidant (5) | 3 | 3 | 3 | 3 | 3 |
| Stearic acid (6) | 2 | 2 | 2 | 2 | 2 |
| Zinc oxide (7) | 3 | 3 | 3 | 3 | 3 |
| Accelerator (8) | 1 | 1 | 1 | 1 | 1 |
| Sulfur | 1.5 | 1.5 | 1.5 | 1.5 | 1.5 |

(1) NR: Natural rubber
(2) BR: polybutadiene, CB24 from Lanxess; 96% of 1,4-cis-; Tg = −107° C.
(3) Carbon black, ASTM N234 grade
(4) Crumb rubber sold under the name RNR30B01 by the company Rubber Ressources and as described below:
Crumb RNR30B01
Acetone extract 10.3%
Chloroform extract 25.9%
Mw (CHCl₃ extract) 34 500 g/mol
Elastomers 80 NR
Carbon black (% by weight) 30
(5) Compound of the Disclosure, e.g., a compound of Tables A-J
(6) Stearin, Pristerene 4931 from the company Uniqema
(7) Zinc oxide, industrial grade - from the company Umicore
(8) N-Cyclohexyl-2-benzothiazolesulfenamide (Santocure CBS from the company Flexsys)

In some embodiments, the disclosure provides a rubber composition based on at least an elastomer, a reinforcing filler, a crosslinking system, Compound of the Disclosure, e.g., a compound of Tables A-J, and a crumb rubber, wherein the crumb rubber has an isoprene elastomer content of greater than 50 phr in the composition of the rubber crumb and a chloroform extract with a weight-average molecular weight of less than 10,000 g/mol.

In some embodiments, the disclosure provides the rubber compositions and/or tires described in U.S. Pat. No. 10,968,333, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 34.

TABLE 34

| | C1 | C2 | C3 | C4 |
|---|---|---|---|---|
| SBR (1) | 100 | 100 | 100 | 100 |
| Carbon black (2) | 4 | 4 | 4 | 4 |
| Silica (3) | 110 | 110 | 110 | 110 |
| Silane (4) | 8.8 | — | — | — |
| Silane (5) | — | 8.1 | — | — |
| Silane (6) | — | — | 9.0 | 9.0 |
| Resin (7) | 45 | 45 | 45 | 45 |
| Oil (8) | 17 | 17 | 17 | 17 |
| Octadecylamine wax | 1.8 | 1.8 | 1.8 | 1.8 |
| DPG (9) | 2 | 2 | 2 | 2 |
| ZnO | 1 | 1 | 1 | — |
| Stearic acid | 2 | 2 | 2 | 2 |
| Antioxidant (10) | 2.7 | 2.7 | 2.7 | 2.7 |
| Sulfur* | 1.1 | 1.8 | 1.8 | 1.8 |
| Accelerator (11) | 2.3 | 2.3 | 2.3 | 2.3 |

(1) SBR with 27% of styrene units and 24% of 1,2-units of the butadiene part (Tg = −48° C.) bearing a silanol functional group at the elastomer chain end, and comprising as a minor component by weight chains of the same microstructure but Sn star-branched;
(2) Carbon black N234, sold by Cabot Corporation;
(3) “HD”-type silica, Zeosil 1165MP from Solvay;
(4) TESPT (Si69 ® from Evonik);
(5) Si75 ® (bis(triethoxysilylpropyl) disulfide from Evonik);
(6) Product B1 (bis(2-methylpropane-1,3-diyl)(triethoxylsilane) (product B1));
(7) Polylimonene resin (Resine THER 8644 from Cray Valley);
(8) Sunflower oil, Lubrirob Tod 1880 from Novance;
(9) Diphenylguanidine (Vulkacit D from Bayer);
(10) Compound of the Disclosure, e.g., a compound of Tables A-J
(11) N-Cyclohexyl-2-benzothiazolesulfenamide (Santocure CBS from Flexsys).
*The sulfur contents are adjusted in order to take into account the release of sulfur which takes place with TESPT not with the products Si75 or B1 (disulfide S₂ foot).

In some embodiments, the disclosure provides a elastomeric composition based on at least a diene elastomer, an inorganic filler as reinforcing filler, Compound of the Disclosure, e.g., a compound of Tables A-J, and an alkoxysilane polysulfide as coupling agent, of formula (I) of U.S. Pat. No. 10,968,333: (R³O)₃₋ₙ(R₁)ₙSi—CH₂—(R²)CH—Z—Sₓ—Z—HC(R²)—CH₂—Si(R¹)ₙ(OR³)₃₋ₙ (I), in which: R¹, which are identical or different, each represent a monovalent hydrocarbon group having from 1 to 18 carbon atoms; R², which are identical or different, each represent a monovalent hydrocarbon group having from 1 to 4 carbon atoms; R³, which are identical or different, each represent a monovalent hydrocarbon group having from 1 to 12 carbon atoms; Z, which are identical or different, each represent a divalent hydrocarbon bonding group comprising from 1 to 16 carbon atoms; x is an integral or fractional number greater than or equal to 2; and n is an integer equal to 2.

In some embodiments, the disclosure provides the rubber compositions and/or tires described in U.S. Pat. No. 10,967,679, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Tables 35 and 36.

TABLE 35

| Constituent | phr |
|---|---|
| SBR (a) | 100 |
| Silica (b) | 110 |
| Coupling agent (c) | 9 |
| Liquid plasticizer (d) | 20 |
| Resin plasticizer (e) | 50 |
| Black | 5 |
| Zinc oxide | 3 |
| Stearic acid | 2 |
| Antioxidant (f) | 2 |
| Accelerator (g) | 2 |
| DPG | 2 |
| Sulfur | 1 |

(a) SBR with 27% stirene, 1,2-butadiene: 5%, cis-1,4-butadiene: 15%, trans-1,4-butadiene: 80%, Tg = −48° C.
(b) “Zeosil1165MP” silica from Solvay with BET surface area of 160 m²/g
(c) “SI69” TESPT silane from Evonik
(d) “Flexon 630” TDAE oil from Shell
(e) “Escorez 2173” resin from Exxon
(f) Compound of the Disclosure, e.g., a compound of Tables A-J
(g) “Santocure CBS” accelerator from Solutia

TABLE 36

| Constituent | phr |
|---|---|
| NR (1) | 100 |
| Carbon black (2) | 70 |
| Phenol-formaldehyde resin (3) | 12 |
| ZnO (4) | 3 |
| Stearic acid (5) | 2 |
| Compound of the Disclosure, e.g., a compound of | 2.5 |
| Tables A-J (6) | |
| HMT (7) | 4 |
| Sulfur | 3 |
| CBS (8) | 2 |

(1) Natural Rubber;
(2) Carbon black N326 (name according to Standard ASTM D-1765);
(3) Phenol-formaldehyde novolac resin (“Peracit 4536K” from Perstorp);
(4) Zinc oxide (industrial grade - Umicore);
(5) Stearin (“Pristerene 4931” from Uniqema);
(6) Compound of the Disclosure, e.g., a compound of Tables A-J
(7) Hexamethylenetetramine (from Degussa);
(8) N-cyclohexylbenzothiazole sulfenamide (Santocure CBS from Flexsys).

In some embodiments, the disclosure provides the rubber compositions and/or tires described in U.S. Pat. No. 10,961,374, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 37.

TABLE 37

| | T4 | C4 | C5 | C6 |
|---|---|---|---|---|
| X1 | 100 | 0 | 0 | 0 |
| I1 | 0 | 70 | 80 | 90 |
| I2 | 0 | 30 | 20 | 10 |
| Silica (1) | 111 | 111 | 111 | 111 |
| DPG (2) | 1.96 | 1.96 | 1.96 | 1.96 |
| Covering agent (3) | 8.2 | 8.2 | 10.6 | 13.5 |
| Compound of the Disclosure, | 2 | 2 | 2 | 2 |
| e.g., a compound of Tables A-J | | | | |
| (4) | | | | |
| ZnO | 3 | 3 | 3 | 3 |
| Stearic Acid | 2 | 2 | 2 | 2 |
| Sulfur | 1 | 1 | 1 | 1 |
| Accelerator (5) | 1.5 | 1.5 | 1.5 | 1.5 |

(1) Precipitated silica 160 MP (Zeosil 1165 MP), manufactured by Solvay, type “HDS” with a BET specific surface area measured at 160 m²/g;
(2) DPG = diphenylguanidine (“Perkacit” DPG, Flexsys);
(3) Octyltriethoxysilane (“Octeo” silane, Degussa);
(4) Compound of the Disclosure, e.g., a compound of Tables A-J
(5) N-Cyclohexy1-2-benzothiazolesulfenamide (“Santocure CBS,” Flexsys).

In some embodiments, the disclosure provides a rubber composition based on at least: an elastomer matrix comprising: a first diene elastomer having a number-average molecular weight, Mn, of greater than or equal to 100 000 g/mol; a functionalized second diene elastomer bearing at the chain end a function capable of reacting with the surface of silica, the functionalized diene elastomer having a number-average molecular weight, Mn, ranging from 20,000 g/mol to 80 000 g/mol; a reinforcing inorganic filler, in an amount ranging from 55 phr to 200 phr; and Compound of the Disclosure, e.g., a compound of Tables A-J.

In some embodiments, the disclosure provides the rubber compositions and/or tires described in U.S. Pat. No. 10,961,371, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 38.

TABLE 38

| | Compositions | | |
|---|---|---|---|
| | C1 | C2 | C3 |
| SBR (1) | 100 | 100 | 100 |
| Carbon black (2) | 4 | 4 | 4 |
| Silica (3) | 110 | 110 | 110 |
| Silane (4) | 8.8 | — | — |
| Silane (5) | — | 6.5 | — |
| Silane (6) | — | — | 7.1 |
| Resin (7) | 45 | 45 | 45 |
| Oil (8) | 17 | 17 | 17 |
| Wax | 1.8 | 1.8 | 1.8 |
| DPG (9) | 2 | 2 | 2 |
| ZnO | 1 | 1 | 1 |
| Stearic acid | 2 | 2 | 2 |
| Antioxidant (10) | 2.7 | 2.7 | 2.7 |
| Sulfur* | 1.1 | 1.1 | 1.8 |
| Accelerator (11) | 2.3 | 2.3 | 2.3 |

(1) SBR with 27% of styrene units and 24% of 1,2-units of the butadiene part (Tg = −48° C.) bearing a silanol functional group at the end of the elastomer chain, and comprising, in a minor proportion by weight, chains of the same microstructure but Sn star-branched;
(2) Carbon black N234, sold by Cabot Corporation
(3) “HD”-type silica, Zeosil 1165MP from Solvay;
(4) TESPT (Si69 from Evonik);
(5) Product B (bis(propyldimethylsilanol) at 90 mol %;
(6) Product A (bis(2-methylpropane-1,3-diyl)(dimethylsilanol) at 77 mol %;
(7) C₅/C₉ Fraction resin (Resine THER 8644 from Cray Valley);
(8) Sunflower oil, Lubrirob Tod 1880 from Novance;
(9) Diphenylguanidine (Vulkacit D from Bayer);
(10) Compound of the Disclosure, e.g., a compound of Tables A-J;
(11) N-Cyclohexyl-2-benzothiazolesulfenamide (Santocure CBS from Flexsys).
*The sulfur contents were adjusted in order to take into account the release of sulfur which takes place with TESTP and product B (polysulfide S₄) and not with product A (disulfide S₂).

In some embodiments, the disclosure provides the rubber compositions of Table 39.

TABLE 39

Compositions

| | C2 | C′2 | C3 | C′3 |
|---|---|---|---|---|
| SBR (1) | 100 | 100 | 100 | 100 |
| Carbon black (2) | 4 | 4 | 4 | 4 |
| Silica (3) | 110 | 110 | 110 | 110 |
| Silane (5) | 6.5 | 6.5 | — | — |
| Silane (6) | — | — | 7.1 | 7.1 |
| Resin (7) | 45 | 45 | 45 | 45 |
| Oil (8) | 17 | 17 | 17 | 17 |
| Wax | 1.8 | 1.8 | 1.8 | 1.8 |
| DPG (9) | 2 | 2 | 2 | 2 |
| ZnO | 1 | — | 1 | — |
| Stearic acid | 2 | 2 | 2 | 2 |
| Antioxidant (10) | 2.7 | 2.7 | 2.7 | 2.7 |
| Sulfur | 1.1 | 1.1 | 1.8 | 1.8 |
| Accelerator (11) | 2.3 | 2.3 | 2.3 | 2.3 |

(1) SBR with 27% of styrene units and 24% of 1,2-units of the butadiene part (Tg = −48° C.) bearing a silanol functional group at the end of the elastomer chain, and comprising, in a minor proportion by weight, chains of the same microstructure but Sn star-branched;
(2) Carbon black N234, sold by Cabot Corporation
(3) “HD”-type silica, Zeosil 1165MP from Solvay;
(5) Product B (bis(propyldimethylsilanol) at 90 mol %;
(6) Product A (bis(2-methylpropane-1,3-diyl)(dimethylsilanol) at 77 mol %;
(7) C₅/C₉ Fraction resin (Resine THER 8644 from Cray Valley);
(8) Sunflower oil, Lubrirob Tod 1880 from Novance;
(9) Diphenylguanidine (Vulkacit D from Bayer);
(10) Compound of the Disclosure, e.g., a compound of Tables A-J;
(11) N-Cyclohexyl-2-benzothiazolesulfenamide (Santocure CBS from Flexsys).

In some embodiments, the disclosure provides an elastomeric composition based on at least: a diene elastomer, an inorganic filler as reinforcing filler, a Compound of the Disclosure, e.g., a compound of Tables A-J, and a monohydroxysilane polysulfide as a coupling agent of formula (I) of U.S. Pat. No. 10,961,371:

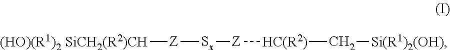

in which: each R¹ represent a monovalent hydrocarbon group having from 1 to 18 carbon atoms and can be the same or different from one another, each R² represents a monovalent hydrocarbon group having from 1 to 4 carbon atoms and can be the same or different from one another, each Z represents a divalent hydrocarbon bonding group comprising from 1 to 16 carbon atoms and can be the same or different from one another, and x is an integral or fractional number greater than or equal to 2.

In some embodiments, the disclosure provides the rubber compositions and/or tires described in U.S. Pat. No. 10,946,697, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 40.

TABLE 40

| | Compositions | | |
|---|---|---|---|
| | A-0 | A-1 | A-2 |
| BR (1) | 15 | 0 | 0 |
| SBR (2) | 85 | 60 | 60 |
| TPE elastomer (3) | 0 | 40 | 40 |
| PPE resin (4) | 0 | 0 | 5 |
| Carbon black (5) | 5 | 5 | 5 |
| Silica (6) | 70 | 26 | 26 |
| Coupling agent (7) | 6 | 2 | 2 |
| Oil (8) | 2 | 0 | 0 |
| Resin (9) | 15 | 0 | 0 |
| Antiozone wax | 1.5 | 1.5 | 1.5 |
| Antioxidant (10) | 2 | 2 | 2 |
| DPG (11) | 1.3 | 0.5 | 0.5 |
| ZnO (12) | 0.5 | 0.5 | 0.5 |
| Stearic acid (13) | 2 | 2 | 2 |
| CBS (14) | 1.7 | 1.7 | 1.7 |
| Sulfur | 1 | 1 | 1 |

(1) BR with 4% of 1,2-units and 93% of cis-1,4-units (Tg = −106° C.);
(2) Solution SSBR (contents expressed as dry SBR: 41% of styrene, 24% of 1,2-polybutadiene units and 50% of trans-1,4-polybutadiene units (Tg = −25° C.));
(3) SOE thermoplastic elastomer, SOE L606 from Asahi Kasei;
(4) PPE resin: Poly(2,6-dimethyl-1,4-phenylene ether), Xyron S202 A from Asahi Kasei, Mn = 37 000 g/mol, Tg = 215° C .;
(5) Carbon black N234;
(6) Silica (Zeosil 1165MP, from Rhodia);
(7) TESTP coupling agent (Si69, from Degussa);
(8) MES oil, Catenex SNR from Shell;
(9) C₅/C₉ resin, Cray Valley Wingtack, from STS;
(10) Compound of the Disclosure, e.g., a compound of Tables A-J;
(11) DPG = Diphenylguanidine (Perkacit DPG from Flexsys);
(12) Zinc oxide (industrial grade - Umicore);
(13) Stearin (Pristerene from Uniqema);
(14) N-Cyclohexyl-2-benzothiazolesulfenamide (Santocure CBS from Flexsys).

In some embodiments, the disclosure provides a tire comprising a tread, a crown with a crown reinforcement, two sidewalls, two beads, a carcass reinforcement anchored to the two beads and extending from one sidewall to the other, the tread comprising a composition based on at least: a diene elastomer, at a content of between 35 and 99 phr (parts by weight per hundred parts of elastomer), a Compound of the Disclosure, e.g., a compound of Tables A-J, a thermoplastic elastomer, at a content of between 1 and 65 phr; and a thermoplastic resin comprising optionally substituted polyphenylene ether units, wherein the thermoplastic resin has a glass transition temperature Tg, measured by DSC according to standard ASTM D3418, 1999, within a range extending from 0 to 280° C. and a number average molecular weight Mn from 15,000 g/mol to 40,000 g/mol, and wherein the thermoplastic elastomer is a block copolymer comprising at least one elastomer block of hydrogenated butadiene/styrene random copolymer type and at least one thermoplastic block of styrene type.

In some embodiments, the disclosure provides the rubber compositions and/or tires described in U.S. Pat. No. 10,920,046, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 41.

TABLE 41

| | Composition A | Composition T |
|---|---|---|
| Polymer A | 100 | — |
| SBR | — | 100 |
| Carbon black (1) | 1 | 1 |
| Silica (2) | 67 | 67 |
| Resin (3) | 31 | 31 |
| Antioxidant (4) | 3 | 3 |
| Paraffin | 1 | 1 |
| Trimethoxy(octyl)silane | 5.4 | 5.4 |
| Diphenylguanidine | 2.5 | 2.5 |
| Stearin (5) | 3 | 3 |
| ZnO (6) | 0.9 | 0.9 |
| Sulfur | 1 | 1 |
| Accelerator (5) | 2.3 | 2.3 |

(1) N234
(2) Micropearl silica with a specific surface area of 160 m²/g
(3) Hydrogenated C9 dicyclopentadiene resin E5600 BR, Exxon Mobil
(4) Compound of the Disclosure, e.g., a compound of Tables A-J
(5) Stearin (Pristerene 4931 - Uniqema)
(6) Zinc oxide (industrial grade - Umicore)
(7) N-Cyclohexyl-2-benzothiazolesulfenamide (Santocure CBS from Flexys)

In some embodiments, the disclosure provides a rubber composition comprising a reinforcing filler, a Compound of the Disclosure, e.g., a compound of Tables A-J, and an elastomer, the elastomer comprising units of a 1,3-diene monomer and bearing carbonate functions, each present in a 1,3-dioxolan-2-one ring.

In some embodiments, the disclosure provides the rubber compositions and/or tires described in U.S. Pat. No. 10,889,147, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 42 and Table 43.

TABLE 42

| | Mn (g/mol) | Mz (g/mol) | PI |
|---|---|---|---|
| Resin 1 (1) | 1830 | 7200 | 2.1 |
| Resin 2 (2) | 1344 | 8835 | 2.6 |
| Resin 3 (3) | 895 | 4228 | 2 |
| Resin 4 (4) | 586 | 5200 | 3 |
| Resin 5 (5) | 341 | 597 | 1.3 |
| Resin 6 (6) | 1370 | 7250 | 2.3 |
| Resin 7 (7) | 901 | 7076 | 2.6 |

(1) Resin 1: R 7578 P from SI group
(2) Resin 2: PICCOTAC 1105-E from Eastman
(3) Resin 3: HIKOREZ A-1100 from Kolon
(4) Resin 4: NOVARES TD 120 from Rutgers
(5) Resin 5: NOVARES TL 10 from Rutgers
(6) Resin 6: ESCOREZ 1102 type 1 from Exxon
(7) Resin 7: ESCOREZ 1102 type 2 from Exxon

TABLE 43

| | C1 | C2 | C3 | C4 | C5 | C6 | C7 | C8 |
|---|---|---|---|---|---|---|---|---|
| NR (1) | 25 | 25 | 25 | 25 | 25 | 25 | 25 | 25 |
| BR (2) | 75 | 75 | 75 | 75 | 75 | 75 | 75 | 75 |
| Carbon | 65 | 65 | 65 | 65 | 65 | 65 | 65 | 65 |
| black (3) | | | | | | | | |
| Resin 1 (4) | — | 5 | — | — | — | — | — | — |
| Resin 2 (5) | — | — | 5 | — | — | — | — | — |
| Resin 3 (6) | — | — | — | 5 | — | — | — | — |
| Resin 4 (7) | — | — | — | — | 5 | — | — | — |
| Resin 5 (8) | — | — | — | — | — | 5 | — | — |
| Resin 6 (9) | — | — | — | — | — | — | 5 | — |
| Resin 7 (10) | — | — | — | — | — | — | — | 5 |
| Antioxidant | 2.5 | 2.5 | 2.5 | 2.5 | 2.5 | 2.5 | 2.5 | 2.5 |
| (11) | | | | | | | | |
| Stearic | 3 | 3 | 3 | 3 | 3 | 3 | 3 | 3 |
| acid (12) | | | | | | | | |
| ZnO (13) | 4 | 4 | 4 | 4 | 4 | 4 | 4 | 4 |
| Accelerator | 1.6 | 1.6 | 1.6 | 1.6 | 1.6 | 1.6 | 1.6 | 1.6 |
| (14) | | | | | | | | |
| Soluble | 0.8 | 0.8 | 0.8 | 0.8 | 0.8 | 0.8 | 0.8 | 0.8 |
| sulphur | | | | | | | | |

(1) NR: Natural rubber
(2) BR: polybutadiene
(3) Carbon black Grade ASTM N375 (Cabot)
(4) Resin 1: R 7578 P from SI group
(5) Resin 2: PICCOTAC 1105-E from Eastman
(6) Resin 3: HIKOREZ A-1100 from Kolon
(7) Resin 4: NOVARES TD 120 from Rutgers
(8) Resin 5: NOVARES TL 10 from Rutgers
(9) Resin 6: ESCOREZ 1102 type 1 from Exxon
(10) Resin 7: ESCOREZ 1102 type 2 from Exxon
(11) Compound of the Disclosure, e.g., a compound of Tables A-J and antiozone wax
(12) Stearin, Pristerene 4931 from Uniqema
(13) Zinc oxide, industrial grade - Umicore
(14) N-Cyclohexy1-2-benzothiazolesulphenamide (Santocure CBS from Flexsys)

In some embodiments, the disclosure provides a rubber composition comprising at least one diene elastomer, a reinforcing filler, a crosslinking system, a Compound of the Disclosure, e.g., a compound of Tables A-J, and an aliphatic hydrocarbon-based resin, wherein the aliphatic hydrocarbon-based resin has a number-average molecular weight Mn of between 700 and 1000 g/mol, an average molecular weight Mz of between 6000 and 8000 g/mol and a polydispersity index PI of greater than 2.4.

In some embodiments, the disclosure provides a tire comprising the rubber composition.

In some embodiments, the disclosure provides the rubber compositions and/or tires described in U.S. Pat. No. 10,875,990, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the compositions of Tables 44-49.

TABLE 44
Formulations and Properties

| Formulations | F1 | F2 | F3 | F4 | F5 |
|---|---|---|---|---|---|
| eBR 5 mol % | 100 | | | 100 | |
| eBR 12.5 mol % | | 100 | 100 | | 100 |
| N234 | 6.56 | 8.56 | 8.56 | 97 | 97 |
| Sil160 | 104 | 100 | 100 | | |
| Si69 coupling agent | 8.32 | 8 | 8 | | |
| C30 | 22 | | | 4 | 16 |
| TP2040 | 51 | | 63 | | |
| Dertophene H150 | | 73 | | | |
| TP2019 | | | | 64 | 67 |
| HTO | | | 10 | | |
| Compound of the | 2 | 1.9 | 1.9 | 2 | 2 |
| Disclosure, e.g., a | | | | | |
| compound of Tables A- | | | | | |
| J | | | | | |
| Wax | 1.5 | 1.5 | 1.5 | 1.5 | 1.5 |
| DPG | 1.7 | 1.7 | 1.7 | | |
| SAD | 2 | 2 | 2 | 2 | 2 |
| ZnO | 1.5 | 1.5 | 1.5 | 1.5 | 1.5 |
| CBS | 3.86 | 3.86 | 3.86 | 1.5 | 1.5 |
| S | 0.83 | 0.83 | 0.83 | 1.5 | 1.5 |

TABLE 45

| Formulations | W1 | F6 |
|---|---|---|
| SBR | 100 | |
| eBR 12.5 mol % | | 100 |
| Carbon Black N234 | 4 | 4 |
| Sil160/165 | 110 | 110 |
| Si69 coupling agent | 11 | |
| Silol coupling agent | | 7.4 |
| High Tg Resin | 60 | 76 |
| Low Tg Resin | | 3 |
| HTO | 12 | 0 |
| Antidegradants Pkg | 8 | 8 |
| Cure Pkg | 9.5 | 11 |

TABLE 46
Formulations and Properties

| Formulations | W1 | F7 | F8A | F8B |
|---|---|---|---|---|
| BR | 43 | | 30 | |
| SBR | 57 | | | 30 |
| eBR 5 mol % | | 100 | 70 | 70 |
| Carbon black N234 | 7 | 7 | 7 | 7 |
| Sil160 | 104 | 104 | 104 | 104 |
| Si69 coupling agent | 8 | 8 | 8 | 8 |
| High Tg Resin | 41 | 68 | 64 | 33 |
| Low Tg Resin | | 10 | 15 | 42 |
| HTO | 16 | 0 | 0 | 0 |
| Antidegradants Pkg | 5 | 3.5 | 3.5 | 3.5 |
| Cure Pkg | 8.5 | 10 | 10 | 10 |

TABLE 47
Base Rubber Composition

| Formulations | Base |
|---|---|
| Rubber* | 100 |
| Carbon Black | 7 |
| Sil160 | 104 |
| Si69 coupling agent | 8.3 |
| Resin | 73/80 |
| Antidegradants Pkg | 3.5 |
| Cure Pkg | 16 |

*See Table 5

TABLE 48
Rubber Formulations Properties 5% eBR

| | Formulations | | | | | | | |
|---|---|---|---|---|---|---|---|---|
| | F9 | F10 | F11 | F12 | F13 | F14 | F15 | F16 |
| eBR 5 mol % | 100 | 67 | 50 | 33 | 100 | 67 | 50 | 33 |
| BR | 0 | 33 | 50 | 67 | 0 | 0 | 0 | 0 |
| SBR | 0 | 0 | 0 | 0 | 0 | 33 | 50 | 67 |
| TP Resin | 73 | 73 | 73 | 73 | 73 | 73 | 73 | 73 |
| TP2019 | | | | | | | | |

TABLE 49
Rubber Formulations Properties 12.5% eBR

| | Formulations | | | | | | |
|---|---|---|---|---|---|---|---|
| | F17 | F18 | F19 | F20 | F21 | F22 | F23 |
| eBR 12.5 mol % | 100 | 67 | 50 | 33 | 25 | 15 | 7 |
| BR | 0 | 33 | 50 | 67 | 75 | 85 | 93 |
| TP Resin TP115 | 80 | 80 | 80 | 80 | 80 | 80 | 80 |

In some embodiments, the disclosure provides a tire comprising a tire component, the tire component comprising a rubber composition that is based upon a cross-linkable elastomer composition, the cross-linkable elastomer composition comprising, per 100 parts by weight of rubber (phr): a modified rubber component selected from a modified polybutadiene rubber, a modified styrene-butadiene rubber or combinations thereof, wherein the modified rubber component has been modified with a functional group having a hydrogen bond acceptor atom, the functional group selected from the group consisting of a pyridine, a pyrrolidone, an ether, a ketone, a sulfone and an epoxide and wherein the modified rubber component has a Tg of between −80° C. and −110° C.; between 10 phr and 75 phr of a second rubber component selected from the group consisting of a polybutadiene rubber (BR), a styrene-butadiene rubber (SBR) and combinations thereof; between 30 phr and 130 phr of an efficient plasticizing resin, wherein the efficient plasticizing resin is, when included in a mixture consisting of the modified rubber component and 67 phr of the efficient plasticizing resin, causes a Tg of the mixture to be at least 14° C. higher than the Tg of the modified rubber component and wherein the efficient plasticizing resin has a hydrogen bond donor group; a reinforcement filler; a Compound of the Disclosure, e.g., a compound of Tables A-J, and a curing system.

In some embodiments, the disclosure provides the rubber compositions and/or tires described in U.S. Pat. No. 10,836,886, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Tables 50-53.

TABLE 50

| | T1 | T2 | T3 | C1 |
|---|---|---|---|---|
| SBR (1) | 80 | 80 | 80 | 80 |
| BR (2) | 20 | 20 | 20 | 20 |
| Carbon black (3) | 4 | 4 | 4 | 4 |
| Silica with CTAB of about 160 m²/g (4) | 90 | 90 | 0 | 0 |
| Silica with CTAB of about 200 m²/g (5) | 0 | 0 | 90 | 90 |
| High-Tg plasticizing resin (6) | 45 | 13 | 45 | 13 |
| Low-Tg plasticizing resin (7) | 0 | 32 | 0 | 32 |
| Plasticizing vegetable oil (8) | 10 | 10 | 10 | 10 |
| Coupling agent (9) | 7.2 | 7.2 | 7.2 | 7.2 |
| Wax | 2 | 2 | 2 | 2 |
| Antioxidant (10) | 2 | 2 | 2 | 2 |
| Stearic acid | 3 | 3 | 3 | 3 |
| Accelerator (11) | 4 | 4 | 4 | 4 |
| Activator (12) | 2 | 2 | 2 | 2 |
| Sulphur | 1 | 1 | 1 | 1 |
| ZnO | 1.2 | 1.2 | 1.2 | 1.2 |

TABLE 51

| | T4 | T5 | T6 | C2 |
|---|---|---|---|---|
| SBR (1) | 100 | 100 | 100 | 100 |
| Carbon black (3) | 4 | 4 | 4 | 4 |
| Silica with BET of about 160 m²/g (4) | 50 | 50 | 0 | 0 |
| Silica with BET of about 200 m²/g (5) | 0 | 0 | 50 | 50 |
| High-Tg plasticizing resin (6) | 30 | 0 | 30 | 0 |
| Low-Tg plasticizing resin (7) | 0 | 30 | 0 | 30 |
| Coupling agent (9) | 4 | 4 | 4 | 4 |
| Wax | 2 | 2 | 2 | 2 |
| Antioxidant (10) | 2 | 2 | 2 | 2 |
| Stearic acid | 3 | 3 | 3 | 3 |
| Accelerator (11) | 4 | 4 | 4 | 4 |
| Activator (12) | 2 | 2 | 2 | 2 |
| Sulphur | 1 | 1 | 1 | 1 |
| ZnO | 1.2 | 1.2 | 1.2 | 1.2 |

TABLE 52

| | T7 | T8 | T9 | C3 |
|---|---|---|---|---|
| SBR (1) | 100 | 100 | 100 | 100 |
| Carbon black (3) | 4 | 4 | 4 | 4 |
| Silica with BET of about 160 m²/g (4) | 140 | 140 | 0 | 0 |
| Silica with BET of about 200 m²/g (5) | 0 | 0 | 140 | 140 |
| High-Tg plasticizing resin (6) | 65 | 10 | 65 | 10 |
| Low-Tg plasticizing resin (7) | 0 | 80 | 0 | 80 |
| Plasticizing vegetable oil (8) | 25 | 0 | 25 | 0 |
| Coupling agent (9) | 11.2 | 11.2 | 11.2 | 11.2 |
| Wax | 2 | 2 | 2 | 2 |
| Antioxidant (10) | 2 | 2 | 2 | 2 |
| Stearic acid | 3 | 3 | 3 | 3 |
| Accelerator (11) | 4 | 4 | 4 | 4 |
| Activator (12) | 2 | 2 | 2 | 2 |
| Sulphur | 1 | 1 | 1 | 1 |
| ZnO | 1.2 | 1.2 | 1.2 | 1.2 |

TABLE 53

| | T10 | T11 | T12 | C4 |
|---|---|---|---|---|
| SBR (1) | 100 | 100 | 100 | 100 |
| Carbon black (3) | 4 | 4 | 4 | 4 |
| Silica with BET of about 160 m²/g (4) | 90 | 90 | 0 | 0 |
| Silica with BET of about 200 m²/g (5) | 0 | 0 | 90 | 90 |
| High-Tg plasticizing resin (6) | 45 | 13 | 45 | 13 |
| Low-Tg plasticizing resin (7) | 0 | 32 | 0 | 32 |
| Plasticizing vegetable oil (8) | 10 | 10 | 10 | 10 |
| Coupling agent (9) | 7.2 | 7.2 | 7.2 | 7.2 |
| Wax | 2 | 2 | 2 | 2 |
| Antioxidant (10) | 2 | 2 | 2 | 2 |
| Stearic acid | 3 | 3 | 3 | 3 |
| Accelerator (11) | 4 | 4 | 4 | 4 |
| Activator (12) | 2 | 2 | 2 | 2 |
| Sulphur | 1 | 1 | 1 | 1 |
| ZnO | 1.2 | 1.2 | 1.2 | 1.2 |

In Tables 50-53 (from U.S. Pat. No. 10,836,886), the components of the compositions referenced 1 to 12 represent the following components:
(1) SBR with 26% of styrene unit and 24% of 1,2 unit of the butadiene moiety (Tg=−48° C.);
(2) BR: polybutadiene with 0.5% of 1-2 unit; 1.2% of trans 1~4 unit; 98.3% of cis 1-4 unit (Tg=−108° C.);
(3) ASTM N234 grade (Cabot);
(4) “Zeosil 1165 MP” silica from Solvay, “HDS” type;
(5) “Zeosil Premium 200 MP” silica from Solvay;
(6) High-Tg hydrocarbon resin, of C5/C9 cut “Wingtack STS” from Cray Valley;
(7) Low-Tg hydrocarbon resin “Novares C30” from Rutgers Chemical;
(8) Glycerol trioleate, sunflower oil with 85 wt % oleic acid “Lubrirob Tod 1880” from Novance;
(9) Coupling agent: “Si69” from Evonik-Degussa;
(10) a Compound of the Disclosure, e.g., a compound of Tables A-J, and Anti-ozone wax;
(11) N-cyclohexyl-2-benzothiazole-sulphenamide (“Santocure CBS” from Flexsys); and
(12) Diphenylguanidine “Perkacit DPG” from Flexsys.

In some embodiments, the disclosure provides a rubber composition based on at least: one diene elastomer; a reinforcing filler; a vulcanizing system; a Compound of the Disclosure, e.g., a compound of Tables A-J, and a plasticizing system, wherein the reinforcing filler predominantly comprises, by weight, a silica with a cetyltrimethyl ammonium bromide (CTAB) specific surface area greater than or equal to 170 m²/g, and wherein the plasticizing system comprises 25 phr to 90 phr of a hydrocarbon resin having a glass transition temperature Tg between −20° C. and 0° C. and 5 phr to 80 phr of a hydrocarbon resin having a glass transition temperature Tg greater than 20° C., phr being parts by weight per hundred parts by weight of elastomer.

In some embodiments, the disclosure provides a tire comprising the rubber composition.

In some embodiments, the disclosure provides the rubber compositions and/or tires described in U.S. Pat. No. 10,808,105, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 54.

TABLE 54

| Compositions | I1 | I2 | I3 | C1 | C2 | C3 | C4 | C5 | C6 | C7 | C8 |
|---|---|---|---|---|---|---|---|---|---|---|---|
| SBR (1) | 100.0 | 100.0 | 100.0 | 100.0 | — | 100.0 | 100.0 | 100.0 | 100.0 | 100.0 | 100.0 |
| SBR (2) | — | — | — | — | 100.0 | — | — | — | — | — | — |
| Carbon black (3) | 3.0 | 3.0 | 3.0 | 3.0 | 3.0 | 3.0 | 3.0 | 3.0 | 3.0 | 3.0 | 3.0 |
| Silica (4) | 87.0 | 57.0 | 107.0 | 87.0 | 87.0 | 87.0 | 87.0 | 87.0 | 87.0 | 42.0 | 107.0 |
| Total content of | 90.0 | 60.0 | 110.0 | 90.0 | 90.0 | 90.0 | 90.0 | 90.0 | 90.0 | 45.0 | 110.0 |
| filler | | | | | | | | | | | |
| Low-Tg resin (5) | 32.5 | 14.5 | 35.0 | — | 32.5 | 11.0 | 8.0 | 3.0 | 56.5 | 32.5 | 12.0 |
| High-Tg resin (6) | 13.5 | 10.5 | 15.0 | 36.0 | 13.5 | 11.0 | 38.0 | 43.0 | 13.5 | 13.5 | 11.0 |
| Plasticizing oil (7) | — | — | 10.0 | 8.0 | — | — | — | — | — | — | — |
| Total content of | 46.0 | 25.0 | 60.0 | 44.0 | 46.0 | 22.0 | 46.0 | 46.0 | 70.0 | 46.0 | 23.0 |
| plasticizer | | | | | | | | | | | |
| Filler/Plasticizer | 2.0 | 2.4 | 1.8 | 2.0 | 2.0 | 4.1 | 2.0 | 2.0 | 1.3 | 1.0 | 5.2 |
| Coupling agent (8) | 7.0 | 4.6 | 8.5 | 7.0 | 7.0 | 7.0 | 7.0 | 7.0 | 7.0 | 3.4 | 9.4 |
| Antioxidants (9) | 6.5 | 6.5 | 6.5 | 6.5 | 6.5 | 6.5 | 6.5 | 6.5 | 6.5 | 6.5 | 6.5 |
| Stearic acid (10) | 3.0 | 3.0 | 3.0 | 3.0 | 3.0 | 3.0 | 3.0 | 3.0 | 3.0 | 3.0 | 3.0 |
| DPG (11) | 1.8 | 1.6 | 2.1 | 1.8 | 1.8 | 1.8 | 1.8 | 1.8 | 1.8 | 1.6 | 2.3 |
| ZnO (12) | 0.9 | 0.9 | 0.9 | 0.9 | 0.9 | 0.9 | 0.9 | 0.9 | 0.9 | 0.9 | 0.9 |
| Accelerator (13) | 2.3 | 2.3 | 2.3 | 2.3 | 2.3 | 2.3 | 2.3 | 2.3 | 2.3 | 2.3 | 2.3 |
| Sulfur | 1.0 | 1.0 | 1.0 | 1.0 | 1.0 | 1.0 | 1.0 | 1.0 | 1.0 | 1.0 | 1.0 |

(1) SBR (Sn star-branched) with 26% of styrene units and 24% of 1,2-units of the butadiene part (Tg = −48° C.) silanol functional group at the chain end
(2) SBR (Sn star-branched) with 44% of styrene units and 41% of 1,2-units of the butadiene part (Tg = −12° C.) silanol at the chain end
(3) ASTM grade N234 (Cabot)
(4) Silica, Zeosil 1165 MP from Rhodia, “HDS” type
(5) Low-Tg hydrocarbon resin, Hikotack LP-9800 from Kolon
(6) High-Tg C₉/DCPD hydrocarbon resin, Escorez 5600 from Exxon (Tg = 55° C.)
(7) Glycerol trioleate, sunflower oil comprising 85% by weight of oleic acid, Lubrirob Tod 1880 from Novance
(8) Coupling agent: TESPT (Si69 from Evonik-Degussa)
(9) Compound of the Disclosure, e.g., a compound of Tables A-J, 2,2,4-trimethyl-1,2-dihydroquinoline (TMQ), and antiozone wax
(10) Stearin, Pristerene 4931 from Uniqema
(11) Diphenylguanidine, Perkacit DPG from Flexsys
(12) Zinc oxide, industrial grade from Umicore
(13) N-Cyclohexy1-2-benzothiazolesulfenamide (Santocure CBS from Flexsys)

In some embodiments, the disclosure provides a rubber composition based on a composition comprising: a diene elastomer with a glass transition temperature Tg of less than −40° C.; a reinforcing filler at a content within a range extending from 60 to 110 phr; a vulcanization system; Compound of the Disclosure, e.g., a compound of Tables A-J, and a combination of plasticizers, wherein the combination of plasticizers comprises more than 10 phr of a hydrocarbon resin with a glass transition temperature Tg of between −40° C. and 0° C. and a supplementary plasticizer selected from the group consisting of plasticizing oils, hydrocarbon resins with a glass transition temperature Tg of greater than 20° C. and mixtures thereof, the total content of plasticizers being within a range extending from 25 to 65 phr, wherein the contents of reinforcing filler and of plasticizers are such that the ratio of the total content of reinforcing filler to the total content of plasticizers is within a range extending from 1.8 to 2.5, and wherein the diene elastomer is a random copolymer of butadiene and styrene (SBR) at a content of 100 phr, phr being parts by weight per hundred parts by weight of elastomer.

In some embodiments, the disclosure provides a tire comprising the rubber composition.

In some embodiments, the disclosure provides the rubber compositions and/or tires described in U.S. Pat. No. 10,781,299, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 55.

TABLE 55

| | T1 | T2 | C1 | T4 | T3 | C2 |
|---|---|---|---|---|---|---|
| SBR (1) | 100 | 100 | 100 | 100 | 100 | 100 |
| Carbon black (2) | 3 | 3 | 3 | 3 | 3 | 3 |
| Silica (3) | 105 | 105 | 105 | 105 | 105 | 105 |
| High-Tg resin (4) | 34 | 0 | 0 | 20.75 | 20.75 | 20.75 |
| Low-Tg resin (5) | 0 | 41.5 | 41.5 | 20.75 | 20.75 | 20.75 |
| Oil (6) | 12 | 12 | 12 | 12 | 12 | 12 |
| Coupling agent 1 (7) | 0 | 8.4 | 0 | 8.4 | 0 | 0 |
| Coupling agent 2 (8) | 6.2 | 0 | 6.2 | 0 | 6.2 | 6.2 |
| DPG (9) | 0 | 0 | 0 | 1.9 | 1.9 | 0 |
| Octadecylamine | 2.2 | 2.2 | 2.2 | 0 | 0 | 2.2 |
| Antioxidant (10) | 3 | 3 | 3 | 3 | 3 | 3 |
| Antiozone wax | 2 | 2 | 2 | 2 | 2 | 2 |
| Stearic acid | 3 | 3 | 3 | 3 | 3 | 3 |
| Sulfur | 1 | 1 | 1 | 1 | 1 | 1 |
| Accelerator (11) | 2 | 2 | 2 | 2 | 2 | 2 |

(1) SBR solution with 26.5% of styrene units and 50% of 1,2- units of the butadiene part (Tg = −48° C.);
(2) N234 ASTM grade (Cabot)
(3) “Zeosil 1165 MP” silica from Rhodia, “HDS” type
(4) “Escorez 5600” high-Tg C₉/DCPD hydrocarbon resin from Exxon
(5) “Novares C30” low-Tg hydrocarbon resin from Rutgers Chemical
(6) “Lubrirob Tod 1880” glycerol trioleate, sunflower oil comprising 85% by weight of oleic acid from Novance
(7) Coupling agent 1: TESPT (“Si69” from Evonik-Degussa)
(8) Coupling agent 2: bis(propyldimethylsilanol) polysulfide as described in document WO 02/31041 (or US 2004/051210)
(9) “Perkacit DPG” diphenylguanidine from Flexsys
(10) Compound of the Disclosure, e.g., a compound of Tables A-J
(11) N-Cyclohexyl-2-benzothiazolesulfenamide (Santocure CBS from Flexsys)

In some embodiments, the disclosure provides a rubber composition based on at least: a diene elastomer; 50 to 160 phr of inorganic reinforcing filler, phr being parts by weight per hundred parts by weight of elastomer; a vulcanization system; Compound of the Disclosure, e.g., a compound of Tables A-J; a plasticizing system comprising at least one hydrocarbon resin with a glass transition temperature Tg of between −40° C. and 0° C.; a hydroxysilane polysulfide coupling agent having general formula (I) of U.S. Pat. No. 10,781,299:

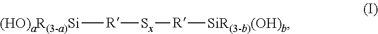

in which the R radicals, which are identical or different, are hydrocarbon groups; the R′ radicals, which are identical or different, are divalent connecting groups; a and b, which are identical or different, are equal to 1 or 2; and x is a number greater than or equal to 2; and a primary amine having general formula (IV) of U.S. Pat. No. 10,781,299:

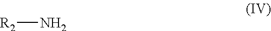

in which R represents a linear or branched hydrocarbon group comprising from 8 to 24 carbon atoms, wherein the rubber composition is devoid of or comprises less than 0.5 phr of guanidine derivative, and wherein the at least one hydrocarbon resin is viscous at 20° C., has a number-average molecular weight (Mn) of less than 400 g/mol, and has a softening point within a range extending from 10° C. to 30° C.

In some embodiments, the disclosure provides the rubber compositions disclosed in Table 56.

TABLE 56

| U.S. Pat. No. | Composition(s) Incorporated by Reference* |
|---|---|
| 11,390,117 | C-1 and C-2 in Table 11 of column 15 |
| 11,370,866 | C1, C2, and C3 in Table 2 of column 10 and Example II.2 of column 7 |
| 11,155,665 | The compositions in Example 1 of column 14 |
| 11,104,755 | C and I in Table 4 of column 17 |
| 10,780,740 | A-O, A-1, A-2, A-3, and A-4 in Table 1 of column 18 |
| 10,773,552 | B and C in Table 1 of column 10 |
| 10,737,532 | C-1, C-2, and C-3 in Table 1 of column 19 |
| | C(a) and C(b) in Table 3 of column 20 |
| 10,662,582 | 1, 2, 3, 4, 5, and 6 in Table 1 of column 12 |
| 10,654,317 | B and C in Table 1 of column 16 |
| RE47,886 | C1, C2, C3, C4, C5, and C6 in Table 1 of column 12 |
| | C7, C8, C9, C10, C11, and C12 in Table 3 of column 12 |
| | C13 and C14 in Table 5 of column 13 |
| 10,519,299 | the base formulation in the table in column 18 |
| | CA1, CA2, CA3, CA4, and CA5 in Table 1 of column 18 |
| 10,457,793 | C1, C2, C3, C4, C5, and C6 in Table 1 of column 18 |
| | C7, C8, C9, C10, and C11 in Table 3 of column 19 |
| 10,435,544 | C1, C2, C3, C4, C5, C6, C7, and C8 in Table 1 of column 16 |
| | C1, C2, C3, C4, C5, C6, C7, and C8 in Table 3 of column 18 |
| | C1, C2, C3, C4, C5, C6, C7, and C8 in Table 5 of columns 18-19 |
| 10,427,476 | C1 in Table 1 of columns 12-13 |
| 10,414,132 | A, B, C1, and C2 in Table 1 of columns 16-17 |
| 10,378,148 | Invention composition in Table 1 of column 14 |
| 10,369,842 | A-1, A-2, A-3, A-4, and A-5 in Table 1 of columns 15-16 |
| 10,364,335 | P, P1, P2, P3, Q, and Q1 in Table 1 of column 11 |
| | C1, C2, C3, M1, M2, M3, M4, M5, M6, M7, M8, and M9 in Table 2 of column |
| | 13 |
| 10,357,998 | A, B, C, and D in Table 1 of columns 9-10 |
| 10,246,577 | T1, T2, T3, T4, T5, T6, T7, C1, C2, C3, and C4 in Table 1 of column 12 |
| | T1, T8, T9, T10, C5, and C6 in Table 3 of column 13 |
| 10,239,971 | Composition according to the invention 1 and 2 in Table 9 of column 19 |
| | Composition according to the invention B in the table of columns 20-21 |
| 10,227,475 | C-1, C-2, and C-3 in Table 1 of column 18 |
| | C-4 and C-5 in Table 3 of column 19 |
| 10,214,638 | C1, C2, C□2, C3, C□3, C4, C□4, C5, and C□5, in Table 1 of column 11 |
| | C6, C7, C□7, C8, C□8, C9, C□9, C10, and C□10, in Table 3 of column 12 |
| 10,173,468 | C-1, C-2, C3, and C-4 in Table 1 of column 19 |
| | C(a), C(b), and C(c) in Table 3 of columns 20-21 |
| 10,131,105 | ME1 and ME2 in Table 2 of column 8 |
| 10,059,833 | the base formulation in the table in column 18 |
| | TM1, CA1, CA2, CA3, CA4, and CA5 in Table 1 of column 18 |
| 10,035,904 | C1, C2, C3, C4, C5, C6, C7, and C8 in Table 1 of column 12 |
| 9,987,884 | BR1, BR2, BR3, BR-T, SC, SC-T in Table 2 of column 7 |
| 9,962,996 | ME1 and ME2 in Table 2 of column 24 |
| 9,944,777 | C1, C2, C3, C4, F2, M1, and M2 in Table 1 of column 11 |
| 9,822,247 | C1, C2, C3, C4, C5, C6, C7, and C8 in Table 1 of column 16 |
| | C1, C2, C3, C4, C5, C6, C7, and C8 in Table 3 of columns 17-18 |
| | C1, C2, C3, C4, C5, C6, C7, and C8 in Table 1 of columns 18-19 |
| 9,751,992 | the base formulation in the table in columns 16-17 |
| | CC1, CRC1, CRC2, CRC3, and CRC4 in Table 1 of column 17 |
| 9,714,339 | C1, C2, C3, C4, C5, C6, C7, C8, C9, and C10 in Table 1 of column 26 |
| 9,663,633 | C1, C2, and C3 in Table 1 of columns 16-17 |
| | C4, C5, and C6 in Table 1 of columns 18-19 |
| 9,636,950 | Mixture R1, Mixture R2, Mixture 1, Mixture 2, Mixture 3, Mixture 4, and |
| | Mixture 5 in the table of columns 19-20 |
| 9,598,560 | Cmp1, Cmp2, Cmp3, Cmp4, Cmp5, Cmp6, Cmp7, Cmp8, Cmp9, Cmp10, |
| | Cmp11, and Cmp12 in Table 6 of column 10 |
| 9,522,571 | C-1 and C-2 in Table 1 of column 18 |
| 9,505,917 | C.1, C.2, C.3, and C.4 in Table 1 of column 15 |
| 9,499,730 | the base formulation in the table in column 14 |
| | A1 and B1 in Table 1 of column 14 |
| | B2 and C2 in Table 3 of column 15 |
| 9,428,011 | invention composition in Table 1 of columns 12-13 |
| 9,416,259 | C1, C2, C3, C4, C5, and C6 in Table 1 of columns 11-12 |
| | C7, C8, C9, C10, C11, and C12 in Table 3 of column 12 |
| | C13 and C14 in Table 5 of columns 12-13 |
| 9,416,250 | 1, 2, 3, 4, 5, and 6 in Table 1 of column 5 |
| 9,413,061 | Composition of the layer 34 in Table 1 of columns 5-6 |
| 9,403,406 | A-1, A-2, and A-3 in Table 1 of column 14 |
| 9,309,386 | F1, F2, F3, F4, F5, F6, F7, F8, C1, and C2 in Table 1A of column 10 |
| | F9, F10, F11, F12, F13, F14, F15, C3, C4, and C5 in Table 1B of columns 10-11 |
| 9,267,014 | C-1 and C-2 in Table 1 of columns 17-18 |
| | C-3, C-4, and C-5 in Table 3 of column 19 |
| 9,260,588 | C-1 and C-2 in Table 1 of column 17 |
| | C-3 and C-4 in Table 3 of column 18 |

*wherein an antidegradant, e.g., an antioxidant, e.g., 6PPD, in each rubber composition is either partially or completely substituted with a Compound of the Disclosure, e.g., a compound of Tables A-J

In some embodiments, the disclosure provides the rubber compositions and/or tires described in U.S. Pat. No. 11,384,103, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions and/or tires described in U.S. Pat. No. 11,365,309, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 57.

TABLE 57

| Constituents | Unit | Vl | V2 | V3 | V4 | V5 | E1 | E2 | E3 |
|---|---|---|---|---|---|---|---|---|---|
| BR^{a} | phr | 20 | 20 | 20 | 20 | 20 | 20 | 20 | 20 |
| Polymer A | phr | 80 | — | 80 | — | — | — | — | — |
| Polymer A-1 | Phr | — | 80 | — | 80 | — | — | — | — |
| Blend V | phr | — | — | — | — | 104 | — | — | — |
| Blend E-1 | phr | — | — | — | — | — | 104 | — | — |
| Blend E-2 | phr | — | — | — | — | — | — | 104 | — |
| Blend E-3 | phr | — | — | — | — | — | — | — | 104 |
| N339 carbon black | phr | 9 | 9 | 9 | 9 | 9 | 9 | 9 | 9 |
| Silica^{e} | phr | 90 | 90 | 90 | 90 | 90 | 90 | 90 | 90 |
| Silane^{f} | phr | 6.5 | 6.5 | 6.5 | 6.5 | 6.5 | 6.5 | 6.5 | 6.5 |
| Polymer B-1 | phr | 24 | 24 | — | — | — | — | — | — |
| Polymer B | phr | — | — | 24 | 24 | — | — | — | — |
| ZnO | phr | 2 | 2 | 2 | 2 | 2 | 2 | 2 | 2 |
| Stabilizer/anti-ozonant/stearic acid^{j} | phr | 5 | 5 | 5 | 5 | 5 | 5 | 5 | 5 |
| Processing auxiliary^{k} | phr | 3 | 3 | 3 | 3 | 3 | 3 | 3 | 3 |
| DPG | phr | 2 | 2 | 2 | 2 | 2 | 2 | 2 | 2 |
| CBS | phr | 2.6 | 2.6 | 2.6 | 2.6 | 2.6 | 2.6 | 2.6 | 2.6 |
| Sulfur | phr | 2.1 | 2.1 | 2.1 | 2.1 | 2.1 | 2.1 | 2.1 | 2.1 |

^{a}BR with cis content greater than 80% by weight;
^{e}Zeosil 1165MP, from Rhodia (BET 149 m²/g, CTAB 154 m²/g);
^{f}STESPD Si261, from Evonik;
^{j}Aging stabilizers, for example a Compound of the Disclosure, e.g., a compound of Tables A-J, N,N′-diphenyl-p-phenylenediamine (DPPD), N,N′-ditolyl-p-phenylenediamine (DTPD), N-isopropyl-N′-pheny-p-phenylenediamine (IPPD), 2,2,4-trimethyl-l,2-dihydroquinoline (TMQ), N,N′-bis(1,4-dimethylpenty1)-p-phenylenediamine (77PD)
^{k}Alctiplast TS, from Rheinchemie

In some embodiments, the disclosure provides a rubber blend comprising: at least one solution-polymerized diene polymer A of high molecular weight, formed from at least one conjugated diene and one or more optional vinylaromatic compound(s), wherein the one or more optional vinylaromatic compound(s) has a vinylaromatic content of 0% to 50% by weight, a vinyl content of 8% to 80% by weight based on any diene content present, and wherein the at least one solution-polymerized diene polymer A has a glass transition temperature Tg according to DSC of −100. degree. C.<Tg<+20. degree. C., a molecular weight Mw according to GPC of more than 350 000 g/mol and a polydispersity PD of 1.1<PD<3; and at least one solution-polymerized polymer B of low molecular weight, formed from at least one conjugated diene, at least one conjugated diene and one or more vinylaromatic compound(s), or at least one or more vinylaromatic compound(s), wherein the one or more vinylaromatic compound(s) has a vinylaromatic content of 0% to 100% by weight, a vinyl content of 8% to 80% by weight based on any diene content present, and wherein the at least one solution-polymerized polymer B has a glass transition temperature Tg according to DSC of −100. degree. C.<Tg<+80. degree. C., a molecular weight Mw according to GPC of 1300 g/mol<Mw<10 000 g/mol and a polydispersity PD of 1<PD<1.5; wherein at least the solution-polymerized polymer B of low molecular weight has been functionalized at the chain end and/or along the polymer chain and/or at a coupling site with at least one group selected from epoxy groups, hydroxyl groups, carboxyl groups, amino groups, siloxane groups, organosilicon groups, phthalocyanine groups and amino group-containing alkoxysilyl groups; and, provided the rubber blend is free of high-cis butadiene rubber; and a Compound of the Disclosure, e.g., a compound of Tables A-J.

In some embodiments, the disclosure provides the rubber compositions and/or tires described in U.S. Pat. No. 11,326,028, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 58.

TABLE 58

| Constituents | Unit | Vl | E1 | E2 |
|---|---|---|---|---|
| NR (TSR) | phr | 60 | 47 | 35 |
| BR | phr | 10 | 10 | 10 |
| SSBR | phr | 30 | 30 | 30 |
| Carbon black | phr | 43 | 31 | 20 |
| NR-CNT MB ^{a)} | phr | — | 17.69 | 34.01 |
| Silica | phr | 16 | 16 | 16 |
| Silane ^{b)} | phr | 2.25 | 2.25 | 2.25 |
| Further additives ^{c)} | phr | 17.1 | 17.1 | 17.1 |
| Accelerator ^{d)} | phr | 1.7 | 1.7 | 1.7 |
| Sulfur | phr | 1.5 | 1.5 | 1.5 |

Substances of Table 58:
^{a)} NR-CNT masterbatch: CNT predispersed in NR: 67.3% by weight NR, 18.7% by weight CNT, 14% by weight resin acids; density 1.03 g/cm³
^{b)} Silane: TESPD + 3-mercaptopropyltriethoxysilane
^{c)} Further additives: processing aids: PEG carboxylic ester; hydrocarbon resin; aging stabilizer (Compound of the Disclosure, e.g., a compound of Tables A-J); antiozonant wax, zinc oxide; stearic acid
^{d)} Accelerator: DPG + CBS

In some embodiments, the disclosure provides the rubber compositions and/or tires described in U.S. Pat. No. 11,325,988, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 59.

TABLE 59

| Constituents | Unit | C1 | I1 |
|---|---|---|---|
| NR TSR | phr | 15 | 15 |
| BR ^{a)} | phr | 20 | 20 |
| SSBR ^{b)} | phr | 65 | 65 |
| Liq. polymer A* ^{c)} | phr | 20 | — |
| Liq. polymer A ^{d)} | phr | — | 20 |
| Carbon black N121 | phr | 8 | 8 |
| Silica ^{e)} | phr | 120 | 120 |
| Plasticizer ^{f)} | phr | 63 | 46 |
| Silane ^{g)} | phr | 12 | 12 |
| Additives ^{h)} | phr | 14 | 14 |

^{a)} High-cis Nd-BR
^{b)} SLR3402, Trinseo
^{c)} Liquid polybutadiene, but not inventive, possessing siloxane functionalization at both chain ends and therefore being labelled A*
^{d)} Polymer A: polybutadiene modified (terminally) at only a maximum of one chain end, modification as per formula I) of U.S. Pat. No. 11,325,988, with R¹, R² and R³ = ethoxy groups, X = divalent linear propyl group, Mw = 5400 g/mol, Mw/Mn = 1.05, vinyl fraction = 65 mol %, glass transition temperature = −50° C., degree of functionalization = 0.97; production as described below;
^{e)} Zeosol 1165 MP, Rhodia
^{f)} TDAE
^{g)} NXT, Momentive: 3-(Octanoylthio)-1-propyltriethoxysilane
^{h)} Zinc oxide, stearic acid, aging inhibitor (Compound of the Disclosure, e.g., a compound of Tables A-J), ozone protection wax Production of Polymer A used d)

In some embodiments, the disclosure provides a sulfur crosslinkable rubber mixture comprising at least the following ingredients: Compound of the Disclosure, e.g., a compound of Tables A-J, a natural polyisoprene rubber; at least one styrene-butadiene rubber which is not end group-modified; at least one polybutadiene rubber; and, at least one liquid linear modified polybutadiene polymer A, which is modified with a functional group according to formula (I) of U.S. Pat. No. 11,325,988 at only one chain end, wherein the number of functional groups per molecule is on average from 0.8 to less than 1, wherein some polymer chains of the at least one liquid linear modified polybutadiene polymer A are entirely unmodified, and wherein polybutadiene A of the at least one liquid linear modified polybutadiene polymer A is composed of 100 mol % of butadiene monomers: (R¹R²R³)Si—X—NH—C(═O)—O—; (1) wherein R¹, R² and R³ are independently selected from methoxy groups, ethoxy groups, phenoxy groups, methyl groups, ethyl groups and phenyl groups, wherein each at least one of the R¹, R² and R³ is a methoxy group, an ethoxy group or a phenoxy group, and wherein X is a divalent alkyl group with 1 to 6 carbon atoms; and, provided the at least one liquid linear modified polybutadiene polymer A is not a terminally amine-modified liquid polybutadiene.

In some embodiments, the disclosure provides the rubber compositions and/or tires described in U.S. Pat. No. 11,292,895, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 60.

TABLE 60

| Constituents | Unit | V1 | V2 | V3 | E1 | E2 | E3 |
|---|---|---|---|---|---|---|---|
| BR^{a} | phr | 20 | 20 | 20 | 20 | 20 | 20 |
| Blend V-1 | phr | 104 | — | — | — | — | — |
| Blend V-2 | phr | | 104 | — | — | — | — |
| Blend V-3 | phr | | — | 104 | — | — | — |
| Blend E-1 | phr | — | — | — | 104 | — | — |
| Blend E-2 | phr | — | — | — | — | 104 | — |
| Blend E-3 | phr | — | — | — | — | — | 104 |
| N339 carbon black | phr | 9 | 9 | 9 | 9 | 9 | 9 |
| Silica^{e} | phr | 90 | 90 | 90 | 90 | 90 | 90 |
| Silane^{f} | phr | 6.5 | 6.5 | 6.5 | 6.5 | 6.5 | 6.5 |
| ZnO | phr | 2 | 2 | 2 | 2 | 2 | 2 |
| Aging | phr | 5 | 5 | 5 | 5 | 5 | 5 |
| stabilizer/antiozonant/ | | | | | | | |
| stearic acid^{f} | | | | | | | |
| Processing auxiliary^{k} | phr | 3 | 3 | 3 | 3 | 3 | 3 |
| DPG | phr | 2 | 2 | 2 | 2 | 2 | 2 |
| CBS | phr | 2.6 | 2.6 | 2.6 | 2.6 | 2.6 | 2.6 |
| Sulfur | phr | 2.1 | 2.1 | 2.1 | 2.1 | 2.1 | 2.1 |

^{a}BR with cis content greater than 80% by weight;
^{e}Zeosil 1165MP, from Rhodia (BET 149 m²/g, CTAB 154 m²/g);
^{f}TESPD Si261, from Evonik;
^{j}Aging stabilizers, for example a Compound of the Disclosure, e.g., a compound of Tables A-J, N,N′-diphenyl-p-phenylenediamine (DPPD), N,N′-ditolyl-p-phenylenediamine (DTPD), N-isopropyl-N′-pheny-p-phenylenediamine (IPPD), 2,2,4-trimethyl-l,2-dihydroquinoline (TMQ), N,N′-bis(1,4-dimethylpentyl)-p-phenylenediamine (77PD)
^{k}Alctiplast TS, from Rheinchemie

In some embodiments, the disclosure provides a rubber blend comprising: at least one solution-polymerized diene polymer A of high molecular weight, formed from at least one conjugated diene and one or more optional vinylaromatic compound(s), having a vinylaromatic content of 0% to 50% by weight, a vinyl content of 8% to 80% by weight based on any diene content present, a glass transition temperature Tg according to DSC of −100. degree. C.<Tg<−35. degree. C., a molecular weight Mw according to GPC of more than 350000 g/mol, and a polydispersity PD of 1.1<PD<3; and Compound of the Disclosure, e.g., a compound of Tables A-J; and at least one solution-polymerized polymer B of low molecular weight, formed from at least one conjugated diene, at least one conjugated diene and one or more vinylaromatic compound(s), or at least one or more vinylaromatic compound(s), having a vinylaromatic content of 0% to 50% by weight, a vinyl content of 8% to 80% by weight based on any diene content present, a glass transition temperature Tg according to DSC of −50. degree. C.<Tg<+80. degree. C., a molecular weight Mw according to GPC of 1300 g/mol<Mw<10000 g/mol, and a polydispersity PD of 1<PD<1.5; wherein at least one of polymers A and B has been functionalized at the chain end and/or along the polymer chain and/or at a coupling site with at least one group selected from epoxy groups, hydroxyl groups, carboxyl groups, silane sulfide groups, amino groups, siloxane groups, organosilicon groups, phthalocyanine groups and amino group-containing alkoxysilyl groups.

In some embodiments, the disclosure provides the rubber compositions and/or tires described in U.S. Pat. No. 11,267,957, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 61.

TABLE 61

| Constituents | W1 | W2 | W3 | W4 | W5 | W6 | W7 | E1 | E2 |
|---|---|---|---|---|---|---|---|---|---|
| SSBR | 100 | 100 | 100 | 100 | 100 | 100 | 100 | 100 | 100 |
| Silica | 60 | 60 | 60 | 60 | 60 | 60 | 60 | 60 | 60 |
| Kristalex ® F-85 | 0 | 20 | 40 | 0 | 0 | 0 | 0 | 0 | 0 |
| Kristalex ® F100 | 0 | 0 | 0 | 20 | 40 | 0 | 0 | 0 | 0 |
| Kristalex ® F-115 | 0 | 0 | 0 | 0 | 0 | 20 | 40 | 0 | 0 |
| Modified Kristalex ® F- | 0 | 0 | 0 | 0 | 0 | 0 | 0 | 20 | 40 |
| 85 thermoplastic resin | | | | | | | | | |
| Compound of the | 2 | 2 | 2 | 2 | 2 | 2 | 2 | 2 | 2 |
| Disclosure, e.g., a | | | | | | | | | |
| compound of Tables A-J | | | | | | | | | |
| Ozone wax | 2 | 2 | 2 | 2 | 2 | 2 | 2 | 2 | 2 |
| ZnO | 2.5 | 2.5 | 2.5 | 2.5 | 2.5 | 2.5 | 2.5 | 2.5 | 2.5 |
| Stearic acid | 2.5 | 2.5 | 2.5 | 2.5 | 2.5 | 2.5 | 2.5 | 2.5 | 2.5 |
| TESPD | 4.3 | 4.3 | 4.3 | 4.3 | 4.3 | 4.3 | 4.3 | 4.3 | 4.3 |
| DPG | 1 | 1 | 1 | 1 | 1 | 1 | 1 | 1 | 1 |
| CBS | 2 | 2 | 2 | 2 | 2 | 2 | 2 | 2 | 2 |
| Sulfur | 2 | 2 | 2 | 2 | 2 | 2 | 2 | 2 | 2 |

In some embodiments, the disclosure provides a non-vulcanized composition, comprising: a polymer, a Compound of the Disclosure, e.g., a compound of Tables A-J, and a modified thermoplastic resin prepared by polymerization of one or more monomers, wherein the modified thermoplastic resin comprises less than or equal to 55 wt % oligomers by gel permeation chromatography (GPC), or less than or equal to 38 wt % by high resolution thermogravimetric analysis, wherein oligomers consist of dimers, trimers, tetramers, pentamers, or a mixture thereof, of the one or more monomers, wherein the modified thermoplastic resin is obtained by modification of pure monomer thermoplastic resin (PMR), C5 thermoplastic resin, C5/C9 thermoplastic resin, C9 thermoplastic resin, terpene thermoplastic resin, indene-coumarone (IC) thermoplastic resin, dicyclopentadiene (DCPD) thermoplastic resin, hydrogenated or partially hydrogenated pure monomer (PMR) thermoplastic resin, hydrogenated or partially hydrogenated C5 thermoplastic resin, hydrogenated or partially hydrogenated C5/C9 thermoplastic resin, hydrogenated or partially hydrogenated C9 thermoplastic resin, hydrogenated or partially hydrogenated dicyclopentadiene (DCPD) thermoplastic resin, terpene thermoplastic resin, modified indene-coumarone (IC) thermoplastic resin, or a mixture thereof, wherein oligomer is determined by GPC, and wherein: (a) when the modified thermoplastic resin is the PMR thermoplastic resin, then the value of Tg/Mz of the modified thermoplastic resin is greater than or equal to 0.14 K/(g/mol), and the percent of the modified thermoplastic resin having a molecular weight of less than 300 g/mol is less than or equal to 2.5, and the percent of the modified thermoplastic resin having a molecular weight of less than 600 g/mol is less than or equal to 19; (b) when the modified thermoplastic resin is the C5 thermoplastic resin, then the percent of the modified thermoplastic resin having a molecular weight of less than 300 g/mol is less than 3, and/or the percent of the modified thermoplastic resin having a molecular weight of less than 600 g/mol is less than 17; (c) when the modified thermoplastic resin is the C5/C9 thermoplastic resin, then the percent of the modified thermoplastic resin having a molecular weight of less than 300 g/mol is less than 3, and/or the percent of the modified thermoplastic resin having a molecular weight of less than 600 g/mol is less than 17; (d) when the modified thermoplastic resin is the C9 thermoplastic resin, then the value of Tg/Mz of the modified thermoplastic resin is greater than 0.09 K/(g/mol), the percent of the modified thermoplastic resin having a molecular weight of less than 300 g/mol is less than 5, and the percent of the modified thermoplastic resin having a molecular weight of less than 600 g/mol is less than 25; (e) when the modified thermoplastic resin is the hydrogenated or partially hydrogenated DCPD thermoplastic resin, then the value of Tg/Mz of the modified thermoplastic resin is greater than 0.25 K/(g/mol), and: (i) the percent modified thermoplastic resin having a molecular weight of less than 300 g/mol is less than 16, and/or (ii) the percent modified thermoplastic resin having a molecular weight of less than 600 g/mol is less than 55; (f) when the modified thermoplastic resin is the hydrogenated or partially hydrogenated C5 thermoplastic resin and/or the hydrogenated or partially hydrogenated C5/C9 thermoplastic resin, then the percent modified thermoplastic resin having a molecular weight of less than 300 g/mol is less than 15, and/or the percent modified thermoplastic resin having a molecular weight of less than 600 g/mol is less than 45; (g) the modified thermoplastic resin is the hydrogenated or partially hydrogenated C9 thermoplastic resin, then the value of Tg/Mz of the modified thermoplastic resin is greater than or equal to 0.19 K/(g/mol), the percent modified thermoplastic resin having a molecular weight of less than 300 g/mol is less than or equal to 10, and the percent modified thermoplastic resin having a molecular weight of less than 600 g/mol is less than 34; and (h) when the modified thermoplastic resin is the hydrogenated or the partially hydrogenated PMR thermoplastic resin, and: the value of Tg/Mz of the modified thermoplastic resin is greater than or equal to 0.30 K/(g/mol), then the percent modified thermoplastic resin having a molecular weight of less than 300 g/mol is less than 10, and/or the percent modified thermoplastic resin having a molecular weight of less than 600 g/mol is less than 45, or the value of Tg/Mz of the modified thermoplastic resin is less than 0.30 K/(g/mol), then the percent modified thermoplastic resin having a molecular weight of less than 300 g/mol is less than 10, and/or the percent modified thermoplastic resin having a molecular weight of less than 600 g/mol is less than 30.

In some embodiments, the disclosure provides a non-vulcanized composition, comprising: a polymer, a Compound of the Disclosure, e.g., a compound of Tables A-J, and a modified thermoplastic resin prepared by polymerization of one or more monomers, wherein the modified thermoplastic resin possesses the properties of formula I, see U.S. Pat. No. 11,267,957, wherein Tg is the glass transition temperature of the modified thermoplastic resin; wherein Mz is the z-average molecular weight of the modified thermoplastic resin; wherein Oligomer is the fraction of oligomer present in the modified thermoplastic resin as measured by high resolution thermal gravimetric analysis (TGA) or gel permeation chromatography (GPC); wherein T₁₀ is the temperature at which the modified thermoplastic resin loses about 10% of its weight as measured by thermal gravimetric analysis (TGA); wherein Tₘₐₓ is the temperature of the maximum first derivative value of the modified thermoplastic resin as measured by thermal gravimetric analysis (TGA); wherein oligomers consist of dimers, trimers, tetramer, and pentamer species of the one or more monomers; wherein the value of S is greater than or equal to 2 and less than 50,000 when Oligomer is determined by GPC, or greater than or equal to 5 and less than 10,000 when Oligomer is determined by high resolution TGA; wherein the value of Mz is less than or equal to 9,000 g/mol, wherein the modified thermoplastic resin is obtained by modification of pure monomer thermoplastic resin (PMR), C5 thermoplastic resin, C5/C9 thermoplastic resin, C9 thermoplastic resin, terpene thermoplastic resin, indene-coumarone (IC) thermoplastic resin, dicyclopentadiene (DCPD) thermoplastic resin, hydrogenated or partially hydrogenated pure monomer (PMR) thermoplastic resin, hydrogenated or partially hydrogenated C5 thermoplastic resin, hydrogenated or partially hydrogenated C5/C9 thermoplastic resin, hydrogenated or partially hydrogenated C9 thermoplastic resin, hydrogenated or partially hydrogenated dicyclopentadiene (DCPD) thermoplastic resin, terpene thermoplastic resin, modified indene-coumarone (IC) thermoplastic resin, or a mixture thereof, and wherein Oligomer is determined by high resolution TGA, and wherein: (a) when the modified thermoplastic resin is a PMR resin, then the value of Tg/Mz is greater than or equal to 0.14, and: the weight percent of oligomer is less than 17, and/or the value of T₁₀/Tₘₐₓ is greater than or equal to 0.90, and/or the value of S is greater than 12; (b) when the modified thermoplastic resin is C5 resin, then the weight percent of oligomer is less than 14, and/or the value of T₁₀/Tₘₐₓ is greater than or equal to 0.92, and/or the value of S is greater than or equal to 5; (c) when the modified thermoplastic resin is a C5/C9 resin, then the weight percent of oligomer is less than 15, and/or the value of T₁₀/Tₘₐₓ is greater than or equal to 0.92, and/or the value of S is greater than or equal to 10; (d) when the modified thermoplastic resin is a C9 resin, then the value of Tg/Mz is greater than or equal to 0.12, and: the weight percent of oligomer is less than or equal to 15, and/or the value of T₁₀/Tₘₐₓ is greater than or equal to 0.88, and/or the value of S is greater than or equal to 16; (e) when the modified thermoplastic resin is a hydrogenated or partially hydrogenated DCPD resin, then the value of Tg/Mz is greater than 0.25, and the weight percent of oligomer is less than 31, and/or the value of T₁₀/Tₘₐₓ is greater than 0.85, and/or the value of S is greater than or equal to 10; (f) when the modified thermoplastic resin is a hydrogenated or partially hydrogenated PMR resin, then the value of Tg/Mz is greater than or equal to 0.30, and: the weight percent of oligomer is less than or equal to 16, and/or the value of T₁₀/Tₘₐₓ is greater than 0.85, and/or the value of S is greater than or equal to 22; (g) when the modified thermoplastic resin is a hydrogenated or partially hydrogenated PMR resin, then the value of Tg/Mz is less than 0.30, and: the weight percent of oligomer is less than 38, and/or the value of T₁₀/Tₘₐₓ is greater than 0.75, and/or the value of S is greater than or equal to 5; (h) when the modified thermoplastic resin is a hydrogenated or partially hydrogenated C5 resin or a hydrogenated or partially hydrogenated C5/C9 resin, then the weight percent of oligomer is less than 30, and/or the value of T₁₀/Tₘₐₓ is greater than or equal to 0.90, and/or the value of S is greater than or equal to 10; or (i) when the modified thermoplastic resin is hydrogenated or partially hydrogenated C₉, where the value of Tg/Mz is greater than or equal to 0.19, then the weight percent of oligomer is less than or equal to 13, and/or the value of T₁₀/Tₘₐₓ is greater than 0.90, and/or the value of S is greater than or equal to 16.

In some embodiments, the disclosure provides the rubber compositions and/or tires described in U.S. Pat. No. 11,261,312, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 62.

TABLE 62

| Constituents | Unit | Vl | V2 | V3 | V4 | V5 | E1 | E2 | E3 |
|---|---|---|---|---|---|---|---|---|---|
| BR^{a} | phr | 20 | 20 | 20 | 20 | 20 | 20 | 20 | 20 |
| Blend V | phr | 104 | — | — | — | 104 | — | — | — |
| Blend E-1 | phr | — | 104 | — | — | — | 104 | — | — |
| Blend E-2 | phr | — | — | 104 | — | — | — | 104 | — |
| Blend E-3 | phr | — | — | — | 104 | — | — | — | 104 |
| N339 carbon black | phr | 9 | 9 | 9 | 9 | 9 | 9 | 9 | 9 |
| Silica^{e} | phr | 90 | 90 | 90 | 90 | 90 | 90 | 90 | 90 |
| Silane coupling | phr | 6.5 | 6.5 | 6.5 | 6.5 | — | — | — | — |
| agent ^{f} | | | | | | | | | |
| Silane coupling | phr | — | — | — | — | 7.2 | 7.2 | 7.2 | 7.2 |
| agent ^{g} | | | | | | | | | |
| ZnO | phr | 2 | 2 | 2 | 2 | 2 | 2 | 2 | 2 |
| Stabilizer/anti- | phr | 5 | 5 | 5 | 5 | 5 | 5 | 5 | 5 |
| ozonant/stearic acid^{j} | | | | | | | | | |
| Processing auxiliary^{k} | phr | 3 | 3 | 3 | 3 | 3 | 3 | 3 | 3 |
| DPG | phr | 2 | 2 | 2 | 2 | 2 | 2 | 2 | 2 |
| CBS | phr | 2.6 | 2.6 | 2.6 | 2.6 | 2.6 | 2.6 | 2.6 | 2.6 |
| Sulfur | phr | 2.1 | 2.1 | 2.1 | 2.1 | 1.4 | 1.4 | 1.4 | 1.4 |

^{a}BR with cis content greater than 80% by weight;
^{e}Zeosil 1165MP, from Rhodia (BET 149 m²/g, CTAB 154 m²/g);
^{f} TESPD Si261, from Evonik;
^{g} TESPT Si69, from Evonik;
^{j}Aging stabilizers, for example a Compound of the Disclosure, e.g., a compound of Tables A-J, N,N′-diphenyl-p-phenylenediamine (DPPD), N,N′-ditolyl-p-phenylenediamine (DTPD), N-isopropyl-N′-pheny-p-phenylenediamine (IPPD), 2,2,4-trimethyl-l,2-dihydroquinoline (TMQ), N,N′-bis(1,4-dimethylpentyl)-p-phenylenediamine (77PD)
^{k}Alctiplast TS, from Rheinchemie

In some embodiments, the disclosure provides the rubber compositions of Table 63.

TABLE 63

| Constituents | Unit | V6 | V7 | V8 | V9 | V10 | V11 | V12 | V13 | E4 | E5 | E6 | E7 |
|---|---|---|---|---|---|---|---|---|---|---|---|---|---|
| NR | phr | 10 | 10 | 10 | 10 | 10 | 10 | 10 | 10 | 10 | 10 | 10 | 10 |
| SBR^{b} | phr | 90 | 90 | — | — | — | — | 90 | 90 | — | — | — | — |
| Blend E-4 | phr | — | — | 108 | — | — | — | — | — | 108 | — | — | — |
| Blend E-5 | phr | — | — | — | 108 | — | — | — | — | — | 108 | — | — |
| Blend E-6 | phr | — | — | — | — | 108 | — | — | — | — | — | 108 | — |
| Blend E-7 | phr | — | — | — | — | — | 108 | — | — | — | — | — | 108 |
| Liquid SBR^{c} | phr | — | 18 | — | — | — | — | — | 18 | — | — | — | — |
| Plasticizer oil^{g} | phr | 35 | 17 | 17 | 17 | 17 | 17 | 35 | 17 | 17 | 17 | 17 | 17 |
| Silica^{h} | phr | 95 | 95 | 95 | 95 | 95 | 95 | 95 | 95 | 95 | 95 | 95 | 95 |
| Silane c. agent^{f} | phr | 6.8 | 6.8 | 6.8 | 6.8 | 6.8 | 6.8 | — | — | — | — | — | — |
| Silane c. agent^{g} | phr | — | — | — | — | — | — | 7.6 | 7.6 | 7.6 | 7.6 | 7.6 | 7.6 |
| ZnO | phr | 2.5 | 2.5 | 2.5 | 2.5 | 2.5 | 2.5 | 2.5 | 2.5 | 2.5 | 2.5 | 2.5 | 2.5 |
| Aging | phr | 6.5 | 6.5 | 6.5 | 6.5 | 6.5 | 6.5 | 6.5 | 6.5 | 6.5 | 6.5 | 6.5 | 6.5 |
| stabilizer/antiozonant/ | | | | | | | | | | | | | |
| stearic acidⁱ | | | | | | | | | | | | | |
| DPG | phr | 2 | 2 | 2 | 2 | 2 | 2 | 2 | 2 | 2 | 2 | 2 | 2 |
| CBS | phr | 2 | 2 | 2 | 2 | 2 | 2 | 2 | 2 | 2 | 2 | 2 | 2 |
| Sulfur | phr | 2 | 2 | 2 | 2 | 2 | 2 | 2 | 2 | 2 | 2 | 2 | 2 |

^{b}SBR, Sprintan ® SLR-4602, from Trinseo, vinyl content: 63% by wt., styrene content: 21% by wt., functionalized
^{c}Liquid SBR, Ricon ® 100, from Cray Valley
^{d}TDAE oil;
^{h}Ultrasil ® VN3, from Evonik (BET 180 m²/g)
^{f}TESPD Si261, from Evonik;
^{g}TESPT Si69, from Evonik;
ⁱAging stabilizers, for example a Compound of the Disclosure, e.g., a compound of Tables A-J, N,N′-diphenyl-p-phenylenediamine (DPPD), N,N′-ditolyl-p-phenylenediamine (DTPD), N-isopropyl-N′-pheny-p-phenylenediamine (IPPD), 2,2,4-trimethyl-l,2-dihydroquinoline (TMQ), N,N′-bis(1,4-dimethylpentyl)-p-phenylenediamine (77PD)

In some embodiments, the disclosure provides a rubber blend comprising: a Compound of the Disclosure, e.g., a compound of Tables A-J, at least one solution-polymerized diene polymer A of high molecular weight, formed from at least one conjugated diene and one or more vinylaromatic compound(s), wherein the one or more vinylaromatic compound(s) have a content of vinylaromatic compound of 0% to 50% by weight, a vinyl content of 8% to 80% by weight based on any diene content present, and wherein the one or more optional vinylaromatic compound(s), has a glass transition temperature Tg according to DSC of −100. degree. C.<Tg<−61. degree. C., a molecular weight Mw according to GPC of more than 350000 g/mol and a polydispersity PD of 1.1<PD<3; at least one solution-polymerized polymer B of low molecular weight, formed from at least one conjugated diene and one or more vinylaromatic compound(s), or at least one or more vinylaromatic compound(s), wherein the one or more vinylaromatic compound(s) has a content of vinylaromatic compound of 0% to 50% by weight, a vinyl content of 8% to 80% by weight based on any diene content present, and wherein the one or more vinylaromatic compound(s) has a glass transition temperature Tg according to DSC of −32. degree. C.<Tg<+80. degree. C., a molecular weight Mw according to GPC of 1300 g/mol<Mw<10000 g/mol and a polydispersity PD of 1<PD<1.5; 30 to 300 phr of at least one silica; and, 1 to 20 phf of at least one substance of formula I) of U.S. Pat. No. 11,267,957 as a silane coupling agent: (R¹R²R³)Si—S₄—Si(R³R²R¹) I) wherein R¹, R², R³ in the structure may be the same or different and may be selected from linear or branched alkoxy, cycloalkoxy, alkyl, cycloalkyl or aryl groups having 1 to 20 carbon atoms; wherein at least one of polymers A and B has been functionalized at the chain end and/or along the polymer chain and/or at a coupling site with at least one group selected from epoxy groups, hydroxyl groups, carboxyl groups, silane sulfide groups, amino groups, siloxane groups, organosilicon groups, phthalocyanine groups and amino group-containing alkoxysilyl groups; and, and wherein the polymers A and B are combined and processed together to give a rubber blend without solvent to obtain a transportable and processible blend.

In some embodiments, the disclosure provides the rubber compositions and/or tires described in U.S. Pat. No. 11,236,217, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 64.

TABLE 64

| Constituents | W1 | W2 | W3 | W4 | W5 | W6 | W7 | E1 | E2 |
|---|---|---|---|---|---|---|---|---|---|
| SSBR | 100 | 100 | 100 | 100 | 100 | 100 | 100 | 100 | 100 |
| Silica | 60 | 60 | 60 | 60 | 60 | 60 | 60 | 60 | 60 |
| Kristalex ® F-85 | 0 | 20 | 40 | 0 | 0 | 0 | 0 | 0 | 0 |
| Kristalex ® F100 | 0 | 0 | 0 | 20 | 40 | 0 | 0 | 0 | 0 |
| Kristalex ® F-115 | 0 | 0 | 0 | 0 | 0 | 20 | 40 | 0 | 0 |
| Modified Kristalex ® F- | 0 | 0 | 0 | 0 | 0 | 0 | 0 | 20 | 40 |
| 85 thermoplastic resin | | | | | | | | | |
| a Compound of the | 2 | 2 | 2 | 2 | 2 | 2 | 2 | 2 | 2 |
| Disclosure, e.g., a | | | | | | | | | |
| compound of Tables A-J | | | | | | | | | |
| Ozone wax | 2 | 2 | 2 | 2 | 2 | 2 | 2 | 2 | 2 |
| ZnO | 2.5 | 2.5 | 2.5 | 2.5 | 2.5 | 2.5 | 2.5 | 2.5 | 2.5 |
| Stearic acid | 2.5 | 2.5 | 2.5 | 2.5 | 2.5 | 2.5 | 2.5 | 2.5 | 2.5 |
| TESPD | 4.3 | 4.3 | 4.3 | 4.3 | 4.3 | 4.3 | 4.3 | 4.3 | 4.3 |
| DPG | 1 | 1 | 1 | 1 | 1 | 1 | 1 | 1 | 1 |
| CBS | 2 | 2 | 2 | 2 | 2 | 2 | 2 | 2 | 2 |
| Sulfur | 2 | 2 | 2 | 2 | 2 | 2 | 2 | 2 | 2 |

In some embodiments, the disclosure provides a vulcanized rubber composition, comprising: an elastomer, a filler, a Compound of the Disclosure, e.g., a compound of Tables A-J, and a modified thermoplastic resin prepared by polymerization of one or more monomers, wherein the modified thermoplastic resin comprises less than or equal to 55 wt % oligomers by gel permeation chromatography (GPC), or less than or equal to 38 wt % by high resolution thermogravimetric analysis (TGA), wherein oligomers consist of dimers, trimers, tetramers, pentamers, or a mixture thereof, of the one or more monomers.

In some embodiments, the disclosure provides a vulcanized rubber composition, comprising: an elastomer, a filler, a Compound of the Disclosure, e.g., a compound of Tables A-J, and a modified thermoplastic resin prepared by polymerization of one or more monomers, wherein the modified thermoplastic resin possesses the properties of formula I of U.S. Pat. No. 11,236,217:

$$S = ( \frac{{T}_{g}}{{M}_{z}} ) / [ Oligomer \times ( 1 - \frac{{T}_{10}}{{T}_{max}} ) ]$$

wherein T_{g} is the glass transition temperature of the modified thermoplastic resin; wherein M_{z} is the z-average molecular weight of the modified thermoplastic resin; wherein Oligomer is the fraction of oligomer present in the modified thermoplastic resin as measured by high resolution thermal gravimetric analysis (TGA) or gel permeation chromatography (GPC); wherein T₁₀ is the temperature at which the modified thermoplastic resin loses about 10% of its weight as measured by high resolution TGA; wherein Tₘₐₓ is the temperature of the maximum first derivative value of the modified thermoplastic resin as measured by high resolution TGA; wherein oligomers consist of dimers, trimers, tetramer, and pentamer species of the one or more monomers; wherein the value of S is greater than or equal to 2 and less than 50,000 when Oligomer is determined by GPC, or greater than or equal to 5 and less than 10,000 when Oligomer is determined by high resolution TGA; and wherein the value of Mz is less than or equal to 9,000 g/mol.

In some embodiments, the disclosure provides the rubber compositions and/or tires described in U.S. Pat. No. 11,142,594, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 65.

TABLE 65

| Component* | Ref. 1 | C1 | C2 | C3 | I1 | I2 | I3 | I4 | I5 | I6 |
|---|---|---|---|---|---|---|---|---|---|---|
| Rubber^{a} | 100 | 100 | 100 | 100 | 100 | 100 | 100 | 100 | 100 | 100 |
| Silica^{b} | 60 | 60 | 60 | 60 | 60 | 60 | 60 | 60 | 60 | 60 |
| Resin a^{c} | 0 | 10 | 20 | 30 | 0 | 0 | 0 | 0 | 0 | 0 |
| Resin b^{d} | 0 | 0 | 0 | 0 | 10 | 20 | 30 | 0 | 0 | 0 |
| Resin c^{e} | 0 | 0 | 0 | 0 | 0 | 0 | 0 | 10 | 20 | 30 |
| Anti- | 2.0 | 2.0 | 2.0 | 2.0 | 2.0 | 2.0 | 2.0 | 2.0 | 2.0 | 2.0 |
| oxidant^{f} | | | | | | | | | | |
| Wax^{g} | 2.0 | 2.0 | 2.0 | 2.0 | 2.0 | 2.0 | 2.0 | 2.0 | 2.0 | 2.0 |
| ZnO^{h} | 2.5 | 2.5 | 2.5 | 2.5 | 2.5 | 2.5 | 2.5 | 2.5 | 2.5 | 2.5 |
| Fatty acidⁱ | 2.5 | 2.5 | 2.5 | 2.5 | 2.5 | 2.5 | 2.5 | 2.5 | 2.5 | 2.5 |
| Silane | 4.32 | 4.32 | 4.32 | 4.32 | 4.32 | 4.32 | 4.32 | 4.3.2 | 4.32 | 4.32 |

^{a}Nipol ® NS 612 (styrene-butadiene rubber (SBR), Zeon Corp., Tokuyama, Japan)
^{b}Ultrasil ® VN 3GR (Evonik, Wesseling, Germany)
^{c}standard resin (Kristalex ™ F-85)
^{d}10% end-capped ether-linked functionalized resin, according to Example 1.2
^{e}30% pendant succinyl functionalized resin, according to Example 1.4
^{f}Compound of the Disclosure, e.g., a compound of Tables A-J
^{g}Ozone Wax
^{h}ZnO
ⁱStearic Acid

In some embodiments, the disclosure provides the rubber compositions of Table 66.

TABLE 66

| Component* | Ref. 2 | C4 | C5 | C6 | I7 | I8 | I9 | I10 | I11 | I12 |
|---|---|---|---|---|---|---|---|---|---|---|
| Rubber^{a} | 100 | 100 | 100 | 100 | 100 | 100 | 100 | 100 | 100 | 100 |
| Silica^{b} | 60 | 60 | 60 | 60 | 60 | 60 | 60 | 60 | 60 | 60 |
| Resin a^{c} | 0 | 10 | 20 | 30 | 0 | 0 | 0 | 0 | 0 | 0 |
| Resin b^{d} | 0 | 0 | 0 | 0 | 10 | 20 | 30 | 0 | 0 | 0 |
| Resin c^{e} | 0 | 0 | 0 | 0 | 0 | 0 | 0 | 10 | 20 | 30 |
| Anti-oxidant^{f} | 2.0 | 2.0 | 2.0 | 2.0 | 2.0 | 2.0 | 2.0 | 2.0 | 2.0 | 2.0 |
| Wax^{g} | 2.0 | 2.0 | 2.0 | 2.0 | 2.0 | 2.0 | 2.0 | 2.0 | 2.0 | 2.0 |
| ZnO^{h} | 2.5 | 2.5 | 2.5 | 2.5 | 2.5 | 2.5 | 2.5 | 2.5 | 2.5 | 2.5 |
| Fatty acidⁱ | 2.5 | 2.5 | 2.5 | 2.5 | 2.5 | 2.5 | 2.5 | 2.5 | 2.5 | 2.5 |
| Silane | 4.32 | 4.32 | 4.32 | 4.32 | 4.32 | 4.32 | 4.32 | 4.32 | 4.32 | 4.32 |

^{a}Natural Rubber (NR)
^{b}Ultrasil ® VN 3GR (Evonik, Wesseling, Germany)
^{c}standard resin (Kristalex ™ F-85)
^{d}10% end-capped ether-linked functionalized resin, according to Example 1.2
^{e}30% pendant succinyl functionalized resin, according to Example 1.4
^{f}Compound of the Disclosure, e.g., a compound of Tables A-J
^{g}Okerin ® OK 2124 (Paramelt B. V., The Netherlands)
^{h}ZnO Rotsiegel Gran (Grillo ZNO GmbH, Goslar, Germany)
ⁱTefacid RG (straight chain aliphatic monocarboxylic acids, mainly palmitic and stearic acid) (Aarhus Karlshamn, Karlshamn, Sweden)

In some embodiments, the disclosure provides a non-vulcanized composition, comprising: a polymer, a Compound of the Disclosure, e.g., a compound of Tables A-J, and a functionalized resin, wherein the functionalized resin comprises Formula I of U.S. Pat. No. 11,142,594:

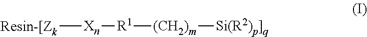

wherein Z is an aromatic group or an aliphatic group, optionally comprising a heteroatom; wherein X is a linker comprising a heteroatom selected from sulfur, oxygen, nitrogen, a carbonyl group, or a combination thereof; wherein R¹ comprises one or more of an aliphatic C₁ to C₁₈, and is one or more of —O—CO—NH—R³—(CH₂)₂—, O—CO—R³—(CH₂)₂—, —O—CH₂—R³—(CH₂)₂—, (CH₂)₂—, and —CO—NH—R³—(CH₂)₂—, and R³ comprises an aliphatic or aromatic C₁ to C₈ carbon chain, optionally branched, and/or optionally comprises one or more heteroatoms; wherein each R² is the same or different and is independently selected from a C₁ to C₁₈ alkoxy, aryloxy, alkyl, aryl, or H, or OH, and is optionally branched, and wherein at least one R² is C₁ to CH alkoxy, aryloxy, or H, or OH; wherein q is an integer from of at least 1; wherein k is 0; wherein n is an integer from 1 to 10; wherein m is an integer from 0 to 10; and, wherein p is 1, 2, or 3.

In some embodiments, the disclosure provides a non-vulcanized composition, comprising: a polymer, a Compound of the Disclosure, e.g., a compound of Tables A-J, and a functionalized resin, wherein the functionalized resin comprises Formula I of U.S. Pat. No. 11,142,594:

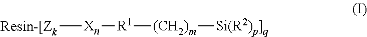

wherein Z is an aromatic group or an aliphatic group, optionally comprising a heteroatom; wherein X is a linker comprising a heteroatom selected from oxygen, a carbonyl group, or a combination thereof, or an oxygen and/or a carbonyl group in combination with sulfur and/or nitrogen; wherein R¹ comprises one or more of an aliphatic C₁ to C₁₈ and/or a linkage group comprising a heteroatom; wherein each R² is the same or different and is independently selected from a C₁ to C₁₈ alkoxy, aryloxy, alkyl, aryl, or H, or OH, and is optionally branched, and wherein at least one R² is C₁ to C₁₈ alkoxy, aryloxy, or H, or OH; wherein q is an integer from of at least 1; wherein k is 0; wherein n is an integer from 1 to 10; wherein m is an integer from 0 to 10; and, wherein p is 1, 2, or 3.

In some embodiments, the disclosure provides a non-vulcanized composition, comprising: a polymer, a Compound of the Disclosure, e.g., a compound of Tables A-J, and a functionalized resin, wherein the functionalized resin comprises Formula I of U.S. Pat. No. 11,142,594:

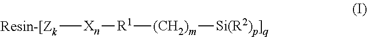

wherein Z is an aromatic group or an aliphatic group, optionally comprising a heteroatom; wherein X is a linker comprising a heteroatom selected from sulfur, oxygen, nitrogen, a carbonyl group, or a combination thereof; wherein R¹ comprises one or more of an aliphatic C₁ to C₁₈ and/or a linkage group comprising a heteroatom; wherein each R² is the same or different and is independently selected from a C₁ to C₁₈ alkoxy, aryloxy, alkyl, aryl, or H, or OH, and is optionally branched, and wherein at least one R² is C₁ to C₁₈ alkoxy, aryloxy, or H, or OH; wherein q is an integer from of at least 1; wherein k is 1; wherein n is an integer from 1 to 10; wherein m is an integer from 0 to 10; and, wherein p is 1, 2, or 3.

In some embodiments, the disclosure provides the rubber compositions and/or tires described in U.S. Pat. No. 11,104,780, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 67.

TABLE 67

| Component | Ref. 1 | C1 | C2 | C3 | I1 | I2 | I3 | I4 | I5 | I6 |
|---|---|---|---|---|---|---|---|---|---|---|
| Rubber^{a} | 100 | 100 | 100 | 100 | 100 | 100 | 100 | 100 | 100 | 100 |
| Silica^{b} | 60 | 60 | 60 | 60 | 60 | 60 | 60 | 60 | 60 | 60 |
| Resin a^{c} | 0 | 10 | 20 | 30 | 0 | 0 | 0 | 0 | 0 | 0 |
| Resin b^{d} | 0 | 0 | 0 | 0 | 10 | 20 | 30 | 0 | 0 | 0 |
| Resin c^{e} | 0 | 0 | 0 | 0 | 0 | 0 | 0 | 10 | 20 | 30 |
| Anti- | 2.0 | 2.0 | 2.0 | 2.0 | 2.0 | 2.0 | 2.0 | 2.0 | 2.0 | 2.0 |
| oxidant^{f} | | | | | | | | | | |
| Wax^{g} | 2.0 | 2.0 | 2.0 | 2.0 | 2.0 | 2.0 | 2.0 | 2.0 | 2.0 | 2.0 |
| ZnO^{h} | 2.5 | 2.5 | 2.5 | 2.5 | 2.5 | 2.5 | 2.5 | 2.5 | 2.5 | 2.5 |
| Fatty acidⁱ | 2.5 | 2.5 | 2.5 | 2.5 | 2.5 | 2.5 | 2.5 | 2.5 | 2.5 | 2.5 |
| Silane | 4.32 | 4.32 | 4.32 | 4.32 | 4.32 | 4.32 | 4.32 | 4.32 | 4.32 | 4.32 |

^{a}Nipol ® NS 612 (styrene-butadiene rubber (SBR), Zeon Corp., Tokuyama, Japan)
^{b}Ultrasil ® VN 3GR (Evonik, Wesseling, Germany)
^{c}standard resin (Kristalex ™ F-85)
^{d}10% end-capped ether-linked functionalized resin, according to Example 1.2
^{e}30% pendant succinyl functionalized resin, according to Example 1.4
^{f}Compound of the Disclosure, e.g., a compound of Tables A-J
^{g}Ozone Wax
^{h}ZnO
ⁱStearic Acid

In some embodiments, the disclosure provides the rubber compositions of Table 68.

TABLE 68

| Component | C4 | C5 | C6 | I7 | I8 | I9 | I10 | I11 | I12 |
|---|---|---|---|---|---|---|---|---|---|
| Rubber^{a} | 100 | 100 | 100 | 100 | 100 | 100 | 100 | 100 | 100 |
| Silica^{b} | 60 | 60 | 60 | 60 | 60 | 60 | 60 | 60 | 60 |
| Resin a^{c} | 10 | 20 | 30 | 0 | 0 | 0 | 0 | 0 | 0 |
| Resin b^{d} | 0 | 0 | 0 | 10 | 20 | 30 | 0 | 0 | 0 |
| Resin c^{e} | 0 | 0 | 0 | 0 | 0 | 0 | 10 | 20 | 30 |
| Anti-oxidant^{f} | 2.0 | 2.0 | 2.0 | 2.0 | 2.0 | 2.0 | 2.0 | 2.0 | 2.0 |
| Wax^{g} | 2.0 | 2.0 | 2.0 | 2.0 | 2.0 | 2.0 | 2.0 | 2.0 | 2.0 |
| ZnO^{h} | 2.5 | 2.5 | 2.5 | 2.5 | 2.5 | 2.5 | 2.5 | 2.5 | 2.5 |
| Fatty acidⁱ | 2.5 | 2.5 | 2.5 | 2.5 | 2.5 | 2.5 | 2.5 | 2.5 | 2.5 |
| Silane | 4.32 | 4.32 | 4.32 | 4.32 | 4.32 | 4.32 | 4.32 | 4.32 | 4.32 |

^{a}Natural Rubber (NR)
^{b}Ultrasil ® VN 3GR (Evonik, Wesseling, Germany)
^{c}standard resin (Kristalex ™ F-85)
^{d}10% end-capped ether-linked functionalized resin, according to Example 1.2
^{e}30% pendant succinyl functionalized resin, according to Example 1.4
^{f}Compound of the Disclosure, e.g., a compound of Tables A-J
^{g}Okerin ® OK 2124 (Paramelt B. V., The Netherlands)
^{h}ZnO Rotsiegel Gran (Grillo ZNO GmbH, Goslar, Germany)
ⁱTefacid RG (straight chain aliphatic monocarboxylic acids, mainly palmitic and stearic acid) (Aarhus Karlshamn, Karlshamn, Sweden)

In some embodiments, the disclosure provides a vulcanized rubber composition, comprising: an elastomer, a filler, a Compound of the Disclosure, e.g., a compound of Tables A-J, and a functionalized resin, wherein the functionalized resin comprises Formula I of U.S. Pat. No. 11,104,780:

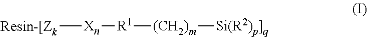

wherein Z is an aromatic group or an aliphatic group, optionally comprising a heteroatom; wherein X is a linker comprising a heteroatom selected from sulfur, oxygen, nitrogen, a carbonyl group, or a combination thereof; wherein R¹ comprises one or more of an aliphatic C₁ to C₁₈, and is one or more of —O—CO—NH—R³—(CH₂)₂—, O—CO—R³—(CH₂)₂—, —OCH₂R³—(CH₂)₂—, —CO—R³—(CH₂)₂—, and —CO—NH—R³—(CH₂)₂—, and R³ comprises an aliphatic or aromatic C₁ to C₈ carbon chain, optionally branched, and/or optionally comprises one or more heteroatoms; wherein each R² is the same or different and is independently selected from a C₁ to C₁₈ alkoxy, aryloxy, alkyl, aryl, or H, or OH, and is optionally branched, and wherein at least one R² is C₁ to C₁₈ alkoxy, aryloxy, or H, or OH; wherein q is an integer from of at least 1; wherein k is 0; wherein n is an integer from 1 to 10; wherein m is an integer from 0 to 10; and, wherein p is 1, 2, or 3.

In some embodiments, the disclosure provides a vulcanized rubber composition, comprising: an elastomer, a filler, a Compound of the Disclosure, e.g., a compound of Tables A-J, and a functionalized resin, wherein the functionalized resin comprises Formula I of U.S. Pat. No. 11,104,780:

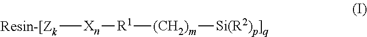

wherein Z is an aromatic group or an aliphatic group, optionally comprising a heteroatom; wherein X is a linker comprising a heteroatom selected from oxygen, a carbonyl group, or a combination thereof, or an oxygen and/or a carbonyl group in combination with sulfur and/or nitrogen; wherein R¹ comprises one or more of an aliphatic C₁ to C₁₈ and/or a linkage group comprising a heteroatom; wherein each R² is the same or different and is independently selected from a C₁ to C₁₈ alkoxy, aryloxy, alkyl, aryl, or H, or OH, and is optionally branched, and wherein at least one R² is C₁ to C₁₈ alkoxy, aryloxy, or H, or OH; wherein q is an integer from of at least 1; wherein k is 0; wherein n is an integer from 1 to 10; wherein m is an integer from 0 to 10; and, wherein p is 1, 2, or 3.

In some embodiments, the disclosure provides a vulcanized rubber composition, comprising: an elastomer, a filler, a Compound of the Disclosure, e.g., a compound of Tables A-J, and a functionalized resin, wherein the functionalized resin comprises Formula I of U.S. Pat. No. 11,104,780:

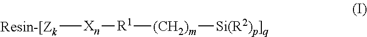

wherein Z is an aromatic group or an aliphatic group, optionally comprising a heteroatom; wherein X is a linker comprising a heteroatom selected from sulfur, oxygen, nitrogen, a carbonyl group, or a combination thereof; wherein R¹ comprises one or more of an aliphatic C₁ to C₁₈ and/or a linkage group comprising a heteroatom; wherein each R² is the same or different and is independently selected from a C₁ to C₁₈ alkoxy, aryloxy, alkyl, aryl, or H, or OH, and is optionally branched, and wherein at least one R² is C₁ to C₁₈ alkoxy, aryloxy, or H, or OH; wherein q is an integer from of at least 1; wherein k is 1; wherein n is an integer from 1 to 10; wherein m is an integer from 0 to 10; and, wherein p is 1, 2, or 3.

In some embodiments, the disclosure provides the rubber compositions and/or tires described in U.S. Pat. No. 11,015,041, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 69.

TABLE 69

| Constituents | Unit | Vl | V2 | V3 | V4 | V5 | E1 | E2 | E3 |
|---|---|---|---|---|---|---|---|---|---|
| BR^{a} | phr | 20 | 20 | 20 | 20 | 20 | 20 | 20 | 20 |
| Blend V | phr | 104 | — | — | — | 104 | — | — | — |
| Blend E-1 | phr | — | 104 | — | — | — | 104 | — | — |
| Blend E-2 | phr | — | — | 104 | — | — | — | 104 | — |
| Blend E-3 | phr | — | — | — | 104 | — | — | — | 104 |
| N339 carbon black | phr | — | — | — | — | 15 | 15 | 15 | 15 |
| Silica^{e} | phr | 110 | 110 | 110 | 110 | 110 | 110 | 110 | 110 |
| Plasticizer oil^{g} | phr | 20 | 20 | 20 | 20 | 20 | 20 | 20 | 20 |
| Silane^{f} | phr | 8.0 | 8.0 | 8.0 | 8.0 | 6.86 | 6.86 | 6.86 | 6.86 |
| ZnO | phr | 2 | 2 | 2 | 2 | 2 | 2 | 2 | 2 |
| Stabilizer/anti- | phr | 5 | 5 | 5 | 5 | 5 | 5 | 5 | 5 |
| ozonant/stearic acid^{j} | | | | | | | | | |
| Processing auxiliary^{k} | phr | 3 | 3 | 3 | 3 | 3 | 3 | 3 | 3 |
| DPG | phr | 2 | 2 | 2 | 2 | 2 | 2 | 2 | 2 |
| CBS | phr | 2.6 | 2.6 | 2.6 | 2.6 | 2.6 | 2.6 | 2.6 | 2.6 |
| Sulfur | phr | 2.1 | 2.1 | 2.1 | 2.1 | 2.1 | 2.1 | 2.1 | 2.1 |

^{a}BR with cis content greater than 80% by weight;
^{e}Zeosil 1165MP, from Rhodia (BET 149 m²/g, CTAB 154 m²/g);
^{f}TESPD Si261, from Evonik;
^{g}TDAE plasticizer oil;
^{j}Aging stabilizers, for example a Compound of the Disclosure, e.g., a compound of Tables A-J, N,N′-diphenyl-p-phenylenediamine (DPPD), N,N′-ditolyl-p-phenylenediamine (DTPD), N-isopropyl-N′-pheny-p-phenylenediamine (IPPD), 2,2,4-trimethyl-l,2-dihydroquinoline (TMQ), N,N′-bis(1,4-dimethylpentyl)-p-phenylenediamine (77PD)
^{k}Alctiplast TS, from Rheinchemie

In some embodiments, the disclosure provides the rubber compositions of Table 70.

TABLE 70

| Constituents | Unit | V6 | V7 | V8 | V9 | V10 | V11 | E4 | E5 | E6 | E7 |
|---|---|---|---|---|---|---|---|---|---|---|---|
| NR | phr | 10 | 10 | 10 | 10 | 10 | 10 | 10 | 10 | 10 | 10 |
| SBR^{b} | phr | 90 | — | — | — | — | 90 | — | — | — | — |
| Blend E-4 | phr | — | 108 | — | — | — | — | 108 | — | — | — |
| Blend E-5 | phr | — | — | 108 | — | — | — | — | 108 | — | — |
| Blend E-6 | phr | — | — | — | 108 | — | — | — | — | 108 | — |
| Blend E-7 | phr | — | — | — | — | 108 | — | — | — | — | 108 |
| Liquid SBR^{c} | phr | 18 | — | — | — | — | 18 | — | — | — | — |
| Plasticizer oil^{g} | phr | 17 | 17 | 17 | 17 | 17 | 17 | 17 | 17 | 17 | 17 |
| N339 carbon black | phr | — | — | — | — | — | 45 | 45 | 45 | 45 | 45 |
| Silica^{d} | phr | 95 | 95 | 95 | 95 | 95 | 50 | 50 | 50 | 50 | 50 |
| Silane c. agent^{f} | phr | 6.8 | 6.8 | 6.8 | 6.8 | 6.8 | 6.8 | 6.8 | 6.8 | 5.8 | 6.8 |
| ZnO | phr | 2.5 | 2.5 | 2.5 | 2.5 | 2.5 | 2.5 | 2.5 | 2.5 | 2.5 | 2.5 |
| Aging | phr | 6.5 | 6.5 | 6.5 | 6.5 | 6.5 | 6.5 | 6.5 | 6.5 | 6.5 | 6.5 |
| stabilizer/antiozonant/ | | | | | | | | | | | |
| stearic acide^{g} | | | | | | | | | | | |
| DPG | phr | 2 | 2 | 2 | 2 | 2 | 2 | 2 | 2 | 2 | 2 |
| CBS | phr | 2 | 2 | 2 | 2 | 2 | 2 | 2 | 2 | 2 | 2 |
| Sulfur | phr | 2 | 2 | 2 | 2 | 2 | 2 | 2 | 2 | 2 | 2 |

^{b}SBR, Sprintan ® SLR-4602, from Trinseo, vinyl content: 63% by wt., styrene content: 21% by wt., functionalized
^{c}Liquid SBR, Ricon ® 100, from Cray Valley
^{d}TDAE plasticizer oil;
^{d}Ultrasil ® VN3, from Evonik (BET 180 m²/g)
^{f}TESPD Si261, from Evonik;
^{g}Aging stabilizers, for example, a Compound of the Disclosure, e.g., a compound of Tables A-J, N,N′-diphenyl-p-phenylenediamine
(DPPD), N,N′-ditolyl-p-phenylenediamine (DTPD), N-isopropyl-N′-pheny-p-phenylenediamine (IPPD), 2,2,4-trimethyl-l,2-dihydroquinoline (TMQ), N,N′-bis(1,4-dimethylpentyl)-p-phenylenediamine (77PD)

In some embodiments, the disclosure provides a rubber blend comprising: a Compound of the Disclosure, e.g., a compound of Tables A-J, a solution-polymerized diene polymer A of high molecular weight, formed from at least one conjugated diene and one or more optional vinylaromatic compound(s), wherein the one or more optional vinylaromatic compound(s) have a content of vinylaromatic compound of 0% to 50% by weight, a vinyl content of 8% to 80% by weight based on any diene content present, and wherein the one or more optional vinylaromatic compound(s), has a glass transition temperature Tg according to DSC of −100° C.<Tg<+20° C., a molecular weight Mw according to GPC of at least 438020 g/mol and a polydispersity PD of 1.1<PD<3; a solution-polymerized polymer B of low molecular weight, formed from at least one conjugated diene, at least one conjugated diene and one or more vinylaromatic compound(s), or at least one or more vinylaromatic compound(s), wherein the one or more vinylaromatic compound(s) has a content of vinylaromatic compound of 0% to 50% by weight, a vinyl content of 8% to 80% by weight based on any diene content present, and wherein the one or more vinylaromatic compound(s) has a glass transition temperature Tg according to DSC of −100° C.<Tg<+80° C., a molecular weight Mw according to GPC of 1300 g/mol<Mw<10000 g/mol and a polydispersity PD of 1<PD<1.5; and, and as filler, at least one optional silica and at least one carbon black in an amount of 25 to 300 phr, wherein the ratio of carbon black to silica in the mixture is 100:0 to 3:97; wherein at least one of polymers A and B has been functionalized at the chain end and/or along the polymer chain and/or at a coupling site with at least one group selected from epoxy groups, hydroxyl groups, carboxyl groups, silane sulfide groups, amino groups, siloxane groups, organosilicon groups, phthalocyanine groups and amino group-containing alkoxysilyl groups; and, wherein polymers comprised in the rubber blend consist of the solution-polymerized diene polymer A, the solution-polymerized diene polymer B, and a diene rubber selected from the group consisting of synthetic polyisoprene (IR), natural polyisoprene (NR), polybutadiene (BR), and mixtures thereof.

In some embodiments, the disclosure provides the rubber compositions and/or tires described in U.S. Pat. No. 11,008,446, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 71.

TABLE 71

| Constituents | Unit | Vl | V2 | V3 | E1 |
|---|---|---|---|---|---|
| BR^{a} | phr | 20 | 20 | 20 | 20 |
| Blend V-1 | phr | 96 | — | — | — |
| Blend V-2 | phr | — | 96 | — | — |
| Blend V-3 | phr | — | — | 96 | — |
| Blend E | phr | — | — | — | 112 |
| N339 carbon black | phr | 9 | 9 | 9 | 9 |
| Silica^{e} | phr | 90 | 90 | 90 | 90 |
| Silane^{f} | phr | 6.5 | 6.5 | 6.5 | 6.5 |
| Polymer B-1 | phr | 16 | — | — | — |
| Polymer B | phr | — | 16 | 16 | — |
| ZnO | phr | 2 | 2 | 2 | 2 |
| Aging stabilizer/antiozonant/stearic | phr | 5 | 5 | 5 | 5 |
| acid^{j} | | | | | |
| Processing auxiliary^{k} | phr | 3 | 3 | 3 | 3 |
| DPG | phr | 2 | 2 | 2 | 2 |
| CBS | phr | 2.6 | 2.6 | 2.6 | 2.6 |
| Sulfur | phr | 2.1 | 2.1 | 2.1 | 2.1 |

^{a}BR with cis content greater than 80% by weight;
^{e}Zeosil 1165MP, from Rhodia (BET 149 m²/g, CTAB 154 m²/g);
^{f}TESPD Si261, from Evonik;
^{g}TDAE plasticizer oil;
^{j}Aging stabilizers, for example a Compound of the Disclosure, e.g., a compound of Tables A-J, N,N′-diphenyl-p-phenylenediamine (DPPD), N,N′-ditolyl-p-phenylenediamine (DTPD), N-isopropyl-N′-pheny-p-phenylenediamine (IPPD), 2,2,4-trimethyl-1,2-dihydroquinoline (TMQ), N,N′-bis(1,4-dimethylpentyl)-p-phenylenediamine (77PD)
^{k}Alctiplast TS, from Rheinchemie

In some embodiments, the disclosure provides a rubber blend comprising: a Compound of the Disclosure, e.g., a compound of Tables A-J, a solution-polymerized diene polymer A of high molecular weight, formed from at least one conjugated diene and one or more optional vinylaromatic compound(s), wherein the one or more optional vinylaromatic compound(s) have a content of vinylaromatic compound of 0% to 50% by weight, a vinyl content of 8% to 80% by weight based on any diene content present, and wherein the one or more optional vinylaromatic compound(s), has a glass transition temperature Tg according to DSC of −100° C.<Tg<+20° C., a molecular weight Mw according to GPC of at least 438020 g/mol and a polydispersity PD of 1.1<PD<3; and a solution-polymerized polymer B of low molecular weight, formed from at least one conjugated diene, at least one conjugated diene and one or more vinylaromatic compound(s), or at least one or more vinylaromatic compound(s), wherein the one or more vinylaromatic compound(s) has a content of vinylaromatic compound of 0% to 100% by weight, a vinyl content of 8% to 80% by weight based on any diene content present, and wherein the one or more vinylaromatic compound(s) has a glass transition temperature Tg according to DSC of −100° C.<Tg<+80° C., a molecular weight Mw according to GPC of 1300 g/mol <Mw<10 000 g/mol and a polydispersity PD of 1<PD<1.5; wherein at least one of polymers A and B has been functionalized at the chain end and/or along the polymer chain and/or at a coupling site with at least one group selected from epoxy groups, hydroxyl groups, carboxyl groups, silane sulfide groups, amino groups, siloxane groups, organosilicon groups, phthalocyanine groups and amino group-containing alkoxysilyl groups; wherein the rubber blend includes 35 to 100 phr of the at least one solution-polymerized polymer B of low molecular weight, based on the at least one solution-polymerized diene polymer A of high molecular weight; and, wherein polymers comprised in the rubber blend consist of the solution-polymerized diene polymer A, the solution-polymerized diene polymer B, and a diene rubber selected from the group consisting of synthetic polyisoprene (IR), natural polyisoprene (NR), polybutadiene (BR), and mixtures thereof.

In some embodiments, the disclosure provides the rubber compositions and/or tires described in U.S. Pat. No. 10,927,241, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides a sulfur-crosslinkable rubber mixture comprising at least the following constituents: a Compound of the Disclosure, e.g., a compound of Tables A-J, at least one diene rubber; 10 to 300 phr of at least one silica; 1 to 30 phf of at least one silane A having general empirical formula A-I) of U.S. Pat. No. 10,927,241:

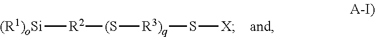

0.5 to 30 phf of at least one silane B having general empirical formula B—I) of U.S. Pat. No. 10,927,241:

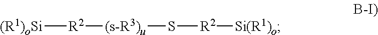

wherein o may be 1, 2 or 3 and the radicals R¹ may be identical or different and are selected from C₁-C₁₀-alkoxy groups, C₆-C₂₀-phenoxy groups, C₂-C₁₀-cyclic dialkoxy groups, C₂-C₁₀-dialkoxy groups, C₄-C₁₀-cycloalkoxy groups, C₆-C₂₀-aryl groups, C₁-C₁₀-alkyl groups, C₂-C₂₀-alkenyl groups, C₂-C₂₀-alkynyl groups, C₇-C₂₀-aralkyl groups, halides or alkyl polyether group —O—(R⁶—O)ᵣ—R⁷, wherein the radicals R⁶ are identical or different and are branched or unbranched, saturated or unsaturated, aliphatic, aromatic or mixed aliphatic/aromatic divalent C₁-C₃₀-hydrocarbon group, r is an integer from 1 to 30, and the radicals R⁷ are unsubstituted or substituted, branched or unbranched monovalent alkyl, alkenyl, aryl or aralkyl groups, or two R¹ correspond to a dialkoxy group having 2 to 10 carbon atoms wherein in that case o<3, or two or more silanes of formulae A-I) and/or B—I) may be bridged via radicals R¹ or by condensation; with the proviso that in the formulae A-I) and B—I) in each (R¹)ₒSi group at least one R¹ is selected from the abovementioned options where this R¹i) is bonded to the silicon atom via an oxygen atom or ii) is a halide; wherein the radicals R² and R³ in each molecule and within a molecule may be identical or different and are branched or unbranched, saturated or unsaturated, aliphatic, aromatic or mixed aliphatic/aromatic divalent C₁-C₃₀-hydrocarbon groups; and, wherein q is 1 or 2 or 3; and u is 1 or 2 or 3; and X is a hydrogen atom or a —C(═O)—R⁸ group wherein R⁸ is selected from hydrogen, C₁-C₂-alkyl groups, C₆-C₂₀-aryl groups, C₂-C₂₀-alkenyl groups and C₇-C₂₀-aralkyl groups.

In some embodiments, the disclosure provides the rubber compositions and/or tires described in U.S. Pat. No. 10,870,744, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 72.

TABLE 72

| Constituents | Unit | Re1 | Re2 | Re3 |
|---|---|---|---|---|
| NR TSR | phr | 10 | 10 | 20 |
| BR ^{k)} | phr | 18 | 18 | 44 |
| SSBR ^{l)} | phr | 72 | 72 | 36 |
| Silica ^{a)} | phr | 95 | 95 | 95 |
| TDAE | phr | 35 | 50 | 45 |
| Other additives ^{b)} | phr | 9 | 9 | 11 |
| Silane - varied ^{d)} | phf | varied | varied | varied |
| Accelerator ^{c)} | phr | 4 | 4 | 4 |
| Sulfur | phr | 2 | 2 | 2 |

^{a)} Silica: VN3, Evonik
^{b)} Other additives: anti-aging additives, anti-ozonant wax, a Compound of the Disclosure, e.g., a compound of Tables A-J, zinc oxide, stearic acid
^{c)} DPG + CBS
^{d)} Silane variants according to e) to h), see tables 2 to 4
^{k)} Polybutadiene: Europrene Neocis BR 40, Polimeri
^{l)} Sprintan ® SLR-4601, Trinseo

In some embodiments, the disclosure provides a sulfur-crosslinkable rubber mixture comprising at least the following constituents: a Compound of the Disclosure, e.g., a compound of Tables A-J, at least one diene rubber; and 10 to 300 phr of at least one silica; and 1 to 22 phf (parts per hundred parts of filler by weight) of at least one silane A having general empirical formula A-I) of U.S. Pat. No. 10,870,744:

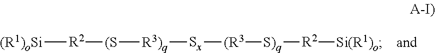

0.5 to 30 phf of at least one silane B having general empirical formula B—I) of U.S. Pat. No. 10,870,744:

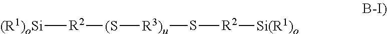

wherein o may be 1 or 2 or 3; wherein the radicals R¹ may be identical or different and are selected from C₁-C₁₀-alkoxy groups, C₆-C₂₀-phenoxy groups, C₂-C₁₀-cyclic dialkoxy groups, C₂-C₁₀-dialkoxy groups, C₄-C₁₀-cycloalkoxy groups, C₆-C₂₀-aryl groups, C₁-C₁₀-alkyl groups, C₂-C₂₀-alkenyl groups, C₂-C₂₀-alkynyl groups, C₇-C₂₀-aralkyl groups, halides or alkyl polyether group —O—(R⁶—O)ᵣ—R⁷, wherein the radicals R⁶ are identical or different and are branched or unbranched, saturated or unsaturated, aliphatic, aromatic or mixed aliphatic/aromatic divalent C₁-C₃₀-hydrocarbon group, r is an integer from 1 to 30, and the radicals R⁷ are unsubstituted or substituted, branched or unbranched monovalent alkyl, alkenyl, aryl or aralkyl groups, or two R¹ correspond to a dialkoxy group having 2 to 10 carbon atoms wherein in that case o<3, or two or more silanes of formulae A-I) and/or B—I) may be bridged via radicals R¹ or by condensation; with the proviso that in the formulae A-I) and B—I) in each (R′)ₒSi group at least one R¹ is selected from the abovementioned options, wherein this R¹i) is bonded to the silicon atom via an oxygen atom or ii) is a halide; wherein the radicals R² and R³ in each molecule and within a molecule may be identical or different and are branched or unbranched, saturated or unsaturated, aliphatic, aromatic or mixed aliphatic/aromatic divalent C₁-C₃₀-hydrocarbon groups; and, wherein x is an integer from 2 to 10 and q is 0 or 1 or 2 or 3; and wherein u is 1 or 2 or 3.

In some embodiments, the disclosure provides the rubber compositions and/or tires described in U.S. Pat. No. 10,858,499, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 73.

TABLE 73

| Constituents | Unit | C1 | C2 | C3 | I1 | I2 | I3 | I4 |
|---|---|---|---|---|---|---|---|---|
| NR | phr | 20 | 20 | 20 | 20 | 20 | 20 | 20 |
| SSBR | phr | 80 | 80 | 80 | 80 | 80 | 80 | 80 |
| TDAE | phr | 35 | 35 | 35 | 35 | 35 | 35 | 35 |
| Silica^{a)} + | phr | 98.4 | 99.4 | 100.5 | — | — | — | — |
| TESPD^{b)} | | | | | | | | |
| Silica^{a)} + | phr | — | — | — | 102.7 | 105.2 | 107.8 | — |
| silane IV)^{c)} | | | | | | | | |
| Silic^{a)} + | phr | — | — | — | — | — | — | 107.8 |
| silane V)^{d)} | | | | | | | | |
| Other | phr | 9 | 9 | 9 | 9 | 9 | 9 | 9 |
| additives^{e)} | | | | | | | | |
| Accelerator^{f)} | phr | 3.6 | 3.6 | 3.6 | 3.6 | 3.6 | 3.6 | 3.6 |
| Sulfur | phr | 2 | 2 | 2 | 2 | 2 | 2 | 2 |

^{a)}Silica: Ultrasil ® VN3, Evonik, in each case 95 phr, remaining amount in each case bound silane
^{b)}TESPD (3,3′-bis(triethoxysilylpropyl) disulfide)
^{c)}Inventive silane of formula IV) of U.S. Pat. No. 10,858,499, prepared as described above
^{d)}Inventive silane of formula V) of U.S. Pat. No. 10,858,499, prepared as described above
^{e)}Aging stabilizers, antiozonant wax, a Compound of the Disclosure, e.g., a compound of Tables A-J, zinc oxide, stearic acid
^{f)}DPG and CBS.

In some embodiments, the disclosure provides the rubber compositions disclosed in the US patents of Table 74.

TABLE 74

| U.S. Pat. No. | Compositions Incorporated by Reference* |
|---|---|
| 10,738,179 | 1(C), 2(C), 3(C), 4(I), 5(I) in Table 1 of column 8 |
| 10,703,141 | M1₁, M1₂ in Table 1 of column 8 |
| | M2₁, M2₂ in Table 2 of column 8 |
| 10,577,488 | C1, C2, I1 in Table 2 of column 18 |
| | C3, I2, I3, C4, I4 in Table 3 of column 19 |
| | C5, C6, C7, C8, C9, C10 in Table 4 of column 19 |
| 10,384,489 | Compound 1 for central segment 6a, Compound 2 for central segment 6b |
| | in Table 2 of column 6 |
| 10,273,351 | C1, C2, C3, I1 in Table 1 of column 14 |
| | C4, C5, C6, I2, C7, I3 in Table 2 of column 14 |
| 10,246,576 | C1, C2, C3, C4, C5, E1, E2, E3, C6, E4, E5, E6 in Table 1 of column 13 |
| 10,214,635 | C1, I1, I2, C2, I3 in Table 1 of column 16 |
| | C3, C4, I4, I5, C5, I6 in Table 2 of column 16 |
| | C7, C8, I8, I9 in Table 3 of column 17 |
| | C9, C10, I10, I11 in Table 4 of column 17 |
| 10,040,925 | C1, C2, I1 in Table 1 of column 13 |
| 9,856,368 | V1, E1, E2, E3 in Table 1 of column 16 |
| | V2, E4, E5, E6 in Table 2 of column 17 |
| 9,758,647 | C1, I1 in Table 1 of column 7 |
| 9,701,809 | C1, I1 in Table 1 of column 13 |
| 9,631,074 | C1, C2, C3, E1, E2, C4, C5, C6, C7 in Table 1 of column 12 |
| 9,593,233 | C1, I1 in Table 1 of column 7 |
| 9,328,227 | C1, I1, C2, I2 in Table 1 of column 6 |
| 9,034,980 | 1(C), 2(I), 3(I), 4(C), 5(C), 6(C), 7(C), 8(C), 9(C) in Table 1 of column 6 |
| 8,912,267 | 1(C), 2(I), 3(I), 4(C), 5(C), 6(C), 7(C), 8(C), 9(C) in Table 1 of column 6 |

*wherein an antidegradant, e.g., an antioxidant, e.g., 6PPD, in each rubber composition is either partially or completely substituted with a Compound of the Disclosure, e.g., a compound of Tables A-J

In some embodiments, the disclosure provides the rubber compositions and/or tires described in U.S. Pat. No. 11,390,118, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 75.

TABLE 75

| | (A) | (B) | (C) | (D) | (E) | (F) |
|---|---|---|---|---|---|---|
| NR | 100 | 100 | 0 | 0 | 0 | 0 |
| Silica | 20 | 30 | 0 | 0 | 0 | 0 |
| MASTER 1 | 0 | 0 | 120 | 0 | 0 | 0 |
| MASTER 2 | 0 | 0 | 0 | 120 | 0 | 0 |
| MASTER 3 | 0 | 0 | 0 | 0 | 130 | 0 |
| MASTER 4 | 0 | 0 | 0 | 0 | 0 | 130 |
| TESPT | 2 | 2 | 2 | 2 | 2 | 2 |
| CB N234 | 2 | 2 | 2 | 2 | 2 | 2 |
| Soluble Sulfur | 2 | 2 | 2 | 2 | 2 | 2 |
| ZnO | 5 | 5 | 5 | 5 | 5 | 5 |
| Stearic Acid | 2 | 2 | 2 | 2 | 2 | 2 |
| CBS | 2 | 2 | 2 | 2 | 2 | 2 |
| TMQ | 1 | 1 | 1 | 1 | 1 | 1 |
| Compound of the | 1.5 | 1.5 | 1.5 | 1.5 | 1.5 | 1.5 |
| Disclosure, e.g., | | | | | | |
| a compound of Tables A-J | | | | | | |

Materials
MASTER 1: Natural rubber masterbatch prepared according to Example 3 (of U.S. Pat. No. 11,390,118) comprising 20 phr of composite reinforcing filler according to Example 1;
MASTER 2: Natural rubber masterbatch prepared according to Example 3 (of U.S. Pat. No. 11,390,118) comprising 20 phr of composite reinforcing filler according to Example 2;
MASTER 3: Natural rubber masterbatch prepared according to Example 3 (of U.S. Pat. No. 11,390,118) comprising 30 phr of composite reinforcing filler according to Example 1;
MASTER 4: Natural rubber masterbatch prepared according to Example 3 (of U.S. Pat. No. 11,390,118) comprising 30 phr of composite reinforcing filler according to Example 2;
NR: coagulated natural rubber, obtained by coagulation of natural rubber latex HA obtained by centrifuging and stabilized with ammonia (60% by weight-commercialized by Von Bundit Co. Ltd);
Silica: Silica Ultrasil VN3, Ege Kymia;
TESPT: bis(3-triethoxysilylpropyl) tetrasulfide, Si69 ®;
CB: Carbon black N234, Cabot;
Soluble Sulfur: S8 (soluble sulfur), Zolfo Industria;
ZnO: Zinc Oxide, Zincol Ossidi;
Stearic acid: Stearin TP8, Undesa;
CBS: N-cyclohexyl-2-benzothiazolesulfenamide (Vulkacit CZ/C), Lanxess;
TMQ: polymerized 2,2,4-trimethyl-1,2 dihydroquinoline, Kemai;

In some embodiments, the disclosure provides the rubber compositions of Table 76.

TABLE 76

| | (G) | (H) | (I) | (L) |
|---|---|---|---|---|
| E-SBR | 80 | 80 | 80 | 0 |
| NR | 20 | 20 | 20 | 20 |
| MASTER 5 | 0 | 0 | 0 | 100 |
| Silica | 20 | 30 | 40 | 0 |
| TESPT | 1.6 | 2.4 | 3.2 | 1.6 |
| CB N234 | 1.6 | 2.4 | 3.2 | 1.6 |
| Soluble Sulfur | 1.63 | 1.63 | 1.63 | 1.63 |
| ZnO | 2.5 | 2.5 | 2.5 | 2.5 |
| Stearic Acid | 2.5 | 2.5 | 2.5 | 2.5 |
| CBS | 2.9 | 2.9 | 2.9 | 2.9 |
| TMQ | 1 | 1 | 1 | 1 |
| Compound of | 1.5 | 1.5 | 1.5 | 1.5 |
| the Disclosure, | | | | |
| e.g., a compound | | | | |
| of Tables A-J | | | | |

Materials
MASTER 5: SBR masterbatch comprising 20 phr of composite reinforcing filler according to Example 2 (of U.S. Pat. No. 11,390,118);
E-SBR: coagulated SBR, obtained by coagulation from SBR latex in emulsion with styrene % of 26% (solid content 66% by weight, Europrene Latice ® E-5570, Versalis);
NR: coagulated natural rubber, obtained by coagulation of natural rubber latex HA obtained by centrifuging and stabilized with ammonia (60% by weight-commercialized by Von Bundit Co. Ltd);
Silica: Silica Ultrasil VN3, Ege Kymia;
TESPT: bis(3-triethoxysilylpropyl) tetrasulfide, Si69 ®;
CB: Carbon black N234, Cabot;
Soluble Sulfur: S8 (soluble sulfur), Zolfo Industria;
ZnO: Zinc oxide, Zincol Ossidi;
Stearic acid: Stearin TP8, Undesa;
CBS: N-cyclohexyl-2-benzothiazolesulfenamide (Vulkacit CZ/C), Lanxess;
TMQ: polymerized 2,2,4-trimethyl-1,2 dihydroquinoline, Kemai;

In some embodiments, the disclosure provides the rubber compositions of Table 77.

TABLE 77

| | (M) | (N) | (O) | (P) | (Q) | (R) |
|---|---|---|---|---|---|---|
| NR | 100 | 100 | 100 | 0 | 0 | 0 |
| Silica | 20 | 30 | 40 | 0 | 0 | 0 |
| MASTER 2 | 0 | 0 | | 120 | 0 | 0 |
| MASTER 4 | 0 | 0 | 0 | 0 | 130 | 0 |
| MASTER 6 | 0 | 0 | 0 | 0 | 0 | 140 |
| TESPT | 2 | 2.4 | 3.2 | 2 | 2.4 | 3.2 |
| CB | 2 | 2.4 | 3.2 | 2 | 2.4 | 3.2 |
| Soluble Sulfur | 2 | 2 | 2 | 2 | 2 | 2 |
| ZnO | 5 | 5 | 5 | 5 | 5 | 5 |
| Stearic Acid | 2 | 2 | 2 | 2 | 2 | 2 |
| CBS | 2 | 2 | 2 | 2 | 2 | 2 |
| TMQ | 1 | 1 | 1 | 1 | 1 | 1 |
| Compound of the | 1.5 | 1.5 | 1.5 | 1.5 | 1.5 | 1.5 |
| Disclosure, e.g., a | | | | | | |
| compound of | | | | | | |
| Tables A-J | | | | | | |

Materials
MASTER 2: Natural rubber masterbatch prepared according to Example 3 comprising 20 phr of composite reinforcing filler according to Example 2;
MASTER 4: Natural rubber masterbatch prepared according to Example 3 comprising 30 phr of composite reinforcing filler according to Example 2;
MASTER 6: Natural rubber masterbatch prepared according to Example 3 comprising 40 phr of composite reinforcing filler according to Example 2;
NR: coagulated natural rubber, obtained by coagulation of natural rubber latex HA obtained by centrifuging and stabilized with ammonia (60% by weight commercialized by Von Bundit Co. Ltd);
Silica: Silica Ultrasil VN3, Ege Kymia;
TESPT: bis(3-triethoxysilylpropyl) tetrasulfide, Si69 ®;
CB: Carbon black N234, Cabot;
Soluble Sulfur: S8 (soluble sulfur), Sulfur Industria;
ZnO: Zinc oxide, Zincol Ossidi;
Stearic acid: Stearin TP8, Undesa;
CBS: N-cyclohexyl-2-benzothiazolesulfenamide (Vulkacit CZ/C), Lanxess;
TMQ: polymerized 2,2,4-trimethyl-1,2 dihydroquinoline, Kemai.

In some embodiments, the disclosure provides a tire for vehicle wheels comprising (1) a Compound of the Disclosure, e.g., a compound of Tables A-J; and (2) at least one structural element comprising a vulcanized elastomeric material obtained by vulcanizing a vulcanizable elastomeric composition comprising: (a) at least one vulcanizable diene elastomeric polymer; (b) at least one composite reinforcing filler comprising a core, and the core comprises nanocrystalline cellulose and an at least partial coating comprising silica.

In some embodiments, the disclosure provides a process for producing a tire for vehicle wheels, comprising: (1) providing a Compound of the Disclosure, e.g., a compound of Tables A-J; and (2) providing a vulcanizable elastomeric composition comprising: (a) at least one vulcanizable diene elastomeric polymer; and (b) at least one composite reinforcing filler comprising a core, and the core comprises nanocrystalline cellulose and an at least partial coating comprising silica; providing a tire structural element comprising the vulcanizable elastomeric composition; assembling the tire structural element in a green tire; and vulcanizing the green tire.

In some embodiments, the disclosure provides the rubber compositions and/or tires described in U.S. Pat. No. 11,383,554, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 78.

TABLE 78

| | Comparative example 10 | | | |
|---|---|---|---|---|
| | MA | MB | MC1 | MD |
| | Comp. | Comp. | Comp. | Comp. |
| Filler | Silica | Silica + | Silica + | Silica + |
| | | sepiolite | modified | modified |
| | | | sepiolite | sepiolite |
| | | | (Ex. 2a) | (Ex. 1) |
| % Mg extracted | — | — | 95% | 33% |
| Zeosil 1115MK | 45 | 35 | 35 | 35 |
| sepiolite | 0 | 10 | 0 | 0 |
| modified | 0 | 0 | 10 | 0 |
| sepiolite Ex. 2a | | | | |
| modified | 0 | 0 | 0 | 10 |
| sepiolite Ex. 1 | | | | |
| NR | 100 | 100 | 100 | 100 |
| Stearic acid | 2 | 2 | 2 | 2 |
| Silane TESPT | 3.6 | 3.6 | 3.6 | 3.6 |
| ZnO | 3.6 | 3.6 | 3.6 | 3.6 |
| Compound of | 2 | 2 | 2 | 2 |
| the Disclosure, | | | | |
| e.g., a compound | | | | |
| of Tables A-J | | | | |
| TBBS | 1.8 | 1.8 | 1.8 | 1.8 |
| Sulfur | 2.8 | 2.8 | 2.8 | 2.8 |

NR (natural rubber): natural rubber;
TESPT: Bis[3-(triethoxysilyl)propyl]tetrasulphide;
Zeosil 1115MK: precipitated synthetic amorphous silica (Rhodia);
sepiolite: Pangel S9;
ZnO: zinc oxide;
TBSS: N-tert-butyl-2-benzothiazylsulfenamide.

In some embodiments, the disclosure provides the rubber compositions of Table 79

TABLE 79
comparatives

| | Example 11 | | | | | | | |
|---|---|---|---|---|---|---|---|---|
| | ME1 | MF1 | MC2 | MG | MH | MI | MJ | MK |
| | Comp. | Comp. | Comp. | Comp. | Comp. | Comp. | Comp. | Comp. |
| | Filler | | | | | | | |
| | | | Silica + | Silica + | Silica + | Silica + | Silica + | Silica + |
| | | | mod. | mod. | mod. | mod. | mod. | mod. |
| | | Silica + | sepiolite | sepiolite | sepiolite | sepiolite | sepiolite | sepiolite |
| | Silica | sepiolite | (Ex. 2b) | (Ex. 3) | (Ex. 4) | (Ex. 5) | (Ex. 6) | (Ex. 7) |
| % Mg | — | — | 97% | 35% | 35% | 26% | 20% | 28% |
| extracted | | | | | | | | |
| CB N550 | 25 | 25 | 25 | 25 | 25 | 25 | 25 | 25 |
| ZEOSIL | 30 | 20 | 20 | 20 | 20 | 20 | 20 | 20 |
| 1115 MK | | | | | | | | |
| sepiolite | — | 7 | — | — | — | — | — | — |
| mod. | — | — | 7 | — | — | — | — | — |
| sepiolite | | | | | | | | |
| Ex. 2b | | | | | | | | |
| mod. | — | — | — | 8.29 | — | — | — | — |
| sepiolite | | | | | | | | |
| Ex. 3 | | | | | | | | |
| mod. | — | — | — | — | 9.79 | — | — | — |
| sepiolite | | | | | | | | |
| Ex. 4 | | | | | | | | |
| mod. | — | — | — | — | — | 8.55 | — | — |
| sepiolite | | | | | | | | |
| Ex. 5 | | | | | | | | |
| mod. | — | — | — | — | — | — | 8.55 | — |
| sepiolite | | | | | | | | |
| Ex. 6 | | | | | | | | |
| mod. | — | — | — | — | — | — | — | 8 |
| sepiolite | | | | | | | | |
| Ex. 7 | | | | | | | | |
| BR (Nd) | 60 | 60 | 60 | 60 | 60 | 60 | 60 | 60 |
| IR | 40 | 40 | 40 | 40 | 40 | 40 | 40 | 40 |
| Silane | 5 | 5 | 5 | 5 | 5 | 5 | 5 | 5 |
| Stearic | 1 | 1 | 1 | 1 | 1 | 1 | 1 | 1 |
| acid | | | | | | | | |
| ZnO | 4 | 4 | 4 | 4 | 4 | 4 | 4 | 4 |
| TMQ | 1 | 1 | 1 | 1 | 1 | 1 | 1 | 1 |
| Compound | 1.5 | 1.5 | 1.5 | 1.5 | 1.5 | 1.5 | 1.5 | 1.5 |
| of the | | | | | | | | |
| Disclosure, | | | | | | | | |
| e.g., a | | | | | | | | |
| compound | | | | | | | | |
| of Tables | | | | | | | | |
| A-J | | | | | | | | |
| TBBS 80 | 4 | 4 | 4 | 4 | 4 | 4 | 4 | 4 |
| Sulfur | 2.3 | 2.3 | 2.3 | 2.3 | 2.3 | 2.3 | 2.3 | 2.3 |

BR(Nd): (high cis) neodymium polybutadiene rubber (Europrene 40 Versalis);
IR: synthetic polyisoprene (SK13 produced by Nitzhnekamsk);
silane: 50% TESPT: Bis[3-(triethoxysilyl)propyl]tetrasulphide on carbon black;
CB: carbon black;
Zeosil 1115MK: precipitated synthetic amorphous silica (Rhodia);
sepiolite: Pangel S9 (Tolsa);
ZnO: zinc oxide;
TMQ: polymerised 2,2,4-trimethyl-1,2-dihydroquinoline;
TBSS: N-tert-butyl-2-benzothiazyl sulfenamide.

In some embodiments, the disclosure provides the rubber compositions of Table 80.

TABLE 80

| | Example 11 | | | |
|---|---|---|---|---|
| | ME2 | MF2 | MQ | MR |
| Filler | Silica | Silica + | Silica + mod. | Silica + mod. |
| | | Sepiolite | Sepiolite | Sepiolite |
| | | | (Ex. 8) | (Ex. 9) |
| % Mg extracted | — | — | 33% | 35% |
| CB N550 | 25 | 25 | 25 | 25 |
| ZEOSIL 1115 | 30 | 20 | 20 | 20 |
| MK | | | | |
| Sepiolite | — | 7 | — | — |
| mod. sepiolite | — | — | 7.5 | — |
| Ex. 8 | | | | |
| mod. sepiolite | — | — | — | 8.5 |
| Ex. 9 | | | | |
| BR (Nd) | 60 | 60 | 60 | 60 |
| IR | 40 | 40 | 40 | 40 |
| Silane TESPT | 5 | 5 | 5 | 5 |
| Stearic acid | 1 | 1 | 1 | 1 |
| ZnO | 4 | 4 | 4 | 4 |
| TMQ | 1 | 1 | 1 | 1 |
| Compound of | 1.5 | 1.5 | 1.5 | 1.5 |
| the Disclosure, | | | | |
| e.g., a compound | | | | |
| of Tables A-J | | | | |
| TBBS 80 | 4 | 4 | 4 | 4 |
| Sulfur | 2.0 | 2.0 | 2.0 | 2.0 |

In some embodiments, the disclosure provides the rubber compositions of Table 81.

TABLE 81

| | ML1 | MM | MN |
|---|---|---|---|
| Filler | Silica | Silica + sepiolite | Silica + modified |
| | | | sepiolite (Ex. 4) |
| % Mg extracted | — | — | 35% |
| ZEOSIL 1165 MK | 85 | 75 | 75 |
| Sepiolite | — | 7 | — |
| mod. sepiolite Ex. 4 | — | — | 9.79 |
| (silane) | | | |
| BR (Nd) | 27 | 27 | 27 |
| S-SBR | 100 | 100 | 100 |
| SI 69 | 6.8 | 6.8 | 6 |
| Stearic acid | 2 | 2 | 2 |
| TDAE olio | 13 | 13 | 13 |
| ZnO | 2.4 | 2.4 | 2.4 |
| Compound of the | 3.5 | 3.5 | 3.5 |
| Disclosure, e.g., a | | | |
| compound of Tables | | | |
| A-J | | | |
| TBBS | 2.5 | 2.5 | 2.5 |
| TBZTD | 0.5 | 0.5 | 0.5 |
| Sulfur | 1 | 1 | 1 |

BR(Nd): (high cis) neodymium polybutadiene rubber (Europrene 40 Versalis);
S-SBR: styrene-butadiene rubber SLR 4630 (oil extended, contained in elastomer 73 phr) by Styron Europe GmbH;
SI 69: liquid Bis[3-(triethoxysilyl)propyl]tetrasulphide (Evonik)
Zeosil 1165MK: precipitated synthetic amorphous silica (Rhodia);
sepiolite: Pangel S9 (Tolsa);
TDAE: distilled aromatic oil;
ZnO: zinc oxide;
TBSS: N-tert-butyl-2-benzothiazyl-sulfenamide;
TBZTD: tetrabenzyl thiuram disulphide.

In some embodiments, the disclosure provides the rubber compositions of Table 82.

TABLE 82

| | ML2 | MS | MT |
|---|---|---|---|
| | Comp. | Inv. | Inv. |
| Filler | Silica | Silica + modified | Silica + modified |
| | | sepiolite (Ex. 8) | sepiolite (Ex. 9) |
| % Mg extracted | — | 33% | 35% |
| ZEOSIL 1165 MK | 85 | 55 | 55 |
| mod. sepiolite Ex. 8 | — | 15 | — |
| mod. sepiolite Ex. 9 | — | — | 17 |
| BR (Nd) | 27 | 27 | 27 |
| S-SBR | 100 | 100 | 100 |
| SI 69 | 8 | 8 | 8 |
| Stearic acid | 2 | 2 | 2 |
| Microcrystalline max | 2 | 2 | 2 |
| TDAE oil | 5 | 5 | 5 |
| N-Octylpyrrolidone | 2.5 | 2.5 | 2.5 |
| ZnO | 3 | 3 | 3 |
| TMQ | 1.75 | 1.75 | 1.75 |
| Compound of the | 3 | 3 | 3 |
| Disclosure, e.g., a | | | |
| compound of Tables | | | |
| A-J | | | |
| TBBS 80 | 2.5 | 2.5 | 2.5 |
| Sulfur | 1.4 | 1.4 | 1.4 |

microcrystalline wax: mixture of N-paraffins, Riowax BNO1 of SER S.P.A. (ozone protection);
TMQ: 2,2,4-Trimethyl-1,2-Dihydrquinoline, Rubatan 184 General Quimica SA (Antioxidant);
N-Octylpyrrolidone is Surfadone LP 100 of BASF;

In some embodiments, the disclosure provides the rubber compositions of Table 83.

TABLE 83

| | MO | MP |
|---|---|---|
| Filler | sepiolite | modified sepiolite (Ex. 5) |
| % Mg extracted | — | 26% |
| sepiolite Pangel S9 | 35 | — |
| mod. sepiolite Ex. 5 | — | 36.4 |
| S-SBR | 100 | 100 |
| TESPD | 2.8 | — |
| Stearic acid | 0.85 | 0.85 |
| ZnO | 2.7 | 2.7 |
| Compound of the Disclosure, | 1 | 1 |
| e.g., a compound of Tables | | |
| A-J | | |
| Sulfur | 2 | 2 |
| CBS | 1.5 | 1.5 |

S-SBR: styrene-butadiene rubber SLR 4630 by Styron Europe GmbH;
TESPD: Bis (3-triethoxysilylpropyl) disulphide by Aldrich;
stearic acid: Stearina TP8 by Undesa;
Sulfur: S8 (soluble sulfur) by Zolfo industria;
ZnO: zinc oxide by Zincol Ossidi;
CBS: N-cyclohexyl-2-benzothiazolsulfenamide Vulkacit CZ/C by Lanxess.

In some embodiments, the disclosure provides the rubber compositions and/or tires described in U.S. Pat. No. 11,365,306, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 84.

TABLE 84

| Components (phr) | Ex. 5A | Ex. 5B |
|---|---|---|
| NA | 70 | 70 |
| BR | 30 | 30 |
| Stearic acid | 1 | 1 |
| TESPT | 4 | 4 |
| N375 | 33 | 33 |
| Ebrosil H-155 AT | 16 | — |
| M1 (Pangel B5) | 16 | — |
| M2 (Silica:Pangel B5 1:1) | — | 32 |
| Zinc stearate | 2.5 | 2.5 |
| ZnO | 3.6 | 3.6 |
| Compound of the Disclosure, | 2 | 2 |
| e.g., a compound of Tables | | |
| A-J | | |
| TBBS | 1.75 | 1.75 |
| Sulphur | 4 | 4 |

NR: CV 60 viscosity controlled natural rubber supplied by Von Bundit (Thailand)
BR: high-cis nebimadium polybutadiene (Europrene 40 Versalis)
Stearic acid: Stearin TP8 from Undesa
TESPT: Bis[3-(triethoxysilyl)propyl]tetrasulphide on carbon black
N375: carbon black (Cabot)
Ebrosil H-155 AT: precipitated synthetic amorphous silica (IQE)
ZnO: zinc oxide from Zincol Oxides
TBBS: N-tert-butyl-2-benzothiazyl sulfonamide Rhenogran TBBS from Lanxess
Sulphur: S8 (soluble sulphur) from Zolfo Industria.
M1 and M2: comparative microbeads and according to the invention prepared in Example 1 (of U.S. Pat. No. 11,365,306).

In some embodiments, the disclosure provides the rubber compositions of Table 85.

TABLE 85

| Components (phr) | Ex. 5C | Ex. 5D | Ex. 5E | Ex. 5F | Ex. 5G |
|---|---|---|---|---|---|
| BR | 60 | 60 | 60 | 60 | 60 |
| IR | 40 | 40 | 40 | 40 | 40 |
| Stearic acid | 2 | 2 | 2 | 2 | 2 |
| TESPT | 3.6 | 3.6 | 3.6 | 3.6 | 3.6 |
| N550 | 25 | 25 | 25 | 25 | 25 |
| Ebrosil H-155 AT | 20 | 12.5 | 5 | 20 | 11.5 |
| M3 (Pangel S9 acid | 7.5 | — | — | — | — |
| treatment) | | | | | |
| M4A (silica:Pangel | — | 15 | — | — | — |
| S9 acid treatment | | | | | |
| 1:1) | | | | | |
| M4B (silica:Pangel | — | — | 22.5 | — | — |
| S9 acid treatment | | | | | |
| 2:1) | | | | | |
| M5 (Pangel B5 acid | — | — | — | 8.5 | — |
| treatment) | | | | | |
| M6 (silica:Pangel | — | — | — | — | 17 |
| B5 acid treatment | | | | | |
| 1:1) | | | | | |
| ZnO | 4 | 4 | 4 | 4 | 4 |
| Compound of the | 2 | 2 | 2 | 2 | 2 |
| Disclosure, e.g., a | | | | | |
| compound of Tables | | | | | |
| A-J | | | | | |
| TBBS | 1.8 | 1.8 | 1.8 | 1.8 | 1.8 |
| Sulphur | 2.8 | 2.8 | 2.8 | 2.8 | 2.8 |

IR: synthetic polyisoprene (NIZHNESKAMSK NEFTEKHIM)
N550: carbon black (Cabot)
M3, M4A, M4B, M5 and M6: materials prepared as described in Examples 2 and 3, and all the other ingredients are as defined in the previous Table 2.

In some embodiments, the disclosure provides the rubber compositions of Table 86.

TABLE 86

| | Ex. | Ex. | Ex. | Ex. | Ex. | Ex. |
|---|---|---|---|---|---|---|
| Components | 6A | 6B | 6C | 6D | 6E | 6F |
| (phr) | Inv. | Inv. | Inv. | Inv. | Inv. | Comp. |
| IR | 100 | 100 | 100 | 100 | 100 | 85 |
| BR 1,2 syn | — | — | — | — | — | 15 |
| Stearic acid | 2 | 2 | 2 | 2 | 2 | 2 |
| TESPT | 3 | 3 | 3 | 3 | 3 | — |
| ZEOSIL 1165 | 45 | 35 | 25 | 15 | 0 | — |
| MP | | | | | | |
| M2 (Pangel | 10 | 20 | 30 | 40 | 55 | — |
| B5 + | | | | | | |
| Silica 1:1) | | | | | | |
| Zinc stearate | 2 | 2 | 2 | 2 | 2 | 2 |
| ZnO | 3.5 | 3.5 | 3.5 | 3.5 | 3.5 | 3.5 |
| Compound of | 3 | 3 | 3 | 3 | 3 | 3 |
| the Disclosure, | | | | | | |
| e.g., a compound | | | | | | |
| of Tables A-J | | | | | | |
| Novolac | 3 | 3 | 3 | 3 | 3 | 3 |
| N375 | 7 | 7 | 7 | 7 | 7 | 40 |
| N550 | — | — | — | — | — | 25 |
| EMMM | 3 | 3 | 3 | 3 | 3 | 3 |
| TBBS | 1.3 | 1.3 | 1.3 | 1.3 | 1.3 | 1.3 |
| Sulphur | 5.3 | 5.3 | 5.3 | 5.3 | 5.3 | 5.3 |

wherein

| | | | | | | |
|---|---|---|---|---|---|---|
| Total silica | 50 | 45 | 40 | 35 | 27.5 | — |
| Pangel B5 | 5 | 10 | 15 | 20 | 27.5 | — |
| Total | 25:1 | 4.5:1 | 2.7:1 | 1.75:1 | 1:1 | — |
| silica/Pangel B5 | | | | | | |
| ratio | | | | | | |

BR 1,2 syn: RB840 is a syndiotactic 1,2-butadienic rubber of JSR;
TESPT: Bis[3-(triethoxysilyl)propyl] tetrasuphide from Evonik;
Zeosil 1165MP: solvent synthetic amorphous silica Solvay;
Novolac: Alnovol PN 760 from Allnex;
EMMM: is hexamethoxymethylmelamine at 65% by weight on inert support, Cyrez 964 P.C. from Cytec;
Sulphur: is polysulfuric Crystex OT33 from Eastman;
M2 microbeads comprising Pangel B5 sepiolite fibres and silica in a 1:1 ratio prepared as described in Ex. 1;
and the other ingredients are as defined above.

In some embodiments, the disclosure provides a vulcanisable elastomeric composition for tire components, comprising: (a) 100 phr of at least one diene elastomer, (b) 2 to 110 phr of microbeads, (c) 0 to 120 phr of a standard reinforcing filler, (d) 0.1 to 15 phr of a vulcanising agent, (e) 0.1 to 20 phr of a coupling agent, and (f) a Compound of the Disclosure, e.g., a compound of Tables A-J; wherein the microbeads have an average diameter of at least 50 microns and comprise (A) silica, and (B) silicate fibres with needle-shaped morphology of nanometric size, wherein the silica (A) and the silicate fibres (B) are present in a weight ratio of A to B ranging from 0.5:1 to 15:1 and in a total amount of A+B of at least 90% by weight of the microbeads when dry, and wherein the microbeads are prepared by a process comprising: providing an aqueous suspension comprising the silica A and the silicate fibres B in a weight ratio of A to B ranging from 0.5:1 to 15:1, from 0.7:1 to 10:1, or from 0.7:1 to 5:1, and in a total amount of A+B of at least 5% (w/w) of the aqueous suspension, and drying the aqueous suspension by nebulisation.

In some embodiments, the disclosure provides a vulcanisable or vulcanised elastomeric compound prepared by a process comprising mixing or mixing and vulcanizing an elastomeric composition comprising: (a) 100 phr of at least one diene elastomer, (b) 2 to 110 phr of microbeads, (c) 0 to 120 phr of a standard reinforcing filler, (d) 0.1 to 15 phr of a vulcanising agent, (e) 0.1 to 20 phr of a coupling agent, and (f) a Compound of the Disclosure, e.g., a compound of Tables A-J; wherein the microbeads have an average diameter of at least 50 microns and comprise (A) silica, and (B) silicate fibres with needle-shaped morphology of nanometric size, wherein the silica (A) and the silicate fibres (B) are present in a weight ratio of A to B ranging from 0.5:1 to 15:1 and in a total amount of A+B of at least 90% by weight of the microbeads when dry, and wherein the microbeads are prepared by a process comprising: providing an aqueous suspension comprising the silica (A) and the silicate fibres (B) in a weight ratio of A to B ranging from 0.5:1 to 15:1, from 0.7:1 to 10:1, or from 0.7:1 to 5:1, and in a total amount of A+B of at least 5% (w/w) of the aqueous suspension, and drying the aqueous suspension by nebulisation.

In some embodiments, the disclosure provides a tire component comprising a vulcanised elastomeric composition comprising: (a) 100 phr of at least one diene elastomer, (b) 2 to 110 phr of microbeads, (c) 0 to 120 phr of a standard reinforcing filler, (d) 0.1 to 15 phr of a vulcanising agent, (e) 0.1 to 20 phr of a coupling agent, and (f) a Compound of the Disclosure, e.g., a compound of Tables A-J; wherein the microbeads have an average diameter of at least 50 microns and comprise (A) silica, and (B) silicate fibres with needle-shaped morphology of nanometric size, wherein the silica (A) and the silicate fibres (B) are present in a weight ratio of A to B ranging from 0.5:1 to 15:1 and in a total amount of A+B of at least 90% by weight of the microbeads when dry, and wherein the microbeads are prepared by a process comprising: providing an aqueous suspension comprising the silica (A) and the silicate fibres (B) in a weight ratio of A to B ranging from 0.5:1 to 15:1, from 0.7:1 to 10:1, or from 0.7:1 to 5:1, and in a total amount of A+B of at least 5% (w/w) of the aqueous suspension, and drying the aqueous suspension by nebulisation.

In some embodiments, the disclosure provides a tire for vehicle wheels comprising at least one component, wherein the at least one component comprises a vulcanised elastomeric composition comprising: (a) 100 phr of at least one diene elastomer, (b) 2 to 110 phr of microbeads, (c) 0 to 120 phr of a standard reinforcing filler, (d) 0.1 to 15 phr of a vulcanising agent, (e) 0.1 to 20 phr of a coupling agent, and (f) a Compound of the Disclosure, e.g., a compound of Tables A-J; wherein the microbeads have an average diameter of at least 50 microns and comprise (A) silica, and (B) silicate fibres with needle-shaped morphology of nanometric size, wherein the silica A and the silicate fibres B are present in a weight ratio of A to B ranging from 0.5:1 to 15:1 and in a total amount of A+B of at least 90% by weight of the microbeads when dry, and wherein the microbeads are prepared by a process comprising: providing an aqueous suspension comprising the silica (A) and the silicate fibres (B) in a weight ratio of A to B ranging from 0.5:1 to 15:1, from 0.7:1 to 10:1, or from 0.7:1 to 5:1, and in a total amount of A+B of at least 5% (w/w) of the aqueous suspension, and drying the aqueous suspension by nebulisation.

In some embodiments, the disclosure provides the rubber compositions and/or tires described in U.S. Pat. No. 11,161,944, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 87.

TABLE 87

| Components (phr) | Ex. 8A | Ex. 8B |
|---|---|---|
| NR | 54 | 70 |
| BR | 30 | 30 |
| MB7 Ex. 7 (Pangel B5) | 32 | — |
| Stearic acid | 2 | 2 |
| TESPT Silane | 1 | 1 |
| ZnO | 3 | 3 |
| 6-PPD | 2.4 | 2.4 |
| CB | 45 | 45 |
| PANGEL B5 | — | 16 |
| TBBS | 1.4 | 1.4 |
| PVI | 0.3 | 0.3 |
| Sulphur | 2.76 | 2.76 |

NR: Natural rubber with controlled viscosity CV 60 provided by Von Bundit (Thailand).
BR(Nd): neodymium high-cis polybutadiene (Europrene 40 Versalis)
TESPT Silane: Bis[3-(triethoxysilyl)propyl]Tetrasulphide on carbon black;
CB: carbon black;
Zeosil 1115 MP: precipitated synthetic amorphous silica (Rhodia);
Pangel B5: organo-modified sepiolite by Tolsa;
ZnO: zinc oxide;
TBBS: N-tert-butyl-2-benzothiazyl sulfonamide;
Sulphur: S8 (soluble sulphur) by Zolfo industria.
MB7 is the composition prepared in Ex. 7; the 32 phr of MB7 comprise about 16 phr of fibres and 16 phr of rubber.

In some embodiments, the disclosure provides the rubber compositions of Table 88.

TABLE 88

| Components (phr) | Ex. 9A | Ex. 9B |
|---|---|---|
| NR | 31.5 | 40 |
| BR | 60 | 60 |
| MB7 | 17 | — |
| Pangel B5 modified with acid (i) | — | 8.5 |
| CB N550 | 25 | 25 |
| ZEOSIL 1115 MP | 20 | 20 |
| Stearic acid | 1 | 1 |
| TESPT Silane | 5 | 5 |
| ZnO | 4 | 4 |
| Compound of the Disclosure, e.g., | 1.5 | 1.5 |
| a compound of Tables A-J | | |
| TBBS 80 | 4 | 4 |
| TMQ | 1 | 1 |
| Sulphur | 2.3 | 2.3 |

NR: Natural rubber with controlled viscosity CV 60 provided by Von Bundit (Thailand);
BR(Nd): neodymium high-cis polybutadiene (Europrene 40 Versalis);
silane: 50% TESPT: Bis[3-(triethoxysilyl)propyl]Tetrasulphide on carbon black;
CB: carbon black;
Zeosil 1115 MP: precipitated synthetic amorphous silica (Rhodia);
ZnO: zinc oxide;
TMQ: polymerised 2,2,4-trimethyl-1,2-dihydroquinoline;
TBBS: N-tert-butyl-2-benzothiazyl sulfenamide;
Sulphur: S8 (soluble sulphur) by Zolfo industria
MB7 is the composition prepared in Ex. 7; the 17 phr of MB7 comprise about 8.5 phr of fibres and 8.5 phr of rubber)

In some embodiments, the disclosure provides a vulcanisable elastomeric composition for tire components, comprising: (a) 100 phr of one or more diene elastomers; (b) from 10 to 200 phr of a solid master elastomeric composition prepared by a process comprising: providing silicate fibres of nanometric size with needle-shaped morphology and an elastomeric latex comprising one or more diene elastomers and an aqueous phase, wherein a weight ratio of the fibres to the diene elastomer present in the latex is at least 0.5:1, combining the fibres and the latex to yield an aqueous suspension, bringing the pH of the aqueous suspension to, or maintaining the pH of the aqueous suspension within, a range from 7.5 to 12.0, bringing a volumetric ratio between the total volume of the aqueous suspension and the weight of the fibres to, or maintaining the volumetric ratio within, a range from 10:1 to 30:1 ml/g, to yield a final suspension (C), allowing the elastomeric composition to precipitate out of the final suspension (C); (c) from 0 to 120 phr of a standard reinforcing filler; (d) from 0.1 to 15 phr of a vulcanising agent; (e) from 0.1 to 20 phr of a coupling agent; and (f) a Compound of the Disclosure, e.g., a compound of Tables A-J.

In some embodiments, the disclosure provides a tire component comprising a vulcanisable elastomeric composition comprising: (a) 100 phr of one or more diene elastomers; (b) from 10 to 200 phr of a solid master elastomeric composition prepared by a process comprising: providing silicate fibres of nanometric size with needle-shaped morphology and an elastomeric latex comprising one or more diene elastomers and an aqueous phase, wherein a weight ratio of the fibres to the diene elastomer present in the latex is at least 0.5:1, combining the fibres and the latex to yield an aqueous suspension, bringing the pH of the aqueous suspension to, or maintaining the pH of the aqueous suspension within, a range from 7.5 to 12.0, bringing a volumetric ratio between the total volume of the aqueous suspension and the weight of the fibres to, or maintaining the volumetric ratio within, a range from 10:1 to 30:1 ml/g, to yield a final suspension (C), allowing the elastomeric composition to precipitate out of the final suspension (C); (c) from 0 to 120 phr of a standard reinforcing filler; (d) from 0.1 to 15 phr of a vulcanising agent; (e) from 0.1 to 20 phr of a coupling agent; and (f) a Compound of the Disclosure, e.g., a compound of Tables A-J.

In some embodiments, the disclosure provides a tire for vehicle wheels comprising at least one tire component comprising a vulcanisable elastomeric composition comprising: (a) 100 phr of one or more diene elastomers; (b) from 10 to 200 phr of a solid master elastomeric composition prepared by a process comprising: providing silicate fibres of nanometric size with needle-shaped morphology and an elastomeric latex comprising one or more diene elastomers and an aqueous phase, wherein a weight ratio of the fibres to the diene elastomer present in the latex is at least 0.5:1, combining the fibres and the latex to yield an aqueous suspension, bringing the pH of the aqueous suspension to, or maintaining the pH of the aqueous suspension within, a range from 7.5 to 12.0, bringing a volumetric ratio between the total volume of the aqueous suspension and the weight of the fibres to, or maintaining the volumetric ratio within, a range from 10:1 to 30:1 ml/g, to yield a final suspension (C), allowing the elastomeric composition to precipitate out of the final suspension (C); (c) from 0 to 120 phr of a standard reinforcing filler; (d) from 0.1 to 15 phr of a vulcanising agent; (e) from 0.1 to 20 phr of a coupling agent; and (f) a Compound of the Disclosure, e.g., a compound of Tables A-J.

In some embodiments, the disclosure provides a tire for vehicle wheels comprising at least one tire component comprising a vulcanized elastomeric composition prepared by, at least partially, vulcanizing an elastomeric composition comprising: (a) 100 phr of one or more diene elastomers; (b) from 10 to 200 phr of a solid master elastomeric composition prepared by a process comprising: providing silicate fibres of nanometric size with needle-shaped morphology and an elastomeric latex comprising one or more diene elastomers and an aqueous phase, wherein a weight ratio of the fibres to the diene elastomer present in the latex is at least 0.5:1, combining the fibres and the latex to yield an aqueous suspension, bringing the pH of the aqueous suspension to, or maintaining the pH of the aqueous suspension within, a range from 7.5 to 12.0, bringing a volumetric ratio between the total volume of the aqueous suspension and the weight of the fibres to, or maintaining the volumetric ratio within, a range from 10:1 to 30:1 ml/g, to yield a final suspension (C), allowing the elastomeric composition to precipitate out of the final suspension (C); (c) from 0 to 120 phr of a standard reinforcing filler; (d) from 0.1 to 15 phr of a vulcanising agent; (e) from 0.1 to 20 phr of a coupling agent; and (f) a Compound of the Disclosure, e.g., a compound of Tables A-J.

In some embodiments, the disclosure provides the rubber compositions and/or tires described in U.S. Pat. No. 11,091,608, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 89.

TABLE 89
Formulations for elastomeric compositions

| | Ex. | Ex. | Ex. | Ex. | Ex. | Ex. | Ex. | Ex. |
|---|---|---|---|---|---|---|---|---|
| | 8 | 9 | 10 | 11 | 12 | 13 | 14 | 15 |
| Ingredient | Phr | | | | | | | |
| NR^{a} | 15.00 | 15.00 | 15.00 | 15.00 | 15.00 | 15.00 | 15.00 | 15.00 |
| S-SBR^{b} | 96.25 | 96.25 | 96.25 | 96.25 | 96.25 | 96.25 | 96.25 | 96.25 |
| BR^{c} | 15.00 | 15.00 | 15.00 | 15.00 | 15.00 | 15.00 | 15.00 | 15.00 |
| Silane Si 69^{d} | 5.20 | 5.20 | 5.20 | 5.20 | 5.20 | 5.20 | 5.20 | 5.20 |
| Silica^{e} | 65.00 | 65.00 | 65.00 | 65.00 | 65.00 | 65.00 | 65.00 | 65.00 |
| MES oil^{f} | 10.00 | 10.00 | 10.00 | 10.00 | 10.00 | 10.00 | 10.00 | 10.00 |
| Stearic acid^{g} | 2.00 | 2.00 | 2.00 | 2.00 | 2.00 | 2.00 | 2.00 | 2.00 |
| Zinc oxide^{h} | 2.50 | 2.50 | 2.50 | 2.50 | 2.50 | 2.50 | 2.50 | 2.50 |
| Compound of | 2.00 | 2.00 | 2.00 | 2.00 | 2.00 | 2.00 | 2.00 | 2.00 |
| the Disclosure, | | | | | | | | |
| e.g., a | | | | | | | | |
| compound of | | | | | | | | |
| Tables A-J | | | | | | | | |
| TBBS^{k} | 1.80 | 1.80 | 1.80 | 1.80 | 1.80 | 1.80 | 1.80 | 1.80 |
| Sulphur^{l} | 1.20 | 1.20 | 1.20 | 1.20 | 1.20 | 1.20 | 1.20 | 1.20 |
| DPG80^{m} | 0.00 | 2.40 | 0.00 | 0.00 | 0.00 | 0.00 | 0.00 | 0.00 |
| Serinolⁿ | 0.00 | 0.00 | 0.83 | 0.00 | 0.00 | 0.00 | 0.00 | 0.00 |
| camphor imine | 0.00 | 0.00 | 0.00 | 2.04 | 0.00 | 0.00 | 0.00 | 0.00 |
| (Ex. 4) | | | | | | | | |
| cinnamaldehyde | 0.00 | 0.00 | 0.00 | 0.00 | 1.87 | 0.00 | 0.00 | 0.00 |
| imine (Ex. 5) | | | | | | | | |
| serinol | 0.00 | 0.00 | 0.00 | 0.00 | 0.00 | 1.19 | 0.00 | 0.00 |
| oxazolidine | | | | | | | | |
| (Ex. 1) | | | | | | | | |
| isoserinol | 0.00 | 0.00 | 0.00 | 0.00 | 0.00 | 0.00 | 1.19 | 0.00 |
| oxazolidine | | | | | | | | |
| (Ex. 2) | | | | | | | | |
| serinol amide | 0.00 | 0.00 | 0.00 | 0.00 | 0.00 | 0.00 | 0.00 | 1.34 |
| (Ex. 7) | | | | | | | | |

^{a}natural poly(1,4-cis-isoprene) (NR) commercial grade SMR GP (from Lee Rubber)
^{b}Styrene-butadiene rubber from solution; commercial grade Styron 4630 (from Styron), 25% as styrene content
^{c}Polybutadiene; commercial grade Europrene neocis (from Polimeri Europa)
^{d}bis[3-(triethoxysilyl)propyl]tetrasulphide from Evonik
^{e}ZEOSIL 1165MP (supplier SOLVAY RHODIA OPERATIONS)
^{f}Aliphatic oil, from Eni
^{g}Stearin N, from SOGIS
^{h}from Zincol Ossidi
^{k}N-tert-butyl-2-benzothiazyl sulphenamide (TBBS), from Flexsys
^{l}from Solfotecnica
^{m}Diphenylguanidine (Rhenogran ® DPG80), from Rhein Chemie Additives
ⁿ2-amino-1,3-propanediol, from Bracco

In some embodiments, the disclosure provides the rubber compositions of Table 90.

TABLE 90
Formulations for elastomeric compositions

| | | |
|---|---|---|
| Ex. 20 | Ex. 21 | Ex. 22 |

| | |
|---|---|
| Ingredient | Phr |

| | | | |
|---|---|---|---|
| S-SBR HP755^{a} | 90.00 | 90.00 | 90.00 |
| BR^{b} | 35.00 | 35.00 | 35.00 |
| Silica^{c} | 50.00 | 50.00 | 50.00 |
| Silane TESPT/Carbon black^{d} | 11.20 | 11.20 | 11.20 |
| Silica Zeosil 1165^{e} | 20.00 | 20.00 | 20.00 |
| MES oil^{f} | 8.00 | 8.00 | 8.00 |
| Stearic acid^{g} | 2.00 | 2.00 | 2.00 |
| Zinc oxide^{h} | 2.50 | 2.50 | 2.50 |
| Compound of the Disclosure, | 2.00 | 2.00 | 2.00 |
| e.g., a compound of Tables A-J | | | |
| Sulphur^{k} | 1.20 | 1.20 | 1.20 |
| TBBS^{l} | 2.00 | 2.00 | 2.00 |
| DPG80^{m} | 2.40 | 0.00 | 0.00 |
| Serinolⁿ | 0.00 | 0.83 | 0.00 |
| Camphor imine (Ex. 4) | 0.00 | 0.00 | 2.04 |

^{a}Styrene-butadiene rubber from solution; commercial grade Styron 4630, from Styron. 25% as styrene content
^{b}Polybutadiene; commercial grade Europrene neocis, from Polimeri Europa
^{c,e}ZEOSIL 1165MP, from SOLVAY RHODIA OPERATIONS
^{d}Silane TESPT: bis[3-(triethoxysilyl)propyl]tetrasulphide TESPT/Carbon black N330 = 1/1, from EVONIK
^{f}Aliphatic oil, from Eni
^{g}Stearin N, from SOGIS
^{h}from Zincol Ossidi
^{k}from Solfotecnica
^{l}N-tert-butyl-2-benzothiazyl sulphenamide, from Flexsys
^{m}Diphenylguanidine (Rhenogran ® DPG80), from Rhein Chemie Additives
ⁿ2-amino-1,3-propanediol, from Bracco

In some embodiments, the disclosure provides the rubber compositions of Table 91.

TABLE 91
Formulations for elastomeric compositions

| | Ex. 23 | Ex. 24 | Ex. 25 | Ex. 26 |
|---|---|---|---|---|
| Ingredient | Phr | | | |
| NR^{a} | 15.00 | 15.00 | 15.00 | 15.00 |
| BR^{b} | 15.00 | 15.00 | 15.00 | 15.00 |
| HP755^{c} | 96.25 | 96.25 | 96.25 | 96.25 |
| Silica^{d} | 85.00 | 85.00 | 85.00 | 85.00 |
| Silane TESPT/Carbon | 13.00 | 13.00 | 13.00 | 13.00 |
| black N330 = 1/1^{e} | | | | |
| Stearic acid^{f} | 2.00 | 2.00 | 2.00 | 2.00 |
| TDAE oil^{g} | 8.00 | 8.00 | 8.00 | 8.00 |
| TMQ^{h} | 1.25 | 1.25 | 1.25 | 1.25 |
| Waxⁱ | 1.25 | 1.25 | 1.25 | 1.25 |
| Adhesive resin^{k} | 4.50 | 4.50 | 4.50 | 4.50 |
| Zinc oxide^{l} | 2.50 | 2.50 | 2.50 | 2.50 |
| Compound of the | 2.00 | 2.00 | 2.00 | 2.00 |
| Disclosure, e.g., a | | | | |
| compound of Tables A-J | | | | |
| AMPDⁿ | 0.00 | 0.00 | 1.50 | 0.00 |
| TRIS AMINO^{o} | 0.00 | 0.00 | 0.00 | 1.50 |
| Sulphur^{p} | 1.40 | 1.40 | 1.40 | 1.40 |
| TBBS^{q} | 2.00 | 2.00 | 2.00 | 2.00 |
| DPG80^{r} | 0.00 | 2.50 | 0.00 | 0.00 |
| PVI^{s} | 0.20 | 0.20 | 0.20 | 0.20 |

^{a}SMR GP = Natural rubber (poly(1,4-cis)isoprene, supplier SENG HIN RUBBER)
^{b}BR40 Europrene neocis = High cis polybutadiene (97% min). Neodymium polymerized. (supplier VERSALIS)
^{c}HP755 = Solution Styrene-butadiene copolymer (styrene 39.5% and vinyl 38.5% on the dienic portion equivalent to 23.3% on the polymer), extended with 37.5 phr of TDAE oil (SUPPLIER JAPAN SYNTHETIC RUBBER)
^{d}SILICA ZEOSIL 1165MP (supplier SOLVAY RHODIA OPERATIONS)
^{e}TESPT (50%) = Silane TESPT/Carbon black N330 = 1/1 = ″Bis[3-(triethoxysilyl)propyl]tetrasulphide (supplier EVONIK)
^{f}STEARIC acid = STEARIN N (supplier: SOGIS)
^{g}TDAE oil = Treated distillate aromatic extract (TDAE) VIVATEC 500 Supplier: H&R
^{h}TMQ = 2,2,4-trimethyl-1,2-dihydroquinoline polymerized (trade name = VULCANOX HS/LG; supplier = LANXESS)
ⁱWAX = Mixture of normal-paraffins, prevailing, and iso-paraffins (trade name: REDEZON 517 supplier REPSOL YPF)
^{k}ADHESIVE RESIN = ALPHA-METHYL-STYRENE THERMOPLASTIC RESIN (trade name: IMPERA P1504 Supplier EASTMAN)
^{l}ZINC OXIDE (supplier = ZINCOL OSSIDI)
ⁿ2-amino-2-methylpropane-1,3-diol (AMPD) (from ANGUS).
^{o}Tris(hydroxymethyl)aminomethane (TRIS AMINO) (from ANGUS),
^{p}Sulphur (from ZOLFINDUSTRIA)
^{q}N-tert-butyl-2-benzothiazyl sulphenamide (TBBS) (from Flexsys)
^{r}Diphenylguanidine (Rhenogran ® DPG80) (from Rhein Chemie Additives)
^{s}N-cyclohexyl-thiophthalimide (PVI) (Vulkalent ®G, from Lanxess)

In some embodiments, the disclosure provides the rubber compositions of Table 92.

TABLE 92
Formulations for elastomeric compositions

| | Ex. 27 | Ex. 28 | Ex. 29 | Ex. 30 | Ex. 31 |
|---|---|---|---|---|---|
| Ingredient | Phr | | | | |
| NR^{a} | 60.00 | 60.00 | 60.00 | 60.00 | 60.00 |
| BR^{b} | 40.00 | 40.00 | 40.00 | 40.00 | 40.00 |
| Carbon black N115^{c} | 55.00 | 55.00 | 55.00 | 55.00 | 55.00 |
| Silica VN3^{d} | 15.00 | 15.00 | 15.00 | 15.00 | 15.00 |
| Silane TESPT/Carbon | 3.00 | 3.00 | 3.00 | 3.00 | 3.00 |
| black N330 = 1/1^{e} | | | | | |
| Stearic acid^{f} | 1.30 | 1.30 | 1.30 | 1.30 | 1.30 |
| Zinc oxide^{g} | 3.00 | 3.00 | 3.00 | 3.00 | 3.00 |
| Zinc stearate^{h} | 2.00 | 2.00 | 2.00 | 2.00 | 2.00 |
| Waxⁱ | 2.00 | 2.00 | 2.00 | 2.00 | 2.00 |
| TMQ^{k} | 1.00 | 1.00 | 1.00 | 1.00 | 1.00 |
| Compound of the | 3.00 | 3.00 | 3.00 | 3.00 | 3.00 |
| Disclosure, e.g., a | | | | | |
| compound of Tables A-J | | | | | |
| Sulphur^{m} | 1.80 | 1.80 | 1.80 | 1.80 | 1.80 |
| CBSⁿ | 1.10 | 1.10 | 1.10 | 1.10 | 1.10 |
| DPG80^{o} | 0.00 | 1.25 | 0.00 | 0.00 | 0.00 |
| AMPD^{p} | 0.00 | 0.00 | 0.75 | 1.00 | 0.00 |
| TRIS AMINO^{q} | 0.00 | 0.00 | 0.00 | 0.00 | 1.00 |
| PVI^{r} | 0.30 | 0.30 | 0.30 | 0.30 | 0.30 |

^{a}SMR GP = Natural rubber (poly(1,4-cis)isoprene, supplier SENG HIN RUBBER)
^{b}BR40 Europrene neocis = High cis polybutadiene (97% min.). From catalysis with neodymium. (supplier VERSALIS)
^{c}from Cabot
^{d}ULTRASIL ® VN 3 GR from Evonik
^{e}from Evonik; Silane TESPT: bis[3-(triethoxysilyl)propyl]tetrasulphide
^{f}Radiacid 444 (Oleon)
^{g}from Zincol Ossidi
^{h}from Sogis
ⁱWAX = Mixture of normal-paraffins, prevailing, and iso-paraffins (trade name: REDEZON 517 supplier REPSOL YPF)
^{k}TMQ = 2,2,4-trimethyl-1,2-dihydroquinoline polymerized (trade name = VULCANOX HS/LG; supplier = LANXESS)
^{m}Sulphur (from ZOLFINDUSTRIA)
ⁿN-cyclohexyl-2-benzothiazyl sulphenamide (CBS) (from Flexsys)
^{o}Diphenylguanidine (Rhenogran ® DPG80) (from Rhein Chemie Additives)
^{p}2-amino-2-methylpropane-1,3-diol (AMPD) (from ANGUS).
^{q}Tris(hydroxymethyl)aminomethane (TRIS AMINO) (from ANGUS),
^{r}N-cyclohexyl-thiophthalimide (PVI) (Vulkalent ®G, from Lanxess)

In some embodiments, the disclosure provides a vulcanizable elastomeric composition comprising: (1) a Compound of the Disclosure, e.g., a compound of Tables A-J, (2) at least one diene elastomer, (3) at least one reinforcing filler, (4) at least one sulfur based vulcanization system, and (5) at least one compound of formula (I) of U.S. Pat. No. 11,091,608:

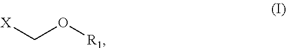

wherein the compound of formula (I) is present in an amount ranging from 0.3 phr to 20 phr, and wherein X is chosen from:

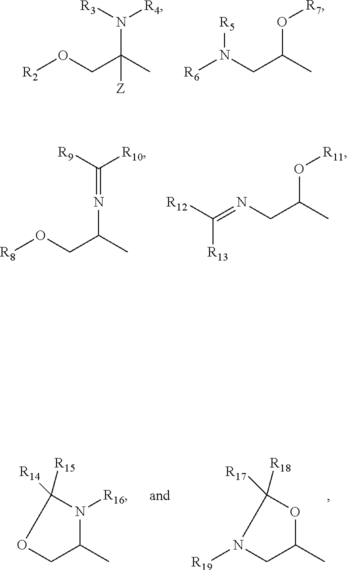

wherein: R₁, R₂, R₇, R₈, R₁₁, R₁₆ and R₁₉ are independently chosen from: hydrogen, C₁-C₂₂ linear or branched alkyl, C₂-C₂₂ linear or branched alkenyl or alkinyl, aryl, C₁-C₂₂ linear or branched alkyl-aryl, C₂-C₂₂ linear or branched alkenyl-aryl, C₂-C₂₂ linear or branched alkinyl-aryl, C₂-C₂₂ linear or branched acyl-alkyl, C₃-C₂₂ linear or branched acyl-alkenyl or acyl-alkinyl, acyl-aryl, acyl-alkyl-aryl with C₂-C₂₂ linear or branched acyl-alkyl, acyl-alkenyl-aryl with C₃-C₂₂ linear or branched acyl-alkenyl, acyl-alkinyl-aryl with C₃-C₂₂ linear or branched acyl-alkinyl, and heteroaryl; at least one of R₃ and R₄ and at least one of R₅ and R₆ is hydrogen; only one of R₃ and R₄ and only one of R₅ and R₆ are chosen from acyl, acyl-aryl, acyl-alkyl-aryl with C₂-C₂₂ linear or branched acyl-alkyl, acyl-alkenyl-aryl with C₃-C₂₂ linear or branched acyl-alkenyl, and acyl-alkinyl-aryl with C₃-C₂₂ linear or branched acyl-alkinyl; Z is chosen from: hydrogen, methyl, ethyl, and hydroxymethyl; R₉ and R₁₀ are independently chosen from: hydrogen, a C₂-C₂₂ linear or branched alkenyl group, a C₂-C₂₂ linear or branched alkylidene group, an aryl group, and an alkyl-aryl group with C₁-C₂₂ linear or branched alkyl, wherein: R₉ and R₁₀ are not simultaneously hydrogen; or R₉ and R₁₀ may form a ring, which may contain from 3 to 20 atoms and one or two heteroatoms selected from O or N, wherein: when the ring comprises one or two heteroatoms the total number of ring atoms is 5 or 6; when the ring contains two heteroatoms, the heteroatoms may be in position 1,2 or 1,3, when position 1 is the position nearest to the carbon atom of the imine group; or R₉ and R¹⁰ may form polycycles formed by a number of carbon atoms which can range from 5 to 20, fused or spiro, with or without bridgehead atoms; R₁₂ and R₁₃ are independently chosen from: hydrogen, a C₂-C₂₂ linear or branched alkenyl group, a C₂-C₂₂ linear or branched alkylidene group, an aryl group, and an alkyl-aryl group with C₁-C₂₂ linear or branched alkyl, wherein: R₁₂ and R₁₃ are not simultaneously hydrogen; or R₁₂ and R₁₃ may form a ring, which may contain from 3 to 20 atoms and one or two heteroatoms selected from O or N, wherein: when the ring comprises one or two heteroatoms, the total number of ring atoms is 5 or 6; when the ring contains two heteroatoms, the heteroatoms may be in position 1,2 or 1,3, when position 1 is the position that is nearest to the carbon atom of the imine group; or R₁₂ and R₁₃ can form polycycles formed by a number of carbon atoms that can range from 5 to 20, fused or spiro, with or without bridgehead atoms; R₁₄, R₁₅, R₁₇, and R₁₈ are independently chosen from: hydrogen, C₁-C₂₂ linear or branched alkyl with no branch on C₁, C₂-C₂₂ linear or branched alkenyl or alkinyl, alkyl-aryl with C₁-C₂₂ linear or branched alkyl with the aryl group not directly bound to the oxazolidine, alkenyl-aryl with C₂-C₂₂ linear or branched alkenyl with the aryl group not directly bound to the oxazolidine, alkinyl-aryl with C₂-C₂₂ linear or branched alkinyl with the aryl group not directly bound to the oxazolidine, C₂-C₂₂ linear or branched acyl-alkyl, and C₃-C₂₂ linear or branched acyl-alkenyl or acyl-alkinyl; or R₁₄, R₁₅, R₁₇, and R₁₈ may form cycles of 5 and 6 carbon atoms.

In some embodiments, the disclosure provides a process for the vulcanization of elastomeric compositions comprising: mixing a Compound of the Disclosure, e.g., a compound of Tables A-J, at least one diene elastomer, at least one sulfur based vulcanization system, at least one reinforcing filler, optionally at least one accelerator chosen from: thiazoles, sulphenamides and xanthogenates, in an amount ranging from 0.1 to 10 phr, and at least one accelerator of formula (I) of U.S. Pat. No. 11,091,608:

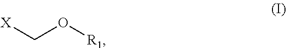

to form a blend, wherein the compound of formula (I) is present in an amount from 0.3 phr to 20 phr, and wherein X is chosen from:

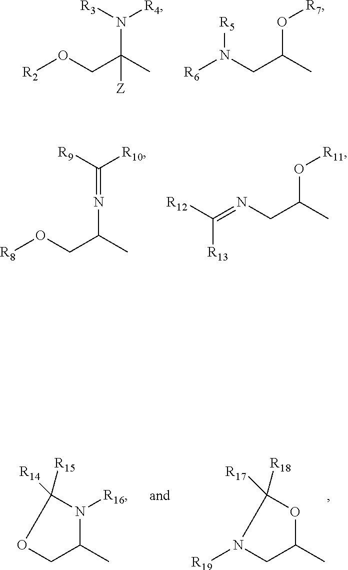

wherein: R₁, R₂, R₇, R₈, R₁₁, R₁₆ and R₁₉ are independently chosen from: hydrogen, C₁-C₂₂ linear or branched alkyl, C₂-C₂₂ linear or branched alkenyl or alkinyl, aryl, C₁-C₂₂ linear or branched alkyl-aryl, C₂-C₂₂ linear or branched alkenyl-aryl, C₂-C₂₂ linear or branched alkinyl-aryl, C₂-C₂₂ linear or branched acyl-alkyl, C₃-C₂₂ linear or branched acyl-alkenyl or acyl-alkinyl, acyl-aryl, acyl-alkyl-aryl with C₂-C₂₂ linear or branched acyl-alkyl, acyl-alkenyl-aryl with C₃-C₂₂ linear or branched acyl-alkenyl, acyl-alkinyl-aryl with C₃-C₂₂ linear or branched acyl-alkinyl, and heteroaryl; at least one of R₃ and R₄ and at least one of R₅ and R₆ is hydrogen; only one of R₃ and R₄ and only one of R₅ and R₆ are chosen from acyl, acyl-aryl, acyl-alkyl-aryl with C₂-C₂₂ linear or branched acyl-alkyl, acyl-alkenyl-aryl with C₃-C₂₂ linear or branched acyl-alkenyl, and acyl-alkinyl-aryl with C₃-C₂₂ linear or branched acyl-alkinyl; Z is chosen from: hydrogen, methyl, ethyl, and hydroxymethyl; R₉ and R₁₀ are independently chosen from: hydrogen, a C₂-C₂₂ linear or branched alkenyl group, a C₂-C₂₂ linear or branched alkylidene group, an aryl group, and an alkyl-aryl group with C₁-C₂₂ linear or branched alkyl, wherein: R₉ and R₁₀ are not simultaneously hydrogen; or R₉ and R₁₀ may form a ring, which may contain from 3 to 20 atoms and one or two heteroatoms selected from 0 or N, wherein: when the ring comprises one or two heteroatoms the total number of ring atoms is 5 or 6; when the ring contains two heteroatoms, the heteroatoms may be in position 1,2 or 1,3, when position 1 is the position nearest to the carbon atom of the imine group; or R₉ and R₁₀ may form polycycles formed by a number of carbon atoms which can range from 5 to 20, fused or spiro, with or without bridgehead atoms; R₁₂ and R₁₃ are independently chosen from: hydrogen, a C₂-C₂₂ linear or branched alkenyl group, a C₂-C₂₂ linear or branched alkylidene group, an aryl group, and an alkyl-aryl group with C₁-C₂₂ linear or branched alkyl, wherein: R₁₂ and R₁₃ are not simultaneously hydrogen; or R₁₂ and R₁₃ may form a ring, which may contain from 3 to 20 atoms and one or two heteroatoms selected from O or N, wherein: when the ring comprises one or two heteroatoms, the total number of ring atoms is 5 or 6; when the ring contains two heteroatoms, the heteroatoms may be in position 1,2 or 1,3, when position 1 is the position that is nearest to the carbon atom of the imine group; or R¹² and R¹³ can form polycycles formed by a number of carbon atoms that can range from 5 to 20, fused or spiro, with or without bridgehead atoms; R₁₄, R₁₅, R₁₇, and R₁₈ are independently chosen from: hydrogen, C₁-C₂₂ linear or branched alkyl with no branch on C₁, C₂-C₂₂ linear or branched alkenyl or alkinyl, alkyl-aryl with C₁-C₂₂ linear or branched alkyl with the aryl group not directly bound to the oxazolidine, alkenyl-aryl with C₂-C₂₂ linear or branched alkenyl with the aryl group not directly bound to the oxazolidine, alkinyl-aryl with C₂-C₂₂ linear or branched alkinyl with the aryl group not directly bound to the oxazolidine, C₂-C₂₂ linear or branched acyl-alkyl, and C₃-C₂₂ linear or branched acyl-alkenyl or acyl-alkinyl; or R₁₄, R₁₅, R₁₇, and R₁₈ may form cycles of 5 and 6 carbon atoms; and heating the blend to a pressure ranging from 5×10⁵ to 20×10⁵ Pa, and at a temperature ranging from 120 to 200° C., for a time ranging from 5 to 200 minutes.

In some embodiments, the disclosure provides a tire comprising at least one semi-finished product comprising a vulcanizable elastomeric composition comprising: Compound of the Disclosure, e.g., a compound of Tables A-J, at least one diene elastomer, at least one reinforcing filler, at least one sulfur based vulcanization system, and at least one compound of formula (I) of U.S. Pat. No. 11,091,608:

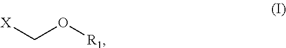

wherein the compound of formula (I) is present in an amount ranging from 0.3 phr to 20 phr, and wherein X is chosen from:

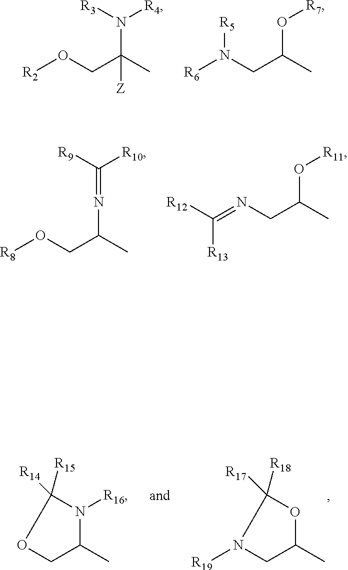

wherein: R₁, R₂, R₇, R₈, R₁₁, R₁₆ and R₁₉ are independently chosen from: hydrogen, C₁-C₂₂ linear or branched alkyl, C₂-C₂₂ linear or branched alkenyl or alkinyl, aryl, C₁-C₂₂ linear or branched alkyl-aryl, C₂-C₂₂ linear or branched alkenyl-aryl, C₂-C₂₂ linear or branched alkinyl-aryl, C₂-C₂₂ linear or branched acyl-alkyl, C₃-C₂₂ linear or branched acyl-alkenyl or acyl-alkinyl, acyl-aryl, acyl-alkyl-aryl with C₂-C₂₂ linear or branched acyl-alkyl, acyl-alkenyl-aryl with C₃-C₂₂ linear or branched acyl-alkenyl, acyl-alkinyl-aryl with C₃-C₂₂ linear or branched acyl-alkinyl, and heteroaryl; at least one of R₃ and R₄ and at least one of R₅ and R₆ is hydrogen; only one of R₃ and R₄ and only one of R₅ and R₆ are chosen from acyl, acyl-aryl, acyl-alkyl-aryl with C₂-C₂₂ linear or branched acyl-alkyl, acyl-alkenyl-aryl with C₃-C₂₂ linear or branched acyl-alkenyl, and acyl-alkinyl-aryl with C₃-C₂₂ linear or branched acyl-alkinyl; Z is chosen from: hydrogen, methyl, ethyl, and hydroxymethyl; R₉ and R₁₀ are independently chosen from: hydrogen, a C₂-C₂₂ linear or branched alkenyl group, a C₂-C₂₂ linear or branched alkylidene group, an aryl group, and an alkyl-aryl group with C₁-C₂₂ linear or branched alkyl, wherein: R₉ and R₁₀ are not simultaneously hydrogen; or R₉ and R₁₀ may form a ring, which may contain from 3 to 20 atoms and one or two heteroatoms selected from O or N, wherein: when the ring comprises one or two heteroatoms the total number of ring atoms is 5 or 6; when the ring contains two heteroatoms, the heteroatoms may be in position 1,2 or 1,3, when position 1 is the position nearest to the carbon atom of the imine group; or R₉ and R₁₀ may form polycycles formed by a number of carbon atoms which can range from 5 to 20, fused or spiro, with or without bridgehead atoms; R₁₂ and R₁₃ are independently chosen from: hydrogen, a C₂-C₂₂ linear or branched alkenyl group, a C₂-C₂₂ linear or branched alkylidene group, an aryl group, and an alkyl-aryl group with C₁-C₂₂ linear or branched alkyl, wherein: R₁₂ and R₁₃ are not simultaneously hydrogen; or R₁₂ and R₁₃ may form a ring, which may contain from 3 to 20 atoms and one or two heteroatoms selected from O or N, wherein: when the ring comprises one or two heteroatoms, the total number of ring atoms is 5 or 6; when the ring contains two heteroatoms, the heteroatoms may be in position 1,2 or 1,3, when position 1 is the position that is nearest to the carbon atom of the imine group; or R¹² and R¹³ can form polycycles formed by a number of carbon atoms that can range from 5 to 20, fused or spiro, with or without bridgehead atoms; R₁₄, R₁₅, R₁₇, and R₁₈ are independently chosen from: hydrogen, C₁-C₂₂ linear or branched alkyl with no branch on C₁, C₂-C₂₂ linear or branched alkenyl or alkinyl, alkyl-aryl with C₁-C₂₂ linear or branched alkyl with the aryl group not directly bound to the oxazolidine, alkenyl-aryl with C₂-C₂₂ linear or branched alkenyl with the aryl group not directly bound to the oxazolidine, alkinyl-aryl with C₂-C₂₂ linear or branched alkinyl with the aryl group not directly bound to the oxazolidine, C₂-C₂₂ linear or branched acyl-alkyl, and C₃-C₂₂ linear or branched acyl-alkenyl or acyl-alkinyl; or R₁₄, R₁₅, R₁₇, and R₁₈ may form cycles of 5 and 6 carbon atoms.

In some embodiments, the disclosure provides the rubber compositions and/or tires described in U.S. Pat. No. 11,091,607, wherein an antidegradant, e.g., an antioxidant, e.g., 6PPD, in each rubber composition and/or tire is either partially or completely substituted with a Compound of the Disclosure, e.g., a compound of Tables A-J.

In some embodiments, the disclosure provides the rubber compositions of Table 93.

TABLE 93

| | | |
|---|---|---|
| | Ex. 4b | |
| Ex. 4a | Invention | |
| Comparative | SIL − | Conventional |
| SIL + | TMMS − | bead |
| TMMS | MAPOSS | material |

Component (amount in phr)

| | | | |
|---|---|---|---|
| SBR 2525 | 100 | 100 | |
| IR | | | 100 |
| Silica 1165 | 30 | | |
| TMMS | 3 | | |
| SIL − TMMS − | | 33 | |
| MAPOSS10 | | | |
| N375 | | | 70 |
| Stearic acid | 2 | 2 | 2 |
| Compound of the | 2 | 2 | 2 |
| Disclosure, e.g., a | | | |
| compound of Tables | | | |
| A-J | | | |
| ZnO | 3.5 | 3.5 | 8 |
| Reactive phenolic resin | | | 15 |
| DCP | 2 | 2 | |
| HMMM 65% | | | 6 |
| TBBS | | | 1 |
| sulphur | | | 7 |

SBR 2525: containing 25% of vinyl on total monomers;
IR: Synthetic polyisoprene by Nizhnekamskneftekhim;
Silica 1165: Zeosil 1165 by Rhodia;
TMMS: trimethoxypropyl methacrylsilane Sigma Aldrich;
SIL − TMMS − MAPOSS10: derivatised silica prepared in Example 3°;
N375: carbon black by Birla Carbon;
Stearic acid: Stearina TP8 by Undesa;
Reactive phenolic resin: DUREZ 12686 by Sumitomo Bakelite Europe NV;
ZnO: zinc oxide by Zincol Ossidi;
DCP: dicumyl peroxide by Arkema;
65% HMMM: hexamethoxymethylmelamine (65%) on an inert support, Cyrez 964 P.C.;
TBBS: N-tert-butyl-2-benzothiazilsulphenamide, Vulkacit ® NZ/EGC, Lanxess;
Sulphur: Redball Superfine, International Sulphur Inc;
G′ (3%) and G′ (9%) represent the shear moduli measured at 70° C., 10 Hz at 3% and 9% of dynamic deformation;
dG′ (0.5-10) indicates the difference between the shear modulus at 0.5% and 10% of dynamic deformation measured at 10 Hz, 70° C. with a Monsanto R.P.A. 2000;
Tan d (Tan delta) represents the value of the ratio between G′ and G″ recorded at 10 Hz, 70° C. at a deformation of 3% and 9%;
dG′ (0.5-10)/G′ (9) is the dG′ value (0.5-10) expressed as a percentage with respect to the dynamic shear modulus value measured at 9%, an index of the extent of the Payne effect with respect to the rigidity of the blend.

In some embodiments, the disclosure provides the rubber compositions of Table 94.

TABLE 94

| | | |
|---|---|---|
| | Ex. 5b | Ex. 5c |
| Ex. 5a | Comparative | Invention |
| Comparative | SIL + | SIL + TMMS + |
| SIL + TMMS | MAPOSS | MAPOSS |

Component (amount in phr)

| | | | |
|---|---|---|---|
| SBR 2525 | 100 | 100 | 100 |
| MAPOSS | | 10 | 10 |
| Silica 1165 | 30 | 30 | 30 |
| TMMS | 2.4 | | 2.4 |
| Stearic acid | 2 | 2 | 2 |
| Compound of the | 2 | 2 | 2 |
| Disclosure, e.g., a | | | |
| compound of Tables | | | |
| A-J | | | |
| ZnO | 3.5 | 3.5 | 3.5 |
| DCP | 2 | 2 | 2 |

MAPOSS Octamethacrylpropyl silsesquioxane (Hybrid Plastic MA0735) formula R = C₇H₁₁O₂, n = 8, 10, 12 (mixture).

In some embodiments, the disclosure provides the rubber compositions of Table 95.

TABLE 95

| | | | | |
|---|---|---|---|---|
| | | | | Conventional |
| | | | | tread |
| Ex. 6a | Ex. 6b | Ex. 6c | Ex. 6d | composition |

Component (amount in phr)

| | | | | | |
|---|---|---|---|---|---|
| SLR 4630 | 100 | 100 | 100 | 100 | 100 |
| SIL − TMMS − | | 33 | | | |
| MAPOSS3 | | | | | |
| SIL − TMMS − | | | 33 | | |
| MAPOSS5 | | | | | |
| SIL − TMMS − | | | | 33 | |
| MAPOSS10 | | | | | |
| Silica 1165 | 30 | | | | 65 |
| TESPT | | | | | 5.2 |
| TMMS | 2.4 | | | | |
| Stearic acid | 2 | 2 | 2 | 2 | 2 |
| Compound of | 2 | 2 | 2 | 2 | 2 |
| the Disclosure, | | | | | |
| e.g., a | | | | | |
| compound of | | | | | |
| Tables A-J | | | | | |
| ZnO | 3.5 | 3.5 | 3.5 | 3.5 | 2 |
| DCP | 2 | 2 | 2 | 2 | |
| Sulphur | | | | | 1 |
| TBBS | | | | | 3 |

SLR 4630SBR Styron: containing 47% of vinyl on total monomers.

In some embodiments, the disclosure provides the rubber compositions of Table 96.

TABLE 96

| | | |
|---|---|---|
| Ex. 7a | Ex. 7b | Ex. 7b |

Component (amount in phr)

| | | | |
|---|---|---|---|
| SLR 4630 | 100 | 100 | 100 |
| MAPOSS | | 10 | |
| SIL − TMMS − | | | 33 |
| MAPOSS10 | | | |
| Silica 1165 | 30 | 30 | |
| TMMS | 2.4 | 2.4 | |
| Stearic acid | 2 | 2 | 2 |
| Compound of the | 2 | 2 | 2 |
| Disclosure, e.g., a | | | |
| compound of Tables | | | |
| A-J | | | |
| ZnO | 3.5 | 3.5 | 3.5 |
| CBS | 3 | 3 | 3 |
| Sulphur | 1 | 1 | 1 |

CBS: N-cyclohexyl-2-benzothiazyl sulphenamide (accelerant) Vulkacit ® CZ/C-(Lanxess).

In some embodiments, the disclosure provides the rubber compositions of Table 97.

TABLE 97

| | |
|---|---|
| Ex. 8a | Ex. 8b |

Component (amount in phr)

| | | |
|---|---|---|
| SLR 4630 | 100 | 100 |
| Silica 1165 | 30 | 30 |
| MAPOSS10 | 10 | 10 |
| TEMS | | 2.4 |
| TESPT | 2.4 | |
| Stearic ac. | 2.0 | 2.0 |
| ZnO | 3.5 | 3.5 |
| Compound of the Disclosure, | 2.0 | 2.0 |
| e.g., a compound of Tables A-J | | |
| DCP | 2.0 | 2.0 |

TESPT: bis[3-(triethoxysilyl)propyl]tetrasulphide.

In some embodiments, the disclosure provides the rubber compositions of Table 98.

TABLE 98

| | | |
|---|---|---|
| Ex. 9a | Ex. 9b | Ex. 9c |

Component (amount in phr)

| | | | |
|---|---|---|---|
| Polyisoprene | 50 | 50 | 50 |
| Poly-butadiene | 50 | 50 | 50 |
| MAPOSS | | | 4 |
| Silica 1165 | 40 | 50 | 40 |
| TEMS | 3.2 | 4.0 | 3.2 |
| Stearic acid | 2 | 2 | 2 |
| Compound of the | 2 | 2 | 2 |
| Disclosure, e.g., a | | | |
| compound of Tables | | | |
| A-J | | | |
| ZnO | 3.5 | 3.5 | 3.5 |
| Peroxide | 2.3 | 2.3 | 2.3 |

Polyisoprene: SKI3 by Nizhnekamskneftekhim;
Poly-butadiene: Polybutadiene BR40 by Versalis;
Peroxide: 2,5-bis(t-butylperoxy)-2,5-dimethyl hexane at 45% active on silica, Luperox 101KL45 by Arkema.

In some embodiments, the disclosure provides an elastomeric composition comprising: a Compound of the Disclosure, e.g., a compound of Tables A-J at least 100 phr of at least one solid diene elastomeric polymer (E), and at least 3 phr of a derivatised silica (SIL-A-B) made by a process comprising: providing silanised silica (SIL-A), the silanised silica made by a process comprising: providing silica (C), providing at least one silanising agent of formula (A) of U.S. Pat. No. 11,091,607: (R1)₃Si—X (A), wherein R1, the same or different from each other, are chosen from R², OR², OSi(OR²)3, OH, halogen, and group X, provided that at least one R¹ is equal to OR², OSi(OR²)3, OH, or halogen; R², the same or different from each other, are chosen from linear and branched alkyl groups with 1 to 20 carbon atoms, cycloalkyl groups with 3 to 20 carbon atoms, alkylaryl groups with 7 to 20 carbon atoms, and aryl groups with 6 to 20 carbon atoms; group X is a reactive alkenyl group chosen from X1, X2, and X3, wherein X1 is a group —R3-C(Wa)═C(R4) R4, X2 is a group —R3-C(R4)=C(Wa)R4, and X3 is a group —R3-Wb-C(R4)=C(R4) R4, wherein R3 is absent or is chosen from linear and branched alkylene groups with 1 to 10 carbon atoms, Wa is H or an electron-attractor group chosen from COOR4, CONR4R4, NO2, CN, COR4, 303R4, NR4R4, and halogen, Wb is a group chosen from —O—CO—, —COO—, —NR4-CO—, —CO—NR4-, —SO—, —SO2-, and —CO—, and R4, the same or different from each other, are H or are chosen from the groups R2 defined above; placing the silica (C) and the silanising agent (A) in contact in a first reaction medium, allowing the silica (C) and the silanising agent (A) to react until the silanised silica (SIL-A) is obtained, and separating the silanised silica (SIL-A) from the first reaction medium; placing the silanised silica (SIL-A) in contact, in a second reaction medium, with at least one compound of formula (B) of U.S. Pat. No. 11,091,607 chosen from the silsesquioxanes of formula (B1), (B2), the compounds of formula (B3), and mixtures thereof,

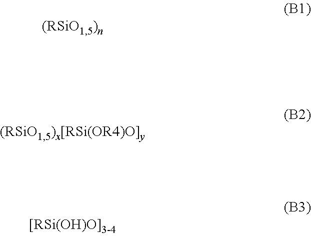

wherein n is an even number ranging from 4 to 24, x is an integer ranging from 3 to 23, y is an integer ranging from 1 to 6, and x+y≤24, and groups R, the same or different from each other, are chosen from R2 and X, provided that at least one of groups R is a group X, wherein R2, R4 and X are as defined above; adding at least one radical initiator (D) to the second reaction medium; and allowing the silanised silica (SIL-A), the at least one compound of (B), and the at least one radical initiator (D) to react until a derivatised silica (SIL-A-B) is obtained.

In some embodiments, the disclosure provides an elastomeric composition comprising: a Compound of the Disclosure, e.g., a compound of Tables A-J; at least 100 phr of at least one solid diene elastomeric polymer (E); at least 5 phr of silica (C); at least 0.3 phr of a silanising agent of formula (A) of U.S. Pat. No. 11,091,607, (R1)₃Si—X (A), wherein R1, the same or different from each other, are chosen from R2, OR2, OSi(OR2)3, OH, halogen, and group X, provided that at least one R1 is equal to OR2, OSi(OR2)3, OH, or halogen; R2, the same or different from each other, are chosen from linear and branched alkyl groups with 1 to 20 carbon atoms, cycloalkyl groups with 3 to 20 carbon atoms, alkylaryl groups with 7 to 20 carbon atoms, and aryl groups with 6 to 20 carbon atoms; group X is a reactive alkenyl group chosen from X1, X2, and X3, wherein X1 is a group —R3-C(Wa)′C(R4) R4, X2 is a group —R3-C(R4)=C(Wa)R4, and X₃ is a group —R3-Wb-C(R4)=C(R4)R4, wherein R³ is absent or is chosen from linear and branched alkylene groups with 1 to 10 carbon atoms, Wa is H or an electron-attractor group chosen from COOR4, CONR4R4, NO2, CN, COR4, SO3R4, NR4R4, and halogen, Wb is a group chosen from —O—CO—, —COO—, —NR4-CO—, —CO—NR4-, —SO—, —SO2-, and —CO—, and R4, the same or different from each other, are H or are chosen from the groups R2 defined above; and at least 0.5 phr of a compound of formula (B) of U.S. Pat. No. 11,091,607, wherein formula (B) is chosen from the silsesquioxanes of formula (B1), (B2), the compounds of formula (B3), and mixtures thereof,

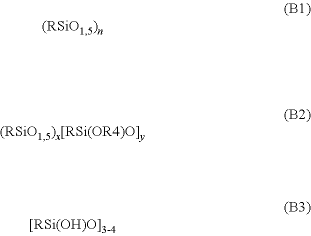

wherein n is an even number ranging from 4 to 24, x is an integer ranging from 3 to 23, y is an integer ranging from 1 to 6, and x+y≤24, and groups R, the same or different from each other, are chosen from R2 and X, provided that at least one of groups R is a group X, wherein R2, R4 and X are as defined above.

In some embodiments, the disclosure provides a vulcanisable elastomeric composition for a tire for vehicle wheels, comprising: at least 0.1 phr of at least one vulcanising agent (F); and an elastomeric composition comprising a Compound of the Disclosure, e.g., a compound of Tables A-J, at least 100 phr of at least one solid diene elastomeric polymer (E) and at least 3 phr of a derivatised silica (SIL-A-B) made by a process comprising: providing silanised silica (SIL-A), the silanised silica made by a process comprising: providing silica (C), providing at least one silanising agent of formula (A) of U.S. Pat. No. 11,091,607, (R1)₃Si—X (A), wherein R1, the same or different from each other, are chosen from R2, OR2, OSi(OR2)₃, OH, halogen, and group X, provided that at least one R1 is equal to OR2, OSi(OR2)₃, OH, or halogen; R2, the same or different from each other, are chosen from linear and branched alkyl groups with 1 to 20 carbon atoms, cycloalkyl groups with 3 to 20 carbon atoms, alkylaryl groups with 7 to 20 carbon atoms, and aryl groups with 6 to 20 carbon atoms; group X is a reactive alkenyl group chosen from X1, X2, and X3, wherein X1 is a group —R3-C(Wa)═C(R4) R4, X2 is a group —R3-C(R4)=C(Wa)R4, and X3 is a group —R3-Wb-C(R4)-C(R4)R4, wherein R³ is absent or is chosen from linear and branched alkylene groups with 1 to 10 carbon atoms, Wa is H or an electron-attractor group chosen from COOR4, CONR4R4, NO2, CN, COR4, SO3R4, NR4R4, and halogen, Wb is a group chosen from —O—CO—, —COO—, —NR4-CO—, —CO—NR4-, —SO—, —SO2-, and —CO—, and R4, the same or different from each other, are H or are chosen from the groups R2 defined above; placing the silica (C) and the silanising agent (A) in contact in a first reaction medium, allowing the silica (C) and the silanising agent (A) to react until the silanised silica (SIL-A) is obtained, and separating the silanised silica (SIL-A) from the first reaction medium; placing the silanised silica (SIL-A) in contact, in a second reaction medium, with at least one compound of formula (B) of U.S. Pat. No. 11,091,607 chosen from the silsesquioxanes of formula (B1), (B2), the compounds of formula (B3), and mixtures thereof,

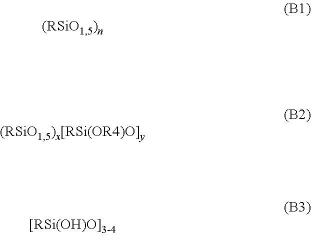

wherein n is an even number ranging from 4 to 24, x is an integer ranging from 3 to 23, y is an integer ranging from 1 to 6, and x+y≤24, groups R, the same or different from each other, are chosen from R2 and X, provided that at least one of groups R is a group X, wherein R2, R4 and X are as defined above; adding at least one radical initiator (D) to the second reaction medium; and allowing the silanised silica (SIL-A), the at least one compound (B), and the at least one radical initiator (D) to react until a derivatised silica (SIL-A-B) is obtained.

In some embodiments, the disclosure provides a tire component for vehicle wheels, either green or at least partially vulcanised, comprising a vulcanisable elastomeric composition comprising: at least 0.1 phr of at least one vulcanising agent (F); and an elastomeric composition comprising a Compound of the Disclosure, e.g., a compound of Tables A-J, at least 100 phr of at least one solid diene elastomeric polymer (E), and at least 3 phr of a derivatised silica (SIL-A-B) made by a process comprising: providing silanised silica (SIL-A), the silanised silica made by a process comprising: providing silica (C), providing at least one silanising agent of formula (A) of U.S. Pat. No. 11,091,607, (R1)₃Si—X (A), wherein R1, the same or different from each other, are chosen from R2, OR2, OSi(OR2)₃, OH, halogen, and group X, provided that at least one R1 is equal to OR2, OSi(OR2)₃, OH, or halogen; R2, the same or different from each other, are chosen from linear and branched alkyl groups with 1 to 20 carbon atoms, cycloalkyl groups with 3 to 20 carbon atoms, alkylaryl groups with 7 to 20 carbon atoms, and aryl groups with 6 to 20 carbon atoms; group X is a reactive alkenyl group chosen from X1, X2, and X3, wherein X1 is a group —R3-C(Wa)═C(R4)R4, X2 is a group —R³—C(R4)=C(Wa)R4, and X3 is a group —R3-Wb-C(R4)=C(R4) R4, wherein R³ is absent or is chosen from linear and branched alkylene groups with 1 to 10 carbon atoms, Wa is H or an electron-attractor group chosen from COOR4, CONR4R4, NO2, CN, COR4, SO3R4, NR4R4, and halogen, Wb is a group chosen from —O—CO—, —COO—, —NR4-CO—, —CO—NR4-, —SO—, —SO2, and —CO—, and R4, the same or different from each other, are H or are chosen from the groups R2 defined above; placing the silica (C) and the silanising agent (A) in contact in a first reaction medium, allowing the silica (C) and the silanising agent (A) to react until the silanised silica (SIL-A) is obtained, and separating the silanised silica (SIL-A) from the first reaction medium; placing the silanised silica (SIL-A) in contact, in a second reaction medium, with at least one compound of formula (B) of U.S. Pat. No. 11,091,607 chosen from the silsesquioxanes of formula (B1), (B2), the compounds of formula (B3), and mixtures thereof, (RSiO_{1,5})ₙ (B1); (RSiO_{1,5})ₓ[RSi(OR4)O]_{y} (B2); [RSi(OH)O]₃₋₄ (B3); wherein n is an even number ranging from 4 to 24, x is an integer ranging from 3 to 23, y is an integer ranging from 1 to 6, and x+y≤24, groups R, the same or different from each other, are chosen from R2 and X, provided that at least one of groups R is a group X, wherein R2, R4 and X are as defined above; adding at least one radical initiator (D) to the second reaction medium; and allowing the silanised silica (SIL-A), the at least one compound of (B), and the at least one radical initiator (D) to react until a derivatised silica (SIL-A-B) is obtained.

In some embodiments, the disclosure provides a tire for vehicle wheels comprising at least one tire component, either green or at least partially vulcanized, chosen from tread, carcass structure, belt structure, under-layer, bead protection layers, sidewall, sidewall insert, mini-sidewall, under-liner, rubber layers, bead filler, and sheet, wherein the tire component comprises a vulcanisable elastomeric composition comprising: at least 0.1 phr of at least one vulcanising agent (F); and an elastomeric composition comprising a Compound of the Disclosure, e.g., a compound of Tables A-J; at least 100 phr of at least one solid diene elastomeric polymer (E), and at least 3 phr of a derivatised silica (SIL-A-B) made by a process comprising: providing silanised silica (SIL-A), the silanised silica being obtainable according to a process which preferably comprises: providing silica (C), providing at least one silanising agent of formula (A) of U.S. Pat. No. 11,091,607, (R¹)₃Si—X (A), wherein R1, the same or different from each other, are chosen from R2, OR2, OSi(OR2)₃, OH, halogen, and group X, provided that at least one R1 is equal to OR2, OSi(OR2)₃, OH, or halogen; R2, the same or different from each other, are chosen from linear and branched alkyl groups with 1 to 20 carbon atoms, cycloalkyl groups with 3 to 20 carbon atoms, alkylaryl groups with 7 to 20 carbon atoms, and aryl groups with 6 to 20 carbon atoms; group X is a reactive alkenyl group chosen from X1, X2, and X3, wherein X1 is a group —R3-C(Wa)=C(R4)R4, X2 is a group —R3-C(R4)=C(Wa)R4, and X3 is a group —R3-Wb-C(R4)=C(R4) R4, wherein R3 is absent or is chosen from linear and branched alkylene groups with 1 to 10 carbon atoms, Wa is H or an electron-attractor group chosen from COOR4, CONR4R4, NO2, CN, COR4, SO3R4, NR4R4, and halogen, Wb is a group chosen from —O—CO—, —COO—, —NR4-CO—, —CO—NR4-, —SO—, —SO2-, and —CO—, and R4, the same or different from each other, are H or are chosen from the groups R2 defined above; placing the silica (C) and the silanising agent (A) in contact in a first reaction medium, allowing the silica (C) and the silanising agent (A) to react until the silanised silica (SIL-A) is obtained, and separating the silanised silica (SIL-A) from the first reaction medium; placing the silanised silica (SIL-A) in contact, in a second reaction medium, with at least one compound of formula (B) of U.S. Pat. No. 11,091,607, chosen from the silsesquioxanes of formula (B1), (B2), the compounds of formula (B3), and mixtures thereof,

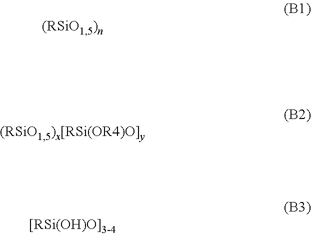

wherein n is an even number ranging from 4 to 24, x is an integer ranging from 3 to 23, y is an integer ranging from 1 to 6, and x+y≤24, groups R, the same or different from each other, are chosen from R2 and X, provided that at least one of groups R is a group X, wherein R2, R4 and X are as defined above; adding at least one radical initiator (D) to the second reaction medium; and allowing the silanised silica (SIL-A), the at least one compound of (B), and the at least one radical initiator (D) to react until a derivatised silica (SIL-A-B) is obtained.

In some embodiments, the disclosure provides the rubber compositions disclosed in Table 99.

TABLE 99

| U.S. Pat. No. | Composition(s) Incorporated by Reference* |
|---|---|
| 10,766,218 | Example A in Table 1 of columns 14 and 15 |
| | Example B in Table 2 of column 15 |
| 10,759,227 | AC1, AC2, AC3, and AC4 in Table 2 of column 20 |
| | C2 and INV1 in Table 3 of column 22 |
| | C5, C6, INV2 and INV3 in Table 4 of column 23 |
| | C7, INV4, INV5 and INV6 in Table 6 of column 25 |
| 10,308,072 | MA, MB, MC1 and MD in Table 3 of columns 27 and 28 |
| | ME, MF, MC2, MG, MH, MI, MJ and MK in Table 4 of column 29 |
| | ML, MM and MN in Table 5 of columns 30 and 31 |
| | MO and MP in Table 6 of column 31 |
| 9,365,006 | The elastomeric compound in Table 1 of column 17 |
| 8,858,852 | The elastomeric compound in Table 1 of column 17 |
| 8,763,658 | Samples 1-4 in Table 1 of columns 12 and 13 |
| | Samples 5-9 in Table 4 of columns 14 and 15 |
| 8,240,350 | Examples 1-2 in Table 1 of column 13 |
| | Examples 3-4 in Table 3 of column 15 |
| | Examples 5-6 in Table 5 of column 17 |
| 8,196,627 | Example 3 in Table 1 of column 12 |
| 8,151,848 | Example 3 in Table 1 of column 12 |
| 7,152,642 | A in Table 1 of column 14 |
| 6,822,037 | SS01, SS02, SS03 and SS04 in Table 1 of column 18 |
| | SS05, SS06, SS07, SS08 and SS09 in Table 3 of column 19 |
| | SS10, SS11, SS12, SS13, SS14 and SS15 in Table 5 of column 20 |
| | SS16, SS17, SS18, SS19, SS20, SS21 and SS22 in Table 7 of column 21 |
| | SS23, SS24, SS25, SS26 and SS27 in Table 9 of columns 22 and 23 |
| | SS28, SS29, SS30, SS31, SS32, SS33 and SS34 in Table 11 of column 24 |
| | SS35, SS36, SS37, SS38, SS39 and SS40 in Table 13 of column 25 |
| | SS41, SS42 and SS43 in Table 16 of column 27 |
| 6,820,666 | Compound A in Table 1 of column 9 |
| 6,805,177 | Compound in Table 1 of columns 4 and 5 |
| 6,737,466 | SS01, SS02, SS03 and SS04 in Table 1 of column 17 |
| | SS05, SS06, SS07, SS08 and SS09 in Table 3 of column 18 |
| | SS10, SS11, SS12, SS13, SS14 and SS15 in Table 5 of column 20 |
| | SS16, SS17, SS18, SS19, SS20, SS21 and SS22 in Table 7 of columns 21 |
| | and 22 |
| | SS23, SS24, SS25, SS26 and SS27 in Table 9 of column 23 |
| | SS28, SS29, SS30, SS31, SS32, SS33 and SS34 in Table 11 of column 24 |
| | SS35, SS36, SS37, SS38, SS39 and SS40 in Table 13 of column 25 |
| | SS41, SS42 and SS43 in Table 16 of column 28 |
| 6,482,884 | SS01, SS02, SS03 and SS04 in Table 1 of column 18 |
| | SS05, SS06, SS07, SS08 and SS09 in Table 3 of column 19 |
| | SS10, SS11, SS12, SS13, SS14 and SS15 in Table 5 of column 20 |
| | SS16, SS17, SS18, SS19, SS20, SS21 and SS22 in Table 7 of column 22 |
| | SS23, SS24, SS25, SS26 and SS27 in Table 9 of column 23 |
| | SS28, SS29, SS30, SS31, SS32, SS33 and SS34 in Table 11 of column 25 |
| | SS35, SS36, SS37, SS38, SS39 and SS40 in Table 13 of columns 26 and |
| | 27 |
| | SS41, SS42 and SS43 in Table 16 of column 29 |
| 6,409,959 | Composition in the table of lines 60-67 of column 7 and lines 1-7 of column |
| | 8 |
| | Composition in the table of lines 14-25 of column 8 |
| | Composition in the table of lines 50-60 of column 8 |
| 6,014,998 | PATMIC1, PATMIC2, PATMIC3, PATMIC4 and PATMIC7 in Table 1 of |
| | column 6 |
| 4,911,991 | Compounds A and B in the table of lines 54-65 of column 4 |
| 11,046,837 | Composition A in Table I of columns 3 and 4 |
| 10,975,178 | Formulation in Table 1 of column 42 |
| 10,336,138 | Examples 1 and 2, and comparative examples 1 and 2 in Table 1 of columns |
| | 13, 14 and 15 |
| 10,214,629 | Compositions A, B, C, D, E, F and G in Table I of column 4 |
| 9,908,998 | Compound II in Table II of columns 4 and 5 |
| 9,018,290 | Compound in Table A of columns 12 and 13 |
| | Compound in Table 6 of column 16 |
| 8,841,376 | Formulation in Table 3 of column 12 |
| | Formulations 11-15 in Table 6 of column 14 |
| 8,299,161 | Examples 2-7 in Table 1 of columns 7 and 8 |
| | Examples 9-14 in Table 4 of columns 9 and 10 |
| 8,097,674 | Formulation in Table 1 of columns 13 and 14 |
| 7,960,463 | Samples 1-6 in Table I of columns 7 and 8 |
| | Samples 7-17 in Table IV of columns 9, 10, 11 and 12 |
| 6,265,454 | Control and example 1 in Table I of column 3 |
| | Control and examples 2-4 in Table II of columns 3 and 4 |
| | Control and examples 8-10 in Table III of column 4 |
| | Control and examples 11-15 in Table IV of column 4 |
| | Control, control 2, control 3 and examples 11-12 in Table V of column 5 |
| 5,104,476 | Liquid A, liquid B and cushion rubber in Table 1 of column 5 |

*wherein an antidegradant, e.g., an antioxidant, e.g., 6PPD, in each rubber composition is either partially or completely substituted with a Compound of the Disclosure, e.g., a compound of Tables A-J

In some embodiments, the disclosure provides the rubber compositions and/or tires as disclosed in the US Patent Application Publications in Table 100, Table 101, or Table 102, wherein an antidegradant, e.g., an antioxidant, e.g., 6PPD, in each rubber composition and/or tire is either partially or completely substituted with a Compound of the Disclosure, e.g., a compound of Tables A-J.

TABLE 100

| # | US Pat. Appl. Pub. No. |
|---|---|
| 1 | 20220283133 |
| 2 | 20220259436 |
| 3 | 20220259414 |
| 4 | 20220259413 |
| 5 | 20220243041 |
| 6 | 20220235203 |
| 7 | 20220213035 |
| 8 | 20220212499 |
| 9 | 20220204731 |
| 10 | 20220145049 |
| 11 | 20220144974 |
| 12 | 20220144863 |
| 13 | 20220073709 |
| 14 | 20220073707 |
| 15 | 20220064415 |
| 16 | 20220056242 |
| 17 | 20220055837 |
| 18 | 20220041843 |
| 19 | 20220041013 |
| 20 | 20220025163 |
| 21 | 20220025159 |
| 22 | 20220010104 |
| 23 | 20220009283 |
| 24 | 20220001695 |
| 25 | 20210380786 |
| 26 | 20210380785 |
| 27 | 20210380784 |
| 28 | 20210363333 |
| 29 | 20210355302 |
| 30 | 20210340306 |
| 31 | 20210332223 |
| 32 | 20210324183 |
| 33 | 20210324181 |
| 34 | 20210324180 |
| 35 | 20210324153 |
| 36 | 20210292522 |
| 37 | 20210284826 |
| 38 | 20210277210 |
| 39 | 20210253832 |
| 40 | 20210252916 |
| 41 | 20210245459 |
| 42 | 20210233018 |
| 43 | 20210230420 |
| 44 | 20210230401 |
| 45 | 20210229505 |
| 46 | 20210214530 |
| 47 | 20210206948 |
| 48 | 20210198459 |
| 49 | 20210188005 |
| 50 | 20210179821 |
| 51 | 20210179819 |
| 52 | 20210178829 |
| 53 | 20210178828 |
| 54 | 20210171676 |
| 55 | 20210163720 |
| 56 | 20210163696 |
| 57 | 20210163632 |
| 58 | 20210162806 |
| 59 | 20210155047 |
| 60 | 20210147655 |
| 61 | 20210139676 |
| 62 | 20210130578 |
| 63 | 20210130526 |
| 64 | 20210130511 |
| 65 | 20210122885 |
| 66 | 20210122191 |
| 67 | 20210115218 |
| 68 | 20210094353 |
| 69 | 20210087366 |
| 70 | 20210087316 |
| 71 | 20210079204 |
| 72 | 20210079132 |
| 73 | 20210061973 |
| 74 | 20210061962 |
| 75 | 20210061006 |
| 76 | 20210033578 |
| 77 | 20210031565 |
| 78 | 20210009610 |
| 79 | 20200407537 |
| 80 | 20200392314 |
| 81 | 20200392311 |
| 82 | 20200392307 |
| 83 | 20200384808 |
| 84 | 20200377702 |
| 85 | 20200377701 |
| 86 | 20200377700 |
| 87 | 20200377699 |
| 88 | 20200377696 |
| 89 | 20200377623 |
| 90 | 20200371075 |
| 91 | 20200362080 |
| 92 | 20200361242 |
| 93 | 20200347207 |
| 94 | 20200346498 |
| 95 | 20200325309 |
| 96 | 20200317891 |
| 97 | 20200308376 |
| 98 | 20200308372 |
| 99 | 20200307315 |
| 100 | 20200299482 |
| 101 | 20200290398 |
| 102 | 20200282770 |
| 103 | 20200277471 |
| 104 | 20200276866 |
| 105 | 20200270431 |
| 106 | 20200269634 |
| 107 | 20200255558 |
| 108 | 20200224011 |
| 109 | 20200223259 |
| 110 | 20200181356 |
| 111 | 20200180359 |
| 112 | 20200157290 |
| 113 | 20200156413 |
| 114 | 20200148877 |
| 115 | 20200130306 |
| 116 | 20200109242 |
| 117 | 20200109222 |
| 118 | 20200108666 |
| 119 | 20200095387 |
| 120 | 20200086692 |
| 121 | 20200079934 |
| 122 | 20200062933 |
| 123 | 20200062928 |
| 124 | 20200056018 |
| 125 | 20200056017 |
| 126 | 20200040166 |
| 127 | 20200031979 |
| 128 | 20200031963 |
| 129 | 20200017662 |
| 130 | 20200016939 |
| 131 | 20200016932 |
| 132 | 20200002513 |
| 133 | 20190382547 |
| 134 | 20190382547 |
| 135 | 20190381832 |
| 136 | 20190367711 |
| 137 | 20190359001 |
| 138 | 20190351708 |
| 139 | 20190345315 |
| 140 | 20190322845 |
| 141 | 20190322777 |
| 142 | 20190322137 |
| 143 | 20190308455 |
| 144 | 20190300684 |
| 145 | 20190300640 |
| 146 | 20190284372 |
| 147 | 20190270866 |
| 148 | 20190255887 |
| 149 | 20190255884 |
| 150 | 20190255883 |
| 151 | 20190248189 |
| 152 | 20190248181 |
| 153 | 20190241722 |
| 154 | 20190241720 |
| 155 | 20190233624 |
| 156 | 20190233557 |
| 157 | 20190232720 |
| 158 | 20190225775 |
| 159 | 20190211191 |
| 160 | 20190203020 |
| 161 | 20190194428 |
| 162 | 20190185646 |
| 163 | 20190169407 |
| 164 | 20190160871 |
| 165 | 20190119475 |
| 166 | 20190119428 |
| 167 | 20190077891 |
| 168 | 20190077887 |
| 169 | 20190062522 |
| 170 | 20190047326 |
| 171 | 20190047326 |
| 172 | 20190031837 |
| 173 | 20190030953 |
| 174 | 20190023881 |
| 175 | 20190016178 |
| 176 | 20190002653 |
| 177 | 20180371216 |
| 178 | 20180370288 |
| 179 | 20180362679 |
| 180 | 20180327575 |
| 181 | 20180326784 |
| 182 | 20180319955 |
| 183 | 20180312732 |
| 184 | 20180312003 |
| 185 | 20180304693 |
| 186 | 20180291181 |
| 187 | 20180291125 |
| 188 | 20180291124 |
| 189 | 20180291041 |
| 190 | 20180290412 |
| 191 | 20180284085 |
| 192 | 20180282588 |
| 193 | 20180282444 |
| 194 | 20180273732 |
| 195 | 20180264882 |
| 196 | 20180244809 |
| 197 | 20180223081 |
| 198 | 20180215903 |
| 199 | 20180215844 |
| 200 | 20180215202 |
| 201 | 20180186977 |
| 202 | 20180186189 |
| 203 | 20180186186 |
| 204 | 20180171053 |
| 205 | 20180170105 |
| 206 | 20180163027 |
| 207 | 20180162165 |
| 208 | 20180155535 |
| 209 | 20180141381 |
| 210 | 20180141296 |
| 211 | 20180126785 |
| 212 | 20180117972 |
| 213 | 20180111424 |
| 214 | 20180111422 |
| 215 | 20180100058 |
| 216 | 20180100057 |
| 217 | 20180079891 |
| 218 | 20180079257 |
| 219 | 20180057668 |
| 220 | 20180057667 |
| 221 | 20180057615 |
| 222 | 20180056717 |
| 223 | 20180051118 |
| 224 | 20180044455 |
| 225 | 20180043736 |
| 226 | 20180009971 |
| 227 | 20180002498 |
| 228 | 20180002497 |
| 229 | 20180002490 |
| 230 | 20180001716 |
| 231 | 20180001703 |
| 232 | 20170369680 |
| 233 | 20170369621 |
| 234 | 20170361658 |
| 235 | 20170361654 |
| 236 | 20170361653 |
| 237 | 20170342253 |
| 238 | 20170342252 |
| 239 | 20170321045 |
| 240 | 20170321040 |
| 241 | 20170313862 |
| 242 | 20170313861 |
| 243 | 20170313005 |
| 244 | 20170306128 |
| 245 | 20170306109 |
| 246 | 20170305191 |
| 247 | 20170267798 |
| 248 | 20170260340 |
| 249 | 20170247533 |
| 250 | 20170246918 |
| 251 | 20170246905 |
| 252 | 20170240729 |
| 253 | 20170239991 |
| 254 | 20170233556 |
| 255 | 20170226322 |
| 256 | 20170218186 |
| 257 | 20170210172 |
| 258 | 20170203612 |
| 259 | 20170197469 |
| 260 | 20170197468 |
| 261 | 20170190935 |
| 262 | 20170182845 |
| 263 | 20170151836 |
| 264 | 20170144486 |
| 265 | 20170137600 |
| 266 | 20170136821 |
| 267 | 20170136820 |
| 268 | 20170121477 |
| 269 | 20170120682 |
| 270 | 20170114213 |
| 271 | 20170081429 |
| 272 | 20170073508 |
| 273 | 20170073477 |
| 274 | 20170066902 |
| 275 | 20170001476 |
| 276 | 20170001398 |
| 277 | 20160376426 |
| 278 | 20160375727 |
| 279 | 20160347777 |
| 280 | 20160339744 |
| 281 | 20160332485 |
| 282 | 20160319115 |
| 283 | 20160319112 |
| 284 | 20160312016 |
| 285 | 20160312015 |
| 286 | 20160311258 |
| 287 | 20160297948 |
| 288 | 20160280886 |
| 289 | 20160280007 |
| 290 | 20160272005 |
| 291 | 20160251502 |
| 292 | 20160237258 |
| 293 | 20160237257 |
| 294 | 20160237256 |
| 295 | 20160237220 |
| 296 | 20160229992 |
| 297 | 20160222197 |
| 298 | 20160215131 |
| 299 | 20160214437 |
| 300 | 20160200900 |
| 301 | 20160200141 |
| 302 | 20160194485 |
| 303 | 20160185938 |
| 304 | 20160177070 |
| 305 | 20160168365 |
| 306 | 20160168339 |
| 307 | 20160160014 |
| 308 | 20160137001 |
| 309 | 20160130427 |
| 310 | 20160130418 |
| 311 | 20160122504 |
| 312 | 20160115296 |
| 313 | 20160108212 |
| 314 | 20160108211 |
| 315 | 20160108209 |
| 316 | 20160108201 |
| 317 | 20160024280 |
| 318 | 20160024270 |
| 319 | 20160009904 |
| 320 | 20160009874 |
| 321 | 20160001598 |
| 322 | 20150376348 |
| 323 | 20150368444 |
| 324 | 20150361248 |
| 325 | 20150353716 |
| 326 | 20150353657 |
| 327 | 20150352909 |
| 328 | 20150344679 |
| 329 | 20150343843 |
| 330 | 20150337109 |
| 331 | 20150322248 |
| 332 | 20150322234 |
| 333 | 20150315356 |
| 334 | 20150314644 |
| 335 | 20150314644 |
| 336 | 20150299435 |
| 337 | 20150291780 |
| 338 | 20150284548 |
| 339 | 20150283854 |
| 340 | 20150274939 |
| 341 | 20150273953 |
| 342 | 20150251501 |
| 343 | 20150240059 |
| 344 | 20150225551 |
| 345 | 20150203662 |
| 346 | 20150191584 |
| 347 | 20150184054 |
| 348 | 20150183983 |
| 349 | 20150183971 |
| 350 | 20150165824 |
| 351 | 20150165821 |
| 352 | 20150158338 |
| 353 | 20150151580 |
| 354 | 20150151579 |
| 355 | 20150141582 |
| 356 | 20150136287 |
| 357 | 20150129100 |
| 358 | 20150125685 |
| 359 | 20150105491 |
| 360 | 20150065627 |
| 361 | 20150031821 |
| 362 | 20150031792 |
| 363 | 20150020945 |
| 364 | 20150011710 |
| 365 | 20150011683 |
| 366 | 20150005418 |
| 367 | 20150000827 |
| 368 | 20150000812 |
| 369 | 20140378575 |
| 370 | 20140373995 |
| 371 | 20140371346 |
| 372 | 20140360647 |
| 373 | 20140360645 |
| 374 | 20140352865 |
| 375 | 20140350174 |
| 376 | 20140350173 |
| 377 | 20140345774 |
| 378 | 20140345773 |
| 379 | 20140338811 |
| 380 | 20140336288 |
| 381 | 20140332137 |
| 382 | 20140332132 |
| 383 | 20140329946 |
| 384 | 20140323627 |
| 385 | 20140311641 |
| 386 | 20140296375 |
| 387 | 20140288250 |
| 388 | 20140261951 |
| 389 | 20140256846 |
| 390 | 20140251521 |
| 391 | 20140251519 |
| 392 | 20140200307 |
| 393 | 20140196827 |
| 394 | 20140196825 |
| 395 | 20140190605 |
| 396 | 20140187693 |
| 397 | 20140171580 |
| 398 | 20140142236 |
| 399 | 20140142235 |
| 400 | 20140114008 |
| 401 | 20140107285 |
| 402 | 20140083588 |
| 403 | 20140080969 |
| 404 | 20140051793 |
| 405 | 20140051792 |
| 406 | 20140051791 |
| 407 | 20140039107 |
| 408 | 20140011924 |
| 409 | 20140001293 |
| 410 | 20140000773 |
| 411 | 20130333819 |
| 412 | 20130331480 |
| 413 | 20130317137 |
| 414 | 20130306865 |
| 415 | 20130303687 |
| 416 | 20130296463 |
| 417 | 20130292023 |
| 418 | 20130281588 |
| 419 | 20130274408 |
| 420 | 20130274407 |
| 421 | 20130274374 |
| 422 | 20130267638 |
| 423 | 20130261272 |
| 424 | 20130261242 |
| 425 | 20130253090 |
| 426 | 20130253088 |
| 427 | 20130237659 |
| 428 | 20130237637 |
| 429 | 20130231426 |
| 430 | 20130217802 |
| 431 | 20130203893 |
| 432 | 20130203892 |
| 433 | 20130197140 |
| 434 | 20130190423 |
| 435 | 20130186541 |
| 436 | 20130186540 |
| 437 | 20130184387 |
| 438 | 20130123418 |
| 439 | 20130116360 |
| 440 | 20130102714 |
| 441 | 20130096248 |
| 442 | 20130085223 |
| 443 | 20130030097 |
| 444 | 20120325390 |
| 445 | 20120305156 |
| 446 | 20120283355 |
| 447 | 20120270966 |
| 448 | 20120259043 |
| 449 | 20120252928 |
| 450 | 20120245270 |
| 451 | 20120232223 |
| 452 | 20120232208 |
| 453 | 20120196976 |
| 454 | 20120165446 |
| 455 | 20120157585 |
| 456 | 20120135857 |
| 457 | 20120108718 |
| 458 | 20120035336 |
| 459 | 20110308684 |
| 460 | 20110269889 |
| 461 | 20110269889 |
| 462 | 20110265923 |
| 463 | 20110259496 |
| 464 | 20110207847 |
| 465 | 20110180195 |
| 466 | 20110144233 |
| 467 | 20110112212 |
| 468 | 20110108179 |
| 469 | 20110095106 |
| 470 | 20110054095 |
| 471 | 20110039994 |
| 472 | 20100319824 |
| 473 | 20100317778 |
| 474 | 20100286348 |
| 475 | 20100261826 |
| 476 | 20100197847 |
| 477 | 20100179247 |
| 478 | 20100149902 |
| 479 | 20100132868 |
| 480 | 20100063178 |
| 481 | 20100059160 |
| 482 | 20100004398 |
| 483 | 20100004368 |
| 484 | 20100000639 |
| 485 | 20090326176 |
| 486 | 20090266461 |
| 487 | 20090247683 |
| 488 | 20090182106 |
| 489 | 20090171002 |
| 490 | 20090163675 |
| 491 | 20090149601 |
| 492 | 20090056847 |
| 493 | 20090005500 |
| 494 | 20080173379 |
| 495 | 20080161475 |
| 496 | 20080161452 |
| 497 | 20080066845 |
| 498 | 20080035260 |
| 499 | 20070208126 |
| 500 | 20070187013 |
| 501 | 20070149689 |
| 502 | 20070135564 |
| 503 | 20070060711 |
| 504 | 20070034309 |
| 505 | 20070012391 |
| 506 | 20070006956 |
| 507 | 20060270817 |
| 508 | 20060217473 |
| 509 | 20060090830 |
| 510 | 20060067159 |
| 511 | 20060020095 |
| 512 | 20060004138 |
| 513 | 20050282950 |
| 514 | 20050267247 |
| 515 | 20050267247 |
| 516 | 20050261453 |
| 517 | 20050209413 |
| 518 | 20050148713 |
| 519 | 20050130835 |
| 520 | 20050090623 |
| 521 | 20050080179 |
| 522 | 20050004333 |
| 523 | 20040220324 |
| 524 | 20040220321 |
| 525 | 20040220315 |
| 526 | 20040194863 |
| 527 | 20040192839 |
| 528 | 20040152809 |
| 529 | 20040102567 |
| 530 | 20040084123 |
| 531 | 20030187110 |
| 532 | 20030158317 |
| 533 | 20020165302 |
| 534 | 20020156202 |
| 535 | 20020107317 |
| 536 | 20020095008 |
| 537 | 20020061409 |
| 538 | 20020045697 |
| 539 | 20020042462 |
| 540 | 20020033216 |
| 541 | 20020007890 |
| 542 | 20010052378 |
| 543 | 20010051677 |
| 544 | 20010031795 |
| 545 | 20010009932 |

TABLE 101

| | | | |
|---|---|---|---|
| US 20220227975 A1 | US 20190242800 A1 | US 20150141578 A1 | US 20110303338 A1 |
| US 20220220288 A1 | US 20190233618 A1 | US 20150126657 A1 | US 20110306700 A1 |
| US 20220195154 A1 | US 20190211120 A1 | US 20150065639 A1 | US 20110290387 A1 |
| US 20220186000 A1 | US 20190211161 A1 | US 20150034224 A1 | US 20110294953 A1 |
| US 20220106463 A1 | US 20190092103 A1 | US 20150034230 A1 | US 20110294915 A1 |
| US 20220072903 A1 | US 20190047326 A1 | US 20150034226 A1 | US 20110259498 A1 |
| US 20220073713 A1 | US 20190031836 A1 | US 20150018469 A1 | US 20110251354 A1 |
| US 20220064415 A1 | US 20190001748 A1 | US 20150005448 A1 | US 20110237707 A1 |
| US 20220056251 A1 | US 20180370289 A1 | US 20150005449 A1 | US 20110190416 A1 |
| US 20220048329 A1 | US 20180361693 A1 | US 20150000827 A1 | US 20110152405 A1 |
| US 20220041843 A1 | US 20180355153 A1 | US 20140378575 A1 | US 20110098404 A1 |
| US 20220025159 A1 | US 20180355152 A1 | US 20140371345 A1 | US 20110067800 A1 |
| US 20220025163 A1 | US 20180326790 A1 | US 20140343216 A1 | US 20110040002 A1 |
| US 20220010101 A1 | US 20180326788 A1 | US 20140343190 A1 | US 20110039976 A1 |
| US 20210403627 A1 | US 20180326789 A1 | US 20140326377 A1 | US 20110021702 A1 |
| US 20210387858 A1 | US 20180304693 A1 | US 20140311641 A1 | US 20110021664 A1 |
| US 20210380784 A1 | US 20180290489 A1 | US 20140305558 A1 | US 20110009547 A1 |
| US 20210371289 A1 | US 20180273723 A1 | US 20140299249 A1 | US 20100276054 A1 |
| US 20210363332 A1 | US 20180265601 A1 | US 20140256846 A1 | US 20100256275 A1 |
| US 20210340297 A1 | US 20180257432 A1 | US 20140230981 A1 | US 20100204358 A1 |
| US 20210340293 A1 | US 20180223083 A1 | US 20140228479 A1 | US 20100154945 A1 |
| US 20210340359 A1 | US 20180223082 A1 | US 20140228459 A1 | US 20100113681 A1 |
| US 20210317287 A1 | US 20180215905 A1 | US 20140228480 A1 | US 20100099796 A1 |
| US 20210253801 A1 | US 20180208756 A1 | US 20140221557 A1 | US 20100071818 A1 |
| US 20210253833 A1 | US 20180194934 A1 | US 20140221526 A1 | US 20100069530 A1 |
| US 20210230401 A1 | US 20180186184 A1 | US 20140216619 A1 | US 20100063189 A1 |
| US 20210230325 A1 | US 20180186979 A1 | US 20140205836 A1 | US 20100059158 A1 |
| US 20210213781 A1 | US 20180178584 A1 | US 20140194545 A1 | US 20100024942 A1 |
| US 20210179821 A1 | US 20180155526 A1 | US 20140171557 A1 | US 20100022714 A1 |
| US 20210179819 A1 | US 20180117972 A1 | US 20140155519 A1 | US 20100022684 A1 |
| US 20210171752 A1 | US 20180072099 A1 | US 20140138004 A1 | US 20100012248 A1 |
| US 20210163632 A1 | US 20180050566 A1 | US 20140135450 A1 | US 20090314408 A1 |
| US 20210155039 A1 | US 20180001702 A1 | US 20140128499 A1 | US 20090297827 A1 |
| US 20210130591 A1 | US 20170368876 A1 | US 20140110025 A1 | US 20090270558 A1 |
| US 20210130592 A1 | US 20170362413 A1 | US 20140107268 A1 | US 20090250151 A1 |
| US 20210130578 A1 | US 20170349728 A1 | US 20140100323 A1 | US 20090234066 A1 |
| US 20210130593 A1 | US 20170327617 A1 | US 20140090548 A1 | US 20090209709 A1 |
| US 20210115218 A1 | US 20170326844 A1 | US 20140083589 A1 | US 20090186961 A1 |
| US 20210114889 A1 | US 20170321033 A1 | US 20140076473 A1 | US 20090165919 A1 |
| US 20210115229 A1 | US 20170313130 A1 | US 20140031487 A1 | US 20090137714 A1 |
| US 20210102022 A1 | US 20170313131 A1 | US 20140024745 A1 | US 20090131572 A1 |
| US 20210101409 A1 | US 20170306108 A1 | US 20130345336 A1 | US 20080319125 A1 |
| US 20210087068 A1 | US 20170306106 A1 | US 20130312892 A1 | US 20080306213 A1 |
| US 20210087366 A1 | US 20170291454 A1 | US 20130317137 A1 | US 20080264543 A1 |
| US 20210087370 A1 | US 20170275237 A1 | US 20130306209 A1 | US 20080156404 A1 |
| US 20210087316 A1 | US 20170275234 A1 | US 20130303685 A1 | US 20080161467 A1 |
| US 20210079135 A1 | US 20170275233 A1 | US 20130303687 A1 | US 20080146725 A1 |
| US 20210079200 A1 | US 20170275239 A1 | US 20130296492 A1 | US 20080132644 A1 |
| US 20210078370 A1 | US 20170246905 A1 | US 20130289163 A1 | US 20080128060 A1 |
| US 20210053397 A1 | US 20170239991 A1 | US 20130289200 A1 | US 20080121324 A1 |
| US 20200399442 A1 | US 20170233556 A1 | US 20130245186 A1 | US 20080041508 A1 |
| US 20200392312 A1 | US 20170226322 A1 | US 20130231417 A1 | US 20080029215 A1 |
| US 20200392314 A1 | US 20170226234 A1 | US 20130231423 A1 | US 20080026244 A1 |
| US 20200392347 A1 | US 20170210887 A1 | US 20130203889 A1 | US 20080009564 A1 |
| US 20200385559 A1 | US 20170210885 A1 | US 20130203890 A1 | US 20070260000 A1 |
| US 20200385550 A1 | US 20170204260 A1 | US 20130178569 A1 | US 20070254983 A1 |
| US 20200346492 A1 | US 20170198114 A1 | US 20130160910 A1 | US 20070161733 A1 |
| US 20200332092 A1 | US 20170190217 A1 | US 20130165560 A1 | US 20070082991 A1 |
| US 20200325312 A1 | US 20170174615 A1 | US 20130165589 A1 | US 20070062623 A1 |
| US 20200317891 A1 | US 20170166731 A1 | US 20130158172 A1 | US 20060116457 A1 |
| US 20200317892 A1 | US 20170121509 A1 | US 20130153107 A1 | US 20060089445 A1 |
| US 20200299482 A1 | US 20170114496 A1 | US 20130153109 A1 | US 20060047050 A1 |
| US 20200254815 A1 | US 20170107663 A1 | US 20130158164 A1 | US 20060016534 A1 |
| US 20200255632 A1 | US 20170051154 A1 | US 20130146198 A1 | US 20060009564 A1 |
| US 20200254817 A1 | US 20170051126 A1 | US 20130150516 A1 | US 20050260406 A1 |
| US 20200189923 A1 | US 20160347121 A1 | US 20130123418 A1 | US 20050171264 A1 |
| US 20200190292 A1 | US 20160339743 A1 | US 20130116376 A1 | US 20050056967 A1 |
| US 20200181356 A1 | US 20160319113 A1 | US 20130096230 A1 | US 20050043448 A1 |
| US 20200165419 A1 | US 20160319114 A1 | US 20130079445 A1 | US 20050032949 A1 |
| US 20200157268 A1 | US 20160319115 A1 | US 20130053559 A1 | US 20050016651 A1 |
| US 20200157269 A1 | US 20160319112 A1 | US 20130053504 A1 | US 20050016650 A1 |
| US 20200140587 A1 | US 20160311201 A1 | US 20130053509 A1 | US 20050004297 A1 |
| US 20200139761 A1 | US 20160208076 A1 | US 20130053510 A1 | US 20040129360 A1 |
| US 20200140662 A1 | US 20160130418 A1 | US 20130046099 A1 | US 20040132880 A1 |
| US 20200131342 A1 | US 20160122504 A1 | US 20130030097 A1 | US 20040055680 A1 |
| US 20200131347 A1 | US 20160108209 A1 | US 20130012652 A1 | US 20040051210 A1 |
| US 20200108666 A1 | US 20160083567 A1 | US 20130005894 A1 | US 20040050471 A1 |
| US 20200101793 A1 | US 20160082787 A1 | US 20120325388 A1 | US 20040045650 A1 |
| US 20200101795 A1 | US 20160068659 A1 | US 20120318424 A1 | US 20040030017 A1 |
| US 20200095401 A1 | US 20160031190 A1 | US 20120318425 A1 | US 20030221760 A1 |
| US 20200095387 A1 | US 20150368444 A1 | US 20120309865 A1 | US 20030212185 A1 |
| US 20200094622 A1 | US 20150337109 A1 | US 20120283360 A1 | US 20030191225 A1 |
| US 20200086686 A1 | US 20150337111 A1 | US 20120283372 A1 | US 20030181562 A1 |
| US 20200062928 A1 | US 20150328931 A1 | US 20120270966 A1 | US 20030144394 A1 |
| US 20200062035 A1 | US 20150322241 A1 | US 20120259043 A1 | US 20030105242 A1 |
| US 20200055335 A1 | US 20150322234 A1 | US 20120247637 A1 | US 20020165302 A1 |
| US 20200056017 A1 | US 20150322183 A1 | US 20120252928 A1 | US 20020125615 A1 |
| US 20200055336 A1 | US 20150315356 A1 | US 20120252915 A1 | US 20020055011 A1 |
| US 20200056016 A1 | US 20150306912 A1 | US 20120245270 A1 | US 20020014185 A1 |
| US 20200040166 A1 | US 20150299435 A1 | US 20120214933 A1 | US 20010056138 A1 |
| US 20200040170 A1 | US 20150284548 A1 | US 20120175033 A1 | |
| US 20200001650 A1 | US 20150284546 A1 | US 20120165468 A1 | |
| US 20190382564 A1 | US 20150259516 A1 | US 20120165449 A1 | |

TABLE 102

| | | | |
|---|---|---|---|
| US 20220372253 A1 | US 20180179365 A1 | US 20140213708 A1 | US 20040129359 A1 |
| US 20220356329 A1 | US 20180170104 A1 | US 20140213700 A1 | US 20040127617 A1 |
| US 20220348700 A1 | US 20180170105 A1 | US 20140202609 A1 | US 20040122157 A1 |
| US 20220306590 A1 | US 20180171053 A1 | US 20140196825 A1 | US 20040099358 A1 |
| US 20220298123 A1 | US 20180171124 A1 | US 20140196827 A1 | US 20040102557 A1 |
| US 20220298335 A1 | US 20180171110 A1 | US 20140190605 A1 | US 20040092644 A1 |
| US 20220288971 A1 | US 20180162165 A1 | US 20140187693 A1 | US 20040084123 A1 |
| US 20220289949 A1 | US 20180155535 A1 | US 20140187720 A1 | US 20040034159 A1 |
| US 20220259436 A1 | US 20180141296 A1 | US 20140179853 A1 | US 20040009870 A1 |
| US 20220259413 A1 | US 20180142165 A1 | US 20140171580 A1 | US 20040006162 A1 |
| US 20220259414 A1 | US 20180141381 A1 | US 20140171577 A1 | US 20030234067 A1 |
| US 20220251333 A1 | US 20180141378 A1 | US 20140142235 A1 | US 20030229166 A1 |
| US 20220251347 A1 | US 20180134078 A1 | US 20140142236 A1 | US 20030216489 A1 |
| US 20220251334 A1 | US 20180134079 A1 | US 20140128531 A1 | US 20030205309 A1 |
| US 20220243041 A1 | US 20180126785 A1 | US 20140124113 A1 | US 20030203992 A1 |
| US 20220235203 A1 | US 20180127569 A1 | US 20140128535 A1 | US 20030201049 A1 |
| US 20220235209 A1 | US 20180126784 A1 | US 20140116594 A1 | US 20030195288 A1 |
| US 20220213035 A1 | US 20180118926 A1 | US 20140114008 A1 | US 20030176573 A1 |
| US 20220212499 A1 | US 20180117972 A1 | US 20140107285 A1 | US 20030158317 A1 |
| US 20220213295 A1 | US 20180118856 A1 | US 20140102611 A1 | US 20030144406 A1 |
| US 20220213236 A1 | US 20180118898 A1 | US 20140100321 A1 | US 20030125419 A1 |
| US 20220204731 A1 | US 20180118897 A1 | US 20140090764 A1 | US 20030125476 A1 |
| US 20220194798 A1 | US 20180112141 A1 | US 20140083588 A1 | US 20030119927 A1 |
| US 20220195074 A1 | US 20180111422 A1 | US 20140088258 A1 | US 20030111153 A1 |
| US 20220195155 A1 | US 20180111424 A1 | US 20140080969 A1 | US 20030114601 A1 |
| US 20220195104 A1 | US 20180105683 A1 | US 20140065337 A1 | US 20030114612 A1 |
| US 20220186001 A1 | US 20180105651 A1 | US 20140066548 A1 | US 20030094854 A1 |
| US 20220185932 A1 | US 20180105654 A1 | US 20140051792 A1 | US 20030082090 A1 |
| US 20220186000 A1 | US 20180105614 A1 | US 20140051793 A1 | US 20030075253 A1 |
| US 20220176744 A1 | US 20180104989 A1 | US 20140051791 A1 | US 20030069345 A1 |
| US 20220169077 A1 | US 20180105612 A1 | US 20140031487 A1 | US 20030069346 A1 |
| US 20220162363 A1 | US 20180105681 A1 | US 20140020808 A1 | US 20030069365 A1 |
| US 20220153964 A1 | US 20180100057 A1 | US 20140020857 A1 | US 20030055139 A1 |
| US 20220144974 A1 | US 20180100058 A1 | US 20140014250 A1 | US 20030040592 A1 |
| US 20220145074 A1 | US 20180099527 A1 | US 20140008002 A1 | US 20020198305 A1 |
| US 20220134808 A1 | US 20180086855 A1 | US 20140011909 A1 | US 20020193465 A1 |
| US 20220135789 A1 | US 20180079895 A1 | US 20140011926 A1 | US 20020187313 A1 |
| US 20220127446 A1 | US 20180072102 A1 | US 20140001293 A1 | US 20020165302 A1 |
| US 20220119555 A1 | US 20180072860 A1 | US 20140000780 A1 | US 20020156202 A1 |
| US 20220119623 A1 | US 20180072100 A1 | US 20130338255 A1 | US 20020151640 A1 |
| US 20220112360 A1 | US 20180072874 A1 | US 20130333819 A1 | US 20020140288 A1 |
| US 20220112361 A1 | US 20180065413 A1 | US 20130331480 A1 | US 20020132888 A1 |
| US 20220073668 A1 | US 20180057674 A1 | US 20130324638 A1 | US 20020115767 A1 |
| US 20220073709 A1 | US 20180057667 A1 | US 20130317137 A1 | US 20020107338 A1 |
| US 20220064415 A1 | US 20180057665 A1 | US 20130306209 A1 | US 20020107317 A1 |
| US 20220064351 A1 | US 20180057672 A1 | US 20130303687 A1 | US 20020100530 A1 |
| US 20220064416 A1 | US 20180051118 A1 | US 20130303657 A1 | US 20020086917 A1 |
| US 20220056242 A1 | US 20180044455 A1 | US 20130296463 A1 | US 20020077408 A1 |
| US 20220056182 A1 | US 20180043736 A1 | US 20130292023 A1 | US 20020068784 A1 |
| US 20220041843 A1 | US 20180044510 A1 | US 20130281588 A1 | US 20020055646 A1 |
| US 20220041013 A1 | US 20180037059 A1 | US 20130281581 A1 | US 20020055011 A1 |
| US 20220033624 A1 | US 20180037459 A1 | US 20130274408 A1 | US 20020042465 A1 |
| US 20220025159 A1 | US 20180030070 A1 | US 20130267638 A1 | US 20020042462 A1 |
| US 20220025163 A1 | US 20180030249 A1 | US 20130267646 A1 | US 20020033216 A1 |
| US 20220017727 A1 | US 20180016424 A1 | US 20130261272 A1 | US 20020019484 A1 |
| US 20220010104 A1 | US 20180016402 A1 | US 20130261242 A1 | US 20020014185 A1 |
| US 20220009283 A1 | US 20180016369 A1 | US 20130261221 A1 | US 20020016391 A1 |
| US 20220001695 A1 | US 20180009971 A1 | US 20130253090 A1 | US 20020016404 A1 |
| US 20210403684 A1 | US 20180002498 A1 | US 20130253088 A1 | US 20020007890 A1 |
| US 20210395497 A1 | US 20180001703 A1 | US 20130237637 A1 | US 20010052378 A1 |
| US 20210388143 A1 | US 20180001716 A1 | US 20130231423 A1 | US 20010051684 A1 |
| US 20210388144 A1 | US 20180002490 A1 | US 20130231426 A1 | US 20010051677 A1 |
| US 20210388185 A1 | US 20180002497 A1 | US 20130217802 A1 | US 20010034395 A1 |
| US 20210388198 A1 | US 20170369606 A1 | US 20130210978 A1 | US 20010031836 A1 |
| US 20210380785 A1 | US 20170369680 A1 | US 20130202830 A1 | US 20010031795 A1 |
| US 20210380784 A1 | US 20170369621 A1 | US 20130203893 A1 | US 20010021729 A1 |
| US 20210380787 A1 | US 20170369683 A1 | US 20130186540 A1 | US 20010009932 A1 |
| US 20210380786 A1 | US 20170361658 A1 | US 20130186541 A1 | US 20230391990 A1 |
| US 20210363333 A1 | US 20170361654 A1 | US 20130190423 A1 | US 20230391989 A1 |
| US 20210355303 A1 | US 20170342252 A1 | US 20130184397 A1 | US 20230391894 A1 |
| US 20210340306 A1 | US 20170342253 A1 | US 20130184387 A1 | US 20230391630 A1 |
| US 20210340360 A1 | US 20170341468 A1 | US 20130184373 A1 | US 20230383091 A1 |
| US 20210332223 A1 | US 20170327601 A1 | US 20130172443 A1 | US 20230383014 A1 |
| US 20210324183 A1 | US 20170327670 A1 | US 20130165560 A1 | US 20230374279 A1 |
| US 20210309837 A1 | US 20170321040 A1 | US 20130158164 A1 | US 20230374278 A1 |
| US 20210301109 A1 | US 20170321045 A1 | US 20130158185 A1 | US 20230365728 A1 |
| US 20210291589 A1 | US 20170321033 A1 | US 20130153100 A1 | US 20230357543 A1 |
| US 20210292520 A1 | US 20170313861 A1 | US 20130146197 A1 | US 20230331042 A1 |
| US 20210292521 A1 | US 20170313862 A1 | US 20130150512 A1 | US 20230322024 A1 |
| US 20210284538 A1 | US 20170313005 A1 | US 20130150501 A1 | US 20230312874 A1 |
| US 20210277210 A1 | US 20170306104 A1 | US 20130150500 A1 | US 20230303727 A1 |
| US 20210261575 A1 | US 20170306130 A1 | US 20130137807 A1 | US 20230295401 A1 |
| US 20210252916 A1 | US 20170306108 A1 | US 20130131240 A1 | US 20230279201 A1 |
| US 20210252912 A1 | US 20170306106 A1 | US 20130131221 A1 | US 20230278369 A1 |
| US 20210245459 A1 | US 20170292013 A1 | US 20130123418 A1 | US 20230278367 A1 |
| US 20210230420 A1 | US 20170291818 A1 | US 20130123387 A1 | US 20230271450 A1 |
| US 20210230401 A1 | US 20170292063 A1 | US 20130116360 A1 | US 20230265113 A1 |
| US 20210230403 A1 | US 20170283593 A1 | US 20130098523 A1 | US 20230264964 A1 |
| US 20210221981 A1 | US 20170283518 A1 | US 20130102722 A1 | US 20230260671 A1 |
| US 20210214530 A1 | US 20170275237 A1 | US 20130096248 A1 | US 20230257553 A1 |
| US 20210206948 A1 | US 20170275234 A1 | US 20130090445 A1 | US 20230257552 A1 |
| US 20210198458 A1 | US 20170275233 A1 | US 20130085223 A1 | US 20230234403 A1 |
| US 20210198459 A1 | US 20170275239 A1 | US 20130059965 A1 | US 20230220212 A1 |
| US 20210188005 A1 | US 20170260340 A1 | US 20130053491 A1 | US 20230220179 A1 |
| US 20210179821 A1 | US 20170253728 A1 | US 20130035437 A1 | US 20230219379 A1 |
| US 20210178829 A1 | US 20170247533 A1 | US 20130035443 A1 | US 20230212369 A1 |
| US 20210178828 A1 | US 20170246905 A1 | US 20130030097 A1 | US 20230212344 A1 |
| US 20210179819 A1 | US 20170246918 A1 | US 20120325388 A1 | US 20230203279 A1 |
| US 20210179789 A1 | US 20170239991 A1 | US 20120325390 A1 | US 20230203255 A1 |
| US 20210179741 A1 | US 20170240729 A1 | US 20120325391 A1 | US 20230202235 A1 |
| US 20210179823 A1 | US 20170233556 A1 | US 20120316289 A1 | US 20230192999 A1 |
| US 20210178835 A1 | US 20170233559 A1 | US 20120316283 A1 | US 20230192986 A1 |
| US 20210171676 A1 | US 20170226322 A1 | US 20120305156 A1 | US 20230192934 A1 |
| US 20210163632 A1 | US 20170226234 A1 | US 20120302665 A1 | US 20230183463 A1 |
| US 20210163720 A1 | US 20170217778 A1 | US 20120296027 A1 | US 20230183457 A1 |
| US 20210162806 A1 | US 20170218186 A1 | US 20120283360 A1 | US 20230183453 A1 |
| US 20210155047 A1 | US 20170218190 A1 | US 20120283372 A1 | US 20230173777 A1 |
| US 20210155778 A1 | US 20170218185 A1 | US 20120283387 A1 | US 20230167371 A1 |
| US 20210147655 A1 | US 20170218170 A1 | US 20120276316 A1 | US 20230167283 A1 |
| US 20210139675 A1 | US 20170210172 A1 | US 20120270966 A1 | US 20230159724 A1 |
| US 20210130578 A1 | US 20170203612 A1 | US 20120267026 A1 | US 20230159685 A1 |
| US 20210130504 A1 | US 20170197469 A1 | US 20120259043 A1 | US 20230151214 A1 |
| US 20210122191 A1 | US 20170197468 A1 | US 20120255661 A1 | US 20230151190 A1 |
| US 20210122885 A1 | US 20170190935 A1 | US 20120259060 A1 | US 20230151183 A1 |
| US 20210115218 A1 | US 20170190888 A1 | US 20120259037 A1 | US 20230146440 A1 |
| US 20210102046 A1 | US 20170182845 A1 | US 20120259038 A1 | US 20230145787 A1 |
| US 20210087366 A1 | US 20170183483 A1 | US 20120259051 A1 | US 20230140989 A1 |
| US 20210087316 A1 | US 20170174876 A1 | US 20120252928 A1 | US 20230134110 A1 |
| US 20210087369 A1 | US 20170174001 A1 | US 20120247630 A1 | US 20230130953 A1 |
| US 20210079124 A1 | US 20170174615 A1 | US 20120252929 A1 | US 20230130750 A1 |
| US 20210070113 A1 | US 20170166727 A1 | US 20120252946 A1 | US 20230130221 A1 |
| US 20210070112 A1 | US 20170166728 A1 | US 20120245270 A1 | US 20230129988 A1 |
| US 20210070111 A1 | US 20170158842 A1 | US 20120234441 A1 | US 20230126418 A1 |
| US 20210061006 A1 | US 20170151836 A1 | US 20120234452 A1 | US 20230116111 A1 |
| US 20210061962 A1 | US 20170152370 A1 | US 20120232223 A1 | US 20230108559 A1 |
| US 20210061826 A1 | US 20170144486 A1 | US 20120232216 A1 | US 20230106817 A1 |
| US 20210047501 A1 | US 20170144490 A1 | US 20120225231 A1 | US 20230098008 A1 |
| US 20210031565 A1 | US 20170136821 A1 | US 20120205589 A1 | US 20230095190 A1 |
| US 20210032439 A1 | US 20170136820 A1 | US 20120196976 A1 | US 20230093015 A1 |
| US 20210032389 A1 | US 20170137604 A1 | US 20120197044 A1 | US 20230091284 A1 |
| US 20210024668 A1 | US 20170137600 A1 | US 20120184671 A1 | US 20230084880 A1 |
| US 20210024725 A1 | US 20170130028 A1 | US 20120184658 A1 | US 20230076622 A1 |
| US 20210023886 A1 | US 20170130036 A1 | US 20120172517 A1 | US 20230073273 A1 |
| US 20210023880 A1 | US 20170129291 A1 | US 20120172492 A1 | US 20230071816 A1 |
| US 20210017369 A1 | US 20170120682 A1 | US 20120165446 A1 | US 20230067289 A1 |
| US 20210009722 A1 | US 20170121490 A1 | US 20120165464 A1 | US 20230061187 A1 |
| US 20200407537 A1 | US 20170121494 A1 | US 20120157585 A1 | US 20230058851 A1 |
| US 20200392312 A1 | US 20170121477 A1 | US 20120157713 A1 | US 20230055055 A1 |
| US 20200392311 A1 | US 20170101526 A1 | US 20120157714 A1 | US 20230052284 A1 |
| US 20200392314 A1 | US 20170096550 A1 | US 20120108718 A1 | US 20230051287 A1 |
| US 20200392309 A1 | US 20170080754 A1 | US 20120097302 A1 | US 20230048540 A1 |
| US 20200392069 A1 | US 20170081506 A1 | US 20120088928 A1 | US 20230045260 A1 |
| US 20200384808 A1 | US 20170073508 A1 | US 20120073724 A1 | US 20230042687 A1 |
| US 20200377636 A1 | US 20170073477 A1 | US 20120065319 A1 | US 20230039642 A1 |
| US 20200377702 A1 | US 20170073506 A1 | US 20120059121 A1 | US 20230038987 A1 |
| US 20200377624 A1 | US 20170073507 A1 | US 20120059113 A1 | US 20230038477 A1 |
| US 20200377699 A1 | US 20170066898 A1 | US 20120048443 A1 | US 20230034747 A1 |
| US 20200377700 A1 | US 20170066910 A1 | US 20120053263 A1 | US 20230033641 A1 |
| US 20200377623 A1 | US 20170051085 A1 | US 20120041128 A1 | US 20230031239 A1 |
| US 20200377696 A1 | US 20170022352 A1 | US 20120016056 A1 | US 20230029797 A1 |
| US 20200377698 A1 | US 20170015812 A1 | US 20110319532 A1 | US 20230022627 A1 |
| US 20200369856 A1 | US 20170001398 A1 | US 20110308684 A1 | US 20230016289 A1 |
| US 20200371075 A1 | US 20170001476 A1 | US 20110297285 A1 | US 20230007840 A1 |
| US 20200361242 A1 | US 20170002101 A1 | US 20110301280 A1 | US 20230002545 A1 |
| US 20200346498 A1 | US 20160375727 A1 | US 20110294936 A1 | US 20220411657 A1 |
| US 20200339720 A1 | US 20160376426 A1 | US 20110294949 A1 | US 20220411613 A1 |
| US 20200331296 A1 | US 20160368324 A1 | US 20110265923 A1 | US 20220410627 A1 |
| US 20200325309 A1 | US 20160362525 A1 | US 20110269889 A1 | US 20220403068 A1 |
| US 20200325310 A1 | US 20160355057 A1 | US 20110259496 A1 | US 20220388351 A1 |
| US 20200317891 A1 | US 20160347926 A1 | US 20110263761 A1 | US 20220332016 A1 |
| US 20200316995 A1 | US 20160347870 A1 | US 20110230613 A1 | US 20220298334 A1 |
| US 20200308376 A1 | US 20160340502 A1 | US 20110226395 A1 | US 20220283133 A1 |
| US 20200307315 A1 | US 20160340446 A1 | US 20110213049 A1 | US 20220282071 A1 |
| US 20200308375 A1 | US 20160340501 A1 | US 20110207847 A1 | US 20220275292 A1 |
| US 20200299482 A1 | US 20160340500 A1 | US 20110207872 A1 | US 20220267580 A1 |
| US 20200290398 A1 | US 20160339744 A1 | US 20110160337 A1 | US 20220267524 A1 |
| US 20200282770 A1 | US 20160332485 A1 | US 20110144236 A1 | US 20220259333 A1 |
| US 20200276866 A1 | US 20160319114 A1 | US 20110136938 A1 | |
| US 20200277486 A1 | US 20160319115 A1 | US 20110136970 A1 | |
| US 20200277471 A1 | US 20160319112 A1 | US 20110130499 A1 | |
| US 20200269634 A1 | US 20160311258 A1 | US 20110118404 A1 | |
| US 20200270420 A1 | US 20160311187 A1 | US 20110108179 A1 | |
| US 20200270431 A1 | US 20160312016 A1 | US 20110112212 A1 | |
| US 20200262956 A1 | US 20160304706 A1 | US 20110112214 A1 | |
| US 20200255636 A1 | US 20160297897 A1 | US 20110094650 A1 | |
| US 20200260619 A1 | US 20160297954 A1 | US 20110098378 A1 | |
| US 20200247193 A1 | US 20160297947 A1 | US 20110095106 A1 | |
| US 20200247980 A1 | US 20160289396 A1 | US 20110086943 A1 | |
| US 20200239603 A1 | US 20160289352 A1 | US 20110054095 A1 | |
| US 20200223259 A1 | US 20160289398 A1 | US 20110046272 A1 | |
| US 20200223258 A1 | US 20160280886 A1 | US 20110039994 A1 | |
| US 20200216633 A1 | US 20160280007 A1 | US 20110028596 A1 | |
| US 20200207969 A1 | US 20160272005 A1 | US 20110021664 A1 | |
| US 20200189331 A1 | US 20160272793 A1 | US 20110021801 A1 | |
| US 20200181356 A1 | US 20160272792 A1 | US 20110011507 A1 | |
| US 20200180359 A1 | US 20160264688 A1 | US 20110003932 A1 | |
| US 20200181370 A1 | US 20160263868 A1 | US 20100319824 A1 | |
| US 20200181372 A1 | US 20160251502 A1 | US 20100324168 A1 | |
| US 20200180366 A1 | US 20160251503 A1 | US 20100317778 A1 | |
| US 20200172639 A1 | US 20160237259 A1 | US 20100317793 A1 | |
| US 20200156413 A1 | US 20160237253 A1 | US 20100317800 A1 | |
| US 20200148871 A1 | US 20160237256 A1 | US 20100308495 A1 | |
| US 20200140663 A1 | US 20160237258 A1 | US 20100298476 A1 | |
| US 20200130306 A1 | US 20160229992 A1 | US 20100292406 A1 | |
| US 20200131344 A1 | US 20160222138 A1 | US 20100288406 A1 | |
| US 20200108666 A1 | US 20160222197 A1 | US 20100286348 A1 | |
| US 20200109222 A1 | US 20160214437 A1 | US 20100234535 A1 | |
| US 20200095387 A1 | US 20160215125 A1 | US 20100234500 A1 | |
| US 20200087502 A1 | US 20160215131 A1 | US 20100224301 A1 | |
| US 20200071505 A1 | US 20160215126 A1 | US 20100200141 A1 | |
| US 20200062928 A1 | US 20160208082 A1 | US 20100184893 A1 | |
| US 20200062933 A1 | US 20160208076 A1 | US 20100179247 A1 | |
| US 20200056017 A1 | US 20160200141 A1 | US 20100163150 A1 | |
| US 20200056018 A1 | US 20160194485 A1 | US 20100163151 A1 | |
| US 20200055881 A1 | US 20160185938 A1 | US 20100168230 A1 | |
| US 20200048373 A1 | US 20160177072 A1 | US 20100132868 A1 | |
| US 20200048429 A1 | US 20160177070 A1 | US 20100130688 A1 | |
| US 20200040166 A1 | US 20160159956 A1 | US 20100120956 A1 | |
| US 20200031963 A1 | US 20160152792 A1 | US 20100112259 A1 | |
| US 20200031979 A1 | US 20160152805 A1 | US 20100113681 A1 | |
| US 20200016932 A1 | US 20160137001 A1 | US 20100093916 A1 | |
| US 20200017662 A1 | US 20160130418 A1 | US 20100076151 A1 | |
| US 20200009914 A1 | US 20160130427 A1 | US 20100059160 A1 | |
| US 20200001651 A1 | US 20160130426 A1 | US 20100063178 A1 | |
| US 20190381832 A1 | US 20160130421 A1 | US 20100048775 A1 | |
| US 20190375913 A1 | US 20160122504 A1 | US 20100044189 A1 | |
| US 20190367711 A1 | US 20160115296 A1 | US 20100012248 A1 | |
| US 20190367708 A1 | US 20160114633 A1 | US 20100012245 A1 | |
| US 20190359797 A1 | US 20160108201 A1 | US 20100010116 A1 | |
| US 20190351708 A1 | US 20160108209 A1 | US 20100004398 A1 | |
| US 20190352489 A1 | US 20160108210 A1 | US 20100004368 A1 | |
| US 20190338084 A1 | US 20160102193 A1 | US 20100000639 A1 | |
| US 20190330448 A1 | US 20160075836 A1 | US 20090326144 A1 | |
| US 20190330401 A1 | US 20160075863 A1 | US 20090326109 A1 | |
| US 20190322845 A1 | US 20160060368 A1 | US 20090326176 A1 | |
| US 20190322137 A1 | US 20160053094 A1 | US 20090318585 A1 | |
| US 20190322844 A1 | US 20160046754 A1 | US 20090306246 A1 | |
| US 20190315946 A1 | US 20160046790 A1 | US 20090306267 A1 | |
| US 20190308455 A1 | US 20160031268 A1 | US 20090292044 A1 | |
| US 20190300684 A1 | US 20160024270 A1 | US 20090272472 A1 | |
| US 20190300640 A1 | US 20160024286 A1 | US 20090266461 A1 | |
| US 20190300681 A1 | US 20160017078 A1 | US 20090247683 A1 | |
| US 20190300683 A1 | US 20160009874 A1 | US 20090186965 A1 | |
| US 20190291958 A1 | US 20160009843 A1 | US 20090182106 A1 | |
| US 20190291957 A1 | US 20160009846 A1 | US 20090171002 A1 | |
| US 20190284370 A1 | US 20160009832 A1 | US 20090163675 A1 | |
| US 20190284371 A1 | US 20160009146 A1 | US 20090151839 A1 | |
| US 20190270866 A1 | US 20160002371 A1 | US 20090137730 A1 | |
| US 20190270234 A1 | US 20160001598 A1 | US 20090137701 A1 | |
| US 20190263979 A1 | US 20150375566 A1 | US 20090137718 A1 | |
| US 20190256624 A1 | US 20150376348 A1 | US 20090124738 A1 | |
| US 20190255884 A1 | US 20150376380 A1 | US 20090124724 A1 | |
| US 20190255887 A1 | US 20150368444 A1 | US 20090115108 A1 | |
| US 20190255883 A1 | US 20150361248 A1 | US 20090111920 A1 | |
| US 20190256694 A1 | US 20150360514 A1 | US 20090105398 A1 | |
| US 20190256670 A1 | US 20150353716 A1 | US 20090105394 A1 | |
| US 20190248189 A1 | US 20150352909 A1 | US 20090105403 A1 | |
| US 20190248990 A1 | US 20150353657 A1 | US 20090099281 A1 | |
| US 20190248181 A1 | US 20150352910 A1 | US 20090093594 A1 | |
| US 20190241720 A1 | US 20150344679 A1 | US 20090088532 A1 | |
| US 20190241721 A1 | US 20150343843 A1 | US 20090088496 A1 | |
| US 20190233624 A1 | US 20150343854 A1 | US 20090076210 A1 | |
| US 20190232720 A1 | US 20150337109 A1 | US 20090056847 A1 | |
| US 20190225775 A1 | US 20150329704 A1 | US 20090062428 A1 | |
| US 20190218350 A1 | US 20150322234 A1 | US 20090043039 A1 | |
| US 20190211191 A1 | US 20150322248 A1 | US 20090036596 A1 | |
| US 20190211161 A1 | US 20150322190 A1 | US 20090030105 A1 | |
| US 20190185646 A1 | US 20150322193 A1 | US 20090015415 A1 | |
| US 20190177516 A1 | US 20150315356 A1 | US 20090005481 A1 | |
| US 20190177497 A1 | US 20150314644 A1 | US 20080293871 A1 | |
| US 20190169406 A1 | US 20150315299 A1 | US 20080287577 A1 | |
| US 20190160871 A1 | US 20150315358 A1 | US 20080279749 A1 | |
| US 20190144281 A1 | US 20150315363 A1 | US 20080269385 A1 | |
| US 20190136019 A1 | US 20150306921 A1 | US 20080255310 A1 | |
| US 20190126682 A1 | US 20150299435 A1 | US 20080242771 A1 | |
| US 20190126683 A1 | US 20150299436 A1 | US 20080223494 A1 | |
| US 20190119473 A1 | US 20150291777 A1 | US 20080161452 A1 | |
| US 20190119428 A1 | US 20150291765 A1 | US 20080161475 A1 | |
| US 20190110382 A1 | US 20150284548 A1 | US 20080135799 A1 | |
| US 20190106566 A1 | US 20150283854 A1 | US 20080121330 A1 | |
| US 20190092098 A1 | US 20150274939 A1 | US 20080108733 A1 | |
| US 20190092937 A1 | US 20150273953 A1 | US 20080097023 A1 | |
| US 20190085158 A1 | US 20150251501 A1 | US 20080066845 A1 | |
| US 20190077887 A1 | US 20150252176 A1 | US 20080058462 A1 | |
| US 20190077891 A1 | US 20150240059 A1 | US 20080035260 A1 | |
| US 20190071560 A1 | US 20150240016 A1 | US 20080033103 A1 | |
| US 20190062483 A1 | US 20150225561 A1 | US 20070295433 A1 | |
| US 20190062536 A1 | US 20150218298 A1 | US 20070231532 A1 | |
| US 20190061427 A1 | US 20150209993 A1 | US 20070197715 A1 | |
| US 20190061426 A1 | US 20150203661 A1 | US 20070187013 A1 | |
| US 20190062538 A1 | US 20150203670 A1 | US 20070167555 A1 | |
| US 20190055380 A1 | US 20150203668 A1 | US 20070161733 A1 | |
| US 20190047326 A1 | US 20150197886 A1 | US 20070144643 A1 | |
| US 20190048175 A1 | US 20150197876 A1 | US 20070149689 A1 | |
| US 20190048173 A1 | US 20150191584 A1 | US 20070142553 A1 | |
| US 20190048174 A1 | US 20150191586 A1 | US 20070100057 A1 | |
| US 20190048120 A1 | US 20150183962 A1 | US 20070093612 A1 | |
| US 20190047332 A1 | US 20150183983 A1 | US 20070084537 A1 | |
| US 20190040240 A1 | US 20150184054 A1 | US 20070078202 A1 | |
| US 20190031863 A1 | US 20150183971 A1 | US 20070072959 A1 | |
| US 20190031866 A1 | US 20150165824 A1 | US 20070059232 A1 | |
| US 20190030953 A1 | US 20150166700 A1 | US 20070060711 A1 | |
| US 20190031837 A1 | US 20150166698 A1 | US 20070037908 A1 | |
| US 20190023829 A1 | US 20150166707 A1 | US 20070037915 A1 | |
| US 20190023881 A1 | US 20150158338 A1 | US 20070029022 A1 | |
| US 20190023880 A1 | US 20150152253 A1 | US 20070012391 A1 | |
| US 20190023827 A1 | US 20150151579 A1 | US 20070006956 A1 | |
| US 20190016178 A1 | US 20150151580 A1 | US 20070000591 A1 | |
| US 20190016872 A1 | US 20150144240 A1 | US 20070004845 A1 | |
| US 20190002670 A1 | US 20150136287 A1 | US 20060281841 A1 | |
| US 20190002653 A1 | US 20150125685 A1 | US 20060280925 A1 | |
| US 20190002702 A1 | US 20150094425 A1 | US 20060254463 A1 | |
| US 20190002697 A1 | US 20150086735 A1 | US 20060252879 A1 | |
| US 20180371216 A1 | US 20150087744 A1 | US 20060217473 A1 | |
| US 20180370288 A1 | US 20150087745 A1 | US 20060207700 A1 | |
| US 20180362679 A1 | US 20150057414 A1 | US 20060199894 A1 | |
| US 20180354210 A1 | US 20150047762 A1 | US 20060165581 A1 | |
| US 20180340074 A1 | US 20150041038 A1 | US 20060167173 A1 | |
| US 20180326784 A1 | US 20150031792 A1 | US 20060161015 A1 | |
| US 20180327575 A1 | US 20150031791 A1 | US 20060155026 A1 | |
| US 20180327571 A1 | US 20150031821 A1 | US 20060148979 A1 | |
| US 20180319992 A1 | US 20150020945 A1 | US 20060137575 A1 | |
| US 20180312003 A1 | US 20150017467 A1 | US 20060116465 A1 | |
| US 20180312732 A1 | US 20150011710 A1 | US 20060108706 A1 | |
| US 20180312670 A1 | US 20150000827 A1 | US 20060099129 A1 | |
| US 20180304693 A1 | US 20150005418 A1 | US 20060100344 A1 | |
| US 20180304683 A1 | US 20150000812 A1 | US 20060090830 A1 | |
| US 20180304682 A1 | US 20140378597 A1 | US 20060094831 A1 | |
| US 20180305469 A1 | US 20140378575 A1 | US 20060089472 A1 | |
| US 20180298165 A1 | US 20140373995 A1 | US 20060025538 A1 | |
| US 20180298166 A1 | US 20140373989 A1 | US 20060025506 A1 | |
| US 20180298164 A1 | US 20140371392 A1 | US 20060004138 A1 | |
| US 20180297405 A1 | US 20140366633 A1 | US 20050288408 A1 | |
| US 20180297404 A1 | US 20140371346 A1 | US 20050282950 A1 | |
| US 20180297403 A1 | US 20140367009 A1 | US 20050267247 A1 | |
| US 20180291041 A1 | US 20140364560 A1 | US 20050256249 A1 | |
| US 20180290490 A1 | US 20140360647 A1 | US 20050223946 A1 | |
| US 20180291181 A1 | US 20140360645 A1 | US 20050209413 A1 | |
| US 20180281520 A1 | US 20140352865 A1 | US 20050176861 A1 | |
| US 20180282446 A1 | US 20140345773 A1 | US 20050154156 A1 | |
| US 20180284085 A1 | US 20140345774 A1 | US 20050148713 A1 | |
| US 20180273724 A1 | US 20140350174 A1 | US 20050130835 A1 | |
| US 20180264883 A1 | US 20140350173 A1 | US 20050124740 A1 | |
| US 20180265666 A1 | US 20140338811 A1 | US 20050087906 A1 | |
| US 20180250985 A1 | US 20140332137 A1 | US 20050080179 A1 | |
| US 20180244108 A1 | US 20140332132 A1 | US 20050051248 A1 | |
| US 20180244112 A1 | US 20140329946 A1 | US 20050040555 A1 | |
| US 20180244103 A1 | US 20140323627 A1 | US 20050004386 A1 | |
| US 20180244809 A1 | US 20140311641 A1 | US 20040266968 A1 | |
| US 20180215202 A1 | US 20140296375 A1 | US 20040266915 A1 | |
| US 20180215844 A1 | US 20140296421 A1 | US 20040249045 A1 | |
| US 20180207984 A1 | US 20140290532 A1 | US 20040220307 A1 | |
| US 20180201741 A1 | US 20140261951 A1 | US 20040220321 A1 | |
| US 20180194167 A1 | US 20140251521 A1 | US 20040214929 A1 | |
| US 20180186189 A1 | US 20140256846 A1 | US 20040194871 A1 | |
| US 20180186975 A1 | US 20140251519 A1 | US 20040198881 A1 | |
| US 20180187013 A1 | US 20140230984 A1 | US 20040194863 A1 | |
| US 20180186186 A1 | US 20140228495 A1 | US 20040192825 A1 | |
| US 20180179372 A1 | US 20140228505 A1 | US 20040192839 A1 | |
| US 20180179364 A1 | US 20140217656 A1 | US 20040181004 A1 | |

In some embodiments, the disclosure provides the rubber compositions and/or tires as disclosed in the US Patents in Table 103 or Table 104, wherein an antidegradant, e.g., an antioxidant, e.g., 6PPD, in each rubber composition and/or tire is either partially or completely substituted with a Compound of the Disclosure, e.g., a compound of Tables A-J.

TABLE 103

| | | | |
|---|---|---|---|
| U.S. Pat. No. 11,512,185 B2 | U.S. Pat. No. 10,442,625 B1 | U.S. Pat. No. 9,556,297 B2 | U.S. Pat. No. 7,981,971 B2 |
| U.S. Pat. No. 11,505,623 B2 | U.S. Pat. No. 10,435,544 B2 | U.S. Pat. No. 9,550,850 B2 | U.S. Pat. No. 7,968,634 B2 |
| U.S. Pat. No. 11,505,677 B2 | U.S. Pat. No. 10,435,541 B2 | U.S. Pat. No. 9,546,251 B2 | U.S. Pat. No. 7,968,633 B2 |
| U.S. Pat. No. 11,499,036 B2 | U.S. Pat. No. 10,435,586 B2 | U.S. Pat. No. 9,546,232 B2 | U.S. Pat. No. 7,964,128 B2 |
| U.S. Pat. No. 11,485,800 B2 | U.S. Pat. No. 10,435,522 B2 | U.S. Pat. No. 9,522,990 B2 | U.S. Pat. No. 7,954,528 B2 |
| U.S. Pat. No. 11,472,947 B2 | U.S. Pat. No. 10,428,188 B2 | U.S. Pat. No. 9,518,172 B2 | U.S. Pat. No. 7,951,861 B2 |
| U.S. Pat. No. 11,466,139 B2 | U.S. Pat. No. 10,428,009 B2 | U.S. Pat. No. 9,505,917 B2 | U.S. Pat. No. 7,939,175 B2 |
| U.S. Pat. No. 11,459,448 B2 | U.S. Pat. No. 10,428,197 B2 | U.S. Pat. No. 9,499,014 B2 | U.S. Pat. No. 7,923,493 B2 |
| U.S. Pat. No. 11,458,767 B2 | U.S. Pat. No. 10,421,767 B2 | U.S. Pat. No. 9,499,730 B2 | U.S. Pat. No. 7,919,558 B2 |
| U.S. Pat. No. 11,458,778 B2 | U.S. Pat. No. 10,414,914 B2 | U.S. Pat. No. 9,499,009 B2 | U.S. Pat. No. 7,902,265 B2 |
| U.S. Pat. No. 11,453,251 B2 | U.S. Pat. No. 10,414,841 B2 | U.S. Pat. No. 9,493,637 B2 | U.S. Pat. No. 7,897,665 B2 |
| U.S. Pat. No. 11,440,349 B2 | U.S. Pat. No. 10,414,909 B2 | U.S. Pat. No. 9,493,639 B2 | U.S. Pat. No. 7,863,389 B2 |
| U.S. Pat. No. 11,441,006 B2 | U.S. Pat. No. 10,414,656 B2 | U.S. Pat. No. 9,493,599 B2 | U.S. Pat. No. 7,855,248 B2 |
| U.S. Pat. No. 11,433,705 B2 | U.S. Pat. No. 10,414,882 B2 | U.S. Pat. No. 9,481,746 B2 | U.S. Pat. No. 7,837,892 B2 |
| U.S. Pat. No. 11,434,333 B2 | U.S. Pat. No. 10,406,862 B2 | U.S. Pat. No. 9,475,924 B2 | U.S. Pat. No. 7,820,751 B2 |
| U.S. Pat. No. 11,427,029 B2 | U.S. Pat. No. 10,399,386 B2 | U.S. Pat. No. 9,464,174 B2 | U.S. Pat. No. 7,803,866 B2 |
| U.S. Pat. No. 11,420,474 B2 | U.S. Pat. No. 10,399,385 B2 | U.S. Pat. No. 9,458,253 B2 | U.S. Pat. No. 7,799,870 B2 |
| U.S. Pat. No. 11,413,905 B2 | U.S. Pat. No. 10,400,094 B2 | U.S. Pat. No. 9,458,274 B2 | U.S. Pat. No. 7,790,131 B2 |
| U.S. Pat. No. 11,397,169 B2 | U.S. Pat. No. 10,392,478 B2 | U.S. Pat. No. 9,447,262 B2 | U.S. Pat. No. 7,776,967 B2 |
| U.S. Pat. No. 11,396,569 B2 | U.S. Pat. No. 10,364,335 B2 | U.S. Pat. No. 9,447,255 B2 | U.S. Pat. No. 7,767,742 B2 |
| U.S. Pat. No. 11,390,119 B2 | U.S. Pat. No. 10,358,769 B2 | U.S. Pat. No. 9,446,627 B2 | U.S. Pat. No. 7,743,807 B2 |
| U.S. Pat. No. 11,390,118 B2 | U.S. Pat. No. 10,358,518 B2 | U.S. Pat. No. 9,416,252 B2 | U.S. Pat. No. 7,737,203 B2 |
| U.S. Pat. No. 11,370,249 B2 | U.S. Pat. No. 10,350,943 B2 | U.S. Pat. No. 9,410,033 B2 | U.S. Pat. No. 7,732,517 B2 |
| U.S. Pat. No. 11,365,309 B2 | U.S. Pat. No. 10,344,147 B2 | U.S. Pat. No. 9,403,959 B2 | U.S. Pat. No. 7,732,522 B2 |
| U.S. Pat. No. 11,365,306 B2 | U.S. Pat. No. 10,343,455 B2 | U.S. Pat. No. 9,394,434 B2 | U.S. Pat. No. 7,718,722 B2 |
| U.S. Pat. No. 11,359,077 B2 | U.S. Pat. No. 10,328,750 B2 | U.S. Pat. No. 9,387,724 B2 | U.S. Pat. No. 7,714,060 B2 |
| U.S. Pat. No. 11,358,414 B2 | U.S. Pat. No. 10,329,406 B2 | U.S. Pat. No. 9,388,526 B2 | U.S. Pat. No. 7,703,493 B2 |
| U.S. Pat. No. 11,352,459 B2 | U.S. Pat. No. 10,316,164 B2 | U.S. Pat. No. 9,376,554 B2 | U.S. Pat. No. 7,687,602 B2 |
| U.S. Pat. No. 11,332,679 B2 | U.S. Pat. No. 10,308,073 B2 | U.S. Pat. No. 9,371,495 B2 | U.S. Pat. No. 7,674,861 B1 |
| U.S. Pat. No. 11,332,556 B2 | U.S. Pat. No. 10,294,314 B2 | U.S. Pat. No. 9,365,699 B2 | U.S. Pat. No. 7,671,137 B2 |
| U.S. Pat. No. 11,325,988 B2 | U.S. Pat. No. 10,294,349 B2 | U.S. Pat. No. 9,358,549 B2 | U.S. Pat. No. 7,666,933 B2 |
| U.S. Pat. No. 11,330,744 B2 | U.S. Pat. No. 10,286,730 B2 | U.S. Pat. No. 9,359,462 B2 | U.S. Pat. No. 7,638,574 B2 |
| U.S. Pat. No. 11,312,843 B2 | U.S. Pat. No. 10,287,419 B2 | U.S. Pat. No. 9,353,248 B2 | U.S. Pat. No. 7,635,729 B2 |
| U.S. Pat. No. 11,306,209 B2 | U.S. Pat. No. 10,280,281 B2 | U.S. Pat. No. 9,328,212 B2 | U.S. Pat. No. 7,628,971 B2 |
| U.S. Pat. No. 11,306,199 B2 | U.S. Pat. No. 10,273,352 B2 | U.S. Pat. No. 9,309,387 B2 | U.S. Pat. No. 7,608,234 B2 |
| U.S. Pat. No. 11,286,369 B2 | U.S. Pat. No. 10,273,351 B2 | U.S. Pat. No. 9,309,372 B2 | U.S. Pat. No. 7,585,913 B2 |
| U.S. Pat. No. 11,279,818 B2 | U.S. Pat. No. 10,266,660 B2 | U.S. Pat. No. 9,302,546 B2 | U.S. Pat. No. 7,569,639 B2 |
| U.S. Pat. No. 11,267,957 B2 | U.S. Pat. No. 10,266,008 B2 | U.S. Pat. No. 9,290,065 B2 | U.S. Pat. No. 7,566,433 B2 |
| U.S. Pat. No. 11,267,954 B2 | U.S. Pat. No. 10,259,934 B2 | U.S. Pat. No. 9,284,418 B2 | U.S. Pat. No. 7,546,863 B2 |
| U.S. Pat. No. 11,262,338 B2 | U.S. Pat. No. 10,260,017 B2 | U.S. Pat. No. 9,273,197 B2 | U.S. Pat. No. 7,544,729 B2 |
| U.S. Pat. No. 11,254,804 B2 | U.S. Pat. No. 10,246,576 B2 | U.S. Pat. No. 9,273,195 B2 | U.S. Pat. No. 7,531,588 B2 |
| U.S. Pat. No. 11,242,448 B2 | U.S. Pat. No. 10,246,581 B2 | U.S. Pat. No. 9,266,399 B2 | U.S. Pat. No. 7,530,378 B2 |
| U.S. Pat. No. 11,236,217 B2 | U.S. Pat. No. 10,233,313 B2 | U.S. Pat. No. 9,260,540 B1 | U.S. Pat. No. 7,431,061 B2 |
| U.S. Pat. No. 11,230,636 B2 | U.S. Pat. No. 10,233,319 B2 | U.S. Pat. No. 9,254,715 B2 | U.S. Pat. No. 7,423,165 B2 |
| U.S. Pat. No. 11,230,046 B2 | U.S. Pat. No. 10,227,480 B2 | U.S. Pat. No. 9,255,167 B2 | U.S. Pat. No. 7,411,018 B2 |
| U.S. Pat. No. 11,225,532 B2 | U.S. Pat. No. 10,227,479 B2 | U.S. Pat. No. 9,248,704 B2 | U.S. Pat. No. 7,399,805 B2 |
| U.S. Pat. No. 11,208,542 B2 | U.S. Pat. No. 10,214,635 B2 | U.S. Pat. No. 9,228,072 B2 | U.S. Pat. No. 7,375,164 B2 |
| U.S. Pat. No. 11,203,658 B2 | U.S. Pat. No. 10,214,058 B2 | U.S. Pat. No. 9,221,923 B2 | U.S. Pat. No. 7,365,110 B2 |
| U.S. Pat. No. 11,180,641 B2 | U.S. Pat. No. 10,207,540 B2 | U.S. Pat. No. 9,212,273 B2 | U.S. Pat. No. 7,351,774 B2 |
| U.S. Pat. No. 11,180,634 B2 | U.S. Pat. No. 10,208,137 B2 | U.S. Pat. No. 9,205,709 B2 | U.S. Pat. No. 7,335,692 B2 |
| U.S. Pat. No. 11,168,168 B2 | U.S. Pat. No. 10,202,005 B2 | U.S. Pat. No. 9,200,141 B2 | U.S. Pat. No. 7,329,704 B2 |
| U.S. Pat. No. 11,161,962 B2 | U.S. Pat. No. 10,202,503 B2 | U.S. Pat. No. 9,175,150 B2 | U.S. Pat. No. 7,253,225 B2 |
| U.S. Pat. No. 11,161,944 B2 | U.S. Pat. No. 10,189,978 B2 | U.S. Pat. No. 9,175,155 B2 | U.S. Pat. No. 7,214,731 B2 |
| U.S. Pat. No. 11,155,665 B2 | U.S. Pat. No. 10,189,313 B2 | U.S. Pat. No. 9,163,135 B2 | U.S. Pat. No. 7,195,045 B2 |
| U.S. Pat. No. 11,142,594 B2 | U.S. Pat. No. 10,179,479 B2 | U.S. Pat. No. 9,163,689 B2 | U.S. Pat. No. 7,196,129 B2 |
| U.S. Pat. No. 11,124,653 B2 | U.S. Pat. No. 10,173,468 B2 | U.S. Pat. No. 9,156,955 B2 | U.S. Pat. No. 7,186,768 B2 |
| U.S. Pat. No. 11,124,590 B2 | U.S. Pat. No. 10,167,252 B2 | U.S. Pat. No. 9,145,494 B2 | U.S. Pat. No. 7,169,872 B2 |
| U.S. Pat. No. 11,104,782 B2 | U.S. Pat. No. 10,160,845 B2 | U.S. Pat. No. 9,139,721 B2 | U.S. Pat. No. 7,144,465 B2 |
| U.S. Pat. No. 11,104,180 B2 | U.S. Pat. No. 10,160,718 B2 | U.S. Pat. No. 9,127,146 B2 | U.S. Pat. No. 7,138,537 B2 |
| U.S. Pat. No. 11,104,780 B2 | U.S. Pat. No. 10,144,794 B2 | U.S. Pat. No. 9,115,257 B2 | U.S. Pat. No. 7,122,586 B2 |
| U.S. Pat. No. 11,098,169 B2 | U.S. Pat. No. 10,138,359 B2 | U.S. Pat. No. 9,115,047 B2 | U.S. Pat. No. 7,112,632 B2 |
| U.S. Pat. No. 11,097,572 B2 | U.S. Pat. No. 10,131,105 B2 | U.S. Pat. No. 9,108,386 B2 | U.S. Pat. No. 7,084,228 B2 |
| U.S. Pat. No. 11,091,608 B2 | U.S. Pat. No. 10,131,763 B2 | U.S. Pat. No. 9,096,742 B2 | U.S. Pat. No. 7,056,998 B2 |
| U.S. Pat. No. 11,091,607 B2 | U.S. Pat. No. 10,112,441 B2 | U.S. Pat. No. 9,090,127 B2 | U.S. Pat. No. 6,994,137 B2 |
| U.S. Pat. No. 11,084,326 B2 | U.S. Pat. No. 10,106,675 B2 | U.S. Pat. No. 9,074,076 B2 | U.S. Pat. No. 6,984,711 B2 |
| U.S. Pat. No. 11,077,711 B2 | U.S. Pat. No. 10,087,314 B2 | U.S. Pat. No. 9,074,078 B2 | U.S. Pat. No. 6,984,706 B2 |
| U.S. Pat. No. 11,059,958 B2 | U.S. Pat. No. 10,087,306 B2 | U.S. Pat. No. 9,068,063 B2 | U.S. Pat. No. 6,984,683 B2 |
| U.S. Pat. No. 11,053,362 B2 | U.S. Pat. No. 10,086,652 B2 | U.S. Pat. No. 9,068,055 B2 | U.S. Pat. No. 6,939,920 B2 |
| U.S. Pat. No. 11,040,572 B2 | U.S. Pat. No. 10,081,699 B2 | U.S. Pat. No. 9,062,189 B2 | U.S. Pat. No. 6,932,130 B2 |
| U.S. Pat. No. 11,041,062 B2 | U.S. Pat. No. 10,081,724 B2 | U.S. Pat. No. 9,061,548 B2 | U.S. Pat. No. 6,913,329 B1 |
| U.S. Pat. No. 11,034,822 B2 | U.S. Pat. No. 10,072,138 B2 | U.S. Pat. No. 9,056,303 B2 | U.S. Pat. No. 6,900,263 B2 |
| U.S. Pat. No. 11,028,208 B2 | U.S. Pat. No. 10,072,131 B2 | U.S. Pat. No. 9,056,527 B2 | U.S. Pat. No. 6,892,774 B2 |
| U.S. Pat. No. 11,021,581 B2 | U.S. Pat. No. 10,066,090 B2 | U.S. Pat. No. 9,056,526 B2 | U.S. Pat. No. 6,893,495 B2 |
| U.S. Pat. No. 11,014,815 B2 | U.S. Pat. No. 10,066,080 B2 | U.S. Pat. No. 9,034,950 B2 | U.S. Pat. No. 6,852,786 B2 |
| U.S. Pat. No. 11,015,042 B2 | U.S. Pat. No. 10,066,091 B2 | U.S. Pat. No. 9,034,961 B2 | U.S. Pat. No. 6,849,754 B2 |
| U.S. Pat. No. 11,008,446 B2 | U.S. Pat. No. 10,066,766 B1 | U.S. Pat. No. 9,023,924 B2 | U.S. Pat. No. 6,841,648 B2 |
| U.S. Pat. No. 11,008,445 B2 | U.S. Pat. No. 10,059,833 B2 | U.S. Pat. No. 9,022,087 B2 | U.S. Pat. No. 6,838,534 B2 |
| U.S. Pat. No. 11,008,444 B2 | U.S. Pat. No. 10,059,825 B2 | U.S. Pat. No. 9,023,928 B2 | U.S. Pat. No. 6,825,262 B2 |
| U.S. Pat. No. 11,008,281 B2 | U.S. Pat. No. 10,059,829 B2 | U.S. Pat. No. 9,018,289 B2 | U.S. Pat. No. 6,821,632 B2 |
| U.S. Pat. No. 11,001,654 B2 | U.S. Pat. No. 10,053,553 B2 | U.S. Pat. No. 9,018,297 B2 | U.S. Pat. No. 6,822,043 B2 |
| U.S. Pat. No. 10,995,163 B2 | U.S. Pat. No. 10,047,173 B2 | U.S. Pat. No. 9,012,541 B2 | U.S. Pat. No. 6,818,696 B2 |
| U.S. Pat. No. 10,988,602 B2 | U.S. Pat. No. 10,040,315 B2 | U.S. Pat. No. 9,000,088 B2 | U.S. Pat. No. 6,815,487 B2 |
| U.S. Pat. No. 10,982,076 B2 | U.S. Pat. No. 10,040,925 B1 | U.S. Pat. No. 9,000,070 B2 | U.S. Pat. No. 6,806,303 B2 |
| U.S. Pat. No. 10,975,231 B2 | U.S. Pat. No. 10,040,316 B2 | U.S. Pat. No. 8,993,666 B2 | U.S. Pat. No. 6,769,746 B2 |
| U.S. Pat. No. 10,967,679 B2 | U.S. Pat. No. 10,035,900 B2 | U.S. Pat. No. 8,986,442 B2 | U.S. Pat. No. 6,759,497 B2 |
| U.S. Pat. No. 10,961,374 B2 | U.S. Pat. No. 10,030,128 B2 | U.S. Pat. No. 8,980,988 B2 | U.S. Pat. No. 6,756,435 B2 |
| U.S. Pat. No. 10,954,330 B2 | U.S. Pat. No. 10,029,516 B2 | U.S. Pat. No. 8,980,989 B2 | U.S. Pat. No. 6,730,710 B2 |
| U.S. Pat. No. 10,934,427 B2 | U.S. Pat. No. 10,030,124 B2 | U.S. Pat. No. 8,980,990 B2 | U.S. Pat. No. 6,726,352 B2 |
| U.S. Pat. No. 10,927,261 B2 | U.S. Pat. No. 10,017,014 B2 | U.S. Pat. No. 8,975,316 B2 | U.S. Pat. No. 6,698,483 B2 |
| U.S. Pat. No. 10,927,241 B2 | U.S. Pat. No. 10,017,612 B2 | U.S. Pat. No. 8,975,324 B2 | U.S. Pat. No. 6,675,851 B1 |
| U.S. Pat. No. 10,919,341 B2 | U.S. Pat. No. 10,017,634 B2 | U.S. Pat. No. 8,969,450 B2 | U.S. Pat. No. 6,667,361 B2 |
| U.S. Pat. No. 10,919,020 B1 | U.S. Pat. No. 10,016,952 B2 | U.S. Pat. No. 8,969,455 B2 | U.S. Pat. No. 6,646,029 B1 |
| U.S. Pat. No. 10,913,888 B2 | U.S. Pat. No. 10,011,704 B2 | U.S. Pat. No. 8,969,463 B2 | U.S. Pat. No. 6,642,291 B2 |
| U.S. Pat. No. 10,907,033 B2 | U.S. Pat. No. 10,011,707 B2 | U.S. Pat. No. 8,969,462 B2 | U.S. Pat. No. 6,639,003 B2 |
| U.S. Pat. No. 10,889,709 B2 | U.S. Pat. No. 10,011,663 B2 | U.S. Pat. No. 8,969,461 B2 | U.S. Pat. No. 6,635,700 B2 |
| U.S. Pat. No. 10,889,658 B2 | U.S. Pat. No. 10,005,893 B2 | U.S. Pat. No. 8,962,745 B2 | U.S. Pat. No. 6,627,693 B1 |
| U.S. Pat. No. 10,882,981 B2 | U.S. Pat. No. 10,005,869 B2 | U.S. Pat. No. 8,952,088 B2 | U.S. Pat. No. 6,579,930 B2 |
| U.S. Pat. No. 10,875,990 B2 | U.S. Pat. No. 10,000,612 B2 | U.S. Pat. No. 8,936,056 B2 | U.S. Pat. No. 6,554,037 B2 |
| U.S. Pat. No. 10,875,267 B2 | U.S. Pat. No. 9,994,699 B2 | U.S. Pat. No. 8,921,468 B2 | U.S. Pat. No. 6,550,508 B1 |
| U.S. Pat. No. 10,870,315 B2 | U.S. Pat. No. 9,988,502 B2 | U.S. Pat. No. 8,921,470 B2 | U.S. Pat. No. 6,548,594 B2 |
| U.S. Pat. No. 10,870,744 B2 | U.S. Pat. No. 9,982,114 B2 | U.S. Pat. No. 8,921,502 B2 | U.S. Pat. No. 6,533,859 B2 |
| U.S. Pat. No. 10,865,292 B1 | U.S. Pat. No. 9,982,116 B2 | U.S. Pat. No. 8,912,267 B2 | U.S. Pat. No. 6,525,121 B1 |
| U.S. Pat. No. 10,858,377 B2 | U.S. Pat. No. 9,975,377 B2 | U.S. Pat. No. 8,895,684 B2 | U.S. Pat. No. 6,523,585 B1 |
| U.S. Pat. No. 10,850,563 B2 | U.S. Pat. No. 9,969,221 B2 | U.S. Pat. No. 8,877,839 B2 | U.S. Pat. No. 6,520,233 B2 |
| U.S. Pat. No. 10,851,224 B2 | U.S. Pat. No. 9,969,872 B2 | U.S. Pat. No. 8,875,765 B2 | U.S. Pat. No. 6,516,847 B1 |
| U.S. Pat. No. 10,836,209 B2 | U.S. Pat. No. 9,969,865 B2 | U.S. Pat. No. 8,871,871 B2 | U.S. Pat. No. 6,482,884 B1 |
| U.S. Pat. No. 10,837,947 B2 | U.S. Pat. No. 9,962,996 B2 | U.S. Pat. No. 8,871,832 B2 | U.S. Pat. No. 6,447,905 B1 |
| U.S. Pat. No. 10,829,613 B2 | U.S. Pat. No. 9,951,197 B2 | U.S. Pat. No. 8,871,840 B2 | U.S. Pat. No. 6,444,759 B1 |
| U.S. Pat. No. 10,828,937 B2 | U.S. Pat. No. 9,951,210 B2 | U.S. Pat. No. 8,865,803 B2 | U.S. Pat. No. 6,433,064 B1 |
| U.S. Pat. No. 10,829,615 B2 | U.S. Pat. No. 9,944,125 B2 | U.S. Pat. No. 8,852,739 B2 | U.S. Pat. No. 6,414,061 B1 |
| U.S. Pat. No. 10,822,477 B2 | U.S. Pat. No. 9,937,753 B2 | U.S. Pat. No. 8,841,383 B2 | U.S. Pat. No. 6,410,624 B1 |
| U.S. Pat. No. 10,822,432 B2 | U.S. Pat. No. 9,938,398 B2 | U.S. Pat. No. 8,835,545 B2 | U.S. Pat. No. 6,374,889 B1 |
| U.S. Pat. No. 10,815,320 B2 | U.S. Pat. No. 9,937,752 B2 | U.S. Pat. No. 8,835,687 B2 | U.S. Pat. No. 6,372,822 B1 |
| U.S. Pat. No. 10,808,106 B2 | U.S. Pat. No. 9,932,462 B2 | U.S. Pat. No. 8,815,995 B2 | U.S. Pat. No. 6,365,663 B2 |
| U.S. Pat. No. 10,808,107 B2 | U.S. Pat. No. 9,931,896 B2 | U.S. Pat. No. 8,813,803 B2 | U.S. Pat. No. 6,359,046 B1 |
| U.S. Pat. No. 10,787,562 B2 | U.S. Pat. No. 9,932,417 B1 | U.S. Pat. No. 8,813,798 B2 | U.S. Pat. No. 6,359,045 B1 |
| U.S. Pat. No. 10,781,300 B2 | U.S. Pat. No. 9,926,440 B2 | U.S. Pat. No. 8,809,450 B2 | U.S. Pat. No. 6,335,396 B1 |
| U.S. Pat. No. 10,780,741 B2 | U.S. Pat. No. 9,926,438 B2 | U.S. Pat. No. 8,802,755 B2 | U.S. Pat. No. 6,329,457 B1 |
| U.S. Pat. No. 10,759,229 B2 | U.S. Pat. No. 9,926,413 B2 | U.S. Pat. No. 8,796,378 B2 | U.S. Pat. No. 6,313,212 B1 |
| U.S. Pat. No. 10,759,226 B2 | U.S. Pat. No. 9,920,173 B2 | U.S. Pat. No. 8,791,177 B2 | U.S. Pat. No. 6,291,588 B1 |
| U.S. Pat. No. 10,759,227 B2 | U.S. Pat. No. 9,919,565 B2 | U.S. Pat. No. 8,763,658 B2 | U.S. Pat. No. 6,291,572 B1 |
| U.S. Pat. No. 10,759,225 B2 | U.S. Pat. No. 9,914,330 B2 | U.S. Pat. No. 8,759,439 B2 | U.S. Pat. No. 6,211,271 B1 |
| U.S. Pat. No. 10,759,914 B2 | U.S. Pat. No. 9,908,998 B2 | U.S. Pat. No. 8,759,587 B2 | U.S. Pat. No. 6,207,757 B1 |
| U.S. Pat. No. 10,757,988 B1 | U.S. Pat. No. 9,902,831 B2 | U.S. Pat. No. 8,722,781 B2 | U.S. Pat. No. 6,201,049 B1 |
| U.S. Pat. No. 10,752,721 B2 | U.S. Pat. No. 9,890,268 B2 | U.S. Pat. No. 8,720,507 B2 | U.S. Pat. No. 6,194,594 B1 |
| U.S. Pat. No. 10,752,722 B2 | U.S. Pat. No. 9,890,265 B2 | U.S. Pat. No. 8,716,375 B2 | U.S. Pat. No. 6,172,154 B1 |
| U.S. Pat. No. 10,752,769 B2 | U.S. Pat. No. 9,884,515 B2 | U.S. Pat. No. 8,701,728 B2 | U.S. Pat. No. 6,169,135 B1 |
| U.S. Pat. No. 10,737,532 B2 | U.S. Pat. No. 9,879,131 B2 | U.S. Pat. No. 8,697,793 B2 | U.S. Pat. No. 6,147,147 A |
| U.S. Pat. No. 10,737,531 B2 | U.S. Pat. No. 9,873,797 B2 | U.S. Pat. No. 8,689,844 B2 | U.S. Pat. No. 6,140,407 A |
| U.S. Pat. No. 10,738,179 B2 | U.S. Pat. No. 9,873,749 B2 | U.S. Pat. No. 8,680,210 B2 | US H001871 H |
| U.S. Pat. No. 10,738,181 B2 | U.S. Pat. No. 9,873,779 B2 | U.S. Pat. No. 8,664,432 B2 | U.S. Pat. No. 6,114,469 A |
| U.S. Pat. No. 10,737,882 B2 | U.S. Pat. No. 9,868,850 B2 | U.S. Pat. No. 8,658,816 B2 | U.S. Pat. No. 6,075,084 A |
| U.S. Pat. No. 10,730,985 B2 | U.S. Pat. No. 9,862,794 B2 | U.S. Pat. No. 8,653,195 B2 | U.S. Pat. No. 6,058,994 A |
| U.S. Pat. No. 10,723,822 B2 | U.S. Pat. No. 9,862,814 B2 | U.S. Pat. No. 8,637,606 B2 | U.S. Pat. No. 6,040,364 A |
| U.S. Pat. No. 10,717,853 B2 | U.S. Pat. No. 9,856,362 B2 | U.S. Pat. No. 8,637,594 B2 | U.S. Pat. No. 6,014,998 A |
| U.S. Pat. No. 10,710,414 B2 | U.S. Pat. No. 9,850,324 B2 | U.S. Pat. No. 8,637,600 B2 | U.S. Pat. No. 6,005,027 A |
| U.S. Pat. No. 10,710,407 B2 | U.S. Pat. No. 9,849,735 B2 | U.S. Pat. No. 8,633,275 B2 | U.S. Pat. No. 6,001,322 A |
| U.S. Pat. No. 10,711,122 B2 | U.S. Pat. No. 9,846,954 B2 | U.S. Pat. No. 8,609,760 B2 | U.S. Pat. No. 5,996,663 A |
| U.S. Pat. No. 10,703,141 B2 | U.S. Pat. No. 9,845,384 B2 | U.S. Pat. No. 8,597,425 B2 | U.S. Pat. No. 5,882,617 A |
| U.S. Pat. No. 10,703,828 B2 | U.S. Pat. No. 9,840,569 B2 | U.S. Pat. No. 8,586,651 B2 | U.S. Pat. No. 5,872,188 A |
| U.S. Pat. No. 10,696,823 B2 | U.S. Pat. No. 9,840,611 B2 | U.S. Pat. No. 8,586,691 B2 | U.S. Pat. No. 5,852,097 A |
| U.S. Pat. No. 10,696,838 B2 | U.S. Pat. No. 9,834,661 B2 | U.S. Pat. No. 8,575,253 B2 | U.S. Pat. No. 5,804,636 A |
| U.S. Pat. No. 10,689,508 B2 | U.S. Pat. No. 9,834,043 B2 | U.S. Pat. No. 8,575,251 B2 | U.S. Pat. No. 5,756,589 A |
| U.S. Pat. No. 10,682,885 B2 | U.S. Pat. No. 9,822,246 B2 | U.S. Pat. No. 8,557,937 B1 | U.S. Pat. No. 5,677,402 A |
| U.S. Pat. No. 10,676,542 B2 | U.S. Pat. No. 9,821,612 B2 | U.S. Pat. No. 8,552,121 B2 | U.S. Pat. No. 5,591,794 A |
| U.S. Pat. No. 10,675,915 B2 | U.S. Pat. No. 9,822,247 B2 | U.S. Pat. No. 8,546,464 B2 | U.S. Pat. No. 5,534,592 A |
| U.S. Pat. No. 10,676,599 B2 | U.S. Pat. No. 9,815,974 B2 | U.S. Pat. No. 8,541,503 B2 | U.S. Pat. No. 5,526,859 A |
| U.S. Pat. No. 10,668,772 B2 | U.S. Pat. No. 9,803,031 B2 | U.S. Pat. No. 8,536,249 B2 | U.S. Pat. No. 5,425,904 A |
| U.S. Pat. No. 10,669,407 B2 | U.S. Pat. No. 9,803,069 B2 | U.S. Pat. No. 8,534,333 B2 | U.S. Pat. No. 5,405,918 A |
| U.S. Pat. No. 10,669,408 B2 | U.S. Pat. No. 9,796,124 B2 | U.S. Pat. No. 8,507,582 B2 | U.S. Pat. No. 5,338,620 A |
| U.S. Pat. No. 10,669,405 B2 | U.S. Pat. No. 9,796,831 B2 | U.S. Pat. No. 8,501,859 B2 | U.S. Pat. No. 5,208,276 A |
| U.S. Pat. No. 10,654,316 B2 | U.S. Pat. No. 9,796,819 B2 | U.S. Pat. No. 8,476,342 B2 | U.S. Pat. No. 5,115,021 A |
| U.S. Pat. No. 10,654,993 B2 | U.S. Pat. No. 9,790,306 B2 | U.S. Pat. No. 8,475,584 B1 | U.S. Pat. No. 5,011,876 A |
| U.S. Pat. No. 10,647,833 B2 | U.S. Pat. No. 9,790,353 B2 | U.S. Pat. No. 8,476,349 B2 | |
| U.S. Pat. No. 10,640,630 B2 | U.S. Pat. No. 9,765,202 B2 | U.S. Pat. No. 8,470,727 B2 | |
| U.S. Pat. No. 10,639,932 B2 | U.S. Pat. No. 9,765,174 B2 | U.S. Pat. No. 8,460,590 B2 | |
| U.S. Pat. No. 10,640,589 B2 | U.S. Pat. No. 9,757,982 B2 | U.S. Pat. No. 8,420,720 B2 | |
| U.S. Pat. No. 10,632,788 B2 | U.S. Pat. No. 9,758,652 B2 | U.S. Pat. No. 8,397,775 B2 | |
| U.S. Pat. No. 10,638,649 B2 | U.S. Pat. No. 9,752,020 B2 | U.S. Pat. No. 8,394,875 B2 | |
| U.S. Pat. No. 10,619,271 B2 | U.S. Pat. No. 9,751,992 B2 | U.S. Pat. No. 8,389,610 B2 | |
| U.S. Pat. No. 10,589,576 B2 | U.S. Pat. No. 9,744,812 B2 | U.S. Pat. No. 8,389,609 B2 | |
| U.S. Pat. No. 10,589,997 B2 | U.S. Pat. No. 9,738,776 B2 | U.S. Pat. No. 8,383,698 B2 | |
| U.S. Pat. No. 10,584,186 B2 | U.S. Pat. No. 9,732,165 B2 | U.S. Pat. No. 8,362,164 B2 | |
| U.S. Pat. No. 10,583,692 B2 | U.S. Pat. No. 9,725,525 B2 | U.S. Pat. No. 8,362,118 B2 | |
| U.S. Pat. No. 10,584,234 B1 | U.S. Pat. No. 9,718,312 B2 | U.S. Pat. No. 8,334,340 B2 | |
| U.S. Pat. No. 10,576,785 B2 | U.S. Pat. No. 9,718,313 B2 | U.S. Pat. No. 8,329,788 B2 | |
| U.S. Pat. No. 10,576,784 B2 | U.S. Pat. No. 9,714,339 B2 | U.S. Pat. No. 8,329,297 B2 | |
| U.S. Pat. No. 10,577,434 B2 | U.S. Pat. No. 9,713,941 B2 | U.S. Pat. No. 8,314,164 B2 | |
| U.S. Pat. No. 10,577,488 B2 | U.S. Pat. No. 9,713,942 B2 | U.S. Pat. No. 8,314,185 B2 | |
| U.S. Pat. No. 10,570,274 B2 | U.S. Pat. No. 9,708,475 B2 | U.S. Pat. No. 8,314,183 B2 | |
| U.S. Pat. No. 10,562,780 B2 | U.S. Pat. No. 9,708,429 B2 | U.S. Pat. No. 8,299,161 B2 | |
| U.S. Pat. No. 10,563,047 B2 | U.S. Pat. No. 9,708,476 B2 | U.S. Pat. No. 8,293,822 B2 | |
| U.S. Pat. No. 10,563,051 B2 | U.S. Pat. No. 9,701,161 B2 | U.S. Pat. No. 8,283,392 B2 | |
| U.S. Pat. No. 10,557,022 B2 | U.S. Pat. No. 9,701,761 B2 | U.S. Pat. No. 8,268,921 B2 | |
| U.S. Pat. No. 10,557,009 B2 | U.S. Pat. No. 9,688,825 B2 | U.S. Pat. No. 8,258,180 B2 | |
| U.S. Pat. No. 10,550,256 B2 | U.S. Pat. No. 9,683,066 B2 | U.S. Pat. No. 8,252,853 B2 | |
| U.S. Pat. No. 10,543,718 B2 | U.S. Pat. No. 9,683,057 B2 | U.S. Pat. No. 8,252,863 B2 | |
| U.S. Pat. No. 10,544,268 B2 | U.S. Pat. No. 9,670,291 B2 | U.S. Pat. No. 8,247,489 B2 | |
| U.S. Pat. No. 10,538,606 B2 | U.S. Pat. No. 9,670,332 B2 | U.S. Pat. No. 8,242,199 B2 | |
| U.S. Pat. No. 10,532,612 B2 | U.S. Pat. No. 9,670,341 B2 | U.S. Pat. No. 8,236,215 B2 | |
| U.S. Pat. No. 10,525,775 B2 | U.S. Pat. No. 9,663,639 B2 | U.S. Pat. No. 8,236,882 B2 | |
| U.S. Pat. No. 10,525,771 B2 | U.S. Pat. No. 9,657,161 B2 | U.S. Pat. No. 8,227,538 B2 | |
| U.S. Pat. No. 10,518,585 B2 | U.S. Pat. No. 9,650,492 B2 | U.S. Pat. No. 8,207,247 B2 | |
| U.S. Pat. No. 10,518,584 B2 | U.S. Pat. No. 9,649,891 B2 | U.S. Pat. No. 8,193,265 B2 | |
| U.S. Pat. No. 10,519,284 B2 | U.S. Pat. No. 9,649,883 B2 | U.S. Pat. No. 8,183,316 B2 | |
| U.S. Pat. No. 10,501,601 B2 | U.S. Pat. No. 9,637,618 B2 | U.S. Pat. No. 8,183,403 B2 | |
| U.S. Pat. No. 10,501,584 B2 | U.S. Pat. No. 9,631,074 B2 | U.S. Pat. No. 8,163,821 B2 | |
| U.S. Pat. No. 10,501,608 B2 | U.S. Pat. No. 9,631,071 B2 | U.S. Pat. No. 8,143,344 B2 | |
| U.S. Pat. No. 10,493,800 B2 | U.S. Pat. No. 9,631,072 B2 | U.S. Pat. No. 8,129,453 B2 | |
| U.S. Pat. No. 10,494,511 B2 | U.S. Pat. No. 9,623,618 B2 | U.S. Pat. No. 8,124,206 B2 | |
| U.S. Pat. No. 10,494,512 B2 | U.S. Pat. No. 9,611,380 B2 | U.S. Pat. No. 8,119,710 B2 | |
| U.S. Pat. No. 10,487,195 B2 | U.S. Pat. No. 9,598,560 B2 | U.S. Pat. No. 8,110,634 B2 | |
| U.S. Pat. No. 10,487,198 B2 | U.S. Pat. No. 9,598,564 B2 | U.S. Pat. No. 8,104,523 B2 | |
| U.S. Pat. No. 10,487,197 B2 | U.S. Pat. No. 9,593,181 B2 | U.S. Pat. No. 8,072,336 B2 | |
| U.S. Pat. No. 10,487,196 B2 | U.S. Pat. No. 9,593,435 B2 | U.S. Pat. No. 8,071,668 B2 | |
| U.S. Pat. No. 10,486,468 B2 | U.S. Pat. No. 9,587,092 B2 | U.S. Pat. No. 8,058,357 B2 | |
| U.S. Pat. No. 10,479,881 B2 | U.S. Pat. No. 9,574,069 B2 | U.S. Pat. No. 8,048,941 B2 | |
| U.S. Pat. No. 10,472,503 B2 | U.S. Pat. No. 9,567,451 B2 | U.S. Pat. No. 8,030,392 B2 | |
| U.S. Pat. No. 10,472,502 B2 | U.S. Pat. No. 9,567,454 B2 | U.S. Pat. No. 8,013,178 B2 | |
| U.S. Pat. No. 10,442,247 B2 | U.S. Pat. No. 9,567,456 B2 | U.S. Pat. No. 8,007,917 B2 | |

TABLE 104

| | | | |
|---|---|---|---|
| U.S. Pat. No. 11,499,036 B2 | U.S. Pat. No. 10,654,992 B2 | U.S. Pat. No. 9,522,571 B2 | U.S. Pat. No. 8,623,169 B2 |
| U.S. Pat. No. 11,492,465 B2 | U.S. Pat. No. 10,640,630 B2 | U.S. Pat. No. 9,505,897 B2 | U.S. Pat. No. 8,623,937 B2 |
| U.S. Pat. No. 11,427,702 B2 | U.S. Pat. No. 10,538,600 B2 | U.S. Pat. No. 9,505,917 B2 | U.S. Pat. No. 8,586,651 B2 |
| U.S. Pat. No. 11,407,881 B2 | U.S. Pat. No. 10,508,196 B2 | U.S. Pat. No. 9,499,730 B2 | U.S. Pat. No. 8,530,017 B2 |
| U.S. Pat. No. 11,400,756 B2 | U.S. Pat. No. 10,457,793 B2 | U.S. Pat. No. 9,487,049 B2 | U.S. Pat. No. 8,499,805 B2 |
| U.S. Pat. No. 11,396,569 B2 | U.S. Pat. No. 10,435,544 B2 | U.S. Pat. No. 9,487,892 B2 | U.S. Pat. No. 8,492,475 B2 |
| U.S. Pat. No. 11,396,208 B2 | U.S. Pat. No. 10,427,476 B2 | U.S. Pat. No. 9,440,496 B2 | U.S. Pat. No. 8,461,269 B2 |
| U.S. Pat. No. 11,390,117 B2 | U.S. Pat. No. 10,428,009 B2 | U.S. Pat. No. 9,428,011 B2 | U.S. Pat. No. 8,455,600 B2 |
| U.S. Pat. No. 11,383,554 B2 | U.S. Pat. No. 10,414,132 B2 | U.S. Pat. No. 9,416,259 B2 | U.S. Pat. No. 8,394,903 B2 |
| U.S. Pat. No. 11,383,561 B2 | U.S. Pat. No. 10,378,148 B2 | U.S. Pat. No. 9,416,250 B2 | U.S. Pat. No. 8,372,901 B2 |
| U.S. Pat. No. 11,370,866 B2 | U.S. Pat. No. 10,369,842 B2 | U.S. Pat. No. 9,403,406 B2 | U.S. Pat. No. 8,357,733 B2 |
| U.S. Pat. No. 11,365,308 B2 | U.S. Pat. No. 10,364,335 B2 | U.S. Pat. No. 9,399,829 B2 | U.S. Pat. No. 8,349,956 B2 |
| U.S. Pat. No. 11,365,306 B2 | U.S. Pat. No. 10,357,998 B2 | U.S. Pat. No. 9,394,434 B2 | U.S. Pat. No. 8,334,340 B2 |
| U.S. Pat. No. 11,352,484 B2 | U.S. Pat. No. 10,336,138 B2 | U.S. Pat. No. 9,393,837 B2 | U.S. Pat. No. 8,314,165 B2 |
| U.S. Pat. No. 11,326,043 B2 | U.S. Pat. No. 10,308,072 B2 | U.S. Pat. No. 9,340,626 B2 | U.S. Pat. No. 8,299,161 B2 |
| U.S. Pat. No. 11,286,369 B2 | U.S. Pat. No. 10,280,281 B2 | U.S. Pat. No. 9,333,802 B2 | U.S. Pat. No. 8,240,350 B2 |
| U.S. Pat. No. 11,267,955 B2 | U.S. Pat. No. 10,259,715 B2 | U.S. Pat. No. 9,328,176 B2 | U.S. Pat. No. 8,196,627 B2 |
| U.S. Pat. No. 11,254,804 B2 | U.S. Pat. No. 10,260,017 B2 | U.S. Pat. No. 9,303,148 B2 | U.S. Pat. No. 8,186,401 B2 |
| U.S. Pat. No. 11,254,164 B2 | U.S. Pat. No. 10,246,577 B2 | U.S. Pat. No. 9,296,260 B2 | U.S. Pat. No. 8,178,605 B2 |
| U.S. Pat. No. 11,241,912 B2 | U.S. Pat. No. 10,239,971 B2 | U.S. Pat. No. 9,267,014 B2 | U.S. Pat. No. 8,151,848 B2 |
| U.S. Pat. No. 11,230,636 B2 | U.S. Pat. No. 10,227,475 B2 | U.S. Pat. No. 9,266,981 B2 | U.S. Pat. No. 8,097,674 B2 |
| U.S. Pat. No. 11,225,567 B2 | U.S. Pat. No. 10,214,638 B2 | U.S. Pat. No. 9,260,588 B2 | U.S. Pat. No. 8,062,551 B2 |
| U.S. Pat. No. 11,220,591 B2 | U.S. Pat. No. 10,173,468 B2 | U.S. Pat. No. 9,205,707 B2 | U.S. Pat. No. 7,987,881 B2 |
| U.S. Pat. No. 11,203,680 B2 | U.S. Pat. No. 10,167,252 B2 | U.S. Pat. No. 9,205,708 B2 | U.S. Pat. No. 7,834,074 B2 |
| U.S. Pat. No. 11,161,962 B2 | U.S. Pat. No. 10,160,845 B2 | U.S. Pat. No. 9,187,620 B2 | U.S. Pat. No. 7,825,183 B2 |
| U.S. Pat. No. 11,161,944 B2 | U.S. Pat. No. 10,160,718 B2 | U.S. Pat. No. 9,175,154 B2 | U.S. Pat. No. 7,820,771 B2 |
| U.S. Pat. No. 11,155,665 B2 | U.S. Pat. No. 10,131,105 B2 | U.S. Pat. No. 9,175,150 B2 | U.S. Pat. No. 7,718,717 B2 |
| U.S. Pat. No. 11,155,701 B2 | U.S. Pat. No. 10,087,306 B2 | U.S. Pat. No. 9,145,494 B2 | U.S. Pat. No. 7,629,408 B2 |
| U.S. Pat. No. 11,155,656 B2 | U.S. Pat. No. 10,059,833 B2 | U.S. Pat. No. 9,132,699 B2 | U.S. Pat. No. 7,605,202 B2 |
| U.S. Pat. No. 11,136,462 B2 | U.S. Pat. No. 10,035,904 B2 | U.S. Pat. No. 9,108,464 B2 | U.S. Pat. No. 7,576,153 B2 |
| U.S. Pat. No. 11,111,360 B2 | U.S. Pat. No. 10,023,723 B2 | U.S. Pat. No. 9,109,109 B2 | U.S. Pat. No. 7,531,596 B2 |
| U.S. Pat. No. 11,104,583 B2 | U.S. Pat. No. 10,011,663 B2 | U.S. Pat. No. 9,096,557 B2 | U.S. Pat. No. 7,491,767 B2 |
| U.S. Pat. No. 11,104,755 B2 | U.S. Pat. No. 10,000,612 B2 | U.S. Pat. No. 9,080,041 B2 | U.S. Pat. No. 7,488,768 B2 |
| U.S. Pat. No. 11,090,980 B2 | U.S. Pat. No. 9,987,884 B2 | U.S. Pat. No. 9,040,613 B2 | U.S. Pat. No. 7,473,472 B2 |
| U.S. Pat. No. 11,091,608 B2 | U.S. Pat. No. 9,976,014 B2 | U.S. Pat. No. 9,040,618 B2 | U.S. Pat. No. 7,435,775 B2 |
| U.S. Pat. No. 11,067,489 B2 | U.S. Pat. No. 9,962,996 B2 | U.S. Pat. No. 9,034,969 B2 | U.S. Pat. No. 7,398,810 B2 |
| U.S. Pat. No. 11,046,115 B2 | U.S. Pat. No. 9,944,777 B2 | U.S. Pat. No. 9,010,393 B2 | U.S. Pat. No. 7,326,745 B2 |
| U.S. Pat. No. 11,046,116 B2 | U.S. Pat. No. 9,926,413 B2 | U.S. Pat. No. 9,000,092 B2 | U.S. Pat. No. 7,312,264 B2 |
| U.S. Pat. No. 11,046,838 B2 | U.S. Pat. No. 9,902,837 B2 | U.S. Pat. No. 8,987,361 B2 | U.S. Pat. No. 7,300,970 B2 |
| U.S. Pat. No. 11,041,065 B2 | U.S. Pat. No. 9,849,727 B2 | U.S. Pat. No. 8,987,353 B2 | U.S. Pat. No. 7,256,233 B2 |
| U.S. Pat. No. 11,028,254 B2 | U.S. Pat. No. 9,822,244 B2 | U.S. Pat. No. 8,978,721 B2 | U.S. Pat. No. 7,250,463 B2 |
| U.S. Pat. No. 11,021,581 B2 | U.S. Pat. No. 9,822,247 B2 | U.S. Pat. No. 8,975,316 B2 | U.S. Pat. No. 7,238,740 B2 |
| U.S. Pat. No. 10,975,178 B2 | U.S. Pat. No. 9,758,645 B2 | U.S. Pat. No. 8,957,155 B2 | U.S. Pat. No. 7,217,751 B2 |
| U.S. Pat. No. 10,967,679 B2 | U.S. Pat. No. 9,751,992 B2 | U.S. Pat. No. 8,927,643 B2 | U.S. Pat. No. 7,202,295 B2 |
| U.S. Pat. No. 10,968,333 B2 | U.S. Pat. No. 9,738,776 B2 | U.S. Pat. No. 8,883,929 B2 | U.S. Pat. No. 7,199,175 B2 |
| U.S. Pat. No. 10,961,371 B2 | U.S. Pat. No. 9,714,339 B2 | U.S. Pat. No. 8,877,839 B2 | U.S. Pat. No. 7,152,642 B2 |
| U.S. Pat. No. 10,961,374 B2 | U.S. Pat. No. 9,688,852 B2 | U.S. Pat. No. 8,858,852 B2 | U.S. Pat. No. 7,135,517 B2 |
| U.S. Pat. No. 10,946,697 B2 | U.S. Pat. No. 9,688,784 B2 | U.S. Pat. No. 8,846,806 B2 | U.S. Pat. No. 7,066,228 B2 |
| U.S. Pat. No. 10,920,046 B2 | U.S. Pat. No. 9,670,291 B2 | U.S. Pat. No. 8,841,376 B2 | U.S. Pat. No. 6,984,689 B2 |
| U.S. Pat. No. 10,889,147 B2 | U.S. Pat. No. 9,670,332 B2 | U.S. Pat. No. 8,835,561 B2 | U.S. Pat. No. 6,951,897 B2 |
| U.S. Pat. No. 10,836,886 B2 | U.S. Pat. No. 9,663,633 B2 | U.S. Pat. No. 8,833,417 B2 | U.S. Pat. No. 6,878,768 B2 |
| U.S. Pat. No. 10,808,105 B2 | U.S. Pat. No. 9,650,492 B2 | U.S. Pat. No. 8,791,177 B2 | U.S. Pat. No. 6,821,632 B2 |
| U.S. Pat. No. 10,780,740 B2 | U.S. Pat. No. 9,624,359 B2 | U.S. Pat. No. 8,779,026 B2 | U.S. Pat. No. 6,800,683 B1 |
| U.S. Pat. No. 10,781,299 B2 | U.S. Pat. No. 9,624,358 B2 | U.S. Pat. No. 8,763,660 B2 | U.S. Pat. No. 6,774,255 B1 |
| U.S. Pat. No. 10,773,552 B2 | U.S. Pat. No. 9,611,380 B2 | U.S. Pat. No. 8,765,943 B2 | U.S. Pat. No. 6,699,924 B1 |
| U.S. Pat. No. 10,766,218 B2 | U.S. Pat. No. 9,598,560 B2 | U.S. Pat. No. 8,759,438 B2 | U.S. Pat. No. 6,533,859 B2 |
| U.S. Pat. No. 10,759,227 B2 | U.S. Pat. No. 9,593,226 B2 | U.S. Pat. No. 8,759,451 B2 | U.S. Pat. No. 6,409,959 B1 |
| U.S. Pat. No. 10,737,532 B2 | U.S. Pat. No. 9,566,828 B2 | U.S. Pat. No. 8,754,164 B2 | U.S. Pat. No. 6,344,506 B1 |
| U.S. Pat. No. 10,662,582 B2 | U.S. Pat. No. 9,550,890 B2 | U.S. Pat. No. 8,686,086 B2 | U.S. Pat. No. 6,014,998 A |
| U.S. Pat. No. 10,654,317 B2 | U.S. Pat. No. 9,550,891 B2 | U.S. Pat. No. 8,637,597 B2 | U.S. Pat. No. 11,834,536 B2 |
| U.S. Pat. No. 11,827,782 B2 | U.S. Pat. No. 11,760,048 B2 | U.S. Pat. No. 11,685,822 B2 | U.S. Pat. No. 11,571,931 B2 |
| U.S. Pat. No. 11,827,726 B2 | U.S. Pat. No. 11,753,529 B2 | U.S. Pat. No. 11,685,190 B2 | U.S. Pat. No. 11,566,187 B2 |
| U.S. Pat. No. 11,820,847 B2 | U.S. Pat. No. 11,752,802 B2 | U.S. Pat. No. 11,674,019 B2 | U.S. Pat. No. 11,560,521 B2 |
| U.S. Pat. No. 11,820,843 B2 | U.S. Pat. No. 11,739,198 B2 | U.S. Pat. No. 11,668,685 B2 | U.S. Pat. No. 11,560,442 B2 |
| U.S. Pat. No. 11,814,523 B2 | U.S. Pat. No. 11,738,599 B2 | U.S. Pat. No. 11,667,774 B2 | U.S. Pat. No. 11,542,286 B2 |
| U.S. Pat. No. 11,807,704 B2 | U.S. Pat. No. 11,732,115 B2 | U.S. Pat. No. 11,661,498 B2 | U.S. Pat. No. 11,542,285 B2 |
| U.S. Pat. No. 11,798,709 B2 | U.S. Pat. No. 11,718,700 B2 | U.S. Pat. No. 11,639,444 B2 | U.S. Pat. No. 11,535,742 B2 |
| U.S. Pat. No. 11,795,308 B2 | U.S. Pat. No. 11,718,699 B2 | U.S. Pat. No. 11,639,409 B2 | U.S. Pat. No. 11,535,687 B2 |
| U.S. Pat. No. 11,795,243 B2 | U.S. Pat. No. 11,718,698 B2 | U.S. Pat. No. 11,634,562 B2 | U.S. Pat. No. 11,518,856 B2 |
| U.S. Pat. No. 11,794,530 B2 | U.S. Pat. No. 11,712,926 B2 | U.S. Pat. No. 11,633,986 B2 | U.S. Pat. No. 11,518,835 B2 |
| U.S. Pat. No. 11,787,235 B2 | U.S. Pat. No. 11,708,482 B2 | U.S. Pat. No. 11,633,983 B2 | U.S. Pat. No. 11,518,194 B2 |
| U.S. Pat. No. 11,787,140 B2 | U.S. Pat. No. 11,702,485 B2 | U.S. Pat. No. 11,623,477 B2 | U.S. Pat. No. 11,518,192 B2 |
| U.S. Pat. No. 11,780,994 B2 | U.S. Pat. No. 11,701,921 B2 | U.S. Pat. No. 11,613,631 B2 | U.S. Pat. No. 11,498,993 B2 |
| U.S. Pat. No. 11,780,972 B2 | U.S. Pat. No. 11,701,919 B2 | U.S. Pat. No. 11,608,425 B2 | U.S. Pat. No. 11,492,452 B2 |
| U.S. Pat. No. 11,773,240 B2 | U.S. Pat. No. 11,697,728 B2 | U.S. Pat. No. 11,608,388 B2 | U.S. Pat. No. 11,472,947 B2 |
| U.S. Pat. No. 11,773,234 B2 | U.S. Pat. No. 11,697,310 B2 | U.S. Pat. No. 11,597,821 B2 | U.S. Pat. No. 11,466,150 B2 |
| U.S. Pat. No. 11,760,864 B2 | U.S. Pat. No. 11,692,092 B2 | U.S. Pat. No. 11,597,820 B2 | U.S. Pat. No. 11,466,143 B2 |
| U.S. Pat. No. 11,760,135 B2 | U.S. Pat. No. 11,692,088 B2 | U.S. Pat. No. 11,572,458 B2 | U.S. Pat. No. 11,459,417 B2 |

### Vulcanized Elastomeric Articles

The present disclosure also provides vulcanized elastomeric articles comprising a first antidegradant. The term “vulcanized elastomeric article” refers to an article that is made by forming a composition comprising an elastomer into a specific shape and vulcanizing the composition to provide the article.

The present disclosure also provides vulcanized elastomeric articles prepared using a composition described herein.

In some embodiments, the vulcanized elastomeric article is a tire. In some embodiments, the tire is a passenger vehicle tire, a light truck tire, a heavy truck or bus tire, a motorcycle tire, an agriculture tire, an earthmover tire, an airplane tire, or a racing tire.

In some embodiments, the vulcanized elastomeric article is a component of a tire. In some embodiments, the component is a bead, a belt, a body ply, an inner liner, a sidewall, an undertread, or a tread.

In some embodiments, the vulcanized elastomeric article is a rubber overshoe, a sealing strip, an acoustic panel, an air spring, a bellow, a membrane, a tactile sensor, a crash pad, a hose, a conveyor belt, or a flooring.

### Processes

The present disclosure also provides processes for preparing a vulcanized elastomeric article, the process comprising:
(a) forming a composition described herein into a formed shape; and
(b) vulcanizing the formed shape, to provide a vulcanized elastomeric article.

In some embodiments, the vulcanizing is performed at an average temperature of from about 140° C. to about 160° C. In some embodiments, the vulcanizing is performed at an average temperature of from about 80° C. to about 100° C., from about 80° C. to about 120° C., from about 80° C. to about 140° C., from about 80° C. to about 160° C., from about 80° C. to about 180° C., from about 80° C. to about 200° C., from about 100° C. to about 120° C., from about 100° C. to about 140° C., from about 100° C. to about 160° C., from about 100° C. to about 180° C., from about 100° C. to about 200° C., from about 120° C. to about 140° C., from about 120° C. to about 160° C., from about 120° C. to about 180° C., from about 120° C. to about 200° C., from about 140° C. to about 180° C., from about 140° C. to about 200° C., from about 160° C. to about 180° C., from about 160° C. to about 200° C., or from about 180° C. to about 200° C.

In some embodiments, the vulcanizing is performed at an average temperature of about 150° C. In some embodiments, the vulcanizing is performed at an average temperature of about 80° C., about 100° C., about 120° C., about 140° C., about 160° C., about 180° C., or about 200° C.

The present disclosure also provides processes for retreading tires, the process comprising:
(a) applying a composition described herein to a tire;
(b) disposing a pre-vulcanized tread around the tire;
(c) disposing a curing envelope around the tire; and
(d) vulcanizing the tire.

### Kits

The present disclosure also provides kits comprising a composition described herein, packaged in a manner, e.g., in a container, that facilitates use of the composition to practice the processes and/or methods of the present disclosure. In some embodiments, the kit comprises a composition described herein and instructions for using the composition in a vulcanizable elastomeric composition. In some embodiments, the kit comprises a composition described herein and instructions for using the composition to prepare a vulcanized elastomeric article. The composition may be packaged in any suitable container, such as a sealed bottle or vessel, with a label affixed to the container or included in the kit that describes the composition and proper use thereof.

### EXAMPLES

### Example 1

### Synthesis of bis(2,2,4-trimethyl-1,2-dihydroquinolin-6-yl) methane (Compound 1-A)

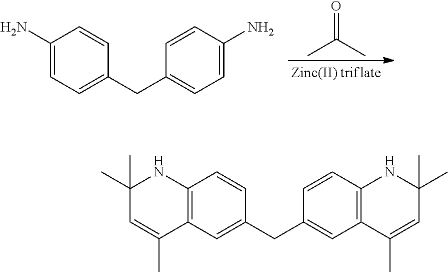

To a 100-mL flask fitted with a stir-bar and a thermometer were loaded 4,4′-methylenedianiline (0.918 g; 4.63 mmol) and acetone (3.5 mL). The mixture was stirred under N₂ protection. Zinc(II) triflate (0.1755 g; 4.83 mmol) was loaded in one portion. The reaction mixture was stirred at room temperature for 6-7 days. The obtained dark slurry was loaded into a chromatography column (2.4 cm inner diameter) previously prepared with silica gel 60 (70-230 mesh) and eluent (20% ethyl acetate in hexanes). The fractions at R_{f}=0.8 were collected and stripped of volatiles under reduced pressure (rotary evaporator; water bath=50° C.). The obtained solid was dried on the rotary evaporator (50° C.; <5 mbars) for 1 hour. The product was a slightly yellow solid weighing 0.41 g (25% yield).

### Example 2

### Synthesis of bis(2,2,4-trimethyl-1,2,3,4-tetrahydroquinolin-6-yl) methane (Compound 2-A)

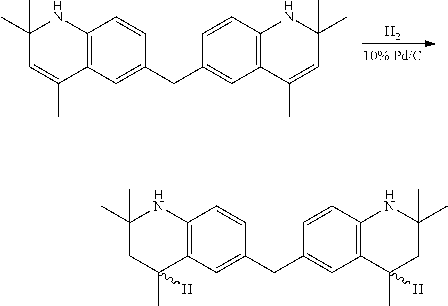

A 300 mL Paar autoclave was charged with crude Compound 1 (1.0 g; <2.79 mmol), methanol (77 mL), aqueous 37% HCl (0.46 mL; 5.58 mmol), and wet 10% Pd/C (1.0 g). The autoclave was sealed, then purged with 20 PSI nitrogen gas. The vessel was charged with 50 PSI H₂, and the reaction mixture was stirred for 1 hour at 25° C. After completion of the reaction, the reaction contents were filtered through a 0.5 μm frit to separate catalyst residues from the product. The filtrate was stripped of volatiles under reduced pressure (rotary evaporator; water bath=50° C.). The crude hydrogenated material as the dihydrochloride salt was dissolved in chloroform. The emerald-green solution was transferred to a separatory funnel, washed with saturated aqueous NaHCO₃, dried over anhydrous MgSO₄, filtered, and stripped of volatiles under reduced pressure (rotary evaporator; water bath=50° C.). Further drying until constant weight provided the desired product as a green-yellow viscous liquid.

### Example 3

### Synthesis of 4,4′-(furan-2-ylmethylene)bis(N-isopropylaniline) (Compound 3-A)

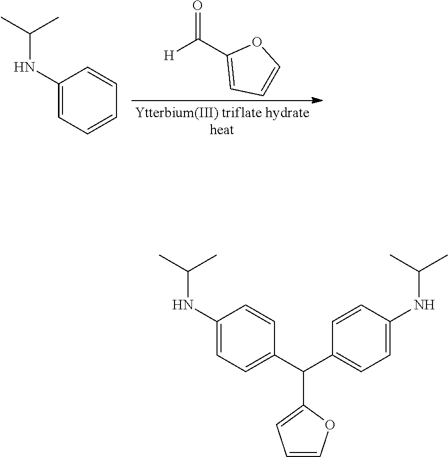

A 25-mL round bottom flask fitted with a stir-bar and a reflux condenser was loaded with N-isopropylaniline (7.0 mL; 48.7 mmol), furfural (1.6 mL; 19.3 mmol), and ytterbium (III) triflate hydrate (1.15 g; <1.85 mmol Yb³⁺). The reaction mixture was stirred under N₂ protection and heated (oil bath temperature=95° C.) for 17 hours. Upon cooling to room temperature, the obtained dark mass was dissolved in ethyl acetate (approx. 100 mL). The resulting dark solution was washed with aq. 0.5 M NaOH (20 mL), aq. 1 M NaHCO₃ (20 mL), distilled water (20 mL), and aqueous saturated NaCl (20 mL). The organic phase was stripped of most of the volatiles. The obtained dark solution was loaded to a 41 mm inner diameter column chromatography previously prepared with silica gel 60 (15-16 cm height) and eluent (10% ethyl acetate in hexanes). The column was eluted with 10% AcOEt in hexanes. Several portions (80 mL each) were collected. Each portion was characterized by TLC (10% AcOEt in hexanes). The portions containing the dot at R_{f}=0.6 (excess N-isopropylaniline), 0.4 (unknown impurity; traces), and 0.5 (unknown impurity; traces) were discarded. The portions containing the dot at R_{f}=0.3 (Compound 3) were collected, stripped of volatiles under reduced pressure (rotary evaporator; water bath=60° C.). The resulting light-brown viscous liquid was dried on the rotary evaporator (60° C.; <5 mbars) for 10 min. Yield=1.4 grams (21% yield based on furfural) as a very viscous brown liquid.

### Example 4

### Synthesis of 4,4′-(furan-2-ylmethylene)bis(N-(furan-2-ylmethyl) aniline) (Compound 7-A)

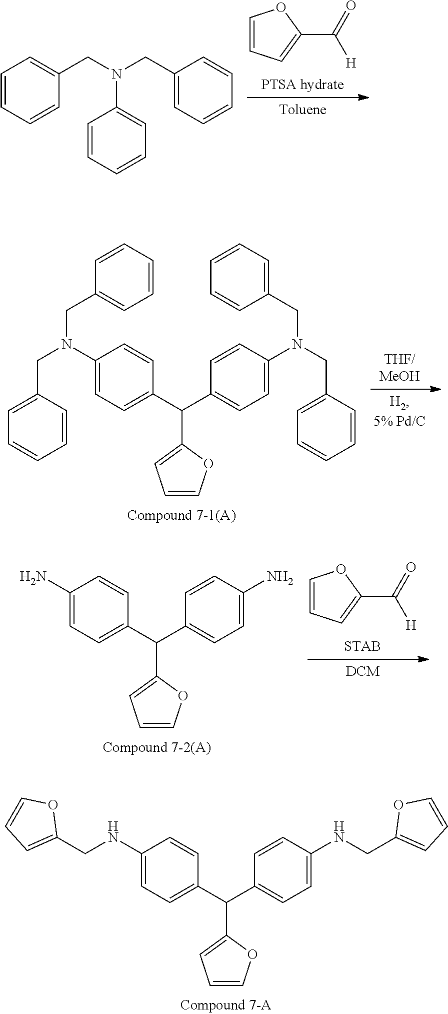

A solution of N,N-dibenzylaniline (42.58 g, 156.120 mmol, 2.14 equiv), furfural (7.00 g, 72.9 mmol, 1.0 equiv) and p-toluenesulfonic acid monohydrate (9.89 g, 51.982 mmol, 0.7 equiv) in toluene (100 mL) was heated overnight at 110° C. The reaction was cooled to room temperature and diluted with dichloromethane (300 mL). The mixture was washed with saturated sodium bicarbonate (100 mL) and the organic layer was concentrated under reduced pressure. The residue was dry loaded onto silica (70 g) and purified on an Interchim automated chromatography system (2×350 g stacked pre-packed 20 mm silica column), eluting with a gradient of 0 to 20% ethyl acetate in heptane to give intermediate compound 7-1(A) (19.9 g, 44% yield) as a white solid.

A suspension of compound 7-1(A) (47.0 g, 75.22 mmol, 1.0 equiv) and 5% palladium on carbon (2.35 g, 50% water wet) in a 1:1 mixture of methanol (235 mL) and THF (235 mL, 5 vol) was hydrogenated @ 25 psi for 2 hours. Upon completion, the reaction was filtered through Celite (30 g), which was washed with methanol (200 mL). The filtrate was concentrated under reduced pressure. The residue was dry loaded onto silica gel (50 g) and purified on an Interchim automated chromatography system (220 g, pre-packed 60 mm silica column), eluting with a gradient of 25 to 100% ethyl acetate in heptane to give compound 7-2 (A) (13.7 g, 69% yield) as an off white solid and 4,4′-((tetrahydrofuran-2-yl)methylene)dianiline (2.1 g, 10% yield) as an off white solid.

A solution of compound 7-2 (A) (13.7 g, 51.83 mmol, 1.0 equiv) and furfural (9.96 g, 103.66 mmol, 2.0 equiv) in dichloromethane (360 mL, 36 vol) was stirred for 1 hour. Sodium triacetoxyborohydride (30.76 g, 145.123 mmol, 2.8 equiv) was added at room temperature and the reaction was stirred for one hour. LCMS and NMR analysis of an indicated completion of the reaction. The reaction was quenched with saturated sodium bicarbonate (360 mL) and stirred for 1 hour. The layers were separated, and the aqueous layer was extracted with dichloromethane (2×130 mL). The combined organics were washed with saturated brine (130 mL) and concentrated under reduced pressure. The residue was then dry loaded onto silica (40 g) and purified on an Interchim automated chromatography system (250 g, pre-packed 60 μm silica column), eluting with a gradient of 0 to 30% ethyl acetate in heptane. The fractions containing pure product were then concentrated under reduced pressure and dried under high vacuum at 50° C. overnight to give compound 7-A (18.3 g, 83% yield, >95% HPLC purity) as an off-white oil. ¹H NMR (400 MHz, DMSO-d₆) δ=7.58-7.51 (m, 3H), 6.86 (d, J=8.6 Hz, 4H), 6.66-6.50 (m, 4H), 6.40-6.33 (m, 3H), 6.28 (dd, J=0.7, 3.2 Hz, 2H), 6.01-5.86 (m, 3H), 5.19-5.12 (m, 1H), 4.20 (d, J=6.0 Hz, 4H); ¹³C (100 MHz, DMSO-d₆) δ=158.52, 153.93, 147.23, 142.31, 142.19, 130.74, 129.16, 112.61, 110.81, 110.58, 107.42, 107.27, 48.94; MS (ESI) m/z [M+H]⁺ calcd, for C₂₇H₂₄N₂O₃, 425.2, found, 425.2.

### Example 5

### Synthesis of 4,4′-methylenebis(N-(furan-2-ylmethyl)aniline) (Compound 8-A)

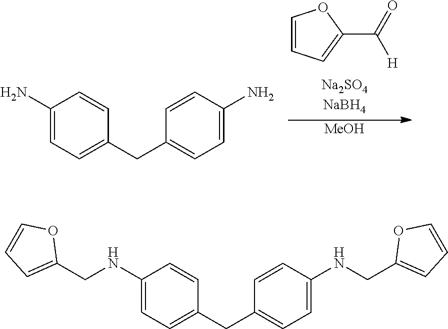 [SMILES: "MeOH" ; O=Cc1ccco1 ; Nc1ccc(Cc2ccc(N)cc2)cc1 ; c1coc(CNc2ccc(Cc3ccc(NCc4ccco4)cc3)cc2)c1]

Furfural (8.80 mL, 106 mmol, 2.1 equiv) and sodium sulfate (14.3 g, 101 mmol, 2.0 equiv) were added to a solution of 4,4′-methylenedianiline (10.0 g, 50.4 mmol, 1.0 equiv) in methanol (100 mL) in a 3-neck 500 mL round bottom flask. The reaction was stirred at room temperature for 1 hour. Sodium borohydride (4.00 g, 101 mmol, 2.1 equiv) was added portion wise over 15 minutes (caution exotherm, methanol began to reflux). The reaction was vigorously stirred at room temperature for 1 hour. The mixture was transferred to a 1-neck round bottom with methanol and concentrated under reduced pressure. The residue was quenched with water (200 mL) then diluted with ethyl acetate (400 mL). The layers were separated and the aqueous was extracted with ethyl acetate (2×200 mL). The combined organics were dried over sodium sulfate, filtered and concentrated under reduced pressure. The residue was absorbed onto silica gel (40 g) using dichloromethane (loading with ethyl acetate resulted in solubility issues during purification) and purified on a Biotage automated chromatography system (350 g, Biotage 60 μm silica gel column), eluting with a gradient of 0 to 30% ethyl acetate in hexanes. The resulting solid was dried under vacuum at room temperature for 18 hours to give compound 8-A (13.9 g, 77% yield, >95% HPLC purity) as an off-white solid. ¹H NMR (400 MHz, CDCl₃) δ=7.34 (dd, J=0.8, 1.8 Hz, 2H), 7.00-6.96 (m, 4H), 6.60-6.56 (m, 4H), 6.30 (dd, J=1.8, 3.2 Hz, 2H), 6.20 (dd, J=0.7, 3.2 Hz, 2H), 4.26 (s, 4H), 3.89 (br s, 2H), 3.76 (s, 2H); ¹³C NMR (101 MHz, CDCl₃) d=152.97 (s, 2C), 145.81, 141.91 (s, 2C), 131.54 (s, 2C), 129.62 (s, 2C), 113.33 (s, 4C), 110.36 (s, 2C), 106.95 (s, 2C), 41.74 (s, 2C), 40.17; MS (ESI) m/z [M+H]⁺ calcd. for C₂₃H₂₂N₂O₂, 359.2, found, 359.1.

### Example 6

### Synthesis of 4,4′-(phenylmethylene)bis(N-isopropylaniline) (Compound 16-A)

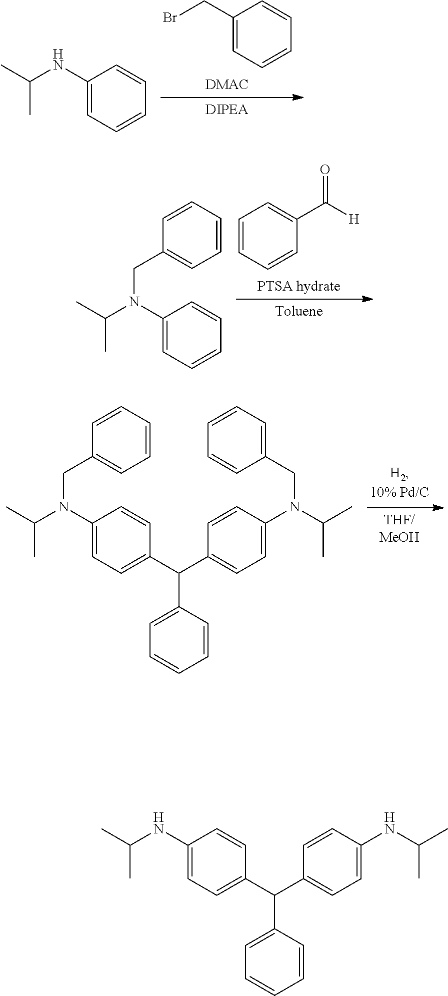

N,N-Diisopropylethylamine (155 mL, 888 mmol, 1.5 equiv) was added to a solution of N-isopropylaniline (80 g, 592 mmol, 1 equiv) and benzyl bromide (121.5 g, 711 mmol, 1.2 equiv) in N,N-dimethylacetamide (700 mL). The mixture was stirred at 110° C. for 2 hours at which point LC/MS analysis indicated the reaction was complete. After cooling to room temperature, the mixture was diluted with saturated brine (1.5 L) and extracted with ethyl acetate (3×1 L). The combined organic layers were washed with saturated brine (IL), dried over anhydrous sodium sulfate, filtered and concentrated under reduced pressure. The residue was purified over silica gel (1.2 kg), eluting with a gradient of 5 to 10% dichloromethane in heptane to give compound 8-1 (114 g, 86% yield, >94% HPLC purity) as a colorless oil.

p-Toluenesulfonic acid monohydrate (32.6 g, 171.4 mmol, 0.6 equiv) was added to a solution of compound 8-1(A) (64 g, 285.7 mmol, 1 equiv) and benzaldehyde (18.2 g, 171.4 mmol, 0.6 equiv) in toluene (500 mL). The reaction mixture was refluxed, equipped with Dean-Stark apparatus, for 24 hours at which point LC/MS analysis indicated 65% of conversion of compound 8-1(A) to compound 8-2 (A). After cooling to room temperature, most of the toluene was removed under reduced pressure. The residue was diluted with ethyl acetate (1.5 L). The resulting mixture was washed sequentially with saturated sodium bicarbonate (2×1 L) and saturated brine (2×1 L). The organic layer was dried over sodium sulfate, filtered and concentrated under reduced pressure to remove three fourths of the solvent. The residual solution was added to methanol (1.5 L), with vigorous stirring, over 10 minutes. The resulting precipitate was filtered, then triturated with a 10:1 mixture of methanol and ethyl acetate (3×300 mL) for 2 hours to give compound 8-2 (A) (25 g, 32% yield, >95% HPLC purity) as an off-white solid.

Compound 8-2 (A) (25 g, 70 mmol, 1 equiv) and 10% palladium on carbon (2.5 g, 50% water wet) was hydrogenated @ 30 psi in a 10:1 mixture of tetrahydrofuran and methanol (300 mL) at room temperature for 2.5 hours, at which point LC/MS analysis indicated the reaction was complete. The reaction was filtered through Celite (20 g), which was washed with tetrahydrofuran (200 mL). The filtrate was concentrated under reduced pressure. The residue was purified over silica gel (800 g), eluting with a gradient of 5 to 15% ethyl acetate in heptane to give compound 16-A (12 g, 72% yield, >95% HPLC purity) as a colorless oil, which slowly solidified as a white solid over 2 days. ¹H NMR (400 MHz, CDCl₃) δ=7.34-7.08 (m, 5H), 6.92-6.86 (m, 4H), 6.51-6.46 (m, 4H), 5.32-5.27 (m, 1H), 3.57 (spt, J=6.3 Hz, 2H), 3.35 (s, 2H), 1.18 (d, J=6.4 Hz, 12H); ¹³C NMR (100 MHz, CDCl₃) δ=145.70, 145.56, 133.25, 130.19, 129.42, 128.05, 125.77, 113.01, 55.21, 44.37, 23.15; MS (ESI) m/z [M+H]⁺ calcd, for C₂₅H₃₀N₂, 359.2, found, 359.2.

### Example 7

### Synthesis of 4,4′-methylenebis(N-isopropylaniline) (Compound 19-A)

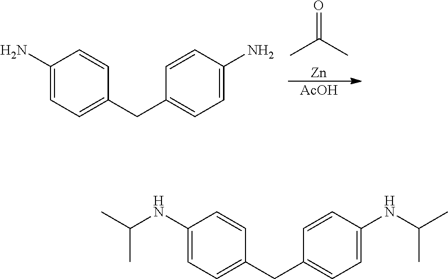

Acetic acid (150 mL) was added slowly to a mixture of 4,4′-methylenedianiline (15 g, 75.7 mmol, 1.0 equiv) and acetone (19.6 mL, 265 mmol, 3.5 equiv) at room temperature (slight exotherm). Zinc (37.5 g, 576.9 mmol, 7.6 equiv) was added in portions at room temperature. After heating at 40° C. for 2 hours, the reaction was cooled to room temperature and filtered through a plug of Celite and silica gel to remove zinc. The column was washed with water (4×100 mL) and dichloromethane (3×100 mL). The filtrate was evaporated under reduced pressure to remove acetic acid. The residue was diluted with a mixture of water (150 mL) and dichloromethane (200 mL). The pH was adjusted to 10 with 20% aqueous sodium hydroxide at 0° C. A white precipitate was formed which was further diluted with water (500 mL) to fully dissolve. The layers were separated and the aqueous layer was extracted with dichloromethane (2×100 mL). The combined organic layers were washed with saturated brine (200 mL), dried over magnesium sulfate, filtered and concentrated under reduced pressure. The residue was purified on a Biotage automated chromatography system (350 g Biotage, 60 μm silica gel column), eluting with a gradient of 0 to 10% ethyl acetate in hexanes to give compound 19-A (20 g, 93% yield, 97.3% purity) as a light-yellow liquid. ¹H NMR (400 MHz, CDCl₃) δ=7.03-6.99 (m, 4H), 6.57-6.53 (m, 4H), 3.79 (s, 2H), 3.62 (spt, J=6.3 Hz, 2H), 3.35 (br s, 2H), 1.22 (d, J=6.2 Hz, 12H); ¹³C NMR (101 MHz, CDCl₃) δ=145.65 (s, 2C), 130.61 (s, 2C), 129.66 (s, 4C), 113.42 (s, 4C), 44.45 (s, 2C), 40.11, 23.14 (s, 4C); MS (ESI) m/z [M+H]⁺ calcd. for C₁₉H₂₆N₂, 283.2, found, 283.2.

### Example 8

### Synthesis of 4,4′-methylenebis(N-(1-(furan-2-yl)ethyl)aniline) (Compound 20-A)

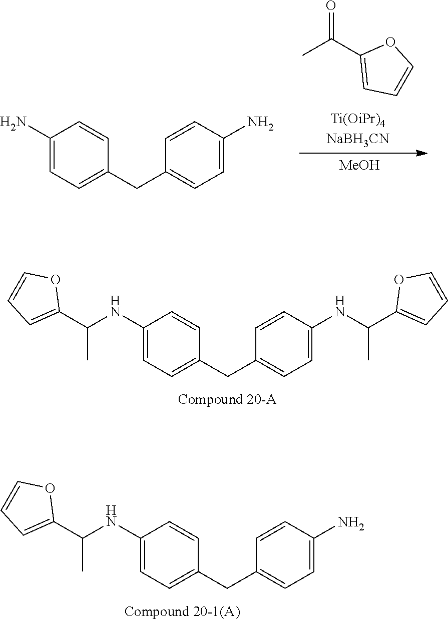

4,4′-Methylenedianiline (19.8 g, 100 mmol, 1 equiv) was added to a solution of 2-furyl methyl ketone (27.5 g, 250 mmol, 2.5 equiv) and titanium (IV) isopropoxide (28.4 g, 100 mmol, 1 equiv) in methanol (200 mL), followed by addition of sodium cyanoborohydride (18.9 g, 300 mmol, 3 equiv). The mixture was refluxed for three days. After cooling to room temperature, sodium borohydride (~1.6 g) was added portion wise until no 2-furyl methyl ketone 2 remained by TLC analysis. The mixture was diluted with water (200 mL) and ethyl acetate (100 mL), filtered through Celite (150 g), which was rinsed with ethyl acetate (300 mL). The layers were separated and the aqueous layer was extracted with ethyl acetate (3×200 mL). The combined organic layers were dried over sodium sulfate, filtered and concentrated under reduced pressure. The residue was purified over silica gel (800 g), eluting with a gradient of 10 to 40% ethyl acetate in heptane to give compound 20-A (9.17 g, 24% yield) as a light-yellow oil and compound 20-1(A) (10.57 g, 36% yield) as a dark brown oil.

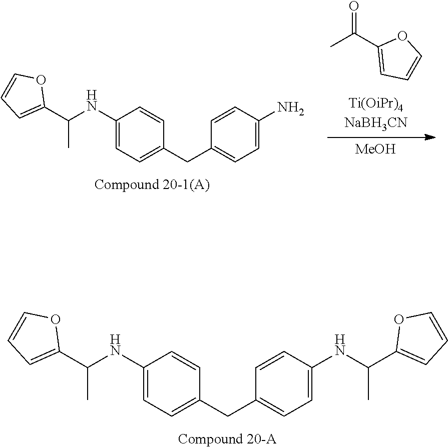

Compound 20-1(A) (29.2 g, 100 mmol, 1 equiv) was added to a solution of 2-furyl methyl ketone 2 (22.0 g, 200 mmol, 2.0 equiv) and titanium(IV) isopropoxide (28.4 g, 100 mmol, 1 equiv) in methanol (300 mL), followed by addition of sodium cyanoborohydride (18.9 g, 300 mmol, 3 equiv). The mixture was refluxed for three days. After cooling to room temperature, sodium borohydride (~1.6 g) was added portion wise until no 2-furyl methyl ketone remained by TLC analysis. The mixture was diluted with water (200 mL) and ethyl acetate (100 mL), filtered through Celite (150 g), which was rinsed with ethyl acetate (300 mL). The layers were separated, and the aqueous layer was extracted with ethyl acetate (3×20 mL). The combined organic layers were dried over sodium sulfate, filtered and concentrated under reduced pressure. The residue was purified over silica gel (750 g), eluting with 10% ethyl acetate in heptane to give compound 20-A (19 g, 49% yield) as light-yellow oil. ¹H NMR (400 MHz, CDCl₃) δ=7.35 (dd, J=0.9, 1.8 Hz, 1H), 7.31 (dd, J=0.9, 1.8 Hz, 2H), 6.97-6.92 (m, 4H), 6.55-6.47 (m, 4H), 6.32-6.29 (m, 1H), 6.26 (dd, J=1.8, 3.2 Hz, 2H), 6.14-6.10 (m, 2H), 4.58 (q, J=6.6 Hz, 2H), 3.72 (s, 2H), 1.51 (d, J=6.7 Hz, 6H), 1.37 (dd, J=6.7, 17.4 Hz, 1H); ¹³C NMR (100 MHz, CDCl₃) δ=157.47, 145.13, 141.42, 131.27, 129.56, 113.61, 110.10, 109.99-109.79 (m, 1C), 105.61, 105.04, 49.00, 48.44, 47.60, 40.13, 21.35, 20.96, 20.11; MS (ESI) m/z [M+H]⁺ calcd. for C₂₅H₂₆N₂O₂, 387.2, found, 387.2.

### Example 9

### Synthesis of 4,4′-methylenebis(N-(1-phenylethyl)aniline) (Compound 21-A)

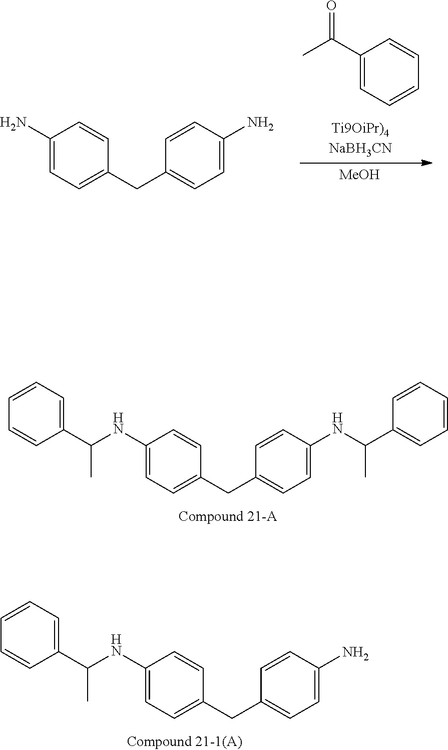

4,4′-Methylenedianiline (24.75 g, 125 mmol, 1 equiv) was added to a solution of acetophenone (37.5 g, 312.5 mmol, 2.5 equiv) and titanium (IV) isopropoxide (35.5 g, 125 mmol, 1 equiv) in methanol (250 mL), followed by addition of sodium cyanoborohydride (23.6 g, 375 mmol, 3 equiv). The mixture was refluxed for 24 hours. After cooling to room temperature, sodium borohydride (~1.7 g) was added portion wise until no acetophenone remained by TLC analysis. The mixture was diluted with water (300 mL) and ethyl acetate (150 mL), filtered through Celite (150 g), which was rinsed with ethyl acetate (300 mL). The layers were separated and the aqueous layer was extracted with ethyl acetate (4×200 mL). The combined organic layers were dried over sodium sulfate, filtered and concentrated under reduced pressure. The residue was purified over silica gel (750 g), eluting with a gradient of 10 to 40% ethyl acetate in heptane to give compound 21-A (12.6 g, 21% yield) as white solid and compound 21-1(A) (19.6 g, 43% yield) as dark brown oil.

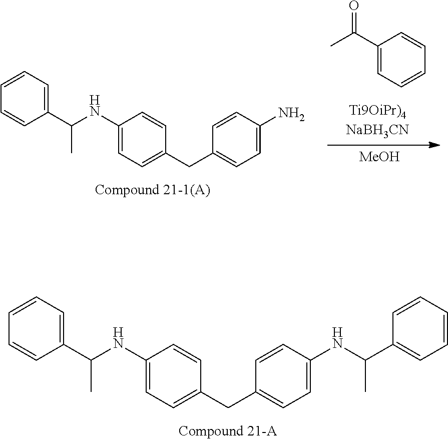

Compound 21-1(A) (35.0 g, 112 mmol, 1 equiv) was added to a solution of acetophenone (26.9 g, 224 mmol, 2.0 equiv) and titanium (IV) isopropoxide (31.8 g, 112 mmol, 1 equiv) in methanol (225 mL), followed by addition of sodium cyanoborohydride (17.6 g, 280 mmol, 2.5 equiv). The mixture was refluxed for three days. After cooling to room temperature, sodium borohydride (~1.7 g) was added portion wise until no acetophenone remained by TLC analysis. The mixture was diluted with water (200 mL) and ethyl acetate (200 mL), filtered through Celite (150 g), which was rinsed with ethyl acetate (300 mL). The layers were separated and the aqueous layer was extracted with ethyl acetate (3×200 mL). The combined organic layers were dried over sodium sulfate, filtered and concentrated under reduced pressure. The residue was purified over silica gel (800 g), eluting with 10% ethyl acetate in heptane to give compound 21-A (22.9 g, 50% yield) as white solid. ¹H NMR (400 MHz, CDCl₃) δ=7.37-7.27 (m, 8H), 7.24-7.18 (m, 2H), 6.95-6.80 (m, 4H), 4.43 (q, J=6.7 Hz, 2H), 3.90 (br s, 2H), 3.66 (s, 2H), 1.49 (s, 3H), 1.48 (s, ³H); 13C NMR (100 MHz, CDCl₃) δ 145.53, 145.47, 130.77, 129.47, 128.67, 126.87, 125.93, 113.41, 60.47, 53.74, 40.12, 25.11, 14.29; MS (ESI) m/z [M+H]⁺ calcd. for C₂₉H₃₀N₂, 407.2, found, 407.3.

### Example 10

### Synthesis of bis(2,2,4-trimethyl-1,2-dihydroquinolin-6-yl)sulfane (Compound 153-A)

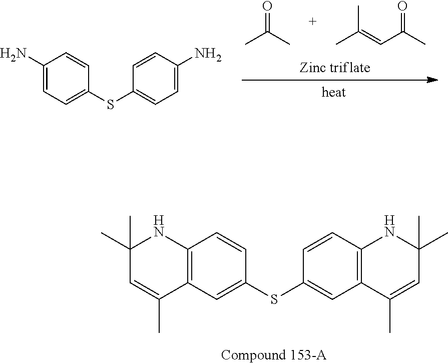

To a 250-mL round bottom flask fitted with a stir-bar and a reflux condenser was loaded the substrate 4,4′-thiodianiline (25.17 g; 116.4 mmol) and acetone (34 mL; 463 mmol). The mixture was stirred under N₂ blanket. The substrate dissolved within minutes. The flask was cooled with a cold tap water bath. To the obtained dark solution was portion-wise added zinc (II) triflate (5.67 g; 15.6 mmol) over 5-6 minutes. The reaction mixture was stirred for 1⅓ hours. The cooling bath was removed. The reaction mixture was stirred without external cooling or heating for about 16 h. The reaction mixture was heated (oil bath temperature=73° C.) for approx. 8 hours, then allowed to cool to room temperature overnight. Mesityl oxide (27 mL; 0.24 mol) was added to the flask. The reaction mixture was refluxed (oil bath temperature=85° C.) for approx. 8 hours then allowed to cool to room temperature overnight. Ethyl acetate (50 mL) was added. The obtained mixture was filtered through pad of Celite. The cake was rinsed with ethyl acetate (10 mL). The combined filtrates were stripped of volatiles under reduced pressure (rotary evaporator; water bath=55° C.). The residue (dark gooey material) was dissolved in toluene (21 mL). The obtained solution was loaded into a 73 mm inner diameter column previously prepared with silica gel 60 and 20% ethyl acetate in hexanes (height of silica=21 cm). The column was eluted with 20% ethyl acetate in hexanes. Each portion coming out was analyzed by silica gel TLC (20% ethyl acetate in hexanes). The portions containing the dot at R_{f}=0.5 were collected, combined, and stripped of volatiles under reduced pressure (rotary evaporator; water bath=50° C.). The obtained light-yellow mass (approx. 14 g) was broken apart into a thin powder. A 10% ethyl acetate in dichloromethane mixture (35 mL) was added and the obtained slurry was stirred (stir-bar) at room temperature for 4 hours. The solid was collected by vacuum filtration, rinsed quickly with several portions of hexanes (total=100 mL), dried under vacuum at 40-50° C. for a few hours then at room temperature overnight to yield 7.97 g (18% with respect to 4,4′-thiodianiline) of Compound 153-A as a white powder. Compound 153-A was characterized by ¹H and ¹³C APT NMR. LC-UV analysis indicated 98.2% purity at 260 nm detection. The melting point of compound 153-A was measured to be about 184° C.

### Example 11

### Synthesis of 4,4′-methylenebis(N-isopropyl-2,6-dimethylaniline) (Compound 154-A)

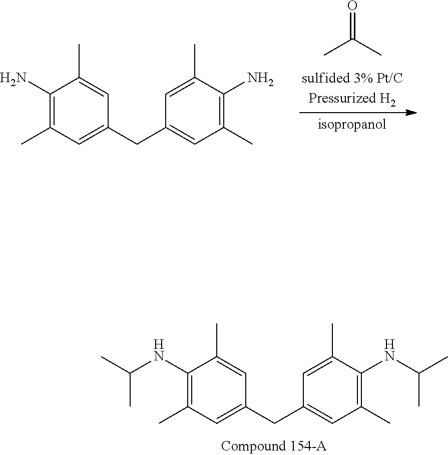

To a 300-mL Parr autoclave was loaded 4,4′-methylenebis(2,6-dimethylaniline) (5.0 g; 19.7 mmol), isopropanol (150 mL), 3% Pt/C sulfided (Johnson Matthey; 40 mg wet), and acetone (4.3 mL; 58.6 mmol). The reaction mixture was heated to 130° C. Once the temperature was reached, the autoclave was continuously fed with H₂ (set pressure=300 PSIG) for several hours. The reaction mixture was allowed to stand at room temperature under N₂ protection overnight. At that stage, approx. 53% monoalkylated intermediates and 27% desired dialkylated product had formed (percentage areas as measured by LC-UV analysis at 260 nm detection). The reaction mixture was heated to 180° C. Once the temperature was reached, the autoclave was continuously fed with H₂ (set pressure=500 PSIG) for approx. 6 hours. Upon cooling to room temperature, the mixture post reaction was filtered through in-line 0.2-micron frit. The clave was rinsed with isopropanol (150 mL) and the mixture was filtered through the inline filter. The combined filtrates were stripped of their volatiles under reduced pressure (rotary evaporator; water bath=55° C.). The obtained light-brown oil was diluted with hexanes (5.5 mL). The solution was loaded into a 41 mm inner diameter column previously prepared with silica gel 60 and 15% ethyl acetate in hexanes (height of silica=7.0-7.5″). The column was eluted with 15% ethyl acetate in hexanes. Each portion coming out was analyzed by TLC (15% ethyl acetate in hexanes). The portions containing the dot at R_{f}=0.4 were collected, combined, and stripped volatiles under reduced pressure (rotary evaporator; water bath=50-55° C.). The obtained solid was dried under vacuum at 40-50° C. for a couple of hours, then at room temperature overnight, to afford 1.81 g (27% with respect to 4,4′-methylenebis(2,6-dimethylaniline)) of Compound 154-A as a light-pink solid. Compound 154-A was characterized by ¹H and ¹³C APT NMR. LC-UV analysis indicated 99.9% purity at 260 nm detection. The melting point of Compound 154-A was measured to be about 84-88° C.

### Example 12

### Synthesis of 2,2,4,8-tetramethyl-N-phenyl-1,2-dihydroquinolin-6-amine (Compound 1-B)

### Step 1

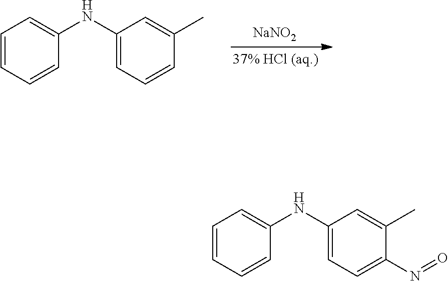

A 250-mL round bottom flask fitted with a stir-bar and a thermometer was purged with N₂, then protected with N₂ blanket (the outlet was connected to a base trap containing about 250 mL of 1 mol/L NaOH). Glacial acetic acid (18.0 mL) was loaded to the flask, then stirred was started. 3-Methyldiphenylamine (4.8 mL; 27.9 mmol) was added (no exotherm was observed). Once 3-methyldiphenylamine was fully dissolved, aq. 37% HCl (2.9 mL; 35.0 mmol HCl) was added over 40 seconds. The temperature rose to 26° C. The flask was chilled with ice-water bath. Once the temperature reached 5° C., a solution of sodium nitrite (1.93 g; 27.9 mmol) in DI water (5.6 mL) was drop-wise added such that the temperature was kept below 8° C., over a period of 9.5-10.0 minutes. A dense liquid phase separated. The ice-water bath was removed. The reaction mixture was stirred at 7-20° C. for 35 min to complete formation of the nitrosamine intermediate. The flask was chilled with an ice-water bath. Once the temperature reached 10° C., aq. 37% HCl (5.8 mL; 70.0 mmol) was added over 2.5-3.0 min (no exotherm was observed). The ice-water bath was removed. The reaction mixture was stirred at 10-25° C. to complete formation of the desired product. A red solid separated after approx. 30 min. After 120 min (total reaction time), the mixture was diluted with DI water (76 mL), whereupon a slurry formed. The solid was collected by vacuum filtration (Buchner-filter paper) and washed with DI water. An aliquot of the damp solid analyzed by LC-MS/UV (260 nm) indicated the presence of 87% desired product. The damp solid was triturated with EtOH (45 mL). The slurry was filtered under suction. The obtained solid was dried under vacuum at 40° C. for a couple of hours. Yield=5.1 g (86% of the theoretical yield with respect to 3-methyldiphenylamine) as a brick red powder. The crude material was involved in the next step without further purification.

### Step 2

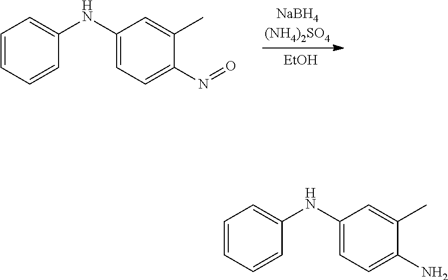 [SMILES: "EtOH" ; Cc1cc(Nc2ccccc2)ccc1N=O ; Cc1cc(Nc2ccccc2)ccc1N]

To a 250-mL flask fitted with a stir-bar and a thermometer were loaded 3-methyl-4-nitroso-N-phenylaniline (see Step 1; 5.0 g; 23.6 mmol) and EtOH (100 mL). The mixture was stirred under N₂ protection (most of the solid dissolved; a brown solution was obtained). Ammonium sulfate (3.11 g; 23.6 mmol) was added in one portion (no exotherm was observed). The mixture was stirred for approx. 1 hour at room temperature. The flask was chilled with a cold tap water bath. Sodium borohydride (1.80 g; 47.6 mmol) was portion-wise added over approximately 2 minutes. The reaction mixture was stirred with the water bath for 10 min (the temperature rose to 32° C.). The water batch was removed. the temperature rose to 35° C. About one hour later, additional NaBH₄ (0.48 g; 12.7 mmol) was added. The reaction mixture was stirred for additional 1.5 hours. Additional NaBH₄ (0.89 g; 23.5 mmol) and ammonium sulfate (3.49 g; 26.4 mmol) were added (at 2.5 hours reaction time). The reaction mixture was stirred for additional time. The total reaction time was 3 hours. DI water (66 mL) was slowly added. The mixture was diluted with ethyl acetate (200 mL). The organic phase was washed with aq. 1M NaOH (3×100 mL), with brine (100 mL), dried over MgSO₄, filtered, and stripped of volatiles under reduced pressure (rotary evaporator; water bath=50° C.). The resulting black oil was dried on a rotary evaporator (55° C.; <5 mbar) for 15-20 minutes. Yield=3.2 g (68% based on 3-methyl-4-nitroso-N-phenylaniline) as a black gooey material (Intermediate Compound 1-1(B)). An aliquot of Intermediate Compound 1-1(B) was characterized by LC-MS/UV (260 nm) as well as 1H and APT 13C NMR spectroscopy. Intermediate Compound 1-1(B) (83.4% pure according to LC-MS/UV (260 nm)) was used in the next step without further purification.

### Step 3

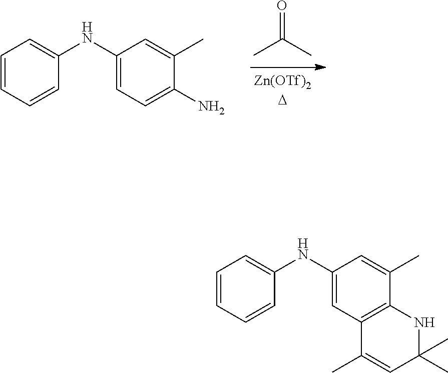

To a 250-mL flask fitted with a stir-bar and a reflux condenser were loaded crude 3-methyl-N¹-phenylbenzene-1,4-diamine (Intermediate Compound 1-1(B); 83.4% pure; 3.1 g; <15.6 mmol), and acetone (6.5 mL; 87.9 mol). The mixture was stirred under N₂ protection. Zinc(II) triflate (679 mg; 1.87 mmol) was loaded in one portion. The reaction mixture was heated (oil bath=62° C.). After 16.5 hours, additional acetone (3 mL; 40.6 mmol) was added. The total reaction time at 62° C. was 25 hours. The reaction mixture was stirred at room temperature for about 48 hours. The obtained black liquid was diluted with a mixture of hexanes and ethyl acetate (5 mL). The obtained solution was loaded into a 41 mm diameter chromatography column previously prepared with silica gel 60 (approx. 23 cm height) and eluent (10% ethyl acetate in hexanes). The column was eluted with 10% ethyl acetate in hexanes. Several fractions (approx. 30 mL each) were collected and characterized by silica gel TLC (10% ethyl acetate in hexanes). The portions containing the dots at Rf=0.35 (desired product) were collected, combined, and stripped of volatiles under reduced pressure (rotary evaporator; water bath=50° C.). Note that mesityl oxide shows as a dot at Rf=0.40 and was not separated from the product at that stage. The resulting yellow liquid was dried on a rotary evaporator (65° C.; <5 mbars) for 10 min. Yield=0.34 g as a yellow viscous material (Compound 1-B). An aliquot of Compound 1-B was characterized by LC-MS/UV (260 nm) as well as by 1H and APT 13C NMR spectroscopy.

### Example 13

### Synthesis of 8-methoxy-2,2,4-trimethyl-N-phenyl-1,2-dihydroquinolin-6-amine (Compound 7-B)

### Step 1

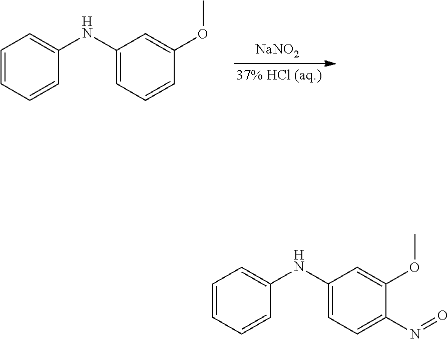

To a 250-mL round bottom flask fitted with a stir-bar and a thermometer was loaded 3-methoxydiphenylamine (11.8 g; 59.2 mmol) and glacial acetic acid (36 mL). The mixture was stirred under N₂ protection (the outlet was connected to a base trap containing about 250 mL of 1 M NaOH). Aq. 37% HCl (18 mL; 217 mmol HCl) was added by portions over a couple of minutes. 3-methoxydiphenylamine dissolved during the addition of aq. HCl. No exotherm was observed. A light-yellow solution was obtained. The flask was chilled with ice-water bath. Once the temperature reached 4-5° C., a solution of sodium nitrite (4.169 g; 60.4 mmol) in distilled water (12 mL) was gradually added over a period of 17-18 min such that the temperature was kept under 10° C. The resulting dark-red mixture was stirred between 2° C. and 9° C. for 30 min, then the chilling bath was removed. The reaction mixture was stirred without external cooling or heating (2-22° C.) for 2 h 40 min, whereupon a dark red solid separated. Distilled water (80 mL) was added and the slurry was stirred for a few minutes. The solid was collected by filtration under suction, then rinsed quickly with distilled water and EtOH (50 mL). Drying under vacuum at 40° C. for about 2 h, then at room temperature overnight, yielded 7.8 g (57% of the theoretical with respect to 3-methoxydiphenylamine) of a dark red powder. An aliquot of this material was characterized by LC-MS/UV (260 nm). The crude material was involved in the next step without further purification.

### Step 2

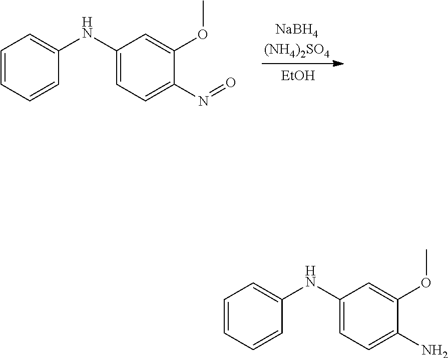 [SMILES: "EtOH" ; COc1cc(Nc2ccccc2)ccc1N=O ; COc1cc(Nc2ccccc2)ccc1N]

To a 500-mL flask fitted with a stir-bar and a thermometer were loaded 3-methoxy-4-nitroso-N-phenylaniline (See Step 1; 7.8 g; 34.2 mmol) and EtOH (210 mL). The mixture was stirred under N₂ protection (some solid remained insoluble; a red slurry was obtained). Ammonium sulfate (9.05 g; 68.5 mmol) was added in one portion (no exotherm was observed) and the mixture was stirred for approximately 1 h at room temperature. The flask was chilled with a cold tap water bath. Sodium borohydride (3.31 g; 87.5 mmol) was portion-wise added over a period of 16 min such that the temperature was kept under 28° C. (frothing occurred). The reaction mixture was stirred with the water bath for 110 min, during which the reaction mixture turned black. The water bath was removed. Approximately 10 min later, distilled water (150 mL) was slowly added and the mixture was stirred for a few minutes. The mixture was diluted with ethyl acetate (450 mL) in a separatory funnel containing distilled water (100 mL) and aq. 1 M NaOH (100 mL). After shaking and decanting, the aqueous layer was discarded. The organic layer was washed with aqueous 1 M NaOH (100 mL) and brine (100 mL), dried over MgSO₄, filtered, and stripped of volatiles under reduced pressure (rotary evaporator; water bath=55° C.). The resulting black oil was dried on a rotary evaporator (55° C.; <12 mbar) for 1 h. Crude yield=6.2 g as a black gooey material. The crude material was dissolved in toluene (10 mL). The obtained black solution was loaded into a 71 mm diameter chromatography column previously prepared with silica gel 60 (8″ height) and eluent (50% ethyl acetate in hexanes). The flask was rinsed with 50% ethyl acetate in hexanes (5-10 mL). The column was eluted with 50% ethyl acetate in hexanes. The portions (100 mL each) containing the desired product (TLC 50% ethyl acetate in hexanes; dots at Rf=0.7) were collected, combined, and stripped of volatiles under reduced pressure (rotary evaporator; water bath=50° C.). The resulting black/purple viscous liquid was dried on a rotary evaporator (55° C.; <2 mbar) for 15-30 min. Yield=4.3 g (58% based on 3-methoxy-4-nitroso-N-phenylaniline) as a dark viscous material (Intermediate Compound 7-1(B)). An aliquot of Intermediate Compound 7-1(B) was characterized by ¹H and APT ¹³C NMR spectroscopy.

### Step 3

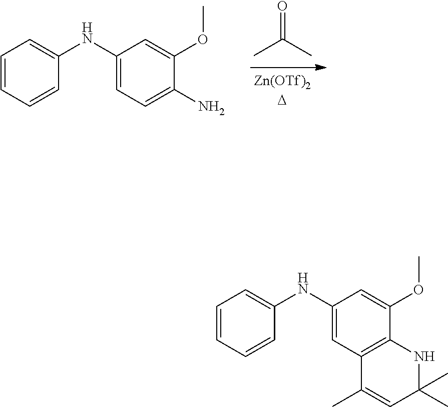

To a 250-mL flask fitted with a stir-bar and a reflux condenser were loaded 3-methoxy-N¹-phenylbenzene-1,4-diamine (Intermediate Compound 7-1(B), see Step 2; 4.3 g; 20.1 mmol), acetone (8.9 mL; 120 mol), and zinc(II) triflate (0.727 g; 2.00 mmol). The mixture was stirred under N₂ protection and heated (oil bath=62° C.) for 40.5 h. The substrate took about 2 h to initially dissolve, then a dark homogenous solution was obtained. Upon cooling to room temperature, the obtained black liquid was loaded into a 41 mm diameter chromatography column previously prepared with silica gel 60 (30 cm height) and eluent (20% ethyl acetate in hexanes). The flask was rinsed with additional acetone (3-4 mL). The column was eluted with 20% ethyl acetate in hexanes. Several fractions (approx. 30 mL each) were collected and characterized by silica gel TLC (20% ethyl acetate in hexanes). The fractions containing the dot at R_{f}=0.6 (desired product) were collected, combined, and stripped of volatiles under reduced pressure (rotary evaporator; water bath=50° C.). The resulting powder was dried on a rotary evaporator (55° C.; <3 mbars) for 20 min. Yield=2.5 g (42% of the theoretical with respect to 3-methoxy-N¹-phenylbenzene-1,4-diamine) as an almost-white crystalline powder (Compound 7-B). An aliquot of Compound 7-B was characterized by LC-MS/UV (260 nm) as well as by 1H and APT 13C NMR spectroscopy.

### Example 14

### Synthesis of 2,2,4,8-tetramethyl-N-phenyl-1,2,3,4-tetrahydroquinolin-6-amine (Compound 2-B)

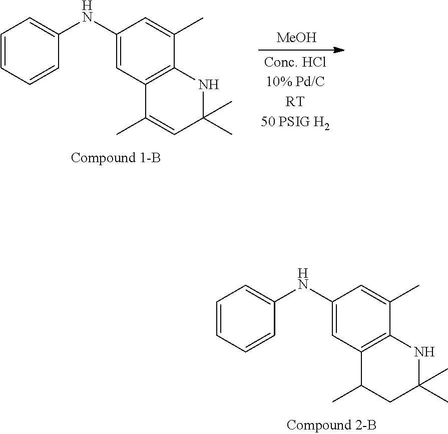 [SMILES: "MeOH" ; CC1=CC(C)(C)Nc2c(C)cc(Nc3ccccc3)cc21 ; Cc1cc(Nc2ccccc2)cc2c1NC(C)(C)CC2C]

To a 20-mL vial was loaded a stir-bar, 2,2,4,8-tetramethyl-N-phenyl-1,2-dihydroquinolin-6-amine (Compound 1-B; 1.07 g; 3.84 mmol), and MeOH (12 mL). The mixture was stirred. Once Compound 1 was fully dissolved, aqueous 37% HCl (0.32 mL; 3.9 mmol) was added. A deep purple solution was obtained, which was added to a 300-mL Parr autoclave with MeOH (130 mL) and 10% Pd on C (Sigma, 0.25 g). The reaction mixture was maintained at 21° C. (water circulator). The autoclave was charged with H₂ until 52 PSIG was attained. A modest exotherm ensued (up to 24° C.), which subsided after 10 minutes. The total reaction time was 75 minutes (the pressure decreased from 52 to 45 PSIG over the first 10 minutes, then plateaued at 44 PSIG the rest of the reaction time). The mixture was filtered through Celite S and the cake was rinsed with methanol. The combined filtrates (dark blue solution) were kept under N₂ protection overnight. The volatiles were stripped under reduced pressure (rotary evaporator; water bath=50° C.). The resulting dark solid was taken up in a mixture of ethyl acetate (50 mL) and aqueous 1 mol/L NaOH (40 mL). The 2-phase system was magnetically stirred until complete dissolution of the solids over a period of 10-15 minutes. The 2-phase system was transferred to a separatory funnel. After shaking and decanting, the aqueous phase was discarded. The organic phase (brownish solution) was washed with aqueous saturated NaCl solution (40 mL), dried over anhydrous MgSO₄, filtered, and stripped of volatiles under reduced pressure (rotary evaporator; water bath=50° C.). The resulting dark oil (0.95 grams) was dissolved in 10% ethyl acetate in hexanes (approx. 4 mL). The obtained solution was loaded into a 1″ inner diameter column previously prepared with silica gel 60 (70-230 mesh) and 20% ethyl acetate in hexanes. The height of wet silica gel in the column was approx. 6.5″. The column was eluted with 20% ethyl acetate in hexanes. The fractions containing the dot at R_{f}=0.6 (silica gel TLC; 20% ethyl acetate in hexanes) were collected, combined, and stripped of volatiles under reduced pressure (rotary evaporator; water bath=50° C.). The obtained oil was dried on the rotary evaporator (water bath=55° C.; <3 mbars) for 1 h 40 min to yield 0.81 grams (75% with respect to Compound 1-B) of 2,2,4,8-tetramethyl-N-phenyl-1,2,3,4-tetrahydroquinolin-6-amine (Compound 2-B) as a light-brown oil. Compound 2-B was characterized by ¹H and ¹³C APT NMR spectroscopy. LC-UV analysis indicated 98.1% purity at 260 nm detection.

### Example 15

### Synthesis of 2,2,8-trimethyl-N-(1-phenylethyl)-1,2,3,4-tetrahydroquinolin-6-amine (Compound 119-B)

### Step 1

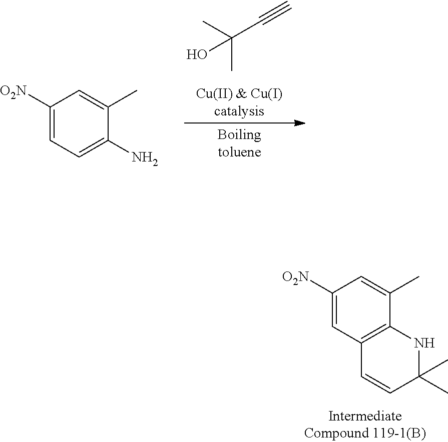

To a 250-mL round bottom flask fitted with a stir-bar, a thermometer, and a reflux condenser was loaded 2-methyl-4-nitroaniline (5.0 g; 32.9 mmol), anhydrous grade toluene (38 mL), and 2-methylbut-3-yn-2-ol (4.8 mL; 49.5 mmol). The mixture was stirred. Dry N₂ was bubbled through the solution for a couple of minutes, then the system was protected with N₂ blanket. Copper (II) chloride (450 mg; 3.35 mmol) and copper (I) chloride (330 mg; 3.33 mmol) were sequentially added to the flask. The reaction mixture was heated to reflux for 44 hours. Upon cooling to room temperature, the mixture was vacuum filtered through Celite S (disposable 0.2-micron polyethylene frit) and the flask/cake was rinsed with copious amounts of toluene. The filtrate was stripped of volatiles under reduced pressure (rotary evaporator; water bath=65° C.). To the residue was added 10% isopropanol in hexanes (20 mL) and the obtained slurry was magnetically stirred overnight. The yellow solid was collected by vacuum filtration (disposable 0.2-micron polyethylene frit) and rinsed with hexanes (20 mL). LC indicated about 75.1% purity at that stage. The solid was washed with 50% isopropanol in hexanes (20 mL). LC indicated about 82.3% purity at that stage. The solid was washed with 25% MeOH in hexanes containing a few drops of isopropanol (20 mL). LC indicated about 88.0% purity at that stage. Finally, the solid was washed with 50% MeOH in hexanes containing a few drops of isopropanol (20 mL) and dried under vacuum at 45° C. for about two hours to yield 1.9 grams (26.5% with respect to 2-methyl-4-nitroaniline) 2,2,8-trimethyl-6-nitro-1,2-dihydroquinoline (Intermediate Compound 119-1(B)) as a yellow solid. Intermediate Compound 119-1(B) was characterized by 1H NMR spectroscopy. LC-UV analysis indicated 98.1% purity at 260 nm detection.

### Step 2

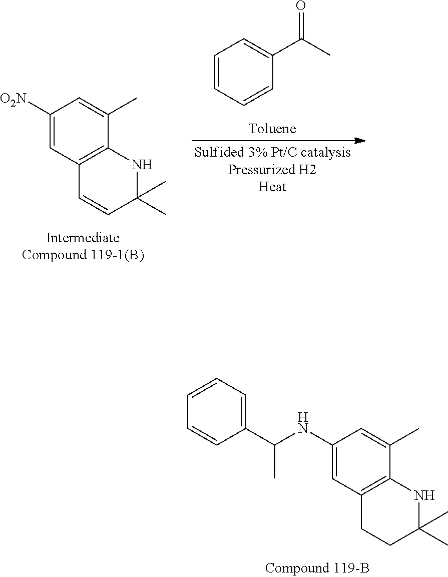

To a 300-mL Parr autoclave was loaded 2,2,8-trimethyl-6-nitro-1,2-dihydroquinoline (Intermediate Compound 119-1(B); 0.949 g; 4.35 mmol), toluene (130 mL), acetophenone (1.00 mL; 8.57 mmol), and sulfided 3% Pt/C frm (Johnson Matthey; 0.134 g wet). The reaction mixture was heated to 120° C. Once the temperature was reached, the autoclave was continuously fed with H₂ (set pressure=300 PSIG) for 2 hours. The reaction mixture was allowed to stand at room temperature under N₂ protection overnight. LC-UV/MS analysis indicated incomplete conversion at that stage. The reaction mixture was heated to 150° C. under 300 PSIG of H₂ for approx. 3 hours. LC-UV/MS analysis indicated better conversion at that stage. Finally, the reaction mixture was heated to 170° C. under 350 PSIG of H₂ for 3 hours. LC-UV/MS analysis indicated almost complete conversion at that stage. The mixture post reaction was filtered under suction through Celite S. The cake was rinsed with minute amounts of isopropanol. The volatiles were stripped under reduced pressure (rotary evaporator; water bath=65° C.). The resulting light-brown liquid was diluted with hexanes (1 mL). The solution was loaded into a 1″ inner diameter column previously prepared with silica gel 60 (70-230 mesh) and 10% ethyl acetate in hexanes. The height of wet silica gel in the column was approx. 22 cm. The column was eluted with 10% ethyl acetate in hexanes, then 20% ethyl acetate in hexanes. The fractions containing the dot at R_{f}=0.2 (silica gel TLC; 10% ethyl acetate in hexanes) were collected, combined, and stripped of volatiles under reduced pressure (rotary evaporator; water bath=50° C.). The obtained oil was dried on the rotary evaporator (water bath=55° C.; <5 mbars) for 2.5 hours to yield 0.78 grams (61% with respect to Intermediate Compound 119-1(B)) of 2,2,8-trimethyl-N-(1-phenylethyl)-1,2,3,4-tetrahydroquinolin-6-amine (Compound 119-B) as a clear light-brown oil. Compound 119-B was characterized by ¹H and ¹³C APT NMR spectroscopy. LC-UV analysis indicated 98.9% purity at 260 nm detection.

### Example 16

### Synthesis of diethyl 2,8-dimethyl-6-(phenylamino)-1,2-dihydroquinoline-2,4-dicarboxylate (Compound 120-B)

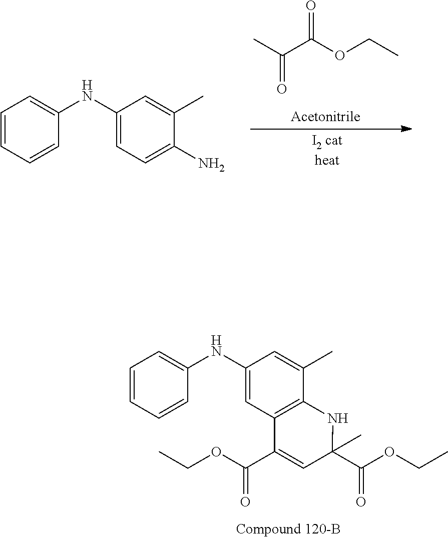

To a 250-mL round bottom flask fitted with a stir-bar and a reflux condenser was loaded 3-methyl-N¹-phenylbenzene-1,4-diamine (1.8 g; 9.08 mmol) and acetonitrile (15 mL). The mixture was stirred under N₂ protection. Ethyl pyruvate (2.1 mL; 18.9 mmol) and iodine (0.070 g; 0.276 mmol) were sequentially added to the flask. The reaction mixture was heated (oil bath temperature set to 60° C.). The temperature was maintained for 90 minutes. Upon cooling to room temperature, sodium sulfite (0.26 g; 2.06 mmol) was added and the mixture was stirred for 30 minutes. The volatiles were stripped under reduced pressure (rotary evaporator; water bath=50° C.). The crude material was diluted with 50% ethyl acetate in hexanes (10 mL). The obtained slurry was loaded to a 41 mm inner diameter column chromatography prepared with silica gel 60 and eluent (50% ethyl acetate in hexanes). The height of wet silica gel in the column was approx. 11″. The column was eluted with the same eluent. The fractions coming out (50 mL each) were analyzed by silica gel TLC (50% ethyl acetate in hexanes). The fractions containing Compound 120 were collected, combined, and stripped of their volatiles under reduced pressure (rotary evaporator; water bath=50° C.). Further drying on the rotary evaporator (50° C.; <5 mbars) for approx. 2 hours afforded 2.7 g of diethyl 2,8-dimethyl-6-(phenylamino)-1,2-dihydroquinoline-2,4-dicarboxylate (Compound 120-B) as a dark oil. Compound 120-B was characterized by 13C APT NMR spectroscopy. LC-UV analysis indicated 97.5% purity at 260 nm detection.

### Example 17

### Synthesis of N-(sec-butyl)-1H-indol-5-amine (Compound 1-C)

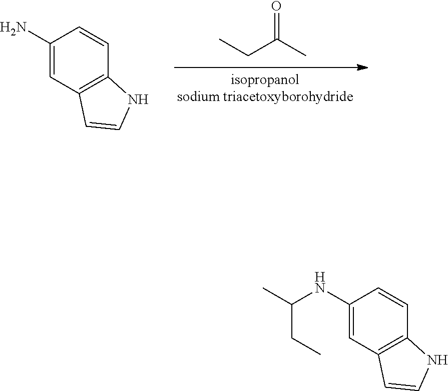

5-aminoindole (20.08 g; 151.9 mmol), isopropanol, (117 mL), and methyl ethyl ketone (47.7 mL; 532 mmol) were added to a 500-mL round bottom flask fitted with a stir-bar, an alcohol thermometer, and a reflux condenser. The reaction mixture was stirred and heated with an oil bath (oil temperature was set to 90° C.) under N₂ protection. Once the reflux temperature was attained (internal temperature=approx. 80° C.), the temperature was held for 7.5 hours to form the imine intermediate. Upon cooling to room temperature overnight, the flask was immersed in a cold tap water bath. Sodium triacetoxyborohydride (42.5 g; 201 mmol), was added in portions over 10 min (apex temperature=31° C.). Once the addition of sodium triacetoxyborohydride was complete, isopropanol (5 mL) was used to rinse the sides of the funnel. The reaction mixture was stirred for 7 min, then the cooling bath was removed. The reaction mixture was stirred without additional cooling or heating for about 2.5 hours. The flask was cooled with a cold tap water bath. Aqueous 2 M NaOH (102 mL) was added by portions over 8-9 min under vigorous stirring. Ethyl acetate (70 mL) was added (no exotherm was observed). The 2-phase system was transferred to a separatory funnel. Additional ethyl acetate (180 mL) was used to rinse the flask and added to the separatory funnel, along with another portion of aqueous 2 M NaOH (102 mL). The separatory funnel was shaken and allowed to settle. The aqueous phase was discarded. The organic phase was washed with aqueous 2 M NaOH (102 mL), deionized water (102 mL), and aqueous saturated NaCl (102 mL). The organic solution was dried over anhydrous MgSO₄, filtered, and stripped of volatiles under reduced pressure (rotary evaporator; water bath=55° C.). The obtained dark liquid was dried on the rotary evaporator (60° C.; <2 mbar) for 1.5 hours to provide 27.2 g (95% of the theoretical with respect to 5-aminoindole) of N-(sec-butyl)-1H-indol-5-amine (Compound 1-C) as a dark oil. Compound 1-C was characterized by ¹H and ¹³C nuclear magnetic resonance (NMR) spectroscopy, and was determined by LC-MS/UV to have a purity of >93.5%.

### Example 18

### Synthesis of N-(sec-butyl) indolin-5-amine (Compound 2-C)

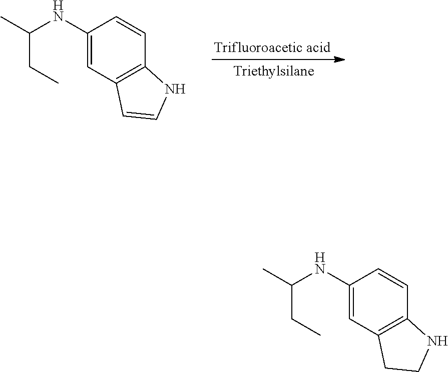

Compound 1-C(1.03 g; 5.47 mmol) was added to a 100-mL round bottom flask fitted with a stir-bar. The flask was protected with N₂ blanket and stirred. Trifluoroacetic acid (5.7 mL) was added. After about 18-24 hours, the flask was cooled with a cold tap water bath. Triethylsilane (1.8 mL; 11.3 mmol) was added via a syringe. No exotherm was observed. The obtained two-phase system was stirred at room temperature for about 22 hours. Silica gel TLC (50% ethyl acetate in hexanes) indicated complete disappearance of the starting material at R_{f}=0.7, and formation of intense dot at R_{f}=0.2. The flask was chilled with cold tap water bath. Aqueous 2 mol/L NaOH (43 mL) was slowly added to the flask. Ethyl acetate (26 mL) was added and the 2-phase system was stirred vigorously until complete dissolution of the oily material. The aqueous layer was discarded. The organic layer was washed with deionized water (20 mL) and brine (20 mL), then stripped of its volatiles under reduced pressure (rotary evaporator; water bath=50° C.). The crude material (black liquid; approx. 1.37 g) was diluted with 50% ethyl acetate in hexanes (3.0 mL). The obtained solution was loaded into a 1-inch inner diameter chromatography column previously prepared with silica gel 60 (approx. 7.5 inches height) and 50% ethyl acetate in hexanes. The column was eluted with 50% ethyl acetate in hexanes, then with 100% ethyl acetate. Each fraction was analyzed by silica gel TLC (50% ethyl acetate in hexanes). The fractions containing R_{f}=0.2 were collected, combined, and stripped of volatiles under reduced pressure (rotary evaporator; water bath=50° C.). Isolated yield=0.492 g as a dark-purple oil (47% based on Compound 1). Compound 2-C was characterized by ¹H and ¹³C NMR, and was determined by LC-MS to have a purity of 96.68%.

Compound 2-C can also be synthesized by reductive alkylation of 5-nitroindoline, as described below:

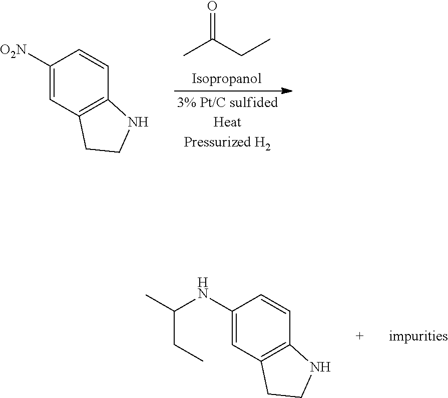

A 300-mL Paar autoclave was charged with 5-nitroindoline (5.0 grams; 30.46 mmol), isopropanol (150 mL), methyl ethyl ketone (4.5 mL; 50.2 mmol), and 3% platinum on carbon sulfided (0.1 g). The reaction mixture was heated to 120° C. under pressurized H₂ (250 PSI) for 3 hours. LC-UV/MS of the crude mixture indicated presence of several compounds including the desired product Compound 2-C.

### Example 19

### Synthesis of N-(1-phenylethyl)-1H-indol-5-amine (Compound 19-C)

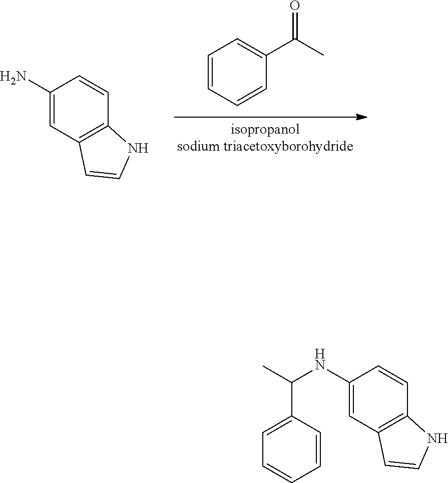

To a 100-mL round bottom flask fitted with a stir-bar and a reflux condenser was loaded 5-aminoindole (2.425 g; 18.35 mmol) and isopropanol (11 mL). The mixture was stirred under N₂ protection and acetophenone (2.8 mL; 24.0 mmol) was added. The reaction mixture was stirred at room temperature for 1 hour, refluxed for 3 hours (oil bath=91° C.), then allowed to cool to room temperature overnight. Silica gel TCL (20% ethyl acetate in hexanes) indicated formation of a spot at R_{f}=0.35. The spots at R_{f}=0.15 (5-aminoindole) and 0.60 (acetophenone) were still quite intense. The reaction mixture was refluxed for additional time (6-6.5 hours) then the flask was cooled with a cold tap water bath. Sodium triacetoxyborohydride (4.67 g; 22.0 mmol) was added by portions over 10-11 minutes. The cooling bath was removed. The reaction mixture was stirred at room temperature overnight (approx. 16 hours). Aqueous 1 mol/L NaOH (68 mL) was added portion-wise to the flask. The mixture was combined with ethyl acetate (50 mL) in a separatory funnel. After shaking and decanting, the aqueous phase was discarded. The organic phase was washed with aqueous 1 mol/L NaOH (25 mL), aqueous dilute NaCl (50 mL), aqueous saturated NaCl (25 mL), was dried over anhydrous MgSO₄, filtered, and finally stripped of volatiles under reduced pressure (rotary evaporator; water bath=50° C.). The obtained dark oil (4.29 g) was dissolved in toluene (5.5 mL). The resulting solution was loaded into a 41 mm inner diameter chromatography column previously prepared with silica gel 60 and eluent 20% ethyl acetate in hexanes (22-23 cm height of silica gel). The column was eluted with the eluent. The portions (approx. 30 mL each) were analyzed by silica gel TLC (20% ethyl acetate in hexanes). The portions containing the desired product (R_{f}=0.35) were collected, combined, and stripped of volatiles under reduced pressure (rotary evaporator; water bath=55° C.). Further drying on the rotary evaporator (water bath=55° C.; 1-6 mbars; 15 min) afforded 2.33 g of a clear light-yellow oil, which darkened upon standing at ambient conditions (proton NMR showed the presence of residual AcOEt). The flask containing the material was immerged into a sand bath. Drying in the vacuum oven at 70° C. for several hours, then at room temperature overnight afforded Compound 19-C as a light blue gooey material (2.1 g; 48% isolated yield with respect to 5-aminoindole). Compound 19-C was characterized by ¹H and ¹³C NMR, and was determined by LC-MS to have a purity of 93.7%.

### Example 20

### Synthesis of 8-methoxy-2,2,4-trimethyl-N-phenylquinolin-6(2H)-imine (Compound 7-D)

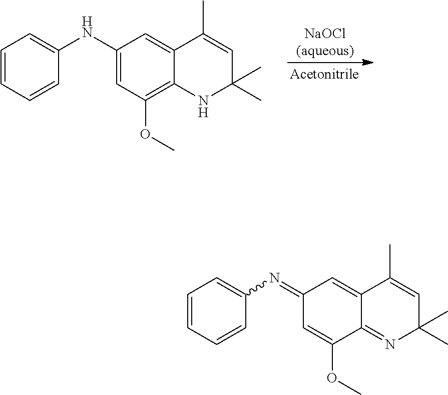 [SMILES: COc1cc(Nc2ccccc2)cc2c1NC(C)(C)C=C2C ; COC1=CC(=Nc2ccccc2)C=C2C(C)=CC(C)(C)N=C12]

A 20-mL vial fitted with a stir-bar was loaded with the 8-methoxy-2,2,4-trimethyl-N-phenyl-1,2-dihydroquinolin-6-amine (Compound 7-B; 300 mg; 1.02 mmol) and acetonitrile (5.5 mL). The mixture was stirred. The substrate did not dissolve completely. Aqueous 10-15 wt % NaOCl solution (0.65 mL) was added. The reaction mixture was stirred without external cooling or heating for 35 minutes whereupon an orange solution was obtained. An aqueous 17 wt % solution of sodium sulfite (1.0 mL; 1.35 mmol sulfite anion) was added to quench excess hypochlorite. Ethyl acetate (approx. 10-11 mL) and anhydrous magnesium sulfate was sequentially added under vigorous stirring. The mixture was gravimetrically filtered. The filtrate was stripped of its volatiles under reduced pressure (rotary evaporator; water bath=50° C.) to yield approx. 300 mg of Compound 7-D as a dark solid. The structure was authenticated by 1H NMR spectroscopy as well as LC-MS. The purity was 94.0 area % (combined areas of the two stereoisomers) as measured by LC-UV at 260 nm detection. The melting point of Compound 7-D was measured to be in the range of 150-185° C.

### Example 21

### Synthesis of N²,N⁵-bis(5-methylhexan-2-yl)pyridine-2,5-diamine (Compound 1-E)

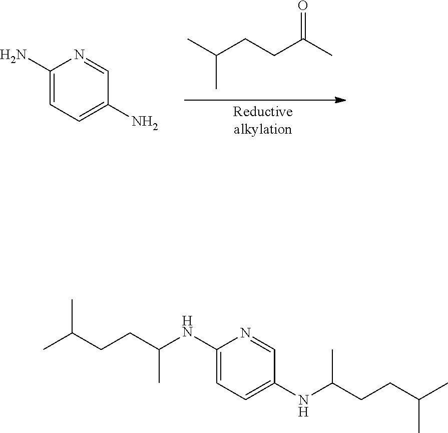

To a 300-mL Parr autoclave was loaded pyridine-2,5-diamine (0.605 g; 5.54 mmol), toluene (130 mL), 3% Pt/C sulfided (Johnson Matthey; 9-10 mg wet), and methyl isoamyl ketone (MIAK) (3.8 mL; 27.1 mmol). The reaction mixture was heated to 245° C. Once the temperature was reached, the autoclave was continuously fed with H₂ (set pressure=500 PSIG) for several hours. The reaction mixture was allowed to stand at room temperature under N₂ protection overnight. At that stage, approx. 60% monoalkylated intermediates and 8-9% desired dialkylated product had formed (percentage areas as measured by LC-UV analysis at 260 nm detection). The reaction mixture was heated to 250° C. Once the temperature was reached, the autoclave was continuously fed with H₂ (set pressure=700 PSIG) for approx. 20 hours. Upon cooling to room temperature, the mixture post reaction was filtered through Celite S. The clave was rinsed with ethyl acetate (120 mL) and the mixture was filtered through the Celite S bed. The combined filtrates were stripped of their volatiles under reduced pressure (rotary evaporator; water bath=60° C.). The obtained black liquid was loaded into a 1″ inner diameter column previously prepared with silica gel 60 and 50% ethyl acetate in hexanes (height of silica=6.25″). The column was eluted with 50% ethyl acetate in hexanes. Each portion was analyzed by TLC (50% ethyl acetate in hexanes). The portions having R_{f}=0.6 were collected, combined, and stripped of volatiles under reduced pressure (rotary evaporator; water bath=55° C.) to afford 0.216 g of N₂,N₅-bis(5-methylhexan-2-yl)pyridine-2,5-diamine (Compound 1-E) as a dark-red oil. Compound 1-E was characterized by 1H and 13C nuclear magnetic resonance (NMR) spectroscop. LC-UV analysis showed 97.7% purity at 260 nm detection.

### Example 22

### Synthesis of N-isopropyl-4,8-dimethyl-4-phenyl-1,2,3,4-tetrahydroquinolin-6-amine (Compound 1-F)

### Step 1

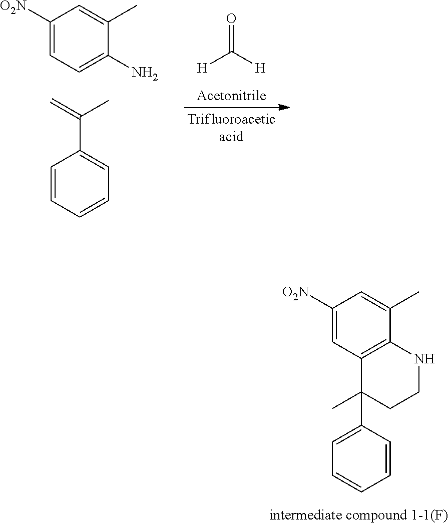

To a 1-L round bottom flask fitted with an overhead stirrer, a thermometer, and a reflux condenser was loaded 2-methyl-4-nitroaniline (30 g; 197 mmol) and acetonitrile (320 mL). The mixture was stirred under N₂ protection. To the resulting clear yellow solution was added trifluoroacetic acid (16.0 mL; 209 mmol), aqueous 37% formaldehyde solution (26.0 mL; 349 mmol HCHO), and alpha-methylstyrene (46.0 mL; 354 mmol) in that order. The reaction mixture (slurry formed after formaldehyde was added) was refluxed for 2 hours (internal temperature=77-78° C.), whereupon a clear yellow solution formed. Upon cooling to room temperature, aqueous 1 mol/L sodium bicarbonate (300 mL) was added by portions. The obtained 2-phase system was stirred until CO₂ generation ceased, then transferred to a 2-L separatory funnel. Ethyl acetate (700 mL) was added. After shaking and decanting, the aqueous phase was discarded. The organic phase was washed with aqueous 1 mol/L sodium bisulfite (300 mL) and aqueous saturated sodium chloride (300 mL), dried over anhydrous magnesium sulfate, filtered, and stripped of volatiles under reduced pressure (rotary evaporator; water bath=50° C.). The obtained dark oil (69.5 g) was diluted with a mixture of isopropanol (100 mL) and hexanes (20 mL). The mixture was swirled until homogenous then kept at −20° C. overnight whereupon a yellow solid separated. The yellow solid was collected by vacuum filtration (disposable 20-micron polyethylene frit) and washed with hexanes (50 mL) directly on the frit. The damp material was dried in the vacuum oven at 45-50° C. for a few hours, then at room temperature overnight, to yield 24.1 g of 4,8-dimethyl-6-nitro-4-phenyl-1,2,3,4-tetrahydroquinoline (intermediate compound 1-1(F)) as a yellow powder. Intermediate compound 1-1(F) was characterized by ¹H and ¹³C NMR spectroscopy. LC-UV analysis indicated 93.4% purity at 260 nm detection.

### Step 2

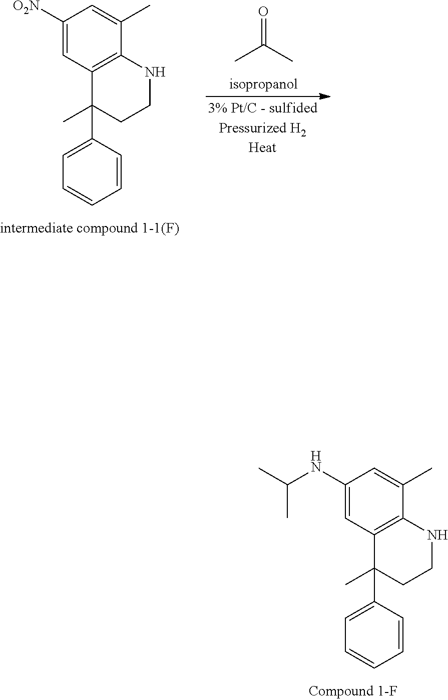

To a 300-mL Parr autoclave was loaded intermediate compound 1-1(F) (23.0 g; 81.5 mmol), 3% Pt/C sulfided (Johnson Matthey) (0.4077 g wet), isopropanol (201 mL), and acetone (10.4 mL; 142 mmol). The reaction mixture was stirred and heated to 120° C. under 250 PSI H₂ for 1.5 hours. Upon cooling to room temperature, the mixture post reaction was filtered through inline 0.2-micron frit. The clave was rinsed with fresh isopropanol (approx. 200 mL) and the obtained mixture was filtered through the inline 0.2-micron frit. The combined filtrates were filtered through filter paper and stripped of their volatiles under reduced pressure (rotary evaporator; water bath=50° C.). The obtained crude material (light-brown oil) weighed 23.7 g. Upon standing for several weeks at room temperature, the oil solidified as a dark solid mass. Upon cooling to −20° C. overnight, the solid mass was broken apart with a spatula. To the obtained dark powder was added a mixture of ethyl acetate and hexanes (10 mL and 51 mL respectively). The obtained slurry was magnetically stirred at room temperature under N₂ protection for 4 days. The solid was collected by vacuum filtration over disposable polyethylene 0.2-micron frit and rinsed quickly with several portions of hexanes (50 mL total). The damp powder (16.58 g) was dried under vacuum at 50-60° C. for a few hours, then at room temperature overnight, to yield 14.48 g of N-isopropyl-4,8-dimethyl-4-phenyl-1,2,3,4-tetrahydroquinolin-6-amine (Compound 1-F) (60% with respect to intermediate compound 1-1(F)) as a light brown powder. Compound 1-F was characterized by ¹³C NMR spectroscopy. LC-UV analysis indicated 96.5% purity at 260 nm detection.

### Example 23

### Synthesis of 4,8-dimethyl-N-(pentan-3-yl)-4-phenyl-1,2,3,4-tetrahydroquinolin-6-amine (Compound 2-F)

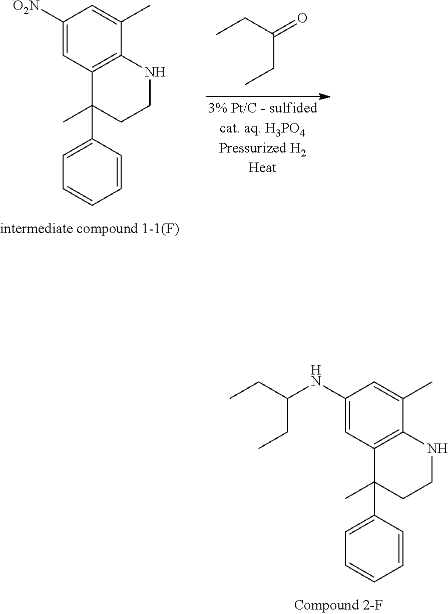

To a 300-mL Parr autoclave was loaded intermediate compound 1-1(F) (12.0 g; 42.5 mmol), 3% Pt/C sulfided (Johnson Matthey) (0.42 g wet), 3-pentanone (180 mL; 1.70 mol) and aqueous 5 wt % phosphoric acid (1.8 g solution; 0.92 mmol H₃PO₄). The reaction mixture was stirred and heated to 150° C. under 250 PSI H₂ for 2 hours. Upon cooling to room temperature, the mixture post reaction was filtered through inline 0.2-micron frit. The clave was rinsed with isopropanol (approx. 150-200 mL) and the obtained mixture was filtered through the inline 0.2-micron frit. The combined filtrates were stripped of their volatiles under reduced pressure (rotary evaporator; water bath=50° C.). The obtained residue was dissolved in hexanes (14 mL) whereupon trace amounts of insoluble material separated. The mixture was vacuum filtered over Celite S and the cake was rinsed with hexanes (100 mL). The combined filtrates were stripped of their volatiles under reduced pressure (rotary evaporator; water bath=50° C.). Drying under vacuum at 60° C. overnight yielded 12.5 g of a brown oil which darkened over time upon standing at room temperature to afford 4,8-dimethyl-N-(pentan-3-yl)-4-phenyl-1,2,3,4-tetrahydroquinolin-6-amine (Compound 2-F). Compound 2-F was characterized by ¹³C NMR spectroscopy. LC-UV analysis indicated 93.4% purity at 260 nm detection.

### Example 24

### Synthesis of N-isopropyl-4,8-dimethyl-2,4-diphenyl-1,2,3,4-tetrahydroquinolin-6-amine (Compound 3-F)

### Step 1

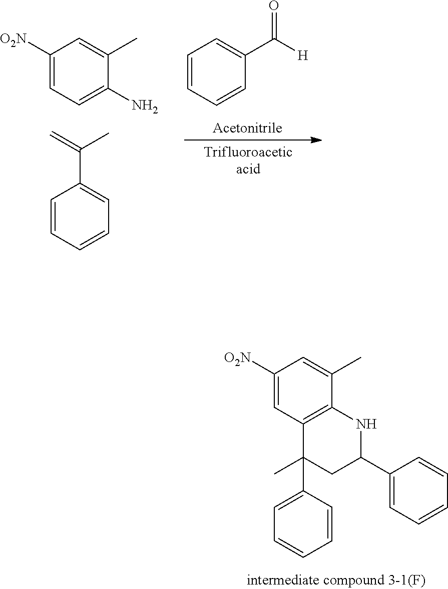

To a 1-L round bottom flask fitted with a stir-bar, a thermometer, and a reflux condenser was loaded 2-methyl-4-nitroaniline (9.96 g; 65.5 mmol) and acetonitrile (200 mL). The mixture was stirred under N₂ protection. To the resulting clear yellow solution was added trifluoroacetic acid (5.3 mL; 68.7 mmol), benzaldehyde (6.6 mL; 65.5 mmol), and alpha-methylstyrene (15.3 mL; 117.9 mmol) in that order. The reaction mixture was heated to 82° C. (oil bath temperature) for 4 hours. Upon cooling to room temperature, a yellow precipitate formed. A solution of sodium bicarbonate (10 g) in deionized water (200 mL) was added by portions. Ethyl acetate (200 mL) was added in portions to dissolve the precipitate. The obtained 2-phase system was transferred to a separatory funnel. The aqueous phase was discarded. The organic phase was washed with a solution of sodium bisulfite (15.0 g) in deionized water (200 mL) and aqueous saturated sodium chloride (200 mL), dried over anhydrous magnesium sulfate, filtered, and stripped of volatiles under reduced pressure (rotary evaporator; water bath=45° C.). The residue was dried under vacuum to 20 mbar at 45 deg C. for 20 min. The resulting viscous orange oil was suspended in 1:1 v/v isopropanol: hexanes (100 mL) and heated to 55° C. for 15 minutes, upon which the orange oil became a yellow solid. The mixture was allowed to cool to room temperature, then filtered to isolate the yellow solid. The solid was washed with hexanes (3×20 mL) and dried over a vacuum filter for approx. 20 min to afford 15.2 g of 4,8-dimethyl-6-nitro-2,4-diphenyl-1,2,3,4-tetrahydroquinoline (intermediate compound 3-1(F)) as a yellow powder. LC-UV analysis indicated 99.0% purity at 260 nm detection.

### Step 2

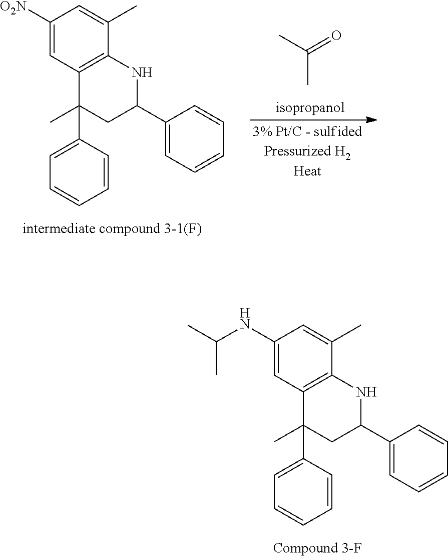

To a 300-mL Parr autoclave was loaded intermediate compound 3-1(F) (10.6 g, 29.7 mmol), 3% Pt/C sulfided (Johnson Matthey) (0.2467 g wet), isopropanol (200 mL), and acetone (5.6 mL, 75.5 mmol). The reaction mixture was stirred and heated to 150° C. under 250 PSI H₂ for 107 minutes. Upon cooling to room temperature, the mixture was filtered over inline 0.2-micron frit, the reactor was rinsed with 100 mL isopropanol, and the combined filtrates were removed under reduced pressure (rotary evaporator; water bath=50° C.) to give a waxy beige solid (10.68 g). The solid was dried under vacuum for 16 hours at 55° C. to yield 9.27 g of N-isopropyl-4,8-dimethyl-2,4-diphenyl-1,2,3,4-tetrahydroquinolin-6-amine (Compound 3-F) as a waxy beige solid. Compound 3-F was characterized by ¹³C NMR spectroscopy. LC-UV analysis indicated 94.5% purity at 260 nm detection.

### Example 25

### Synthesis of N,2-diisopropyl-4,8-dimethyl-4-phenyl-1,2,3,4-tetrahydroquinolin-6-amine (Compound 4-F)

### Step 1

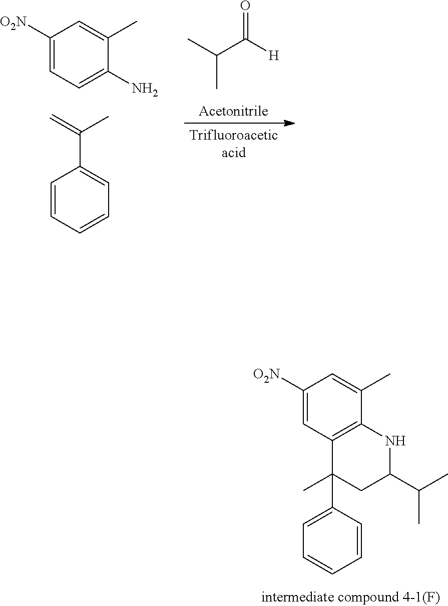

To a 250-mL flask equipped with a stir-bar and a reflux condenser was loaded 2-methyl-4-nitroaniline (4.2 g; 27.6 mmol) and acetonitrile (50 mL). The mixture was stirred under N₂ protection (2-methyl-4-nitroaniline dissolved within a few minutes). To the resulting dark solution were sequentially added trifluoroacetic acid (2.2 mL; 28.7 mmol), isobutyraldehyde (4.4 mL; 48 mmol), and alpha-methylstyrene (6.4 mL; 49.2 mmol) in that order. The reaction mixture was heated (oil bath set to 80° C.). Once the set temperature was reached, it was maintained for 5 hours. Upon cooling to room temperature (overnight), a solution of sodium bicarbonate (4.75 g; 56.5 mmol) in deionized water (60 mL) was portion-wise added. The obtained 2-phase system was stirred until CO₂ generation ceased, Ethyl acetate was added (50 mL), then the mixture was transferred to a separatory funnel. The flask was rinsed with ethyl acetate (2×20 mL). The organic solutions were transferred to the separatory funnel. After decantation, the aqueous layer was discarded. The organic layer was washed with aq. saturated sodium bisulfite (30 mL), dried over MgSO₄, filtered, and stripped of its volatiles under reduced pressure (rotary evaporator; water bath=50° C.). No attempt was undertaken to strip excess alpha-methylstyrene (BP=165-169 deg C.). To the obtained impure orange oil weighing approx. 9.9 g was added a mixture of hexanes (20 mL) and isopropanol (10 mL). After swirling for a few seconds, the obtained solution was kept at −20° C. for 1 hour whereupon a yellow crystalline solid and a dark dense mass separated. Upon warming to room temperature and vigorous swirling, the dark mass vanished, and additional amounts of yellow crystals formed. The solid was collected by vacuum filtration over disposable polyethylene 0.2-micron frit and rinsed quickly with hexanes (10 mL). The damp solid (2.87 g) was dried under vacuum at 50-60° C. for a few hours, then at room temperature for a few hours, to afford 2.78 g of 2-isopropyl-4,8-dimethyl-6-nitro-4-phenyl-1,2,3,4-tetrahydroquinoline (intermediate compound 4-1(F)) as a yellow powder. Intermediate compound 4-1(F) was characterized by ¹³C NMR spectroscopy. LC-UV analysis indicated 95.2% purity at 260 nm detection.

### Step 2

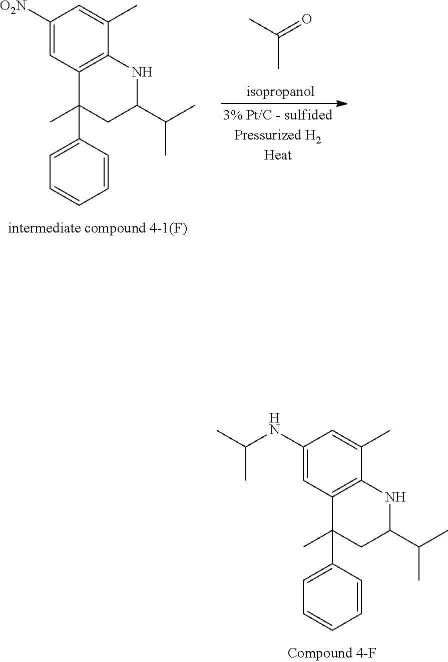

To a 300-mL Parr autoclave was loaded intermediate compound 4-1(F) (1.6 g; 4.93 mmol), 3% Pt/C sulfided (Johnson Matthey) (0.0366 g wet), isopropanol (130 mL), and acetone (0.99 mL; 13 mmol). The reaction mixture was stirred and heated to 150° C. under 250 PSI H₂ for 65-70 minutes. Upon cooling to room temperature, the mixture post reaction was filtered through inline 0.2-micron frit. The clave was rinsed with fresh isopropanol (150 mL) and the obtained mixture was filtered through the inline 0.2-micron frit. The combined filtrates were stripped of volatiles under reduced pressure (rotary evaporator; water bath=55° C.). The residue was dissolved in 40% ethyl acetate in hexanes (5 mL). The obtained solution was loaded into a 41 mm inner diameter column previously prepared with silica gel (ultrapure; 60 Å; 60-200 μm) and 20% ethyl acetate in hexanes (height of silica=10-11 cm). The column was eluted with 20% ethyl acetate in hexanes. Each fraction coming out was analyzed by silica gel TLC (20% ethyl acetate in hexanes). The fractions having R_{f}=0.3 were collected, combined, and stripped of their volatiles under reduced pressure (rotary evaporator; water bath=55° C.). The obtained light-brown oil was dried under vacuum (rotary evaporator; water bath=55° C.; <2 mbars) for 1.5 hours, then in a vacuum oven at 75-80° C. overnight, to yield 1.4 g N,2-diisopropyl-4,8-dimethyl-4-phenyl-1,2,3,4-tetrahydroquinolin-6-amine (Compound 4-F) as a transparent light orange very viscous oil. Compound 4-F was characterized by ¹³C NMR spectroscopy. LC-UV analysis indicated 97.2% purity at 260 nm detection.

### Example 26

### Synthesis of N-isopropyl-3,3,8-trimethyl-1,2,3,4-tetrahydroquinolin-6-amine (Compound 47-F)

### Step 1

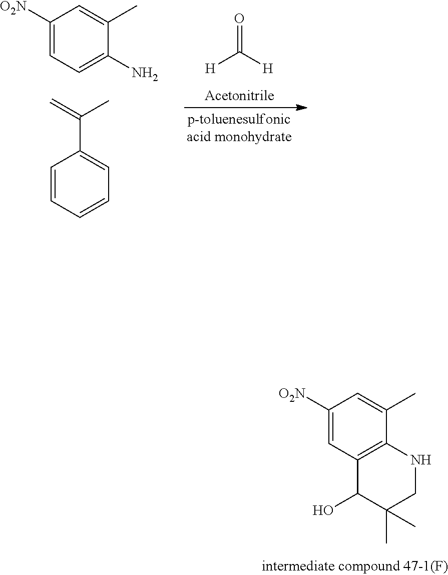

To a 100-mL flask equipped with a stir-bar and a reflux condenser was loaded 2-methyl-4-nitroaniline (3.96 g; 26.0 mmol) and acetonitrile (42 mL). The mixture was stirred under N₂ blanket. To the obtained dark solution were sequentially added para-toluenesulfonic acid monohydrate (0.486 g; 2.56 mmol acid), aqueous 37% formaldehyde (2.4 mL; 32.2 mmol HCHO), and isobutyraldehyde (3.7 mL; 41 mmol). A yellow solid separated after addition of the formaldehyde solution. The reaction mixture was stirred without external cooling or heating for 2 days whereupon a dark solution was obtained. Sodium bicarbonate (0.337 g; 4.01 mmol) was added and the mixture was stirred for 5-10 minutes. Anhydrous magnesium sulfate was added and the obtained slurry was stirred for approx. 5 minutes. The insoluble materials were removed by gravimetric filtration over filter paper. The cake was rinsed with some acetonitrile. The filtrate was stripped of its volatiles under reduced pressure (rotary evaporator; water bath=50° C.). The crude material (6.35 g of damp yellow-orange solid) was triturated in isopropanol (20 mL) with a spatula until all the solid had detached from the flask walls. The obtained slurry was magnetically stirred for 10-15 minutes. Hexanes (20 mL) was added and the mixture was magnetically stirred for 30 minutes. The solid was collected by vacuum filtration over disposable 0.2-micron polyethylene frit, and rinsed with several portions of hexanes (total=25 mL). The damp solid was dried under vacuum at approx. 50° C. for a few hours then at room temperature overnight to afford 3.09 g of crude 3,3,8-trimethyl-6-nitro-1,2,3,4-tetrahydroquinolin-4-ol (intermediate compound 47-1(F)) as a yellow powder. Crude intermediate compound 47-1(F) was characterized by ¹³C APT NMR spectroscopy. LC-UV analysis indicated approx. 66% purity at 260 nm detection. The crude material was involved in the subsequent step without further purification.

### Step 2

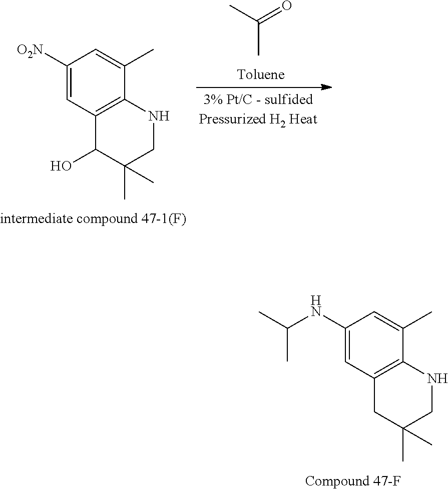

To a 300-mL Parr autoclave was loaded crude intermediate compound 47-1(F) (2.8 g; <11.9 mmol), toluene (140 mL), acetone (1.7 mL; 23.2 mmol), and 3% Pt/C sulfided (Johnson Matthey) (150 mg wet). The reaction mixture was stirred and heated to 120° C. under 250 PSI H₂ for 2 hours. Upon cooling to room temperature, the mixture post reaction was filtered through inline 0.2-micron frit. The clave was rinsed with isopropanol (130 mL) and the obtained mixture was filtered through the inline 0.2-micron frit. The combined filtrates were stripped of volatiles under reduced pressure (rotary evaporator; water bath=60° C.). The residue was dissolved in hexanes (4 mL). The obtained solution was loaded into a 41 mm inner diameter column previously prepared with silica gel (ultrapure; 60 Å; 60-200 μm) and 30% ethyl acetate in hexanes (height of silica=16-17 cm). The column was eluted with 30% ethyl acetate in hexanes. Each fraction coming out was analyzed by silica gel TLC (30% ethyl acetate in hexanes). The fractions having Rf=0.45 were collected, combined, and stripped of their volatiles under reduced pressure (rotary evaporator; water bath=50° C.). The obtained light-brown oil was dried under vacuum (rotary evaporator; water bath=55° C.; <8 mbars) for 1.5 hours to yield 0.96 g of N-isopropyl-3,3,8-trimethyl-1,2,3,4-tetrahydroquinolin-6-amine (Compound 47-F) as a brown oil. Compound 47-F was characterized by ¹³C APT NMR spectroscopy. LC-UV analysis indicated 94.6% purity at 260 nm detection.

### Example 27

### Synthesis of N-(furan-2-ylmethyl)-2,2,4-trimethyl-1,2-dihydroquinolin-6-amine (Compound 1-H)

### Step 1

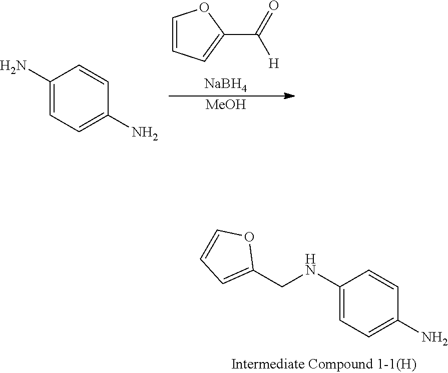

To a 500-mL flask fitted with an overhead mechanical stirrer, a 50-mL pressure-equalized addition funnel, and a thermometer was loaded 1,4-phenylenediamine (20.9 g; 180 mmol) and methanol (150 mL). The mixture was stirred under N₂ protection. A solution of furfural (15.0 g; 12.9 mL; 155.7 mmol) in methanol (19 mL) was loaded to the addition funnel. Once 1,4-phenylenediamine was fully dissolved, the solution of furfural was gradually added to the flask over 8-10 minutes. After completion of the addition, the reaction mixture was stirred at room temperature for 30 minutes (formation of the imine intermediate). The flask was chilled with an ice-water bath. Sodium borohydride (7.4 g; 195 mmol) was added portionwise such that the temperature was kept below 35° C. About 30 min later, the ice-water bath was removed. The reaction mixture was stirred without external cooling or heating for 90 minutes (reduction of imine to desired amine product). DI water (150 mL) was slowly added to the flask to quench the reaction. Once the exotherm subsided, the mixture was transferred to a 1-L beaker equipped with a stir-bar. Ethyl acetate (400 mL) was added. The two-phase system was vigorously stirred, then transferred to a 1-L separatory funnel. The aqueous layer was discarded. The organic layer was washed with water (100 mL) and aqueous saturated NaCl (50 mL), then stripped of volatiles under reduced pressure (rotary evaporator; water bath=50° C.). The crude product was diluted with toluene (10 mL). The obtained solution was loaded to a column (73 mm inner diameter) prepared with silica gel 60 (20 cm height) and 50% ethyl acetate in hexanes. The column was eluted with 50% ethyl acetate in hexanes. Each fraction coming out was analyzed by silica gel TLC (50% ethyl acetate in hexanes). The fractions containing the dot at R_{f}=0.8 were discarded (over-alkylated by-product N¹,N⁴-bis(furan-2-ylmethyl)benzene-1,4-diamine). Next, the fractions containing the dot at R_{f}=0.4 were collected, combined, then stripped of volatiles under reduced pressure (rotary evaporator; water bath=50° C.). Further drying on the rotary evaporator (50° C.; <3 mbars) for 30 minutes afforded N¹-(furan-2-ylmethyl)benzene-1,4-diamine (Intermediate Compound 1-1(H)) a dark reddish liquid (18.3 g; 83% yield with respect to furfural). The desired structure was authenticated by ¹³C NMR spectroscopy.

### Step 2

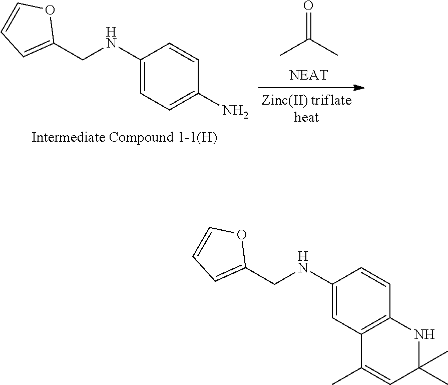

To a 250-mL flask fitted with a stir-bar and a reflux condenser was loaded N¹-(furan-2-ylmethyl)benzene-1,4-diamine (Intermediate Compound 1-1 (H); 15.367 g; 81.64 mmol), and acetone dried over molecular sieves (25.0 mL; 338 mmol). The mixture was stirred under N₂ protection and immerged in an oil bath at room temperature. Zinc(II) triflate (3.0139 g; 8.29 mmol) was loaded in one portion. The reaction mixture was heated (oil bath temperature=61° C.) for 6.5 hours, then allowed to cool to room temperature overnight. Again, the reaction mixture was heated (oil bath temperature=61° C.) for 6.5 hours, then allowed to cool to room temperature. Additional acetone dried over molecular sieves (10 mL; 135.5 mmol) was added. The reaction mixture was stirred at room temperature overnight, then heated (oil bath temperature=61° C.) for 6.5 hours. The total reflux time was 19.5 hours. Upon cooling to room temperature (2 days), the crude material was loaded into a 73 mm inner diameter column prepared with silica gel 60 (70-230 mesh; 29 cm height) and 20% ethyl acetate in hexanes. Minute amounts of acetone were used to rinse the flask and the washes were loaded to the column. The column was eluted with 20% ethyl acetate in hexanes. Each fraction coming out was analyzed by silica gel TLC (20% ethyl acetate in hexanes). Once the desired product started coming out (R_{f}=0.5), the column was eluted with 50% ethyl acetate in hexanes. All the fractions containing the dot at R_{f}=0.5 (20% ethyl acetate in hexanes) were combined and stripped of volatiles under reduced pressure (rotary evaporator; water bath=50° C.). The resulting yellow oil was dried on the rotary evaporator (50° C.; <10 mbars) for 1.5 hour to yield=13.7 g (62.5% with respect to N¹-(furan-2-ylmethyl)benzene-1,4-diamine) of N-(furan-2-ylmethyl)-2,2,4-trimethyl-1,2-dihydroquinolin-6-amine (Compound 1-H) as a yellow oil. Compound 1-H was characterized by 1H and 13C NMR spectroscopy. LC-UV analysis indicated 94.1% purity at 260 nm detection.

### Example 28

### Synthesis of diethyl 2-methyl-6-(phenylamino)-1,2-dihydroquinoline-2,4-dicarboxylate (Compound 3-H)

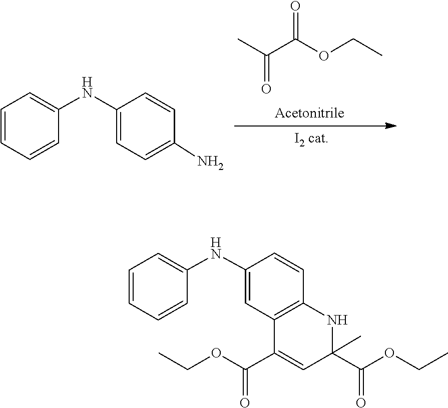

To a 250-mL round bottom flask fitted with a stir-bar and a reflux condenser was loaded N¹-phenylbenzene-1,4-diamine (4-ADPA; 14.6 g; 79.2 mmol) and acetonitrile (85 mL). The mixture was stirred under N₂ protection. Once 4-ADPA was fully dissolved, ethyl pyruvate (18.5 mL; 166 mmol) and iodine (0.623 g; 2.45 mmol) were sequentially added to the flask. The solution turned darker upon addition of iodine. The mixture was heated (oil bath temperature set to 60° C.). The temperature was maintained for about 2 h. Upon cooling to room temperature, sodium sulfite (2.4 g; 19.0 mmol) was added and the mixture was stirred for about 2 h. The volatiles were stripped under reduced pressure (rotary evaporator; water bath=50° C.). The crude material was diluted with toluene (16 mL). The obtained solution was loaded to a column (73 mm inner diameter) previously prepared with silica gel 60 and 30% ethyl acetate in hexanes. The height of silica gel in the column was approx. 24 cm. The column was eluted with 30% ethyl acetate in hexanes. Each fraction coming out was analyzed by silica gel TLC (30% ethyl acetate in hexanes). The fractions containing the dot at R_{f}=0.5 were collected, combined, and stripped of their volatiles under reduced pressure (rotary evaporator; water bath=50° C.). Drying on the rotary evaporator (55° C.; <8 mbars) for approx. 1 hour afforded 20.0 g of diethyl 2-methyl-6-(phenylamino)-1,2-dihydroquinoline-2,4-dicarboxylate (Compound 3-H) as a dark-red viscous oil (66% yield with respect to 4-ADPA). Compound 3-H was characterized by ¹H and ¹³C APT NMR spectroscopy. LC-UV analysis indicated 98.4% purity at 260 nm detection.

### Example 29

### Synthesis of 2,4-diethyl-2-methyl-N-phenyl-1,2-dihydroquinolin-6-amine (Compound 6-H)

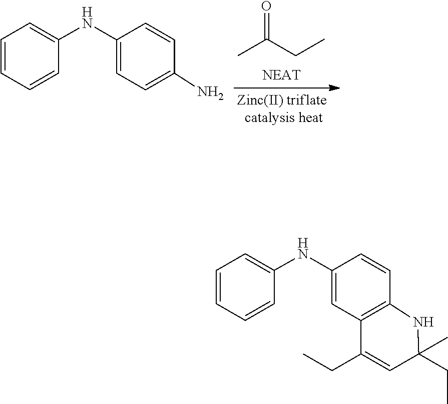

To a 250-mL round bottom flask equipped with a stir-bar and reflux condenser was loaded 4-ADPA (5.08 g; 27.6 mmol) and methyl ethyl ketone (40 mL; 447 mmol). The mixture was stirred under N₂ protection. Zinc(II) triflate (1.005 g; 2.77 mmol) was added and the reaction mixture was refluxed (oil bath set to 80° C.) for 14 hours. A first purification by column chromatography (silica gel 60; 20% ethyl acetate in hexanes) allowed removal of most of the impurities. Then a second column chromatography (silica gel 60; 10% ethyl acetates in hexanes to 20% ethyl acetate in hexanes gradient) was carried out to obtain a product in acceptable purity. LC-UV analysis indicated 95.0% purity at 260 nm detection.

### Example 30

### Synthesis of 2,2,4,7,7,9-hexamethyl-1,2,6,7-tetrahydropyrido[2,3-g]quinolone (Compound 32-H)

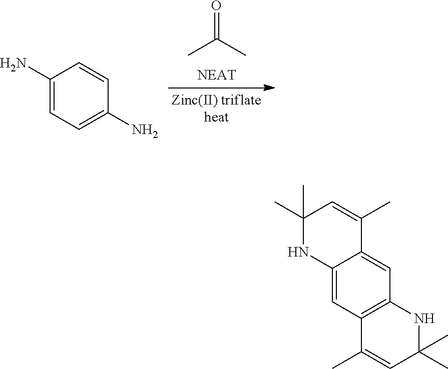

To a 250-mL flask fitted with a stir-bar and a reflux condenser were loaded 1,4-phenylenediamine (12.6 g; 117 mmol) and acetone dried over molecular sieves (57 mL; 771 mmol). The mixture was stirred under N₂ protection. Most of 1,4-phenylenediamine remained insoluble. The flask was immersed in an oil bath at room temperature. Zinc(II) triflate (4.5039 g; 12.4 mmol) was loaded in one portion. Most of the solids dissolved readily. The reaction mixture was refluxed (oil bath temperature=63° C.) for 26 hours (some insoluble yellow material separated). Upon cooling to room temperature, the mixture was partitioned between dichloromethane (250 mL) and DI water (100 mL) in a separatory funnel. After shaking and decanting, the aqueous phase was discarded. The organic phase was washed with DI water (2×100 mL) and saturated aqueous NaCl (100 mL), then stripped of volatiles under reduced pressure (rotary evaporator; water bath=45° C.). The crude material was dissolved in dichloromethane (100 mL). The obtained solution (some insoluble material remained) was carefully charged into a sintered filter (7.2 cm inner diameter) previously prepared with silica gel (high purity; 60 Å; 230-400 mesh; 40-63 μm; approx. 7.0 cm height dry) and eluent (70% dichloromethane-25% hexanes-5% ethyl acetate). The filter was gravimetrically eluted with additional eluent. The colored filtrate was collected (approx. 700 mL) and stripped of volatiles under reduced pressure (rotary evaporator; water bath=45° C.). The obtained solid was dried on the rotary evaporator (water bath=45° C.; <5 mbars) for 15 min to yield 10.3 g (33% with respect to 1,4-phenylenediamine) of 2,2,4,7,7,9-hexamethyl-1,2,6,7-tetrahydropyrido[2,3-g]quinoline (Compound 32-H) as a yellow solid. Compound 32-H was characterized by ¹H and ¹³C APT NMR spectroscopy. LC-UV analysis indicated 91.9% purity at 260 nm detection.

### Example 31

### Synthesis of 2,2,4,7,7,9-hexamethyl-1,2,3,4,6,7,8,9-octahydropyrido[2,3-g]quinoline (Compound 33-H)

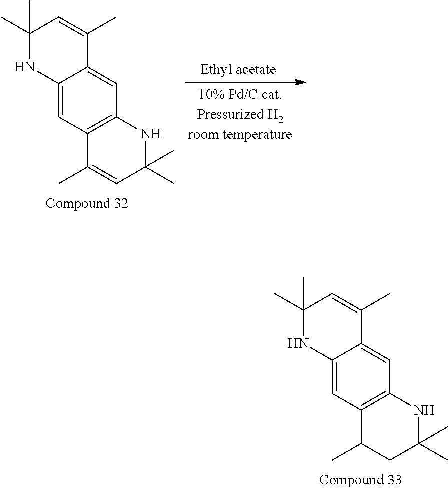

To a 300-mL Parr autoclave was loaded Compound 32-H (3.0 g; 11.2 mmol), ethyl acetate (100 mL), and 10% Pd on C (Sigma; 0.61 g). The reaction mixture was stirred at room temperature under pressurized H₂ (50 PSIG) for 35 minutes. The mixture post reaction was filtered under suction through Celite S and the cake was rinsed with copious amounts of ethyl acetate. The combined filtrates were stripped of their volatiles under reduced pressure (rotary evaporator; water bath=50° C.) to yield 2,2,4,7,7,9-hexamethyl-1,2,3,4,6,7,8,9-octahydropyrido[2,3-g]quinoline (Compound 33-H) as a light-brown solid weighing 2.1 g. Compound 33-H was characterized by ¹H and ¹³C APT NMR spectroscopy. LC-UV analysis indicated 93.1% purity at 260 nm detection as a mixture of diastereomers.

### Example 32

### Synthesis of 2,2,4,8-tetramethyl-N-(4-methylpentan-2-yl)-1,2-dihydroquinolin-7-amine (Compound 1-J)

### Step 1

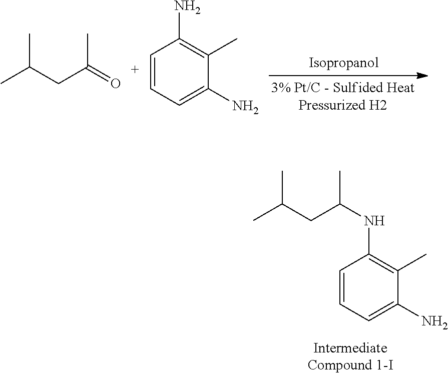

To a 300-mL Parr autoclave was loaded 2-methylbenzene-1,3-diamine (25.4 g; 208 mmol), isopropanol (200 mL), methyl isobutyl ketone (MIBK; 26 mL; 208 mmol), and 3% Pt/C sulfided from Johnson Matthey (approx. 373 mg wet). The reaction mixture was stirred and heated to 180° C. under 450 PSI H₂ for about 6-7 hours. Upon cooling to room temperature (overnight; under N₂ protection), the mixture post reaction was filtered through inline 0.2-micron frit. The clave was rinsed with ethyl acetate (200 mL) and the contents were filtered through the inline frit. The combined filtrates were stripped of volatiles under reduced pressure (rotary evaporator; water bath=55° C.). The crude material was diluted with hexanes (16 mL). The obtained slurry was loaded into a 73 mm inner diameter column chromatography prepared with silica gel 60 and 30% ethyl acetate in hexanes (height of wet silica gel in column=19 cm). The flask and column walls were carefully rinsed with hexanes (9-10 mL). The column was eluted with 30% ethyl acetate in hexanes. Each fraction coming out (80-100 mL) was analyzed by silica gel TLC (30% ethyl acetate in hexanes). The fractions showing a dot at R_{f}=0.4 were collected, combined, and stripped of volatiles under reduced pressure (rotary evaporator; water bath=50° C.). The material was dried on the rotary evaporator (55° C.; <25 mbars) for about 1.5 hours to afford 19.2 g (45% with respect to 2-methylbenzene-1,3-diamine) of 2-methyl-N1-(4-methylpentan-2-yl)benzene-1,3-diamine (Intermediate compound 1-I) as an oil. Intermediate 1-I was characterized by HPLC-UV/MS. The purity was 97.3 area % as measured at 260 nm detection.

### Step 2

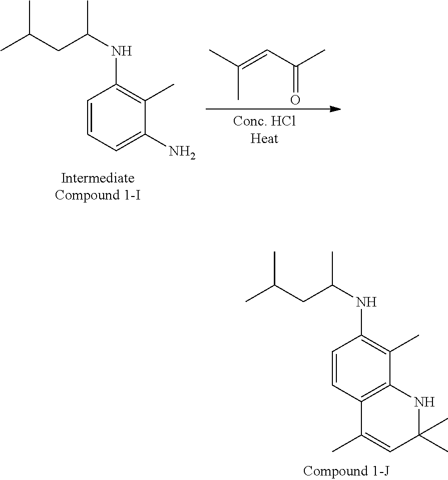

To a 500-mL round bottom flask fitted with a stir-bar and a 60-mL pressure-equalized addition funnel was loaded Intermediate compound 1-I (36.3 g; 176 mmol). The flask was put under N₂ protection and magnetic stirring was started. Aqueous 37% HCl (2.2 mL; 27 mmol HCl) was added. The mixture was heated with an oil bath set to 104° C. Mesityl oxide (47.5 mL; 413 mmol) was placed in the addition funnel. Once the set temperature was attained, mesityl oxide was dropwise added over about 1.5 hours. After completion of the mesityl oxide addition, the reaction mixture was stirred and maintained at the same temperature for 30 minutes. Upon cooling to room temperature, sodium carbonate (6.01 g; 56.7 mmol) was added in one portion. The mixture was stirred for about 1.5 hours, allowed to stand overnight, then loaded into a 73 mm inner diameter column prepared with silica gel 60 and 10% ethyl acetate in hexanes (height of wet silica gel in column=28 cm). The flask and column walls were rinsed with minute amounts of hexanes. The column was eluted with 10% ethyl acetate in hexanes. Each fraction coming out was analyzed by silica gel TLC (10% ethyl acetate in hexanes). The fractions showing a dot at R_{f}=0.5 were collected, combined, and stripped of volatiles under reduced pressure (rotary evaporator; water bath=50° C.). At that stage, the product was an orange liquid weighing 28.4 grams and was 76-77 area % pure as measured by HPLC-UV at 260 nm detection. The impure material was diluted with hexanes (13 mL). The obtained solution was loaded into a 73 mm inner diameter column prepared with silica gel 60 and 5% ethyl acetate in hexanes (height of silica gel=16 cm). The flask and column walls were rinsed with minute amounts of hexanes. The column was eluted with 5% ethyl acetate in hexanes. Each fraction coming out was analyzed by silica gel TLC (5% ethyl acetate in hexanes). The fractions showing a dot at R_{f}=0.3 were collected, combined, and stripped of volatiles under reduced pressure (rotary evaporator; water bath=50° C.). Further drying on the rotary evaporator (water bath=70° C.; <3 mbars) for approx. 2 hours afforded 24.0 g (47% yield with respect to Intermediate Compound 1-I) of 2,2,4,8-tetramethyl-N-(4-methylpentan-2-yl)-1,2-dihydroquinolin-7-amine (Compound 1-J) as an orange liquid. The desired structure was authenticated by proton and carbon 13 APT NMR spectroscopy (DMSO-d₆). LC-UV analysis showed 97.5% purity at 260 nm detection.

### Example 33

### Synthesis of N-isopropyl-4,8-dimethyl-4-phenyl-1,2,3,4-tetrahydroquinolin-7-amine (Compound 2-J)

### Step 1

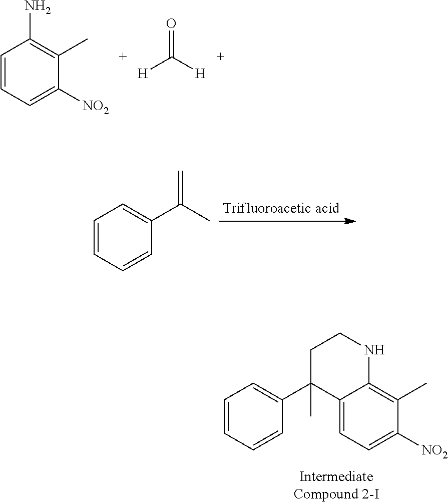

To a 1-L round bottom flask fitted with a reflux condenser was loaded 2-methyl-3-nitroaniline (20.1 g, 0.132 mol) and acetonitrile (250 mL). The mixture was stirred under nitrogen. To the obtained clear yellow solution was added trifluoroacetic acid (TFA, 10.72 mL, 0.140 mol), aqueous 37% formaldehyde solution (17.4 mL, 0.233 mol HCHO), and alpha-methylstyrene (30.7 mL, 0.236 mol) in that order. Upon addition of alpha-methylstyrene, the solution increased in temperature from 19° C. to 28° C., and the color became reddish. The reaction mixture was stirred for 4 hours in an 85° C. oil bath. Aqueous 1.2 M sodium bicarbonate 250 mL was added to quench the TFA. The reaction was stirred until frothing ceased, and the mixture was transferred to a 2-L separatory funnel. The aqueous phase was discarded and to the organic layer was added 250 mL of 1M sodium bisulfite. The mixture was shaken and the aqueous layer was discarded. The organic layer was then washed with 250 mL of brine, and dried over magnesium sulfate. The suspension was then filtered and evaporated to yield a dark orange oil (24.15 g). A 10 g portion of the dark oil was eluted through silica gel using 20% v/v ethyl acetate/hexanes, and the fractions containing product were collected and evaporated to give 4,8-dimethyl-7-nitro-4-phenyl-1,2,3,4-tetrahydroquinoline (Intermediate Compound 2-I) as a yellow oil (2.73 g). Intermediate compound 2-I was characterized by ¹³C APT NMR spectroscopy in DMSO-d₆. The material was used in Step 2 without further purification.

### Step 2

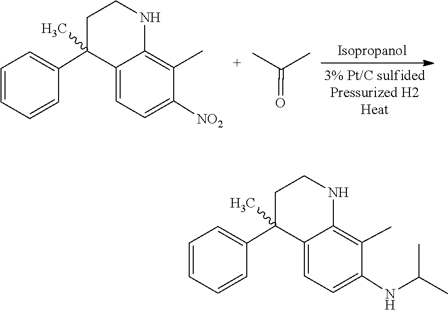

To a 300-mL Parr autoclave was loaded Intermediate Compound 2-I (2.60 g, 9.21 mmol), 3% Pt/C sulfided from Johnson Matthey (0.0629 g wet), acetone (1.75 mL, 23.6 mmol), and isopropanol (140 mL). The reaction mixture was stirred and heated to 150° C. under 250 PSI H₂ for 6 hours. Upon cooling to room temperature, the solution was filtered through the inline 0.2-micron frit. The reactor was rinsed with an additional 50 mL of fresh isopropanol and the mixture was filtered through the inline 0.2-micron frit. The filtrates were combined and concentrated under reduced pressure at 50° C. to approx. 10 mL. The product was purified on a silica gel column using 20% v/v ethyl acetate/hexanes. Volatiles were evaporated under reduced pressure at 50° C. to give a viscous orange oil. Upon standing for 16 hours at ambient temperature the oil became a crystalline orange solid yielding 1.75 g of N-isopropyl-4,8-dimethyl-4-phenyl-1,2,3,4-tetrahydroquinolin-7-amine (Compound 2-J) (97.1% purity by HPLC at 260 nm, 63% yield). MS (APCI+): m/z: [M+1] 295 amu. Compound 2 was characterized by ¹³C APT NMR spectroscopy in CDCl₃.

### Example 34

### Synthesis of 2,2,4-trimethyl-N-phenyl-2,3-dihydro-1H-benzo[b][1,4]diazepin-8-amine and 2,2,4-trimethyl-N-phenyl-2,3-dihydro-1H-benzo[b][1,4]diazepin-7-amine (Mixture of Compounds 19-J and 20-J)

### Step 1

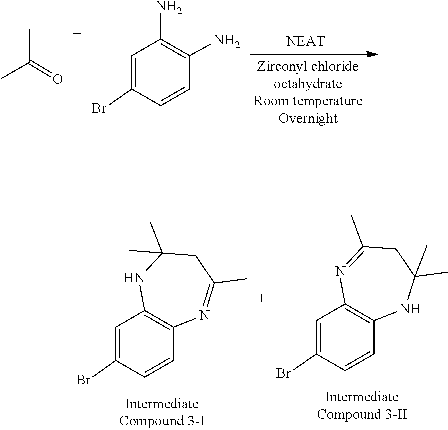

To a 250-mL round bottom flask fitted with a stir-bar was charged 4-bromo-1,2-diaminobenzene (14.5 g; 77.5 mmol). The flask was put under N₂ protection and acetone (28.5 mL; 388 mmol) was added. Stirring was started (the substrate dissolved readily) and zirconyl chloride octahydrate (2.45 g; 7.6 mmol Zr⁴⁺ cation) was added in several portions over 2-3 minutes (an insignificant exotherm ensured). The reaction mixture was stirred without external cooling or heating for 18 h30 (overnight). The obtained dark slurry was loaded into a 73 mm inner diameter column prepared with silica gel 60 and 30% AcOEt in hexanes. The height of wet silica gel in the column was 12.5-13.0 cm. The flask and column walls were rinsed with minutes amounts of toluene. The column was eluted with 30% AcOEt in hexanes. Each fraction coming out was analyzed by silica gel TLC (30% AcOEt in hexanes). The fractions containing the dot at Rf=0.2 were combined and stripped of volatiles under reduced pressure (rotary evaporator; water bath=50 deg C.). Further drying on the rotary evaporator (55 deg C.; approx. 75 mbars) for 2 hours afforded 15.7 g of a light-brown oil. Carbon 13 APT NMR analysis (DMSO-d₆) displayed the presence of 2 regioisomers (mixture of Compound 3-I and Compound 3-II). The purity was 88.4 area % as measured by HPLC-UV at 260 nm detection (a single peak accounting for the two regioisomers Compounds 3-I and Compound 3-II was observed). The material was used in Step 2 without further purification.

### Step 2

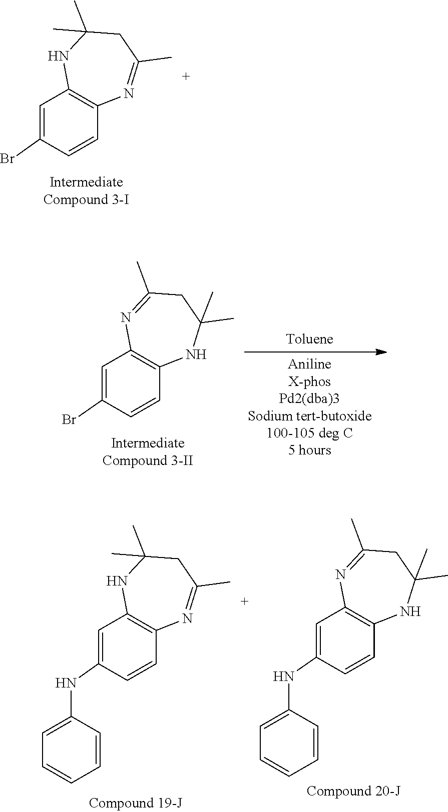 [SMILES: CC1=Nc2ccc(Br)cc2NC(C)(C)C1 ; CC1=Nc2cc(Br)ccc2NC(C)(C)C1 ; CC1=Nc2ccc(Nc3ccccc3)cc2NC(C)(C)C1 ; CC1=Nc2cc(Nc3ccccc3)ccc2NC(C)(C)C1]

To a 250-mL round bottom flask fitted with a stir-bar and a reflux condenser was charged the mixture of compounds 3-I and 3-II (4.95 g; 18.5 mmol total aryl-Br), anhydrous grade toluene (50 mL), and aniline (2.2 mL; 24.1 mmol). The mixture was stirred under N₂ blanket. Once the substrate was fully dissolved, N₂ was bubbled thought the solution for a few min. Dicyclohexyl(2′,4′,6′-triisopropyl-[1,1′-biphenyl]-2-yl)phosphane (0.365 g; 0.766 mmol), tris(dibenzylideneacetone) dipalladium (0) (0.353 g; 0.385 mmol), and sodium tert-butoxide (2.50 g; 26.0 mmol) were sequentially added to the flask. N₂ was bubbled through the mixture for a few min one more time. The reaction mixture was heated (oil bath temperature set to 105 deg C.) under N₂ blanket for 5 hours. Upon cooling to room temperature (overnight), the mixture post-reaction was filtered under suction over Celite S. The cake was rinsed with toluene. The combined filtrates were stripped of volatiles under reduced pressure (rotary evaporator; water bath=65 deg C.). The obtained thick dark liquid was diluted with minute amounts of toluene and loaded into a 41 mm inner diameter column prepared with silica gel 60 and AcOEt. The height of wet silica gel in the column was 22-23 cm. The column was eluted with AcOEt, then with 10% isopropanol in AcOEt. Each fraction coming out was analyzed by silica gel TLC (AcOEt). The fractions containing the dot at Rf=0.4 were combined and stripped of volatiles under reduced pressure (rotary evaporator; water bath=55 deg C.). Further drying on the rotary evaporator (water bath=55° C.; <25 mbars) until constant weight afforded 4.0 g of a brown glassy solid (mixture of Compound 19-J and Compound 20-J; combined yield=77% with respect to total aryl bromide). The desired structures were authenticated by carbon 13 APT NMR spectroscopy (DMSO-d₆). LC-UV analysis showed 98.5% purity at 260 nm detection (a single peak accounting for the 2 regioisomers Compounds 19-J and Compound 20-J was observed).

### Example 35

### Synthesis of N¹,N²,N⁴-trineopentylbenzene-1,2,4-triamine (Compound 11-J)

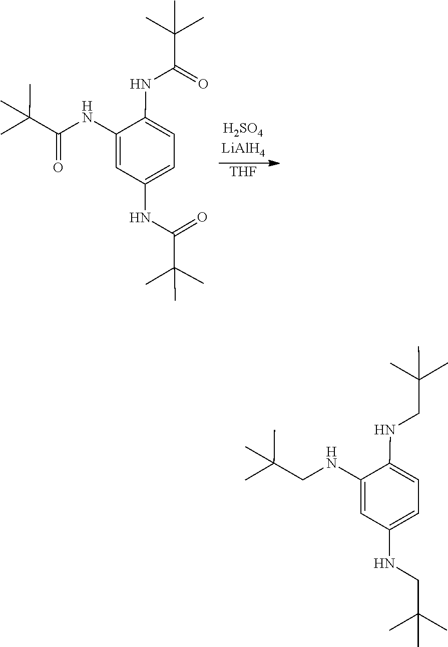 [SMILES: CC(C)(C)C(=O)Nc1ccc(NC(=O)C(C)(C)C)c(NC(=O)C(C)(C)C)c1 ; CC(C)(C)CNc1ccc(NCC(C)(C)C)c(NCC(C)(C)C)c1 ; "THF"]

This is a prophetic example. Concentrated sulfuric acid (15 mmol) is dropwise added at 0° C. to a suspension of 30 mmol of lithium aluminum hydride in 100 mL of argon saturated THF. After hydrogen gas evolution ceases, the resulting suspension is stirred for 1 h at ambient temperature. 1.0 mmol of 1,2,4-tris(2,2-dimethylpropanamido)benzene (Seillan et al Eur. J. Org Chem 2008, 3113) is slowly added portion-wise. The resulting mixture is stirred for 3 days at ambient temperature. Degassed water is added at 0° C. to quench the aluminum hydrides. The solution is extracted 3× with diethyl ether and the combined extracts are dried over MgSO₄. After filtration, solvent is removed in vacuo to afford Compound 11-J.

### Example 36

### Synthesis of N-isopropylbenzo[d]thiazol-5-amine (Compound 17-J)

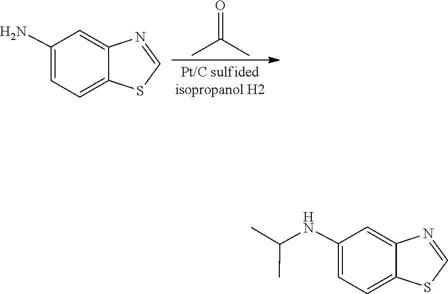

This is a prophetic example. To a 300-mL Parr autoclave is loaded 3.0 g benzo[d]thiazol-5-amine (Komuraiah, et al Chemical Biology & Drug Design 2021, 97(5), 1109-1116), 3% Pt/C sulfided (Johnson Matthey) (0.0629 g wet), acetone (1.75 mL, 23.6 mmol), and isopropanol (140 mL). The reaction mixture is stirred and heated to 150° C. under 250 PSI H₂ for 6 hours. Upon cooling to room temperature, the solution is filtered through the inline 0.2-micron frit. The reactor is rinsed with an additional 50 mL of fresh isopropanol and the mixture is filtered through the inline 0.2-micron frit. The filtrates are combined and concentrated under reduced pressure at 50° C. to approx. 10 mL. The product is purified on a silica gel column using ethyl acetate/hexanes. Volatiles are evaporated under reduced pressure at 50° C. to afford Compound 17-J.

### Example 37

### Use of Compounds of the Disclosure in Sidewall Formulations

In this study, rubber compounds were prepared using Compounds 1-A, 2-A, and 3-A as antidegradants in sidewall formulations. As shown in Table 2A, these rubber compounds are a 50/50 blend of natural rubber and butadiene rubber with a carbon black of the N500 series. Sidewall compounds with Compounds 1-A, 2-A, and 3-A can be seen in Examples #1, #2, and #3, respectively. According to American Society for Testing Materials (ASTM) test method D5289, vulcanization properties of all the compounds were characterized by a moving die rheometer (Alpha Technologies MDR 2000), also known as MDR, at a temperature of 160° C. for 60 minutes. The oscillation strain and frequency were set to 0.5° C. and 1.667 Hz, respectively. The MDR test results were summarized in Table 3A.

TABLE 2A

| Material | Example #1 | Example #2 | Example #3 |
|---|---|---|---|
| Natural rubber | 50 | 50 | 50 |
| (SIR-10) | | | |
| Butadiene | 50 | 50 | 50 |
| rubber (CB24) | | | |
| N-550 Carbon | 50 | 50 | 50 |
| Black | | | |
| Stearic acid | 2 | 2 | 2 |
| Calsol 8240 | 6.25 | 6.25 | 6.25 |
| (Naphthenic | | | |
| Oil) | | | |
| Zinc oxide | 4 | 4 | 4 |
| Sulfur | 1.5 | 1.5 | 1.5 |
| TBBS | 0.6 | 0.6 | 0.6 |
| Compound 1-A | 2.68 | — | — |
| Compound 2-A | — | 2.71 | — |
| Compound 3-A | — | — | 2.6 |
| Total parts per | 167.03 | 167.06 | 166.95 |
| hundred rubber | | | |
| (phr) | | | |

TABLE 3A

| Material | Example #1 | Example #2 | Example #3 |
|---|---|---|---|
| Temperature (° C.) | 150 | 150 | 150 |
| ML (dNm) ¹ | 2.38 | 2.53 | 2.48 |
| MH (dNm) ² | 15.43 | 15.18 | 14.8 |
| Ts₂ (min) ³ | 7.51 | 5.87 | 7.06 |
| T₁₀ (min) ⁴ | 7.05 | 5.47 | 6.59 |
| T₅₀ (min) ⁵ | 9.6 | 7.75 | 9.04 |
| T₉₀ (min) ⁶ | 14.84 | 12.67 | 14.09 |

¹ ML is the minimum torque, which is a measure of rigidity and viscosity of the non-vulcanized compound.
² MH is the maximum torque, which is a measure of the cross-linking density of the fully vulcanized compound.
³ Ts₂ is the time for viscosity to increase 2 units (dNm) above ML.
⁴ T₁₀ is the moment when 10% cross-linking has been reached.
⁵ T₅₀ is the moment when 50% cross-linking has been reached.
⁶ T₉₀ is the moment when 90% cross-linking has been reached.

### Example 38

### Antiozonant Performance of Compounds of the Disclosure in Sidewall Compounds

Each of the rubber compounds prepared in Example 32 were cured at 150° C. to a state equivalent to its T₉₀ time. The ozone test specimens were died out from vulcanized tensile sheets by using a die followed the American Society for Testing and Materials (ASTM) D1329 standard. The ozone test specimens were stored at ambient environment for more than 24 hours prior to antiozonant performance testing in an ozone chamber, which was maintained at an ozone concentration of 10±2 parts per hundred million (pphm) and 40±2° C. The ozone test specimens were simultaneously relaxed and extended within ozone chamber under three different conditions: static, intermittent, and dynamic. The ozone test specimens were maintained at 25% strain during static exposure and alternately relaxed and extended to 25% strain at a rate of 90 cycles per minute during dynamic exposure. The intermittent test alternated 18 minutes of dynamic exposure and 102 minutes of static exposure. Exposure was in increments of 16 hours followed by at least one hour of relaxation after removal from the ozone chamber and prior to measurement of force at a strain of 100%.

Antiozonant performance of antidegradant formulated compounds were evaluated by percentage of force retention. Percentage of force retention is defined by equation 1.

$$Percentage of force retention = \frac{F}{{F}_{0}} * 100 \% \qquad Equation 1$$

wherein F₀ is the force at a strain of 100% prior to ozone testing and F is the force at a strain of 100% after samples are aged in ozone chamber for 16-hour cycle at static, intermittent, or dynamic exposure. Higher percentage of force retention is an indication of better antiozonant performance of an antidegradant compound incorporated in the vulcanized rubber compound.

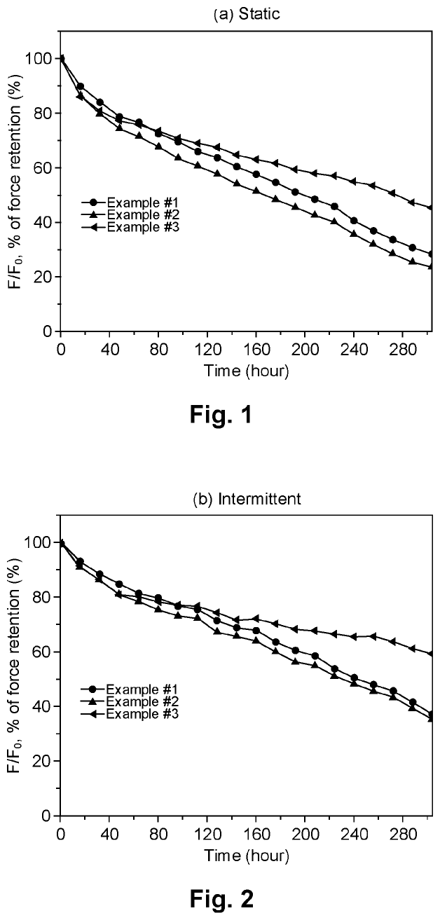

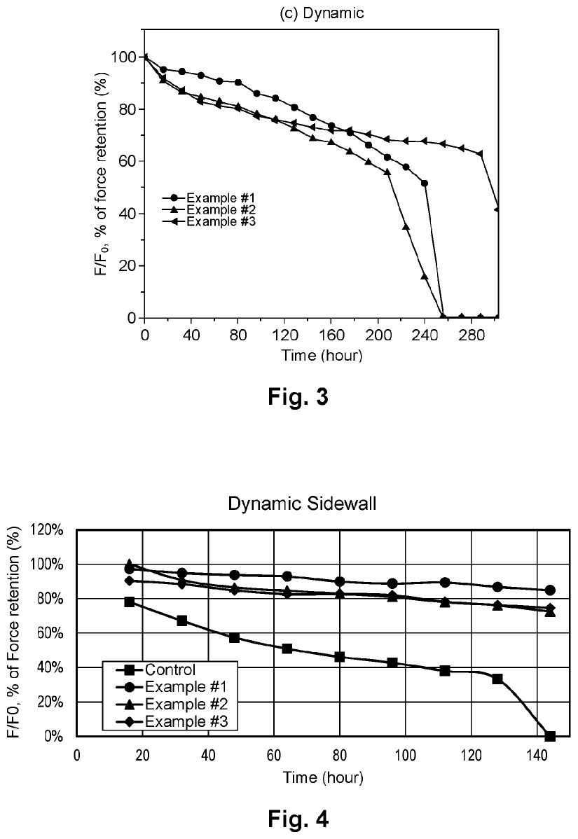

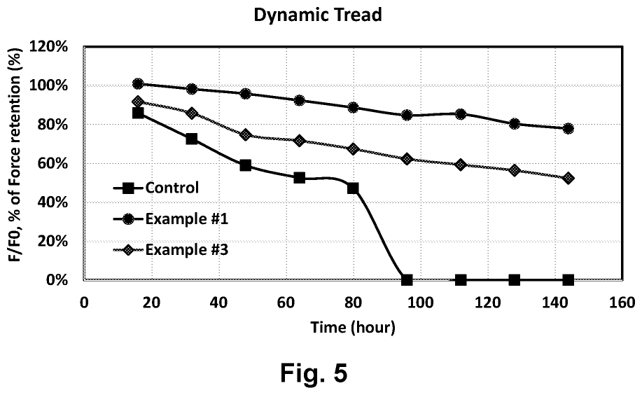

The force of aged and unaged ozone test specimens was measured by using a tensometer (Alpha Technologies, 2000) at a strain of 100%. The percentage of force retention were calculated and plotted as a function of ozone aging time in FIGS. 1-5.

### Example 39

### Oxidative Induction Time (OIT) Performance of Compounds of the Disclosure

In order to demonstrate the antioxidant efficacy of the Compounds of the Disclosure, the oxidative induction time (OIT) of selected examples were evaluated. OIT is measured according to a procedure carried out in a differential scanning calorimeter (TA Instruments, Q200), also knows as DSC, and is used to predict thermo-oxidative performance of a material. In this procedure, each sample is held in a sample cell and heated under a nitrogen atmosphere to a preselected temperature. Oxygen is then introduced to the sample cell and the length of time before the onset of degradation, as seen by the initiation of increase in heat flow, is measured.

0.5 wt % of a Compound of the Disclosure, or no antidegradant (blank) was mixed with polyisoprene and heated isothermally at 160° C. in O₂. The peak time of OIT testing in minutes is shown in Table 4A. As indicated by the data in Table 4A, the molecules of the present invention demonstrate some antioxidant performance compared against blank control and indicates utility in rubber and other applications that can benefit from an active antioxidant.

TABLE 4A

| | Peak time of OIT |
|---|---|
| Material | testing (minutes) |
| Blank | 1-2 |
| Compound 1-A | 4.8 |
| Compound 2-A | 10.8 |
| Compound 3-A | 5.9 |
| Compound 7-A | 4.1 |
| Compound 8-A | 2.9 |
| Compound 11-A | 2.5 |
| Compound 16-A | 6.6 |
| Compound 19-A | 2.7 |
| Compound 20-A | 2.3 |
| Compound 21-A | 2.6 |
| Compound 27-A | 4.2 |
| Compound 153-A | 5.8 |
| Compound 154-A | 1.5 |
| Compound 1-B | 15.2 |
| Compound 2-B | 17.8 |
| Compound 7-B | 31.0 |
| Compound 119-B | 21.9 |
| Compound 120-B | 11.5 |
| Compound 1-C | 19.2 |
| Compound 2-C | 14.1 |
| Compound 19-C | 6.9 |
| Compound 7-D | 24.6 |
| Compound 1-E | 11.1 |
| Compound 1-F | 20.3 |
| Compound 2-F | 17.4 |
| Compound 3-F | 43.8 |
| Compound 4-F | 19.6 |
| Compound 47-F | 3.2 |
| Compound 1-H | 10.7 |
| Compound 3-H | 12.9 |
| Compound 32-H | 6.6 |
| Compound 33-H | 8.3 |
| Compound 52-I | 36.3 |
| Compound 53-I | 16.0 |
| Compound 1-J | 2.6 |
| Compound 2-J | 15.6 |

Having now fully described the methods, compounds, and compositions herein, it will be understood by those of skill in the art that the same can be performed within a wide and equivalent range of conditions, formulations, and other parameters without affecting the scope of the methods, compounds, and compositions provided herein or any embodiment thereof. All patents, patent applications, and publications cited herein are fully incorporated by reference herein in their entirety.

What is claimed is:

1. A composition comprising the following components:
(i) a first antidegradant; and
(ii) one or more elastomers; or
(iii) one or more fillers; or
(iv) one or more rubber chemicals; or
(v) one or more plasticizers; or
(vi) one or more second antidegradants; or
(vii) a combination of one or more elastomers, one or more fillers, one or more rubber chemicals, one or more plasticizers, and/or one or more second antidegradants,
wherein the first antidegradant is: (a) a compound of any one of Formulae (I-A), (IV-A), (I-B), (I-C), (VI-C), (VII-C), (I-D), (II-D), (III-D), (IV-D), (V-D), (VI-D), (VII-D), (I E), (II-E), (III-E), (IV-E), (V-E), (VI-E), (I-F), (II-F), (III-F), (I-G), (II-G), (III-G), (I-H), (II-H), (III-H), (IV-H), (V-H), (VI-H), or (I-J), (II-J), (III-J), (IV-J), (V-J), (VI-J), (VII-J), (VIII-J), (IX-J), (X-J), (XI-J), (XII-J), (XIII-J), (XIV-J), or (XV-J); or (b) a compound of Table A, Table B, Table C, Table D, Table E, Table F, Table G, Table H, Table I, or Table J.

2. The composition of claim 1 comprising the components of any one of Tables 1-55, 57-73, or 75-98.

3. The composition of claim 2 further comprising one or more additional elastomers.

4. The composition of claim 2 or 3 further comprising one or more additional fillers.

5. The composition of any one of claims 2-4 further comprising one or more additional rubber chemicals.

6. The composition of any one of claims 2-5 further comprising one or more additional plasticizers.

7. The composition of any one of claims 2-6 further comprising one or more second antidegradants.

8. The composition of any one of claims 2-7 further comprising one or more one or more carriers.

9. The composition of claim 1 consisting essentially of the components of any one of Tables 1-55, 57-73, or 75-98.

10. The composition of claim 1 consisting of the components of any one of Tables 1-55, 57-73, or 75-98.

11. The composition of claim 1 comprising the components of any one of Tables 56, 74, or 99.

12. The composition of claim 1 consisting essentially of the components of any one of Tables 56, 74, or 99.

13. The composition of claim 1 consisting of the components of any one of Tables 56, 74, or 99.

14. A composition disclosed in a US Patent Application Publication listed in Table 100, Table 101, or Table 102, wherein:
(i) the composition comprises one or more antidegradants; and
(ii) at least one of the one or more antidegradants is either partially or completely removed from the composition and replaced with a compound of: (a) any one of Formulae (I-A), (IV-A), (I-B), (I-C), (VI-C), (VII-C), (I-D), (II-D), (III-D), (IV-D), (V-D), (VI-D), (VII-D), (I E), (II-E), (III-E), (IV-E), (V-E), (VI-E), (I-F), (II-F), (III-F), (I-G), (II-G), (III-G), (I-H), (II-H), (III-H), (IV-H), (V-H), (VI-H), or (I-J), (II-J), (III-J), (IV-J), (V-J), (VI-J), (VII-J), (VIII-J), (IX-J), (X-J), (XI-J), (XII-J), (XIII-J), (XIV-J), or (XV-J); or (b) Table A, Table B, Table C, Table D, Table E, Table F, Table G, Table H, Table I, or Table J.

15. A composition disclosed in a US Patent listed in Table 103 or Table 104, wherein:
(i) the composition comprises one or more antidegradants; and
(ii) at least one of the one or more antidegradants is either partially or completely removed from the composition and replaced with a compound of: (a) any one of Formulae (I-A), (IV-A), (I-B), (I-C), (VI-C), (VII-C), (I-D), (II-D), (III-D), (IV-D), (V-D), (VI-D), (VII-D), (I E), (II-E), (III-E), (IV-E), (V-E), (VI-E), (I-F), (II-F), (III-F), (I-G), (II-G), (III-G), (I-H), (II-H), (III-H), (IV-H), (V-H), (VI-H), or (I-J), (II-J), (III-J), (IV-J), (V-J), (VI-J), (VII-J), (VIII-J), (IX-J), (X-J), (XI-J), (XII-J), (XIII-J), (XIV-J), or (XV-J); or (b) Table A, Table B, Table C, Table D, Table E, Table F, Table G, Table H, Table I, or Table J.

16. The composition of claim 14 or 15, wherein 6PPD is either partially or completely removed from the composition.

17. A vulcanized elastomeric article prepared using the composition of any one of claims 1-16.

18. The vulcanized elastomeric article of claim 17, wherein the vulcanized elastomeric article is a tire.

19. A vehicle comprising the vulcanized article of claim 17 or 18.
